(19) United States
(12) Patent Application Publication
(10) Pub. No.: US 2021/0253985 A1
(43) Pub. Date: Aug. 19, 2021

(54) MOSCATO WINE REPLICAS PRODUCED FROM INDIVIDUAL COMPONENTS

(71) Applicant: Ava Food Labs, Inc., San Francisco, CA (US)

(72) Inventors: Mardonn Carl Chua, San Francisco, CA (US); Alec Kremonic Lee, San Francisco, CA (US); Joshua Canaria Decolongon, San Francisco, CA (US); Ethan Charles Beswick, San Francisco, CA (US); Leslie P. Silva, Emeryville, CA (US); Jillian Angela Jastrzembski, San Francisco, CA (US); Taylor Shulman, Berkeley, CA (US); Joshua Lundquist, Dublin, CA (US)

(21) Appl. No.: 16/971,593

(22) PCT Filed: Feb. 22, 2019
(86) PCT No.: PCT/US19/19312

§ 371 Date: Aug. 20, 2020

Related U.S. Application Data
(60) Provisional application No. 62/634,747, filed on Feb. 23, 2018.

(51) Int. Cl. C12G 1/00

(52) U.S. Cl. CPC C12G 1/00; C12G 2200/21

(57) ABSTRACT

Materials and methods for producing Moscato wine replicas from individual components are provided herein.

### CROSS-REFERENCE TO RELATED APPLICATIONS

This application claims benefit of priority from U.S. Provisional Application Ser. No. 62/634,747, filed on Feb. 23, 2018.

### TECHNICAL FIELD

This document relates to materials and methods for producing Moscato wines from individual components.

### BACKGROUND

Traditional methods for producing alcoholic beverages are often lengthy and costly, involving the harvesting of fastidious crops, followed by processing, fermenting, and aging steps. Each component of the traditional, geographically constrained process has an inherent variability and risk, including climate, crop disease, and contamination, which can render such methods and their resulting products inconsistent from batch to batch and year to year. Traditional wine production methods require imprecise practices, and it can be difficult to account for all inconsistencies, often involving adulteration of the final product with ingredients to mask imperfections.

### SUMMARY

This document is based, at least in part, on the identification of compounds that contribute to the flavor and aroma of Moscato wines, and on the development of methods for combining those compounds to yield Moscato replicas that have the taste, aroma, and other characteristics of traditionally generated Moscato wines. Because each ingredient is added individually, the methods disclosed herein reduce many of the risks and variability associated with traditional wine production, which can vary by region, vineyard, or year. In some cases, one or more ingredients (e.g., at least 50%, 60%, 70%, 80%, 90%, 95%, 99%, or 100% of the ingredients) can be highly defined (e.g., by lot analysis). In some cases, one or more ingredients (e.g., at least 50%, 60%, 70%, 80%, 90%, 95%, 99%, or 100% of the ingredients) can be highly pure (e.g., at least 90%, 95%, 96%, 97%, 98%, 99%, 99.5%, or 99.9% pure). The methods also provide infinite reproducibility of a recipe, which is not possible with traditional production methods. Further, the methods described herein allow for unique flexibility in optimization of the flavors, aromas, and textures of Moscato wine, and greatly reduce or even eliminate the possibility that the resulting wine will contain detrimental or undesired components. Moreover, the methods disclosed herein differ from currently existing methods in that they are rapid, reproducible, and cost-effective.

In one aspect, this document features a Moscato-like alcoholic beverage that contains ethanol, water, and one or more additional volatile organic compounds (VOCs), where the additional VOCs do not include one or more of 1-decanol, 1-octanol, 1-octen-3-ol, 2,3-pentadione, 2-methylbutyraldehyde, 4-ethyl phenol, cinnamaldehyde, cis-3-hexen-1-ol, ethyl levulinate, ethyl phenyl acetate, ethyl propionate, eucalyptol, isovaleraldehyde, methyl acetate, phenethyl acetate, propyl acetate, 1,1-diethoxyethane, 2-heptanone, 2-methoxy-4-propylphenol, 2-methylbutyl isovalerate, 2-nonanol, 2-undecanone, 3-carene, 4-ethyl guaiacol, acetophenone, alpha ionone, amyl butyrate, beta-ionone, butyl acetate, cis-3-hexenyl acetate, cis-whiskey lactone, diethyl malate, ethyl 3-hydroxyhexanoate, ethyl benzoate, ethyl cinnamate, ethyl heptanoate, ethyl myristate, ethyl nonanoate, ethyl salicylate, ethyl trans-2-butenoate, ethyl trans-3-hexenoate, ethyl undecanoate, ethyl(methylthio) acetate, ethyl-2-methylbutyrate, eugenol, farnesol, fufural, gamma-nonalactone, geranyl acetone, guaiacol, heptyl acetate, isoamyl hexanoate, isoamyl isobutyrate, isoamyl octanoate, isobutyl isobutyrate, isobutyraldehyde, linalool oxide, methional, methyl laurate, methyl octanoate, methyl salicylate, myrcene, p-cresol, p-cymene, phenethyl formate, phenethyl octanoate, salicylaldehyde, 2-acetylpyridine, 2-isopropyl-3-methoxypyrazine, 2-methoxy-4-methylphenol, 3-(methylthio)-1-propanol, 3,7 dimethyl-6-octenoic acid, 3-nonene-2-one, acetaldehyde, alpha-phellandrene, butyl formate, butyl isovalerate, dimethyl sulfide, ethyl palmitate, ethyl-3-hydroxybutyrate, gamma-octalactone, hexyl hexanoate, isoborneol, isovaleric acid, Jasmine lactone, maltol, myrtenol, octyl acetate, propyl hexanoate, trans-2-pentenal, trans-2-hexen-1-al, and trans-2-hexen-1-ol.

The one or more additional VOCs can include one or more, two or more, three or more, four or more, five or more, six or more, or all of butyl formate, ethyl octanoate, ethyl propionate, ethyl-2-methylbutyrate, isoamyl acetate, isoamyl alcohol, and isobutanol. In some cases, the one or more additional VOCs include no more than 6 of butyl formate, ethyl octanoate, ethyl propionate, ethyl-2-methylbutyrate, isoamyl acetate, isoamyl alcohol, and isobutanol. The one or more additional VOCs can include no more than 5 of butyl formate, ethyl octanoate, ethyl propionate, ethyl-2-methylbutyrate, isoamyl acetate, isoamyl alcohol, and isobutanol, or no more than 4 of butyl formate, ethyl octanoate, ethyl propionate, ethyl-2-methylbutyrate, isoamyl acetate, isoamyl alcohol, and isobutanol.

The Moscato-like alcoholic beverage can further include one or more non-volatile compounds, where the non-volatile compounds include one or more of glutamine, mannose, inositol, acetic acid, glycerol, disodium 5′ ribonucleotides, monosodium glutamate, a pH-modifying salt, food coloring Carotene, food coloring Caramel, a natural colorant derived from a fruit or vegetable, a synthetic dye, gum arabic, pectin, and a surfactant. The Moscato-like alcoholic beverage can further include one or more non-volatile compounds, where the non-volatile compounds do not include one or more of betaine, pyridoxine, choline, carnitine, ornithine, trans 4-hydroxy-L-proline, adenine, guanine, kynurenic acid, quinic acid, pantothenic acid, caffeic acid, polydatin, coumaric acid, pyruvic acid, D-glucuronic acid, fumaric acid, gallic acid, 2-furoic acid, 3,4-dihydroxybenzoic acid, 2-isopropylmalic acid, catechin, epicatechin, ellagic acid, salicylic acid, ribose, arabitol, and glucosamine.

The one or more additional VOCs can include one or more of the following: 2-nonanone in an amount of at least about 0.0013 mg/L, 2-phenylethanol in an amount less than about 13 mg/L, 2-phenyethylacetate in an amount of at least about 0.08 mg/L, 3-methyl-1-pentanol in an amount less than about 0.025 mg/L, 4-carvomenthenol in an amount of at least about 0.006 mg/L, benzaldehyde in an amount of at least about 0.004 mg/L, butyric acid in an amount less than about 0.035 mg/L, citronellol in an amount of at least about 0.01 mg/L, damascenone in an amount less than about 0.2 mg/L, decanoic acid in an amount of at least about 0.6 mg/L, delta-decalactone in an amount of at least about 0.007 mg/L, diethyl succinate in an amount less than about 0.4 mg/L, ethyl acetate in an amount less than about 12 mg/L, ethyl butyrate in an amount of at least about 0.25 mg/L, ethyl isobutyrate in an amount of at least about 0.3 mg/L, ethyl isovalerate in an amount of at least about 0.05 mg/L, ethyl lactate in an amount less than about 2 mg/L. ethyl octanoate in an amount less than about 2.5 mg/L. ethyl valerate in an amount of at least about 0.0012 mg/L, gamma-decalactone in an amount of at least about 0.012 mg/L, gamma-terpinene in an amount of at least about 0.0017 mg/L, geraniol in an amount of at least about 0.011 mg/L, hexyl acetate in an amount of at least about 0.04 mg/L, isoamyl acetate in an amount of at least about 1.7 mg/L, isobutyric acid in an amount less than about 1.6 mg/L, limonene in an amount of at least about 0.005 mg/L, linalool in an amount of at least about 0.5 mg/L, linalyl acetate in an amount of at least about 0.01 mg/L, linalyl butyrate in an amount of at least about 0.0002 mg/L, methyl decanoate in an amount of at least about 0.0008 mg/L, nerol in an amount of at least about 0.006 mg/L, phenethyl butyrate in an amount of at least about 0.0017 mg/L, phenethyl propionate in an amount of at least about 0.0002 mg/L, and/or propanol in an amount less than about 1.3 mg/L.

In some cases, at least about 0.008% by mass of the one or more additional VOCs can comprise (−)-beta-pinene, at least about 0.01% by mass of the one or more additional VOCs can comprise 2-methylbutyl acetate, at least about 0.0009% by mass of the one or more additional VOCs can comprise (−)-cis-rose oxide, at least about 0.0009% by mass of the one or more additional VOCs can comprise 2-nonanone, at least about 0.05% by mass of the one or more additional VOCs can comprise 2-phenethylacetate, at least about 0.004% by mass of the one or more additional VOCs can comprise 4-carvomenthenol, at least about 0.003% by mass of the one or more additional VOCs can comprise benzaldehyde, at least about 0.007% by mass of the one or more additional VOCs can comprise citronellol, at least about 0.4% by mass of the one or more additional VOCs can comprise decanoic acid, at least about 0.005% by mass of the one or more additional VOCs can comprise delta-decalactone, at least about 0.16% by mass of the one or more additional VOCs can comprise ethyl butyrate, at least about 0.2% by mass of the one or more additional VOCs can comprise ethyl isobutyrate, at least about 0.03% by mass of the one or more additional VOCs can comprise ethyl isovalerate, at least about 0.001% by mass of the one or more additional VOCs can comprise ethyl valerate, at least about 0.008% by mass of the one or more additional VOCs can comprise gamma-decalactone, at least about 0.0015% by mass of the one or more additional VOCs can comprise gamma terpinene. at least about 0.008% by mass of the one or more additional VOCs can comprise geraniol, at least about 0.03% by mass of the one or more additional VOCs can comprise hexyl acetate, at least about 1.2% by mass of the one or more additional VOCs can comprise isoamyl acetate, at least about 0.004% by mass of the one or more additional VOCs can comprise limonene, at least about 0.4% by mass of the one or more additional VOCs can comprise linalool, at least about 0.007% by mass of the one or more additional VOCs can comprise linalyl acetate, at least about 0.0002% by mass of the one or more additional VOCs can comprise linalyl butyrate, at least about 0.0007% by mass of the one or more additional VOCs can comprise methyl decanoate, at least about 0.004% by mass of the one or more additional VOCs can comprise nerol, at least about 0.002% by mass of the one or more additional VOCs can comprise phenethyl butyrate, and/or at least about 0.00016% by mass of the one or more additional VOCs can comprise phenethyl propionate.

The one or more additional VOCs can include an ester; an acid; an alcohol; an aldehyde, a ketone, or an aldehyde and a ketone; a terpene, an isoprenoid, or a terpene and an isoprenoid; a phenol; a lactone; and an amine, a pyrazine, or an amine and a pyrazine.

The one or more additional VOCs can include one or more esters. The one or more esters can be selected from the group consisting of 2-methylbutyl acetate, 2-phenethylacetate, amyl butyrate, butyl acetate, butyl formate, butyl isovalerate, cis-3-hexenyl acetate, diethyl succinate, ethyl acetate, ethyl anthranilate, ethyl butanoate, ethyl butyrate, ethyl decanoate, ethyl hexanoate, ethyl isobutyrate, ethyl isovalerate, ethyl lactate, ethyl laurate, ethyl myristate, ethyl nonanoate, ethyl octanoate, ethyl palmitate, ethyl phenyl acetate, ethyl propionate, ethyl undecanoate, ethyl valerate, ethyl-2-methylbutyrate, ethyl-3-hydroxybutyrate, heptyl acetate, hexyl acetate, hexyl hexanoate, isoamyl acetate, isoamyl octanoate, linalyl acetate, linalyl butyrate, methyl decanoate, methyl hexanoate, methyl laurate, methyl octanoate, methyl salicylate, methyl vanillate, octyl acetate, phenethyl butyrate, phenethyl octanoate, phenethyl propionate, and propyl hexanoate. The one or more additional VOCs can include one or more acids. The one or more acids can be selected from the group consisting of 3,7-dimethyl-6-octenoic acid, butyric acid, decanoic acid, hexanoic acid, isobutyric acid, isovaleric acid, and octanoic acid. The one or more additional VOCs can include one or more alcohols. The one or more alcohols can be selected from the group consisting of 1-decanol, 1-octanol, 1-octen-3-ol, 2-methyl-1-butanol, 2-phenylethanol, 3-methyl-1-pentanol, Amyl alcohol, benzyl alcohol, butanol, Hexanol, isoamyl alcohol, isobutanol, propanol, and trans-2-hexen-1-ol. The one or more additional VOCs can include one or more aldehydes or ketones. The one or more aldehydes or ketones can be selected from the group consisting of 2-heptanone, 2-methylbutyraldehyde, 2-nonanone, 2-undecanone, 3-nonen-2-one, acetaldehyde, acetovanillone, alpha-ionone, benzaldehyde, cinnamaldehyde, furfural, isovaleraldehyde, maltol, methional, p-anisaldehyde, trans-2-heptenal, trans-2-hexen-1-al, and trans-2-pentenal. The one or more additional VOCs can include one or more terpenes or isoprenoids. The one or more terpenes or isoprenoids can be selected from the group consisting of (−)-beta-pinene, (−)-cis-rose oxide, 3-carene, 4-carvomenthenol, alpha-phellandrene, alpha-terpineol, citronellol, damascenone, eucalyptol, gamma-terpinene, geraniol, isoborneol, limonene, linalool, linalool oxide, myrcene, myrtenol, nerol, and p-cymene. The one or more additional VOCs can include one or more phenols. The one or more phenols can be selected from the group consisting of 2-methoxy-4-methylphenol, 4-ethylguaiacol, 4-ethylphenol, eugenol, and guaiacol. The one or more additional VOCs can include one or more lactones. The one or more lactones can be selected from the group consisting of delta-decalactone, gamma-decalactone, gamma-nonalactone, gamma-octalactone, Jasmine lactone, and cis-whiskey lactone. The one or more additional VOCs can include one or more amines or pyrazines. The one or more amines or pyrazines can be selected from the group consisting of 2-acetylpyridine, 2-isopropyl-3-methoxypyrazine, and methyl anthranilate. The one or more additional VOCs can include one or more thiols. The one or more thiols can be selected from the group consisting of 2,3-pentadione, 3-(methylthio)-1-propanol, 3-mercaptohexylacetate, dimethyl sulfide, and furfuryl mercaptan.

The one or more additional VOCs can further include at least 10, at least 20, at least 30, or at least 40 compounds selected from the group consisting of (−)-beta-pinene, (−)-cis-rose oxide, 2-methyl-1-butanol, 2-methylbutyl acetate, 2-nonanone, 2-phenethyl acetate, 2-phenylethanol, 3-mercaptohexyl acetate, 3-methyl-1-pentanol, 4-carvomenthenol, 4-vinylphenol, acetovanillone, alpha-terpineol, benzaldehyde, benzyl alcohol, butanol, butyric acid, citronellol, damascenone, decanoic acid, delta-decalactone, diethyl succinate, ethyl acetate, ethyl butanoate, ethyl decanoate, ethyl hexanoate, ethyl isobutyrate, ethyl isovalerate, ethyl lactate, ethyl laurate, ethyl octanoate, ethyl valerate, gamma-decalactone, gamma-terpinene, geraniol, hexanoic acid, hexanol, hexyl acetate, isoamyl acetate, isoamyl alcohol, isobutyl alcohol, isobutyric acid, limonene, linalool, linalyl acetate, linalyl butyrate, methyl decanoate, methyl hexanoate, nerol, octanoic acid, phenethyl butyrate, phenethyl propionate, and propanol. The one or more additional VOCs can further include (−)-beta-pinene, (−)-cis-rose oxide, 2-methyl-1-butanol, 2-methylbutyl acetate, 2-nonanone, 2-phenethyl acetate, 2-phenylethanol, 3-mercaptohexyl acetate, 3-methyl-1-pentanol, 4-carvomenthenol, 4-vinylphenol, acetovanillone, alpha-terpineol, benzaldehyde, benzyl alcohol, butanol, butyric acid, citronellol, damascenone, decanoic acid, delta-decalactone, diethyl succinate, ethyl acetate, ethyl butanoate, ethyl decanoate, ethyl hexanoate, ethyl isobutyrate, ethyl isovalerate, ethyl lactate, ethyl laurate, ethyl octanoate, ethyl valerate, gamma-decalactone, gamma-terpinene, geraniol, hexanoic acid, hexanol, hexyl acetate, isoamyl acetate, isoamyl alcohol, isobutyl alcohol, isobutyric acid, limonene, linalool, linalyl acetate, linalyl butyrate, methyl decanoate, methyl hexanoate, nerol, octanoic acid, phenethyl butyrate, phenethyl propionate, and propanol.

The Moscato-like alcoholic beverage can further include one or more non-volatile compounds. The non-volatile compounds can include one or more of the following: leucine in an amount less than about 5 mg/L, methionine in an amount less than about 1.5 mg/L, lysine in an amount of at least about 8.5 mg/L, tryptophan in an amount less than about 2.2 mg/L, valine in an amount of at least about 0.8 mg/L, asparagine in an amount less than about 0.8 mg/L, glutamic acid in an amount of at least about 20 mg/L, arginine in an amount of at least about 8.8 mg/L, tartaric acid in an amount less than about 1800 mg/L, malic acid in an amount less than about 1000 mg/L, lactic acid in an amount less than about 50 mg/L, lactic acid in an amount of at least about 220 mg/L, citric acid in an amount less than about 190 mg/L, succinic acid in an amount less than about 260 mg/L, succinic acid in an amount of at least about 1100 mg/L, fructose in an amount less than about 60000 mg/L, glucose in an amount less than about 50000 mg/L, sorbitol in an amount of at least about 65 mg/L, mannitol in an amount less than about 75 mg/L, and/or mannitol in an amount of at least about 350 mg/L.

The non-volatile compounds can include at least 10, at least 15, or at least 20 compounds selected from the group consisting of acetic acid, a pH-modifying salt, tartaric acid, malic acid, citric acid, succinic acid, lactic acid, glucose, fructose, disodium 5′ ribonucleotides, monosodium glutamate, alanine, arginine, aspartic acid, asparagine, b-alanine, glutamic acid, glutamine, histidine, lysine, methionine, phenylalanine, proline, tryptophan, and tyrosine. In some cases, the non-volatile compounds can include acetic acid, a pH-modifying salt, tartaric acid, malic acid, citric acid, succinic acid, lactic acid, glucose, fructose, disodium 5′ ribonucleotides, monosodium glutamate, alanine, arginine, aspartic acid, asparagine, b-alanine, glutamic acid, glutamine, histidine, lysine, methionine, phenylalanine, proline, tryptophan, and tyrosine.

The non-volatile compounds can include at least five or at least ten compounds selected from the group consisting of Carotene food coloring, Caramel food coloring, sorbitol, inositol, mannitol, GABA, isoleucine, leucine, serine, threonine, valine, and glycerol. In some cases, the non-volatile compounds can include Carotene food coloring, Caramel food coloring, sorbitol, inositol, mannitol, GABA, isoleucine, leucine, serine, threonine, valine, and glycerol. The non-volatile compounds can include one or more compounds selected from the group consisting of mannose, cysteine, and glycine, and/or one or more compounds selected from the group consisting of a surfactant, gum arabic, and pectin.

The non-volatile compounds can have less than 80%, less than 70%, less than 60%, less than 50%, or less than 40% identity to the non-volatile compounds in a single reference Moscato. The Moscato-like alcoholic beverage can include at least 17 non-volatile compounds, where no more than 16 of the non-volatile compounds are present in a single reference Moscato. The Moscato-like alcoholic beverage can include at least 21 non-volatile compounds, where no more than 20 of the non-volatile compounds are present in a single reference Moscato. The Moscato-like alcoholic beverage can include at least 25 non-volatile compounds, where no more than 24 of the non-volatile compounds are present in a single reference Moscato.

The additional VOCs in a Moscato-like alcoholic beverage can have less than 90% identity to the VOCs in a single reference Moscato, less than 80% identity to the VOCs in a single reference Moscato, less than 70% identity to the VOCs in a single reference Moscato, less than 60% identity to the VOCs in a single reference Moscato, less than 50% identity to the VOCs in a single reference Moscato, or less than 40% identity to the VOCs in a single reference Moscato.

The Moscato-like alcoholic beverage can include at least 54 additional VOCs, where no more than 53 of the additional VOCs are found in a single reference Moscato. The Moscato-like alcoholic beverage can include at least 55 additional VOCs, where no more than 54 of the additional VOCs are found in a single reference Moscato. The Moscato-like alcoholic beverage can include at least 56 additional VOCs, where no more than 55 of the additional VOCs are found in a single reference Moscato.

The Moscato-like alcoholic beverage can lack one or more of Escherichia coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, mold, mildew, rot, insects, insect eggs, insect filth, rodent filth, mammalian excreta, insect lecithins, hydrogen sulfide, hydrogen disulfide, 2,4,6-trichloranisole, 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, and dichloromethane.

In another aspect, this document features a method for making a Moscato-like alcoholic beverage, where the method includes combining ingredients that include water, one or more acids, one or more sugars, a pH-modifying salt, one or more nucleotide monophosphates, one or more amino acids, ethanol, and ten or more additional VOCs selected from the group consisting of (−)-beta-pinene, (−)-cis-rose oxide, 1-decanol, 1-octanol, 1-octen-3-ol, 2,3-pentadione, 2-acetylpyridine, 2-heptanone, 2-isopropyl-3-methoxypyrazine, 2-methoxy-4-methylphenol, 2-methyl-1-butanol, 2-methylbutyl acetate, 2-methylbutyraldehyde, 2-nonanone, 2-phenethylacetate, 2-phenylethanol, 2-undecanone, 3-(methylthio)-1-propanol, 3,7-dimethyl-6-octenoic acid, 3-carene, 3-mercaptohexylacetate, 3-methyl-1-pentanol, 3-nonen-2-one, 4-carvomenthenol, 4-ethylguaiacol, 4-ethylphenol, acetaldehyde, acetovanillone, alpha-ionone, Amyl alcohol, amyl butyrate, alpha-phellandrene, alpha-terpineol, benzaldehyde, benzyl alcohol, butanol, butyl acetate, butyl formate, butyl isovalerate, butyric acid, cinnamaldehyde, cis-3-hexenyl acetate, citronellol, damascenone, decanoic acid, delta-decalactone, diethyl succinate, dimethyl sulfide, ethyl acetate, ethyl anthranilate, ethyl butanoate, ethyl butyrate, ethyl decanoate, ethyl hexanoate, ethyl isobutyrate, ethyl isovalerate, ethyl lactate, ethyl laurate, ethyl myristate, ethyl nonanoate, ethyl octanoate, ethyl palmitate, ethyl phenyl acetate, ethyl propionate, ethyl undecanoate, ethyl valerate, ethyl-2-methylbutyrate, ethyl-3-hydroxybutyrate, eucalyptol, eugenol, furfural, furfuryl mercaptan, gamma-decalactone, gamma-nonalactone, gamma-octalactone, gamma-terpinene, geraniol, guaiacol, heptyl acetate, hexanoic acid, Hexanol, hexyl acetate, hexyl hexanoate, isoamyl acetate, isoamyl alcohol, isoamyl octanoate, isoborneol, isobutanol, isobutyric acid, isovaleraldehyde, isovaleric acid, Jasmine lactone, limonene, linalool, linalool oxide, linalyl acetate, linalyl butyrate, maltol, methional, methyl anthranilate, methyl decanoate, methyl hexanoate, methyl laurate, methyl octanoate, methyl salicylate, methyl vanillate, myrcene, myrtenol, nerol, octanoic acid, octyl acetate, p-anisaldehyde, p-cymene, phenethyl butyrate, phenethyl octanoate, phenethyl propionate, propanol, propyl hexanoate, trans-2-heptenal, trans-2-hexen-1-al, trans-2-hexen-1-ol, trans-2-pentenal, and cis-whiskey lactone.

The one or more acids can include tartaric acid and malic acid. The one or more acids can further include a compound selected from the group consisting of citric acid, succinic acid, lactic acid, acetic acid, and combinations thereof. The one or more sugars can include glycerol, glucose, and fructose. The one or more sugars can further include a compound selected from the group consisting of sorbitol, inositol, mannose, mannitol, and combinations thereof. The pH-modifying salt can include potassium hydroxide. The one or more nucleotide monophosphates can include guanosine monophosphate and inosine monophosphate. The one or more amino acids can include alanine, arginine, aspartic acid, asparagine, b-alanine, glutamic acid, glutamine, histidine, lysine, methionine, monosodium glutamate, phenylalanine, proline, tryptophan, tyrosine, and valine. The one or more amino acids can further include a compound selected from the group consisting of gamma-aminobutyric acid (GABA), glycine, isoleucine, leucine, serine, threonine, and combinations thereof. The ingredients can further include a coloring agent (e.g., a coloring agent selected from the group consisting of carotene, caramel, a natural colorant derived from a fruit or vegetable, a synthetic dye, and combinations thereof), a surfactant, and/or a compound selected from the group consisting of gum arabic, pectin, and combinations thereof.

In another aspect, this document features a Moscato-like alcoholic beverage containing ethanol, water, and one or more non-volatile compounds, where the one or more non-volatile compounds include one or more of glutamine, mannose, inositol, acetic acid, glycerol, disodium 5′ ribonucleotides, monosodium glutamate, a pH-modifying salt, food coloring Carotene, food coloring Caramel, a natural colorant derived from a fruit or vegetable, a synthetic dye, gum arabic, pectin, and a surfactant. In some cases, the one or more non-volatile compounds do not include one or more of betaine, pyridoxine, choline, carnitine, ornithine, trans 4-hydroxy-L-proline, adenine, guanine, kynurenic acid, quinic acid, pantothenic acid, caffeic acid, polydatin, coumaric acid, pyruvic acid, D-glucuronic acid, fumaric acid, gallic acid, 2-furoic acid, 3,4-dihydroxybenzoic acid, 2-isopropylmalic acid, catechin, epicatechin, ellagic acid, salicylic acid, ribose, arabitol, and glucosamine. This document also features a Moscato-like alcoholic beverage containing ethanol, water, and one or more non-volatile compounds, where the one or more non-volatile compounds do not include one or more of betaine, pyridoxine, choline, carnitine, ornithine, trans 4-hydroxy-L-proline, adenine, guanine, kynurenic acid, quinic acid, pantothenic acid, caffeic acid, polydatin, coumaric acid, pyruvic acid, D-glucuronic acid, fumaric acid, gallic acid, 2-furoic acid, 3,4-dihydroxybenzoic acid, 2-isopropylmalic acid, catechin, epicatechin, ellagic acid, salicylic acid, ribose, arabitol, and glucosamine.

The non-volatile compounds can include one or more of the following: leucine in an amount less than about 5 mg/L, methionine in an amount less than about 1.5 mg/L, lysine in an amount of at least about 8.5 mg/L, tryptophan in an amount less than about 2.2 mg/L, valine in an amount of at least about 0.8 mg/L, asparagine in an amount less than about 0.8 mg/L, glutamic acid in an amount of at least about 20 mg/L, arginine in an amount of at least about 8.8 mg/L, tartaric acid in an amount less than about 1800 mg/L, malic acid in an amount less than about 1000 mg/L, lactic acid in an amount less than about 50 mg/L, lactic acid in an amount of at least about 220 mg/L, citric acid in an amount less than about 190 mg/L, succinic acid in an amount less than about 260 mg/L, succinic acid in an amount of at least about 1100 mg/L, fructose in an amount less than about 60000 mg/L, glucose in an amount less than about 50000 mg/L, sorbitol in an amount of at least about 65 mg/L, mannitol in an amount less than about 75 mg/L, or mannitol in an amount of at least about 350 mg/L.

The non-volatile compounds can include at least 10, at least 15, or at least 20 compounds selected from the group consisting of acetic acid, a pH-modifying salt, tartaric acid, malic acid, citric acid, succinic acid, lactic acid, glucose, fructose, disodium 5′ ribonucleotides, monosodium glutamate, alanine, arginine, aspartic acid, asparagine, b-alanine, glutamic acid, glutamine, histidine, lysine, methionine, phenylalanine, proline, tryptophan, and tyrosine. In some cases, the non-volatile compounds can include acetic acid, a pH-modifying salt, tartaric acid, malic acid, citric acid, succinic acid, lactic acid, glucose, fructose, disodium 5′ ribonucleotides, monosodium glutamate, alanine, arginine, aspartic acid, asparagine, b-alanine, glutamic acid, glutamine, histidine, lysine, methionine, phenylalanine, proline, tryptophan, and tyrosine.

The non-volatile compounds can include at least five or at least ten compounds selected from the group consisting of Carotene food coloring, Caramel food coloring, sorbitol, inositol, mannitol, GABA, isoleucine, leucine, serine, threonine, valine, and glycerol. In some cases, the non-volatile compounds can include Carotene food coloring, Caramel food coloring, sorbitol, inositol, mannitol, GABA, isoleucine, leucine, serine, threonine, valine, and glycerol.

The non-volatile compounds can include one or more compounds selected from the group consisting of mannose, cysteine, and glycine, and/or one or more compounds selected from the group consisting of a surfactant, gum arabic, and pectin.

The non-volatile compounds have less than 80%, less than 70%, less than 60%, less than 50%, or less than 40% identity to the non-volatile compounds in a single reference Moscato. The Moscato-like alcoholic beverage can include at least 17 non-volatile compounds, where no more than 16 of the non-volatile compounds are present in an single reference Moscato. The Moscato-like alcoholic beverage can include at least 21 non-volatile compounds, where no more than 20 of the non-volatile compounds are present in an single reference Moscato. The Moscato-like alcoholic beverage can include at least 25 non-volatile compounds, where no more than 24 of the non-volatile compounds are present in an single reference Moscato.

The Moscato-like alcoholic beverage can further include one or more additional VOCs.

The one or more additional VOCs can include one or more, two or more, three or more, four or more, five or more, six or more, or all of butyl formate, ethyl octanoate, ethyl propionate, ethyl-2-methylbutyrate, isoamyl acetate, isoamyl alcohol, and isobutanol. In some cases, the one or more additional VOCs include no more than six, nor more than five, or no more than four of butyl formate, ethyl octanoate, ethyl propionate, ethyl-2-methylbutyrate, isoamyl acetate, isoamyl alcohol, and isobutanol.

In some cases, the one or more additional VOCs do not include at least one compound selected from the group consisting of 1-decanol, 1-octanol, 1-octen-3-ol, 2,3-pentadione, 2-methylbutyraldehyde, 4-ethyl phenol, cinnamaldehyde, cis-3-hexen-1-ol, ethyl levulinate, ethyl phenyl acetate, ethyl propionate, eucalyptol, isobutyl acetate, isovaleraldehyde, methyl acetate, phenethyl acetate, propyl acetate, 1,1-diethoxyethane, 2-heptanone, 2-methoxy-4-propylphenol, 2-methylbutyl isovalerate, 2-nonanol, 2-undecanone, 3-carene, 4-ethyl guaiacol, acetophenone, alpha ionone, amyl butyrate, beta-ionone, butyl acetate, cis-3-hexenyl acetate, cis-whiskey lactone, diethyl malate, ethyl 3-hydroxyhexanoate, ethyl benzoate, ethyl cinnamate, ethyl heptanoate, ethyl myristate, ethyl nonanoate, ethyl salicylate, ethyl trans-2-butenoate, ethyl trans-3-hexenoate, ethyl undecanoate, ethyl(methylthio) acetate, ethyl-2-methylbutyrate, eugenol, farnesol, fufural, gamma-nonalactone, geranyl acetone, guaiacol, heptyl acetate, isoamyl hexanoate, isoamyl isobutyrate, isoamyl octanoate, isobutyl isobutyrate, isobutyraldehyde, linalool oxide, methional, methyl laurate, methyl octanoate, methyl salicylate, myrcene, p-cresol, p-cymene, phenethyl formate, phenethyl octanoate, salicylaldehyde, 2-acetylpyridine, 2-isopropyl-3-methoxypyrazine, 2-methoxy-4-methylphenol, 3-(methylthio)-1-propanol, 3,7 dimethyl-6-octenoic acid, 3-nonene-2-one, acetaldehyde, alpha-phellandrene, butyl formate, butyl isovalerate, dimethyl sulfide, ethyl palmitate, ethyl-3-hydroxybutyrate, gamma-octalactone, hexyl hexanoate, isoborneol, isovaleric acid, Jasmine lactone, maltol, myrtenol, octyl acetate, propyl hexanoate, trans-2-pentenal, trans-2-hexen-1-al, and trans-2-hexen-1-ol.

The one or more additional VOCs can include one or more of the following: 2-nonanone in an amount of at least about 0.0013 mg/L, 2-phenylethanol in an amount less than about 13 mg/L, 2-phenyethylacetate in an amount of at least about 0.08 mg/L, 3-methyl-1-pentanol in an amount less than about 0.025 mg/L, 4-carvomenthenol in an amount of at least about 0.006 mg/L, benzaldehyde in an amount of at least about 0.004 mg/L, butyric acid in an amount less than about 0.035 mg/L, citronellol in an amount of at least about 0.01 mg/L, damascenone in an amount less than about 0.2 mg/L, decanoic acid in an amount of at least about 0.6 mg/L, delta-decalactone in an amount of at least about 0.007 mg/L, diethyl succinate in an amount less than about 0.4 mg/L, ethyl acetate in an amount less than about 12 mg/L, ethyl butyrate in an amount of at least about 0.25 mg/L, ethyl isobutyrate in an amount of at least about 0.3 mg/L, ethyl isovalerate in an amount of at least about 0.05 mg/L, ethyl lactate in an amount less than about 2 mg/L, ethyl octanoate in an amount less than about 2.5 mg/L, ethyl valerate in an amount of at least about 0.0012 mg/L, gamma-decalactone in an amount of at least about 0.012 mg/L, gamma-terpinene in an amount of at least about 0.0017 mg/L, geraniol in an amount of at least about 0.011 mg/L, hexyl acetate in an amount of at least about 0.04 mg/L, isoamyl acetate in an amount of at least about 1.7 mg/L, isobutyric acid in an amount less than about 1.6 mg/L, limonene in an amount of at least about 0.005 mg/L, linalool in an amount of at least about 0.5 mg/L, linalyl acetate in an amount of at least about 0.01 mg/L, linalyl butyrate in an amount of at least about 0.0002 mg/L, methyl decanoate in an amount of at least about 0.0008 mg/L, nerol in an amount of at least about 0.006 mg/L, phenethyl butyrate in an amount of at least about 0.0017 mg/L, phenethyl propionate in an amount of at least about 0.0002 mg/L, and/or propanol in an amount less than about 1.3 mg/L.

In some cases, at least about 0.008% by mass of the one or more additional VOCs comprises (−)-beta-pinene, at least about 0.01% by mass of the one or more additional VOCs comprises 2-methylbutyl acetate. at least about 0.0009% by mass of the one or more additional VOCs comprises (−)-cis-rose oxide, at least about 0.0009% by mass of the one or more additional VOCs comprises 2-nonanone, at least about 0.05% by mass of the one or more additional VOCs comprises 2-phenethylacetate, at least about 0.004% by mass of the one or more additional VOCs comprises 4-carvomenthenol, at least about 0.003% by mass of the one or more additional VOCs comprises benzaldehyde, at least about 0.007% by mass of the one or more additional VOCs comprises citronellol, at least about 0.4% by mass of the one or more additional VOCs comprises decanoic acid, at least about 0.005% by mass of the one or more additional VOCs comprises delta-decalactone, at least about 0.16% by mass of the one or more additional VOCs comprises ethyl butyrate, at least about 0.2% by mass of the one or more additional VOCs comprises ethyl isobutyrate, at least about 0.03% by mass of the one or more additional VOCs comprises ethyl isovalerate, at least about 0.001% by mass of the one or more additional VOCs comprises ethyl valerate, at least about 0.008% by mass of the one or more additional VOCs comprises gamma-decalactone, at least about 0.0015% by mass of the one or more additional VOCs comprises gamma terpinene, at least about 0.008% by mass of the one or more additional VOCs comprises geraniol, at least about 0.03% by mass of the one or more additional VOCs comprises hexyl acetate, at least about 1.2% by mass of the one or more additional VOCs comprises isoamyl acetate, at least about 0.004% by mass of the one or more additional VOCs comprises limonene, at least about 0.4% by mass of the one or more additional VOCs comprises linalool, at least about 0.007% by mass of the one or more additional VOCs comprises linalyl acetate, at least about 0.0002% by mass of the one or more additional VOCs comprises linalyl butyrate, at least about 0.0007% by mass of the one or more additional VOCs comprises methyl decanoate, at least about 0.004% by mass of the one or more additional VOCs comprises nerol, at least about 0.002% by mass of the one or more additional VOCs comprises phenethyl butyrate, and/or at least about 0.00016% by mass of the one or more additional VOCs comprises phenethyl propionate.

The one or more additional VOCs can include an ester; an acid; an alcohol; an aldehyde, a ketone, or an aldehyde and a ketone; a terpene, an isoprenoid, or a terpene and an isoprenoid; a phenol; a lactone; and an amine, a pyrazine, or an amine and a pyrazine.

The one or more additional VOCs can include one or more esters. The one or more esters can be selected from the group consisting of 2-methylbutyl acetate, 2-phenethylacetate, amyl butyrate, butyl acetate, butyl formate, butyl isovalerate, cis-3-hexenyl acetate, diethyl succinate, ethyl acetate, ethyl anthranilate, ethyl butanoate, ethyl butyrate, ethyl decanoate, ethyl hexanoate, ethyl isobutyrate, ethyl isovalerate, ethyl lactate, ethyl laurate, ethyl myristate, ethyl nonanoate, ethyl octanoate, ethyl palmitate, ethyl phenyl acetate, ethyl propionate, ethyl undecanoate, ethyl valerate, ethyl-2-methylbutyrate, ethyl-3-hydroxybutyrate, heptyl acetate, hexyl acetate, hexyl hexanoate, isoamyl acetate, isoamyl octanoate, linalyl acetate, linalyl butyrate, methyl decanoate, methyl hexanoate, methyl laurate, methyl octanoate, methyl salicylate, methyl vanillate, octyl acetate, phenethyl butyrate, phenethyl octanoate, phenethyl propionate, and propyl hexanoate. The one or more additional VOCs can include one or more acids. The one or more acids can be selected from the group consisting of 3,7-dimethyl-6-octenoic acid, butyric acid, decanoic acid, hexanoic acid, isobutyric acid, isovaleric acid, and octanoic acid. The one or more additional VOCs can include one or more alcohols. The one or more alcohols can be selected from the group consisting of 1-decanol, 1-octanol, 1-octen-3-ol, 2-methyl-1-butanol, 2-phenylethanol, 3-methyl-1-pentanol, Amyl alcohol, benzyl alcohol, butanol, Hexanol, isoamyl alcohol, isobutanol, propanol, and trans-2-hexen-1-ol. The one or more additional VOCs can include one or more aldehydes or ketones. The one or more aldehydes or ketones can be selected from the group consisting of 2-heptanone, 2-methylbutyraldehyde, 2-nonanone, 2-undecanone, 3-nonen-2-one, acetaldehyde, acetovanillone, alpha-ionone, benzaldehyde, cinnamaldehyde, furfural, isovaleraldehyde, maltol, methional, p-anisaldehyde, trans-2-heptenal, trans-2-hexen-1-al, and trans-2-pentenal. The one or more additional VOCs can include one or more terpenes or isoprenoids. The one or more terpenes or isoprenoids can be selected from the group consisting of (−)-beta-pinene, (−)-cis-rose oxide, 3-carene, 4-carvomenthenol, alpha-phellandrene, alpha-terpineol, citronellol, damascenone, eucalyptol, gamma-terpinene, geraniol, isoborneol, limonene, linalool, linalool oxide, myrcene, myrtenol, nerol, and p-cymene. The one or more additional VOCs can include one or more phenols. The one or more phenols can be selected from the group consisting of 2-methoxy-4-methylphenol, 4-ethylguaiacol, 4-ethylphenol, eugenol, and guaiacol. The one or more additional VOCs can include one or more lactones. The one or more lactones can be selected from the group consisting of delta-decalactone, gamma-decalactone, gamma-nonalactone, gamma-octalactone, Jasmine lactone, and cis-whiskey lactone. The one or more additional VOCs can include one or more amines or pyrazines. The one or more amines or pyrazines can be selected from the group consisting of 2-acetylpyridine, 2-isopropyl-3-methoxypyrazine, and methyl anthranilate. The one or more additional VOCs can include one or more thiols. The one or more thiols can be selected from the group consisting of 2,3-pentadione, 3-(methylthio)-1-propanol, 3-mercaptohexylacetate, dimethyl sulfide, and furfuryl mercaptan.

The one or more additional VOCs can further include at least 10, at least 20, at least 30, or at least 40 compounds selected from the group consisting of (−)-beta-pinene, (−)-cis-rose oxide, 2-methyl-1-butanol, 2-methylbutyl acetate, 2-nonanone, 2-phenethyl acetate, 2-phenylethanol, 3-mercaptohexyl acetate, 3-methyl-1-pentanol, 4-carvomenthenol, 4-vinylphenol, acetovanillone, alpha-terpineol, benzaldehyde, benzyl alcohol, butanol, butyric acid, citronellol, damascenone, decanoic acid, delta-decalactone, diethyl succinate, ethyl acetate, ethyl butanoate, ethyl decanoate, ethyl hexanoate, ethyl isobutyrate, ethyl isovalerate, ethyl lactate, ethyl laurate, ethyl octanoate, ethyl valerate, gamma-decalactone, gamma-terpinene, geraniol, hexanoic acid, hexanol, hexyl acetate, isoamyl acetate, isoamyl alcohol, isobutyl alcohol, isobutyric acid, limonene, linalool, linalyl acetate, linalyl butyrate, methyl decanoate, methyl hexanoate, nerol, octanoic acid, phenethyl butyrate, phenethyl propionate, and propanol. In some cases, the one or more additional VOCs can further include (−)-beta-pinene, (−)-cis-rose oxide, 2-methyl-1-butanol, 2-methylbutyl acetate, 2-nonanone, 2-phenethyl acetate, 2-phenylethanol, 3-mercaptohexyl acetate, 3-methyl-1-pentanol, 4-carvomenthenol, 4-vinylphenol, acetovanillone, alpha-terpineol, benzaldehyde, benzyl alcohol, butanol, butyric acid, citronellol, damascenone, decanoic acid, delta-decalactone, diethyl succinate, ethyl acetate, ethyl butanoate, ethyl decanoate, ethyl hexanoate, ethyl isobutyrate, ethyl isovalerate, ethyl lactate, ethyl laurate, ethyl octanoate, ethyl valerate, gamma-decalactone, gamma-terpinene, geraniol, hexanoic acid, hexanol, hexyl acetate, isoamyl acetate, isoamyl alcohol, isobutyl alcohol, isobutyric acid, limonene, linalool, linalyl acetate, linalyl butyrate, methyl decanoate, methyl hexanoate, nerol, octanoic acid, phenethyl butyrate, phenethyl propionate, and propanol.

The additional VOCs can have less than 90%, less than 80%, less than 70%, less than 60%, less than 50%, or less than 40% identity to the VOCs in a single reference Moscato. The Moscato-like alcoholic beverage can include at least 54 additional VOCs. where no more than 53 of the additional VOCs are found in a single reference Moscato. The Moscato-like alcoholic beverage can include at least 55 additional VOCs, where no more than 54 of the additional VOCs are found in a single reference Moscato. The Moscato-like alcoholic beverage can include at least 56 additional VOCs, where no more than 55 of the additional VOCs are found in a single reference Moscato.

The Moscato-like alcoholic beverage can lack one or more of Escherichia coli, Salmonella sp., Brettanomyces sp., Lactobacillales, Saccharomyces sp., Acremonium strictum, Chrysoniha sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, mold, mildew, rot, insects, insect eggs, insect filth, rodent filth, mammalian excreta, insect lecithins, hydrogen sulfide, hydrogen disulfide, 2,4,6-trichloranisole, 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, and dichloromethane.

In still another aspect, this document features a Moscato-like alcoholic beverage that contains ethanol; water; VOCs that include (−)-beta-pinene, (−)-cis-rose oxide, 2-methyl-1-butanol, 2-methylbutyl acetate, 2-nonanone, 2-phenethylacetate, 2-phenylethanol, 3-mercaptohexylacetate, 3-methyl-1-pentanol, 4-carvomenthenol, acetovanillone, alpha-terpineol, benzaldehyde, benzyl alcohol, butanol, butyric acid, citronellol, damascenone, decanoic acid, delta-decalactone, diethyl succinate, ethyl acetate, ethyl butanoate, ethyl decanoate, ethyl hexanoate, ethyl isobutyrate, ethyl isovalerate, ethyl lactate, ethyl laurate, ethyl octanoate, ethyl valerate, gamma-decalactone, gamma-terpinene, geraniol, hexanoic acid, Hexanol, hexyl acetate, isoamyl acetate, isoamyl alcohol, isobutanol, isobutyric acid, limonene, linalool, linalyl acetate, linalyl butyrate, methyl decanoate, methyl hexanoate, nerol, octanoic acid, phenethyl butyrate, phenethyl propionate, and propanol; and non-volatile compounds that include acetic acid, citric acid, lactic acid, malic acid, succinic acid, tartaric acid, fructose, glucose, glycerol, guanosine monophosphate, inosine monophosphate, potassium hydroxide, alanine, arginine, asparagine, aspartic acid, b-alanine, glutamic acid, glutamine, histidine, lysine, methionine, monosodium glutamate, phenylalanine, proline, serine, tryptophan, tyrosine, and valine.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the description below. Other features, objects, and advantages of the invention will be apparent from the description and from the claims.

### DETAILED DESCRIPTION

This document provides Moscato-like alcoholic beverages (also referred to as “Moscato replicas”), as well as methods for making Moscato-like alcoholic beverages by combining water and ethanol with individual VOCs and non-volatile organic compounds. The Moscato-like alcoholic beverages described herein have characteristics—including taste, aroma, mouthfeel, and appearance—of traditionally generated Moscato wines, and are meant to be consumed and enjoyed in the same manner as traditional Moscatos.

As used herein, the terms “traditional” and “reference” Moscato refer to Moscato wines produced through standard winemaking (vinification) processes, which include the fermentation of fruit such as grapes. “Traditionally-produced Moscato” is Moscato wine that was generated using standard vinification processes with Muscat grapes.

Traditional Moscatos are complex mixtures on a chemical level. In some aspects, this document provides Moscato replicas that are less complex than a traditional Moscato. It was surprising that the replicas disclosed herein, do not need to have the complexity of a traditional Moscato in order to be perceived as such. It was also surprising that some compounds, which by themselves have an unpleasant taste and/or smell, can enhance the taste and/or smell of the Moscato replicas disclosed herein. Non-limiting examples of such components include isovaleric acid (which has been associated with foot smell) and butyric acid (which has been associated with the smell of vomit). It was further surprising that the exclusion of some compounds found in all tested traditional Moscatos was not detrimental to the Moscato replicas described herein. Similarly, it was surprising that some compounds that were not found in any tested traditional Moscato could be beneficial to the Moscato replicas described herein. It was also surprising that Moscato replicas described herein containing some compounds in amounts greater than the highest measured amount in any tested traditional Moscato or lower than the lowest measured amount in any tested traditional Moscato were superior to replicas that contained the same compounds in amounts within the measured range of traditional Moscato. Therefore, in another aspect, this document provides Moscato replicas that are not mere replicas of existing products, but instead provide a similar sensory experience with a different chemical composition.

In some embodiments, a Moscato replica can consist of the ingredients included in a particular list, or can have a VOC content (or non-volatile compound content) that consists of the VOCs or non-volatile compounds included in a particular list. Further, a Moscato replica can consist essentially of the ingredients included in a particular list, or can have a VOC content (or non-volatile compound content) that consists essentially of the VOCs or non-volatile compounds that are included in a particular list. By “consisting essentially of” is meant that a Moscato replica contains specified ingredients/VOCs/non-volatile compounds, and can contain additional ingredients/VOCs/non-volatile compounds that do not materially affect the basic and novel characteristics of the Moscato.

Various formulations for Moscato replicas are described herein. In general, the Moscato replicas include the following components, or classes of components:

a) a source of water, either pure or with mineral content present to improve flavor;

b) a source of distilled ethanol with a concentration between about 20% and 100% weight by volume;

c) one or more VOCs; and

d) one or more non-volatile compounds.

Water is the main component of the Moscato replicas, acting as a solvent for all the other ingredients. The ethanol component provides the alcoholic content. The VOCs can provide both aroma and flavor, including fruity, floral, earthy, herbaceous, oak, yeast, spice, and/or mineral aromas and flavors. The non-volatile components can provide acidity and much of the flavor, aftertaste, and mouthfeel perception of the Moscato replicas.

In some embodiments, a Moscato-like alcoholic beverage can include water, ethanol, and (a) one or more additional VOCs (i.e., VOCs in addition to ethanol), where the one or more additional VOCs are not present in a corresponding reference Moscato wine; (b) one or more additional VOCs, where the one or more additional VOCs do not include one or more VOCs that are present in a corresponding reference Moscato; (c) one or more non-volatile compounds, where the one or more non-volatile compounds are not present in a corresponding reference Moscato wine; (d) one or more non-volatile compounds, where the one or more non-volatile compounds do not include one or more non-volatile compounds that are present in a corresponding reference Moscato; or (e) any combination of (a), (b), (c), and (d) [(a) and (b); (a) and (c); (a) and (d); (b) and (c); (b) and (d); (c) and (d); (a), (b), and (c); (a), (b), and (d); (a), (c), and (d); (b), (c), and (d); or (a), (b), (c), and (d)].

In general, the Moscato replicas provided herein can have an ethanol content that ranges from about 3% v/v to about 12% v/v (e.g., about 3%, about 4%, about 5%, about 6%, about 7%, about 8%, about 9%, about 10%, about 11%, about 12%, about 3 to 5%, about 4 to 6%, about 4.5 to 6.5%, about 5 to 7%, about 5.5 to 7.5%, about 6 to 8%, about 7 to 9%, about 8 to 10%, about 9 to 11%, about 10 to 12%, about 3 to 6%, about 4 to 7%, about 5 to 8%, about 5.5 to 9%, about 6 to 9%, about 6 to 9.5%, about 6.5 to 10%, about 7 to 10%, about 8 to 11%, or about 9 to 12% v/v).

It is to be noted, however, that the ethanol component can be omitted in order to generate a “non-alcoholic” version of a Moscato replica. In such ethanol-free embodiments, the ethanol can essentially be replaced by water, although it is noted that adjustments to the amounts of the other VOCs and non-volatile components may require adjustment to produce a Moscato replica with the “feel” of traditional Moscato.

The additional VOCs present in a Moscato replica can include compounds that fall into several categories, including esters, acids, higher alcohols, aldehydes/ketones, terpenes/isoprenoids, phenols, lactones, amines/pyrazines, and/or thiols. In some embodiments, for example, a Moscato replica can contain VOCs that include an ester, an acid, an alcohol in addition to the ethanol, an aldehyde, ketone, or both, a terpene, isoprenoid, or both, a phenol, a lactone, and an amine, pyrazine, or both. In some embodiments, for example, a Moscato replica can contain VOCs that include an ester, an acid, an alcohol in addition to the ethanol, an aldehyde, ketone, or both, a terpene, isoprenoid, or both, and a lactone. It will be appreciated that any and all stereoisomers can be used when no stereochemistry is specified.

Esters, including ethyl, methyl, and acetate esters, can contribute to the fruity and floral characteristics of a wine, which may be considered the most elementary flavor and/or aroma class in all wines. Esters that may be used in a Moscato replica include, without limitation, one or more of 2-methylbutyl acetate, 2-methylbutyl isovalerate, 3-heptyl acetate, 3-methylthio hexyl acetate, allyl heptanoate, allyl hexanoate, amyl butyrate, amyl formate, anisyl acetate, anisyl butyrate, benzyl acetate, benzyl benzoate, benzyl butyrate, benzyl formate, benzyl propionate, butyl acetate, butyl butyryllactate, butyl formate, butyl isovalerate, cis-3-hexenyl acetate, cis-3-hexenyl butyrate, cis-3-hexenyl caproate, cis-3-hexenyl valerate, citronellyl acetate, diethyl malate, diethyl succinate, dimethyl anthranilate, dimethyl succinate, ethyl (methylthio) acetate, ethyl 2-methylbutyrate, ethyl 2-trans-4-cis-decadienoate, ethyl 3-hydroxyhexanoate, ethyl acetate, ethyl anthranilate, ethyl benzoate, ethyl butyrate (also called ethyl butanoate), ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenylacetate, ethyl propionate, ethyl salicylate, ethyl trans-2-butenoate, ethyl undecanoate, ethyl valerate, ethyl-2-mercaptopropionate, ethyl-3-hydroxybutyrate, ethyl-trans-3-hexenoate, geranyl acetate, geranyl butyrate, geranyl propionate, heptyl acetate, hexyl 3-methylbutanoate, hexyl acetate, hexyl butyrate, hexyl formate, hexyl hexanoate, hexyl isobutyrate, hexyl propionate, isoamyl acetate, isoamyl cinnamate, isoamyl hexanoate, isoamyl isobutyrate, isoamyl isovalerate, isoamyl octanoate, isoamyl phenylacetate, isobutyl acetate, isobutyl butyrate, isobutyl isobutyrate, isobutyl propionate, linalyl acetate, linalyl butyrate, linalyl formate, methionyl acetate (also called 3-methylthio-propylacetate), methionyl butyrate, methyl acetate, methyl anthranilate, methyl benzoate, methyl cinnamate, methyl decanoate, methyl dihydrojasmonate, methyl hexanoate, methyl laurate, methyl octanoate, methyl salicylate, methyl vanillate, neryl acetate, octyl acetate, phenethyl 2-methylbutyrate, phenethyl acetate (also called 2-phenylethylacetate), phenethyl butyrate, phenethyl formate, phenethyl formate, phenethyl isobutyrate, phenethyl octanoate, phenethyl propionate, phenethyl tiglate, propyl acetate, propyl butyrate, propyl hexanoate, propyl isovalerate, and any combination thereof. In some embodiments, esters can be selected from the group consisting of 2-methylbutyl acetate, diethyl malate, diethyl succinate, ethyl 2-methylbutyrate, ethyl acetate, ethyl butyrate, ethyl decanoate, ethyl hexanoate, ethyl isobutyrate, ethyl isovalerate, ethyl lactate, ethyl laurate, ethyl myristate, ethyl octanoate, ethyl salicylate, ethyl valerate, hexyl acetate, isoamyl acetate, linalyl acetate, linalyl butyrate, methyl decanoate, methyl hexanoate, phenethyl acetate, phenethyl butyrate, phenethyl propionate, and mixtures thereof. In some embodiments, esters can be selected from the group consisting of diethyl malate, diethyl succinate, ethyl 2-methylbutyrate, ethyl butyrate, ethyl decanoate, ethyl isobutyrate, ethyl lactate, ethyl laurate, ethyl myristate, ethyl octanoate, ethyl salicylate, hexyl acetate, isoamyl acetate, linalyl acetate, phenethyl acetate, phenethyl butyrate, phenethyl propionate, and mixtures thereof. The ester(s) can make up any suitable proportion of the overall additional VOC content. Any suitable number of esters can be used, for example, 1 to 35 esters, 1 to 30 esters, 1 to 25 esters, 1 to 20 esters, 1 to 10 esters, 1 to 5 esters, 5 to 35 esters, 5 to 30 esters, 5 to 25 esters, 5 to 20 esters, 5 to 15 esters, 5 to 10 esters, 10 to 35 esters, 10 to 30 esters, 10 to 25 esters, 10 to 20 esters, 10 to 15 esters, 15 to 35 esters, 15 to 30 esters, 15 to 25 esters, 15 to 20 esters, 20 to 35 esters, 20 to 30 esters, 20 to 25 esters, 25 to 35 esters, 25 to 30 esters, or 30 to 35 esters can be used. In some embodiments, esters can be present in a total amount of about 9 mg/L to about 70 mg/L (e.g., about 9 to about 20 mg/L, about 10 to about 20 mg/L, about 10 to about 50 mg/L, about 9 to about 50 mg/L, about 20 to about 60 mg/L, about 30 to about 70 mg/L, about 10 to about 30 mg/L, about 30 to about 50 mg/L, or about 50 to about 70 mg/L). In some embodiments, esters can be present in a total amount of at least about 26 mg/L (e.g., at least 27 mg/L, 28 mg/L, 29 mg/L, 30 mg/L, 35 mg/L, 40 mg/L, 45 mg/L, 50 mg/L, 55 mg/L, 60 mg/L, or 65 mg/L). In some embodiments, for example, about 15% to about 55% by mass (e.g., about 15% to about 25%, about 20% to about 30%, about 25% to about 35%, about 30% to about 40%, about 35% to about 45%, about 40% to about 50%, or about 45% to about 55% by mass) of the VOCs can comprise one or more esters.

Acids may contribute to “sour” or “fermented” aromas and/or flavors, which can be important to the general character of wine. Acids that may be included in a Moscato wine replica include, without limitation, 3,7-dimethyl-6-octanoic acid, 3,7-dimethyl-6-octenoic acid, butyric acid, decanoic acid, hexanoic acid, isobutyric acid, isovaleric acid, octanoic acid, propanoic acid, and any combination thereof. In some cases, the acid(s) can be selected from the group consisting of 3,7-dimethyl-6-octenoic acid, butyric acid, decanoic acid, hexanoic acid, isobutyric acid, isovaleric acid, and octanoic acid. In some embodiments, acids can be selected from the group consisting of butyric acid, decanoic acid, hexanoic acid, isobutyric acid, octanoic acid, and mixtures thereof. In some embodiments, acids can be selected from the group consisting of butyric acid, decanoic acid, hexanoic acid, isobutyric acid, and mixtures thereof. The acid(s) can make up any suitable proportion of the overall additional VOC content. Any suitable number of acids can be used, for example, 1 to 5 acids, 2 to 5 acids, 3 to 5 acids, or 4 to 5 acids can be used. In some embodiments, acids can be present in a total amount of about 0.07 mg/L to about 11 mg/L (e.g., about 0.07 to about 0.1 mg/L, about 0.1 to about 0.5 mg/L, about 0.5 to about 1 mg/L, about 1 to about 5 mg/L, about 1 to about 10 mg/L, about 1 to about 11 mg/L, about 5 to about 10 mg/L, about 5 to about 11 mg/L, about 1 to about 3 mg/L, about 3 to about 5 mg/L, about 5 to about 7 mg/L, about 7 to about 9 mg/L, or about 9 to about 11 mg/L). In some embodiments, for example, about 2% to about 8% by mass (e.g., about 2% to about 4%, about 4% to about 6%, or about 6% to about 8% by mass) of the VOCs can comprise one or more acids.

Higher alcohols can provide various flavor and/or aroma components to wine, including banana, spice, grassiness, and oxidized characteristics. Higher alcohols also can be important for adding roundness to the general aroma of wine, as well as some weight on the palate. Higher alcohols that can be present in the Moscato replicas provided herein include, without limitation, 1-octanol, 1-octen-3-ol, 1-propanol, 2-(methylthio)ethanol, 2-heptanol, 2-methyl-1-butanol, 2-nonanol, 3-(methylthio)-1-propanol, 3-methyl-1-pentanol, amyl alcohol, anisyl alcohol, benzyl alcohol, butyl alcohol, cis-2-hexenol, cis-3-hexen-1-ol, cis-5-octen-1-ol, cis-6-nonen-1-ol, decanol, DL-3-methyl-2-butanol, hexadecanol, hexyl alcohol (also called hexanol), isoamyl alcohol, isobutyl alcohol, phenethyl alcohol (also called 2-phenylethanol), trans-2-hexen-1-ol, and any combination thereof. In some embodiments, alcohols can be selected from the group consisting of 1-propanol, 2-methyl-1-butanol, 2-nonanol, 3-methyl-1-pentanol, benzyl alcohol, butyl alcohol, hexyl alcohol, isoamyl alcohol, isobutyl alcohol, phenethyl alcohol, and mixtures thereof. In some embodiments, alcohols can be selected from the group consisting of 2-methyl-1-butanol, 2-nonanol, 3-methyl-1-pentanol, butyl alcohol, hexyl alcohol, isoamyl alcohol, isobutyl alcohol, phenethyl alcohol, and mixtures thereof. The alcohol(s) can make up any suitable proportion of the overall additional VOC content. Any suitable number of alcohols can be used, for example 1 to 15 alcohols, 1 to 10 alcohols, 1 to 8 alcohols, 1 to 5 alcohols, 5 to 8 alcohols, 5 to 10 alcohols, 5 to 15 alcohols, 8 to 10 alcohols, 8 to 15 alcohols, or 10 to 15 alcohols can be used. In some embodiments, alcohols can be present in a total amount of about 1.9 to about 86 mg/L (e.g., about 1.9 to about 5 mg/L, about 5 to about 10 mg/L, about 10 to about 30 mg/L, about 30 to about 50 mg/L, about 50 to about 70 mg/L, about 70 to about 86 mg/L, about 20 to about 40 mg/L, about 40 to about 60 mg/L, about 60 to about 80 mg/L, or about 60 to about 86 mg/L). In some embodiments, alcohols can be present in a total amount of at least about 5.5 mg/L (e.g., at least 7 mg/L, 8 mg/L, 9 mg/L, 10 mg/L, 15 mg/L, 20 mg/L, 25 mg/L, 30 mg/L, 40 mg/L, 50 mg/L, 60 mg/L, 70 mg/L, or 80 mg/L). In some cases, for example, about 30% to about 95% by mass (e.g., about 35% to about 95%, 30% to about 50%, about 50% to about 70%, about 70% to about 90%, about 70% to about 95%, about 40% to about 60%, about 60% to about 80%, about 30% to about 60%, about 40% to about 70%, about 50% to about 80%, about 60% to about 90%, or about 60% to about 95% by mass) of the additional VOCs can comprise one or more alcohols.

Aldehydes and ketones can provide flavors and/or aromas that are important to the general character of wine. For example, acetaldehyde is a by-product of alcoholic fermentation that gives a vinous and oxidized aroma, diacetyl is a by-product of malolactic fermentation that provides a buttery flavor, and sotolon can provide a maple-like scent that is indicative in oxidized wines. Non-limiting examples of aldehydes/ketones that may be used in the Moscato replicas provided herein include 2,3-hexanedione, 2,3-pentadione, 2,6-dimethyl-5-heptenal, 2-acetyl-1-methylpyrrole, 2-heptanone, 2-methoxycinnamaldehyde, 2-methylbutyraldehyde, 2-nonanone, 2-octanone, 2-undecanone, 3-nonen-2-one, 3-phenylpropanal, 4-(4-hydroxyphenyl)-2-butanone, 4-hydroxy-2,5-dimethyl-3(2H)-furanone, 5-ethyl-3-hydroxy-4-methyl-2(5H)-furanone (also called maple furanone), 5-methyl furfural, 5-methyl-2-phenyl-2-hexenal, 6-methyl-5-hepten-2-one, acetaldehyde, acetoin, acetophenone, acetovanillone, benzaldehyde, butyraldehyde, cinnamaldehyde, cuminaldehyde, damascenone, decanal, diacetyl, furfural, hexanal, isobutyraldehyde, isovaleraldehyde, maltol, methional, methyl cyclopentenolone, methyl β-naphthyl ketone, methyl-2-pyrrolyl ketone, nonanal, octanal, p-anisaldehyde, phenylacetaldehyde, phenylacetaldehyde dimethyl acetal, propanal, salicylaldehyde, sotolon, trans-2-heptenal, trans-2-Hexen-1-al, trans-2-pentenal, valeraldehyde, and any combination thereof. In some embodiments, aldehydes or ketones can be selected from the group consisting of 2-nonanone, 2-undecanone, acetovanillone, benzaldehyde, damascenone, isobutyraldehyde, and mixtures thereof. In some embodiments, aldehydes or ketones can be selected from the group consisting of 2-nonanone, 2-undecanone, benzaldehyde, isobutyraldehyde, and mixtures thereof. The aldehyde(s)/ketone(s) can make up any suitable proportion of the overall additional VOC content. Any suitable number of aldehydes or ketones can be used, for example, 1 to 20 aldehydes or ketones, 1 to 15 aldehydes or ketones, 1 to 10 aldehydes or ketones, 1 to 8 aldehydes or ketones, 1 to 5 aldehydes or ketones, 1 to 4 aldehydes or ketones, 5 to 20 aldehydes or ketones, 5 to 15 aldehydes or ketones, 5 to 10 aldehydes or ketones, 5 to 8 aldehydes or ketones, 10 to 20 aldehydes or ketones, 10 to 15 aldehydes or ketones, or 15 to 20 aldehydes or ketones can be used. In some embodiments, aldehydes or ketones can be present in a total amount of about 0.05 mg/L to about 0.6 mg/L (e.g., about 0.05 to about 0.1 mg/L, about 0.1 to about 0.5 mg/L, or about 0.1 to about 0.6 mg/L). In some embodiments, for example, about 0.04% to about 0.6% by mass (e.g., about 0.04% to about 0.1%, about 0.05% to about 0.1%, about 0.1% to about 0.5%, about 0.1% to about 0.6%, about 0.1% to about 0.2%, about 0.2% to about 0.4%, about 0.3% to about 0.5%, or about 0.4% to about 0.6% by mass) by mass of the additional VOCs can comprise one or more aldehydes and/or ketones.

Terpenes and isoprenoids can contribute floral and green characteristics to wine that may or may not be specific to a certain grape variety. For example, linalool can be important in aromatic grapes such as Muscat (from which traditional Moscato wine is produced), while limonene can contribute citrus flavors. Terpenes and isoprenoids that can be included in the Moscato replicas provided herein include, without limitation, (1R)-(−)-myrtenal, 1,4-cineole, 3-carene, 4,5,6,7-tetrahydro-3,6-dimethylbenzofuran, 4-carvomenthenol, 4-ethyl guaiacol, 6,10-dimethyl-5,9-undecadien-2-one (geranyl acetone), a-ionone, a-phellandrene, a-pinene, a-terpineol, b-caryophellene, beta-ionone, beta-pinene, carvacrol, citral, citronellol, damascone, D-camphor, D-carvone, d-fenchone, eucalyptol, farnesol, gamma-terpinene, geraniol, isoborneol, L-carvone, linalool oxide, 1-limonene, 1-linalool, L-menthyl acetate, L-rose oxide, myrcene, myrtenol, nerol, nerolidol, p,a-dimethyl styrene, p-cymene, perillaldehyde, terpinolene, tetrahydrolinalool, thymol, valencene, and any combination thereof. In some embodiments, terpenes or isoprenoids can be selected from the group consisting of 4-carvomenthenol, a-terpineol, beta-pinene, citronellol, eucalyptol, gamma-terpinene, geraniol, l-limonene, l-linalool, L-rose oxide, nerol, p-cymene, and mixtures thereof. In some embodiments, terpenes or isoprenoids can be selected from the group consisting of 4-carvomenthenol, a-terpineol, beta-pinene, citronellol, eucalyptol, gamma-terpinene, geraniol, l-limonene, L-rose oxide, nerol, p-cymene, and mixtures thereof. The terpene(s)/isoprenoid(s) can make up any suitable proportion of the overall additional VOC content. Any suitable number of terpenes or isoprenoids can be used, for example, about 1 to 15 terpenes or isoprenoids, about 1 to 10 terpenes or isoprenoids, about 1 to 5 terpenes or isoprenoids, about 5 to about 15 terpenes or isoprenoids, about 5 to about 10 terpenes or isoprenoids, or about 10 to about 15 terpenes or isoprenoids can be used. In some embodiments, terpenes or isoprenoids can be present in a total amount of about 0.08 mg/L to about 5 mg/L (e.g., about 0.08 to about 0.1 mg/L, about 0.08 to about 0.5 mg/L, about 0.5 to about 1 mg/L, about 1 to about 5 mg/L, about 1 to about 3 mg/L, about 3 to about 5 mg/L, or about 2 to about 4 mg/L). In some embodiments, for example, about 1% to about 3.5% by mass (e.g., about 1% to about 2%, about 1% to about 3%, about 2% to about 3%, about 1.5% to about 2.5%, about 1.5% to about 2.5%, or about 2.5% to about 3.5% by mass) of the additional VOCs can comprise one or more terpenes/isoprenoids.

Phenols can contribute to the smoky characteristics that may be found in wine as a result of oak exposure, and they also can contribute earthy characteristics. Examples of phenols that can be used in the Moscato replicas described herein include, without limitation, 2,4,6-trimethylphenol (also called mesitol), 2-methoxy-4-methylphenol (also called creosol), 2-methoxy-4-propylphenol, 4-ethyl phenol, 4-vinylphenol, eugenol, guaiacol, isoeugenol, p-cresol, and any combination thereof. In some cases, the phenol(s) can be selected from the group consisting of 2-methoxy-4-methylphenol, 4-ethylguaiacol, 4-ethylphenol, eugenol, and guaiacol. In some embodiments, the phenols can comprise 4-vinylphenol. The phenol(s) can make up any suitable proportion of the overall additional VOC content. Any suitable number of phenols can be used, for example, 1, 1 to 2, or 1 to 5 phenols can be used. In some embodiments phenols can be present in a total amount of about 0.001 mg/L to about 0.2 mg/L (e.g., about 0.001 to about 0.005 mg/L, about 0.005 to about 0.01 mg/L, about 0.01 to about 0.05 mg/L, about 0.05 mg/L to about 0.1 mg/L, or about 0.1 to about 0.2 mg/L). In some embodiments, for example, about 0.03% to about 0.15% by mass (e.g., about 0.03% to about 0.05%, about 0.05% to about 0.1%, about 0.05% to about 0.15%, about 0.03% to about 0.1%, or about 0.10% to about 0.15% by mass) of the VOCs can comprise one or more phenols. In some embodiments, at least about 0.03% by mass (e.g., at least about 0.04%, 0.05%, 0.06%, 0.07%, 0.08%, 0.09%, 0.10%, 0.11%, 0.12%, 0.13%, or 0.014% by mass) of the additional VOCs can comprise the one or more phenols. In some embodiments, the additional VOCs can comprise no phenols.

Lactones are mainly found in wines that have been exposed to oak, which is a common treatment for wines made from non-aromatic grapes such as Chardonnay, although lactones also may be present in other wine varieties. Non-limiting examples of lactones that can be included in the Moscato replicas provided herein include delta-decalactone, delta-dodecalactone, dihydrocoumarin, gamma-decalactone, gamma-dodecalactone, gamma-heptalactone, gamma-hexalactone, gamma-nonalactone, gamma-octalactone, gamma-undecalactone, Jasmine lactone, omega-pentadecalactone, whiskey lactone, and any combination thereof. In some cases, the lactone(s) can be selected from the group consisting of delta-decalactone, gamma-decalactone, gamma-nonalactone, gamma-octalactone, Jasmine lactone, and cis-whiskey lactone. In some embodiments, the lactones can comprise delta-decalactone, gamma-decalactone, or both. In some embodiments, the lactones can comprise delta-decalactone. The lactone(s) can make up any suitable proportion of the overall additional VOC content. Any suitable number of lactones can be used, for example, 1 lactone, 1 to 2 lactones, or 1 to 5 lactones can be used. In some embodiments, lactones can be present in a total concentration of about 0.001 mg/L to about 2.5 mg/L (e.g., about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1.5 mg/L, about 1.5 to about 2.5 mg/L, about 0.5 to about 1 mg/L, or about 1 to about 2 mg/L). In some embodiments, for example, about 0.004% to about 2% by mass (e.g., about 0.004% to about 0.01%, about 0.005% to about 0.01%, about 0.01% to about 0.05%, about 0.05% to about 0.1%, about 0.1% to about 0.5%, about 0.5% to about 1%, about 1% to about 2%, about 0.5% to about 1.5%, about 1.0% to about 1.5%, or about 1.5% to about 2.0% by mass) of the VOCs can comprise one or more lactones. In some embodiments, at least about 0.1% by mass (e.g., at least about 0.11%, 0.12%, 0.13%, 0.14%, 0.15%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, or 1.9% by mass) of the additional VOCs can comprise one or more lactones.

Amines and pyrazines can contribute unique characteristics that may be found in specific grapes. Pyrazines, for example, can contribute to the green bell pepper flavors found in grapes such as Sauvignon Blanc and Cabernet Sauvignon. Examples of amines and pyrazines that can be used in a Moscato replica as provided herein include, without limitation, 2,6-dimethylpyrazine, 2-acetylpyridine, 2-ethyl-3(5 or 6)-dimethylpyrazine, 2-ethyl-3-methylpyrazine, 2-isobutyl-3-methoxypyrazine, 2-isopropyl-3-methoxypyrazine, 2-methoxy-3-(1-methylpropyl) pyrazine, indole, and any combination thereof. In some cases, the amine(s) and pyrazine(s) can be selected from the group consisting of 2-acetylpyridine, 2-isopropyl-3-methoxypyrazine, and methyl anthranilate. The amine(s)/pyrazine(s) can make up any suitable proportion of the overall additional VOC content. Any suitable number of amine(s)/pyrazine(s) can be used, for example, 1, 1 to 2, or 1 to 5 amine(s)/pyrazine(s) can be used. In some embodiments, the additional VOCs can comprise no amines/pyrazines.

Like amines and pyrazines, thiols can contribute to the signature flavors and/or aromas of wines. For example, 3-mercaptohexyl acetate can contribute tropical flavors and/or aromas to Sauvignon Blanc from New Zealand. Examples of thiols that may be included in the Moscato replicas provided herein are, without limitation, 1-para-menthene-8-thiol, 2-isopropyl-4-methyl thiazole, 3-mercaptohexyl acetate, 4-mercapto-4-methyl-2-pentanone, dimethyl sulfide, furfuryl mercaptan, furfuryl thioacetate, and any combination thereof. In some cases, the thiol(s) can be selected from the group consisting of 2,3-pentadione, 3-(methylthio)-1-propanol, 3-mercaptohexylacetate, dimethyl sulfide, and furfuryl mercaptan. In some embodiments, the thiol(s) can comprise 3-mercaptohexyl acetate. The thiol(s) can make up any suitable proportion of the overall VOC content. Any suitable number of thiol(s) can be used, for example, 1, 1 to 2, or 1 to 5 thiols can be used. In some embodiments, the thiol(s) can be present in a total amount of about 0.00007 mg/L to about 0.0008 mg/L (e.g., 0.00007 to about 0.0001 mg/L, about 0.0001 to about 0.0005 mg/L, about 0.0001 to about 0.0008 mg/L, about 0.0002 to about 0.0004 mg/L, about 0.0004 to about 0.0006 mg/L, or about 0.0006 to about 0.0008 mg/L). In some embodiments, for example, about 0.0003% to about 0.0006% (e.g., about 0.0003% to about 0.0005% or about 0.0004% to about 0.0006% by mass) of the additional VOCs can comprise one or more thiols. In some embodiments, the additional VOCs can comprise no thiols.

Ethers can also contribute to the flavors and/or aromas of wines. Examples of ethers that may be included in the Moscato replicas provided herein are, without limitation, furfuryl ether, vanillyl butyl ether, vanillyl ethyl ether, and any combination thereof. The ethers can make up any suitable proportion of the overall additional VOC content. Any suitable number of ethers can be used. In some embodiments, the additional VOCs can comprise no ethers.

Acetals can also contribute to the flavors and/or aromas of wines. Examples of acetals that may be included in the Moscato replicas provided herein are, without limitation 2-isobutyl-4-methyl-1,3-dioxolane; acetal (also called 1,1-diethoxyethane); acetaldehyde, diethyl acetal; phenethylacetaldehyde dimethyl acetal; and any combination thereof. The acetals can make up any suitable proportion of the overall additional VOC content. Any suitable number of acetals can be used. In some embodiments, the additional VOCs can comprise no acetals.

Furans can also contribute to the flavors and/or aromas of wines. A non-limiting example of a furan that may be included in the Moscato replicas provided herein is 2-pentylfuran. The furans can make up any suitable proportion of the overall additional VOC content. Any suitable number of furans can be used. In some embodiments, the additional VOCs can comprise no furans.

In some cases, a Moscato replica can have a total additional VOC content (in mg/L) of about 65 to about 175 mg/L (e.g., about 65 to about 75 mg/L, about 65 to about 100 mg/L, about 75 to about 100 mg/L, about 100 to about 125 mg/L, about 100 to about 150 mg/L, about 125 to about 150 mg/L, about 125 to about 175 mg/L, or about 150 to about 175 mg/L). In some embodiments, a Moscato replica can have a total VOC content of less than about 140 mg/L (e.g., less than about 130 mg/L, 120 mg/L, 110 mg/L, 100 mg/L, 90 mg/L, 80 mg/L, or 70 mg/L).

In some embodiments, a Moscato replica can include one or more (e.g., one, two, three, four, five, six, or all seven) additional VOCs selected from the group consisting of butyl formate, ethyl octanoate, ethyl propionate, ethyl-2-methylbutyrate, isoamyl acetate, isoamyl alcohol, and isobutanol.

For example, in some cases, a Moscato-like alcoholic beverage can include two compounds selected from the group consisting of butyl formate, ethyl octanoate, ethyl propionate, ethyl-2-methylbutyrate, isoamyl acetate, isoamyl alcohol, and isobutanol, where the two compounds are butyl formate and ethyl octanoate; butyl formate and ethyl propionate; butyl formate and ethyl-2-methylbutyrate; butyl formate and isoamyl acetate; butyl formate and isoamyl alcohol; butyl formate and isobutanol; ethyl octanoate and ethyl propionate; ethyl octanoate and ethyl-2-methylbutyrate; ethyl octanoate and isoamyl acetate; ethyl octanoate and isoamyl alcohol; ethyl octanoate and isobutanol; ethyl propionate and ethyl-2-methylbutyrate; ethyl propionate and isoamyl acetate; ethyl propionate and isoamyl alcohol; ethyl propionate and isobutanol; ethyl-2-methylbutyrate and isoamyl acetate; ethyl-2-methylbutyrate and isoamyl alcohol; ethyl-2-methylbutyrate and isobutanol; isoamyl acetate and isoamyl alcohol; isoamyl acetate and isobutanol; or isoamyl alcohol and isobutanol.

In some cases, a Moscato-like alcoholic beverage can include three compounds selected from the group consisting of butyl formate, ethyl octanoate, ethyl propionate, ethyl-2-methylbutyrate, isoamyl acetate, isoamyl alcohol, and isobutanol. The three compounds can be butyl formate, ethyl octanoate, and ethyl propionate; butyl formate, ethyl octanoate, and ethyl-2-methylbutyrate; butyl formate, ethyl octanoate, and isoamyl acetate; butyl formate, ethyl octanoate, and isoamyl alcohol; butyl formate, ethyl octanoate, and isobutanol; butyl formate, ethyl propionate, and ethyl-2-methylbutyrate; butyl formate, ethyl propionate, and isoamyl acetate; butyl formate, ethyl propionate, and isoamyl alcohol; butyl formate, ethyl propionate, and isobutanol; butyl formate, ethyl-2-methylbutyrate, and isoamyl acetate; butyl formate, ethyl-2-methylbutyrate, and isoamyl alcohol; butyl formate, ethyl-2-methylbutyrate, and isobutanol; butyl formate, isoamyl acetate, and isoamyl alcohol; butyl formate, isoamyl acetate, and isobutanol; butyl formate, isoamyl alcohol, and isobutanol; ethyl octanoate, ethyl propionate, and ethyl-2-methylbutyrate; ethyl octanoate, ethyl propionate, and isoamyl acetate; ethyl octanoate, ethyl propionate, and isoamyl alcohol; ethyl octanoate, ethyl propionate, and isobutanol; ethyl octanoate, ethyl-2-methylbutyrate, and isoamyl acetate; ethyl octanoate, ethyl-2-methylbutyrate, and isoamyl alcohol; ethyl octanoate, ethyl-2-methylbutyrate, and isobutanol; ethyl octanoate, isoamyl acetate, and isoamyl alcohol; ethyl octanoate, isoamyl acetate, and isobutanol; ethyl octanoate, isoamyl alcohol, and isobutanol; ethyl propionate, ethyl-2-methylbutyrate, and isoamyl acetate; ethyl propionate, ethyl-2-methylbutyrate, and isoamyl alcohol; ethyl propionate, ethyl-2-methylbutyrate, and isobutanol; ethyl propionate, isoamyl acetate, and isoamyl alcohol; ethyl propionate, isoamyl acetate, and isobutanol; ethyl propionate, isoamyl alcohol, and isobutanol; ethyl-2-methylbutyrate, isoamyl acetate, and isoamyl alcohol; ethyl-2-methylbutyrate, isoamyl acetate, and isobutanol; ethyl-2-methylbutyrate, isoamyl alcohol, and isobutanol; or isoamyl acetate, isoamyl alcohol, and isobutanol.

In some cases, a Moscato-like alcoholic beverage can include four compounds selected from the group consisting of butyl formate, ethyl octanoate, ethyl propionate, ethyl-2-methylbutyrate, isoamyl acetate, isoamyl alcohol, and isobutanol. The four compounds can be butyl formate, ethyl octanoate, ethyl propionate, and ethyl-2-methylbutyrate; butyl formate, ethyl octanoate, ethyl propionate, and isoamyl acetate; butyl formate, ethyl octanoate, ethyl propionate, and isoamyl alcohol; butyl formate, ethyl octanoate, ethyl propionate, and isobutanol; butyl formate, ethyl octanoate, ethyl-2-methylbutyrate, and isoamyl acetate; butyl formate, ethyl octanoate, ethyl-2-methylbutyrate, and isoamyl alcohol; butyl formate, ethyl octanoate, ethyl-2-methylbutyrate, and isobutanol; butyl formate, ethyl octanoate, isoamyl acetate, and isoamyl alcohol; butyl formate, ethyl octanoate, isoamyl acetate, and isobutanol; butyl formate, ethyl octanoate, isoamyl alcohol, and isobutanol; butyl formate, ethyl propionate, ethyl-2-methylbutyrate, and isoamyl acetate; butyl formate, ethyl propionate, ethyl-2-methylbutyrate, and isoamyl alcohol; butyl formate, ethyl propionate, ethyl-2-methylbutyrate, and isobutanol; butyl formate, ethyl propionate, isoamyl acetate, and isoamyl alcohol; butyl formate, ethyl propionate, isoamyl acetate, and isobutanol; butyl formate, ethyl propionate, isoamyl alcohol, and isobutanol; butyl formate, ethyl-2-methylbutyrate, isoamyl acetate, and isoamyl alcohol; butyl formate, ethyl-2-methylbutyrate, isoamyl acetate, and isobutanol; butyl formate, ethyl-2-methylbutyrate, isoamyl alcohol, and isobutanol; butyl formate, isoamyl acetate, isoamyl alcohol, and isobutanol; ethyl octanoate, ethyl propionate, ethyl-2-methylbutyrate, and isoamyl acetate; ethyl octanoate, ethyl propionate, ethyl-2-methylbutyrate, and isoamyl alcohol; ethyl octanoate, ethyl propionate, ethyl-2-methylbutyrate, and isobutanol; ethyl octanoate, ethyl propionate, isoamyl acetate, and isoamyl alcohol; ethyl octanoate, ethyl propionate, isoamyl acetate, and isobutanol; ethyl octanoate, ethyl propionate, isoamyl alcohol, and isobutanol; ethyl octanoate, ethyl-2-methylbutyrate, isoamyl acetate, and isoamyl alcohol; ethyl octanoate, ethyl-2-methylbutyrate, isoamyl acetate, and isobutanol; ethyl octanoate, ethyl-2-methylbutyrate, isoamyl alcohol, and isobutanol; ethyl octanoate, isoamyl acetate, isoamyl alcohol, and isobutanol; ethyl propionate, ethyl-2-methylbutyrate, isoamyl acetate, and isoamyl alcohol; ethyl propionate, ethyl-2-methylbutyrate, isoamyl acetate, and isobutanol; ethyl propionate, ethyl-2-methylbutyrate, isoamyl alcohol, and isobutanol; ethyl propionate, isoamyl acetate, isoamyl alcohol, and isobutanol; or ethyl-2-methylbutyrate, isoamyl acetate, isoamyl alcohol, and isobutanol.

In some cases, a Moscato-like alcoholic beverage can include five compounds selected from the group consisting of butyl formate, ethyl octanoate, ethyl propionate, ethyl-2-methylbutyrate, isoamyl acetate, isoamyl alcohol, and isobutanol. The five compounds can be butyl formate, ethyl octanoate, ethyl propionate, ethyl-2-methylbutyrate, and isoamyl acetate; butyl formate, ethyl octanoate, ethyl propionate, ethyl-2-methylbutyrate, and isoamyl alcohol; butyl formate, ethyl octanoate, ethyl propionate, ethyl-2-methylbutyrate, and isobutanol; butyl formate, ethyl octanoate, ethyl propionate, isoamyl acetate, and isoamyl alcohol; butyl formate, ethyl octanoate, ethyl propionate, isoamyl acetate, and isobutanol; butyl formate, ethyl octanoate, ethyl propionate, isoamyl alcohol, and isobutanol; butyl formate, ethyl octanoate, ethyl-2-methylbutyrate, isoamyl acetate, and isoamyl alcohol; butyl formate, ethyl octanoate, ethyl-2-methylbutyrate, isoamyl acetate, and isobutanol; butyl formate, ethyl octanoate, ethyl-2-methylbutyrate, isoamyl alcohol, and isobutanol; butyl formate, ethyl octanoate, isoamyl acetate, isoamyl alcohol, and isobutanol; butyl formate, ethyl propionate, ethyl-2-methylbutyrate, isoamyl acetate, and isoamyl alcohol; butyl formate, ethyl propionate, ethyl-2-methylbutyrate, isoamyl acetate, and isobutanol; butyl formate, ethyl propionate, ethyl-2-methylbutyrate, isoamyl alcohol, and isobutanol; butyl formate, ethyl propionate, isoamyl acetate, isoamyl alcohol, and isobutanol; butyl formate, ethyl-2-methylbutyrate, isoamyl acetate, isoamyl alcohol, and isobutanol; ethyl octanoate, ethyl propionate, ethyl-2-methylbutyrate, isoamyl acetate, and isoamyl alcohol; ethyl octanoate, ethyl propionate, ethyl-2-methylbutyrate, isoamyl acetate, and isobutanol; ethyl octanoate, ethyl propionate, ethyl-2-methylbutyrate, isoamyl alcohol, and isobutanol; ethyl octanoate, ethyl propionate, isoamyl acetate, isoamyl alcohol, and isobutanol; ethyl octanoate, ethyl-2-methylbutyrate, isoamyl acetate, isoamyl alcohol, and isobutanol; or ethyl propionate, ethyl-2-methylbutyrate, isoamyl acetate, isoamyl alcohol, and isobutanol.

In some cases, a Moscato-like alcoholic beverage can include six compounds selected from the group consisting of butyl formate, ethyl octanoate, ethyl propionate, ethyl-2-methylbutyrate, isoamyl acetate, isoamyl alcohol, and isobutanol. The six compounds can be butyl formate, ethyl octanoate, ethyl propionate, ethyl-2-methylbutyrate, isoamyl acetate, and isoamyl alcohol; butyl formate, ethyl octanoate, ethyl propionate, ethyl-2-methylbutyrate, isoamyl acetate, and isobutanol; butyl formate, ethyl octanoate, ethyl propionate, ethyl-2-methylbutyrate, isoamyl alcohol, and isobutanol; butyl formate, ethyl octanoate, ethyl propionate, isoamyl acetate, isoamyl alcohol, and isobutanol; butyl formate, ethyl octanoate, ethyl-2-methylbutyrate, isoamyl acetate, isoamyl alcohol, and isobutanol; butyl formate, ethyl propionate, ethyl-2-methylbutyrate, isoamyl acetate, isoamyl alcohol, and isobutanol; or ethyl octanoate, ethyl propionate, ethyl-2-methylbutyrate, isoamyl acetate, isoamyl alcohol, and isobutanol.

In some embodiments, a Moscato-like alcoholic beverage as provided herein can include no more than six (e.g., six, five, four, three, two, one, or none), no more than five (e.g., five, four, three, two, one, or none), or no more than four (e.g., four, three, two, one, or none) of the VOCs in the group consisting of butyl formate, ethyl octanoate, ethyl propionate, ethyl-2-methylbutyrate, isoamyl acetate, isoamyl alcohol, and isobutanol.

The Moscato-like alcoholic beverages can, in some embodiments, include at least ten (e.g., at least 20, at least 30, at least 40, or at least 50) or 1 to 50 (e.g., 1 to 10, 1 to 20, 1 to 30, 1 to 40, 10 to 20, 10 to 30, 10 to 40, 10 to 50, 20 to 30, 20 to 40, 20 to 50, 30 to 40, 30 to 50, or 40 to 50) VOCs from the group that includes (−)-beta-pinene, (−)-cis-rose oxide, 2-methyl-1-butanol, 2-methylbutyl acetate, 2-nonanone, 2-phenethyl acetate, 2-phenylethanol, 3-mercaptohexyl acetate, 3-methyl-1-pentanol, 4-carvomenthenol, 4-vinylphenol, acetovanillone, alpha-terpineol, benzaldehyde, benzyl alcohol, butanol, butyric acid, citronellol, damascenone, decanoic acid, delta-decalactone, diethyl succinate, ethyl acetate, ethyl butanoate, ethyl decanoate, ethyl hexanoate, ethyl isobutyrate, ethyl isovalerate, ethyl lactate, ethyl laurate, ethyl octanoate, ethyl valerate, gamma-decalactone, gamma-terpinene, geraniol, hexanoic acid, hexanol, hexyl acetate, isoamyl acetate, isoamyl alcohol, isobutyl alcohol, isobutyric acid, limonene, linalool, linalyl acetate, linalyl butyrate, methyl decanoate, methyl hexanoate, nerol, octanoic acid, phenethyl butyrate, phenethyl propionate, and propanol.

In some cases, the VOCs in a Moscato replica can include (−)-beta-pinene, (−)-cis-rose-oxide, 2-methyl-1-butanol, 2-methylbutyl acetate, 2-nonanone, 2-phenethylacetate, 2-phenylethanol, 3-mercaptohexylacetate, 3-methyl-1-pentanol, 4-carvomenthenol, acetovanillone, alpha-terpineol, benzaldehyde, benzyl alcohol, butanol, butyric acid, citronellol, damascenone, decanoic acid, delta-decalactone, diethyl succinate, ethyl acetate, ethyl butanoate, ethyl decanoate, ethyl hexanoate, ethyl isobutyrate, ethyl isovalerate, ethyl lactate, ethyl laurate, ethyl octanoate, ethyl valerate, gamma-decalactone, gamma-terpinene, geraniol, hexanoic acid, Hexanol, hexyl acetate, isoamyl acetate, isoamyl alcohol, isobutanol, isobutyric acid, limonene, linalool, linalyl acetate, linalyl butyrate, methyl decanoate, methyl hexanoate, nerol, octanoic acid, phenethyl butyrate, phenethyl propionate, and propanol.

In some embodiments, the Moscato replicas provided herein can include one or more (e.g., one, two, three, four, five, or more than five) VOCs that are not present in traditional Moscato. Examples of such VOCs include, without limitation benzyl alcohol and 3-mercaptohexylacetate. Thus, a Moscato replica can include one or both of these compounds.

Further, in some embodiments, the Moscato replicas provided herein can lack one or more (e.g., one, two, three, four, five, ten, 15, 20, or more than 20) VOCs that are present in traditional Moscato. Examples of such VOCs include, without limitation, 1-decanol, 1-octanol, 1-octen-3-ol, 2,3-pentadione, 2-methylbutyraldehyde, 4-ethyl phenol, cinnamaldehyde, cis-3-hexen-1-ol, ethyl levulinate, ethyl phenyl acetate, ethyl propionate, eucalyptol, isobutyl acetate, isovaleraldehyde, methyl acetate, phenethyl acetate, propyl acetate, 1,1-diethoxyethane, 2-heptanone, 2-methoxy-4-propylphenol, 2-methylbutyl isovalerate, 2-nonanol, 2-undecanone, 3-carene, 4-ethyl guaiacol, acetophenone, alpha ionone, amyl butyrate, beta-ionone, butyl acetate, cis-3-hexenyl acetate, cis-whiskey lactone, diethyl malate, ethyl 3-hydroxyhexanoate, ethyl benzoate, ethyl cinnamate, ethyl heptanoate, ethyl myristate, ethyl nonanoate, ethyl salicylate, ethyl trans-2-butenoate, ethyl trans-3-hexenoate, ethyl undecanoate, ethyl(methylthio) acetate, ethyl-2-methylbutyrate, eugenol, farnesol, fufural, gamma-nonalactone, geranyl acetone, guaiacol, heptyl acetate, isoamyl hexanoate, isoamyl isobutyrate, isoamyl octanoate, isobutyl isobutyrate, isobutyraldehyde, linalool oxide, methional, methyl laurate, methyl octanoate, methyl salicylate, myrcene, p-cresol, p-cymene, phenethyl formate, phenethyl octanoate, salicylaldehyde, 2-acetylpyridine, 2-isopropyl-3-methoxypyrazine, 2-methoxy-4-methylphenol, 3-(methylthio)-1-propanol, 3,7 dimethyl-6-octenoic acid, 3-nonene-2-one, acetaldehyde, alpha-phellandrene, butyl formate, butyl isovalerate, dimethyl sulfide, ethyl palmitate, ethyl-3-hydroxybutyrate, gamma-octalactone, hexyl hexanoate, isoborneol, isovaleric acid, Jasmine lactone, maltol, myrtenol, octyl acetate, propyl hexanoate, trans-2-pentenal, trans-2-hexen-1-al, and trans-2-hexen-1-ol.

In some embodiments, VOCs can be placed in various groups, and a Moscato replica can lack certain VOCs according to their groupings. In certain cases, for example, “Group A” can include acetophenone, ethyl heptanoate, ethyl salicylate, ethyl trans-3-hexenoate, ethyl undecanoate, ethyl(methylthio) acetate, isoamyl hexanoate, isoamyl isobutyrate, isobutyl isobutyrate, phenethyl formate, 2-acetylpyridine, 3,7 dimethyl-6-octenoic acid, 3-nonene-2-one, alpha-phellandrene, isoborneol, trans-2-pentenal, trans-2-hexen-1-al, trans-2-hexen-1-ol, 2,6-dimethyl-5-heptenal, 3,7-dimethyl-6-octanoic acid, 4-(4-Hydroxyphenyl)-2-butanone, geranyl acetate, and hexanal.

In some cases, “Group B” can include 1-decanol, 1-octanol, eucalyptol, 2-heptanone, 2-methoxy-4-propylphenol, 2-methylbutyl isovalerate, 2-nonanol, 2-undecanone, 3-carene, alpha ionone, beta-ionone, beta-pinene, cis-3-hexenyl acetate, heptyl acetate, methyl octanoate, methyl salicylate, myrcene, p-cymene, phenethyl octanoate, salicylaldehyde, 2-isopropyl-3-methoxypyrazine, 2-methoxy-4-methylphenol, 3-(methylthio)-1-propanol, butyl formate, butyl isovalerate, dimethyl sulfide, ethyl palmitate, Jasmine lactone, maltol, myrtenol, octyl acetate, propyl hexanoate, cis-whiskey lactone, 2,6-dimethylpyrazine, 2-isobutyl-3-methoxypyrazine, ethyl-trans-3-hexenoate, L/D-carvone, methyl anthranilate, methyl vanillate, 4-carvomenthenol, and alpha-terpineol.

In some cases, the VOCs in “Group C” can include 1-octen-3-ol, 2,3-pentadione, ethyl levulinate, isobutyl acetate, isovaleraldehyde, methyl acetate, propyl acetate, 4-ethyl guaiacol, amyl butyrate, butyl acetate, diethyl malate, ethyl 3-hydroxyhexanoate, ethyl benzoate, ethyl cinnamate, ethyl myristate, ethyl nonanoate, ethyl trans-2-butenoate, ethyl-2-methylbutyrate, eugenol, farnesol, geranyl acetone, guaiacol, isoamyl octanoate, linalool oxide, methional, methyl laurate, p-cresol, ethyl-3-hydroxybutyrate, gamma-octalactone, hexyl hexanoate, isovaleric acid, 2-(methylthio)ethanol, 4-hydroxy-2,5-dimethyl-3(2H)-furanone, acetaldehyde diethyl acetal, amyl formate, cis-2-hexenol, citronellyl acetate, diacetyl, dimethyl anthranilate, ethyl-2-mercaptopropionate, sotolon, (−)-beta-pinene, trans-2-heptenal, 4-vinylphenol, acetovanillone, 2-nonanone, 3-mercaptohexyl acetate, 3-methyl-1-pentanol, amyl alcohol, benzyl acetate, benzyl alcohol, isoamyl isovalerate, linalyl acetate, linalyl butyrate, methyl decanoate, methyl hexanoate, and vanillyl ethyl ether.

“Group D” VOCs can include, in some embodiments, 2-methylbutyraldehyde, 4-ethyl phenol, cinnamaldehyde, cis-3-hexen-1-ol, ethyl phenyl acetate, ethyl propionate, phenethyl acetate, 1,1-diethoxyethane, (−)-cis-rose oxide, cis-whiskey lactone, fufural, gamma-nonalactone, isobutyraldehyde, acetaldehyde, 1,1-diethoxyethane, damascone, dimethyl succinate, propanoic acid, 2-methyl-1-butanol, 2-methylbutyl acetate, 2-phenethyl acetate, 2-phenylethanol, benzaldehyde, butanol, butyric acid, citronellol, damascenone, decanoic acid, delta-decalactone, diethyl succinate, ethyl acetate, ethyl butyrate, ethyl decanoate, ethyl hexanoate, ethyl isobutyrate, ethyl isovalerate, ethyl lactate, ethyl laurate, ethyl octanoate, ethyl valerate, gamma-decalactone, gamma-terpinene, geraniol, hexanoic acid, hexanol, hexyl acetate, isoamyl acetate, isoamyl alcohol, isobutanol, isobutyric acid, limonene, linalool, nerol, octanoic acid, phenethyl butyrate, phenethyl propionate, and propanol.

Based on the above groupings of VOCs, a Moscato replica can lack, for example, the VOCs in Group A, 20 or more (e.g., 20, 25, 30, 35, 40, 45, 50, or more than 50) of the VOCs in Group B, ten or more (e.g., ten, 15, 20, 25, 30, 35, 40, 45, 50, or more than 50) of the VOCs in Group C, and one or more (e.g., one, two, three, four, five, six, seven, eight, nine, ten, or more than ten) of the VOCs in Group D.

The Moscato-like alcoholic beverages can, in some embodiments, include at least ten (e.g., at least 15, at least 20, at least 25) or 1 to 25 (e.g., 1 to 10, 1 to 20, 1 to 25, 10 to 20, 10 to 25, or 20 to 25) VOCs selected from the group consisting of 2-methyl-1-butanol, 3-methyl-1-pentanol, a-terpineol, beta-pinene, butyric acid, decanoic acid, delta-decalactone, diethyl succinate, ethyl butyrate, ethyl decanoate, ethyl hexanoate, ethyl isobutyrate, ethyl lactate, ethyl laurate, ethyl octanoate, gamma-terpinene, geraniol, hexyl acetate, hexyl alcohol, isoamyl acetate, isobutyl alcohol, isobutyric acid, linalyl acetate, 1-limonene, 1-linalool, phenethyl acetate, and phenethyl alcohol. In some embodiments, the Moscato-like alcoholic beverages can include 2-methyl-1-butanol, 3-methyl-1-pentanol, a-terpineol, beta-pinene, butyric acid, decanoic acid, delta-decalactone, diethyl succinate, ethyl butyrate, ethyl decanoate, ethyl hexanoate, ethyl isobutyrate, ethyl lactate, ethyl laurate, ethyl octanoate, gamma-terpinene, geraniol, hexyl acetate, hexyl alcohol, isoamyl acetate, isobutyl alcohol, isobutyric acid, linalyl acetate, 1-limonene, 1-linalool, phenethyl acetate, and phenethyl alcohol.

The Moscato-like alcoholic beverages can, in some embodiments, include at least ten (e.g., at least 20, at least 25, or at least 30) or 1 to 30 (e.g., 1 to 10, 1 to 20, 1 to 30, 10 to 20, 10 to 30, or 20 to 30) VOCs selected from the group consisting of 1-propanol, 2-methylbutyl acetate, 2-nonanone, 2-undecanone, 3-mercaptohexyl acetate, 4-carvomenthenol, benzaldehyde, benzyl alcohol, butyl alcohol, citronellol, damascenone, diethyl malate, ethyl 2-methylbutyrate, ethyl acetate, ethyl isovalerate, ethyl myristate, ethyl salicylate, ethyl valerate, eucalyptol, gamma-decalactone, hexanoic acid, isoamyl alcohol, isobutyraldehyde, linalyl butyrate, L-rose oxide, methyl decanoate, methyl hexanoate, nerol, octanoic acid, p-cymene, phenethyl butyrate, and phenethyl propionate.

The Moscato-like alcoholic beverages can, in some embodiments, include 1, 2, or 3 VOCs selected from the group consisting of 2-nonanol, 4-vinylphenol, and acetovanillone.

The Moscato-like alcoholic beverages can, in some embodiments, include at least 1 (e.g., at least 2, at least 3, at least 5, at least 6, at least 8, or at least 10) or 1 to 10 (e.g., 1 to 2, 1 to 3, 1 to 5, 1 to 6, 1 to 8, or 1 to 10) VOCs selected from the group consisting of 1-octanol, 1-octen-3-ol, 2,3-pentadione, 2,4,6-trimethylphenol, 2-acetylpyridine, 2-heptanone, 2-isopropyl-3-methoxypyrazine, 2-Methoxy-4-methylphenol, 2-methoxy-4-propylphenol, 2-methylbutyraldehyde, 3-(methylthio)-1-propanol, 3,7-dimethyl-6-octanoic acid, 3-carene, 3-nonen-2-one, 4-ethyl guaiacol, 4-ethyl phenol, 5-ethyl-3-hydroxy-4-methyl-2(5H)-furanone, 5-methyl furfural, 6,10-dimethyl-5,9-undecadien-2-one, 6-methyl-5-hepten-2-one, acetaldehyde, acetophenone, a-ionone, amyl alcohol, amyl butyrate, a-phellandrene, b-caryophellene, beta-ionone, butyl acetate, butyl formate, butyl isovalerate, cinnamaldehyde, cis-3-hexen-1-ol, cis-3-hexenyl acetate, citral, damascone, D-camphor, decanol, dimethyl sulfide, DL-3-methyl-2-butanol, ethyl 3-hydroxyhexanoate, ethyl benzoate, ethyl cinnamate, ethyl levulinate, ethyl nonanoate, ethyl palmitate, ethyl phenylacetate, ethyl propionate, ethyl trans-2-butenoate, ethyl undecanoate, ethyl-3-hydroxybutyrate, eugenol, farnesol, furfural, furfuryl mercaptan, gamma-hexalactone, gamma-nonalactone, gamma-octalactone, gamma-undecalactone, guaiacol, heptyl acetate, Hexadecanol, hexyl hexanoate, isoamyl hexanoate, isoamyl isobutyrate, isoamyl isovalerate, isoamyl octanoate, isoborneol, isobutyl acetate, isovaleraldehyde, isovaleric acid, Jasmine lactone, linalool oxide, maltol, methional, methyl acetate, methyl anthranilate, methyl cyclopentenolone, methyl laurate, methyl octanoate, methyl salicylate, methyl vanillate, methyl β-naphthyl ketone, myrcene, myrtenol, nerolidol, nonanal, octyl acetate, p,a-dimethylstyrene, p-cresol, phenethyl octanoate, phenylacetaldehyde, propyl acetate, propyl butyrate, propyl hexanoate, salicylaldehyde, terpinolene, trans-2-heptenal, trans-2-Hexen-1-al, trans-2-hexen-1-ol, trans-2-pentenal, and whiskey lactone.

The Moscato-like alcoholic beverages can, in some embodiments, include at least 1 (e.g., at least 2, at least 3, at least 5, at least 6, at least 8, or at least 10) or 1 to 10 (e.g., 1 to 2, 1 to 3, 1 to 5, 1 to 6, 1 to 8, or 1 to 10) VOCs selected from the group consisting of (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-octanone, 2-pentylfuran, 3,7-dimethyl-6-octenoic acid, 3-heptyl acetate, 3-methylthio hexyl acetate, 3-phenylpropanal, 4-(4-Hydroxyphenyl)-2-butanone, 4,5,6,7-tetrahydro-3,6-dimethylbenzofuran, 4-Hydroxy-2,5-dimethyl-3(2H)-furanone, 4-mercapto-4-methyl-2-pentanone, 5-methyl-2-phenyl-2-hexenal, acetal, acetaldehyde, diethyl acetal, acetoin, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-2-hexenol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexanal, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl formate, phenethyl isobutyrate, phenethyl tiglate, phenethylacetaldehyde dimethyl acetal, phenylacetaldehyde dimethyl acetal, propanal, propanoic acid, propyl isovalerate, sotolon, tetrahydrolinalool, thymol, valencene, valeraldehyde, vanillyl butyl ether, and vanillyl ethyl ether.

In some embodiments, the Moscato replicas provided herein can include one or more (e.g., one, two, three, four, five, or more than five) VOCs that are not present in traditional Moscato. Examples of such VOCs can include, without limitation, (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-nonanol, 2-octanone, 2-pentylfuran, 3,7-dimethyl-6-octenoic acid, 3-heptyl acetate, 3-methylthio hexyl acetate, 3-phenylpropanal, 4-(4-hydroxyphenyl)-2-butanone, 4,5,6,7-tetrahydro-3,6-dimethylbenzofuran, 4-hydroxy-2,5-dimethyl-3(2H)-furanone, 4-mercapto-4-methyl-2-pentanone, 4-vinylphenol, 5-methyl-2-phenyl-2-hexenal, acetal (1,1-diethoxyethane), acetaldehyde, diethyl acetal, acetoin, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-2-hexenol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, damascone, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexanal, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl isobutyrate, phenethyl tiglate, phenethylacetaldehyde dimethyl acetal, phenylacetaldehyde dimethyl acetal, propanal, propanoic acid, propionaldehyde, propyl isovalerate, sotolon, tetrahydrolinalool, thymol, valencene, valeraldehyde, valeric acid, vanillyl butyl ether, and vanillyl ethyl ether.

Thus, in some embodiments, a Moscato-like alcoholic beverage can include 1 to 123 (e.g., 1, 1 to 2, 1 to 3, 1 to 4, 1 to 5, 1 to 10, 1 to 15, 1 to 20, 1 to 25, 1 to 30, 1 to 40, 1 to 50, 1 to 60, 1 to 70, 1 to 80, 1 to 90, 1 to 100, 1 to 110, 1 to 120, or 123) compounds selected from the group consisting of (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-nonanol, 2-octanone, 2-pentylfuran, 3,7-dimethyl-6-octenoic acid, 3-heptyl acetate, 3-methylthio hexyl acetate, 3-phenylpropanal, 4-(4-hydroxyphenyl)-2-butanone, 4,5,6,7-tetrahydro-3,6-dimethylbenzofuran, 4-hydroxy-2,5-dimethyl-3(2H)-furanone, 4-mercapto-4-methyl-2-pentanone, 4-vinylphenol, 5-methyl-2-phenyl-2-hexenal, acetal (1,1-diethoxyethane), acetaldehyde, diethyl acetal, acetoin, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-2-hexenol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, damascone, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexanal, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl isobutyrate, phenethyl tiglate, phenethylacetaldehyde dimethyl acetal, phenylacetaldehyde dimethyl acetal, propanal, propanoic acid, propionaldehyde, propyl isovalerate, sotolon, tetrahydrolinalool, thymol, valencene, valeraldehyde, valeric acid, vanillyl butyl ether, and vanillyl ethyl ether.

In some embodiments, a Moscato-like alcoholic beverage can include 1 to 119 (e.g., 1, 1 to 2, 1 to 3, 1 to 4, 1 to 5, 1 to 10, 1 to 15, 1 to 20, 1 to 25, 1 to 30, 1 to 40, 1 to 50, 1 to 60, 1 to 70, 1 to 80, 1 to 90, 1 to 100, 1 to 110, 5 to 10, 10 to 20, 20 to 30, 30 to 40, 40 to 50, 50 to 60, 60 to 70, 70 to 80, 80 to 90, 90 to 100, 100 to 110, 110 to 119, or 119) selected from the group consisting of: (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-nonanol, 2-octanone, 2-pentylfuran, 3-heptyl acetate, 3-methylthio hexyl acetate, 3-phenylpropanal, 4-(4-hydroxyphenyl)-2-butanone, 4,5,6,7-tetrahydro-3,6-dimethylbenzofuran, 4-hydroxy-2,5-dimethyl-3(2H)-furanone, 4-mercapto-4-methyl-2-pentanone, 4-vinylphenol, 5-methyl-2-phenyl-2-hexenal, acetal (1,1-diethoxyethane), acetoin, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, damascone, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexanal, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl tiglate, phenethylacetaldehyde dimethyl acetal, phenylacetaldehyde dimethyl acetal, propanal, propanoic acid, propionaldehyde, propyl isovalerate, sotolon, tetrahydrolinalool, thymol, valencene, valeraldehyde, valeric acid, vanillyl butyl ether, and vanillyl ethyl ether.

In some embodiments, a Moscato-like alcoholic beverage can include 1 to 13 (e.g., 1, 1 to 2, 1 to 3, 1 to 4, 1 to 5, 1 to 6, 1 to 8, 1 to 10, 1 to 12, 2 to 4, 4 to 6, 6 to 8, 8 to 10, 10 to 12, or 13) compounds selected from the group consisting of 2-nonanol, 4-(4-hydroxyphenyl)-2-butanone, 4-hydroxy-2,5-dimethyl-3(2H)-furanone, 4-vinylphenol, butyraldehyde, citronellyl acetate, damascone, decanal, gamma-dodecalactone, hexanal, propionaldehyde, sotolon, and valeric acid.

In some embodiments, a Moscato-like alcoholic beverage can include 2-nonanol, 4-vinylphenol, or both.

In some embodiments, a Moscato-like alcoholic beverage can include 2-nonanol.

In some embodiments, a Moscato-like alcoholic beverage can include 4-vinylphenol.

In some embodiments, a Moscato-like alcoholic beverage can include 1 to 110 (e.g., 1, 1 to 2, 1 to 3, 1 to 4, 1 to 5, 1 to 10, 1 to 15, 1 to 20, 1 to 25, 1 to 30, 1 to 40, 1 to 50, 1 to 60, 1 to 70, 1 to 80, 1 to 90, 1 to 100, 5 to 10, 10 to 20, 20 to 30, 30 to 40, 40 to 50, 50 to 60, 60 to 70, 70 to 80, 80 to 90, 90 to 100, 100 to 110, or 110) compounds selected from the group consisting of (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-octanone, 2-pentylfuran, 3-heptyl acetate, 3-methylthio hexyl acetate, 3-phenylpropanal, 4,5,6,7-tetrahydro-3,6-dimethylbenzofuran, 4-mercapto-4-methyl-2-pentanone, 5-methyl-2-phenyl-2-hexenal, acetal (1,1-diethoxyethane), acetoin, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl tiglate, phenethylacetaldehyde dimethyl acetal, phenylacetaldehyde dimethyl acetal, propanal, propanoic acid, propyl isovalerate, tetrahydrolinalool, thymol, valencene, valeraldehyde, vanillyl butyl ether, and vanillyl ethyl ether.

In some embodiments, a Moscato-like alcoholic beverage can include 1 to 9 (e.g., 1, 1 to 2, 1 to 3, 1 to 4, 1 to 5, 1 to 6, 1 to 7, 1 to 8, 2 to 4, 4 to 6, 6 to 8, or 9) compounds selected from the group consisting of 3,7-dimethyl-6-octenoic acid, 4-(4-hydroxyphenyl)-2-butanone, 4-hydroxy-2,5-dimethyl-3(2H)-furanone, acetaldehyde, diethyl acetal, cis-2-hexenol, hexanal, phenethyl formate, phenethyl isobutyrate, and sotolon.

In some embodiments, a Moscato-like alcoholic beverage can include 1 to 13 (e.g., 1, 1 to 2, 1 to 3, 1 to 4, 1 to 5, 1 to 6, 1 to 7, 1 to 8, 1 to 9, 1 to 10, 1 to 11, 1 to 12, 2 to 4, 4 to 6, 6 to 8, 8 to 10, 10 to 12, or 13) compounds selected from the group consisting of 2-nonanol, 4-(4-hydroxyphenyl)-2-butanone, 4-hydroxy-2,5-dimethyl-3(2H)-furanone, 4-vinylphenol, butyraldehyde, citronellyl acetate, damascone, decanal, gamma-dodecalactone, hexanal, propionaldehyde, sotolon, and valeric acid.

The presence, absence, and/or amounts of VOCs and non-volatile compounds in traditional Moscato wines and in Moscato replicas is assessed using the gas chromatography/mass spectrometry (GC-MS) and liquid chromatography/mass spectrometry (LC-MS) methods described herein. A volatile or non-volatile compound that is “not present” in a reference Moscato is one that is not detected in the reference Moscato using the methods set forth in Example 2. Limits of detection for various VOCs are disclosed in TABLES 3A, 3B, 3C, and 3D herein, and limits of detection for various non-volatile compounds are disclosed in TABLES 10A and 10B herein.

Further, in some embodiments, the Moscato replicas provided herein can lack one or more (e.g., one, two, three, four, five, ten, 15, 20, or more than 20) VOCs that are present in traditional Moscato. Examples of such VOCs include, without limitation 1-octanol, 1-octen-3-ol, 1-propanol, 2,4,6-trimethylphenol, 2-acetylpyridine, 2-isopropyl-3-methoxypyrazine, 2-methylbutyl acetate, 2-methylbutyraldehyde, 3-(methylthio)-1-propanol, 3,7-dimethyl-6-octanoic acid, 3-nonen-2-one, 5-ethyl-3-hydroxy-4-methyl-2(5H)-furanone, 5-methyl furfural, 6-methyl-5-hepten-2-one, acetaldehyde, a-phellandrene, b-caryophellene, butyl formate, butyl isovalerate, cinnamaldehyde, citral, damascone, D-camphor, decanol, dimethyl sulfide, ethyl acetate, ethyl palmitate, ethyl phenylacetate, ethyl propionate, ethyl trans-2-butenoate, ethyl-3-hydroxybutyrate, furfural, hexadecanol, hexyl hexanoate, isoborneol, isobutyl acetate, isovaleraldehyde, isovaleric acid, jasmine lactone, linalool oxide, methyl acetate, methyl cyclopentenolone, methyl decanoate, myrtenol, octyl acetate, p,a-dimethylstyrene, phenylacetaldehyde, propyl butyrate, propyl hexanoate, terpinolene, trans-2-hexen-1-ol, and trans-2-pentenal.

In some embodiments, a Moscato-like alcoholic beverage can exclude 1 to 52 (e.g., 1, 1 to 2, 1 to 3, 1 to 4, 1 to 5, 1 to 10, 1 to 15, 1 to 20, 1 to 30, 1 to 40, 1 to 50, 5 to 10, 10 to 20, 20 to 30, 30 to 40, 40 to 50, or 52) compounds selected from the group consisting of 1-octanol, 1-octen-3-ol, 1-propanol, 2,4,6-trimethylphenol, 2-acetylpyridine, 2-isopropyl-3-methoxypyrazine, 2-methylbutyl acetate, 2-methylbutyraldehyde, 3-(methylthio)-1-propanol, 3,7-dimethyl-6-octanoic acid, 3-nonen-2-one, 5-ethyl-3-hydroxy-4-methyl-2(5H)-furanone, 5-methyl furfural, 6-methyl-5-hepten-2-one, acetaldehyde, a-phellandrene, b-caryophellene, butyl formate, butyl isovalerate, cinnamaldehyde, citral, damascone, D-camphor, decanol, dimethyl sulfide, ethyl acetate, ethyl palmitate, ethyl phenylacetate, ethyl propionate, ethyl trans-2-butenoate, ethyl-3-hydroxybutyrate, furfural, hexadecanol, hexyl hexanoate, isoborneol, isobutyl acetate, isovaleraldehyde, isovaleric acid, jasmine lactone, linalool oxide, methyl acetate, methyl cyclopentenolone, methyl decanoate, myrtenol, octyl acetate, p,a-dimethylstyrene, phenylacetaldehyde, propyl butyrate, propyl hexanoate, terpinolene, trans-2-hexen-1-ol, and trans-2-pentenal.

In some embodiments, a Moscato-like alcoholic beverage can exclude 1 to 48 (e.g., 1, 1 to 2, 1 to 3, 1 to 4, 1 to 5, 1 to 10, 1 to 15, 1 to 20, 1 to 30, 1 to 40, 5 to 10, 10 to 20, 20 to 30, 30 to 40, or 48) compounds selected from the group consisting of 1-octanol, 1-octen-3-ol, 2,4,6-trimethylphenol, 2-acetylpyridine, 2-isopropyl-3-methoxypyrazine, 2-methylbutyraldehyde, 3-(methylthio)-1-propanol, 3,7-dimethyl-6-octanoic acid, 3-nonen-2-one, 5-ethyl-3-hydroxy-4-methyl-2(5H)-furanone, 5-methyl furfural, 6-methyl-5-hepten-2-one, acetaldehyde, a-phellandrene, b-caryophellene, butyl formate, butyl isovalerate, cinnamaldehyde, citral, damascone, D-camphor, decanol, dimethyl sulfide, ethyl palmitate, ethyl phenylacetate, ethyl propionate, ethyl trans-2-butenoate, ethyl-3-hydroxybutyrate, furfural, hexadecanol, hexyl hexanoate, isoborneol, isobutyl acetate, isovaleraldehyde, isovaleric acid, jasmine lactone, linalool oxide, methyl acetate, methyl cyclopentenolone, myrtenol, octyl acetate, p,a-dimethylstyrene, phenylacetaldehyde, propyl butyrate, propyl hexanoate, terpinolene, trans-2-hexen-1-ol, and trans-2-pentenal.

In some embodiments, a Moscato-like alcoholic beverage can exclude 1 to 22 (e.g., 1, 1 to 2, 1 to 3, 1 to 4, 1 to 5, 1 to 10, 1 to 15, 1 to 20, 5 to 10, 5 to 15, 5 to 20, 10 to 15, 10 to 20, 15 to 20, or 22) compounds selected from the group consisting of 1-octanol, 1-octen-3-ol, 2,4,6-trimethylphenol, 2-methylbutyraldehyde, 5-ethyl-3-hydroxy-4-methyl-2(5H)-furanone, 6-methyl-5-hepten-2-one, b-caryophellene, butyl formate, cinnamaldehyde, citral, D-camphor, decanol, ethyl phenylacetate, ethyl propionate, ethyl trans-2-butenoate, hexadecanol, isobutyl acetate, isovaleraldehyde, methyl acetate, p,a-dimethylstyrene, phenylacetaldehyde, and terpinolene.

In some embodiments a Moscato-like alcoholic beverage can exclude 1 to 26 (e.g., 1, 1 to 2, 1 to 3, 1 to 4, 1 to 5, 1 to 10, 1 to 15, 1 to 20, 5 to 10, 5 to 15, 5 to 20, 5 to 25, 10 to 15, 10 to 20, 10 to 20, 10 to 25, 15 to 20, 15 to 25, 20 to 25, or 26) compounds selected from the group consisting of 1-octanol, 1-octen-3-ol, 1-propanol, 2,4,6-trimethylphenol, 2-methylbutyl acetate, 2-methylbutyraldehyde, 5-ethyl-3-hydroxy-4-methyl-2(5H)-furanone, 6-methyl-5-hepten-2-one, b-caryophellene, butyl formate, cinnamaldehyde, citral, D-camphor, decanol, ethyl acetate, ethyl phenylacetate, ethyl propionate, ethyl trans-2-butenoate, hexadecanol, isobutyl acetate, isovaleraldehyde, methyl acetate, methyl decanoate, p,a-dimethylstyrene, phenylacetaldehyde, and terpinolene.

A Moscato-like alcoholic beverage can include any appropriate number of additional VOCs. For example, a Moscato-like alcoholic beverage can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) additional VOCs. In some cases, the number of additional VOCs in Moscato-like alcoholic beverage can be less than the number of additional VOCs in a single reference Moscato.

In some cases, the overall population of additional (non-ethanol) VOCs in a replica Moscato can have less than 95% identity to the VOCs in a corresponding reference Moscato (e.g., in a single type, brand, vintage, or bottle of traditional Moscato). For example, the additional VOCs in a Moscato replica can have less than 90%, less than 80%, less than 70%, less than 60%, less than 50%, or less than 40% identity to the population of VOCs in a corresponding reference Moscato. Some Moscato replicas may contain at least 10 (e.g., at least 15, at least 20, at least 25, at least 30, at least 35, at least 40, at least 45, or at least 50) VOCs that are not found in a single reference Moscato. Moreover, some Moscato replicas may contain no more than 55 (e.g., no more than 54, 53, 52, 51, 50, 45, 40, 35, 30, 25, 20, 15, or 10) VOCs that are present in a single reference Moscato. For example, in some embodiments, a Moscato replica can have at least n additional VOCs and wherein less than n (e.g., n−1, n−2, n−3, n−4, n−5, n−6, n−7, n−8, n−9, n−10, n−15, n−20, and the like, as applicable) of the additional VOCs are found in a single reference Moscato; in some embodiments, n can be equal to 5, 6, 7, 8, 9, 10, 11, 12, 13, 14, 15, 16, 17, 18, 19, 20, 25, 30, 35, 40, 45, 50, or 55.

The Examples below set forth amounts of VOCs that were included in a Moscato replica that was made according to the methods disclosed herein, and also set forth the amounts of VOCs that were detected in traditional Moscato wine samples. In some embodiments, the amount of a particular VOC in a Moscato replica can be an amount, based on concentration or percent composition, that is within a range 30% higher and lower than the amount disclosed for that VOC. For example, a VOC can be present in a Moscato replica in an amount that is 70 to 90%, 80 to 100%, 90 to 110%, 100 to 120%, 110 to 130%, 70 to 100%, 80 to 110%, 90 to 120%, or 100 to 130% of an amount for that VOC as disclosed herein.

The one or more additional VOCs in a Moscato-like alcoholic beverage can include (−)-beta-pinene (also sometimes called beta-pinene, beta pinen, or b-pinene). In some embodiments, the (−)-beta-pinene can be present in an amount of about 0.0012 mg/L to about 0.12 mg/L (e.g., about 0.0012 to about 0.005 mg/L, about 0.005 to about 0.01 mg/L, about 0.01 to about 0.05 mg/L, about 0.05 to about 0.10 mg/L, or about 0.10 to about 0.12 mg/L). In some embodiments, the one or more additional VOCs can include (−)-beta-pinene in an amount of at least about 0.014 mg/L (e.g., at least about 0.015 mg/L, 0.016 mg/L, 0.018 mg/L, 0.02 mg/L, 0.03 mg/L, 0.04 mg/L, 0.05 mg/L, 0.06 mg/L, 0.07 mg/L, 0.08 mg/L, 0.09 mg/L, 0.10 mg/L, 0.11 mg/L, or 0.12 mg/L). In some embodiments, about 0.00003% to about 0.085% by mass (e.g., about 0.00003% to about 0.0001% by mass, about 0.0001% to about 0.0005% by mass, about 0.0005% to about 0.001% by mass, about 0.001% to about 0.005% by mass, about 0.005% to about 0.010% by mass, about 0.010% to about 0.050% by mass, or about 0.050% to about 0.085% by mass) of the one or more additional VOCs can be (−)-beta-pinene. In some embodiments, at least about 0.014% by mass (e.g., at least about 0.017%, 0.018%, 0.019%, 0.02%, 0.03%, 0.04%, 0.05%, 0.06%, or 0.07% by mass) of the one or more additional VOCs can be (−)-beta-pinene. In some embodiments, the one or more additional VOCs can include no (−)-beta-pinene.

It will be understood that when both a range (or subrange) and an “at least” or “less than” amount (or percent by mass) are disclosed, these together disclose all ranges that exist in the overlap of the range (or subrange) and one of the “at least” or “less than” values in any logical combination. By way of example only, (−)-beta-pinene can be present in an amount of about 0.0012 mg/L to about 0.12 mg/L and the one or more additional VOCs can include (−)-beta-pinene in an amount of at least about 0.014 mg/L. Therefore, (−)-beta-pinene can be present in an amount of about 0.014 mg/L to about 0.12 mg/L (e.g., 0.014 to about 0.05 mg/L, about 0.05 to about 0.10 mg/L, or about 0.10 to about 0.12 mg/L). This also means that (−)-beta-pinene can be present in an amount of about 0.015 mg/L to about 0.12 mg/L (e.g., 0.015 to about 0.05 mg/L, about 0.05 to about 0.10 mg/L, or about 0.10 to about 0.12 mg/L); (−)-beta-pinene can be present in an amount of about 0.016 mg/L to about 0.12 mg/L (e.g., 0.016 to about 0.05 mg/L, about 0.05 to about 0.10 mg/L, or about 0.10 to about 0.12 mg/L); (−)-beta-pinene can be present in an amount of about 0.018 mg/L to about 0.12 mg/L (e.g., 0.018 to about 0.05 mg/L, about 0.05 to about 0.10 mg/L, or about 0.10 to about 0.12 mg/L); (−)-beta-pinene can be present in an amount of about 0.02 mg/L to about 0.12 mg/L (e.g., 0.02 to about 0.05 mg/L, about 0.05 to about 0.10 mg/L, or about 0.10 to about 0.12 mg/L); (−)-beta-pinene can be present in an amount of about 0.03 mg/L to about 0.12 mg/L (e.g., 0.03 to about 0.05 mg/L, about 0.05 to about 0.10 mg/L, or about 0.10 to about 0.12 mg/L); (−)-beta-pinene can be present in an amount of about 0.04 mg/L to about 0.12 mg/L (e.g., 0.04 to about 0.05 mg/L, about 0.05 to about 0.10 mg/L, or about 0.10 to about 0.12 mg/L); (−)-beta-pinene can be present in an amount of about 0.05 mg/L to about 0.12 mg/L (e.g., about 0.05 to about 0.10 mg/L, or about 0.10 to about 0.12 mg/L); (−)-beta-pinene can be present in an amount of about 0.06 mg/L to about 0.12 mg/L (e.g., about 0.06 to about 0.10 mg/L, or about 0.10 to about 0.12 mg/L); (−)-beta-pinene can be present in an amount of about 0.07 mg/L to about 0.12 mg/L (e.g., about 0.07 to about 0.10 mg/L, or about 0.10 to about 0.12 mg/L); (−)-beta-pinene can be present in an amount of about 0.08 mg/L to about 0.12 mg/L (e.g., about 0.08 to about 0.10 mg/L, or about 0.10 to about 0.12 mg/L); (−)-beta-pinene can be present in an amount of about 0.09 mg/L to about 0.12 mg/L (e.g., about 0.09 to about 0.10 mg/L, or about 0.10 to about 0.12 mg/L); (−)-beta-pinene can be present in an amount of about 0.10 mg/L to about 0.12 mg/L; or (−)-beta-pinene can be present in an amount of about 0.11 mg/L to about 0.12 mg/L.

Further, it will be understood that if both a range and an “at least” or “less than” value are described for a Moscato-like alcoholic beverage, the interpretation will be the largest logical overlap of those descriptions. For example, if a Moscato-like alcoholic beverage is described with both “(−)-beta-pinene is present in an amount of about 0.0012 mg/L to about 0.12 mg/L” and “the one or more additional VOCs include (−)-beta-pinene in an amount of at least about 0.014 mg/L”, the interpretation shall be that (−)-beta-pinene is present in an amount of about 0.014 mg/L to about 0.12 mg/L.

Similarly by way of example, about 0.00003% to about 0.085% by mass of the one or more additional VOCs can be (−)-beta-pinene and at least about 0.016% by mass of the one or more additional VOCs can be (−)-beta-pinene.

The one or more additional VOCs in a Moscato-like alcoholic beverage can include (−)-cis-rose oxide (also sometimes called cis-rose oxide or L-rose oxide). In some embodiments, the (−)-cis-rose oxide can be present in an amount of about 0.0003 mg/L to about 0.06 mg/L (e.g., about 0.0003 to about 0.0005 mg/L, about 0.0005 to about 0.001 mg/L, about 0.001 to about 0.005 mg/L, about 0.005 to about 0.01 mg/L, about 0.01 to about 0.02 mg/L, about 0.02 to about 0.05 mg/L, about 0.03 to about 0.04 mg/L, about 0.04 to about 0.05 mg/L, or about 0.05 to about 0.06 mg/L). In some embodiments, the (−)-cis-rose oxide can be present in an amount of at least about 0.0011 mg/L (e.g., at least about 0.0011 mg/L, 0.0013 mg/L, 0.0015 mg/L, 0.0017 mg/L, 0.0019 mg/L, 0.002 mg/L, 0.003 mg/L, 0.005 mg/L, 0.01 mg/L, 0.02 mg/L, or 0.03 mg/L) In some embodiments, about 0.00001% to about 0.07% by mass (e.g., about 0.00001% to about 0.0001% by mass, about 0.0001% to about 0.001% by mass, about 0.001% to about 0.01% by mass, about 0.01% to about 0.02% by mass, about 0.02% to about 0.03% by mass, about 0.03% to about 0.04% by mass, about 0.04% to about 0.05% by mass, about 0.01% to about 0.05% by mass, about 0.01% to about 0.07% by mass, about 0.05% to about 0.06% by mass, or about 0.06% to about 0.07% by mass) of the additional VOCs can be (−)-cis-rose-oxide. In some embodiments, at least about 0.0013% by mass (e.g., at least about 0.0015%, 0.002%, 0.003%, 0.004%, 0.005%, 0.006%, 0.007%, 0.008%, 0.009%, 0.01%, 0.02%, 0.03%, 0.04%, 0.05%, 0.06%, or 0.07% by mass) of the one or more additional VOCs can be (−)-cis-rose-oxide. In some embodiments, a Moscato-like alcoholic beverage can include no (−)-cis-rose-oxide.

The one or more additional VOCs in a Moscato-like alcoholic beverage can include 1-decanol (also sometimes called decanol, decyl alcohol, or n-decyl alcohol). In some embodiments, the 1-decanol can be present in an amount of about 0.001 mg/L to about 0.005 mg/L (e.g., about 0.001 to about 0.002 mg/L, about 0.002 to 0.003 mg/L, about 0.003 to about 0.004 mg/L, or about 0.004 to about 0.005 mg/L). In some embodiments, about 0.00003% to about 0.006% by mass (e.g., about 0.00003% to about 0.00005% by mass, about 0.00005% to about 0.00010% by mass, about 0.0001% to about 0.0005% by mass, about 0.0005% to about 0.001% by mass, or about 0.001% to about 0.006% by mass, about 0.001% to about 0.005% by mass, about 0.001% to about 0.002% by mass, about 0.002% to about 0.003% by mass, about 0.003% to about 0.004% by mass, about 0.004% to about 0.005%, or about 0.005% to about 0.006% by mass) of the one or more additional VOCs can be 1-decanol. In some embodiments, the one or more additional VOCs can include no 1-decanol.

The additional VOCs in a Moscato-like alcoholic beverage can include 1-octanol. In some embodiments, the 1-octanol can be present in an amount of between about 0.0004 mg/L to about 0.025 mg/L (e.g., about 0.0004 to about 0.0006 mg/L, about 0.0006 to about 0.0008 mg/L, about 0.0008 to about 0.001 mg/L, about 0.001 to about 0.005 mg/L, about 0.005 to about 0.010 mg/L, about 0.010 to about 0.020 mg/L, about 0.010 to about 0.015 mg/L, about 0.015 to about 0.020 mg/L, about 0.015 to about 0.025 mg/L, or about 0.020 to about 0.025 mg/L). In some embodiments, about 0.00001% to about 0.03% by mass (e.g., about 0.00001% to about 0.00005% by mass, about 0.00005% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% to about 0.02% by mass, about 0.02% to about 0.03% by mass, or about 0.01% to about 0.03% by mass) of the one or more additional VOCs can be 1-octanol. In some embodiments, the one or more additional VOCs can include no 1-octanol.

The one or more additional VOCs in a Moscato-like alcoholic beverage can include 1-octen-3-ol. In some embodiments, the 1-octen-3-ol can be present in an amount of about 0.0002 mg/L to about 0.005 mg/L (e.g., about 0.0002 to about 0.0005 mg/L, about 0.0005 to about 0.001 mg/L, about 0.001 to about 0.002 mg/L, about 0.002 to about 0.003 mg/L, about 0.003 to about 0.004 mg/L, about 0.004 to about 0.005 mg/L, or about 0.001 to about 0.005 mg/L). In some embodiments, about 0.000006% to about 0.006% by mass (e.g., about 0.000006% to about 0.00001% by mass, 0.00001% to about 0.00005% by mass, about 0.00005% to about 0.0001% by mass, about 0.0001% to about 0.0005% by mass, about 0.0005% to about 0.001% by mass, about 0.001% to about 0.002% by mass, about 0.002% to about 0.003% by mass, about 0.003% to about 0.004% by mass, about 0.004% to about 0.005% by mass, about 0.005% to about 0.006% by mass, about 0.001% to about 0.005% by mass, or about 0.001% to about 0.006% by mass) of the one or more additional VOCs can be 1-octen-3-ol. In some embodiments, the one or more additional VOCs can include no 1-octen-3-ol.

The one or more additional VOCs in a Moscato-like alcoholic beverage can include 2,3-pentadione. In some embodiments, the 2,3-pentadione can be present in an amount of about 0.008 mg/L to about 0.055 mg/L (e.g., about 0.008 to about 0.010 mg/L about 0.010 to about 0.020 mg/L, about 0.020 to about 0.030 mg/L, 0.030 to about 0.040 mg/L, about 0.040 to about 0.050 mg/L, or about 0.050 to about 0.055 mg/L). In some embodiments, about 0.0002% to about 0.06% by mass (e.g., about 0.0002% to about 0.0005% by mass, about 0.0005% to about 0.001% by mass, about 0.001% to about 0.005% by mass, about 0.005% to about 0.01% by mass, about 0.01% to about 0.02% by mass, about 0.02% to about 0.03% by mass, about 0.03% to about 0.04% by mass, about 0.04% to about 0.05% by mass, about 0.05% to about 0.06% by mass, about 0.01% to about 0.05% by mass, or about 0.01% to about 0.06% by mass) of the one or more additional VOCs can be 2,3-pentadione. In some embodiments, the one or more additional VOCs can include no 2,3-pentadione.

The one or more additional VOCs in a Moscato-like alcoholic beverage can include 2,4,6-trimethylphenol (also called mesitol). In some embodiments, the 2,4,6-trimethylphenol can be present in an amount of about 0.001 to about 0.004 mg/L (e.g., about 0.001 to about 0.002 mg/L, about 0.002 to about 0.003 mg/L, about 0.003 to about 0.004 mg/L, about 0.001 to about 0.003 mg/L, or about 0.002 to about 0.004 mg/). In some embodiments, about 0.00004% to about 0.004% by mass (e.g., about 0.00004% to about 0.0001% by mass, about 0.00005% to about 0.0001% by mass, about 0.0001% to about 0.0005% by mass, about 0.0005% to about 0.001% by mass, about 0.001% to about 0.004% by mass, about 0.001% to about 0.002% by mass, about 0.002% to about 0.003% by mass, or about 0.003% to about 0.004% by mass) of the one or more additional VOCs can be 2,4,6-trimethylphenol. In some embodiments, the one or more additional VOCs can include no 2,4,6-trimethylphenol.

The one or more additional VOCs in a Moscato-like alcoholic beverage can include 2-acetylpyridine. In some embodiments, the 2-acetylpyridine can be present in an amount of about 0.007 mg/L to about 0.02 mg/L (e.g., about 0.007 to about 0.010 mg/L, about 0.01 to about 0.02 mg/L, about 0.010 to about 0.015 mg/L, or about 0.015 to about 0.020 mg/L). In some embodiments, about 0.0002% to about 0.02% by mass (e.g., about 0.0002% to about 0.0005% by mass, about 0.0005% to about 0.001% by mass, about 0.001% to about 0.005% by mass, about 0.005% to about 0.01% by mass, or about 0.01% to about 0.02% by mass) of the one or more additional VOCs can be 2-acetylpyridine. In some embodiments, the one or more additional VOCs can include no 2-acetylpyridine.

The one or more additional VOCs in a Moscato-like alcoholic beverage can include 2-heptanone. In some embodiments, the 2-heptanone can be present in an amount of about 0.0001 mg/L to about 0.004 mg/L (e.g., about 0.0001 to about 0.0005 mg/L, about 0.0005 to about 0.001 mg/L, about 0.001 to about 0.004 mg/L, about 0.001 to about 0.002 mg/L, about 0.002 to about 0.003 mg/L, or about 0.003 to about 0.004 mg/L). In some embodiments, about 0.000004% to about 0.004% by mass (e.g., about 0.000004% to about 0.00001% by mass, about 0.00001% to about 0.00005% by mass, about 0.00005% to about 0.0001% by mass, about 0.0001% to about 0.0005% by mass, about 0.0005% to about 0.001% by mass, about 0.001% to about 0.004% by mass, about 0.001% to about 0.002% by mass, about 0.002% to about 0.003% by mass, about 0.003% to about 0.004% by mass) of the one or more additional VOCs can be 2-heptanone. In some embodiments, the one or more additional VOCs can include no 2-heptanone.

The one or more additional VOCs in a Moscato-like alcoholic beverage can include 2-isopropyl-3-methoxypyrazine. In some embodiments, the 2-isopropyl-3-methoxypyrazine can be present in an amount of about 0.00007 mg/L to about 0.0008 mg/L (e.g., about 0.00007 to about 0.00008 mg/L, about 0.00008 to about 0.0001 mg/L, about 0.0001 to about 0.0002 mg/L, about 0.0002 to about 0.0004 mg/L, about 0.0004 to about 0.006 mg/L, or about 0.0006 to about 0.0008 mg/L). In some embodiments, about 0.000002% to about 0.0009% by mass (e.g., about 0.000002% to about 0.000005% by mass, about 0.000005% to about 0.00001% by mass, about 0.00001% to about 0.00005% by mass, about 0.00005% to about 0.0001% by mass, about 0.0001% to about 0.0003% by mass, about 0.0003% to about 0.0005% by mass, about 0.0005% to about 0.0007% by mass, about 0.0007% to about 0.0009% by mass, about 0.0001% to about 0.0005% by mass, or about 0.0001% to about 0.0009% by mass) of the one or more additional VOCs can be 2-isopropyl-3-methoxypyrazine. In some embodiments, the one or more additional VOCs can include no 2-isopropyl-3-methoxypyrazine.

The one or more additional VOCs in a Moscato-like alcoholic beverage can include 2-methoxy-4-methylphenol (also called creosol). In some embodiments, the 2-methoxy-4-methylphenol can be present in an amount of about 0.0015 mg/L to about 0.005 mg/L (e.g., about 0.0015 to about 0.002 mg/L, about 0.002 to about 0.003 mg/L, about 0.003 to about 0.004 mg/L, or about 0.004 to about 0.005 mg/L). In some embodiments, about 0.00005% to about 0.006% by mass (e.g., about 0.00005% to about 0.0001% by mass, about 0.0001% to about 0.0002% by mass, about 0.0002% to about 0.0005% by mass, about 0.0005% to about 0.001% by mass, about 0.001% to about 0.002% by mass, about 0.002% to about 0.003% by mass, about 0.003% to about 0.004% by mass, about 0.004% to about 0.005% by mass, about 0.005% to about 0.006% by mass, about 0.001% to about 0.005% by mass, or about 0.001% to about 0.006% by mass) of the one or more additional VOCs can be 2-methoxy-4-methylphenol. In some embodiments, the one or more additional VOCs can include no 2-methoxy-4-methylphenol.

The one or more additional VOCs in a Moscato-like alcoholic beverage can include 2-methoxy-4-propylphenol. In some embodiments, the 2-methoxy-4-propylphenol can be present in an amount of about 0.00007 mg/L to about 0.00020 mg/L (e.g., about 0.00007 to about 0.00010 mg/L, about 0.00010 to about 0.00015 mg/L, or about 0.00015 to about 0.00020 mg/L). In some embodiments, about 0.000002% to about 0.0002% by mass (e.g., about 0.000002% to about 0.000005% by mass, about 0.000005% to about 0.00001% by mass, about 0.00001% to about 0.00005% by mass, about 0.00005% to about 0.0001% by mass, or about 0.0001% to about 0.0002% by mass) of the one or more additional VOCs can be 2-methoxy-4-propylphenol. In some embodiments, the one or more additional VOCs can include no 2-methoxy-4-propylphenol.

The one or more additional VOCs in a Moscato-like alcoholic beverage can include 2-methyl-1-butanol. In some embodiments, the 2-methyl-1-butanol can be present in an amount of about 10 mg/L to about 360 mg/L (e.g., about 10 to about 15 mg/L, about 10 to about 20 mg/L, about 20 to about 30 mg/L, about 40 to about 50 mg/L, about 50 to about 60 mg/L, about 60 to about 70 mg/L, about 70 to about 80 mg/L, about 80 to about 90 mg/L, about 90 to about 100 mg/L, about 100 mg/L to about 150 mg/L, about 150 to about 200 mg/L, about 200 to about 250 mg/L, about 250 to about 300 mg/L, or about 300 to about 360 mg/L). In some embodiments, about 0.4% to about 90% by mass (e.g., about 0.4% to about 1% by mass, about 1% to about 5% by mass, about 5% to about 10% by mass, about 10% to about 15% by mass, about 10% to about 20% by mass, about 20% to about 30% by mass, about 30% to about 40% by mass, about 40% to about 50% by mass, about 50% to about 60% by mass, about 60% to about 70% by mass, about 70% to about 80% by mass, or about 80% to about 90% by mass) of the one or more additional VOCs can be 2-methyl-1-butanol.

The one or more additional VOCs in a Moscato-like alcoholic beverage can include 2-methylbutyl acetate. In some embodiments, the 2-methylbutyl acetate can be present in an amount of about 0.005 mg/L to about 0.05 mg/L (e.g., about 0.005 to about 0.01 mg/L, about 0.01 to about 0.02 mg/L, about 0.02 to about 0.03 mg/L, about 0.03 to about 0.04 mg/L, about 0.01 to about 0.05 mg/L, or about 0.04 to about 0.05 mg/L). In some embodiments, about 0.0002% to about 0.05% by mass (e.g., about 0.0002% to about 0.0005% by mass, about 0.0005% to about 0.001% by mass, about 0.001% to about 0.002% by mass, about 0.002% to about 0.005% by mass, about 0.005% to about 0.01% by mass, about 0.01% to about 0.02% by mass, about 0.02% to about 0.03% by mass, about 0.03% to about 0.04% by mass, about 0.04% to about 0.05% by mass, or about 0.01% to about 0.05% by mass) of the one or more additional VOCs can be 2-methylbutyl acetate.

The one or more additional VOCs in a Moscato-like alcoholic beverage can include 2-methylbutyraldehyde. In some embodiments, the 2-methylbutyraldehyde can be present in an amount of about 0.001 mg/L to about 0.1 mg/L (e.g., about 0.001 to about 0.005 mg/L, about 0.005 to about 0.01 mg/L, about 0.01 to about 0.05 mg/L, or about 0.05 to about 0.1 mg/L). In some embodiments, about 0.00002% to about 0.1% by mass (e.g., about 0.00002% to about 0.00005% by mass, about 0.00005% to about 0.0001% by mass, about 0.0001% to about 0.0002% by mass, about 0.0002% to about 0.0005% by mass, about 0.0005% to about 0.001% by mass, about 0.001% by mass to about 0.005% by mass, about 0.005% to about 0.01% by mass, about 0.01% to about 0.05% by mass, or about 0.05% to about 0.1% by mass) of the one or more additional VOCs can be 2-methylbutyraldehyde. In some embodiments, the one or more additional VOCs can include no 2-methylbutyraldehyde.

The one or more additional VOCs in a Moscato-like alcoholic beverage can include 2-nonanol. In some embodiments, the 2-nonanol can be present in an amount of about 0.04 mg/L to about 0.09 mg/L (e.g., about 0.04 to about 0.05 mg/L, about 0.05 to about 0.06 mg/L, about 0.06 to about 0.07 mg/L, about 0.07 to about 0.08 mg/L, about 0.08 mg/L to about 0.09 mg/L, about 0.04 to about 0.06 mg/L, about 0.06 to about 0.08 mg/L, about 0.05 to about 0.07 mg/L, or about 0.07 to about 0.09 mg/L). In some embodiments, about 0.05% to about 0.1% by mass (e.g., about 0.05% to about 0.06% by mass, about 0.06% to about 0.07% by mass, about 0.07% to about 0.08% by mass, about 0.08% to about 0.09% by mass, about 0.09% to about 0.1% by mass, about 0.05% to about 0.07% by mass, about 0.07% to about 0.09% by mass, about 0.06% to about 0.08% by mass, or about 0.08% to about 0.1% by mass) of the one or more additional VOCs can be 2-nonanol. In some embodiments, the one or more additional VOCs can include no 2-nonanol.

The one or more additional VOCs in a Moscato-like alcoholic beverage can include 2-nonanone. In some embodiments, the 2-nonanone can be present in an amount of about 0.0003 mg/L to about 0.09 mg/L. (e.g., about 0.0003 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.09 mg/L, about 0.01 to about 0.03 mg/L, about 0.03 to about 0.05 mg/L, about 0.05 to about 0.07 mg/L, or about 0.07 to about 0.09 mg/L). In some embodiments, the 2-nonanone can be present in an amount of at least about 0.0014 mg/L (e.g., at least about 0.0015 mg/L, 0.0016 mg/L, 0.0017 mg/L, 0.0018 mg/L, 0.0019 mg/L, 0.002 mg/L, 0.005 mg/L, 0.01 mg/L, 0.02 mg/L, 0.03 mg/L, or 0.04 mg/L). In some embodiments, about 0.00001% to about 0.1% by mass (e.g., about 0.00001% to about 0.00005% by mass, about 0.00005% to about 0.0001% by mass, about 0.0001% to about 0.0005% by mass, about 0.0005% to about 0.001% by mass, about 0.001% to about 0.005% by mass, about 0.005% to about 0.01% by mass, 0.01% to about 0.02% by mass, about 0.02% to about 0.03% by mass, 0.03% to about 0.04% by mass, about 0.04% to about 0.05% by mass, about 0.01% to about 0.05% by mass, about 0.05% to about 0.1% by mass, about 0.05% to about 0.06% by mass, about 0.06% to about 0.07% by mass, about 0.07% to about 0.08% by mass, about 0.08% to about 0.09% by mass, or about 0.09% to about 0.1% by mass) of the one or more additional VOCs can be 2-nonanone. In some embodiments, at least about 0.0017% by mass (e.g., at least about 0.0018%, 0.0019%, 0.002%, 0.005%, 0.01%, 0.02%, 0.03%, 0.04%, 0.05%, 0.06%, 0.07%, 0.08%, or 0.09% by mass) of the one or more additional VOCs can be 2-nonenone.

The one or more additional VOCs in a Moscato-like alcoholic beverage can include 2-phenylethylacetate (also called 2-phenethyl acetate or phenethyl acetate). In some embodiments, the 2-phenylethylacetate can be present in an amount of about 0.005 mg/L to about 0.75 mg/L (e.g., about 0.005 to about 0.01 mg/L, about 0.01 to about 0.02 mg/L, about 0.02 to about 0.05 mg/L, about 0.05 to about 0.10 mg/L, about 0.10 to about 0.25 mg/L, about 0.25 to about 0.5 mg/L, or about 0.5 to about 0.75 mg/L). In some embodiments, the 2-phenylethylacetate can be present in an amount of at least about 0.15 mg/L (e.g., at least about 0.16 mg/L, 0.17 mg/L, 0.18 mg/L, 0.19 mg/L, 0.20 mg/L, 0.30 mg/L, 0.40 mg/L, 0.50 mg/L, or 0.60 mg/L). In some embodiments, about 0.00015% to about 0.7% by mass (e.g., about 0.00015% to about 0.0005% by mass, about 0.0005% to about 0.001% by mass, about 0.001% by mas to about 0.005% by mass, about 0.005% to about 0.01% by mass, about 0.01% to about 0.05% by mass, about 0.05% to about 0.1% by mass, about 0.1% to about 0.2% by mass, about 0.2% to about 0.3% by mass, about 0.3% to about 0.4% by mass, about 0.4% to about 0.5% by mass, about 0.1% to about 0.5% by mass, about 0.1% to about 0.7%, by mass, about 0.5% to about 0.6% by mass, or about 0.6% to about 0.7% by mass) of the one or more additional VOCs can be 2-phenylethylacetate. In some embodiments, at least 0.18% by mass (e.g., at least about 0.19%, 0.2%, 0.3%, or 0.4% by mass) of the one or more additional VOCs can be 2-phenylethylacetate.

The one or more additional VOCs in a Moscato-like alcoholic beverage can include 2-phenylethanol (also called 2-phenethanol or phenethyl alcohol). In some embodiments, the 2-phenylethanol can be present in an amount of about 6 mg/L to about 170 mg/L (e.g., about 6 to about 10 mg/L, about 8 to about 12 mg/L, about 10 to about 20 mg/L, about 20 to about 30 mg/L, about 30 to about 50 mg/L, about 50 to about 75 mg/L, about 75 to about 100 mg/L, about 100 mg/L to about 150 mg/L, or about 100 to about 170 mg/L. In some embodiments, the 2-phenylethanol can be present in an amount of less than about 13.5 mg/L (e.g., less than about 13 mg/L, 12 mg/L, 11 mg/L, 10 mg/L, 9 mg/L, 8 mg/L, or 7 mg/L). In some embodiments, about 0.5% to about 90% by mass (e.g., about 0.5% to about 1% by mass, about 1% to about 2% by mass, about 2% to about 5% by mass, about 5% to about 8% by mass, about 7% to about 9% by mass, about 5% to about 10% by mass, about 8% to about 12% by mass, about 10% to about 15% by mass, about 15% to about 20% by mass, about 20% to about 30% by mass, about 30% to about 50% by mass, about 50% to about 70% by mass, or about 70% to about 90% by mass) of the one or more additional VOCs can be 2-phenylethanol.

The one or more additional VOCs in a Moscato-like alcoholic beverage can include 2-undecanone. In some embodiments, 2-undecanone can be present in an amount of about 0.00004 mg/L to about 0.007 mg/L (e.g., about 0.00004 to about 0.0001 mg/L, about 0.0001 to about 0.0002 mg/L, about 0.0001 to about 0.0005 mg/L, about 0.0005 to about 0.001 mg/L, about 0.001 to about 0.005 mg/L, about 0.001 to about 0.007 mg/L, about 0.001 to about 0.003 mg/L, about 0.003 to about 0.005 mg/L, or about 0.005 to about 0.007 mg/L). In some embodiments, 2-undecanone can be present in an amount of at least 0.0014 mg/L (e.g., at least about 0.0015 mg/L, 0.0016 mg/L, 0.0017 mg/L, 0.0018 mg/L, 0.0019 mg/L, 0.002 mg/L, 0.003 mg/L, 0.004 mg/L, 0.005 mg/L, or 0.006 mg/L). In some embodiments, about 0.000001% to about 0.008% by mass (e.g., about 0.000001% to about 0.000005% by mass, about 0.000005% to about 0.00001% by mass, about 0.00001% to about 0.00005% by mass, about 0.00005% to about 0.0001% by mass, about 0.0001% to about 0.0005% by mass, about 0.0005% to about 0.001% by mass, about 0.001% to about 0.005% by mass, about 0.001% to about 0.008% by mass, about 0.001% to about 0.002% by mass, about 0.002% to about 0.004% by mass, about 0.004% to about 0.006% by mass, or about 0.006% to about 0.008% by mass) of the one or more additional VOCs can be 2-undecanone. In some embodiments, at least about 0.0017% by mass (e.g., at least about 0.0018%, 0.0019%, 0.002%, 0.003%, 0.004%, 0.005%, 0.006%, or 0.007% by mass) of the one or more additional VOCs can be 2-undecanone. In some embodiments, the one or more additional VOCs can include no 2-undecanone.

The one or more additional VOCs in a Moscato-like alcoholic beverage can include 3-(methylthio)-1-propanol. In some embodiments, the 3-(methylthio)-1-propanol can be present in an amount of about 0.8 mg/L to about 2.2 mg/L (e.g., about 0.8 to about 0.9 mg/L, about 0.9 to about 1.0 mg/L, about 1.0 to about 1.2 mg/L, about 1 to about 2 mg/L, about 1.2 to about 1.4 mg/L, about 1.4 to about 1.6 mg/L, about 1.6 to about 1.8 mg/L, about 1.8 to about 2.0 mg/L, or about 2.0 to about 2.2 mg/L). In some embodiments, about 0.02% to about 2.5% by mass (e.g., about 0.02% to about 0.05% by mass, about 0.05% by mass to about 0.1% by mass, about 0.1% to about 0.5% by mass, about 0.5% to about 1.0% by mass, about 1.0% to about 1.5% by mass, about 1% to about 2% by mass, about 1.5% to about 2.0% by mass, or about 2.0% to about 2.5% by mass) of the one or more additional VOCs can be 2-(methylthio)-1-propanol. In some embodiments, the one or more additional VOCs can include no 3-(methylthio)-1-propanol.

The one or more additional VOCs in a Moscato-like alcoholic beverage can include 3,7-dimethyl-6-octenoic acid. In some embodiments, the 3,7-dimethyl-6-octenoic acid can be present in an amount of about 0.0006 mg/L to about 0.0015 mg/L (e.g., 0.0006 to about 0.0007 mg/L, about 0.0007 to about 0.0008 mg/L, about 0.0008 to about 0.0009 mg/L, about 0.0009 to about 0.0010 mg/L, about 0.0010 mg/L to about 0.0011 mg/L, about 0.0010 to about 0.0015 mg/L, about 0.0011 to about 0.0012 mg/L, about 0.0012 to about 0.0013 mg/L, about 0.0013 to about 0.0014 mg/L, or about 0.0014 to about 0.0015 mg/L). In some embodiments, about 0.00002% to about 0.002% by mass (e.g., about 0.00002% to about 0.00005% by mass, about 0.00005% to about 0.0001% by mass, about 0.0001% to about 0.0002% by mass, about 0.0002% to about 0.0005% by mass, about 0.0005% to about 0.001% by mass, or about 0.001% to about 0.002% by mass) of the one or more additional VOCs can be 3,7-dimethyl-6-octenoic acid. In some embodiments, the one or more additional VOCs can include no 3,7-dimethyl-6-octenoic acid.

The one or more additional VOCs in a Moscato-like alcoholic beverage can include 3-carene. In some embodiments, the 3-carene can be present in an amount of about 0.003 mg/L to about 0.009 mg/L (e.g., about 0.003 to about 0.004 mg/L, about 0.004 to about 0.025 mg/L, about 0.005 to about 0.010 mg/L, about 0.01 to about 0.02 mg/L, about 0.010 to about 0.015 mg/L, about 0.015 to about 0.020 mg/L, or about 0.020 to about 0.25 mg/L). In some embodiments, about 0.00008% to about 0.03% by mass (e.g., about 0.00008% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% by mass to about 0.03% by mass, about 0.01% to about 0.02% by mass, or about 0.02% to about 0.03% by mass) of the one or more additional VOCs can be 3-carene. In some embodiments, the one or more additional VOCs can include no 3-carene.

The one or more additional VOCs in a Moscato-like alcoholic beverage can include 3-mercaptohexylacetate. In some embodiments, the 3-mercaptohexylacetate can be present in an amount of about 0.0004 mg/L to about 0.0008 mg/L (e.g., about 0.0004 to about 0.0005 mg/L, about 0.0005 to about 0.0006 mg/L, about 0.0006 to about 0.0007 mg/L, or about 0.0007 to about 0.0008 mg/L). In some embodiments, about 0.0003% to about 0.0006% by mass (e.g., about 0.0003% to about 0.0004% by mass, about 0.0004% to about 0.0005% by mass, or about 0.0005% to about 0.0006% by mass) of the one or more additional VOCs can be 3-mercaptohexylacetate. In some embodiments, the one or more additional VOCs can include no 3-mercaptohexylacetate.

The one or more additional VOCs in a Moscato-like alcoholic beverage can include 3-methyl-1-pentanol. In some embodiments, the 3-methyl-1-pentanol can be present in an amount of about 0.007 mg/L to about 0.12 mg/L (e.g., about 0.007 to about 0.01 mg/L, about 0.01 to about 0.02 mg/L, about 0.01 to about 0.05 mg/L, about 0.02 to about 0.03 mg/L, about 0.03 to about 0.04 mg/L, about 0.04 to about 0.05 mg/L, about 0.05 to about 0.07 mg/L, about 0.07 mg/L to about 0.10 mg/L, about 0.05 to about 0.1 mg/L, or about 0.10 mg/L to about 0.012 mg/L). In some embodiments, about 0.0002% to about 0.15% by mass (e.g., about 0.0002% to about 0.0005% by mass, about 0.0005% to about 0.001% by mass, about 0.001% to about 0.005% by mass, about 0.005% to about 0.01% by mass, 0.01% to about 0.02% by mass, about 0.02% to about 0.03% by mass, 0.03% to about 0.05% by mass, about 0.05% to about 0.07% by mass, about 0.07% to about 0.09% by mass, about 0.09% to about 0.11% by mass, about 0.11% to about 0.13% by mass, about 0.13% to about 0.15% by mass, about 0.01% to about 0.05% by mass, about 0.05% to about 0.10% by mass, or about 0.10% to about 0.15% by mass) of the one or more additional VOCs can be 3-methyl-1-pentanol. In some embodiments, the one or more additional VOCs can include no 3-methyl-1-pentanol.

The one or more additional VOCs in a Moscato-like alcoholic beverage can include 3-nonen-2-one. In some embodiments, the 3-nonen-2-one can be present in an amount of about 0.0015 mg/L to about 0.0035 mg/L (e.g., about 0.0015 to about 0.0020 mg/L, about 0.0020 to about 0.0025 mg/L, about 0.0025 to about 0.0030 mg/L, or about 0.0030 to about 0.0035 mg/L). In some embodiments, about 0.00004% to about 0.004% by mass (e.g., about 0.00004% to about 0.0001% by mass, about 0.0001% to about 0.0002% by mass, about 0.0002% to about 0.0005% by mass, about 0.0005% to about 0.001% by mass, about 0.001% to about 0.002% by mass, about 0.002% to about 0.003% by mass, about 0.003% to about 0.004% by mass, or about 0.001% to about 0.004% by mass) of the one or more additional VOCs can be 3-nonen-2-one. In some embodiments, the one or more additional VOCs can include no 3-nonen-2-one.

The one or more additional VOCs in a Moscato-like alcoholic beverage can include 4-carvomenthenol. In some embodiments, the 4-carvomenthenol can be present in an amount of about 0.0009 mg/L to about 0.09 mg/L (e.g., 0.0009 to about 0.002 mg/L, about 0.002 to about 0.005 mg/L, about 0.005 to about 0.01 mg/L, about 0.01 to about 0.02 mg/L, about 0.02 to about 0.03 mg/L, about 0.03 to about 0.04 mg/L, about 0.04 to about 0.05 mg/L, about 0.05 to about 0.06 mg/L, about 0.06 to about 0.07 mg/L, about 0.07 to about 0.08 mg/L, about 0.08 to about 0.09 mg/L, about 0.01 to about 0.05 mg/L, about 0.01 to about 0.09 mg/L, or about 0.05 to about 0.09 mg/L). In some embodiments, the 4-carvomenthenol can be present in an amount of at least 0.02 mg/L (e.g., at least about 0.03 mg/L, 0.04 mg/L, 0.05 mg/L, 0.06 mg/L, 0.07 mg/L, or 0.08 mg/L). In some embodiments, about 0.00002% to about 0.1% by mass (e.g., about 0.00002% to about 0.00005% by mass, about 0.00005% to about 0.0001% by mass, about 0.0001% to about 0.0005% by mass, about 0.0005% to about 0.001% by mass, about 0.001% to about 0.002% by mass, about 0.002% to about 0.005% by mass, about 0.005% to about 0.01% by mass, about 0.01% to about 0.02% by mass, about 0.02% to about 0.03% by mass, about 0.03% to about 0.04% by mass, about 0.04% to about 0.05% by mass, about 0.01% to about 0.05% by mass, about 0.05% to about 0.06% by mass, about 0.06% to about 0.07% by mass, about 0.07% to about 0.08% by mass, about 0.08% to about 0.09% by mass, about 0.09% to about 0.1% by mass, or about 0.05% to about 0.1% by mass) of the one or more additional VOCs can be 4-carvomenthenol. In some embodiments, at least about 0.025% by mass (e.g., at least about 0.03%, 0.04%, 0.05%, 0.06%, 0.07%, 0.08%, or 0.09% by mass) of the one or more additional VOCs can be 4-carvomenthenol. In some embodiments, the one or more additional VOCs can include no 4-carvomenthenol.

The one or more additional VOCs in a Moscato-like alcoholic beverage can include 4-ethylguaiacol. In some embodiments, the 4-ethylguaiacol can be present in an amount of about 0.2 mg/L to about 0.5 mg/L (e.g., about 0.2 to about 0.3 mg/L, about 0.3 to about 0.4 mg/L, or about 0.4 to about 0.5 mg/L). In some embodiments, about 0.006% to about 0.6% by mass (e.g., about 0.006% to about 0.01% by mass, about 0.01% to about 0.05% by mass, about 0.05% by mass, about 0.05% to about 0.1% by mass, about 0.1% to about 0.5% by mass, about 0.1% to about 0.6% by mass, about 0.1% to about 0.2%, about 0.2% to about 0.4% by mass, or about 0.2% to about 0.4% by mass) of the one or more additional VOCs can be 4-ethylguaiacol. In some embodiments, the one or more additional VOCs can include no 4-ethylguaiacol.

The one or more additional VOCs in a Moscato-like alcoholic beverage can include 4-ethylphenol. In some embodiments, the 4-ethylphenol can be present in an amount of about 0.00006 mg/L to about 0.004 mg/L (e.g., about 0.00006 to about 0.0001 mg/L, about 0.0001 to about 0.0005 mg/L, about 0.0005 to about 0.001 mg/L, about 0.001 to about 0.002 mg/L, about 0.002 to about 0.003 mg/L, about 0.001 to about 0.004 mg/L, or about 0.003 to about 0.004 mg/L). In some embodiments, 0.000002% to about 0.005% by mass (e.g., about 0.000002% to about 0.00001% by mass, about 0.00001% to about 0.00005% by mass, about 0.00005% to about 0.0001% by mass, about 0.0001% to about 0.0005% by mass, about 0.0005% to about 0.001% by mass, about 0.001% to about 0.002% by mass, about 0.002% to about 0.003% by mass, about 0.003% to about 0.004% by mass, about 0.004% to about 0.005% by mass, or about 0.001% to about 0.005% by mass) of the one or more additional VOCs can be 4-ethylphenol. In some embodiments, the one or more additional VOCs can include no 4-ethylphenol.

The one or more additional VOCs in a Moscato-like alcoholic beverage can include 4-vinylphenol. In some embodiments, the 4-vinylphenol can be present in an amount of about 0.09 mg/L to about 0.2 mg/L (e.g., about 0.09 to about 0.10 mg/L, about 0.10 to about 0.12 mg/L, about 0.12 to about 0.14 mg/L, about 0.14 to about 0.16 mg/L, about 0.16 to about 0.18 mg/L, about 0.1 to about 0.2 mg/L, or about 0.18 to about 0.20 mg/L). In some embodiments, about 0.07% to about 0.14% by mass (e.g., about 0.06% to about 0.08% by mass, 0.08% to about 0.10% by mass, about 0.10% to about 0.12% by mass, or about 0.12% to about 0.14% by mass) of the one or more additional VOCs can be 4-vinylphenol. In some embodiments, the one or more additional VOCs can include no 4-vinylphenol.

The one or more additional VOCs in a Moscato-like alcoholic beverage can include 5-ethyl-3-hydroxy-4-methyl-2(5H)-furanone (also called maple furanone). In some embodiments, the 5-ethyl-3-hydroxy-4-methyl-2(5H)-furanone can be present in an amount of about 0.04 mg/L to about 0.15 mg/L (e.g., about 0.04 to about 0.10 mg/L, about 0.05 to about 0.10 mg/L, about 0.10 to about 0.15 mg/L, about 0.04 to about 0.06 mg/L, about 0.06 to about 0.09 mg/L, about 0.09 to about 0.12 mg/L, or about 0.12 to about 0.15 mg/L). In some embodiments, about 0.001% to about 0.2% by mass (e.g., 0.001% to about 0.005% by mass, about 0.005% to about 0.01% by mass, about 0.01% to about 0.05% by mass, about 0.05% to about 0.1% by mass, or about 0.1% to about 0.2% by mass) of the one or more additional VOCs can be 5-ethyl-3-hydroxy-4-methyl-2(5H)-furanone. In some embodiments, the one or more additional VOCs can include no 5-ethyl-3-hydroxy-4-methyl-2(5H)-furanone.

The one or more additional VOCs in a Moscato-like alcoholic beverage can include 5-methyl furfural. In some embodiments, the 5-methyl furfural can be present in an amount of about 0.006 to about 0.04 mg/L (e.g., about 0.006 to about 0.01 mg/L, about 0.01 to about 0.04 mg/L, about 0.01 to about 0.02 mg/L, about 0.02 to about 0.03 mg/L, or about 0.03 to about 0.04 mg/L). In some embodiments, about 0.0002% to about 0.04% by mass (e.g., about 0.0002% to about 0.0005% by mass, about 0.0005% to about 0.001% by mass, about 0.001% to about 0.005% by mass, about 0.005% to about 0.01% by mass, about 0.01% to about 0.04% by mass, about 0.01% to about 0.02% by mass, about 0.02% to about 0.03% by mass, or about 0.03% to about 0.04% by mass) of the one or more additional VOCs can be 5-methyl furfural. In some embodiments, the one or more additional VOCs can include no 5-methyl furfural.

The one or more additional VOCs in a Moscato-like alcoholic beverage can include 6-methyl-5-hepten-2-one. In some embodiments, the 6-methyl-5-hepten-2-one can be present in an amount of about 0.0008 mg/L to about 0.002 mg/L (e.g., about 0.0008 to about 0.001 mg/L or about 0.001 to about 0.002 mg/L). In some embodiments, about 0.00002% to about 0.002% by mass (e.g., about 0.00002% to about 0.00005% by mass, about 0.00005% to about 0.0001% by mass, about 0.0001% to about 0.0005% by mass, about 0.0005% to about 0.001% by mass, or about 0.001% to about 0.002% by mass) of the one or more additional VOCs can be 6-methyl-5-hepten-2-one. In some embodiments, the one or more additional VOCs can include no 6-methyl-5-hepten-2-one.

The one or more additional VOCs in a Moscato-like alcoholic beverage can include acetaldehyde. In some embodiments, the acetaldehyde can be present in an amount of about 0.006 mg/L to about 0.035 mg/L (e.g., about 0.006 to about 0.010 mg/L, about 0.010 to about 0.015 mg/L, about 0.015 to about 0.020 mg/L, about 0.020 to about 0.025 mg/L, about 0.025 to about 0.030 mg/L, about 0.01 to about 0.02 mg/L, about 0.02 to about 0.03 mg/L, or about 0.025 to about 0.035 mg/L). In some embodiments, about 0.0001% to about 0.04% by mass (e.g., about 0.0001% to about 0.0005% by mass, about 0.0005% to about 0.001% by mass, about 0.001% to about 0.005% by mass, about 0.005% to about 0.01% by mass, about 0.01% to about 0.02% by mass, 0.02% to about 0.03% by mass, about 0.03% to about 0.04%, or about 0.01% to about 0.04% by mass) of the one or more additional VOCs can be acetaldehyde. In some embodiments, the one or more additional VOCs can include no acetaldehyde.

The one or more additional VOCs in a Moscato-like alcoholic beverage can include acetophenone. In some embodiments, the acetophenone can be present in an amount of about 0.0006 mg/L to about 0.002 mg/L (e.g., about 0.0006 to about 0.001 mg/L or about 0.001 to about 0.002 mg/L). In some embodiments, about 0.00002% to about 0.002% by mass (e.g., about 0.00002% to about 0.00005%, about 0.00005% to about 0.0001% by mass, about 0.0001% to about 0.0005% by mass, about 0.0005% to about 0.001% by mass, or about 0.001% to about 0.002% by mass) of the one or more VOCs can be acetophenone. In some embodiments, the one or more additional VOCs can include no acetophenone.

The one or more additional VOCs in a Moscato-like alcoholic beverage can include acetovanillone. In some embodiments, the acetovanillone can be present in an amount of about 0.0004 mg/L to about 0.0008 mg/L (e.g., about 0.0004 to about 0.0005 mg/L, about 0.0005 to about 0.0006 mg/L, bout 0.0006 to about 0.0007 mg/L, or about 0.0007 to about 0.0008 mg/L). In some embodiments, about 0.0003% to about 0.0006% by mass (e.g., about 0.0003% to about 0.0004% by mass, about 0.0004% to about 0.0005% by mass, or about 0.0005% to about 0.0006% by mass) of the one or more additional VOCs can be acetovanillone. In some embodiments, the one or more additional VOCs can include no acetovanillone.

The one or more additional VOCs in a Moscato-like alcoholic beverage can include alpha-ionone (also called a-ionone). In some embodiments, the alpha-ionone can be present in an amount of about 0.00007 mg/L to about 0.0005 mg/L (e.g., about 0.00007 to about 0.0001 mg/L, about 0.0001 to about 0.0002 mg/L, about 0.0002 to about 0.0003 mg/L, about 0.0003 to about 0.0004 mg/L, about 0.0001 to about 0.0005 mg/L, or about 0.0004 to about 0.0005 mg/L). In some embodiments, about 0.000002% to about 0.0006% by mass (e.g., about 0.000002% to about 0.000005%, about 0.000005% to about 0.00001% by mass, about 0.00001% to about 0.00005% by mass, about 0.00005% to about 0.0001% by mass, about 0.0001% to about 0.0002% by mass, about 0.0002% to about 0.0003% by mass, about 0.0003% to about 0.0004% by mass, about 0.0004% to about 0.0005% by mass, about 0.0005% to about 0.0006% by mass, about 0.0001% to about 0.0005% by mass, or about 0.0001% to about 0.0006% by mass) of the one or more additional VOCs can be alpha-ionone. In some embodiments, the one or more additional VOCs can include no alpha-ionone.

The one or more additional VOCs in a Moscato-like alcoholic beverage can include alpha terpineol (also called alpha-terpineol or a-terpineol). In some embodiments, the alpha terpineol can be present in an amount of about 0.08 mg/L to about 1 mg/L (e.g., about 0.08 to about 0.10 mg/L, about 0.10 to about 0.12 mg/L, about 0.12 to about 0.14 mg/L, about 0.14 to about 0.16 mg/L, about 0.16 to about 0.18 mg/L, about 0.18 to about 0.2 mg/L, about 0.2 to about 0.3 mg/L, about 0.3 to about 0.5 mg/L, about 0.5 to about 0.7 mg/L, about 0.7 to about 0.9 mg/L, about 0.1 to about 0.5 mg/L, about 0.5 to about 1 mg/L, or about 0.9 mg/L to about 1 mg/L). In some embodiments, about 0.003% to about 1.2% by mass (e.g., about 0.003% to about 0.01% by mass, about 0.01% to about 0.02% by mass, about 0.02% to about 0.05% by mass, about 0.05% to about 0.1% by mass, about 0.1% to about 0.2% by mass, about 0.2% to about 0.3% by mass, about 0.3% to about 0.5% by mass, about 0.5% to about 0.7% by mass, about 0.7% to about 0.9% by mass, about 0.8% to about 1.0% by mass, about 1.0% to about 1.2% y mass, about 0.1% to about 0.5% by mass, about 0.5% to about 1% by mass, or about 0.5% to about 2.5% by mass) of the one or more additional VOCs can be alpha terpineol. In some embodiments, the one or more additional VOCs can include no alpha terpineol.

The one or more additional VOCs in a Moscato-like alcoholic beverage can include amyl alcohol. In some embodiments, the amyl alcohol can be present in an amount of about 0.03 mg/L to about 0.15 mg/L (e.g., about 0.03 to about 0.05 mg/L, about 0.05 to about 0.1 mg/L, about 0.10 to about 0.15 mg/L, or about 0.05 to about 0.15 mg/L). In some embodiments, about 0.0008% to about 0.2% by mass (e.g., about 0.0008% to about 0.001% by mass, about 0.001% to about 0.005% by mass, about 0.005% to about 0.01% by mass, about 0.01% to about 0.05% by mass, about 0.05% to about 0.1% by mass, or about 0.1% to about 0.2% by mass) of the one or more additional VOCs can be amyl alcohol. In some embodiments, the one or more additional VOCs can include no amyl alcohol.

The one or more additional VOCs in a Moscato-like alcoholic beverage can include amyl butyrate. In some embodiments, the amyl butyrate can be present in an amount of about 0.004 mg/L to about 0.02 mg/L (e.g., about 0.004 to about 0.005 mg/L, about 0.005 to about 0.006 mg/L, about 0.006 to about 0.007 mg/L, about 0.007 to about 0.008 mg/L, about 0.008 to about 0.009 mg/L, about 0.009 to about 0.01 mg/L, about 0.005 to about 0.01 mg/L, or about 0.01 to about 0.02 mg/L). In some embodiments, about 0.0001% to about 0.025% by mass (e.g., about 0.0001% to about 0.0005% by mass, about 0.0005% to about 0.001% by mass, about 0.001% to about 0.005% by mass, about 0.005% to about 0.01% by mass, about 0.01% to about 0.02% by mass, or about 0.010% to about 0.025% by mass) of the one or more additional VOCs can be amyl butyrate. In some embodiments, the one or more additional VOCs can include no amyl butyrate.

The one or more additional VOCs in a Moscato-like alcoholic beverage can include alpha-phellandrene (also called a-phellandrene). In some embodiments, the alpha-phellandrene can be present in an amount of about 0.004 mg/L to about 0.02 mg/L (e.g., about 0.004 to about 0.005 mg/L, about 0.005 to about 0.008 mg/L, about 0.008 to about 0.01 mg/L, about 0.005 to about 0.01 mg/L, or about 0.01 to about 0.02 mg/L). In some embodiments, about 0.0001% to about 0.02% by mass (e.g., about 0.0001% to about 0.0002% by mass, about 0.0002% to about 0.0005% by mass, about 0.0005% to about 0.001% by mass, about 0.001% to about 0.005% by mass, about 0.005% to about 0.01% by mass, or about 0.01% to about 0.02% by mass) of the one or more additional VOCs can be alpha-phellandrene. In some embodiments, the one or more additional VOCs can include no alpha-phellandrene.

The one or more additional VOCs in a Moscato-like alcoholic beverage can include b-caryophellene. In some embodiments, the b-caryophellene can be present in an amount of about 0.004 to about 0.008 mg/L (e.g., about 0.004 to about 0.006 mg/L, about 0.006 to about 0.008 mg/L, or about 0.005 to about 0.007 mg/L). In some embodiments, about 0.0001% to about 0.01% by mass (e.g., about 0.0001% to about 0.0005%, about 0.0005% to about 0.001%, about 0.001% to about 0.005%, or about 0.005% to about 0.01% by mass) of the one or more additional VOCs can be b-caryophellene. In some embodiments, the one or more additional VOCs can include no b-caryophellene.

The one or more additional VOCs in a Moscato-like alcoholic beverage can include benzaldehyde. In some embodiments, the benzaldehyde can be present in an amount of about 0.001 mg/L to about 0.2 mg/L (e.g., about 0.001 to about 0.005 mg/L, about 0.005 to about 0.01 mg/L, about 0.01 to about 0.05 mg/L, about 0.05 to about 0.1 mg/L, or about 0.1 to about 0.2 mg/L). In some embodiments, the benzaldehyde can be present in an amount of at least about 0.022 mg/L (e.g., at least about 0.023 mg/L, 0.024 mg/L, 0.025 mg/L, 0.03 mg/L, 0.04 mg/L, 0.05 mg/L, 0.06 mg/L, 0.07 mg/L, 0.08 mg/L, 0.09 mg/L, or 0.1 mg/L). In some embodiments, about 0.00003% to about 0.25% by mass (e.g., about 0.00003% to about 0.00005% by mass, about 0.00005% to about 0.0001% by mass, about 0.0001% to about 0.0005% by mass, about 0.0005% to about 0.001% by mass, about 0.001% to about 0.002% by mass, about 0.002% to about 0.005% by mass, about 0.005% to about 0.01% by mass, about 0.01% to about 0.05% by mass, about 0.05% to about 0.1% by mass, about 0.1% to about 0.2% by mass, about 0.10% to about 0.15% by mass, about 0.15% to about 0.20% by mass, about 0.20% to about 0.25% by mass, or about 0.15% to about 0.25% by mass) of the one or more additional VOCs can be benzaldehyde. In some embodiments, at least about 0.025% by mass (e.g., at least about 0.026%, 0.027%, 0.028%, 0.029%, 0.03%, 0.04%, 0.05%, 0.06%, 0.07%, 0.08%, 0.09%, 0.1%, or 0.2% by mass) of the one or more additional VOCs can be benzaldehyde. In some embodiments, the one or more additional VOCs can include no benzaldehyde.

The one or more additional VOCs in a Moscato-like alcoholic beverage can include benzyl alcohol. In some embodiments, the benzyl alcohol can be present in an amount of about 0.01 mg/L to about 0.06 mg/L (e.g., about 0.01 to about 0.05 mg/L, about 0.01 to about 0.02 mg/L, about 0.02 to about 0.03 mg/L, about 0.03 to about 0.04 mg/L, about 0.04 to about 0.05 mg/L, or about 0.05 to about 0.06 mg/L). In some embodiments, about 0.0004% to about 0.075% by mass (e.g., about 0.0004% to about 0.001% by mass, about 0.0005% to about 0.001% by mass, about 0.001% to about 0.005% by mass, about 0.005% to about 0.01% by mass, about 0.01% to about 0.05% by mass, about 0.01% to about 0.03% by mass, about 0.03% to about 0.05% by mass, about 0.05% to about 0.07% by mass, or about 0.050% to about 0.075% by mass) of the one or more additional VOCs can be benzyl alcohol. In some embodiments, the one or more additional VOCs can include no benzyl alcohol.

The one or more additional VOCs in a Moscato-like alcoholic beverage can include beta-ionone. In some embodiments, the beta-ionone can be present in an amount of about 0.00006 mg/L to about 0.00015 mg/L (e.g., about 0.00006 to about 0.00008 mg/L, about 0.00008 to about 0.00010 mg/L, about 0.00010 to about 0.00012 mg/L, about 0.00012 to about 0.00014 mg/L, about 0.00010 to about 0.00015 mg/L, or about 0.00012 to about 0.00015 mg/L). In some embodiments, about 0.000002% to about 0.00015% by mass (e.g., about 0.000002% to about 0.000005% by mass, about 0.000005% to about 0.00001% by mass, about 0.00001% to about 0.00005% by mass, about 0.00005% to about 0.0001% by mass, or about 0.00010% to about 0.00015% by mass) of the one or more additional VOCs can be beta-ionone. In some embodiments, the one or more additional VOCs can include no beta-ionone.

The one or more additional VOCs in a Moscato-like alcoholic beverage can include butanol (also called butyl alcohol). In some embodiments, the butanol can be present in an amount of about 0.02 mg/L to about 0.6 mg/L (e.g., about 0.02 to about 0.05 mg/L, about 0.05 to about 0.1 mg/L, about 0.1 to about 0.2 mg/L, about 0.2 to about 0.3 mg/L, about 0.3 to about 0.4 mg/L, about 0.4 to about 0.5 mg/L, about 0.5 to about 0.6 mg/L, about 0.1 to about 0.5 mg/L, or about 0.1 to about 0.6 mg/L). In some embodiments, about 0.0008% to about 0.7% by mass (e.g., about 0.0008% to about 0.001% by mass, about 0.001% to about 0.005% by mass, about 0.005% to about 0.01% by mass, about 0.01% to about 0.05% by mass, about 0.05% to about 0.1% by mass, about 0.1% to about 0.2% by mass, about 0.2% to about 0.3% by mass, about 0.3% to about 0.4% by mass, about 0.4% to about 0.5% by mass, about 0.5% to about 0.6% by mass, about 0.6% to about 0.7% by mass, about 0.1% to about 0.5% by mass, or about 0.1 to about 0.7% by mass) of the one or more additional VOCs can be butanol. In some embodiments, the one or more additional VOCs can include no butanol.

The one or more additional VOCs in a Moscato-like alcoholic beverage can include butyl acetate. In some embodiments, the butyl acetate can be present in an amount of about 0.09 mg/L to about 0.20 mg/L (e.g., about 0.09 to about 0.10 mg/L, about 0.10 to about 0.12 mg/L, about 0.12 to about 0.15 mg/L, about 0.15 to about 0.18 mg/L, about 0.1 to about 0.2 mg/L, or about 0.18 to about 0.20 mg/L). In some embodiments, about 0.002% to about 0.25% by mass (e.g., about 0.002% to about 0.005% by mass, about 0.005% to about 0.01% by mass, about 0.01% to about 0.05% by mass, about 0.05% to about 0.1% by mass, about 0.1% to about 0.2% by mass, about 0.10% to about 0.15% by mass, about 0.15% to about 0.20% by mass, about 0.20% to about 0.25% by mass, or about 0.15% to about 0.15% by mass) of the one or more additional VOCs can be butyl acetate. In some embodiments, the one or more additional VOCs can include no butyl acetate.

The one or more additional VOCs in a Moscato-like alcoholic beverage can include butyl formate. In some embodiments, the butyl formate can be present in an amount of about 0.2 mg/L to about 1.8 mg/L (e.g., about 0.2 to about 0.4 mg/L, about 0.4 to about 0.6 mg/L, about 0.6 to about 0.8 mg/L, about 0.8 to about 1.0 mg/L, about 0.2 to about 0.5 mg/L, about 0.5 to about 1 mg/L, about 1.0 to about 1.5 mg/L, about 1.0 to about 1.8 mg/L, about 1.0 to about 1.2 mg/L, about 1.2 to about 1.4 mg/L, about 1.4 to about 1.6 mg/L, or about 1.6 to about 1.8 mg/L). In some embodiments, about 0.005% to about 2.2% by mass (e.g., about 0.005% to about 0.01% by mass, about 0.01% to about 0.05% by mass, about 0.05% to about 0.1% by mass, about 0.1% to about 0.5% by mass, about 0.5% to about 1% by mass, about 1.0% to about 1.5% by mass, about 1.5% to about 2.0% by mass, about 1% to about 2% by mass, about 1.5% to about 2.2% by mass, or about 2.0 to about 2.2% by mass) of the one or more additional VOCs can be butyl formate. In some embodiments, the one or more additional VOCs can include no butyl formate.

The one or more additional VOCs in a Moscato-like alcoholic beverage can include butyl isovalerate. In some embodiments, the butyl isovalerate can be present in an amount of about 0.0002 mg/L to about 0.0008 mg/L (e.g., about 0.0002 to about 0.0003 mg/L, about 0.0003 to about 0.0004 mg/L, about 0.0004 to about 0.0005 mg/L, about 0.0005 to about 0.0006 mg/L, about 0.0006 to about 0.0007 mg/L, or about 0.0007 to about 0.0008 mg/L). In some embodiments, about 0.000008% to about 0.001% by mass (e.g., about 0.000008% to about 0.00001% by mass, about 0.00001% to about 0.00005% by mass, about 0.00005% to about 0.0001% by mass, about 0.0001% to about 0.0005% by mass, or about 0.0005% to about 0.001% by mass) of the one or more additional VOCs can be butyl isovalerate. In some embodiments, the one or more additional VOCs can include no butyl isovalerate.

The one or more additional VOCs in a Moscato-like alcoholic beverage can include butyric acid. In some embodiments, the butyric acid can be present in an amount of about 0.001 mg/L to about 0.15 mg/L (e.g., about 0.001 to about 0.005 mg/L, about 0.005 to about 0.01 mg/L, about 0.01 to about 0.05 mg/L, about 0.05 to about 0.1 mg/L, about 0.10 to about 0.15 mg/L, or about 0.05 to about 0.15 mg/L). In some embodiments, about 0.0004% to about 0.15% by mass (e.g., about 0.0004% to about 0.001% by mass, about 0.0005% to about 0.001% by mass, about 0.001% to about 0.005% by mass, about 0.005% to about 0.01% by mass, about 0.01% to about 0.05% by mass, about 0.05% to about 0.1% by mass, about 0.10% to about 0.15% by mass, or about 0.05% to about 0.15% by mass) of the one or more additional VOCs can be butyric acid. In some embodiments, the one or more additional VOCs can include no butyric acid.

The one or more additional VOCs in a Moscato-like alcoholic beverage can include cinnamaldehyde. In some embodiments, the cinnamaldehyde can be present in an amount of about 0.00006 mg/L to about 0.0005 mg/L (e.g., about 0.00006 to about 0.0001 mg/L, about 0.0001 to about 0.0005 mg/L, about 0.0001 to about 0.0002 mg/L, about 0.0002 to about 0.0003 mg/L, about 0.0003 to about 0.0004 mg/L, or about 0.0004 to about 0.0005 mg/L). In some embodiments, about 0.000002% to about 0.0006% by mass (e.g., about 0.000002% to about 0.000005% by mass, about 0.000005% to about 0.00001% by mass, about 0.00001% to about 0.00005% by mass, about 0.00005% to about 0.0001% by mass, about 0.0001% to about 0.0005% by mass, about 0.0001% to about 0.0006% by mass, about 0.0001% to about 0.0002% by mass, about 0.0002% to about 0.0004% by mass, or about 0.0004% to about 0.0006% by mass) of the one or more VOCs can be cinnamaldehyde. In some embodiments, the one or more additional VOCs can include no cinnamaldehyde.

The one or more additional VOCs in a Moscato-like alcoholic beverage can include cis-3-hexen-1-ol. In some embodiments, the cis-3-hexen-1-ol can be present in an amount of about 0.03 mg/L to about 0.2 mg/L (e.g., about 0.03 to about 0.05 mg/L, about 0.05 to about 0.1 mg/L, or about 0.1 to about 0.2 mg/L). In some embodiments, about 0.0009% to about 0.2% by mass (e.g., about 0.0009% to about 0.001% by mass, about 0.001% to about 0.005% by mass, about 0.005% to about 0.01% by mass, about 0.01% to about 0.05% by mass, about 0.05% to about 0.1%, or about 0.1% to about 0.2% by mass) of the one or more additional VOCs can be cis-3-hexen-1-ol. In some embodiments, the one or more additional VOCs can include no cis-3-hexen-1-ol.

The one or more additional VOCs in a Moscato-like alcoholic beverage can include cis-3-hexenyl acetate. In some embodiments, the cis-3-hexenyl acetate can be present in an amount of about 0.001 mg/L to about 0.015 mg/L (e.g., about 0.001 to about 0.005 mg/L, about 0.005 to about 0.007 mg/L, about 0.007 to about 0.009 mg/L, about 0.009 to about 0.011 mg/L, about 0.011 to about 0.013 mg/L, about 0.005 to about 0.01 mg/L, about 0.010 to about 0.015 mg/L, or about 0.013 to about 0.015 mg/L). In some embodiments, about 0.00003% to about 0.02% by mass (e.g., about 0.00003% to about 0.00005%, about 0.00005% to about 0.0001% by mass, about 0.0001% to about 0.0005% by mass, about 0.0005% to about 0.001% by mass, about 0.001% to about 0.005% by mass, about 0.005% to about 0.01% by mass, or about 0.01% to about 0.02% by mass) of the one or more additional VOCs can be cis-3-hexenyl acetate. In some embodiments, the one or more additional VOCs can include no cis-3-hexenyl acetate.

The one or more additional VOCs in a Moscato-like alcoholic beverage can include citral. In some embodiments, the citral can be present in an amount of about 0.005 mg/L to about 0.01 mg/L (e.g., about 0.005 to about 0.006 mg/L, about 0.006 to about 0.007 mg/L, about 0.007 to about 0.008 mg/L, about 0.008 to about 0.009 mg/L, or about 0.009 to about 0.01 mg/L). In some embodiments, about 0.0001% to about 0.015% by mass (e.g., about 0.0001% to about 0.0005% by mass, about 0.0005% to about 0.001% by mass, about 0.001% to about 0.005% by mass, about 0.005% to about 0.01% by mass, about 0.010% to about 0.015% by mass, or about 0.005% to about 0.015% by mass) of the one or more additional VOCs can be citral. In some embodiments, the one or more additional VOCs can include no citral.

The one or more additional VOCs in a Moscato-like alcoholic beverage can include cis-whiskey lactone (also called whiskey lactone). In some embodiments, the cis-whiskey lactone can be present in an amount of about 0.0006 mg/L to about 0.008 mg/L (e.g., about 0.0006 to about 0.001 mg/L, about 0.001 to about 0.005 mg/L, about 0.001 to about 0.008 mg/L, about 0.005 to about 0.008 mg/L, about 0.001 to about 0.002 mg/L, about 0.002 to about 0.004 mg/L, about 0.004 to about 0.006 mg/L, or about 0.006 to about 0.008 mg/L). In some embodiments, about 0.00001% to about 0.009% by mass (e.g., about 0.00001% to about 0.00005% by mass, about 0.00005% to about 0.0001% by mass, about 0.0001% to about 0.0005% by mass, about 0.0005% to about 0.001% by mass, about 0.001% to about 0.005% by mass, about 0.001% to about 0.009% by mass, about 0.005% to about 0.009% by mass, about 0.001% to about 0.003% by mass, about 0.003% to about 0.005% by mass, about 0.005% to about 0.007% by mass, or about 0.007% to about 0.009% by mass) of the one or more additional VOCs can be cis-whiskey lactone. In some embodiments, the one or more additional VOCs can include no cis-whiskey lactone.

The one or more additional VOCs in a Moscato-like alcoholic beverage can include citronellol. In some embodiments, the citronellol can be present in an amount of 0.00007 mg/L to about 0.2 mg/L (e.g., about 0.00007 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, or about 0.1 to about 0.2 mg/L). In some embodiments, the citronellol can be present in an amount of at least about 0.01 mg/L (e.g., at least about 0.015 mg/L, 0.02 mg/L, 0.03 mg/L, 0.04 mg/L 0.05 mg/L, 0.06 mg/L, 0.07 mg/L, 0.08 mg/L, 0.09 mg/L, or 0.1 mg/L). In some embodiments, about 0.000002% to about 0.25% by mass (e.g., about 0.000002% to about 0.000005% by mass, about 0.000005% to about 0.00001% by mass, about 0.00001% to about 0.00005% by mass, about 0.00005% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% to about 0.05% by mass, about 0.05% to about 0.1% by mass, about 0.1% to about 0.2% by mass, about 0.10% to about 0.15% by mass, about 0.15% to about 0.20% by mass, about 0.20% to about 0.25% by mass, about 0.05% to about 0.15% by mass, or about 0.15% to about 0.25% by mass) of the one or more additional VOCs can be citronellol. In some embodiments, at least 0.012% by mass (e.g., at least about 0.013%, 0.014%, 0.015%, 0.016%, 0.017%, 0.018%, 0.019%, 0.02%, 0.03%, 0.04%, 0.05%, 0.06%, 0.07%, 0.08%, or 0.09% by mass) of the one or more additional VOCs can be citronellol. In some embodiments, the one or more additional VOCs can include no citronellol.

The one or more additional VOCs in a Moscato-like alcoholic beverage can include damascenone. In some embodiments, the damascenone can be present in an amount of about 0.007 mg/L to about 1.2 mg/L (e.g., about 0.007 to about 0.01 mg/L, about 0.01 to about 0.02 mg/L, about 0.02 to about 0.05 mg/L, about 0.05 to about 0.1 mg/L, about 0.1 to about 0.2 mg/L, about 0.20 to about 0.5 mg/L, about 0.5 to about 1 mg/L, about 0.5 to about 0.7 mg/L, about 0.7 to about 1.0 mg/L, or about 1.0 mg/L to about 1.2 mg/L). In some embodiments, about 0.009% to about 1.5% by mass (e.g., about 0.005% to about 0.01% by mass, about 0.01% to about 0.05% by mass, about 0.05% to about 0.1% by mass, about 0.1% to about 0.5% by mass, about 0.5% to about 1%, or about 1.0% to about 1.5% by mass) of the one or more additional VOCs can be damascenone. In some embodiments, the one or more additional VOCs can include no damascenone.

The one or more additional VOCs in a Moscato-like alcoholic beverage can include damascone. In some embodiments, the damascone can be present in an amount of about 0.5 mg/L to about 1.1 mg/L (e.g., about 0.5 to about 0.6 mg/L, about 0.6 to about 0.8 mg/L, about 0.7 to about 0.8 mg/L, about 0.8 to about 0.9 mg/L, about 0.9 to about 1.0 mg/L, about 0.5 to about 1 mg/L, or about 1.0 to about 1.1 mg/L). In some embodiments, about 0.01% to about 1.5% by mass (e.g., about 0.01% to about 0.05% by mass, about 0.05% to about 0.1% by mass, about 0.1% to about 0.5% by mass, about 0.5% to about 1%, or about 1.0% to about 1.5% by mass) of the one or more additional VOCs can be damascone. In some embodiments, the one or more additional VOCs can include no damascone.

The one or more additional VOCs in a Moscato-like alcoholic beverage can include D-camphor. In some embodiments, the D-camphor can be present in an amount of about 0.01 mg/L to about 0.03 mg/L (e.g., about 0.01 to about 0.02 mg/L or about 0.02 to about 0.03 mg/L). In some embodiments, about 0.0003% to about 0.03% by mass (e.g., about 0.0003% to about 0.0005% by mass, about 0.0005% to about 0.001% by mass, about 0.001% to about 0.005% by mass, about 0.005% to about 0.01% by mass, about 0.01% to about 0.03% by mass, about 0.01% to about 0.02% by mass, or about 0.02% to about 0.03% by mass) of the one or more additional VOCs can be D-camphor. In some embodiments, the one or more additional VOCs can include no D-camphor.

The one or more additional VOCs in a Moscato-like alcoholic beverage can include decanoic acid. In some embodiments, the decanoic acid can be present in an amount of about 0.003 mg/L to about 3.0 mg/L (e.g., about 0.003 to about 0.01 mg/L, about 0.01 mg/L to about 0.05 mg/L, about 0.050 to about 0.1 mg/L, about 0.1 to about 0.5 mg/L, about 0.5 to about 1.0 mg/L, about 1.0 to about 1.5 mg/L, about 1.5 to about 2.0 mg/L, about 2.0 to about 2.5 mg/L, about 1 to about 3 mg/L, about 1 to about 2 mg/L, about 2 to about 3 mg/L, or about 2.5 to about 3.0 mg/L). In some embodiments, the decanoic acid is present in an amount of at least about 0.6 mg/L (e.g., at least about 0.7 mg/L, 0.8 mg/L, 0.9 mg/L, 1.0 mg/L, 1.5 mg/L, or 2.0 mg/L). In some embodiments, about 0.0001% to about 2.2% by mass (e.g., about 0.0001% to about 0.0005% by mass, 0.0005% to about 0.001% by mass, about 0.001% to about 0.005% by mass, about 0.005% to about 0.01% by mass, about 0.01% to about 0.05% by mass, about 0.05% to about 0.1% by mass, about 0.1% to about 0.5% by mass, about 0.5% to about 1.0% by mass, about 1.0% to about 1.5% by mass, about 1.5% to about 2.0% by mass, about 1% to about 2% by mass, or about 1.5% to about 2.2% by mass) of the one or more additional VOCs can be decanoic acid. In some embodiments, at least about 0.7% by mass (e.g., at least 0.8%, 0.9%, 1.0%, 1.1%, 1.2%, 1.3%, 1.4%, or 1.5% by mass) of the one or more additional VOCs can be decanoic acid.

The one or more additional VOCs in a Moscato-like alcoholic beverage can include delta-decalactone. In some embodiments, the delta-decalactone can be present in an amount of about 0.0001 mg/L to about 0.013 mg/L (e.g., about 0.0001 to about 0.0005 mg/L, about 0.0005 to about 0.001 mg/L, about 0.001 to about 0.005 mg/L, about 0.005 to about 0.010 mg/L, or about 0.010 mg/L to about 0.013 mg/L). In some embodiments, the delta-decalactone can be present in an amount of at least about 0.007 mg/L (e.g., at least about 0.008 mg/L, 0.009 mg/L, or 0.01 mg/L). In some embodiments, about 0.000004% to about 0.01% by mass (e.g., about 0.000004% to about 0.00001% by mass, about 0.00001% to about 0.00005% by mass, about 0.00005% to about 0.0001% by mass, about 0.0001% to about 0.0005% by mass, about 0.0005% to about 0.001% by mass, about 0.001% to about 0.005% by mass, or about 0.005% to about 0.01% by mass) of the one or more additional VOCs can be delta-decalactone.

The one or more additional VOCs in a Moscato-like alcoholic beverage can include diethyl malate. In some embodiments, the diethyl malate can be present in an amount of about 0.1 mg/L to about 45 mg/L (e.g., about 0.1 to about 0.3 mg/L, about 0.1 to about 0.4 mg/L, about 0.1 to about 0.5 mg/L, about 0.5 to about 1 mg/L, about 1 to about 5 mg/L, about 5 to about 10 mg/L, about 10 to about 20 mg/L, about 20 to about 30 mg/L, about 30 to about 40 mg/L, or about 40 to about 45 mg/L). In some embodiments, the diethyl malate can be present in an amount of less than about 0.35 mg/L (e.g., less than about 0.34 mg/L, 0.33 mg/L, 0.32 mg/L, 0.31 mg/L, 0.30 mg/L, 0.25 mg/L, 0.20 mg/L, or 0.15 mg/L). In some embodiments, about 0.01% to about 40% by mass (e.g., about 0.01% to about 0.05% by mass, about 0.05% to about 0.1% by mass, about 0.1% to about 0.2% by mass, about 0.1% to about 0.5% by mass, about 0.5% to about 1% by mass, about 1% to about 5% by mass, about 5% to about 10% by mass, about 10% to about 15% by mass, about 15% to about 20% by mass, about 20% to about 25% by mass, about 25% to about 30% by mass, about 30% to about 35% by mass, or about 35% to about 40% by mass) of the one or more additional VOCs can be diethyl malate. In some embodiments, the one or more additional VOCs can include no diethyl malate.

The one or more additional VOCs in a Moscato-like alcoholic beverage can include diethyl succinate. In some embodiments, the diethyl succinate can be present in an amount of about 0.02 mg/L to about 2.1 mg/L (e.g., about 0.02 to about 0.05 mg/L, about 0.05 to about 0.1 mg/L, about 0.1 to about 0.2 mg/L, about 0.2 to about 0.5 mg/L, about 0.5 to about 0.7 mg/L, about 0.7 to about 1.0 mg/L, about 1.0 to about 1.5 mg/L, about 1 to about 2 mg/L, about 1.5 to about 2.0 mg/L, or about 1.5 to about 2.1 mg/L). In some embodiments, the diethyl succinate can be present in an amount of less than about 0.4 mg/L (e.g., less than about 0.35 mg/L, 0.3 mg/L, 0.2 mg/L, 0.1 mg/L, or 0.05 mg/L). In some embodiments about 0.015% to about 2.5% by mass (e.g., about 0.015% to about 0.02% by mass, about 0.02% to about 0.05% by mass, about 0.05% to about 0.1% by mass, about 0.1% to about 0.2% by mass, about 0.2% to about 0.3% by mass, about 0.3% to about 0.4% by mass, about 0.4% to about 0.5% by mass, about 0.5% to about 1% by mass, about 1% to about 2% by mass, about 1.0 to about 1.5% by mass, about 1.5% to about 2.0% by mass, about 2.0% to about 2.5% by mass, about 0.5% to about 1.5% by mass, or about 1.5% to about 2.5% by mass) of the one or more additional VOCs can be diethyl succinate.

The one or more additional VOCs in a Moscato-like alcoholic beverage can include dimethyl sulfide. In some embodiments, the dimethyl sulfide can be present in an amount of about 0.006 mg/L to about 0.021 mg/L (e.g., about 0.006 to about 0.010 mg/L, about 0.010 to about 0.015 mg/L, about 0.015 to about 0.020 mg/L, or about 0.015 to about 0.021 mg/L). In some embodiments, about 0.0002% to about 0.025% by mass (e.g., about 0.0002% to about 0.0005% by mass, about 0.0005% to about 0.001% by mass, about 0.001% to about 0.002% by mass, about 0.002% to about 0.005% by mass, about 0.005% to about 0.01% by mass, about 0.01% to about 0.02% by mass, about 0.010% to about 0.015% by mass, about 0.015% to about 0.020% by mass, about 0.020% to about 0.025% by mass, about 0.005% to about 0.015% by mass, or about 0.015% by mass to about 0.025% by mass) of the one or more additional VOCs can be dimethyl sulfide. In some embodiments, the one or more additional VOCs can include no dimethyl sulfide. The one or more additional VOCs in a Moscato-like alcoholic beverage can include DL-3-methyl-2-butanol (also called 3-methyl-2-butanol). In some embodiments, the DL-3-methyl-2-butanol can be present in an amount of about 0.015 mg/L to about 0.035 mg/L (e.g., about 0.015 to about 0.025 mg/L, about 0.025 to about 0.025 mg/L, or about 0.02 to about 0.03 mg/L). In some embodiments, about 0.0005% to about 0.04% by mass (e.g., about 0.0005% to about 0.001% by mass, about 0.001% to about 0.005% by mass, about 0.005% to about 0.01% by mass, about 0.01% to about 0.04% by mass, about 0.01% to about 0.02% by mass, about 0.02% to about 0.03% by mass, or about 0.03% to about 0.04% by mass) of the one or more additional VOCs can be DL-3-methyl-2-butanol. In some embodiments, the one or more additional VOCs can include no DL-3-methyl-2-butanol.

The one or more additional VOCs in a Moscato-like alcoholic beverage can include ethyl 3-hydroxyhexanoate. In some embodiments, the ethyl 3-hydroxyhexanoate can be present in an amount of about 0.001 mg/L to about 0.004 mg/L (e.g., about 0.001 to about 0.002 mg/L, about 0.002 to about 0.003 mg/L, or about 0.003 to about 0.004 mg/L). In some embodiments, about 0.00005% to about 0.004% by mass (e.g., about 0.00005% to about 0.0001% by mass, about 0.0001% to about 0.0005% by mass, about 0.0005% to about 0.001% by mass, about 0.001% to about 0.004% by mass, about 0.001% to about 0.004% by mass, about 0.001% to about 0.002% by mass, about 0.002% to about 0.003% by mass, or about 0.003% to about 0.004% by mass) of the one or more additional VOCs can be ethyl 3-hydroxyhexanoate. In some embodiments, the one or more additional VOCs can include no ethyl 3-hydroxyhexanoate.

The one or more additional VOCs in a Moscato-like alcoholic beverage can include ethyl acetate. In some embodiments, the ethyl acetate is present in an amount of about 0.6 mg/L to about 240 mg/L (e.g., about 0.6 to about 0.7 mg/L, about 0.7 to about 0.8 mg/L, 0.8 to about 0.9 mg/L, 0.9 to about 1 mg/L, about 0.6 to about 1 mg/L, about 1.0 to about 1.2 mg/L, about 1.2 to about 1.5 mg/L, about 1.5 to about 2.0 mg/L, about 2.0 to about 5 mg/L, about 5 to about 10 mg/L, about 10 to about 25 mg/L, about 25 to about 50 mg/L, about 50 to about 75 mg/L, about 75 to about 100 mg/L, about 100 to about 125 mg/L, about 125 to about 150 mg/L, about 150 to about 175 mg/L, about 175 to about 200 mg/L, about 200 to about 225 mg/L, or about 200 to about 240 mg/L). In some embodiments, the ethyl acetate is present in an amount of less than about 7 mg/L (e.g., less than 6 mg/L, 5 mg/L, 4 mg/L, 3 mg/L, 2 mg/L, or 1 mg/L). In some embodiments, about 0.3% to about 90% by mass (e.g. about 0.3% to about 0.5% by mass, about 0.5% to about 0.7% by mass, about 0.7% to about 0.9% by mass, about 0.9% to about 1.1% by mass, about 1% to about 2% by mass, about 2% to about 3% by mass, about 3% to about 4% by mass, about 4% to about 5% by mass, about 5% by mass to about 10% by mass, about 10% to about 20% by mass, about 20% to about 30% by mass, about 30% to about 40% by mass, about 40% to about 50% by mass, about 50% to about 60% by mass, about 60% to about 70% by mass, about 70% to about 80% by mass, or about 80% to about 90% by mass) of the one or more additional VOCs can be ethyl acetate. In some embodiments, the one or more additional VOCs can include no ethyl acetate.

The one or more additional VOCs in a Moscato-like alcoholic beverage can include ethyl benzoate. In some embodiments, the ethyl benzoate can be present in an amount of 0.00004 mg/L to about 0.006 mg/L (e.g., about 0.00004 to about 0.00005 mg/L, about 0.00005 to about 0.0001 mg/L, about 0.0001 to about 0.0005 mg/L, about 0.0005 to about 0.001 mg/L, about 0.001 to about 0.005 mg/L, about 0.001 to about 0.006 mg/L, about 0.001 to about 0.002 mg/L, about 0.002 to about 0.004 mg/L, or about 0.004 to about 0.006 mg/L). In some embodiments, about 0.000001% to about 0.007% by mass (e.g., about 0.000001% to about 0.000005% by mass, about 0.000005% to about 0.00001% by mass, about 0.00001% to about 0.00005% by mass, about 0.00005% to about 0.0001% by mass, about 0.0001% to about 0.0005% by mass, about 0.0005% to about 0.001% by mass, about 0.001% to about 0.005% by mass, about 0.001% to about 0.007% by mass, about 0.001% to about 0.003% by mass, about 0.003% to about 0.005% by mass, or about 0.005% to about 0.007% by mass) of the one or more additional VOCs can be ethyl benzoate. In some embodiments, the one or more additional VOCs can include no ethyl benzoate.

The one or more additional VOCs in a Moscato-like alcoholic beverage can include ethyl butanoate (also called ethyl butyrate). In some embodiments, the ethyl butanoate can be present in an amount of about 0.03 mg/L to about 20 mg/L (e.g., about 0.03 to about 0.1 mg/L, about 0.1 to about 0.2 mg/L, about 0.2 to about 0.5 mg/L, about 0.5 to about 1 mg/L, about 1 to about 2 mg/L, about 2 to about 5 mg/L, about 5 to about 7 mg/L, about 7 to about 10 mg/L, about 10 to about 12 mg/L, about 12 to about 15 mg/L, about 15 to about 17 mg/L, or about 17 to about 20 mg/L). In some embodiments, the ethyl butanoate can be present in an amount of at least about 0.5 mg/L (e.g., at least about 0.6 mg/L, 0.7 mg/L, 0.8 mg/L, 0.9 mg/L, 1.0 mg/L, 1.5 mg/L, 2.0 mg/L, 2.5 mg/L, 3.0 mg/L, 4.0 mg/L, 5.0 mg/L, 6.0 mg/L, 7.0 mg/L, 8.0 mg/L, 9.0 mg/L, 10.0 mg/L, 11.0 mg/L, 12.0 mg/L, 13.0 mg/L, or 14.0 mg/L). In some embodiments, about 0.001% to about 15% by mass (e.g., about 0.002% to about 0.005% by mass, about 0.005% to about 0.01% by mass, about 0.01% to about 0.02% by mass, about 0.02% to about 0.05% by mass, about 0.05% to about 0.1% by mass, about 0.1% to about 0.2% by mass, about 0.2% to about 0.5% by mass, about 0.5% to about 1% by mass, about 1% to about 2% by mass, about 2% to about 4% by mass, about 4% to about 6% by mass, about 6% to about 8% by mass, about 8% to about 10% by mass, about 10% to about 12% by mass, about 10% to about 12% by mass, about 12% to about 14% by mass, or about 12% to about 15% by mass) of the one or more additional VOCs can be ethyl butanoate. In some embodiments, at least about 0.6% by mass (e.g., at least about 0.7%, 0.8%, 0.9%, 1%, 2%, 3%, 4%, 5%, 6%, 7%, 8%, 9%, or 10% by mass) of the one or more additional VOCs can be ethyl butanoate.

The one or more additional VOCs in a Moscato-like alcoholic beverage can include ethyl cinnamate. In some embodiments, the ethyl cinnamate can be present in an amount of 0.00002 mg/L to about 0.00004 mg/L (e.g., about 0.00002 to about 0.00003 mg/L or about 0.00003 to about 0.00004 mg/L). In some embodiments, about 0.000006% to about 0.00005% by mass (e.g., about 0.0000006% to about 0.000001% by mass, about 0.000001% to about 0.000005% by mass, about 0.000005% to about 0.00001% by mass, about 0.00001% to about 0.00002% by mass, about 0.00002% to about 0.00003% by mass, about 0.00003% to about 0.00004% by mass, about 0.00004% to about 0.00005% by mass, or about 0.00001% to about 0.00005% by mass) of the one or more additional VOCs can be ethyl cinnamate. In some embodiments, the one or more additional VOCs can include no ethyl cinnamate.

The one or more additional VOCs in a Moscato-like alcoholic beverage can include ethyl decanoate. In some embodiments, the ethyl decanoate can be present in an amount from about 0.002 mg/L to about 2 mg/L (e.g., about 0.002 to about 0.005 mg/L, about 0.005 to about 0.01 mg/L, about 0.01 to about 0.02 mg/L, about 0.02 to about 0.05 mg/L, about 0.05 to about 0.1 mg/L, about 0.1 to about 0.2 mg/L, about 0.2 to about 0.3 mg/L, about 0.3 to about 0.4 mg/L, about 0.4 to about 0.5 mg/L, about 0.1 to about 0.5 mg/L, about 0.5 to about 1 mg/L, about 1 to about 2 mg/L, about 1.0 to about 1.5 mg/L, or about 1.5 to about 2.0 mg/L). In some embodiments, about 0.00006% to about 2.2% by mass (e.g., about 0.00006% to about 0.0001% by mass, 0.0001% to about 0.0002% by mass, about 0.0002% to about 0.0005% by mass, about 0.0005% to about 0.001% by mass, about 0.001% to about 0.005% by mass, about 0.005% to about 0.01% by mass, about 0.01% to about 0.05% by mass, about 0.05% to about 0.1% by mass, about 0.1% to about 0.2% by mass, about 0.2% to about 0.3% by mass, about 0.3% to about 0.4% by mass, about 0.4% to about 0.5% by mass, about 0.1% to about 0.5% by mass, about 0.5% to about 1% by mass, about 1% to about 2% by mass, about 1.0% to about 2.2% by mass, about 1.0% to about 1.5% by mass, about 1.5% to about 2.0% by mass, or about 1.5% to about 2.2% by mass) of the one or more additional VOCs can be ethyl decanoate.

The one or more additional VOCs in a Moscato-like alcoholic beverage can include ethyl hexanoate. In some embodiments, the ethyl hexanoate can be present in an amount of about 0.2 mg/L to about 2.7 mg/L (e.g., about 0.2 to about 0.4 mg/L, about 0.4 to about 0.6 mg/L, about 0.6 to about 0.8 mg/L, about 0.8 to about 1.0 mg/L, about 1.0 to about 1.5 mg/L, about 1.5 to about 2.0 mg/L, about 1 to about 2 mg/L about 2.0 to about 2.5 mg/L, or about 2.0 to about 2.7 mg/L). In some embodiments, about 0.005% to about 3.1% by mass (e.g., about 0.005% to about 0.02% by mass, about 0.02% to about 0.05% by mass, about 0.05% to about 0.1% by mass, about 0.1% to about 0.5% by mass, about 0.5% to about 1.0% by mass, about 1.0% to about 1.5% by mass, about 1.5% to about 2.0% by mass, about 2.0% to about 2.5% by mass, about 1% to about 2% by mass, about 2% to about 3% by mass, about 1% to about 3% by mass, about 2.5% to about 3.0% by mass, or about 2.5% to about 3.1% by mass) of the one or more additional VOCs can be ethyl hexanoate.

The one or more additional VOCs in a Moscato-like alcoholic beverage can include ethyl isobutyrate. In some embodiments, the ethyl isobutyrate can be present in an amount of about 0.02 mg/L to about 0.9 mg/L (e.g., about 0.02 to about 0.05 mg/L, about 0.05 to about 0.1 mg/L, about 0.1 to about 0.2 mg/L, about 0.2 to about 0.3 mg/L, about 0.3 to about 0.4 mg/L, about 0.4 to about 0.5 mg/L, about 0.5 to about 0.6 mg/L, about 0.6 to about 0.7 mg/L, about 0.7 to about 0.8 mg/L, about 0.8 to about 0.9 mg/L, about 0.1 to about 0.5 mg/L, or about 0.1 to about 0.9 mg/L). In some embodiments, the ethyl isobutyrate is present in an amount of at least about 0.3 mg/L (e.g., at least about 0.35 mg/L, 0.4 mg/L, 0.5 mg/L, 0.6 mg/L, 0.7 mg/L, or 0.8 mg/L). In some embodiments, about 0.0008% to about 1% by mass (e.g., about 0.0008% to about 0.001%, about 0.001% to about 0.005% by mass, about 0.005% to about 0.01% by mass, about 0.01% to about 0.05% by mass, about 0.05% to about 0.1% by mass, about 0.1% to about 0.5% by mass, about 0.5% to about 1% by mass, about 0.1% to about 0.2% by mass, about 0.2% to about 0.4% by mass, about 0.4% to about 0.6% by mass, about 0.6% to about 0.8% by mass, or about 0.8% to about 1% by mass) of the one or more additional VOCs can be ethyl isobutyrate. In some embodiments, at least about 0.36% by mass (e.g., at least about 0.37%, 0.38%, 0.39%, 0.4%, 0.5%, 0.6%, 0.7%, 0.8%, or 0.9% by mass) of the one or more additional VOCs can be ethyl isobutyrate.

The one or more additional VOCs in a Moscato-like alcoholic beverage can include ethyl isovalerate. In some embodiments, the ethyl isovalerate can be present in an amount of about 0.001 mg/L to about 3.5 mg/L (e.g., about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1.0 mg/L, about 1.0 to about 1.5 mg/L, about 1.5 to about 2.0 mg/L, about 2.0 to about 2.5 mg/L, about 2.5 to about 3.0 mg/L, about 1 to about 2 mg/L, about 2 to about 3 mg/L, about 1 to about 3 mg/L, or about 3.0 to about 3.5 mg/L). In some embodiments, the ethyl isovalerate can be present in an amount of at least about 0.07 mg/L (e.g., at least about 0.08 mg/L, 0.09 mg/L, 0.1 mg/L, 0.2 mg/L, 0.3 mg/L, 0.4 mg/L, 0.5 mg/L, 1 mg/L, 1.5 mg/L, 2 mg/L, 2.5 mg/L, or 3 mg/L). In some embodiments, about 0.00003% to about 2.5% by mass (e.g., about 0.00003% to about 0.0001% by mass, 0.0001% to about 0.0005% by mass, 0.0005% to about 0.001% by mass, about 0.001% to about 0.005% by mass, about 0.005% to about 0.01% by mass, about 0.01% to about 0.05% by mass, about 0.05% to about 0.1% by mass, about 0.1% to about 0.5% by mass, about 0.5% to about 1.0% by mass, about 1.0% to about 1.5% by mass, about 1.5% to about 2.0% by mass, about 1% to about 2% by mass, or about 2.0% to about 2.5% by mass) of the one or more additional VOCs can be ethyl isovalerate. In some embodiments, at least about 0.09% by mass (e.g., at least about 0.1%, 0.2%, 0.3%, 0.4%, 0.5%, 1%, 1.5%, or 2.0% by mass) of the one or more additional VOCs can be ethyl isovalerate. In some embodiments, the one or more additional VOVs can include no ethyl isovalerate.

The one or more additional VOCs in a Moscato-like alcoholic beverage can include ethyl lactate. In some embodiments, the ethyl lactate can be present in an amount of about 0.5 mg/L to about 13 mg/L, (e.g., about 0.5 to about 0.8 mg/L, 0.5 to about 1.0 mg/L, about 1.0 to about 1.5 mg/L, about 1.5 to about 2.0 mg/L, about 2.0 to about 2.5 mg/L, about 2.5 to about 3 mg/L, about 3.0 to about 3.5 mg/L, about 3.5 to about 4 mg/L, about 4 to about 5 mg/L, about 5 to about 7 mg/L, about 7 to about 9 mg/L, about 9 to about 11 mg/L, or about 11 to about 13 mg/L). In some embodiments, the ethyl lactate is present in an amount of less than about 2 mg/L (e.g., less than about 1.5 mg/L or 1.0 mg/L). In some embodiments, about 0.08% to about 14% by mass (e.g., about 0.08% to about 0.1% by mass, about 0.1% to about 0.5% by mass, about 0.5% to about 1% by mass, about 1% to about 2% by mass, about 2% to about 4% by mass, about 4% to about 6% by mass, about 6% to about 8% by mass, about 8% to about 10% by mass, about 10% to about 12% by mass, about 12% to about 14% by mass, about 1% to about 5% by mass, about 5% to about 10% by mass, or about 10% to about 14% by mass) of the one or more additional VOCs can be ethyl lactate.

The one or more additional VOCs in a Moscato-like alcoholic beverage can include ethyl laurate. In some embodiments, the ethyl laurate can be present in an amount of about 0.002 mg/L to about 0.15 mg/L (e.g., about 0.002 to about 0.005 mg/L, about 0.005 mg/L to about 0.01 mg/L, about 0.01 to about 0.05 mg/L, about 0.05 to about 0.07 mg/L, about 0.07 to about 0.09 mg/L, about 0.09 to about 0.11 mg/L, about 0.11 to about 0.13 mg/L, about 0.13 to about 0.15 mg/L, about 0.05 to about 0.10 mg/L, or about 0.10 to about 0.15 mg/L). In some embodiments, about 0.00007% to about 0.15% by mass (e.g., about 0.00007% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% to about 0.05% by mass, about 0.05% to about 0.1% by mass, about 0.10% to about 0.15% by mass, or about 0.05% to about 0.15% by mass) of the one or more additional VOCs can be ethyl laurate.

The one or more additional VOCs in a Moscato-like alcoholic beverage can include ethyl levulinate. In some embodiments, the ethyl levulinate can be present in an amount of about 0.002 mg/L to about 0.005 mg/L (e.g., about 0.002 to about 0.003 mg/L, about 0.003 to about 0.004 mg/L, or about 0.004 to about 0.005 mg/L). In some embodiments, 0.00005% to about 0.006% by mass (e.g., about 0.00005% to about 0.0001% by mass, about 0.0001% to about 0.0005% by mass, about 0.0005% to about 0.001% by mass, about 0.001% to about 0.005% by mass, about 0.001% to about 0.006% by mass, about 0.001% to about 0.002% by mass, about 0.002% to about 0.004% by mass, or about 0.004% to about 0.006% by mass) of the one or more additional VOCs can include ethyl levulinate. In some embodiments, the one or more additional VOCs can include no ethyl levulinate.

The one or more additional VOCs in a Moscato-like alcoholic beverage can include ethyl myristate. In some embodiments, the ethyl myristate can be present in an amount of about 0.00004 mg/L to about 0.06 mg/L (e.g., about 0.00004 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.02 mg/L, about 0.02 to about 0.03 mg/L, about 0.03 to about 0.4 mg/L, about 0.4 to about 0.5 mg/L, about 0.5 to about 0.6 mg/L, about 0.4 to about 0.6 mg/L, about 0.1 to about 0.5 mg/L, or about 0.1 to about 0.6 mg/L). In some embodiments, the ethyl myristate can be present in an amount of at least about 0.45 mg/L (e.g., at least about 0.46 mg/L, 0.47 mg/L, 0.48 mg/L, 0.49 mg/L, 0.5 mg/L, or 0.55 mg/L). In some embodiments, about 0.000001% to about 0.07% by mass (e.g., about 0.000001% to about 0.000005% by mass, about 0.000005% to about 0.00001% by mass, about 0.00001% to about 0.00005% by mass, about 0.00005% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% to about 0.05% by mass, about 0.01% to about 0.07% by mass, about 0.01% to about 0.03% by mass, about 0.03% to about 0.05% by mass, or about 0.05% to about 0.07% by mass) of the one or more additional VOCs can be ethyl myristate. In some embodiments, the one or more additional VOCs can include no ethyl myristate.

The one or more additional VOCs in a Moscato-like alcoholic beverage can include ethyl nonanoate. In some embodiments, the ethyl nonanoate can be present in an amount of about 0.0001 mg/L to about 0.003 mg/L (e.g., about 0.0001 to about 0.0005 mg/L, about 0.0005 to about 0.001 mg/L, about 0.001 to about 0.003 mg/L, about 0.001 to about 0.002 mg/L, or about 0.002 to about 0.003 mg/L). In some embodiments, about 0.000004% to about 0.003% by mass (e.g., about 0.000004% to about 0.00001% by mass, about 0.00001% to about 0.00002% by mass, about 0.00002% to about 0.00005% by mass, about 0.00005% to about 0.0001% by mass, about 0.0001% to about 0.0005% by mass, about 0.0005% to about 0.001% by mass, about 0.001% to about 0.003% by mass, about 0.001% to about 0.002% by mass, or about 0.002% to about 0.003% by mass) of the one or more additional VOCs can be ethyl nonanoate. In some embodiments, the one or more additional VOCs can include no ethyl nonanoate.

The one or more additional VOCs in a Moscato-like alcoholic beverage can include ethyl octanoate. In some embodiments, the ethyl octanoate can be present in an amount of about 0.3 mg/L to about 9 mg/L (e.g., about 0.3 to about 0.5 mg/L, about 0.5 to about 1 mg/L, about 0.3 to about 1 mg/L, about 0.3 to about 0.8 mg/L, about 0.8 to about to about 1.0 mg/L, about 1.0 to about 1.5 mg/L, about 1.5 to about 2.0 mg/L, about 2.0 to about 2.5 mg/L, about 2.5 to about 3 mg/L, about 3 to about 4 mg/L, about 4 to about 5 mg/L, about 5 to about 6 mg/L, about 6 to about 7 mg/L, about 7 to about 8 mg/L, or about 8 to about 9 mg/L). In some embodiments, about 0.01% to about 10% by mass (e.g., 0.01% to about 0.05% by mass, about 0.05% to about 0.1% by mass, 0.1% to about 0.5% by mass, about 0.1 to about 1% by mass, about 0.5% to about 1% by mass, about 1% to about 2% by mass, about 2% to about 4% by mass, about 4% to about 6% by mass, about 6% to about 8% by mass, about 8% to about 10% by mass, about 1% to about 5% by mass, or about 5% to about 10% by mass) of the one or more additional VOCs can be ethyl octanoate.

The one or more additional VOCs in a Moscato-like alcoholic beverage can include ethyl palmitate. In some embodiments, the ethyl palmitate can be present in an amount of about 0.007 mg/L to about 0.025 mg/L (e.g., about 0.007 to about 0.010 mg/L, about 0.010 to about 0.015 mg/L, about 0.015 to about 0.020 mg/L, about 0.020 to about 0.025 mg/L, about 0.01 to about 0.02 mg/L, or about 0.015 to about 0.025 mg/L). In some embodiments, about 0.0002% to about 0.03% by mass (e.g., about 0.0002% to about 0.0005% by mass, about 0.0005% to about 0.001% by mass, about 0.001% to about 0.005% by mass, about 0.005% to about 0.01% by mass, about 0.01% to about 0.02% by mass, about 0.02% to about 0.03% by mass, or about 0.01% to about 0.03% by mass) of the one or more VOCs can be ethyl palmitate. In some embodiments, the one or more additional VOCs may include no ethyl palmitate.

The one or more additional VOCs in a Moscato-like alcoholic beverage can include ethyl phenyl acetate (also called ethyl phenylacetate). In some embodiments, the ethyl phenyl acetate can be present in an amount of about 0.00025 mg/L to about 0.005 mg/L (e.g., about 0.00025 to about 0.0003 mg/L, about 0.0003 to about 0.0005 mg/L, about 0.0005 to about 0.001 mg/L, about 0.001 to about 0.002 mg/L, about 0.002 to about 0.003 mg/L, about 0.003 to about 0.004 mg/L, about 0.004 to about 0.005 mg/L, or about 0.001 to about 0.005 mg/L). In some embodiments, about 0.000008% to about 0.006% by mass (e.g., about 0.000008% to about 0.00001% by mass, about 0.00001% to about 0.00005% by mass, about 0.00005% to about 0.0001% by mass, about 0.0001% to about 0.0005% by mass, about 0.0005% to about 0.001% by mass, about 0.001% to about 0.002% by mass, about 0.002% to about 0.004% by mass, about 0.004% to about 0.006% by mass, about 0.001 to about 0.005% by mass, or about 0.001% to about 0.006% by mass) of the one or more additional VOCs can be ethyl phenyl acetate. In some embodiments, the one or more additional VOCs can include no ethyl phenyl acetate.

The one or more additional VOCs in a Moscato-like alcoholic beverage can include ethyl propionate. In some embodiments, the ethyl propionate can be present in an amount of about 0.02 mg/L to about 0.1 mg/L (e.g., about 0.02 to about 0.04 mg/L, about 0.04 to about 0.06 mg/L, about 0.06 to about 0.08 mg/L, about 0.02 to about 0.05 mg/L, about 0.05 to about 0.1 mg/L, or about 0.08 to about 0.1 mg/L). In some embodiments, about 0.0006% to about 0.15% by mass (e.g., about 0.0006% to about 0.001% by mass, about 0.001% to about 0.005% by mass, about 0.005% to about 0.01% by mass, about 0.01% to about 0.05% by mass, about 0.05% to about 0.10% by mass, or about 0.10% to about 0.15% by mass) of the one or more additional VOCs can be ethyl propionate. In some embodiments, the one or more additional VOCs can include no ethyl propionate.

The one or more additional VOCs in a Moscato-like alcoholic beverage can include ethyl salicylate. In some embodiments, the ethyl salicylate can be present in an amount of about 0.0003 to about 0.002 mg/L (e.g., about 0.0003 to about 0.0005 mg/L, about 0.0003 to about 0.001 mg/L, about 0.0005 to about 0.001 mg/L, or about 0.001 to about 0.002 mg/L). In some embodiments, about 0.00002% to about 0.002% by mass (e.g., about 0.00002% to about 0.00005% by mass, about 0.00005% to about 0.0001% by mass, about 0.0001% to about 0.0005% by mass, about 0.0005% to about 0.001% by mass, or about 0.0001% to about 0.002% by mass) of the one or more additional VOCs can be ethyl salicylate. In some embodiments, the one or more additional VOCs can include no ethyl salicylate.

The one or more additional VOCs in a Moscato-like alcoholic beverage can include ethyl trans-2-butenoate. In some embodiments, the ethyl trans-2-butenoate can be present in an amount of about 0.001 mg/L to about 0.007 mg/L (e.g., about 0.001 to about 0.003 mg/L, about 0.003 to about 0.005 mg/L, about 0.005 to about 0.007 mg/L, or about 0.001 to about 0.005 mg/L). In some embodiments, about 0.00004% to about 0.008% by mass (e.g., about 0.00004% to about 0.00005% by mass, about 0.00005% to about 0.0001% by mass, about 0.0001% to about 0.0005% by mass, about 0.0005% to about 0.001% by mass, about 0.001% to about 0.002% by mass, about 0.002% to about 0.004% by mass, about 0.004% to about 0.006% by mass, about 0.006% to about 0.008% by mass, about 0.001% to about 0.005% by mass, or about 0.001% to about 0.008% by mass) of the one or more additional VOCs can be ethyl trans-2-butenoate. In some embodiments, the one or more additional VOCs can include no ethyl trans-2-butenoate.

The one or more additional VOCs in a Moscato-like alcoholic beverage can include ethyl undecanoate. In some embodiments, the ethyl undecanoate can be present in an amount of about 0.0001 mg/L to about 0.01 mg/L (e.g., about 0.0001 to about 0.0005 mg/L, about 0.0005 to about 0.001 mg/L, about 0.001 to about 0.005 mg/L, or about 0.005 to about 0.01 mg/L). In some embodiments, about 0.000004% to about 0.01% by mass (e.g., about 0.000004% to about 0.00001% by mass, about 0.00001% to about 0.00005% by mass, about 0.00005% to about 0.0001% by mass, about 0.001% to about 0.005% by mass, about 0.005% to about 0.001% by mass, about 0.001% to about 0.005% by mass, or about 0.005% to about 0.01% by mass) of the one or more additional VOCs can be ethyl undecanoate. In some embodiments, the one or more additional VOCs can include no ethyl undecanoate.

The one or more additional VOCs in a Moscato-like alcoholic beverage can include ethyl valerate. In some embodiments, the ethyl valerate can be present in an amount of about 0.0002 mg/L to about 0.25 mg/L (e.g., about 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.10 mg/L, about 0.10 to about 0.15 mg/L, about 0.15 to about 0.20 mg/L, about 0.1 to about 0.2 mg/L or about 0.20 to about 0.25 mg/L). In some embodiments, the ethyl valerate can be present in an amount of at least about 0.0012 mg/L (e.g., at least about 0.0013 mg/L, 0.0014 mg/L, 0.0015 mg/L, 0.002 mg/L, 0.005 mg/L, 0.01 mg/L, 0.02 mg/L, 0.05 mg/L, 0.1 mg/L, or 0.15 mg/L). In some embodiments, about 0.000006% to about 0.2% by mass (e.g., about 0.000006% to about 0.00001% by mass, about 0.00001% to 0.00005% by mass, 0.00005% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% to about 0.05% by mass, about 0.05% to about 0.1% by mass, or about 0.1% to about 0.2% by mass) of the one or more additional VOCs can be ethyl valerate. In some embodiments, at least 0.0015% by mass (e.g., at least about 0.0016%, 0.0017%, 0.0018%, 0.0019%, 0.002%, 0.003%, 0.004%, 0.005%, 0.01%, 0.02%, 0.05%, or 0.1% by mass) of the one or more additional VOCs can be ethyl valerate.

The one or more additional VOCs in a Moscato-like alcoholic beverage can include ethyl-2-methylbutyrate (also called ethyl 2-methylbutyrate). In some embodiments, the ethyl-2-methylbutyrate can be present in an amount of about 0.0015 mg/L to about 0.007 mg/L (e.g., about 0.0015 to about 0.002 mg/L, about 0.002 to about 0.003 mg/L, about 0.003 to about 0.004 mg/L, about 0.004 to about 0.005 mg/L, about 0.005 to about 0.006 mg/L, about 0.006 to about 0.007 mg/L, about 0.0015 to about 0.005 mg/L, or about 0.005 to about 0.007 mg/L). In some embodiments, about 0.00004% to about 0.008% by mass (e.g., about 0.00004% to about 0.0001% by mass, about 0.00005% to about 0.0001% by mass, about 0.0001% to about 0.0002% by mass, about 0.0002% to about 0.0005% by mass, about 0.0005% to about 0.001% by mass, about 0.001% to about 0.002% by mass, about 0.002% to about 0.004% by mass, about 0.004% to about 0.006% by mass, about 0.006% to about 0.008% by mass, about 0.001% to about 0.005% by mass, or about 0.001% to about 0.008% by mass) of the one or more additional VOCs can be ethyl-2-methylbutyrate. In some embodiments, the one or more additional VOCs can include no ethyl-2-methylbutyrate.

The one or more additional VOCs in a Moscato-like alcoholic beverage can include ethyl-3-hydroxybutyrate. In some embodiments, the ethyl-3-hydroxybutyrate can be present in an amount of about 0.02 mg/L to about 0.07 mg/L (e.g., about 0.02 to about 0.03 mg/L, about 0.03 to about 0.04 mg/L, about 0.04 to about 0.05 mg/L, about 0.05 to about 0.06 mg/L, or about 0.06 to about 0.07 mg/L). In some embodiments, about 0.0006% to about 0.08% by mass (e.g., about 0.0006% to about 0.001% by mass about 0.001% to about 0.002% by mass, about 0.002% to about 0.005% by mass, about 0.005% to about 0.01% by mass, about 0.01% to about 0.02% by mass, about 0.02% to about 0.04% by mass, about 0.04% to about 0.06% by mass, about 0.06% to about 0.08% by mass, about 0.01% to about 0.05% by mass, or about 0.01% to about 0.08% by mass) of the one or more additional VOCs can be ethyl-3-hydroxybutyrate. In some embodiments, the one or more additional VOCs can include no ethyl-3-hydroxybutyrate.

The one or more additional VOCs in a Moscato-like alcoholic beverage can include eucalyptol. In some embodiments, the eucalyptol can be present in an amount of about 0.0001 mg/L to about 0.03 mg/L (e.g., about 0.0001 to about 0.0005 mg/L, about 0.0005 to about 0.001 mg/L, about 0.001 to about 0.005 mg/L, about 0.005 to about 0.01 mg/L, about 0.01 to about 0.02 mg/L, about 0.02 to about 0.03 mg/L, or about 0.01 to about 0.03 mg/L). In some embodiments, the eucalyptol can be present in an amount of at least about 0.0009 mg/L (e.g., at least about 0.001 mg/L, 0.002 mg/L, 0.003 mg/L, 0.004 mg/L, 0.005 mg/L, 0.006 mg/L, 0.007 mg/L, 0.008 mg/L, 0.009 mg/L, 0.01 mg/L, 0.015 mg/L, or 0.02 mg/L). In some embodiments, about 0.000004% to about 0.035% by mass (e.g., about 0.000004% to about 0.00001% by mass, about 0.00001% to about 0.00005% by mass, about 0.00005% to about 0.0001% by mass, about 0.0001% to about 0.0005% by mass, about 0.0005% to about 0.001% by mass, about 0.001% to about 0.005% by mass, about 0.005% to about 0.01% by mass, about 0.010% to about 0.035% by mass, about 0.01% to about 0.02% by mass, about 0.01% to about 0.03% by mass, about 0.005% to about 0.015% by mass, about 0.015% to about 0.025% by mass, or about 0.025% to about 0.025% by mass) of the one or more additional VOCs can be eucalyptol. In some embodiments, at least about 0.0012% by mass (e.g., at least about 0.0013%, 0.0014%, 0.0015%, 0.002%, 0.003%, 0.004%, 0.005%, 0.006%, 0.007%, 0.008%, 0.009%, 0.01%, 0.015%, 0.02%, 0.025%, or 0.03% by mass) of the one or more additional VOCs can be eucalyptol. In some embodiments, the one or more additional VOCs can include no eucalyptol.

The one or more additional VOCs in a Moscato-like alcoholic beverage can include eugenol. In some embodiments, the eugenol can be present in an amount of about 0.00007 mg/L to about 0.007 mg/L (e.g., about 0.00007 to about 0.0001 mg/L, about 0.0001 to about 0.0005 mg/L, about 0.0005 to about 0.001 mg/L, about 0.001 to about 0.005 mg/L, about 0.001 to about 0.007 mg/L, about 0.001 to about 0.003 mg/L, about 0.003 to about 0.005 mg/L, or about 0.005 to about 0.007 mg/L). In some embodiments, about 0.000002% to about 0.008% by mass (e.g., e.g., about 0.000002% to about 0.000005% by mass, about 0.000005% to about 0.00001% by mass, about 0.00001% to about 0.00005% by mass, about 0.00005% to about 0.0001% by mass, about 0.0001% to about 0.0005% by mass, about 0.0005% to about 0.001% by mass, about 0.001% to about 0.005% by mass, about 0.001% to about 0.008% by mass, or about 0.005% to about 0.008% by mass) of the one or more additional VOCs can be eugenol. In some embodiments, the one or more additional VOCs can include no eugenol.

The one or more additional VOCs in a Moscato-like alcoholic beverage can include farnesol. In some embodiments, the farnesol can be present in an amount of about 0.002 mg/L to about 0.005 mg/L (e.g., about 0.002 to about 0.003 mg/L, about 0.003 to about 0.004 mg/L, or about 0.004 to about 0.005 mg/L). In some embodiments, about 0.00006% to about 0.005% by mass (e.g., about 0.00006% to about 0.0001% by mass, about 0.0001% to about 0.0005% by mass, about 0.0005% to about 0.001% by mass, about 0.001% to about 0.002% by mass, about 0.002% to about 0.003% by mass, about 0.003% to about 0.004% by mass, about 0.004% to about 0.005% by mass, or about 0.001% to about 0.005% by mass) of the one or more additional VOCs can be farnesol. In some embodiments, the one or more additional VOCs can include no farnesol.

The one or more additional VOCs in a Moscato-like alcoholic beverage can include furfural. In some embodiments, the furfural can be present in an amount of about 0.15 mg/L to about 6 mg/L (e.g., about 0.15 to about 0.5 mg/L, about 0.2 to about 0.5 mg/L, about 0.5 to about 1 mg/L, about 1 to about 5 mg/L, about 1 to about 6 mg/L, about 1 to about 2 mg/L, about 2 to about 4 mg/L, or about 4 to about 6 mg/L). In some embodiments, about 0.005% to about 7% by mass (e.g., about 0.005% to about 0.01% by mass, about 0.01% to about 0.05% by mass, about 0.05% to about 0.1% by mass, about 0.1% to about 0.5% by mass, about 0.5% to about 1% by mass, about 1% to about 5% by mass, about 1% to about 7% by mass, about 1% to about 3% by mass, about 3 to about 5% by mass, or about 5% to about 7% by mass) of the one or more additional VOCs can be furfural. In some embodiments, the one or more additional VOCs can include no furfural.

The one or more additional VOCs in a Moscato-like alcoholic beverage can include furfuryl mercaptan. In some embodiments, the furfuryl mercaptan can be present in an amount of about 0.00007 mg/L to about 0.00015 mg/L (e.g., about 0.00007 to about 0.00010 mg/L, about 0.00010 to about 0.00015 mg/L, about 0.00007 to about 0.00009 mg/L, about 0.00009 to about 0.00011 mg/L, about 0.00011 to about 0.00013 mg/L, or about 0.00013 to about 0.00015 mg/L). In some embodiments, about 0.000002% to about 0.0002% by mass (e.g. about 0.000002% to about 0.000005% by mass, about 0.000005% to about 0.00001% by mass, about 0.00001% to about 0.00005% by mass, about 0.00005% to about 0.0001% by mass, or about 0.0001% to about 0.0002% by mass) of the one or more additional VOCs can be furfuryl mercaptan. In some embodiments, the one or more additional VOCs can include no furfuryl mercaptan.

The one or more additional VOCs in a Moscato-like alcoholic beverage can include gamma-decalactone. In some embodiments, the gamma-decalactone can be present in an amount of about 0.0001 mg/L to about 2.5 mg/L (e.g., about 0.0001 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1.0 mg/L, about 1 to about 2 mg/L, about 1.5 to about 2.5 mg/L, about 1.0 to about 1.5 mg/L, about 1.5 to about 2.0 mg/L, or about 2.0 to about 2.5 mg/L). In some embodiments, the gamma-decalactone can be present in an amount of at least about 0.012 mg/L (e.g., at least about 0.013 mg/L, 0.014 mg/L, 0.015 mg/L, 0.02 mg/L, 0.05 mg/L, 0.1 mg/L, 0.2 mg/L, 0.3 mg/L, 0.4 mg/L, 0.5 mg/L, 0.6 mg/L, 0.7 mg/L, 0.8 mg/L, 0.9 mg/L, 1 mg/L, 1.5 mg/L, or 2 mg/L). In some embodiments, about 0.000004% to about 2% by mass (e.g., about 0.000004% to about 0.00001%, about 0.00001% to about 0.00005% by mass, about 0.00005% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% to about 0.05% by mass, about 0.05% to about 0.1% by mass, about 0.1% by mass to about 0.5% by mass, about 0.5% to about 1.0% by mass, about 1.0% to about 1.5% by mass, about 1% to about 2% by mass, or about 1.5% to about 2.0% by mass) of the one or more additional VOCs can be gamma-decalactone. In some embodiments, at least about 0.014% by mass (e.g., at least about 0.015%, 0.02%, 0.03%, 0.04%, 0.05%, 0.06%, 0.07%, 0.08%, 0.09% 0.1%, 0.2%, 0.3%, 0.4%, 0.5%, 0.6%, 0.7%, 0.8%, 0.9%, 1%, or 1.5% by mass) of the one or more additional VOCs can be gamma-decalactone. In some embodiments, the one or more additional VOCs can include no gamma-decalactone.

The one or more additional VOCs in a Moscato-like alcoholic beverage can include gamma-hexalactone. In some embodiments, the gamma-hexalactone can be present in an amount of about 0.015 to about 0.03 mg/L (e.g., about 0.015 to about 0.2 mg/L or about 0.2 to about 0.3 mg/L). In some embodiments, about 0.0004% to about 0.04% by mass (e.g., about 0.0004% to about 0.001% by mass, about 0.0005% to about 0.001% by mass, about 0.001% to about 0.005% by mass, about 0.005% to about 0.01% by mass, about 0.01% to about 0.04% by mass, about 0.01% to about 0.02% by mass, about 0.02% to about 0.03% by mass, or about 0.03% to about 0.04% by mass) of the one or more additional VOCs can be gamma-hexalactone. In some embodiments, the one or more additional VOCs can include no gamma-hexalactone.

The one or more additional VOCs in a Moscato-like alcoholic beverage can include gamma-nonalactone. In some embodiments, the gamma-nonalactone can be present in an amount of about 0.00007 mg/L to about 0.004 mg/L (e.g., about 0.00007 to about 0.0001 mg/L, about 0.0001 to about 0.0005 mg/L, about 0.0005 to about 0.001 mg/L, about 0.001 to about 0.004 mg/L, about 0.001 to about 0.002 mg/L, about 0.002 to about 0.003 mg/L, or about 0.003 to about 0.004 mg/L). In some embodiments, about 0.000002% to about 0.005% by mass (e.g., about 0.000002% to about 0.000005% by mass, about 0.000005% to about 0.00001% by mass, about 0.00001% to about 0.00005% by mass, about 0.00005% to about 0.0001% by mass, about 0.0001% to about 0.0005% by mass, about 0.0005% to about 0.001% by mass, or about 0.001% to about 0.005% by mass) of the one or more additional VOCs can be gamma-nonalactone. In some embodiments, the one or more additional VOCs can include no gamma-nonalactone.

The one or more additional VOCs in a Moscato-like alcoholic beverage can include gamma-octalactone. In some embodiments, the gamma-octalactone can be present in an amount of about 0.0015 mg/L to about 0.006 mg/L (e.g., about 0.0015 to about 0.002 mg/L, about 0.002 to about 0.003 mg/L, about 0.003 to about 0.004 mg/L, about 0.004 to about 0.005 mg/L, or about 0.005 to about 0.006 mg/L). In some embodiments, about 0.00004% to about 0.007% by mass (e.g., about 0.00004% to about 0.0001% by mass, about 0.0001% to about 0.0002% by mass, about 0.0001% to about 0.0002% by mass, about 0.0002% to about 0.0005% by mass, about 0.0005% to about 0.001% by mass, about 0.001% to about 0.002% by mass, about 0.002% to about 0.003% by mass, about 0.003% to about 0.004% by mass, about 0.004% to about 0.005% by mass, about 0.001% to about 0.005% by mass, about 0.001% to about 0.007% by mass, about 0.005% to about 0.006% by mass, or about 0.006% to about 0.007% by mass) of the one or more additional VOCs can be gamma-octalactone. In some embodiments, the one or more additional VOCs can include no gamma-octalactone.

The one or more additional VOCs in a Moscato-like alcoholic beverage can include gamma-terpinene. In some embodiments, the gamma-terpinene can be present in an amount of about 0.0002 mg/L to about 0.15 mg/L (e.g., about 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.10 mg/L, about 0.010 to about 0.015 mg/L, or about 0.05 to about 0.15 mg/L). In some embodiments, the gamma-terpinene can be present in an amount of at least about 0.04 mg/L (e.g., at least about 0.045 mg/L, 0.05 mg/L, 0.06 mg/L, 0.07 mg/L, 0.08 mg/L, 0.09 mg/L, 0.10 mg/L, 0.11 mg/L, 0.12 mg/L, 0.13 mg/L, or about 0.14 mg/L). In some embodiments, about 0.000006% to about 0.09% by mass (e.g., about 0.000006% to about 0.00001% by mass, about 0.00001% to about 0.00005% by mass, about 0.00005% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% to about 0.05% by mass, or about 0.05% to about 0.09% by mass) of the one or more additional VOCs can be gamma-terpinene. In some embodiments, at least about 0.05% by mass (e.g., at least about 0.055%, 0.06%, 0.07%, or 0.08% by mass) of the one or more additional VOCs can be gamma-terpinene.

The one or more additional VOCs in a Moscato-like alcoholic beverage can include gamma-undecalactone. In some embodiments, the gamma-undecalactone can be present in an amount of about 0.01 mg/L to about 0.04 mg/L (e.g., about 0.01 to about 0.02 mg/L, about 0.02 to about 0.03 mg/L, or about 0.03 to about 0.04 mg/). In some embodiments, about 0.0003% to about 0.05% by mass (e.g., about 0.0003% to about 0.0005% by mass, about 0.0005% to about 0.001% by mass, about 0.001% to about 0.005% by mass, about 0.005% to about 0.01%, or about 0.01% to about 0.05% by mass) of the one or more additional VOCs can be gamma-undecalactone. In some embodiments, the one or more additional VOCs can include no gamma-undecalactone.

The one or more additional VOCs in a Moscato-like alcoholic beverage can include geraniol. In some embodiments, the geraniol can be present in an amount of about 0.002 mg/L to about 0.5 mg/L (e.g., about 0.002 to about 0.005 mg/L, about 0.005 to about 0.01 mg/L, about 0.01 to about 0.02 mg/L, about 0.02 to about 0.05 mg/L, about 0.05 to about 0.1 mg/L, about 0.1 to about 0.5 mg/L, about 0.1 to about 0.2 mg/L, about 0.2 to about 0.3 mg/L, about 0.3 to about 0.4 mg/L, or about 0.4 to about). In some embodiments, about 0.00006% to about 0.6% by mass (e.g., about 0.00006% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% to about 0.05% by mass, about 0.05% to about 0.1% by mass, about 0.1% to about 0.5% by mass, about 0.1% to about 0.6% by mass, about 0.1% to about 0.2% by mass, about 0.2% to about 0.4% by mass, or about 0.4% to about 0.6% by mass) of the one or more additional VOCs can be geraniol.

The one or more additional VOCs in a Moscato-like alcoholic beverage can include 6,10-dimethyl-5,9-undecadien-2-one (also called geranyl acetone). In some embodiments, the 6,10-dimethyl-5,9-undecadien-2-one can be present in an amount of about 0.0010 mg/L to about 0.0020 mg/L (e.g., about 0.0010 to about 0.0015 mg/L or about 0.0015 to about 0.0020 mg/L). In some embodiments, about 0.00003% to about 0.0025% by mass (e.g., about 0.00003% to about 0.00005% by mass, about 0.00005% to about 0.0001% by mass, about 0.0001% to about 0.0005% by mass, about 0.0005% to about 0.0010% by mass, about 0.0010% to about 0.0015% by mass, about 0.0015% to about 0.0020% by mass, about 0.0020% to about 0.0025% by mass, about 0.0005% to about 0.0015% by mass, or about 0.0015% to about 0.0015% by mass) of the one or more additional VOCs can be 6,10-dimethyl-5,9-undecadien-2-one. In some embodiments, the one or more additional VOCs can include no 6,10-dimethyl-5,9-undecadien-2-one.

The one or more additional VOCs in a Moscato-like alcoholic beverage can include guaiacol. In some embodiments, the guaiacol can be present in an amount of about 0.001 mg/L to about 0.005 mg/L (e.g., about 0.001 to about 0.002 mg/L, about 0.002 to about 0.003 mg/L, about 0.003 to about 0.004 mg/L, or about 0.004 to about 0.005 mg/L). In some embodiments, about 0.00002% to about 0.005% by mass (e.g., about 0.00002% to about 0.00005% by mass, about 0.00005% to about 0.0001% by mass, about 0.0001% to about 0.0002% by mass, about 0.0002% to about 0.0005% by mass, about 0.0005% to about 0.001% by mass, about 0.001% to about 0.002% by mass, about 0.002% to about 0.003% by mass, about 0.003% to about 0.004% by mass, about 0.004% to about 0.005% by mass, or about 0.001% to about 0.005% by mass) of the one or more additional VOCs can be guaiacol. In some embodiments, the one or more additional VOCs can include no guaiacol.

The one or more additional VOCs in a Moscato-like alcoholic beverage can include heptyl acetate. In some embodiments, the heptyl acetate can be present in an amount of about 0.0002 mg/L to about 0.0006 mg/L (e.g., about 0.0002 to about 0.0003 mg/L, about 0.0003 to about 0.0004 mg/L, about 0.0004 to about 0.0005 mg/L, or about 0.0005 to about 0.0006 mg/L), In some embodiments, about 0.000008% to about 0.0006% by mass (e.g., about 0.000008% to about 0.00001% by mass, about 0.00001% to about 0.00005% by mass, about 0.00005% to about 0.0001% by mass, about 0.0001% to about 0.0002% by mass, about 0.0002% to about 0.0003% by mass, about 0.0003% to about 0.0004% by mass, about 0.0004% to about 0.0005% by mass, about 0.0005% to about 0.0006% by mass, about 0.0001% to about 0.0005% by mass, or about 0.0001% to about 0.0005% by mass) of the one or more additional VOCs can be heptyl acetate. In some embodiments, the one or more additional VOCs can include no heptyl acetate.

The one or more additional VOCs in a Moscato-like alcoholic beverage can include hexadecanol. In some embodiments, the hexadecanol can be present in an amount of about 0.005 mg/L to about 0.02 mg/L (e.g., about 0.005 to about 0.01 mg/L or about 0.01 to about 0.02 mg/L). In some embodiments, about 0.00015% to about 0.03% by mass (e.g., about 0.00015% to about 0.0005% by mass, about 0.0005% to about 0.001% by mass, about 0.001% to about 0.005% by mass, about 0.005% to about 0.01% by mass, about 0.01% to about 0.03% by mass, about 0.01% to about 0.02% by mass, or about 0.02% to about 0.03% by mass) of the one or more additional VOCs can be hexadecanol. In some embodiments, the one or more additional VOCs can include no hexadecanol.

The one or more additional VOCs in a Moscato-like alcoholic beverage can include hexanoic acid. In some embodiments, the hexanoic acid can be present in an amount of about 0.07 mg/L to about 3.5 mg/L (e.g., about 0.07 to about 0.1 mg/L, about 0.1 to about 0.5 mg/L, 0.5 to about 1 mg/L, about 1 to about 2 mg/L, about 2 to about 3 mg/L, about 1.0 to about 1.5 mg/L, about 1.5 to about 2.0 mg/L, about 2.0 to about 2.5 mg/L, about 2.5 to about 3.0 mg/L, or about 3.0 to about 3.5 mg/L). In some embodiments, the hexanoic acid can be present in an amount of at least about 0.35 mg/L (e.g., at least about 0.4 mg/L, 0.5 mg/L, 0.6 mg/L, 0.7 mg/L, 0.8 mg/L, 0.9 mg/L, 1 mg/L, 1.5 mg/L, 2 mg/L, 2.5 mg/L, or 3 mg/L). In some embodiments, about 0.002% to about 3.5% by mass (e.g., about 0.002% to about 0.005% by mass, about 0.005% to about 0.01% by mass, about 0.01% to about 0.05% by mass, about 0.05% to about 0.1% by mass, about 0.1% to about 0.5% by mass, about 0.5% to about 1% by mass, about 1% to about 2% by mass, about 1% to about 3% by mass, about 1% to about 2% by mass, about 1.0% to about 1.5% by mass, about 1.5% to about 2.0% by mass, about 2.0% to about 2.5% by mass, about 2.5% to about 3.0% by mass, or about 3.0% to about 3.5% by mass) of the one or more additional VOCs can be hexanoic acid. In some embodiments, at least about 0.4% by mass (e.g., at least about 0.5%, 0.6%, 0.7%, 0.8%, 0.9%, 1%, 1.5%, 2%, 2.5%, or 3% by mass) of the one or more additional VOCs can be hexanoic acid. In some embodiments, the one or more additional VOCs can include no hexanoic acid.

The one or more additional VOCs in a Moscato-like alcoholic beverage can include hexanol (also called hexyl alcohol). In some embodiments, the hexanol can be present in an amount of about 0.25 mg/L to about 0.75 mg/L (e.g., about 0.25 to about 0.35 mg/L, about 0.35 to about 0.45 mg/L, about 0.45 to about 0.55 mg/L, about 0.55 to about 0.65 mg/L, or about 0.65 to about 0.65 mg/L). In some embodiments, about 0.007% to about 0.9% by mass (e.g., about 0.008% to about 0.01% by mass, about 0.01% to about 0.02% by mass, about 0.02% to about 0.05% by mass, about 0.05% to about 0.1% by mass, about 0.1% to about 0.5% by mass, about 0.5% to about 0.9% by mass, about 0.1% to about 0.3% by mass, about 0.3% to about 0.5% by mass, about 0.5% to about 0.7% by mass, or about 0.7% to about 0.9% by mass) of the one or more additional VOCs can be hexanol.

The one or more additional VOCs in a Moscato-like alcoholic beverage can include hexyl acetate. In some embodiments, the hexyl acetate can be present in an amount of about 0.003 mg/L to about 0.7 mg/L (e.g., about 0.003 to about 0.005 mg/L, about 0.005 to about 0.01 mg/L, about 0.01 to about 0.02 mg/L, about 0.02 to about 0.03 mg/L, about 0.03 to about 0.05 mg/L, about 0.05 to about 0.07 mg/L, about 0.07 to about 0.1 mg/L, about 0.1 to about 0.2 mg/L, about 0.1 to about 0.5 mg/L, about 0.1 to about 0.7 mg/L, about 0.2 to about 0.3 mg/L, about 0.3 to about 0.4 mg/L, about 0.4 to about 0.5 mg/L, about 0.5 to about 0.6 mg/L, or about 0.6 to about 0.7 mg/L). In some embodiments, the hexyl acetate can be present in an amount of at least 0.04 mg/L (e.g., at least about 0.05 mg/L, 0.07 mg/L, 0.1 mg/L, 0.2 mg/L, 0.3 mg/L, 0.4 mg/L, 0.5 mg/L, or 0.6 mg/L). In some embodiments, about 0.0001% to about 0.5% by mass (e.g., about 0.0001% to about 0.0005% by mass, about 0.0005% to about 0.001% by mass, about 0.001% to about 0.005% by mass, about 0.005% to about 0.01% by mass, about 0.01% to about 0.05% by mass, about 0.05% to about 0.1% by mass, about 0.1% to about 0.2% by mass, about 0.2% to about 0.3% by mass, about 0.3% to about 0.4% by mass, or about 0.4% to about 0.5% by mass) of the one or more additional VOCs can be hexyl acetate. In some embodiments, at least about 0.05% by mass (e.g., at least about 0.06%, 0.07%, 0.08%, 0.09%, 0.1%, 0.2%, 0.3%, or 0.4% by mass) of the one or more additional VOCs can be hexyl acetate.

The one or more additional VOCs in a Moscato-like alcoholic beverage can include hexyl hexanoate. In some embodiments, the hexyl hexanoate can be present in an amount of about 0.001 mg/L to about 0.003 mg/L (e.g., about 0.001 to about 0.002 mg/L or about 0.002 to about 0.003 mg/L). In some embodiments, about 0.00003% to about 0.003% by mass (e.g., about 0.00003% to about 0.00005% by mass, about 0.00005% to about 0.0001% by mass, 0.0001% to about 0.0005% by mass, about 0.0005% to about 0.001% by mass, about 0.001% to about 0.002% by mass, about 0.001% to about 0.003% by mass, or about 0.002% to about 0.003% by mass) of the one or more additional VOCs can be hexyl hexanoate. In some embodiments, the one or more additional VOCs can include no hexyl hexanoate.

The one or more additional VOCs in a Moscato-like alcoholic beverage can include isoamyl acetate. In some embodiments, the isoamyl acetate can be present in an amount of about 0.07 mg/L to about 35 mg/L (e.g., about 0.07 to about 0.1 mg/L, about 0.1 to about 0.5 mg/L, about 0.5 to about 1 mg/L, about 1 to about 2 mg/L, about 2 to about 5 mg/L, about 5 to about 10 mg/L, about 10 to about 15 mg/L, about 15 to about 20 mg/L, about 20 to about 25 mg/L, about 25 to about 30 mg/L, or about 30 to about 35 mg/L). In some embodiments, the isoamyl acetate can be present in an amount of at least about 1.7 mg/L (e.g., at least about 1.8 mg/L, 1.9 mg/L, 2.0 mg/L, 2.5 mg/L, 3 mg/L, 4 mg/L, 5 mg/L, 6 mg/L, 7 mg/L, 8 mg/L, 9 mg/L, 10 mg/L, 15 mg/L, 20 mg/L, or 25 mg/L). In some embodiments, about 0.002% to about 25% by mass (e.g., about 0.002% to about 0.005% by mass, about 0.005% to about 0.01% by mass, about 0.01% to about 0.05% by mass, about 0.05% to about 0.1% by mass, about 0.1% to about 0.5% by mass, about 0.5% to about 1% by mass, about 1% to about 2% by mass, about 2% to about 5% by mass, about 5% to about 10% by mass, about 10% to about 15% by mass, about 15% to about 20% by mass, or about 20% to about 25% by mass) of the one or more additional VOCs can be isoamyl acetate. In some embodiments, at least about 2% by mass (e.g., at least about 2.5%, 3%, 4%, 5%, 6%, 7%, 8%, 9%, 10%, 11%, 12%, 13%, 14%, 15%, 16%, 17%, 18%, 19%, 20%, 21%, 22%, 23%, or 24% by mass) of the one or more additional VOCs can be isoamyl acetate.

The one or more additional VOCs in a Moscato-like alcoholic beverage can include isoamyl alcohol. In some embodiments, the isoamyl alcohol can be present in an amount of about 10 to about 2 g/L (e.g., about 10 to about 20 mg/L, about 20 to about 30 mg/L, about 30 to about 50 mg/L, about 50 to about 75 mg/L, about 75 to about 100 mg/L, about 100 to about 250 mg/L, about 250 to about 500 mg/L, about 500 to about 750 mg/L, about 750 to about 1 g/L, about 1 to about 1.5 g/L, or about 1.5 to about 2 g/L). In some embodiments, about 0.5% to about 90% by mass (e.g., about 0.5% to about 1% by mass, about 1% to about 2% by mass, about 2% to about 5% by mass, about 5% to about 10% by mass, about 10% to about 15% by mass, about 15% to about 20% by mass, about 15% to about 25% by mass, about 20% to about 30% by mass, about 30% to about 40% by mass, about 40% to about 50% by mass, about 50% to about 60% by mass, about 60% to about 70% by mass, about 70% to about 80% by mass, or about 80% to about 90% by mass) of the one or more additional VOCs can be isoamyl alcohol. In some embodiments, the one or more additional VOCs can include no isoamyl alcohol.

The one or more additional VOCs in a Moscato-like alcoholic beverage can include isoamyl hexanoate. In some embodiments, the isoamyl hexanoate can be present in an amount of about 0.0001 mg/L to about 0.0006 mg/L (e.g., about 0.0001 to about 0.0003 mg/L, about 0.0003 to about 0.0005 mg/L, about 0.0002 to about 0.0004 mg/L, or about 0.0004 to about 0.0006 mg/L). In some embodiments, about 0.000004% to about 0.0006% by mass (e.g., about 0.000004% to about 0.00001% by mass, about 0.000005% to about 0.00001% by mass, about 0.00001% to about 0.00005% by mass, about 0.00005% to about 0.0001% by mass, about 0.0001% to about 0.0005% by mass, about 0.0001% to about 0.0006% by mass, about 0.0001% to about 0.0003% by mass, about 0.0002% to about 0.0004% by mass, or about 0.0004% to about 0.0006% by mass) of the one or more additional VOCs can be isoamyl hexanoate. In some embodiments, the one or more additional VOCs can include no isoamyl hexanoate.

The one or more additional VOCs in a Moscato-like alcoholic beverage can include isoamyl isobutyrate. In some embodiments, the isoamyl isobutyrate can be present in an amount of about 0.00003 mg/L to about 0.00006 mg/L (e.g., about 0.00003 to about 0.00004 mg/L, about 0.00004 to about 0.00005 mg/L, or about 0.00005 to about 0.00006 mg/L). In some embodiments, about 0.000001% to about 0.00007% by mass (e.g., about 0.000001% to about 0.000005% by mass, about 0.000005% to about 0.00001% by mass, about 0.00001% to about 0.00005% by mass, about 0.00001% to about 0.00007% by mass, about 0.00001% to about 0.00003% by mass, about 0.00003% to about 0.00005% by mass, or about 0.00005% to about 0.00007% by mass) of the one or more additional VOCs can be isoamyl isobutyrate. In some embodiments, the one or more additional VOCs can include no isoamyl isobutyrate.

The one or more additional VOCs in a Moscato-like alcoholic beverage can include isoamyl isovalerate. In some embodiments, the isoamyl isovalerate can be present in an amount of about 0.005 mg/L to about 0.009 mg/L (e.g., about 0.005 to about 0.007 mg/L or about 0.007 to about 0.009 mg/L). In some embodiments, about 0.0001% to about 0.01% by mass (e.g., about 0.0001% to about 0.0005% by mass, about 0.0005% to about 0.001% by mass, about 0.001% to about 0.005% by mass, or about 0.005% to about 0.01% by mass) of the one or more additional VOCs can be isoamyl isovalerate. In some embodiments, the one or more additional VOCs can include no isoamyl isovalerate.

The one or more additional VOCs in a Moscato-like alcoholic beverage can include isoamyl octanoate. In some embodiments, the isoamyl octanoate can be present in an amount of about 0.001 mg/L to about 1.5 g/L (e.g., about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 2 mg/L, about 2 to about 5 mg/L, about 5 to about 10 mg/L, about 10 to about 20 mg/L, about 20 to about 50 mg/L, about 50 to about 100 mg/L, about 100 to about 200 mg/L, about 200 to about 500 mg/L, about 500 to about 1 g/L, or about 1 to about 1.5 g/L). In some embodiments, about 0.00004% to about 90% by mass (e.g., about 0.00004% to about 0.0001% by mass, about 0.00005% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% to about 0.05% by mass, about 0.05% to about 0.1% by mass, about 0.1% to about 0.5% by mass, about 0.5% to about 1% by mass, about 1% to about 2% by mass, about 2% to about 5% by mass, about 5% to about 10% by mass, about 10% to about 15% by mass, about 15% to about 20% by mass, about 20% to about 30% by mass, about 30% to about 40% by mass, about 40% to about 50% by mass, about 50% to about 60% by mass, about 60% to about 70% by mass, about 70% to about 80% by mass, or about 80% to about 90% by mass) of the one or more additional VOCs can be isoamyl octanoate. In some embodiments, the one or more additional VOCs can include no isoamyl octanoate.

The one or more additional VOCs in a Moscato-like alcoholic beverage can include isoborneol. In some embodiments, the isoborneol can be present in an amount of about 0.001 mg/L to about 0.004 mg/L (e.g., about 0.001 to about 0.002 mg/L, about 0.002 to about 0.003 mg/L, or about 0.003 to about 0.004 mg/L). In some embodiments, about 0.00005% to about 0.005% by mass (e.g., about 0.00005% to about 0.0001% by mass, about 0.0001% to about 0.0005% by mass, about 0.0005% to about 0.001% by mass, about 0.001% to about 0.002% by mass, about 0.002% to about 0.003% by mass, about 0.003% to about 0.004% by mass, about 0.004% to about 0.005% by mass, or about 0.001% to about 0.005% by mass) of the one or more additional VOCs can be isoborneol. In some embodiments, the one or more additional VOCs can include no isoborneol.

The one or more additional VOC in a Moscato-like alcoholic beverage can include isobutanol (also called isobutyl alcohol). In some embodiments, the isobutanol can be present in an amount of about 1 mg/L to about 240 mg/L (e.g., about 1 to about 2 mg/L, about 2 to about 3 mg/L, about 3 to about 5 mg/L, about 5 to about 10 mg/L, about 10 to about 20 mg/L, about 20 to about 40 mg/L, about 40 to about 60 mg/L, about 60 to about 80 mg/L, about 80 to about 100 mg/L, about 100 to about 150 mg/L, about 150 to about 200 mg/L, or about 200 to about 240 mg/L). In some embodiments, about 0.03% to about 90% by mass (e.g., about 0.03% to about 0.05% by mass, about 0.05% to about 0.1% by mass, about 0.1% to about 0.5% by mass, about 0.5% to about 1% by mass, about 1% to about 2% by mass, about 2% to about 5% by mass, about 5% to about 10% by mass, about 10% to about 15% by mass, about 15% to about 20% by mass, about 10% to about 25% by mass, about 20% to about 30% by mass, about 30% to about 40% by mass, about 40% to about 50% by mass, about 50% to about 60% by mass, about 60% to about 70% by mass, about 70% to about 80% by mass, or about 80% to about 90% by mass) of the one or more VOCs can be isobutanol.

The one or more additional VOCs in a Moscato-like alcoholic beverage can include isobutyl acetate. In some embodiments, the isobutyl acetate can be present in an amount of about 0.001 mg/L to about 0.05 mg/L (e.g., about 0.001 to about 0.002 mg/L, about 0.002 to about 0.005 mg/L, about 0.005 to about 0.01 mg/L, about 0.01 to about 0.02 mg/L, about 0.01 to about 0.05 mg/L, or about 0.02 to about 0.05 mg/L). In some embodiments, about 0.00005% to about 0.06% by mass (e.g., about 0.00005% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% to about 0.02% by mass, about 0.02% to about 0.03% by mass, about 0.03% to about 0.04% by mass, about 0.04% to about 0.05% by mass, about 0.05% to about 0.06% by mass, about 0.01% to about 0.05% by mass, or about 0.01% to about 0.06% by mass) of the one or more additional VOCs can be isobutyl acetate. In some embodiments, the one or more additional VOCs can include no isobutyl acetate.

The one or more additional VOCs in a Moscato-like alcoholic beverage can include isobutyraldehyde. In some embodiments, the isobutyraldehyde can be present in an amount of about 0.0002 mg/L to about 0.25 mg/L (e.g., about 0.0002 to about 0.0005 mg/L, about 0.0005 mg/L to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.2 mg/L, about 0.05 to about 0.15 mg/L, or about 0.15 to about 0.25 mg/L). In some embodiments, the isobutyraldehyde can be present in an amount of at least about 0.0035 mg/L (e.g., at least about 0.004 mg/L, 0.005 mg/L, 0.006 mg/L, 0.007 mg/L, 0.008 mg/L, 0.009 mg/L, 0.01 mg/L, 0.02 mg/L, 0.03 mg/L, 0.04 mg/L, 0.05 mg/L, 0.05 mg/L, 0.07 mg/L, 0.08 mg/L, 0.09 mg/L, 0.1 mg/L, 0.15 mg/L, or 0.2 mg/L). In some embodiments, about 0.000008% to about 0.25% by mass (e.g., about 0.000008% to about 0.00001% by mass, about 0.0001% to about 0.00005% by mass, about 0.0005% to about 0.001% by mass, about 0.001% to about 0.005% by mass, about 0.005% to about 0.01% by mass, about 0.01% to about 0.05% by mass, about 0.05% to about 0.1% by mass, about 0.1% by mass to about 0.2% by mass, about 0.05% by mass to about 0.15% by mass, or about 0.15% by mass to about 0.25% by mass) of the one or more additional VOCs can be isobutyraldehyde. In some embodiments, at least about 0.0045% (e.g., at least about 0.005%, 0.006%, 0.007%, 0.008%, 0.009%, 0.01%, 0.02%, 0.03%, 0.04%, 0.05%, 0.06%, 0.07%, 0.08% 0.09%, 0.1%, 0.15%, or 0.2% by mass) of the one or more additional VOCs can be isobutyraldehyde. In some embodiments, the one or more additional VOCs can include no isobutyraldehyde.

The one or more additional VOCs in a Moscato-like alcoholic beverage can include isobutyric acid. In some embodiments, the isobutyric acid can be present in an amount of about 0.15 mg/L to about 200 mg/L (e.g., about 0.15 to about 0.20 mg/L, about 0.20 to about 0.25 mg/L, about 0.25 to about 0.3 mg/L, about 0.3 to about 0.5 mg/L, about 0.5 to about 1 mg/L, about 1 to about 2 mg/L, about 2 to about 5 mg/L, about 5 to about 10 mg/L, about 10 to about 20 mg/L, about 20 to about 50 mg/L, about 50 to about 100 mg/L, about 100 to about 150 mg/L, or about 150 to about 200 mg/L). In some embodiments, the isobutyric acid can be present in an amount of less than about 1.6 mg/L (e.g., less than about 1.5 mg/L, 1.4 mg/L, 1.3 mg/L, 1.2 mg/L, 1.1 mg/L, 1.0 mg/L, 0.9 mg/L, 0.8 mg/L, 0.7 mg/L, 0.6 mg/L, 0.5 mg/L, 0.4 mg/L, or 0.3 mg/L). In some embodiments, about 0.06% to about 90% by mass (e.g., about 0.06% to about 0.10%, about 0.10% to about 0.15% by mass, about 0.15% to about 0.2% by mass, about 0.2% to about 0.3% by mass, about 0.3% to about 0.5% by mass, about 0.5% to about 1% by mass, about 1% to about 2% by mass, about 2% to about 5% by mass, about 5% to about 10% by mass, about 10% to about 15% by mass, about 15% to about 20% by mass, about 20% to about 30% by mass, about 30% to about 40% by mass, about 40% to about 50% by mass, about 50% to about 60% by mass, about 60% to about 70% by mass, about 70% to about 80% by mass, or about 80% to about 90% by mass) of the one or more additional VOCs can be isobutyric acid.

The one or more additional VOCs in a Moscato-like alcoholic beverage can include isovaleraldehyde. In some embodiments, the isovaleraldehyde can be present in an amount of about 0.001 mg/L to about 0.2 mg/L (e.g. about 0.001 to about 0.005 mg/L, about 0.005 to about 0.01 mg/L, about 0.01 mg/L to about 0.05 mg/L, about 0.05 to about 0.1 mg/L, or about 0.1 to about 0.2 mg/L). In some embodiments, about 0.00004% to about 0.2% by mass (e.g., about 0.00004% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% to about 0.05% by mass, about 0.05% to about 0.1% by mass, or about 0.1% to about 0.2% by mass) of the one or more additional VOCs can be isovaleraldehyde. In some embodiments, the one or more additional VOCs can include no isovaleraldehyde.

The one or more additional VOCs in a Moscato-like alcoholic beverage can include isovaleric acid. In some embodiments, the isovaleric acid can be present in an amount of about 2 mg/L to about 5 mg/L (e.g., about 2 to about 3 mg/L, about 3 to about 4 mg/L, about 4 to about 5 mg/L, about 2 to about 4 mg/L, or about 3 to about 5 mg/L). In some embodiments, about 0.06% to about 6% by mass (e.g., about 0.06% to about 0.1% by mass, about 0.1% to about 0.2% by mass, about 0.2% to about 0.5% by mass, about 0.5% to about 1% by mass, about 1% to about 2% by mass, about 2% to about 3% by mass, about 3% to about 4% by mass, about 4% to about 5%, about 5% to about 6%, about 1% to about 5%, or about 1% to about 6%) of the one or more additional VOCs can be isovaleric acid. In some embodiments, the one or more additional VOCs can include no isovaleric acid.

The one or more additional VOCs in a Moscato-like alcoholic beverage can include Jasmine lactone. In some embodiments, the Jasmine lactone can be present in an amount of about 0.006 mg/L to about 0.014 mg/L (e.g., about 0.006 to about 0.008 mg/L, about 0.008 to about 0.010 mg/L, about 0.010 to about 0.012 mg/L, or about 0.012 to about 0.014 mg/L). In some embodiments, about 0.0002% to about 0.02% by mass (e.g., about 0.0002% to about 0.0005% by mass, about 0.0005% to about 0.001% by mass, about 0.001% to about 0.005% by mass, about 0.005% to about 0.01% by mass, or about 0.01% to about 0.02% by mass) of the one or more additional VOCs can be Jasmine lactone. In some embodiments, the one or more additional VOCs can include no Jasmine lactone.

The one or more additional VOCs in a Moscato-like alcoholic beverage can include limonene (also called 1-limonene). In some embodiments, the limonene can be present in an amount of about 0.0002 mg/L to about 1.1 mg/L (e.g., about 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 mg/L to about 1.0 mg/L, or about 0.5 to about 1.1 mg/L). In some embodiments, the limonene can be present in an amount of at least 0.012 mg/L (e.g., at least about 0.013 mg/L, 0.014 mg/L, 0.015 mg/L, 0.016 mg/L, 0.017 mg/L, 0.018 mg/L, 0.019 mg/L, 0.2 mg/L, 0.3 mg/L, 0.4 mg/L, 0.5 mg/L, 0.6 mg/L, 0.7 mg/L, 0.8 mg/L, 0.9 mg/L, or 1 mg/L). In some embodiments, about 0.000006% to about 0.9% by mass (e.g., about 0.000006% to about 0.00001% by mass, about 0.00001% to about 0.00005% by mass, about 0.00005% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% to about 0.05% by mass, about 0.05% to about 0.1% by mass, about 0.1% to about 0.2% by mass, about 0.2% to about 0.3 by mass, about 0.3% to about 0.5% by mass, about 0.5% to about 0.7% by mass, about 0.1% to about 0.5% by mass, about 0.5% to about 0.9% by mass, or about 0.7% to about 0.9% by mass) of the one or more additional VOCs can be limonene. In some embodiments, at least about 0.014% by mass (e.g., at least about 0.015%, 0.016%, 0.017%, 0.018%, 0.019%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, or 0.8% by mass) of the one or more additional VOCs can be limonene.

The one or more additional VOCs in a Moscato-like alcoholic beverage can include linalool (also called 1-linalool). In some embodiment, the linalool can be present in an amount of about 0.025 mg/L to about 2.5 mg/L (e.g., about 0.025 to about 0.5 mg/L, about 0.5 to about 1 mg/L, about 1 to about 2 mg/L, about 1.0 to about 1.5 mg/L, about 1.50 to about 2.0 mg/L, about 1.5 to about 2.5 mg/L, or 2.0 to about 2.5 mg/L). In some embodiments, the linalool is present in an amount of at least about 0.5 mg/L (e.g., at least about 00.6 mg/L, 0.7 mg/L, 0.8 mg/L, 0.9 mg/L, 1.0 mg/L, 1.2 mg/L, 1.4 mg/L, 1.6 mg/L, 1.8 mg/L, 1.9 mg/L, 2 mg/L, 2.1 mg/L, 2.2 mg/L, 2.3 mg/L, or 2.4 mg/L). In some embodiments, about 0.0007% to about 1.8% by mass (e.g., about 0.0007% to about 0.001% by mass, about 0.001% to about 0.005% by mass, about 0.005% to about 0.01% by mass, about 0.01% to about 0.05% by mass, about 0.05% to about 0.1% by mass, about 0.1% to about 0.2% by mass, about 0.2% to about 0.5% by mass, about 0.5% to about 1.0% by mass, about 1.0% to about 1.5%, or about 1.5% to about 1.8% by mass) of the one or more additional VOCs can be linalool. In some embodiments, at least about 0.6% by mass (e.g., at least about 0.7%, 0.8%, 0.9%, 1%, 1.1%, 1.2%, 1.3%, 1.4%, 1.5%, 1.6%, or 1.7% by mass) of the one or more additional VOCs can be linalool.

The one or more additional VOCs in a Moscato-like alcoholic beverage can include Linalool oxide. In some embodiments, the Linalool oxide can be present in an amount of about 0.08 mg/L to about 0.8 mg/L (e.g., about 0.08 to about 0.1 mg/L, about 0.1 to about 0.2 mg/L, about 0.2 to about 0.3 mg/L, about 0.3 to about 0.4 mg/L, about 0.4 to about 0.5 mg/L, about 0.5 to about 0.6 mg/L, about 0.6 to about 0.7 mg/L, about 0.1 to about 0.5 mg/L, about 0.5 to about 0.8 mg/L, or about 0.7 to about 0.8 mg/L). In some embodiments, about 0.002% to about 0.9% by mass (e.g., about 0.002% to about 0.005% by mass, about 0.005% to about 0.01% by mass, about 0.01% to about 0.05% by mass, about 0.05% to about 0.1% by mass, about 0.1% to about 0.5% by mass, about 0.5% to about 0.9% by mass, about 0.1% to about 0.3% by mass, about 0.3% to about 0.5% by mass, about 0.5% to about 0.7% by mass, or about 0.7% to about 0.9% by mass) of the one or more additional VOCs can be Linalool oxide. In some embodiments, the one or more additional VOCs can include no Linalool oxide.

The one or more additional VOCs in a Moscato-like alcoholic beverage can include linalyl acetate. In some embodiments, the linalyl acetate can be present in an amount of about 0.0007 mg/L to about 1.2 mg/L (e.g., about 0.0007 to about 0.001 mg/L, about 0.001 to about 0.005 mg/L, about 0.005 to about 0.01 mg/L, about 0.01 to about 0.02 mg/L, about 0.02 to about 0.05 mg/L, about 0.05 to about 0.1 mg/L, about 0.1 to about 0.2 mg/L, about 0.2 to about 0.4 mg/L, about 0.4 to about 0.6 mg/L, about 0.6 to about 0.8 mg/L, about 0.8 to about 1.0 mg/L, about 0.1 to about 0.5 mg/L, about 0.3 to about 1 mg/L, or about 1.0 to about 1.2 mg/L). In some embodiments the linalyl acetate can be present in an amount of at least about 0.22 mg/L (e.g., at least about 0.23 mg/L, 0.24 mg/L, 0.25 mg/L, 0.3 mg/L, 0.4 mg/L, 0.5 mg/L, 0.6 mg/L, 0.7 mg/L, 0.8 mg/L, 0.9 mg/L, 1 mg/L, or 1.1 mg/L). In some embodiments, about 0.00002% to about 1% by mass (e.g., about 0.00002% to about 0.00005% by mass, about 0.00005% to about 0.0001% by mass, about 0.0001 to about 0.0005% by mass, about 0.0005% to about 0.001% by mass, about 0.001% to about 0.005% by mass, about 0.005% to about 0.01% by mass, about 0.01% to about 0.05% by mass, about 0.05% to about 0.1% by mass, about 0.1% to about 0.2% by mass, about 0.2% to about 0.3% by mass, about 0.3% to about 0.4% by mass, about 0.4% to about 0.5% by mass, about 0.5% to about 0.6% by mass, about 0.6% to about 0.7% by mass, about 0.6% to about 0.8% by mass, 0.7% to about 0.8% by mass, about 0.8% to about 0.9% by mass, about 0.9% to about 1% by mass, about 0.1% to about 0.5% by mass, about 0.5% to about 1% by mass) of the one or more additional VOCs can be linalyl acetate. In some embodiments, at least about 0.25% by mass (e.g., at least about 0.3%, 0.4%, 0.5%, 0.6%, 0.7%, 0.8%, or 0.9% mass) of the one or more additional VOCs can be linalyl acetate.

The one or more additional VOCs in a Moscato-like alcoholic beverage can include linalyl butyrate. In some embodiments, the linalyl butyrate can be present in an amount of about 0.00006 mg/L to about 2.5 mg/L (e.g., about 0.00006 to about 0.0001 mg/L, about 0.0001 to about 0.0002 mg/L, about 0.0002 to about 0.0005 mg/L, about 0.0005 to about 0.001 mg/L, about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1.0 mg/L, about 1 to about 2 mg/L, about 1.0 to about 1.5 mg/L, about 1.5 to about 2.0 mg/L, or about 2.0 to about 2.5 mg/L). In some embodiments, the linalyl butyrate can be present in an amount of at least about 0.0002 mg/L (e.g., at least about 0.0005 mg/L, 0.001 mg/L, 0.005 mg/L, 0.01 mg/L, 0.05 mg/L, 0.1 mg/L, 0.5 mg/L, 1.0 mg/L, or 1.5 mg/L). In some embodiments, about 0.000002% to about 1.8% by mass (e.g., about 0.000002% to about 0.000005%, about 0.000005% to about 0.00001% by mass, about 0.00001% to about 0.00002% by mass, about 0.00002% to about 0.00003% by mass, 0.00003% to about 0.00005% by mass, about 0.00005% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% to about 0.05% by mass, about 0.05% to about 0.1% by mass, about 0.1% to about 0.5% by mass, about 0.5% to about 1.0% by mass, about 1.0% to about 1.5% by mass, or about 1.5% to about 1.8% by mass) of the one or more additional VOCs can be linalyl butyrate. In some embodiments, at least about 0.00025% by mass (e.g., at least about 0.0003%, 0.0004%, 0.0005%, 0.0006%, 0.0007%, 0.0008%, 0.0009%, 0.001%, 0.005%, 0.01%, 0.05%, 0.1%, 0.5%, 1%, or 1.5% by mass) of the one or more additional VOCs can be linalyl butyrate. In some embodiments, the one or more additional VOCs can include no linalyl butyrate.

The one or more additional VOCs in a Moscato-like alcoholic beverage can include maltol. In some embodiments, the maltol can be present in an amount of 1.3 mg/L to about 5.0 mg/L (e.g., 1.3 to 1.5 mg/L, 1.5 to 2.0 mg/L, 2.0 to 2.5 mg/L, 2.5 to 3.0 mg/L, 3.0 to 3.5 mg/L, 3.5 to 4.0 mg/L, 4.0 to 4.5 mg/L, or 4.5 to 5.0 mg/L). In some embodiments, about 0.04% to about 6% by mass (e.g., about 0.04% to about 0.1% by mass, about 0.1% to about 0.2% by mass, about 0.2% to about 0.5% by mass, about 0.5% to about 1% by mass, about 1% to about 2% by mass, about 2% to about 3% by mass, about 3% to about 4% by mass, about 4% to about 5% by mass, about 5% to about 6%, about 1% to about 5% by mass, about 1% to about 6%) of the one or more additional VOCs can be maltol. In some embodiments, the one or more additional VOCs can include no maltol.

The one or more additional VOCs in a Moscato-like alcoholic beverage can include methional. In some embodiments, the methional can be present in an amount of about 0.0001 mg/L to about 0.002 mg/L (e.g., about 0.0001 to about 0.0002 mg/L, about 0.0002 to about 0.0005 mg/L, about 0.0005 to about 0.001 mg/L, or about 0.001 to about 0.002 mg/L). In some embodiments, about 0.000004% to about 0.002% by mass (e.g., about 0.000004% to about 0.00001% by mass, about 0.00001% to about 0.00002% by mass, about 0.00002% to about 0.00005% by mass, about 0.00005% to about 0.0001% by mass, about 0.0001% to about 0.0005% by mass, about 0.0005% to about 0.001% by mass, or about 0.001% to about 0.002% by mass) of the one or more additional VOCs can be methional. In some embodiment, the one or more additional VOCs can include no methional.

The one or more additional VOCs in a Moscato-like alcoholic beverage can include methyl acetate. In some embodiments, the methyl acetate can be present in an amount of about 0.03 mg/L to about 0.15 mg/L (e.g., about 0.03 to about 0.05 mg/L, about 0.05 to about 0.1 mg/L, or about 0.10 to about 0.15 mg/L). In some embodiments, about 0.0008% to about 0.2% by mass (e.g., about 0.0008% to about 0.001% by mass, about 0.001% to about 0.005% by mass, about 0.005% to about 0.01% by mass, about 0.01% to about 0.05% by mass, about 0.05% to about 0.1% by mass, or about 0.1% to about 0.2% by mass) of the one or more additional VOCs can be methyl acetate. In some embodiments, the one or more additional VOCs can include no methyl acetate.

The one or more additional VOCs in a Moscato-like alcoholic beverage can include methyl anthranilate. In some embodiments, the methyl anthranilate can be present in an amount of about 0.00006 mg/L to about 0.0008 mg/L (e.g., about 0.00006 to about 0.0001 mg/L, about 0.0001 to about 0.0002 mg/L, about 0.0002 to about 0.0004 mg/L, about 0.0004 to about 0.0006 mg/L, or about 0.0006 to about 0.0008 mg/L). In some embodiments, about 0.000002% to about 0.0009% by mass (e.g., about 0.000002% to about 0.000005% by mass, about 0.000005% to about 0.00001% by mass, about 0.00001% to about 0.00002% by mass, about 0.00002% to about 0.00005% by mass, about 0.00005% to about 0.0001% by mass, about 0.0001% to about 0.0003% by mass, about 0.0003% to about 0.0005% by mass, about 0.0005% to about 0.0007% by mass, about 0.0007% to about 0.0009% by mass, about 0.0001% to about 0.0005% by mass, or about 0.0005% to about 0.0009% by mass) of the one or more additional VOCs can be methyl anthranilate. In some embodiments, the one or more additional VOCs can include no methyl anthranilate.

The one or more additional VOCs in a Moscato-like alcoholic beverage can include methyl cyclopentenolone. In some embodiments, the methyl cyclopentenolone can be present in an amount of about 0.02 mg/L to about 0.06 mg/L (e.g., about 0.02 mg/L to about 0.04 mg/L or about 0.04 to about 0.06 mg/L). In some embodiments, about 0.0005% to about 0.07% by mass (e.g., about 0.0005% to about 0.001% by mass, about 0.001% to about 0.005% by mass, about 0.005% to about 0.01% by mass, about 0.01% to about 0.05% by mass, about 0.01% to about 0.03% by mass, about 0.03% to about 0.05% by mass, or about 0.05% to about 0.07% by mass) of the one or more additional VOCs can be methyl cyclopentenolone. In some embodiments, the one or more additional VOCs can include no methyl cyclopentenolone.

The one or more additional VOCs in a Moscato-like alcoholic beverage can include methyl decanoate. In some embodiments, the methyl decanoate can be present in an amount of about 0.0002 mg/L to about 0.006 mg/L (e.g., about 0.0002 to about 0.0005 mg/L, about 0.0005 to about 0.001 m/L, about 0.001 to about 0.005 mg/L, about 0.001 to about 0.006 mg/L, about 0.001 to about 0.002 mg/L, about 0.002 to about 0.004 mg/L, or about 0.004 to about 0.006 mg/L). In some embodiments, about 0.000006% to about 0.007% by mass (e.g., about 0.000006% to about 0.00001% by mass, about 0.00001% to about 0.00002% by mass, about 0.00002% to about 0.00005% by mass, about 0.00005% to about 0.0001% by mass, about 0.0001% to about 0.0002% by mass, about 0.0002% to about 0.0005% by mass, about 0.0005% to about 0.001% by mass, about 0.001% to about 0.005% by mass, about 0.001% to about 0.007% by mass, about 0.001% to about 0.003% by mass, about 0.003% to about 0.005% by mass, or about 0.005% to about 0.007% by mass) of the one or more additional VOCs can be methyl decanoate. In some embodiments, the one or more additional VOCs can include no methyl decanonate.

The one or more additional VOCs in a Moscato-like alcoholic beverage can include methyl hexanoate. In some embodiments, the methyl hexanoate can be present in an amount of about 0.001 mg/L to about 5 mg/L (e.g., about 0.001 to about 0.005 mg/L, about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 2 mg/L, about 2 to about 3 mg/L, about 3 to about 4 mg/L, or about 4 to about 5 mg/L). In some embodiments, about 0.00005% to about 6% by mass (e.g., about 0.00005% to about 0.0001%, about 0.0001% to about 0.0005%, about 0.0005% to about 0.001% by mass, about 0.001% to about 0.005% by mass, about 0.005% to about 0.01% by mass, about 0.01% to about 0.05% by mass, about 0.05% to about 0.1% by mass, about 0.1% to about 0.5% by mass, about 0.5% to about 1% by mass, about 1% to about 5% by mass, about 1% to about 6% by mass, about 1% to about 2% by mass, about 2% to about 3% by mass, about 3% to about 4% by mass, about 4% to about 5% by mass, or about 5% to about 6% by mass) of the one or more additional VOCs can be methyl hexanoate. In some embodiments, the one or more additional VOVs can include no methyl hexanoate.

The one or more additional VOCs in a Moscato-like alcoholic beverage can include methyl laurate. In some embodiments, the methyl laurate can be present in an amount of about 0.00002 mg/L to about 0.001 mg/L (e.g., about 0.00002 to about 0.00005 mg/L, about 0.00005 to about 0.0001 mg/L, about 0.0001 to about 0.0002 mg/L, about 0.0002 to about 0.0005 mg/L, or about 0.0005 to about 0.001 mg/L). In some embodiments, about 0.0000005% to about 0.001% by mass (e.g., about 0.0000005% to about 0.000001% by mass, about 0.000001% to about 0.000005% by mass, about 0.000005% to about 0.00001% by mass, about 0.00001% to about 0.00005% by mass, about 0.00005% to about 0.0001% by mass, about 0.0001% to about 0.0003% by mass, about 0.0003% to about 0.0005% by mass, or about 0.0005% to about 0.001% by mass) of the one or more additional VOCs can be methyl laurate. In some embodiments, the one or more additional VOCs can include no methyl laurate.

The one or more additional VOCs in a Moscato-like alcoholic beverage can include methyl octanoate. In some embodiments, the methyl octanoate can be present in an amount of about 0.002 mg/L to about 0.14 mg/L (e.g., about 0.002 to about 0.005 mg/L, about 0.005 to about 0.01 mg/L, about 0.01 to about 0.02 mg/L, about 0.01 to about 0.05 mg/L, about 0.05 to about 0.1 mg/L, about 0.02 to about 0.04 mg/L, about 0.06 to about 0.08 mg/L, about 0.08 to about 0.10 mg/L, about 0.10 to about 0.12 mg/L, or about 0.12 to about 0.14 mg/L). In some embodiments, about 0.00007% to about 0.2% by mass (e.g., about 0.00007% to about 0.0001% by mass, about 0.0001% to about 0.0005% by mass, about 0.0005% to about 0.001% by mass, about 0.001% to about 0.005% by mass, about 0.005% to about 0.01% by mass, about 0.01% by mass to about 0.02% by mass, about 0.02% to about 0.05% by mass, about 0.05% to about 0.07% by mass, about 0.05% to about 0.1% by mass, or about 0.1% to about 0.2% by mass) of the one or more additional VOCs can be methyl octanoate. In some embodiments, the one or more additional VOCs can include no methyl octanoate.

The one or more additional VOCs in a Moscato-like alcoholic beverage can include methyl salicylate. In some embodiments, the methyl salicylate can be present in an amount of about 0.00006 mg/L to about 0.003 mg/L (e.g. about 0.00006 to about 0.0001 mg/L, about 0.0001 to about 0.0005 mg/L, about 0.0005 to about 0.001 mg/L, about 0.001 to about 0.003 mg/L, about 0.001 to about 0.002 mg/L, or about 0.002 to about 0.003 mg/L). In some embodiments, about 0.000002% to about 0.003% by mass (e.g., about 0.000002% to about 0.000005% by mass, about 0.000005% to about 0.00001% by mass, about 0.00001% to about 0.00005% by mass, about 0.00005% to about 0.0001% by mass, or about 0.0001% to about 0.0005% by mass, about 0.0005% to about 0.001% by mass, about 0.001% to about 0.003% by mass, about 0.001% to about 0.002% by mass, or about 0.002% to about 0.003% by mass) of the one or more additional VOCs can be methyl salicylate. In some embodiments, the one or more additional VOCs can include no methyl salicylate.

The one or more additional VOCs in a Moscato-like alcoholic beverage can include methyl vanillate. In some embodiments, the methyl vanillate can be present in an amount of about 0.03 mg/L to about 0.35 mg/L (e.g., about 0.03 to about 0.05 mg/L, about 0.05 to about 0.10 mg/L, about 0.10 to about 0.15 mg/L, about 0.15 to about 0.20 mg/L, about 0.20 to about 0.25 mg/L, about 0.25 to about 0.30 mg/L, or about 0.30 to about 0.35 mg/L). In some embodiments, about 0.0008% to about 0.4% by mass (e.g., about 0.0008% to about 0.001% by mass, about 0.001% to about 0.005% by mass, about 0.005% to about 0.01% by mass, about 0.01% to about 0.05% by mass, about 0.05% to about 0.1% by mass, about 0.1% to about 0.2% by mass, about 0.2% to about 0.3% by mass, about 0.3% to about 0.4% by mass, or about 0.1% to about 0.4% by mass) of the one or more additional VOCs can be methyl vanillate.

The one or more additional VOCs in a Moscato-like alcoholic beverage can include methyl β-naphthyl ketone. In some embodiments, the methyl β-naphthyl ketone can be present in an amount of about 0.01 mg/L to about 0.03 mg/L (e.g., about 0.01 to about 0.02 mg/L or about 0.02 to about 0.03 mg/L). In some embodiments, about 0.0004% to about 0.04% by mass (e.g., about 0.0004% to about 0.001% by mass, about 0.0005% to about 0.001% by mass, about 0.001% to about 0.005% by mass, about 0.005% to about 0.01% by mass, about 0.01% to about 0.04% by mass, about 0.01% to about 0.02% by mass, about 0.02% to about 0.03% by mass, or about 0.03% to about 0.04% by mass) of the one or more additional VOCs can be methyl β-naphthyl ketone. In some embodiments, the one or more additional VOCs can include no methyl β-naphthyl ketone.

The one or more additional VOCs in a Moscato-like alcoholic beverage can include myrcene. In some embodiments, the myrcene can be present in an amount of about 0.0006 mg/L to about 0.0030 mg/L (e.g., about 0.0006 to about 0.0010 mg/L, about 0.0010 to about 0.0015 mg/L, about 0.0015 to about 0.0020 mg/L, about 0.0020 to about 0.0025 mg/L, or about 0.0025 to about 0.0030 mg/L). In some embodiments, about 0.00002% to about 0.003% by mass (e.g., 0.00002% to about 0.00005% by mass, about 0.00005% to about 0.0001% by mass, about 0.0001% to about 0.0002% by mass, about 0.0002% to about 0.0005% by mass, about 0.0005% to about 0.001% by mass, about 0.001% to about 0.002% by mass, about 0.002% to about 0.003% by mass, or about 0.001% to about 0.003% by mass) of the one or more additional VOCs can be myrcene. In some embodiments, the one or more additional VOCs can include no myrcene.

The one or more additional VOCs in a Moscato-like alcoholic beverage can include myrtenol. In some embodiments, the myrtenol can be present in an amount of about 0.035 mg/L to about 0.090 mg/L (e.g., about 0.035 to 0.040 mg/L, about 0.040 to about 0.050 mg/L, about 0.050 to about 0.060 mg/L, about 0.060 to about 0.070 mg/L, about 0.070 to about 0.080 mg/L, or about 0.080 to about 0.090 mg/L). In some embodiments, about 0.001% to about 0.1% by mass (e.g., about 0.001% to about 0.005% by mass, about 0.005% to about 0.01% by mass, about 0.01% to about 0.02% by mass, about 0.02% to about 0.04% by mass, about 0.04% to about 0.06% by mass, about 0.06% to about 0.08% by mass, about 0.08% to about 0.1% by mass, about 0.01% to about 0.05% by mass, or about 0.05% to about 0.1% by mass) of the one or more additional VOCs can be myrtenol. In some embodiments, the one or more additional VOCs can include no myrtenol.

The one or more additional VOCs in a Moscato-like alcoholic beverage can include nerol. In some embodiments, the nerol can be present in an amount of about 0.0009 mg/L to about 0.25 mg/L (e.g., about 0.0008 to about 0.001 mg/L, about 0.001 to about 0.002 mg/L, about 0.002 to about 0.003 mg/L, about 0.003 to about 0.005 mg/L, about 0.005 to about 0.01 mg/L, about 0.01 to about 0.05 mg/L, about 0.05 to about 0.10 mg/L, about 0.10 to about 0.15 mg/L, about 0.1 to about 0.2 mg/L, about 0.15 to about 0.20 mg/L, or about 0.20 to about 0.25 mg/L). In some embodiments, the nerol can be present in an amount of at least about 0.006 mg/L (e.g., at least about 0.007 mg/L, 0.008 mg/L, 0.009 mg/L, 0.01 mg/L, 0.02 mg/L, 0.03 mg/L, 0.04 mg/L, 0.05 mg/L, 0.06 mg/L, 0.07 mg/L, 0.08 mg/L, 0.09 mg/L, 0.1 mg/L, 0.15 mg/L, or 0.2 mg/L). In some embodiments, about 0.00002% to about 0.2% by mass (e.g., about 0.00002% to about 0.00005% by mass, about 0.00005% to about 0.0001% by mass, about 0.0001% to about 0.0002% by mass, about 0.0002% to about 0.0005% by mass, about 0.0005% to about 0.001% by mass, about 0.001% to 0.005% by mass, about 0.005% to about 0.01% by mass, about 0.01% to about 0.05% by mass, about 0.05% to about 0.1% by mass, about 0.1% to about 0.2% by mass) of the one or more additional VOCs can be nerol. In some embodiments, at least about 0.007% by mass (e.g., at least about 0.008%, 0.009%, 0.01%, 0.02%, 0.03%, 0.04%, 0.05%, 0.06%, 0.07%, 0.08%, 0.09%, or 0.1% by mass) of the one or more additional VOCs can be nerol.

The one or more additional VOCs in a Moscato-like alcoholic beverage can include nerolidol. In some embodiments, the nerolidol can be present in an amount of about 0.001 to about 0.003 mg/L (e.g., about 0.001 to about 0.002 mg/L or about 0.002 to about 0.003 mg/L). In some embodiments, about 0.00004% to about 0.004% by mass (e.g., about 0.00004% to about 0.0001% by mass, about 0.00005% to about 0.0001% by mass, about 0.0001% to about 0.0005% by mass, about 0.0005% by mass to about 0.001% by mass, about 0.001% by mass to about 0.004% by mass, about 0.001% to about 0.002% by mass, about 0.002% to about 0.003% by mass, or about 0.003% to about 0.004% by mass) of the one or more additional VOCs can be nerolidol. In some embodiments, the one or more additional VOCs can include no nerolidol.

The one or more additional VOCs in a Moscato-like alcoholic beverage can include nonanal. In some embodiments, the nonanal can be present in an amount of about 0.004 mg/L to about 0.02 mg/L (e.g., about 0.004 to about 0.01 mg/L, about 0.005 to about 0.01 mg/L, or about 0.01 to about 0.02 mg/L). In some embodiments, about 0.0001% to about 0.025% by mass (e.g., 0.0001% to about 0.0005% by mass, about 0.0005% to about 0.001% by mass, about 0.001% to about 0.005% by mass, about 0.005% to about 0.01% by mass, about 0.01% to about 0.02% by mass, about 0.010% to about 0.015% by mass, about 0.015% to about 0.020% by mass, about 0.020% to about 0.025% by mass, about 0.005% to about 0.015% by mass, or about 0.015% to about 0.025% by mass) of the one or more additional VOCs can be nonanal. In some embodiments, the one or more additional VOCs can include no nonanal.

The one or more additional VOCs in a Moscato-like alcoholic beverage can include octanoic acid. In some embodiments, the octanoic acid can be present in an amount of about 1.3 mg/L to about 12 mg/L (e.g., about 1.3 to about 2 mg/L, about 2 to about 3 mg/L, about 3 to about 4 mg/L, about 4 to about 6 mg/L, about 6 to about 8 mg/L, about 8 to about 10 mg/L, about 10 to about 12 mg/L, or about 10 to about 12 mg/L). In some embodiments, about 0.04% to about 13% by mass (e.g., about 0.04% to about 0.1% by mass, about 0.1% to about 0.5% by mass, about 0.5% to about 1% by mass, about 1% to about 2% by mass, about 2% to about 4% by mass, about 4% to about 6% by mass, about 6% to about 8% by mass, about 8% to about 10% by mass, about 10% to about 12% by mass, about 1% to about 5% by mass, about 5% to about 10% by mass, or about 10% to about 13% by mass) of the one or more additional VOCs can be octanoic acid. In some embodiments, the one or more additional VOCs can include no octanoic acid.

The one or more additional VOCs in a Moscato-like alcoholic beverage can include octyl acetate. In some embodiments, the octyl acetate can be present in an amount of about 0.0006 mg/L to about 0.0013 mg/L (e.g., about 0.0006 to about 0.0007 mg/L, about 0.0007 to about 0.0008 mg/L, about 0.0008 to about 0.0009 mg/L, about 0.0009 to about 0.0011 mg/L, about 0.0010 to about 0.0011 mg/L, about 0.0011 to about 0.0012 mg/L, or about 0.0012 to about 0.0013 mg/L). In some embodiments, about 0.00002% to about 0.002% by mass (e.g., about 0.00002% to about 0.00005% by mass, about 0.00005% to about 0.0001% by mass, about 0.0001% to about 0.0002%, about 0.0002% to about 0.0005% by mass, about 0.0005% to about 0.001% by mass, or about 0.001% to about 0.002% by mass) of the one or more additional VOCs can be octyl acetate. In some embodiments, the one or more additional VOCs can include no octyl acetate.

The one or more additional VOCs in a Moscato-like alcoholic beverage can include p,a-dimethylstyrene. In some embodiments, the p,a-dimethylstyrene can be present in an amount of about 0.0001 to about 0.0004 mg/L (e.g., about 0.0001 to about 0.0002 mg/L, about 0.0002 to about 0.0003 mg/L, or about 0.0003 to about 0.0004 mg/L). In some embodiments, about 0.000004% to about 0.0005% by mass (e.g., about 0.000004% to about 0.00001% by mass, about 0.000005% to about 0.00001% by mass, about 0.00001% to about 0.00005% by mass, about 0.00005% to about 0.0001% by mass, or about 0.0001% to about 0.0005% by mass) of the one or more additional VOCs can be p,a-dimethylstyrene. In some embodiments, the one or more additional VOCs can include no p,a-dimethylstyrene.

The one or more additional VOCs in a Moscato-like alcoholic beverage can include p-cresol. In some embodiments, the p-cresol can be present in an amount of 0.003 mg/L to about 0.006 mg/L (e.g., about 0.003 to about 0.004 mg/L, about 0.004 to about 0.005 mg/L, or about 0.005 to about 0.006 mg/L). In some embodiments, about 0.00008% to about 0.007% by mass (e.g., about 0.00008% to about 0.0001% by mass, about 0.0001% to about 0.0005% by mass, about 0.0005% to about 0.001% by mass, about 0.001% to about 0.002% by mass, about 0.002% to about 0.003% by mass, about 0.003% to about 0.004% by mass, about 0.004% to about 0.005% by mass, about 0.005% to about 0.006% by mass, about 0.006% to about 0.007% by mass, about 0.001% to about 0.005% by mass, or about 0.001% to about 0.007% by mass) of the one or more additional VOCs can be p-cresol. In some embodiments, the one or more additional VOCs can include no p-cresol.

The one or more additional VOCs in a Moscato-like alcoholic beverage can include p-cymene. In some embodiments, the p-cymene can be present in an amount of about 0.00013 mg/L to about 0.015 mg/L (e.g., about 0.00013 to about 0.0005 mg/L, about 0.0005 to about 0.001 mg/L, about 0.001 to about 0.005 mg/L, about 0.005 to about 0.010 mg/L, about 0.005 to about 0.015 mg/L, or about 0.010 to about 0.015 mg/L). In some embodiments, the p-cymene is present in an amount of at least about 0.0006 mg/L (e.g., at least about 0.0007 mg/L, about 0.0008 mg/L, 0.0009 mg/L, 0.001 mg/L, 0.002 mg/L, 0.003 mg/L, 0.004 mg/L, 0.005 mg/L, 0.006 mg/L, 0.007 mg/L, 0.008 mg/L, 0.009 mg/L, 0.010 mg/L, 0.011 mg/L, 0.012 mg/L, 0.013 mg/L, or 0.014 mg/L). In some embodiments, about 0.000004% to about 0.015% by mass (e.g., about 0.000004% to about 0.000005% by mass, about 0.000005% to about 0.00001% by mass, about 0.00001% to about 0.00002% by mass, about 0.00002% to about 0.00005% by mass, about 0.00005% to about 0.0001% by mass, about 0.0001% to about 0.0005% by mass, about 0.0005% to about 0.001% by mass, about 0.001% to about 0.005% by mass, about 0.005% to about 0.010% by mass, about 0.010% to about 0.015% by mass, or about 0.005% to about 0.015% by mass) of the one or more additional VOCs can be p-cymene. In some embodiments, at least about 0.0007% by mass (e.g., at least about 0.0008%, 0.0009%, 0.001%, 0.002%, 0.003%, 0.004%, 0.005%, 0.006%, 0.007%, 0.008%, 0.009%, 0.010%, 0.011%, 0.012%, 0.013%, or 0.014% by mass) of the one or more additional VOCs can be p-cymene. In some embodiments, the one or more additional VOCs can include no p-cymene.

The one or more additional VOCs in a Moscato-like alcoholic beverage can include phenethyl butyrate. In some embodiments, the phenethyl butyrate can be present in an amount of about 0.0005 mg/L to about 0.03 mg/L (e.g., about 0.0005 to about 0.001 mg/L, about 0.001 to about 0.005 mg/L, about 0.005 to about 0.01 mg/L, about 0.01 to about 0.02 mg/L, or about 0.02 to about 0.03 mg/L). In some embodiments, the phenethyl butyrate can be present in an amount of at least about 0.0017 mg/L (e.g., at least about 0.0018 mg/L, 0.0019 mg/L, 0.0020 mg/L, 0.0022 mg/L, 0.0024 mg/L, 0.0026 mg/L, or 0.0028 mg/L). In some embodiments, about 0.00001% to about 0.04% by mass (e.g., about 0.00001% to about 0.00005% by mass, about 0.00005% to about 0.0001% by mass, about 0.0001% to about 0.0005% by mass, about 0.0005% to about 0.001% by mass, 0.001% to about 0.005% by mass, about 0.005% to about 0.01% by mass, about 0.01% to about 0.02% by mass, about 0.02% to about 0.03% by mass, about 0.03% to about 0.04% by mass, about 0.01% to about 0.04% by mass, or about 0.02% to about 0.04% by mass) of the one or more additional VOCs can be phenethyl butyrate. In some embodiments, at least about 0.002% by mass (e.g., about 0.003%, 0.004%, 0.005%, 0.006%, 0.007%, 0.008%, 0.009%, 0.01%, 0.02%, or 0.03% by mass) of the one or more additional VOCs can be phenethyl butyrate. In some embodiments, the one or more additional VOCs can include no phenethyl butyrate.

The one or more additional VOCs in a Moscato-like alcoholic beverage can include phenethyl octanoate. In some embodiments, the phenethyl octanoate can be present in an amount of about 0.00005 mg/L to about 0.0020 mg/L (e.g., about 0.00005 to about 0.0001 mg/L, about 0.0001 to about 0.0005 mg/L, about 0.0005 to about 0.0010 mg/L, about 0.0010 to about 0.0012 mg/L, about 0.0012 to about 0.0014 mg/L, about 0.0014 to about 0.0016 mg/L, about 0.0016 to about 0.0018 mg/L, or about 0.0018 to about 0.0020 mg/L). In some embodiments, about 0.000002% to about 0.0025% by mass (e.g., about 0.000002% to about 0.000005% by mass, about 0.000005% to about 0.00001% by mass, about 0.00001% to about 0.00005% by mass, about 0.00005% to about 0.00010% by mass, about 0.00005% to about 0.0001% by mass, about 0.0001% to about 0.0002% by mass, about 0.0002% to about 0.0005% by mass, about 0.0005% to about 0.001% by mass, about 0.001% to about 0.002% by mass, about 0.0005% to about 0.0015% by mass, about 0.0015% to about 0.0025% by mass, about 0.0010% to about 0.0015% by mass, about 0.0015% to about 0.0020% by mass, or about 0.0020% to about 0.0025% by mass) of the one or more additional VOCs can be phenethyl octanoate. In some embodiments, the one or more additional VOCs can include no phenethyl octanoate.

The one or more additional VOCs in a Moscato-like alcoholic beverage can include phenethyl propionate. In some embodiments, the phenethyl propionate can be present in an amount of about 0.00006 mg/L to about 0.12 mg/L (e.g., about 0.00006 to about 0.0001 mg/L, about 0.0001 to about 0.0005 mg/L, about 0.0005 to about 0.001 mg/L, about 0.001 to about 0.005 mg/L, about 0.005 to about 0.01 mg/L, about 0.01 to about 0.02 mg/L, about 0.02 to about 0.03 mg/L, about 0.03 to about 0.04 mg/L, about 0.04 to about 0.05 mg/L, about 0.05 to about 0.06 mg/L, about 0.06 to about 0.07 mg/L, about 0.07 to about 0.08 mg/L, about 0.08 to about 0.09 mg/L, about 0.09 to about 0.10 mg/L, about 0.10 to about 0.11 mg/L, or about 0.11 to about 0.12 mg/L). In some embodiments, the phenethyl propionate is present in an amount of at least about 0.0002 mg/L (e.g., at least about 0.0003 mg/L, 0.0004 mg/L, 0.0005 mg/L, 0.0006 mg/L, 0.007 mg/L, 0.0008 mg/L, 0.0009 mg/L, 0.001 mg/L, 0.002 mg/L, 0.003 mg/L, 0.004 mg/L, 0.005 mg/L, 0.006 mg/L, 0.007 mg/L, 0.008 mg/L, 0.009 mg/L, 0.01 mg/L, 0.02 mg/L, 0.04 mg/L, 0.06 mg/L, 0.08 mg/L, or 0.1 mg/L) In some embodiments, about 0.000002% to about 0.09% by mass (e.g., about 0.000002% to about 0.000005% by mass, about 0.000005% to about 0.00001% by mass, about 0.00001% to about 0.00005% by mass, about 0.00005% to about 0.0001% by mass, about 0.0001% to about 0.0005% by mass, about 0.0005% to about 0.001% by mass, about 0.001% by mass to about 0.005% by mass, about 0.05% to about 0.01% by mass, about 0.01% by mass to about 0.02% by mass, about 0.02% by mass to about 0.04% by mass, about 0.04% by mass to about 0.06% by mass, about 0.06% to about 0.08% by mass, or about 0.08% to about 0.09% by mass) of the one or more additional VOCs can be phenethyl propionate. In some embodiments, at least about 0.00025% by mass (e.g., at least about 0.0003%, 0.0004%, 0.0005%, 0.0006%, 0.0007%, 0.0008%, 0.0009%, 0.001%, 0.002%, 0.003%, 0.004%, 0.005%, 0.006%, 0.007%, 0.008%, 0.009%, 0.01%, 0.02% 0.03%, 0.04%, 0.05%, or 0.06% by mass) of the one or more additional VOCs can be phenethyl propionate. In some embodiments, the one or more additional VOCs can include phenethyl propionate.

The one or more additional VOCs in a Moscato-like alcoholic beverage can include propanol (also called 1-propanol). In some embodiments, the propanol can be present in an amount of about 0.2 mg/L to about 18 mg/L (e.g., about 0.2 to about 0.4 mg/L, about 0.4 to about 0.6 mg/L, about 0.6 to about 0.8 mg/L, about 0.8 to about 1 mg/L, about 1 to about 1.5 mg/L, about 1.5 to about 2 mg/L, about 2 to about 3 mg/L, about 3 to about 5 mg/L, about 1 to about 5 mg/L, about 5 to about 10 mg/L, about 10 to about 15 mg/L, about 5 to about 7 mg/L, about 7 to about 9 mg/L, about 9 to about 11 mg/L, about 11 to about 13 mg/L, about 13 to about 15 mg/L, about 15 to about 17 mg/L, or about 15 to about 18 mg/L). In some embodiments the propanol can be present in an amount of less than about 1.35 mg/L (e.g., less than about 1.2 mg/L, 1.1 mg/L, 1.0 mg/L, 0.9 mg/L, 0.8 mg/L, 0.7 mg/L, 0.6 mg/L, 0.5 mg/L, or 0.4 mg/L). In some embodiments, about 0.05% to about 20% by mass (e.g., about 0.05% to about 0.1% by mass, about 0.1% to about 0.5% by mass, about 0.5% to about 1% by mass, about 1% to about 2% by mass, about 2% to about 5% by mass, about 5% to about 10% by mass, about 10% to about 15% by mass, or about 15% to about 20% by mass) of the one or more VOCs can be propanol. In some embodiments, the one or more additional VOCs can include no propanol.

The one or more additional VOCs in a Moscato-like alcoholic beverage can include phenylacetaldehyde. In some embodiments, the phenylacetaldehyde can be present in an amount of about 0.02 mg/L to about 0.08 mg/L (e.g., about 0.02 to about 0.04 mg/L, about 0.04 to about 0.06 mg/L, or about 0.06 to about 0.08 mg/L). In some embodiments, about 0.0007% to about 0.09% by mass (e.g., about 0.0007% to about 0.001% by mass, about 0.001% to about 0.005% by mass, about 0.005% to about 0.01% by mass, about 0.01% to about 0.05%, or about 0.05% to about 0.09% by mass) of the one or more additional VOCs can be phenylacetaldehyde. In some embodiments, the one or more additional VOCs can include no phenylacetaldehyde.

The one or more additional VOCs in a Moscato-like alcoholic beverage can include propyl acetate. In some embodiments, the propyl acetate can be present in an amount of about 0.002 mg/L to about 0.005 mg/L (e.g., about 0.002 to about 0.003 mg/L, about 0.003 to about 0.004 mg/L, or about 0.004 to about 0.005 mg/L). In some embodiments, about 0.00006% to about 0.006% by mass (e.g., about 0.00006% to about 0.0001% by mass, about 0.0001% to about 0.0005% by mass, about 0.0005% to about 0.001% by mass, about 0.001% to about 0.002% by mass, about 0.002% to about 0.003% by mass, about 0.003% to about 0.004% by mass, about 0.004% to about 0.005% by mass, about 0.005% to about 0.006% by mass, about 0.001% to about 0.005% by mass, or about 0.001% to about 0.006% by mass) of the one or more additional VOCs can be propyl acetate. In some embodiments, the one or more additional VOCs include no propyl acetate.

The one or more additional VOCs in a Moscato-like alcoholic beverage can include propyl butyrate. In some embodiments, the propyl butyrate can be present in an amount of about 0.001 mg/L to about 0.003 mg/L (e.g., about 0.001 to about 0.002 mg/L or about 0.002 to about 0.003 mg/L). In some embodiments, about 0.00004% to about 0.004% by mass (e.g., about 0.00004% to about 0.0001% by mass, about 0.00005% to about 0.0001% by mass, about 0.0001% to about 0.0005% by mass, about 0.0005% to about 0.001% by mass, about 0.001% to about 0.004% by mass, about 0.001% to about 0.002% by mass, about 0.002% to about 0.003% by mass, or about 0.003% to about 0.004% by mass) of the one or more additional VOCs can be propyl butyrate. In some embodiments, the one or more additional VOCs can include no propyl butyrate.

The one or more additional VOCs in a Moscato-like alcoholic beverage can include propyl hexanoate. In some embodiments, the propyl hexanoate can be present in an amount of about 0.00006 mg/L to about 0.00013 mg/L (e.g., about 0.00006 to about 0.00007 mg/L, about 0.00007 to about 0.00008 mg/L, about 0.00008 to about 0.00009 mg/L, about 0.00009 to about 0.00010 mg/L, about 0.00010 to about 0.00011 mg/L, about 0.00011 to about 0.00012 mg/L, or about 0.00012 to about 0.00013 mg/L). In some embodiments, about 0.000002% to about 0.0002% by mass (e.g., about 0.000002% to about 0.000005% by mass, about 0.000005% to about 0.00001% by mass, about 0.00001% to about 0.00002% by mass, about 0.00002% to about 0.00005% by mass, about 0.00005% to about 0.0001% by mass, or about 0.0001% to about 0.0002% by mass) of the one or more additional VOCs can be propyl hexanoate. In some embodiments, the one or more additional VOCs can include no propyl hexanoate.

The one or more additional VOCs in a Moscato-like alcoholic beverage can include salicylaldehyde. In some embodiments, the salicylaldehyde can be present in an amount of about 0.0005 mg/L to about 0.0015 mg/L (e.g., about 0.0005 to about 0.0010 mg/L, or about 0.0010 to about 0.0015 mg/L). In some embodiments, about 0.00001% to about 0.002% by mass (e.g., about 0.00001% to about 0.00005% by mass, about 0.00005% to about 0.0001% by mass, about 0.0001% to about 0.0002% by mass, about 0.0002% to about 0.0005% by mass, about 0.0005% to about 0.001% by mass, or about 0.001% to about 0.002% by mass) of the one or more additional VOCs can be salicylaldehyde. In some embodiments, the one or more additional VOCs can include no salicylaldehyde.

The one or more additional VOCs in a Moscato-like alcoholic beverage can include terpinolene. In some embodiments, the terpinolene can be present in an amount of about 0.001 mg/L to about 0.003 mg/L (e.g., about 0.001 to about 0.002 mg/L or about 0.002 to about 0.003 mg/L). In some embodiments, about 0.00003% to about 0.004% by mass (e.g., about 0.00003% to about 0.00005% by mass, about 0.00005% to about 0.0001% by mass, about 0.0001% to about 0.0005% by mass, about 0.0005% to about 0.001% by mass, about 0.001% to about 0.004% by mass, about 0.001% to about 0.002% by mass, about 0.002% to about 0.003% by mass, or about 0.003% to about 0.004% by mass) of the one or more additional VOCs can be terpinolene. In some embodiments, the one or more additional VOCs can include no terpinolene.

The one or more additional VOCs in a Moscato-like alcoholic beverage can include trans-2-pentenal. In some embodiments, the trans-2-pentenal can be present in an amount of about 0.08 mg/L to about 0.20 mg/L (e.g., about 0.08 to about 0.10 mg/L, about 0.10 to about 0.12 mg/L, about 0.12 to about 0.14 mg/L, about 0.14 to about 0.16 mg/L, about 0.16 to about 0.18 mg/L, or about 0.18 to about 0.20 mg/L). In some embodiments, about 0.002% to about 0.3% by mass (e.g., about 0.002% to about 0.005%, about 0.005% to about 0.01% by mass, about 0.01% to about 0.02% by mass, about 0.02% to about 0.05% by mass, about 0.05% to about 0.1% by mass, about 0.1% to about 0.2% by mass, about 0.2% to about 0.3% by mass, or about 0.1% to about 0.3% by mass) of the one or more additional VOCs can be trans-2-pentenal. In some embodiments, the one or more additional VOCs can include no trans-2-pentenal.

The one or more additional VOCs in a Moscato-like alcoholic beverage can include trans-2-heptenal. In some embodiments, the trans-2-heptenal can be present in an amount of about 0.0003 mg/L to about 0.0007 mg/L (e.g., about 0.0003 to about 0.0004 mg/L, about 0.0004 to about 0.0005 mg/L, about 0.0005 to about 0.0006 mg/L, or about 0.0006 to about 0.0007 mg/L). In some embodiments, about 0.00001% to about 0.0008% by mass (e.g., about 0.00001% to about 0.00005% by mass, about 0.00005% to about 0.0001% by mass, about 0.0001% to about 0.002% by mass, about 0.002% to about 0.003% by mass, about 0.003% to about 0.004% by mass, about 0.004% to about 0.005% by mass, about 0.005% to about 0.006% by mass, about 0.006% to about 0.007% by mass, about 0.007% to about 0.008% by mass, about 0.001% to about 0.005% by mass, or about 0.005% to about 0.008% by mass) of the one or more additional VOCs can be trans-2-heptenal. In some embodiments, the one or more additional VOCs can include no trans-2-heptenal.

The one or more additional VOCs in a Moscato-like alcoholic beverage can include trans-2-hexen-1-al. In some embodiments, the trans-2-hexen-1-al can be present in an amount of about 0.004 mg/L to about 0.012 mg/L (e.g., about 0.004 to about 0.006 mg/L, about 0.006 to about 0.008 mg/L, about 0.008 to about 0.010 mg/L, or about 0.010 to about 0.012 mg/L). In some embodiments, about 0.0001% to about 0.015% by mass (e.g., about 0.0001% to about 0.0005% by mass, about 0.0005% to about 0.001% by mass, about 0.001% to about 0.005% by mass, about 0.005% to about 0.01% by mass, about 0.010% to about 0.015% by mass, or about 0.005% to about 0.015% by mass) of the one or more additional VOCs can be trans-2-hexen-1-al. In some embodiments, the one or more additional VOCs include no trans-2-hexen-1-al.

The one or more additional VOCs in a Moscato-like alcoholic beverage can include trans-2-hexen-1-ol. In some embodiments, the trans-2-hexen-1-ol can be present in an amount of about 0.04 mg/L to about 0.11 mg/L (e.g., about 0.04 to about 0.06 mg/L, about 0.06 to about 0.08 mg/L, about 0.08 to about 0.10 mg/L, or about 0.08 to about 0.11 mg/L). In some embodiments, about 0.001% to about 0.08% by mass (e.g., about 0.001% to about 0.005% by mass, about 0.005% to about 0.15% by mass, about 0.01% to about 0.02% by mass, about 0.02% to about 0.04% by mass, about 0.04% to about 0.06% by mass, about 0.06% to about 0.08% by mass, about 0.08% to about 0.10% by mass, about 0.10% to about 0.12% by mass, about 0.12% to about 0.14% by mass, about 0.12% to about 0.15% by mass, about 0.01% to about 0.05% by mass, about 0.05% to about 0.10% by mass, or about 0.10% to about 0.15% by mass) of the one or more additional VOCs can be trans-2-hexen-1-ol. In some embodiments, the one or more additional VOCs can include no trans-2-hexen-1-ol.

The one or more additional VOCs in a Moscato-like alcoholic beverage can include one or more compounds selected from the group consisting of 1,1-diethoxyethane, 2-methylbutyl isovalerate, acetophenone, ethyl heptanoate, ethyl salicylate, ethyl(methylthio) acetate, isoamyl hexanoate, isoamyl isobutyrate, isobutyl isobutyrate, ethyl trans-3-hexenoate, 2,6-dimethyl-5-heptenal, 2-isobutyl-3-methoxypyrazine, amyl formate, dimethyl anthranilate, ethyl heptanoate, ethyl-trans-3-hexenoate, geranyl acetate, isoamyl hexanoate, and L/D-carvone.

In some cases, the total amount of VOCs in a Moscato replica can be less than the total amount of VOCs in a reference Moscato. For example, a Moscato-like alcoholic beverage can have a total VOC content that is 145 mg/L or less (e.g., 140 mg/L or less, 130 mg/L or less, 125 mg/L or less, 120 mg/L or less, 110 mg/L or less, or 100 mg/L or less).

Further, the amount of any particular VOC in a Moscato replica may be different than the amount of that VOC in a corresponding reference Moscato. In some cases, the amount of a VOC in a Moscato replica can be 75% or less (e.g., 70% or less, 60% or less, 50% or less, 40% or less, 30% or less, 20% or less, or 10% or less), by concentration or percent mass, than the amount of the same VOC in a corresponding reference Moscato. In some cases, the amount of a VOC in a Moscato replica can be 125% or more (e.g., 150% or more, 200% or more, or 300% or more), by concentration or percent mass, than the amount of the same VOC in a corresponding reference Moscato. For example, a Moscato-like alcoholic beverage can include one or more of the following: 2-nonanone in an amount of at least about 0.0014 mg/L (e.g., about 0.0015, 0.0017, or 0.0017 mg/L), 2-phenylethanol in an amount less than about 13.5 mg/L (e.g., about 13.0, 12.5, or 12.0 mg/L), 2-phenyethylacetate in an amount of at least about 0.15 mg/L (e.g., about 0.16, 0.17, 0.2 mg/L), 2-undecanone in an amount of at least about 0.0014 mg/L (e.g., about 0.0015, 0.0017, or 0.0017 mg/L), 4-carvomenthenol in an amount of at least about 0.02 mg/L (e.g., about 0.03, 0.04, or 0.05 mg/L), benzaldehyde in an amount of at least about 0.022 mg/L (e.g., about 0.023, 0.024, or 0.025 mg/L), beta-pinene in an amount of at least about 0.014 mg/L (e.g., about 0.015, 0.017, or 0.02 mg/L), citronellol in an amount of at least about 0.01 mg/L (e.g., about 0.02, 0.03, or 0.04 mg/L), decanoic acid in an amount of at least about 0.6 mg/L (e.g., about 0.7, 0.8, or 0.9 mg/L), delta-decalactone in an amount of at least about 0.007 mg/L (e.g., about 0.008, 0.009, or 0.01 mg/L), diethyl malate in an amount of less than about 0.35 mg/L (e.g., about 0.34, 0.33, or 0.32 mg/L), diethyl succinate in an amount less than about 0.4 mg/L (e.g., about 0.3, 0.2, or 0.1 mg/L), ethyl acetate in an amount less than about 7 mg/L (e.g., about 6, 5, or 4 mg/L), ethyl butyrate in an amount of at least about 0.5 mg/L (e.g., about 0.6, 0.7, or 0.8 mg/L), ethyl isobutyrate in an amount of at least about 0.3 mg/L (e.g., about 0.4, 0.5, or 0.6 mg/L), ethyl isovalerate in an amount of at least about 0.07 mg/L (e.g., about 0.08, 0.09, or 0.1 mg/L), ethyl lactate in an amount less than about 2 mg/L (e.g., about 1.5, 1.0, or 0.5 mg/L), ethyl myristate in an amount of at least about 0.45 mg/L (e.g., about 0.5, 0.6, or 0.7 mg/L), ethyl valerate in an amount of at least about 0.0012 mg/L (e.g., at least about 0.0013, 0.0014, or 0.0015 mg/L), eucalyptol in an amount of at least about 0.0009 mg/L (e.g., about 0.001, 0.002, or 0.003 mg/L), gamma-decalactone in an amount of at least about 0.012 mg/L (e.g., about 0.012, 0.013, or 0.015 mg/L), gamma-terpinene in an amount of at least about 0.04 mg/L (e.g., about 0.05, 0.06, or 0.07 mg/L), hexanoic acid in an amount of at least about 0.35 mg/L (e.g., about 0.4, 0.5, or 0.6 mg/L), hexyl acetate in an amount of at least about 0.04 mg/L (e.g., about 0.05, 0.06, or 0.07 mg/L), isoamyl acetate in an amount of at least about 1.7 mg/L (e.g., about 1.8, 1.9, or 2 mg/L), isobutyraldehyde in an amount of at least about 0.0035 mg/L (e.g., about 0.004, 0.005, or 0.006 mg/L), isobutyric acid in an amount less than about 1.6 mg/L (e.g., 1.5, 1.4, or 1.3 mg/L), limonene in an amount of at least about 0.012 mg/L (e.g., 0.013, 0.014, or 0.015 mg/L), linalool in an amount of at least about 0.5 mg/L (e.g., about 0.6, 0.7, or 0.8 mg/L), linalyl acetate in an amount of at least about 0.22 mg/L (e.g., about 0.23, 0.24, or 0.25 mg/L), linalyl butyrate in an amount of at least about 0.0002 mg/L (e.g., about 0.0003, 0.0004, or about 0.0005 mg/L), L-rose oxide in an amount of at least about 0.0011 mg/L (e.g., about 0.0012, 0.0013, or 0.0015 mg/L), nerol in an amount of at least about 0.006 mg/L (e.g., about 0.007, 0.008, or 0.01 mg/L), p-cymene in an amount of at least about 0.0006 mg/L (e.g., about 0.0007, 0.0008, or 0.0009 mg/L), phenethyl butyrate in an amount of at least about 0.0017 mg/L (e.g., about 0.0018, 0.0019, or 0.002 mg/L), phenethyl propionate in an amount of at least about 0.0002 mg/L (e.g., about 0.0003, 0.0004, or 0.0005 mg/L), or propanol in an amount less than about 1.35 mg/L (e.g., about 1.3, 1.2, or 1.1 mg/L).

In some embodiments, a Moscato-like alcoholic beverage can include additional VOCs that are characterized by at least one of the following: at least about 0.016% (e.g., about 0.017%, 0.018%, or 0.02%) by mass of the one or more additional VOCs comprises (−)-beta-pinene, at least about 0.0013% (e.g., about 0.0014%, 0.0015%, or 0.0016%) by mass of the one or more additional VOCs comprises L-rose oxide, at least about 0.0017% (e.g., about 0.0018%, 0.0019%, or 0.002%) by mass of the one or more additional VOCs comprises 2-nonanone, at least about 0.18% (e.g., about 0.19%, 0.20%, or 0.25%) by mass of the one or more additional VOCs comprises 2-phenethylacetate, at least about 0.0017% (e.g., about 0.0018%, 0.0019%, or 0.002%) by mass of the one or more additional VOCs comprises 2-undecanone, at least about 0.025% (e.g., about 0.026%, 0.027%, or 0.028%) by mass of the one or more additional VOCs comprises 4-carvomenthenol, at least about 0.026% (e.g., about 0.027%, 0.028%, 0.03%) by mass of the one or more additional VOCs comprises benzaldehyde, at least about 0.012% (e.g., about 0.013%, 0.014%, or 0.015%) by mass of the one or more additional VOCs comprises citronellol, at least about 0.7% (e.g., about 0.8%, 0.9%, or 1%) by mass of the one or more additional VOCs comprises decanoic acid, at least about 0.6% (e.g., about 0.7%, 0.8%, or 1%) by mass of the one or more additional VOCs comprises ethyl butyrate, at least about 0.36% (e.g., about 0.37%, 0.38%, or 0.4%) by mass of the one or more additional VOCs comprises ethyl isobutyrate, at least about 0.09% (e.g., about 0.10%, 0.12%, or 0.15%) by mass of the one or more additional VOCs comprises ethyl isovalerate, at least about 0.0015% (e.g., about 0.0016%, 0.0018%, or 0.002%) by mass of the one or more additional VOCs comprises ethyl valerate, at least about 0.0012% (e.g., about 0.0013%, 0.0014%, or 0.0015%) by mass of the one or more additional VOCs comprises eucalyptol, at least about 0.014% (e.g., about 0.015%, 0.016%, or 0.017%) by mass of the one or more additional VOCs comprises gamma-decalactone, at least about 0.05% (e.g., about 0.06%, 0.08%, or 0.1%) by mass of the one or more additional VOCs comprises gamma terpinene, at least about 0.4% (e.g., about 0.5%, 0.6%, or 0.7%) by mass of the one or more additional VOCs comprises hexanoic acid, at least about 0.05% (e.g., about 0.06%, 0.08%, or 0.1%) by mass of the one or more additional VOCs comprises hexyl acetate, at least about 2% (e.g., about 3%, 4%, or 5%) by mass of the one or more additional VOCs comprises isoamyl acetate, at least about 0.0045% (e.g., about 0.0046%, 0.0048%, or 0.005%) by mass of the one or more additional VOCs comprise isobutyraldehyde, at least about 0.014% (e.g., about 0.0015%, 0.016%, or 0.017%) by mass of the one or more additional VOCs comprises limonene, at least about 0.6% (e.g., about 0.7%, 0.8%, or 1%) by mass of the one or more additional VOCs comprises linalool, at least about 0.25% (e.g., about 0.26%, 0.28%, or 0.3%) by mass of the one or more additional VOCs comprises linalyl acetate, at least about 0.00025% (e.g., about 0.00026%, 0.00028%, or 0.0003%) by mass of the one or more additional VOCs comprises linalyl butyrate, at least about 0.007% (e.g., about 0.008%, 0.009%, or 0.01%) by mass of the one or more additional VOCs comprises nerol, at least about 0.0007% (e.g., about 0.0008%, 0.0009%, or 0.001%) by mass of the one or more additional VOCs comprise p-cymene, at least about 0.002% (e.g., about 0.003%, 0.004%, or 0.005%) by mass of the one or more additional VOCs comprises phenethyl butyrate, or at least about 0.00025% (e.g., about 0.00026%, 0.00028%, or 0.0003%) by mass of the one or more additional VOCs comprises phenethyl propionate.

The non-volatile compounds present in a Moscato replica can include compounds that fall into any of several categories, including amino acids, organic acids, sugars, sugar alcohols, lipids, vitamins, other flavorants, colors, tannin components, salt (e.g., NaCl), and pH-modifying salt (e.g., KOH). It will be appreciated that any of these components can be provided in any appropriate form. For example, it will be appreciated that amino acids can be provided in the form of a salt (e.g., an HCl salt). It will also be appreciated that any and all stereoisomers can be used when no stereochemistry is specified.

Amino acids that may be present in a Moscato replica as provided herein include, without limitation, alanine, arginine, asparagine, aspartic acid, beta-alanine, betaine, citrulline, cysteine, gamma-aminobutyric acid (GABA), glutamic acid, glutamine, glycine, histidine, isoleucine, leucine, lysine, methionine, ornithine, phenylalanine, proline, serine, threonine, trans-4-hydroxyproline tryptophan, tyrosine, valine, and any combination thereof. In some embodiments, an amino acid can be provided as the L-stereoisomer.

Examples of acids that can be included in a Moscato replica include, without limitation, acetic acid, citric acid, D-gluconolactone (gluconic acid), fumaric acid, lactic acid, malic acid, pyruvic acid, sorbic acid, succinic acid, syringic acid, tartaric acid, vanillic acid, and any combination thereof.

Sugars that can be used in a Moscato replica include, without limitation, fructose, fucose, galactose, glucosamine, glucose, mannose, rhamnose, ribose, xylose, and any combination thereof.

Sugar alcohols that can be present in a Moscato replica include, without limitation, arabitol, glycerol, inositol (e.g., myo-inositol), mannitol, sorbitol, and any combination thereof.

A Moscato replica can include lipids such as, for example, choline or a surfactant (e.g., a surfactant from Quillaja saponaria), or a combination thereof.

In some cases, a Moscato replica can include one or more vitamins [e.g., pantothenic acid (vitamin B5), pyridoxine (vitamin B6), or a combination thereof].

Flavorants that can be included in a Moscato replica include, without limitation, acetovanillone, carnitine, disodium 5′ ribonucleotides (e.g., 5′-guanylate and/or 5′-inosinate), monosodium glutamate (MSG), syringaldehyde, vanillin, or any combination thereof.

Other components that can be included in a Moscato replica include, without limitation, 2,3,5,6-tetramethylpyrazine, 2,3,5-trimethylpyrazine, 2-furoic acid, 2-isopropylmalic acid, 3,4-dihydroxybenzoic acid, 4-guanidinobutyric acid, acetovanillone, adenine, adipic acid, camphoric acid, carnitine, carnosine, catechin, choline, cinnamic acid, coumaric acid, cystine, cytidine, cytosine, D-glucuronic acid, ellagic acid, epicatechin, epicatechin gallate, gallic acid, guanine, hesperetin, homoserine, kynurenic acid, methyl gallate, pipecolinic acid, piperine, polydatin, propyl gallate, quercetin, quinic acid, resveratrol, rutin, salicylic acid, sinapinic acid, trans-ferulic acid, tryptamine, tyramine, and uracil. It will be appreciated that these compounds may also fall into one or more of the categories above.

Colorants that may be used in the Moscato replicas provided herein include, without limitation, Amber, Caramel food color, Carotene, Fruit Punch, Purple Mist, Rustic Brown, Scarlet Red, Vineyard Select, and any combination thereof. Alternatively or in addition, colorants can include natural colorants derived from fruits and vegetables such as beet, carrot, and cabbage [e.g., annatto extract, beet extract, beta carotene, caramel carmine (cochineal extract), elderberry extract, grapeskin extract (enocianina), paprika, saffron, titanium dioxide, and turmeric], as well as synthetic dyes (e.g., FD+C/synthetic colors). See, e.g., www.ttb.gov/spirits/bam/chapter7.pdf.

The non-volatile compounds in a Moscato replica as provided herein can include, in some cases, acetic acid, citric acid, lactic acid, malic acid, succinic acid, tartaric acid, fructose, glucose, glycerol, guanosine monophosphate, inosine monophosphate, potassium hydroxide, alanine, arginine, asparagine, aspartic acid, b-alanine, glutamic acid, glutamine, histidine, lysine, methionine, monosodium glutamate, phenylalanine, proline, serine, tryptophan, tyrosine, and valine.

In some embodiments, the non-volatile compounds can include one or more (e.g., 1 to 2, 1 to 3, 1 to 5, 1 to 10, 1 to 15, 1 to 20, 1 to 25, 1 to 30, 5 to 10, 10 to 15, 10 to 20, 15 to 20, 20 to 30, 20 to 25, or 25 to 30) of 2,3-dimethylpyrazine, acetic acid, adipic acid, alanine, cysteine, cystine, disodium 5′ ribonucleotides (5′-guanylate & 5′-inosinate), epicatechin gallate, caramel food colouring, carotene food colouring, galactose, glutamine, glycerol, gum arabic, potassium hydroxide (KOH), mannose, methyl gallate, methyl 2-pyrrolyl ketone, monosodium glutamate, pectin, propyl gallate, pyridine, rutin, sorbic acid, a surfactant, syringaldehyde, syringic acid, tryptamine, tyramine, and vanillin.

In some embodiments, the non-volatile compounds can include one or more (e.g., 1 to 2, 1 to 3, 1 to 5, 1 to 10, 1 to 15, 1 to 20, 5 to 10, 10 to 15, 10 to 20, or 15 to 20) of 2,3-dimethylpyrazine, adipic acid, alanine, cysteine, cystine, epicatechin gallate, glutamine, mannose, methyl gallate, methyl 2-pyrrolyl ketone, propyl gallate, pyridine, rutin, sorbic acid, syringaldehyde, syringic acid, tryptamine, tyramine, and vanillin.

In some embodiments, the non-volatile compounds can include one or more (e.g., 1, 2, 3, 4, or 5) of alanine, cysteine, glutamine, mannose, and vanillin.

In some embodiments, the non-volatile compounds can include one or more (e.g., 1 2, or 3) of alanine, glutamine, and vanillin.

In some embodiments, the non-volatile compounds can include one or more (e.g., 1, 2, 3, or 4) of cysteine, glutamine, mannose, and vanillin.

In some embodiments, the non-volatile compounds can include alanine.

In some embodiments, the non-volatile compounds can include glutamine, vanillin, or both.

In some embodiments, the non-volatile compounds can include one or more (e.g., 1 to 2, 1 to 3, 1 to 5, 1 to 10, 5 to 10, or 14) of 2,3-dimethylpyrazine, adipic acid, cystine, epicatechin gallate, methyl gallate, methyl 2-pyrrolyl ketone, propyl gallate, pyridine, rutin, sorbic acid, syringaldehyde, syringic acid, tryptamine, and tyramine.

In some embodiments, the non-volatile compounds can include one or more (e.g., 1 to 2, 1 to 3, 1 to 5, 1 to 10, 5 to 10, or 12) of acetic acid, alanine, disodium 5′ ribonucleotides (5′-guanylate & 5′-inosinate), caramel food colouring, carotene food colouring, galactose, glycerol, gum arabic, KOH, monosodium glutamate, pectin, and a surfactant.

In some embodiments, the non-volatile compounds can exclude one or more (e.g., 1 to 2, 1 to 3, 1 to 5, 1 to 10, 1 to 15, 1 to 20, 1 to 25, 5 to 10, 10 to 20, or 15 to 25) of 2-isopropylmalic acid, 3,4-dihydroxybenzoic acid, 4-guanidinobutyric acid, adenine, caffeic acid, camphoric acid, carnitine, catechin, choline, coumaric acid, cytidine, cytosine, D-glucuronic acid, epicatechin, gallic acid, guanine, homoserine, methionine, pantothenic acid, polydatin, pyridoxine, pyruvic acid, quercetin, salicylic acid, serine, sorbitol, trans-4-hydroxyproline, trans-ferulic acid, and uracil.

In some embodiments, the non-volatile compounds can exclude one or more (e.g., 1 to 2, 1 to 3, 1 to 5, 1 to 10, 1 to 15, 1 to 20, 5 to 10, or 10 to 20) of 3,4-dihydroxybenzoic acid, 4-guanidinobutyric acid, adenine, caffeic acid, carnitine, catechin, coumaric acid, cytidine, cytosine, epicatechin, gallic acid, guanine, homoserine, methionine, pantothenic acid, polydatin, pyridoxine, pyruvic acid, serine, sorbitol, trans-4-hydroxyproline, and uracil.

In some embodiments, the non-volatile compounds can include at least 10 (e.g., 10 to 15, 10 to 20, 15 to 25, 20 to 30, or 25 to 35) compounds selected from the group consisting of 2-isopropylmalic acid, arginine, asparagine, beta-alanine, camphoric acid, choline, citric acid, D-glucuronic acid, fructose, fucose, fumaric acid, GABA, glucose, glutamic acid, glutamine, glycine, histidine, isoleucine, lactic acid, leucine, lysine, malic acid, mannitol, inositol, phenylalanine, proline, quercetin, salicylic acid, sorbitol, succinic acid, tartaric acid, threonine, trans-ferulic acid, tryptophan, tyrosine, and valine.

In some embodiments, the non-volatile compounds can include one or more (e.g., at least 2, at least 3, at least 5, 1 to 5, 1 to 10, or 5 to 10) compounds selected from the group consisting of 2,3,5,6-tetramethylpyrazine, 2,3,5-trimethylpyrazine, 2-furoic acid, 3,4-dihydroxybenzoic acid, a pH-modifying salt, acetic acid, alanine, arabitol, aspartic acid, carnitine, cinnamic acid, cysteine, disodium 5′ ribonucleotides, ellagic acid, food colouring Caramel, food colouring Carotene, glucosamine, glycerol, guanine, hesperetin, mannose, methionine, monosodium glutamate, pantothenic acid, piperine, pyruvic acid, rhamnose, serine, sinapinic acid, trans-4-hydroxyproline, vanillic acid, vanillin, and xylose.

In some embodiments, the non-volatile compounds can include one or more (e.g., at least 2, at least 3, at least 5, 1 to 5, 1 to 10, or 5 to 10) compounds selected from the group consisting of 4-guanidinobutyric acid, acetovanillone, adenine, betaine, caffeic acid, carnosine, catechin, citrulline, coumaric acid, cytidine, cytosine, epicatechin, gallic acid, homoserine, kynurenic acid, ornithine, pipecolinic acid, polydatin, pyridoxine, quinic acid, resveratrol, ribose, and uracil.

In some embodiments, the non-volatile compounds include one or more (e.g., 1, 2, or 3) compounds selected from the group consisting of a surfactant, gum arabic, and pectin.

In some embodiments, non-volatile compounds can be placed in various groups, and can be included in a Moscato replica according to their groupings. In certain cases, for example, “Group A” compounds may include acetic acid, a pH-modifying salt, tartaric acid, malic acid, citric acid, succinic acid, lactic acid, glucose, fructose, disodium 5′ ribonucleotides (particularly 5′-guanylate and 5′-inosinate), monosodium glutamate, ethanol, alanine, arginine, aspartic acid, asparagine, b-alanine, glutamic acid, glutamine, histidine, lysine, methionine, phenylalanine, proline, tryptophan, and tyrosine; “Group B” compounds can include sorbitol, inositol, mannitol, GABA, isoleucine, leucine, serine, threonine, valine, glycerol, Carotene food coloring, Caramel food coloring, and similar natural or artificial colors that combine to achieve the desired color; “Group C” compounds can include mannose, cysteine, and glycine; and “Group D” compounds can include a surfactant, gum arabic, and pectin, and other suitable viscosity modifying substances.

A Moscato replica can include, for example, at least five (e.g., six, seven, eight, nine, ten, 15, 20, or all) of the compounds of Group A, in combination with at least three (e.g., four, five six, seven, eight, nine, ten, or all) of the compounds of Group B, one or more compounds of Group C, and one or more compounds of Group D.

In some embodiments, a Moscato-like alcoholic beverage can include the non-volatile compounds from Group A and nine non-volatile compounds from Group B. For example, a Moscato replica may include the compounds in Group A in combination with one of the following subsets of Group B: Carotene food coloring, Caramel food coloring, sorbitol, inositol, mannitol, GABA, isoleucine, leucine, and serine; Carotene food coloring, Caramel food coloring, sorbitol, inositol, mannitol, GABA, isoleucine, leucine, and threonine; Carotene food coloring, Caramel food coloring, sorbitol, inositol, mannitol, GABA, isoleucine, leucine, and valine; Carotene food coloring, Caramel food coloring, sorbitol, inositol, mannitol, GABA, isoleucine, leucine, and glycerol; Carotene food coloring, Caramel food coloring, sorbitol, inositol, mannitol, GABA, isoleucine, serine, and threonine; Carotene food coloring, Caramel food coloring, sorbitol, inositol, mannitol, GABA, isoleucine, serine, and valine; Carotene food coloring, Caramel food coloring, sorbitol, inositol, mannitol, GABA, isoleucine, serine, and glycerol; Carotene food coloring, Caramel food coloring, sorbitol, inositol, mannitol, GABA, isoleucine, threonine, and valine; Carotene food coloring, Caramel food coloring, sorbitol, inositol, mannitol, GABA, isoleucine, threonine, and glycerol; Carotene food coloring, Caramel food coloring, sorbitol, inositol, mannitol, GABA, isoleucine, valine, and glycerol; Carotene food coloring, Caramel food coloring, sorbitol, inositol, mannitol, GABA, leucine, serine, and threonine; Carotene food coloring, Caramel food coloring, sorbitol, inositol, mannitol, GABA, leucine, serine, and valine; Carotene food coloring, Caramel food coloring, sorbitol, inositol, mannitol, GABA, leucine, serine, and glycerol; Carotene food coloring, Caramel food coloring, sorbitol, inositol, mannitol, GABA, leucine, threonine, and valine; Carotene food coloring, Caramel food coloring, sorbitol, inositol, mannitol, GABA, leucine, threonine, and glycerol; Carotene food coloring, Caramel food coloring, sorbitol, inositol, mannitol, GABA, leucine, valine, and glycerol; Carotene food coloring, Caramel food coloring, sorbitol, inositol, mannitol, GABA, serine, threonine, and valine; Carotene food coloring, Caramel food coloring, sorbitol, inositol, mannitol, GABA, serine, threonine, and glycerol; Carotene food coloring, Caramel food coloring, sorbitol, inositol, mannitol, GABA, serine, valine, and glycerol; Carotene food coloring, Caramel food coloring, sorbitol, inositol, mannitol, GABA, threonine, valine, and glycerol; Carotene food coloring, Caramel food coloring, sorbitol, inositol, mannitol, isoleucine, leucine, serine, and threonine; Carotene food coloring, Caramel food coloring, sorbitol, inositol, mannitol, isoleucine, leucine, serine, and valine; Carotene food coloring, Caramel food coloring, sorbitol, inositol, mannitol, isoleucine, leucine, serine, and glycerol; Carotene food coloring, Caramel food coloring, sorbitol, inositol, mannitol, isoleucine, leucine, threonine, and valine; Carotene food coloring, Caramel food coloring, sorbitol, inositol, mannitol, isoleucine, leucine, threonine, and glycerol; Carotene food coloring, Caramel food coloring, sorbitol, inositol, mannitol, isoleucine, leucine, valine, and glycerol; Carotene food coloring, Caramel food coloring, sorbitol, inositol, mannitol, isoleucine, serine, threonine, and valine; Carotene food coloring, Caramel food coloring, sorbitol, inositol, mannitol, isoleucine, serine, threonine, and glycerol; Carotene food coloring, Caramel food coloring, sorbitol, inositol, mannitol, isoleucine, serine, valine, and glycerol; Carotene food coloring, Caramel food coloring, sorbitol, inositol, mannitol, isoleucine, threonine, valine, and glycerol; Carotene food coloring, Caramel food coloring, sorbitol, inositol, mannitol, leucine, serine, threonine, and valine; Carotene food coloring, Caramel food coloring, sorbitol, inositol, mannitol, leucine, serine, threonine, and glycerol; Carotene food coloring, Caramel food coloring, sorbitol, inositol, mannitol, leucine, serine, valine, and glycerol; Carotene food coloring, Caramel food coloring, sorbitol, inositol, mannitol, leucine, threonine, valine, and glycerol; Carotene food coloring, Caramel food coloring, sorbitol, inositol, mannitol, serine, threonine, valine, and glycerol; Carotene food coloring, Caramel food coloring, sorbitol, inositol, GABA, isoleucine, leucine, serine, and threonine; Carotene food coloring, Caramel food coloring, sorbitol, inositol, GABA, isoleucine, leucine, serine, and valine; Carotene food coloring, Caramel food coloring, sorbitol, inositol, GABA, isoleucine, leucine, serine, and glycerol; Carotene food coloring, Caramel food coloring, sorbitol, inositol, GABA, isoleucine, leucine, threonine, and valine; Carotene food coloring, Caramel food coloring, sorbitol, inositol, GABA, isoleucine, leucine, threonine, and glycerol; Carotene food coloring, Caramel food coloring, sorbitol, inositol, GABA, isoleucine, leucine, valine, and glycerol; Carotene food coloring, Caramel food coloring, sorbitol, inositol, GABA, isoleucine, serine, threonine, and valine; Carotene food coloring, Caramel food coloring, sorbitol, inositol, GABA, isoleucine, serine, threonine, and glycerol; Carotene food coloring, Caramel food coloring, sorbitol, inositol, GABA, isoleucine, serine, valine, and glycerol; Carotene food coloring, Caramel food coloring, sorbitol, inositol, GABA, isoleucine, threonine, valine, and glycerol; Carotene food coloring, Caramel food coloring, sorbitol, inositol, GABA, leucine, serine, threonine, and valine; Carotene food coloring, Caramel food coloring, sorbitol, inositol, GABA, leucine, serine, threonine, and glycerol; Carotene food coloring, Caramel food coloring, sorbitol, inositol, GABA, leucine, serine, valine, and glycerol; Carotene food coloring, Caramel food coloring, sorbitol, inositol, GABA, leucine, threonine, valine, and glycerol; Carotene food coloring, Caramel food coloring, sorbitol, inositol, GABA, serine, threonine, valine, and glycerol; Carotene food coloring, Caramel food coloring, sorbitol, inositol, isoleucine, leucine, serine, threonine, and valine; Carotene food coloring, Caramel food coloring, sorbitol, inositol, isoleucine, leucine, serine, threonine, and glycerol; Carotene food coloring, Caramel food coloring, sorbitol, inositol, isoleucine, leucine, serine, valine, and glycerol; Carotene food coloring, Caramel food coloring, sorbitol, inositol, isoleucine, leucine, threonine, valine, and glycerol; Carotene food coloring, Caramel food coloring, sorbitol, inositol, isoleucine, serine, threonine, valine, and glycerol; Carotene food coloring, Caramel food coloring, sorbitol, inositol, leucine, serine, threonine, valine, and glycerol; Carotene food coloring, Caramel food coloring, sorbitol, mannitol, GABA, isoleucine, leucine, serine, and threonine; Carotene food coloring, Caramel food coloring, sorbitol, mannitol, GABA, isoleucine, leucine, serine, and valine; Carotene food coloring, Caramel food coloring, sorbitol, mannitol, GABA, isoleucine, leucine, serine, and glycerol; Carotene food coloring, Caramel food coloring, sorbitol, mannitol, GABA, isoleucine, leucine, threonine, and valine; Carotene food coloring, Caramel food coloring, sorbitol, mannitol, GABA, isoleucine, leucine, threonine, and glycerol; Carotene food coloring, Caramel food coloring, sorbitol, mannitol, GABA, isoleucine, leucine, valine, and glycerol; Carotene food coloring, Caramel food coloring, sorbitol, mannitol, GABA, isoleucine, serine, threonine, and valine; Carotene food coloring, Caramel food coloring, sorbitol, mannitol, GABA, isoleucine, serine, threonine, and glycerol; Carotene food coloring, Caramel food coloring, sorbitol, mannitol, GABA, isoleucine, serine, valine, and glycerol; Carotene food coloring, Caramel food coloring, sorbitol, mannitol, GABA, isoleucine, threonine, valine, and glycerol; Carotene food coloring, Caramel food coloring, sorbitol, mannitol, GABA, leucine, serine, threonine, and valine; Carotene food coloring, Caramel food coloring, sorbitol, mannitol, GABA, leucine, serine, threonine, and glycerol; Carotene food coloring, Caramel food coloring, sorbitol, mannitol, GABA, leucine, serine, valine, and glycerol; Carotene food coloring, Caramel food coloring, sorbitol, mannitol, GABA, leucine, threonine, valine, and glycerol; Carotene food coloring, Caramel food coloring, sorbitol, mannitol, GABA, serine, threonine, valine, and glycerol; Carotene food coloring, Caramel food coloring, sorbitol, mannitol, isoleucine, leucine, serine, threonine, and valine; Carotene food coloring, Caramel food coloring, sorbitol, mannitol, isoleucine, leucine, serine, threonine, and glycerol; Carotene food coloring, Caramel food coloring, sorbitol, mannitol, isoleucine, leucine, serine, valine, and glycerol; Carotene food coloring, Caramel food coloring, sorbitol, mannitol, isoleucine, leucine, threonine, valine, and glycerol; Carotene food coloring, Caramel food coloring, sorbitol, mannitol, isoleucine, serine, threonine, valine, and glycerol; Carotene food coloring, Caramel food coloring, sorbitol, mannitol, leucine, serine, threonine, valine, and glycerol; Carotene food coloring, Caramel food coloring, sorbitol, GABA, isoleucine, leucine, serine, threonine, and valine; Carotene food coloring, Caramel food coloring, sorbitol, GABA, isoleucine, leucine, serine, threonine, and glycerol; Carotene food coloring, Caramel food coloring, sorbitol, GABA, isoleucine, leucine, serine, valine, and glycerol; Carotene food coloring, Caramel food coloring, sorbitol, GABA, isoleucine, leucine, threonine, valine, and glycerol; Carotene food coloring, Caramel food coloring, sorbitol, GABA, isoleucine, serine, threonine, valine, and glycerol; Carotene food coloring, Caramel food coloring, sorbitol, GABA, leucine, serine, threonine, valine, and glycerol; Carotene food coloring, Caramel food coloring, sorbitol, isoleucine, leucine, serine, threonine, valine, and glycerol; Carotene food coloring, Caramel food coloring, inositol, mannitol, GABA, isoleucine, leucine, serine, and threonine; Carotene food coloring, Caramel food coloring, inositol, mannitol, GABA, isoleucine, leucine, serine, and valine; Carotene food coloring, Caramel food coloring, inositol, mannitol, GABA, isoleucine, leucine, serine, and glycerol; Carotene food coloring, Caramel food coloring, inositol, mannitol, GABA, isoleucine, leucine, threonine, and valine; Carotene food coloring, Caramel food coloring, inositol, mannitol, GABA, isoleucine, leucine, threonine, and glycerol; Carotene food coloring, Caramel food coloring, inositol, mannitol, GABA, isoleucine, leucine, valine, and glycerol; Carotene food coloring, Caramel food coloring, inositol, mannitol, GABA, isoleucine, serine, threonine, and valine; Carotene food coloring, Caramel food coloring, inositol, mannitol, GABA, isoleucine, serine, threonine, and glycerol; Carotene food coloring, Caramel food coloring, inositol, mannitol, GABA, isoleucine, serine, valine, and glycerol; Carotene food coloring, Caramel food coloring, inositol, mannitol, GABA, isoleucine, threonine, valine, and glycerol; Carotene food coloring, Caramel food coloring, inositol, mannitol, GABA, leucine, serine, threonine, and valine; Carotene food coloring, Caramel food coloring, inositol, mannitol, GABA, leucine, serine, threonine, and glycerol; Carotene food coloring, Caramel food coloring, inositol, mannitol, GABA, leucine, serine, valine, and glycerol; Carotene food coloring, Caramel food coloring, inositol, mannitol, GABA, leucine, threonine, valine, and glycerol; Carotene food coloring, Caramel food coloring, inositol, mannitol, GABA, serine, threonine, valine, and glycerol; Carotene food coloring, Caramel food coloring, inositol, mannitol, isoleucine, leucine, serine, threonine, and valine; Carotene food coloring, Caramel food coloring, inositol, mannitol, isoleucine, leucine, serine, threonine, and glycerol; Carotene food coloring, Caramel food coloring, inositol, mannitol, isoleucine, leucine, serine, valine, and glycerol; Carotene food coloring, Caramel food coloring, inositol, mannitol, isoleucine, leucine, threonine, valine, and glycerol; Carotene food coloring, Caramel food coloring, inositol, mannitol, isoleucine, serine, threonine, valine, and glycerol; Carotene food coloring, Caramel food coloring, inositol, mannitol, leucine, serine, threonine, valine, and glycerol; Carotene food coloring, Caramel food coloring, inositol, GABA, isoleucine, leucine, serine, threonine, and valine; Carotene food coloring, Caramel food coloring, inositol, GABA, isoleucine, leucine, serine, threonine, and glycerol; Carotene food coloring, Caramel food coloring, inositol, GABA, isoleucine, leucine, serine, valine, and glycerol; Carotene food coloring, Caramel food coloring, inositol, GABA, isoleucine, leucine, threonine, valine, and glycerol; Carotene food coloring, Caramel food coloring, inositol, GABA, isoleucine, serine, threonine, valine, and glycerol; Carotene food coloring, Caramel food coloring, inositol, GABA, leucine, serine, threonine, valine, and glycerol; Carotene food coloring, Caramel food coloring, inositol, isoleucine, leucine, serine, threonine, valine, and glycerol; Carotene food coloring, Caramel food coloring, mannitol, GABA, isoleucine, leucine, serine, threonine, and valine; Carotene food coloring, Caramel food coloring, mannitol, GABA, isoleucine, leucine, serine, threonine, and glycerol; Carotene food coloring, Caramel food coloring, mannitol, GABA, isoleucine, leucine, serine, valine, and glycerol; Carotene food coloring, Caramel food coloring, mannitol, GABA, isoleucine, leucine, threonine, valine, and glycerol; Carotene food coloring, Caramel food coloring, mannitol, GABA, isoleucine, serine, threonine, valine, and glycerol; Carotene food coloring, Caramel food coloring, mannitol, GABA, leucine, serine, threonine, valine, and glycerol; Carotene food coloring, Caramel food coloring, mannitol, isoleucine, leucine, serine, threonine, valine, and glycerol; Carotene food coloring, Caramel food coloring, GABA, isoleucine, leucine, serine, threonine, valine, and glycerol; Carotene food coloring, sorbitol, inositol, mannitol, GABA, isoleucine, leucine, serine, and threonine; Carotene food coloring, sorbitol, inositol, mannitol, GABA, isoleucine, leucine, serine, and valine; Carotene food coloring, sorbitol, inositol, mannitol, GABA, isoleucine, leucine, serine, and glycerol; Carotene food coloring, sorbitol, inositol, mannitol, GABA, isoleucine, leucine, threonine, and valine; Carotene food coloring, sorbitol, inositol, mannitol, GABA, isoleucine, leucine, threonine, and glycerol; Carotene food coloring, sorbitol, inositol, mannitol, GABA, isoleucine, leucine, valine, and glycerol; Carotene food coloring, sorbitol, inositol, mannitol, GABA, isoleucine, serine, threonine, and valine; Carotene food coloring, sorbitol, inositol, mannitol, GABA, isoleucine, serine, threonine, and glycerol; Carotene food coloring, sorbitol, inositol, mannitol, GABA, isoleucine, serine, valine, and glycerol; Carotene food coloring, sorbitol, inositol, mannitol, GABA, isoleucine, threonine, valine, and glycerol; Carotene food coloring, sorbitol, inositol, mannitol, GABA, leucine, serine, threonine, and valine; Carotene food coloring, sorbitol, inositol, mannitol, GABA, leucine, serine, threonine, and glycerol; Carotene food coloring, sorbitol, inositol, mannitol, GABA, leucine, serine, valine, and glycerol; Carotene food coloring, sorbitol, inositol, mannitol, GABA, leucine, threonine, valine, and glycerol; Carotene food coloring, sorbitol, inositol, mannitol, GABA, serine, threonine, valine, and glycerol; Carotene food coloring, sorbitol, inositol, mannitol, isoleucine, leucine, serine, threonine, and valine; Carotene food coloring, sorbitol, inositol, mannitol, isoleucine, leucine, serine, threonine, and glycerol; Carotene food coloring, sorbitol, inositol, mannitol, isoleucine, leucine, serine, valine, and glycerol; Carotene food coloring, sorbitol, inositol, mannitol, isoleucine, leucine, threonine, valine, and glycerol; Carotene food coloring, sorbitol, inositol, mannitol, isoleucine, serine, threonine, valine, and glycerol; Carotene food coloring, sorbitol, inositol, mannitol, leucine, serine, threonine, valine, and glycerol; Carotene food coloring, sorbitol, inositol, GABA, isoleucine, leucine, serine, threonine, and valine; Carotene food coloring, sorbitol, inositol, GABA, isoleucine, leucine, serine, threonine, and glycerol; Carotene food coloring, sorbitol, inositol, GABA, isoleucine, leucine, serine, valine, and glycerol; Carotene food coloring, sorbitol, inositol, GABA, isoleucine, leucine, threonine, valine, and glycerol; Carotene food coloring, sorbitol, inositol, GABA, isoleucine, serine, threonine, valine, and glycerol; Carotene food coloring, sorbitol, inositol, GABA, leucine, serine, threonine, valine, and glycerol; Carotene food coloring, sorbitol, inositol, isoleucine, leucine, serine, threonine, valine, and glycerol; Carotene food coloring, sorbitol, mannitol, GABA, isoleucine, leucine, serine, threonine, and valine; Carotene food coloring, sorbitol, mannitol, GABA, isoleucine, leucine, serine, threonine, and glycerol; Carotene food coloring, sorbitol, mannitol, GABA, isoleucine, leucine, serine, valine, and glycerol; Carotene food coloring, sorbitol, mannitol, GABA, isoleucine, leucine, threonine, valine, and glycerol; Carotene food coloring, sorbitol, mannitol, GABA, isoleucine, serine, threonine, valine, and glycerol; Carotene food coloring, sorbitol, mannitol, GABA, leucine, serine, threonine, valine, and glycerol; Carotene food coloring, sorbitol, mannitol, isoleucine, leucine, serine, threonine, valine, and glycerol; Carotene food coloring, sorbitol, GABA, isoleucine, leucine, serine, threonine, valine, and glycerol; Carotene food coloring, inositol, mannitol, GABA, isoleucine, leucine, serine, threonine, and valine; Carotene food coloring, inositol, mannitol, GABA, isoleucine, leucine, serine, threonine, and glycerol; Carotene food coloring, inositol, mannitol, GABA, isoleucine, leucine, serine, valine, and glycerol; Carotene food coloring, inositol, mannitol, GABA, isoleucine, leucine, threonine, valine, and glycerol; Carotene food coloring, inositol, mannitol, GABA, isoleucine, serine, threonine, valine, and glycerol; Carotene food coloring, inositol, mannitol, GABA, leucine, serine, threonine, valine, and glycerol; Carotene food coloring, inositol, mannitol, isoleucine, leucine, serine, threonine, valine, and glycerol; Carotene food coloring, inositol, GABA, isoleucine, leucine, serine, threonine, valine, and glycerol; Carotene food coloring, mannitol, GABA, isoleucine, leucine, serine, threonine, valine, and glycerol; Caramel food coloring, sorbitol, inositol, mannitol, GABA, isoleucine, leucine, serine, and threonine; Caramel food coloring, sorbitol, inositol, mannitol, GABA, isoleucine, leucine, serine, and valine; Caramel food coloring, sorbitol, inositol, mannitol, GABA, isoleucine, leucine, serine, and glycerol; Caramel food coloring, sorbitol, inositol, mannitol, GABA, isoleucine, leucine, threonine, and valine; Caramel food coloring, sorbitol, inositol, mannitol, GABA, isoleucine, leucine, threonine, and glycerol; Caramel food coloring, sorbitol, inositol, mannitol, GABA, isoleucine, leucine, valine, and glycerol; Caramel food coloring, sorbitol, inositol, mannitol, GABA, isoleucine, serine, threonine, and valine; Caramel food coloring, sorbitol, inositol, mannitol, GABA, isoleucine, serine, threonine, and glycerol; Caramel food coloring, sorbitol, inositol, mannitol, GABA, isoleucine, serine, valine, and glycerol; Caramel food coloring, sorbitol, inositol, mannitol, GABA, isoleucine, threonine, valine, and glycerol; Caramel food coloring, sorbitol, inositol, mannitol, GABA, leucine, serine, threonine, and valine; Caramel food coloring, sorbitol, inositol, mannitol, GABA, leucine, serine, threonine, and glycerol; Caramel food coloring, sorbitol, inositol, mannitol, GABA, leucine, serine, valine, and glycerol; Caramel food coloring, sorbitol, inositol, mannitol, GABA, leucine, threonine, valine, and glycerol; Caramel food coloring, sorbitol, inositol, mannitol, GABA, serine, threonine, valine, and glycerol; Caramel food coloring, sorbitol, inositol, mannitol, isoleucine, leucine, serine, threonine, and valine; Caramel food coloring, sorbitol, inositol, mannitol, isoleucine, leucine, serine, threonine, and glycerol; Caramel food coloring, sorbitol, inositol, mannitol, isoleucine, leucine, serine, valine, and glycerol; Caramel food coloring, sorbitol, inositol, mannitol, isoleucine, leucine, threonine, valine, and glycerol; Caramel food coloring, sorbitol, inositol, mannitol, isoleucine, serine, threonine, valine, and glycerol; Caramel food coloring, sorbitol, inositol, mannitol, leucine, serine, threonine, valine, and glycerol; Caramel food coloring, sorbitol, inositol, GABA, isoleucine, leucine, serine, threonine, and valine; Caramel food coloring, sorbitol, inositol, GABA, isoleucine, leucine, serine, threonine, and glycerol; Caramel food coloring, sorbitol, inositol, GABA, isoleucine, leucine, serine, valine, and glycerol; Caramel food coloring, sorbitol, inositol, GABA, isoleucine, leucine, threonine, valine, and glycerol; Caramel food coloring, sorbitol, inositol, GABA, isoleucine, serine, threonine, valine, and glycerol; Caramel food coloring, sorbitol, inositol, GABA, leucine, serine, threonine, valine, and glycerol; Caramel food coloring, sorbitol, inositol, isoleucine, leucine, serine, threonine, valine, and glycerol; Caramel food coloring, sorbitol, mannitol, GABA, isoleucine, leucine, serine, threonine, and valine; Caramel food coloring, sorbitol, mannitol, GABA, isoleucine, leucine, serine, threonine, and glycerol; Caramel food coloring, sorbitol, mannitol, GABA, isoleucine, leucine, serine, valine, and glycerol; Caramel food coloring, sorbitol, mannitol, GABA, isoleucine, leucine, threonine, valine, and glycerol; Caramel food coloring, sorbitol, mannitol, GABA, isoleucine, serine, threonine, valine, and glycerol; Caramel food coloring, sorbitol, mannitol, GABA, leucine, serine, threonine, valine, and glycerol; Caramel food coloring, sorbitol, mannitol, isoleucine, leucine, serine, threonine, valine, and glycerol; Caramel food coloring, sorbitol, GABA, isoleucine, leucine, serine, threonine, valine, and glycerol; Caramel food coloring, inositol, mannitol, GABA, isoleucine, leucine, serine, threonine, and valine; Caramel food coloring, inositol, mannitol, GABA, isoleucine, leucine, serine, threonine, and glycerol; Caramel food coloring, inositol, mannitol, GABA, isoleucine, leucine, serine, valine, and glycerol; Caramel food coloring, inositol, mannitol, GABA, isoleucine, leucine, threonine, valine, and glycerol; Caramel food coloring, inositol, mannitol, GABA, isoleucine, serine, threonine, valine, and glycerol; Caramel food coloring, inositol, mannitol, GABA, leucine, serine, threonine, valine, and glycerol; Caramel food coloring, inositol, mannitol, isoleucine, leucine, serine, threonine, valine, and glycerol; Caramel food coloring, inositol, GABA, isoleucine, leucine, serine, threonine, valine, and glycerol; Caramel food coloring, mannitol, GABA, isoleucine, leucine, serine, threonine, valine, and glycerol; sorbitol, inositol, mannitol, GABA, isoleucine, leucine, serine, threonine, and valine; sorbitol, inositol, mannitol, GABA, isoleucine, leucine, serine, threonine, and glycerol; sorbitol, inositol, mannitol, GABA, isoleucine, leucine, serine, valine, and glycerol; sorbitol, inositol, mannitol, GABA, isoleucine, leucine, threonine, valine, and glycerol; sorbitol, inositol, mannitol, GABA, isoleucine, serine, threonine, valine, and glycerol; sorbitol, inositol, mannitol, GABA, leucine, serine, threonine, valine, and glycerol; sorbitol, inositol, mannitol, isoleucine, leucine, serine, threonine, valine, and glycerol; sorbitol, inositol, GABA, isoleucine, leucine, serine, threonine, valine, and glycerol; sorbitol, mannitol, GABA, isoleucine, leucine, serine, threonine, valine, and glycerol; or inositol, mannitol, GABA, isoleucine, leucine, serine, threonine, valine, and glycerol.

In some embodiments, a Moscato-like alcoholic beverage can include the non-volatile compounds from Group A and 10 non-volatile compounds from Group B. For example, a Moscato replica may include the compounds of Group A and one of the following subsets of Group B: Carotene food coloring, Caramel food coloring, sorbitol, inositol, mannitol, GABA, isoleucine, leucine, serine, and threonine; Carotene food coloring, Caramel food coloring, sorbitol, inositol, mannitol, GABA, isoleucine, leucine, serine, and valine; Carotene food coloring, Caramel food coloring, sorbitol, inositol, mannitol, GABA, isoleucine, leucine, serine, and glycerol; Carotene food coloring, Caramel food coloring, sorbitol, inositol, mannitol, GABA, isoleucine, leucine, threonine, and valine; Carotene food coloring, Caramel food coloring, sorbitol, inositol, mannitol, GABA, isoleucine, leucine, threonine, and glycerol; Carotene food coloring, Caramel food coloring, sorbitol, inositol, mannitol, GABA, isoleucine, leucine, valine, and glycerol; Carotene food coloring, Caramel food coloring, sorbitol, inositol, mannitol, GABA, isoleucine, serine, threonine, and valine; Carotene food coloring, Caramel food coloring, sorbitol, inositol, mannitol, GABA, isoleucine, serine, threonine, and glycerol; Carotene food coloring, Caramel food coloring, sorbitol, inositol, mannitol, GABA, isoleucine, serine, valine, and glycerol; Carotene food coloring, Caramel food coloring, sorbitol, inositol, mannitol, GABA, isoleucine, threonine, valine, and glycerol; Carotene food coloring, Caramel food coloring, sorbitol, inositol, mannitol, GABA, leucine, serine, threonine, and valine; Carotene food coloring, Caramel food coloring, sorbitol, inositol, mannitol, GABA, leucine, serine, threonine, and glycerol; Carotene food coloring, Caramel food coloring, sorbitol, inositol, mannitol, GABA, leucine, serine, valine, and glycerol; Carotene food coloring, Caramel food coloring, sorbitol, inositol, mannitol, GABA, leucine, threonine, valine, and glycerol; Carotene food coloring, Caramel food coloring, sorbitol, inositol, mannitol, GABA, serine, threonine, valine, and glycerol; Carotene food coloring, Caramel food coloring, sorbitol, inositol, mannitol, isoleucine, leucine, serine, threonine, and valine; Carotene food coloring, Caramel food coloring, sorbitol, inositol, mannitol, isoleucine, leucine, serine, threonine, and glycerol; Carotene food coloring, Caramel food coloring, sorbitol, inositol, mannitol, isoleucine, leucine, serine, valine, and glycerol; Carotene food coloring, Caramel food coloring, sorbitol, inositol, mannitol, isoleucine, leucine, threonine, valine, and glycerol; Carotene food coloring, Caramel food coloring, sorbitol, inositol, mannitol, isoleucine, serine, threonine, valine, and glycerol; Carotene food coloring, Caramel food coloring, sorbitol, inositol, mannitol, leucine, serine, threonine, valine, and glycerol; Carotene food coloring, Caramel food coloring, sorbitol, inositol, GABA, isoleucine, leucine, serine, threonine, and valine; Carotene food coloring, Caramel food coloring, sorbitol, inositol, GABA, isoleucine, leucine, serine, threonine, and glycerol; Carotene food coloring, Caramel food coloring, sorbitol, inositol, GABA, isoleucine, leucine, serine, valine, and glycerol; Carotene food coloring, Caramel food coloring, sorbitol, inositol, GABA, isoleucine, leucine, threonine, valine, and glycerol; Carotene food coloring, Caramel food coloring, sorbitol, inositol, GABA, isoleucine, serine, threonine, valine, and glycerol; Carotene food coloring, Caramel food coloring, sorbitol, inositol, GABA, leucine, serine, threonine, valine, and glycerol; Carotene food coloring, Caramel food coloring, sorbitol, inositol, isoleucine, leucine, serine, threonine, valine, and glycerol; Carotene food coloring, Caramel food coloring, sorbitol, mannitol, GABA, isoleucine, leucine, serine, threonine, and valine; Carotene food coloring, Caramel food coloring, sorbitol, mannitol, GABA, isoleucine, leucine, serine, threonine, and glycerol; Carotene food coloring, Caramel food coloring, sorbitol, mannitol, GABA, isoleucine, leucine, serine, valine, and glycerol; Carotene food coloring, Caramel food coloring, sorbitol, mannitol, GABA, isoleucine, leucine, threonine, valine, and glycerol; Carotene food coloring, Caramel food coloring, sorbitol, mannitol, GABA, isoleucine, serine, threonine, valine, and glycerol; Carotene food coloring, Caramel food coloring, sorbitol, mannitol, GABA, leucine, serine, threonine, valine, and glycerol; Carotene food coloring, Caramel food coloring, sorbitol, mannitol, isoleucine, leucine, serine, threonine, valine, and glycerol; Carotene food coloring, Caramel food coloring, sorbitol, GABA, isoleucine, leucine, serine, threonine, valine, and glycerol; Carotene food coloring, Caramel food coloring, inositol, mannitol, GABA, isoleucine, leucine, serine, threonine, and valine; Carotene food coloring, Caramel food coloring, inositol, mannitol, GABA, isoleucine, leucine, serine, threonine, and glycerol; Carotene food coloring, Caramel food coloring, inositol, mannitol, GABA, isoleucine, leucine, serine, valine, and glycerol; Carotene food coloring, Caramel food coloring, inositol, mannitol, GABA, isoleucine, leucine, threonine, valine, and glycerol; Carotene food coloring, Caramel food coloring, inositol, mannitol, GABA, isoleucine, serine, threonine, valine, and glycerol; Carotene food coloring, Caramel food coloring, inositol, mannitol, GABA, leucine, serine, threonine, valine, and glycerol; Carotene food coloring, Caramel food coloring, inositol, mannitol, isoleucine, leucine, serine, threonine, valine, and glycerol; Carotene food coloring, Caramel food coloring, inositol, GABA, isoleucine, leucine, serine, threonine, valine, and glycerol; Carotene food coloring, Caramel food coloring, mannitol, GABA, isoleucine, leucine, serine, threonine, valine, and glycerol; Carotene food coloring, sorbitol, inositol, mannitol, GABA, isoleucine, leucine, serine, threonine, and valine; Carotene food coloring, sorbitol, inositol, mannitol, GABA, isoleucine, leucine, serine, threonine, and glycerol; Carotene food coloring, sorbitol, inositol, mannitol, GABA, isoleucine, leucine, serine, valine, and glycerol; Carotene food coloring, sorbitol, inositol, mannitol, GABA, isoleucine, leucine, threonine, valine, and glycerol; Carotene food coloring, sorbitol, inositol, mannitol, GABA, isoleucine, serine, threonine, valine, and glycerol; Carotene food coloring, sorbitol, inositol, mannitol, GABA, leucine, serine, threonine, valine, and glycerol; Carotene food coloring, sorbitol, inositol, mannitol, isoleucine, leucine, serine, threonine, valine, and glycerol; Carotene food coloring, sorbitol, inositol, GABA, isoleucine, leucine, serine, threonine, valine, and glycerol; Carotene food coloring, sorbitol, mannitol, GABA, isoleucine, leucine, serine, threonine, valine, and glycerol; Carotene food coloring, inositol, mannitol, GABA, isoleucine, leucine, serine, threonine, valine, and glycerol; Caramel food coloring, sorbitol, inositol, mannitol, GABA, isoleucine, leucine, serine, threonine, and valine; Caramel food coloring, sorbitol, inositol, mannitol, GABA, isoleucine, leucine, serine, threonine, and glycerol; Caramel food coloring, sorbitol, inositol, mannitol, GABA, isoleucine, leucine, serine, valine, and glycerol; Caramel food coloring, sorbitol, inositol, mannitol, GABA, isoleucine, leucine, threonine, valine, and glycerol; Caramel food coloring, sorbitol, inositol, mannitol, GABA, isoleucine, serine, threonine, valine, and glycerol; Caramel food coloring, sorbitol, inositol, mannitol, GABA, leucine, serine, threonine, valine, and glycerol; Caramel food coloring, sorbitol, inositol, mannitol, isoleucine, leucine, serine, threonine, valine, and glycerol; Caramel food coloring, sorbitol, inositol, GABA, isoleucine, leucine, serine, threonine, valine, and glycerol; Caramel food coloring, sorbitol, mannitol, GABA, isoleucine, leucine, serine, threonine, valine, and glycerol; Caramel food coloring, inositol, mannitol, GABA, isoleucine, leucine, serine, threonine, valine, and glycerol; or sorbitol, inositol, mannitol, GABA, isoleucine, leucine, serine, threonine, valine, and glycerol.

In some embodiments, a Moscato-like alcoholic beverage can include the non-volatile compounds from Group A and 11 non-volatile compounds from Group B. For example, a Moscato replica may include the compounds of Group A in combination with one of the following subsets of Group B: Carotene food coloring, Caramel food coloring, sorbitol, inositol, mannitol, GABA, isoleucine, leucine, serine, threonine, and valine; Carotene food coloring, Caramel food coloring, sorbitol, inositol, mannitol, GABA, isoleucine, leucine, serine, threonine, and glycerol; Carotene food coloring, Caramel food coloring, sorbitol, inositol, mannitol, GABA, isoleucine, leucine, serine, valine, and glycerol; Carotene food coloring, Caramel food coloring, sorbitol, inositol, mannitol, GABA, isoleucine, leucine, threonine, valine, and glycerol; Carotene food coloring, Caramel food coloring, sorbitol, inositol, mannitol, GABA, isoleucine, serine, threonine, valine, and glycerol; Carotene food coloring, Caramel food coloring, sorbitol, inositol, mannitol, GABA, leucine, serine, threonine, valine, and glycerol; Carotene food coloring, Caramel food coloring, sorbitol, inositol, mannitol, isoleucine, leucine, serine, threonine, valine, and glycerol; Carotene food coloring, Caramel food coloring, sorbitol, inositol, GABA, isoleucine, leucine, serine, threonine, valine, and glycerol; Carotene food coloring, Caramel food coloring, sorbitol, mannitol, GABA, isoleucine, leucine, serine, threonine, valine, and glycerol; Carotene food coloring, Caramel food coloring, inositol, mannitol, GABA, isoleucine, leucine, serine, threonine, valine, and glycerol; Carotene food coloring, sorbitol, inositol, mannitol, GABA, isoleucine, leucine, serine, threonine, valine, and glycerol; or Caramel food coloring, sorbitol, inositol, mannitol, GABA, isoleucine, leucine, serine, threonine, valine, and glycerol.

In some embodiments, a Moscato-like alcoholic beverage can include the non-volatile compounds from Group A and all of the non-volatile compounds from Group B.

In some cases, a Moscato-like alcoholic beverage can include the non-volatile compounds from Group A, between nine and 12 non-volatile compounds from Group B as listed above, and one non-volatile compound from Group C (mannose, cysteine, or glycine). In some cases, a Moscato-like alcoholic beverage can include the non-volatile compounds from Group A, between nine and 12 non-volatile compounds from Group B as listed above, and two non-volatile compounds from Group C (mannose and cysteine; mannose and glycine; or cysteine and glycine). In some embodiments, a Moscato-like alcoholic beverage can include the non-volatile compounds from Group A, between nine and 12 non-volatile compounds from Group B as listed above, and all three non-volatile compounds from Group C.

In some embodiments, a Moscato-like alcoholic beverage can include the non-volatile compounds from Group A, between nine and 12 non-volatile compounds from Group B as listed above, zero to three of the non-volatile compounds from Group C as listed above, and one non-volatile compound from Group D (a surfactant, gum arabic, or pectin). In some cases, a Moscato-like alcoholic beverage can include the non-volatile compounds from Group A, between nine and 12 non-volatile compounds from Group B as listed above, zero to three of the non-volatile compounds from Group C as listed above, and two non-volatile compounds from Group D (a surfactant and gum arabic; a surfactant and pectin; or gum arabic and pectin). In some cases, a Moscato-like alcoholic beverage can include the non-volatile compounds from Group A, between nine and 12 non-volatile compounds from Group B as listed above, zero to three non-volatile compounds from Group C as listed above, and all three non-volatile compounds from Group D.

In some embodiments, the Moscato replicas provided herein can include one or more (e.g., one, two, three, four, five, six, seven, eight, nine, ten, 11, 12, 13, or more than 13) non-volatile compounds that are not present in traditional Moscato. Examples of such non-volatile compounds include, without limitation, glutamine, mannose, inositol, acetic acid, glycerol, disodium 5′ ribonucleotides, monosodium glutamate, a pH-modifying salt, food coloring Carotene, food coloring Caramel, gum arabic, pectin, and a surfactant.

Again, non-volatile compounds are detected in traditional Moscato wines using the LC-MS method described in Example 2 herein. A non-volatile compound that is “not present” in a reference Moscato is one that is not detected in the reference Moscato using the methods set forth in Example 2. Limits of detection for various non-volatile compounds are disclosed in TABLES 10A and 10B herein.

Further, in some embodiments, the Moscato replicas provided herein can lack one or more (e.g., one, two, three, four, five, or more than five) non-volatile compounds that are present in traditional Moscato. Examples of such non-volatile compounds include, without limitation, choline, carnitine, ornithine, trans 4-hydroxy-L-proline, adenine, guanine, kynurenic acid, quinic acid, pantothenic acid, caffeic acid, polydatin, coumaric acid, pyruvic acid, D-glucuronic acid, fumaric acid, gallic acid, 2-furoic acid, 3,4-dihydroxybenzoic acid, 2-isopropylmalic acid, catechin, epicatechin, ellagic acid, salicylic acid, ribose, arabitol, glucosamine, pyridoxine, and betaine.

A Moscato-like alcoholic beverage can include any appropriate number of non-volatile compounds. For example, a Moscato-like alcoholic beverage can include 1 to 100 (e.g., at least 5, at least 10, at least 20, at least 30, at least 40, at least 50, 1 to 90, 1 to 80, 1 to 70, 1 to 60, 1 to 50, 1 to 40, 1 to 30, 1 to 20, 1 to 10, 1 to 5, 5 to 100, 5 to 90, 5 to 80, 5 to 70, 5 to 60, 5 to 40, 5 to 30, 5 to 20, 5 to 10, 10 to 100, 10 to 90, 10 to 90, 10 to 70, 10 to 60, 10 to 50, 10 to 40, 10 to 30, 10 to 20, 20 to 100, 20 to 90, 20 to 80, 20 to 70, 20 to 60, 20 to 50, 20 to 40, 20 to 30, 30 to 100, 30 to 90, 30 to 80, 30 to 70, 30 to 60, 30 to 50, 30 to 40, 40 to 100, 40 to 90, 40 to 80, 40 to 70, 40 to 60, 40 to 50, 50 to 100, 50 to 90, 50 to 80, 50 to 70, or 50 to 60) non-volatile compounds. In some cases, the number of non-volatile compounds in a Moscato-like alcoholic beverage can be less than the number of non-volatile compounds in a single reference Moscato.

In some cases, the overall population of non-volatile compounds in a replica Moscato can have less than 95% identity to the non-volatile compounds in a corresponding reference Moscato (e.g., in a single type of traditional Moscato). For example, the non-volatile compounds in a Moscato replica can have less than 90%, less than 80%, less than 70%, less than 60%, less than 50%, or less than 40% identity to the population of non-volatile compounds in a corresponding reference Moscato. Some Moscato replicas may contain at least 10 (e.g., at least 15, at least 20, at least 25, or at least 30) non-volatile compounds that are not found in a single reference Moscato. For example, in some embodiments, a Moscato replica can have at least m non-volatile compounds and less than m (e.g., m−1, m−2, m−3, m−4, m−5, m−6, m−7, m−8, m−9, m−10, m−15, m−20, and the like, as applicable) of the non-volatile compounds are found in a single reference Moscato; in some embodiments, m can be equal to 5, 6, 7, 8, 9, 10, 11, 12, 13, 14, 15, 16, 17, 18, 19, 20, 25, 30, 35, or 40.

The Examples below set forth amounts of non-volatile compounds that were included in Moscato replicas made according to the methods disclosed herein, and also set forth the amounts of non-volatile compounds that were detected in traditional Moscato wine samples. In some embodiments, the amount of a particular non-volatile compound in a Moscato replica can be an amount, based on concentration or percent composition, that is within a range 30% higher and lower than the amount disclosed for that non-volatile compound. For example, a non-volatile compound can be present in a Moscato replica in an amount that is 70 to 90%, 80 to 100%, 90 to 110%, 100 to 120%, 110 to 130%, 70 to 100%, 80 to 110%, 90 to 120%, or 100 to 130% of a disclosed amount for that non-volatile compound in a traditional Moscato.

The one or more non-volatile compounds in a Moscato-like alcoholic beverage can include pyroxidine. In some embodiments, the pyroxidine can be present in an amount of about 0.07 mg/L to about 0.65 mg/L (e.g., about 0.07 to about 0.1 mg/L, about 0.1 to about 0.2 mg/L, about 0.2 to about 0.3 mg/L, about 0.3 to about 0.4 mg/L, about 0.4 to about 0.5 mg/L, about 0.5 to about 0.6 mg/L, about 0.50 to about 0.65 mg/L, or about 0.55 to about 0.65 mg/L). In some embodiments, the one or more non-volatile compounds can include no pyroxidine.

The one or more non-volatile compounds in a Moscato-like alcoholic beverage can include betaine (also called betaine). In some embodiments, the betaine can be present in an amount of about 2.5 mg/L to about 22 mg/L (e.g., about 2.5 to about 5 mg/L, about 3 to about 5 mg/L, about 5 to about 10 mg/L, about 10 to about 15 mg/L, about 10 to about 20 mg/L, about 15 to about 20 mg/L, about 10 to about 22 mg/L, or about 15 to about 22 mg/L). In some embodiments, the one or more non-volatile compounds can include no betaine.

The one or more non-volatile compounds in a Moscato-like alcoholic beverage can include choline. In some embodiments, the choline can be present in an amount of about 10 mg/L to about 135 mg/L (e.g., about 10 to about 25 mg/L, about 25 to about 50 mg/L, about 50 to about 75 mg/L, about 75 to about 100 mg/L, about 100 to about 125 mg/L, or about 100 to about 135 mg/L). In some embodiments, the one or more non-volatile compounds can include no choline.

The one or more non-volatile compounds in a Moscato-like alcoholic beverage can include leucine. In some embodiments, the leucine can be present in an amount of about 0.3 mg/L to about 40 mg/L (e.g., about 0.3 to about 1 mg/L, about 1 to about 5 mg/L, about 5 to about 10 mg/L, about 10 to about 20 mg/L, about 20 to about 30 mg/L, or about 30 to about 40 mg/L). In some embodiments, the leucine can be present in an amount of at least about 22 mg/L (e.g., at least about 23 mg/L, 24 mg/L, 25 mg/L, 26 mg/L, 27 mg/L, 28 mg/L, 29 mg/L, 30 mg/L, 32 mg/L, 34 mg/L, 36 mg/L, or 38 mg/L). In some embodiments, the one or more non-volatile compounds can include no leucine.

The one or more non-volatile compounds in a Moscato-like alcoholic beverage can include phenylalanine. In some embodiments, the phenylalanine can be present in an amount of about 1.5 mg/L to about 20 mg/L (e.g., about 1.5 to about 5 mg/L, about 5 to about 10 mg/L, about 10 to about 15 mg/L, or about 15 to about 20 mg/L). In some embodiments, the one or more non-volatile compounds can include no phenylalanine.

The one or more non-volatile compounds in a Moscato-like alcoholic beverage can include methionine. In some embodiments, the methionine can be present in an amount of about 0.05 mg/L to about 4.5 mg/L (e.g., about 0.05 to about 0.10 mg/L, about 0.10 to about 0.20 mg/L, about 0.20 to about 0.50 mg/L, about 0.50 to about 1.0 mg/L, about 1.0 to about 1.5 mg/L, about 1.5 to about 2.0 mg/L, about 2.0 to about 2.5 mg/L, about 2.5 to about 3.0 mg/L, about 3.0 to about 3.5 mg/L, about 3.5 to about 4.0 mg/L, about 4.0 to about 4.5 mg/L, about 1 to about 2 mg/L, about 2 to about 3 mg/L, about 3 to about 4 mg/L, or about 1 to about 4 mg/L). In some embodiments, the methionine can be present in amount less than about 0.35 mg/L (e.g., less than about 0.34 mg/L, 0.33 mg/L, 0.32 mg/L, 0.31 mg/L, 0.3 mg/L, 0.25 mg/L, 02 mg/L, 0.15 mg/L, or 0.1 mg/L).

The one or more non-volatile compounds in a Moscato-like alcoholic beverage can include gamma-Aminobutyric acid (also called GABA). In some embodiments, the GABA can be present in an amount of about 0.6 mg/L to about 12 mg/L (e.g., about 0.6 to about 1 mg/L, about 1 to about 2 mg/L, about 1 to about 5 mg/L, about 5 to about 10 mg/L, about 5 to about 12 mg/L, about 2 to about 4 mg/L, about 4 to about 6 mg/L, about 6 to about 8 mg/L, about 8 to about 10 mg/L, or about 10 to about 12 mg/L). In some embodiments, the one or more non-volatile compounds can include no GABA.

The one or more non-volatile compounds in a Moscato-like alcoholic beverage can include tyrosine. In some embodiments, the tyrosine can be present in an amount of about 0.6 mg/L to about 15 mg/L (e.g., about 0.6 to about 1 mg/L, about 1 to about 2 mg/L, about 1 to about 5 mg/L, about 5 to about 10 mg/L, about 10 to about 15 mg/L, about 1 to about 3 mg/L, about 3 to about 5 mg/L, about 5 to about 7 mg/L, about 7 to about 9 mg/L, about 9 to about 11 mg/L, about 11 to about 13 mg/L, or about 13 to about 15 mg/L). In some embodiments, the tyrosine can be present in an amount of at least about 10.5 mg/L (e.g., at least about 11 mg/L, 12 mg/L, 13 mg/L, or 14 mg/L). In some embodiments, the one or more non-volatile compounds can include no tyrosine.

The one or more non-volatile compounds in a Moscato-like alcoholic beverage can include serine. In some embodiments, the serine can be present in an amount of about 0.25 mg/L to about 4 mg/L (e.g., about 0.25 to about 0.5 mg/L, about 0.5 to about 1 mg/L, about 1 to about 4 mg/L, about 1 to about 2 mg/L, about 2 to about 3 mg/L, about 3 to about 4 mg/L, about 1 to about 3 mg/L, or about 2 to about 4 mg/L). In some embodiments, the serine can be present in an amount of less than about 0.36 mg/L (e.g., less than about 0.35 mg/L, 0.34 mg/L, 0.33 mg/L, 0.32 mg/L, 0.031 mg/L, 0.30 mg/L, 0.29 mg/L, 0.28 mg/L, 0.27 mg/L, or 0.26 mg/). In some embodiments, the one or more non-volatile compounds can include no serine.

The one or more non-volatile compounds in a Moscato-like alcoholic beverage can include aspartic acid. In some embodiments, the aspartic acid can be present in an amount of about 2.5 mg/L to about 5 mg/L (e.g., about 2.5 to about 3 mg/L, about 3 to about 4 mg/L, about 4 to about 5 mg/L, or about 3 to about 5 mg/L). In some embodiments, the one or more non-volatile compounds can include no aspartic acid.

The one or more non-volatile compounds in a Moscato-like alcoholic beverage can include glycine. In some embodiments, the glycine can be present in an amount of about 0.2 mg/L to about 2.5 mg/L (e.g., about 0.2 to about 1 mg/L, about 0.2 to about 0.5 mg/L, about 0.5 to about 1 mg/L, about 1 to about 2 mg/L, about 1.0 to about 1.5 mg/L, about 1.5 to about 2.0 mg/L, or about 2.0 to about 2.5 mg/L). In some embodiments, the one or more non-volatile compounds can include no glycine.

The one or more non-volatile compounds in a Moscato-like alcoholic beverage can include glucosamine. In some embodiments, the glucosamine can be present in an amount of about 11 mg/L to about 480 mg/L (e.g., about 11 to about 50 mg/L, about 50 to about 100 mg/L, about 100 to about 150 mg/L, about 150 to about 200 mg/L, about 200 to about 250 mg/L, about 250 to about 300 mg/L, about 300 to about 350 mg/L, about 350 to about 400 mg/L, about 400 to about 450 mg/L, about 100 to about 200 mg/L, about 100 to about 400 mg/L, about 200 to about 300 mg/L, about 300 to about 400 mg/L, about 100 to about 300 mg/L, about 200 to about 400 mg/L, or about 450 to about 480 mg/L). In some embodiments, the one or more non-volatile compounds can include no glucosamine.

The one or more non-volatile compounds in a Moscato-like alcoholic beverage can include histidine. In some embodiments, the histidine can be present in an amount of about 0.3 to about 5 mg/L (e.g., about 0.3 to about 0.5 mg/L, about 0.5 to about 1 mg/L, about 1 to about 5 mg/L, about 1 to about 2 mg/L, about 2 to about 3 mg/L, about 3 to about 4 mg/L, about 4 to about 5 mg/L, about 1 to about 3 mg/L, about 2 to about 4 mg/L, or about 3 to about 5 mg/L).

The one or more non-volatile compounds in a Moscato-like alcoholic beverage can include lysine. In some embodiments, the lysine can be present in an amount of about 1.8 mg/L to about 18 mg/L (e.g., about 1.8 to about 5 mg/L, about 1.8 to about 2 mg/L, about 2 to about 5 mg/L, about 5 to about 10 mg/L, about 10 to about 15 mg/L, about 15 to about 18 mg/L, or about 10 to about 18 mg/L). In some embodiments, the lysine can be present in an amount of at least 8.5 mg/L (e.g., at least about 9 mg/L, 9.5 mg/L, 10 mg/L, 11 mg/L, 12 mg/L, 13 mg/L, 14 mg/L, 15 mg/L, 16 mg/L, or 17 mg/L).

The one or more non-volatile compounds in a Moscato-like alcoholic beverage can include alanine. In some embodiments, the alanine can be present in an amount of about 1.0 mg/L to about 2.5 mg/L (e.g., about 1.0 to about 1.1 mg/L, about 1.1 to about 1.3 mg/L, about 1.3 to about 1.5 mg/L, about 1.5 to about 1.7 mg/L, about 1.7 to about 1.9 mg/L, about 1.9 to about 2.1 mg/L, about 2.1 to about 2.3 mg/L, about 1 to about 2 mg/L, or about 2.3 to about 2.5 mg/L).

The one or more non-volatile compounds in a Moscato-like alcoholic beverage can include isoleucine. In some embodiments, the isoleucine can be present in an amount of about 2.5 mg/L to about 32 mg/L (e.g., about 2.5 to about 5 mg/L, about 5 to about 10 mg/L, about 10 to about 15 mg/L, about 10 to about 20 mg/L, about 15 to about 20 mg/L, about 15 to about 25 mg/L, about 20 to about 25 mg/L, about 20 to about 30 mg/L, about 20 to about 32 mg/L, about 25 to about 30 mg/L, or about 25 to about 32 mg/L). In some embodiments, the isoleucine can be present in an amount of at least about 10.6 mg/L (e.g., at least about 11 mg/L, 12 mg/L, 13 mg/L, 14 mg/L, 15 mg/L, 16 mg/L, 17 mg/L, 18 mg/L, 19 mg/L, 20 mg/L, 22 mg/L, 24 mg/L, 26 mg/L, 28 mg/L, or 30 mg/L). In some embodiments, the one or more non-volatile compounds can include no isoleucine.

The one or more non-volatile compounds in a Moscato-like alcoholic beverage can include carnitine. In some embodiments, the carnitine can be present in an amount of about 0.6 mg/L to about 4.8 mg/L (e.g., about 0.6 to about 1 mg/L, about 1 to about 1.5 mg/L, about 1.5 to about 2.0 mg/L, about 2.0 to about 2.5 mg/L, about 2.5 to about 3.0 mg/L, about 3.0 to about 3.5 mg/L, about 3.5 to about 4.0 mg/L, about 4.0 to about 4.5 mg/L, about 1 to about 2 mg/L, about 2 to about 3 mg/L, about 3 to about 4 mg/L, about 1 to about 3 mg/L, about 2 to about 4 mg/L, or about 4.5 to about 4.8 mg/L). In some embodiments, the one or more non-volatile compounds can include no carnitine.

The one or more non-volatile compounds in a Moscato-like alcoholic beverage can include tryptophan. In some embodiments, the tryptophan can be present in an amount of about 0.3 mg/L to about 8.5 mg/L (e.g., about 0.3 to about 0.5 mg/L, about 0.5 to about 1 mg/L, about 1.0 to about 1.2 mg/L, about 1.2 to about 1.4 mg/L, about 1.4 to about 1.6 mg/L, about 1.6 to about 1.8 mg/L, about 1.8 to about 2.0 mg/L, about 2.0 to about 2.2 mg/L, about 2.2 to about 2.5 mg/L, about 2.5 to about 3.0 mg/L, about 1 to about 5 mg/L, about 5 to about 8 mg/L, about 2 to about 4 mg/L, about 4 to about 6 mg/L, about 6 to about 8 mg/L, about 1 to about 2 mg/L, about 2 to about 3 mg/L, about 3 to about 4 mg/L, about 4 to about 5 mg/L, about 5 to about 6 mg/L, about 6 to about 7 mg/L, about 7 to about 8 mg/L, or about 8.0 to about 8.5 mg/L). In some embodiments, the tryptophan can be present in an amount less than about 4.0 mg/L (e.g., less than about 3.8 mg/L, 3.6 mg/L, 3.4 mg/L, 3.2 mg/L, 3.0 mg/L, 2.8 mg/L, 2.6 mg/L, 2.4 mg/L, 2.2 mg/L, 2.0 mg/L, 1.8 mg/L, or 1.6 mg/L).

The one or more non-volatile compounds in a Moscato-like alcoholic beverage can include proline. In some embodiments, the proline can be present in an amount of about 20 mg/L to about 450 mg/L (e.g., about 20 to about 50 mg/L, about 50 to about 100 mg/L, about 100 to about 150 mg/L, about 150 to about 200 mg/L, about 200 to about 250 mg/L, about 250 to about 300 mg/L, about 300 to about 350 mg/L, about 350 to about 400 mg/L, about 100 to about 200 mg/L, about 100 to about 300 mg/L, about 100 to about 400 mg/L, about 200 to about 300 mg/L, about 300 to about 400 mg/L, about 200 to about 400 mg/L, or about 400 to about 450 mg/L).

The one or more non-volatile compounds in a Moscato-like alcoholic beverage can include valine. In some embodiments, the valine can be present in an amount of about 0.005 mg/L to about 500 mg/L (e.g., about 0.005 to about 0.01 mg/L, about 0.01 to about 0.05 mg/L, about 0.05 to about 0.1 mg/L, about 0.1 to about 0.5 mg/L, about 0.5 to about 1 mg/L, about 1 to about 5 mg/L, about 5 to about 10 mg/L, about 10 to about 50 mg/L, about 50 to about 100 mg/L, about 100 to about 150 mg/L, about 150 to about 200 mg/L, about 200 to about 250 mg/L, about 250 to about 300 mg/L, about 300 to about 350 mg/L, about 350 to about 400 mg/L, about 400 to about 450 mg/L, about 10 to about 500 mg/L, about 100 to about 500 mg/L, about 100 to about 300 mg/L, about 300 to about 500 mg/L, about 200 to about 400 mg/L, about 200 to about 300 mg/L, about 300 to about 400 mg/L, about 400 to about 500 mg/L, or about 450 to about 500 mg/L). In some embodiments, the valine can be present in an amount of at least about 7.1 mg/L (e.g., at least about 7.5 mg/L, 8 mg/L, 9 mg/L, 10 mg/L, 15 mg/L, 20 mg/L, 50 mg/L, 75 mg/L, 100 mg/L, 150 mg/L, 200 mg/L, 250 mg/L, or 300 mg/L).

The one or more non-volatile compounds in a Moscato-like alcoholic beverage can include b-alanine (also called beta-alanine). In some embodiments, the b-alanine can be present in an amount of about 0.1 mg/L to about 12 mg/L (e.g., about 0.1 to about 0.5 mg/L, about 0.5 to about 1 mg/L, about 1 to about 5 mg/L, about 5 to about 10 mg/L, about 5 to about 12 mg/L, about 1 to about 2 mg/L, about 2 to about 4 mg/L, about 4 to about 6 mg/L, about 6 to about 8 mg/L, about 8 to about 10 mg/L, or about 10 to about 12 mg/L). In some embodiments, the b-alanine can be present in an amount of at least about 4.1 mg/L (e.g., at least about 4.2 mg/L, 4.3 mg/L, 4.4 mg/L, 4.5 mg/L, 5 mg/L, 6 mg/L, 7 mg/L, 8 mg/L, 9 mg/L, 10 mg/L, or 11 mg/L).

The one or more non-volatile compounds in a Moscato-like alcoholic beverage can include threonine. In some embodiments, the threonine can be present in an amount of about 0.1 mg/L to about 6.5 mg/L (e.g., about 0.1 to about 0.5 mg/L, about 0.5 to about 1 mg/L, about 1 to about 5 mg/L, about 1 to about 6.5 mg/L, about 1 to about 2 mg/L, about 2 to about 3 mg/L, about 3 to about 4 mg/L, about 4 to about 5 mg/L, about 5.0 to about 6.5 mg/L, about 1 to about 3 mg/L, about 3 to about 5 mg/L, about 2 to about 4 mg/L, about 4 to about 6 mg/L, or about 4.0 to about 6.5 mg/L). In some embodiments, the one or more non-volatile compounds can include no threonine.

The one or more non-volatile compounds in a Moscato-like alcoholic beverage can include glutamine. In some embodiments, the glutamine can be present in an amount of about 0.04 mg/L to 0.6 mg/L (e.g., about 0.04 to about 0.1 mg/L, about 0.05 to about 0.1 mg/L, about 0.1 to about 0.5 mg/L, about 0.1 to about 0.6 mg/L, about 0.1 to about 0.2 mg/L, about 0.2 to about 0.3 mg/L, about 0.3 to about 0.4 mg/L, about 0.4 to about 0.5 mg/L, about 0.5 to about 0.6 mg/L, about 0.1 to about 0.3 mg/L, about 0.3 to about 0.5 mg/L, about 0.2 to about 0.4 mg/L, or about 0.4 to about 0.6 mg/L). In some embodiments the one or more non-volatile compounds can include no glutamine.

The one or more non-volatile compounds in a Moscato-like alcoholic beverage can include asparagine. In some embodiments, the asparagine can be present in an amount of about 0.2 mg/L to about 2.5 mg/L (e.g., about 0.2 to about 0.3 mg/L, about 0.3 to about 0.4 mg/L, about 0.4 to about 0.5 mg/L, about 0.5 to about 0.6 mg/L, about 0.6 to about 0.7 mg/L, about 0.7 to about 0.8 mg/L, about 0.8 to about 0.9 mg/L, about 0.9 to about 1.0 mg/L, about 1.0 to about 1.2 mg/L, about 1.2 to about 1.4 mg/L, about 1.4 to about 1.6 mg/L, about 1.6 to about 1.8 mg/L, about 1.8 to about 2.0 mg/L, about 2.0 to about 2.2 mg/L, about 2.2 to about 2.4 mg/L, about 0.5 to about 1 mg/L, about 1 to about 2 mg/L, about 0.5 to about 1.5 mg/L, about 1.5 to about 2.5 mg/L, or about 2.2 to about 2.5 mg/L).

The one or more non-volatile compounds in a Moscato-like alcoholic beverage can include glutamic acid. In some embodiments, the glutamic acid is present in an amount of about 0.6 mg/L to about 110 mg/L (e.g., about 0.6 to about 1 mg/L, about 1 to about 5 mg/L, about 5 to about 10 mg/L, about 10 to about 20 mg/L, about 20 to about 30 mg/L, about 30 to about 40 mg/L, about 40 to about 50 mg/L, about 50 to about 60 mg/L, about 60 to about 70 mg/L, about 70 to about 80 mg/L, about 80 to about 90 mg/L, about 90 to about 100 mg/L, about 100 to about 110 mg/L, about 10 to about 50 mg/L, about 50 to about 100 mg/L, or about 50 to about 110 mg/L). In some embodiments, the glutamic acid can be present in an amount of at least about 45 mg/L (e.g., at least about 46 mg/L, 47 mg/L, 48 mg/L, 49 mg/L, 50 mg/L, 55 mg/L, 60 mg/L, 65 mg/L, 70 mg/L, 75 mg/L, 80 mg/L, 85 mg/L, 90 mg/L, 95 mg/L, 100 mg/L, or 105 mg/L).

The one or more non-volatile compounds in a Moscato-like alcoholic beverage can include arginine. In some embodiments, the arginine can be present in an amount of about 0.2 mg/L to about 36 mg/L (e.g., about 0.2 to about 0.5 mg/L, about 0.5 to about 1 mg/L, about 1 to about 5 mg/L, about 5 to about 10 mg/L, about 10 mg/L to about 15 mg/L, about 15 mg/L to about 20 mg/L, about 10 to about 20 mg/L, about 20 to about 30 mg/L, about 30 to about 36 mg/L, about 10 to about 30 mg/L, or about 10 to about 36 mg/L). In some embodiments, the arginine can be present in an amount of at least about 8.7 mg/L (e.g., at least about 8.8 mg/L, 8.9 mg/L, 9 mg/L, 10 mg/L, 12 mg/L, 15 mg/L, 20 mg/L, 25 mg/L, or 30 mg/L).

The one or more non-volatile compounds in a Moscato-like alcoholic beverage can include ornithine. In some embodiments, the ornithine can be present in an amount of about 0.07 mg/L to about 0.15 mg/L (e.g., about 0.07 to about 0.08 mg/L, about 0.08 to about 0.09 mg/L, about 0.09 to about 0.10 mg/L, about 0.10 to about 0.11 mg/L, about 0.11 to about 0.12 mg/L, about 0.12 to about 0.13 mg/L, about 0.13 to about 0.14 mg/L, or about 0.14 to about 0.15 mg/L). In some embodiments, the one or more non-volatile compounds can include no ornithine.

The one or more non-volatile compounds in a Moscato-like alcoholic beverage can include trans-4-hydroxy-L-proline (also called trans-4-hydroxyproline). In some embodiments, the trans-4-hydroxy-L-proline can be present in an amount of about 0.4 mg/L to about 3 mg/L (e.g., about 0.4 to about 1 mg/L, about 0.5 to about 1 mg/L, about 1 to about 3 mg/L, about 1 to about 2 mg/L, or about 2 to about 3 mg/L). In some embodiments, the one or more non-volatile compounds can include no trans-4-hydroxy-L-proline.

The one or more non-volatile compounds in a Moscato-like alcoholic beverage can include homoserine. In some embodiments, the homoserine can be present in an amount of about 0.2 to about 1 mg/L (e.g., about 0.2 to about 0.5 mg/L, about 0.5 to about 1 mg/L, about 0.2 to about 0.4 mg/L, about 0.4 to about 0.6 mg/L, about 0.6 to about 0.8 mg/L, or about 0.8 to about 1 mg/L). In some embodiments, the one or more non-volatile compounds can include no homoserine.

The one or more non-volatile compounds in a Moscato-like alcoholic beverage can include carnosine. In some embodiments, the carnosine can be present in an amount of about 0.04 to about 0.3 mg/L (e.g., about 0.04 to about 0.1 mg/L, about 0.05 to about 0.1 mg/L, about 0.1 to about 0.3 mg/L, about 0.1 to about 0.2 mg/L, or about 0.2 to about 0.3 mg/L). In some embodiments, the one or more non-volatile compounds can include no carnosine.

The one or more non-volatile compounds in a Moscato-like alcoholic beverage can include pipecolinic acid. In some embodiments, the pipecolinic acid can be present in an amount of about 0.7 to about 2.2 mg/L (e.g., about 0.7 to about 1 mg/L, about 1 to about 2 mg/L, about 1.0 to about 2.2 mg/L, about 1.0 to about 1.5 mg/L, about 1.5 to about 2.0 mg/L, or about 1.5 to about 2.2 mg/L). In some embodiments, the one or more non-volatile compounds can include no pipecolinic acid.

The one or more non-volatile compounds in a Moscato-like alcoholic beverage can include adenine. In some embodiments, the adenine can be present in an amount of about 0.6 mg/L to about 13 mg/L (e.g., about 0.6 to about 1 mg/L, about 1 to about 5 mg/L, about 5 to about 10 mg/L, about 5 to about 13 mg/L, about 1 to about 3 mg/L, about 3 to about 5 mg/L, about 5 to about 7 mg/L, about 7 to about 9 mg/L, about 9 to about 11 mg/L, or about 11 to about 13 mg/L). In some embodiments, the one or more non-volatile compounds can include no adenine.

The one or more non-volatile compounds in a Moscato-like alcoholic beverage can include guanine. In some embodiments, the guanine can be present in an amount of about 0.5 mg/L to about 500 mg/L (e.g., about 0.5 to about 1 mg/L, about 1 to about 10 mg/L, about 10 to about 50 mg/L, about 50 to about 100 mg/L, about 100 to about 500 mg/L, about 100 to about 200 mg/L, about 200 to about 300 mg/L, about 300 to about 400 mg/L, about 400 to about 500 mg/L, about 200 to about 400 mg/L, about 100 to about 300 mg/L, or about 300 to about 500 mg/L). In some embodiments, the one or more non-volatile compounds can include no guanine.

The one or more non-volatile compounds in a Moscato-like alcoholic beverage can include cytidine. In some embodiments, the cytidine can be present in an amount of about 0.2 to about 0.5 mg/L (e.g., about 0.2 to about 0.3 mg/L, about 0.3 to about 0.4 mg/L, about 0.4 to about 0.5 mg/L, about 0.2 to about 0.4 mg/L, or about 0.3 to about 0.5 mg/L). In some embodiments, the one or more non-volatile compounds can include no cytidine.

The one or more non-volatile compounds in a Moscato-like alcoholic beverage can include uracil. In some embodiments, the uracil can be present in an amount of about 1.2 to about 4.5 mg/L (e.g., about 1.2 to about 1.5 mg/L, about 1.5 to about 2.0 mg/L, about 1.2 to about 2.0 mg/L, about 2 to about 3 mg/L, about 3 to about 4 mg/L, about 2.0 to about 2.5 mg/L, about 2.5 to about 3.0 mg/L, about 3.0 to about 3.5 mg/L, about 3.5 to about 4.0 mg/L, or about 4.0 to about 4.5 mg/L), In some embodiments, the one or more non-volatile compounds can include no uracil.

The one or more non-volatile compounds in a Moscato-like alcoholic beverage can include kynurenic acid. In some embodiments, the kynurenic acid can be present in an amount of about 0.008 mg/L to about 0.04 mg/L (e.g., about 0.008 to about 0.01 mg/L, about 0.01 to about 0.02 mg/L, about 0.02 to about 0.03 mg/L, or about 0.03 to about 0.4 mg/L). In some embodiments, the one or more non-volatile compounds can include no kynurenic acid.

The one or more non-volatile compounds in a Moscato-like alcoholic beverage can include quinic acid. In some embodiments, the quinic acid can be present in an amount of about 20 mg/L to about 45 mg/L (e.g., about 20 to about 25 mg/L, about 25 to about 30 mg/L, about 30 to about 35 mg/L, about 35 to about 40 mg/L, about 20 to about 30 mg/L, about 30 to about 40 mg/L, or about 40 to about 45 mg/L). In some embodiments, the one or more non-volatile compounds can include no quinic acid.

The one or more non-volatile compounds in a Moscato-like alcoholic beverage can include pantothenic acid. In some embodiments, the pantothenic acid can be present in an amount of about 0.07 mg/L to about 0.40 mg/L (e.g., about 0.07 to about 0.10 mg/L, about 0.10 to about 0.15 mg/L, about 0.15 to about 0.20 mg/L, about 0.20 to about 0.25 mg/L, about 0.25 to about 0.30 mg/L, about 0.30 to about 0.35 mg/L, or about 0.35 to about 0.40 mg/L). In some embodiments, the one or more non-volatile compounds can include no pantothenic acid.

The one or more non-volatile compounds in a Moscato-like alcoholic beverage can include caffeic acid. In some embodiments, the caffeic acid can be present in an amount of about 4.5 mg/L to about 22 mg/L (e.g., about 4.5 to about 10 mg/L, about 5 to about 10 mg/L, about 10 to about 15 mg/L, about 15 to about 20 mg/L, about 15 to about 22 mg/L, about 10 to about 20 mg/L, or about 10 to about 22 mg/L). In some embodiments, the one or more non-volatile compounds can include no caffeic acid.

The one or more non-volatile compounds in a Moscato-like alcoholic beverage can include polydatin. In some embodiments, the polydatin can be present in an amount of about 0.15 mg/L to about 1.2 mg/L (e.g., about 0.15 to about 0.5 mg/L, about 0.5 to about 1 mg/L, or about 0.5 to about 1.2 mg/L). In some embodiments, the one or more non-volatile compounds can include no polydatin.

The one or more non-volatile compounds in a Moscato-like alcoholic beverage can include coumaric acid. In some embodiments, the coumaric acid can be present in an amount of about 1.3 mg/L to about 5 mg/L (e.g., about 1.3 to about 2 mg/L, about 1.5 to about 2 mg/L, about 2 to about 3 mg/L, about 3 to about 4 mg/L, about 4 to about 5 mg/L, about 2 to about 4 mg/L, or about 3 to about 5 mg/L). In some embodiments, the one or more non-volatile compounds can include no coumaric acid.

The one or more non-volatile compounds in a Moscato-like alcoholic beverage can include tartaric acid. In some embodiments, the tartaric acid can be present in an amount of about 800 mg/L to about 8 g/L (e.g., about 800 mg/L to about 1 g/L, about 1 g/L to about 2 g/L, about 1 g/L to about 5 g/L, about 1 g/L to about 8 g/L, about 1 g/L to about 3 g/L, about 3 g/L to about 5 g/L, about 5 g/L to about 7 g/L, about 2 g/L to about 4 g/L, about 4 g/L to about 6 g/L, or about 6 g/L to about 8 g/L).

The one or more non-volatile compounds in a Moscato-like alcoholic beverage can include malic acid. In some embodiments, the malic acid can be present in an amount of about 450 mg/L to about 4 g/L (e.g., about 450 to about 1 g/L, about 500 mg/L to about 1 g/L, about 1 to about 4 g/L, about 1 to about 2 g/L, about 2 to about 3 g/L, about 1 to about 3 g/L, or about 2 to about 4 g/L).

The one or more non-volatile compounds in a Moscato-like alcoholic beverage can include pyruvic acid. In some embodiments, the pyruvic acid can be present in an amount of about 0.1 mg/L to about 100 mg/L (e.g., about 0.1 to about 0.5 mg/L, about 0.5 to about 1 mg/L, about 0.1 to about 1 mg/L, about 1 to about 5 mg/L, about 5 to about 10 mg/L, about 1 to about 10 mg/L, about 10 to about 20 mg/L, about 10 to about 50 mg/L, about 50 to about 100 mg/L, about 20 to about 30 mg/L, about 30 to about 40 mg/L, about 40 to about 60 mg/L, about 60 to about 80 mg/L, or about 80 mg/L). In some embodiments, the pyruvic acid can be present in an amount of less than about 13 mg/L (e.g., less than about 12.5 mg/L, 12 mg/L, 11 mg/L, 10 mg/L, 9 mg/L, 8 mg/L, 7 mg/L, 6 mg/L, 5 mg/L, 4 mg/L, 3 mg/L, 2 mg/L, 1 mg/L, or 0.5 mg/L). In some embodiments, the one or more non-volatile compounds can include no pyruvic acid.

The one or more non-volatile compounds in a Moscato-like alcoholic beverage can include D-glucuronic acid. In some embodiments, the D-glucuronic acid can be present in an amount of about 1 mg/L to about 2 g/L (e.g., about 1 to about 5 mg/L, about 5 to about 10 mg/L, about 1 to about 10 mg/L, about 10 to about 20 mg/L, about 10 to about 50 mg/L, about 50 to about 100 mg/L, about 100 to about 500 mg/L, about 1 to about 400 mg/L, about 500 mg/L to about 1 g/L, or about 1 to about 2 g/L). In some embodiments, the D-glucuronic acid can be present in an amount of less than about 400 mg/L (e.g., less than about 350 mg/L, 300 mg/L, 250 mg/L, 200 mg/L, 150 mg/L, 100 mg/L, 75 mg/L, 50 mg/L, 25 mg/L, 10 mg/L, 9 mg/L, 8 mg/L, 7 mg/L, 6 mg/L, 5 mg/L, 4 mg/L, 3 mg/L, or 2 mg/L). In some embodiments, the one or more non-volatile compounds can include no D-glucuronic acid.

The one or more non-volatile compounds in a Moscato-like alcoholic beverage can include lactic acid. In some embodiments, the lactic acid can be present in an amount of about 18 mg/L to about 2.5 g/L (e.g., about 18 to about 25 mg/L, about 25 to about 100 mg/L, about 100 to about 500 mg/L, about 100 to about 200 mg/L, about 200 mg/L to about 2.5 g/L, about 500 mg/L to about 1 g/L, about 1 to about 2 g/L, about 1 to about 1.5 g/L, about 1.5 to about 2 g/L, about 2 to about 2.5 g/L, or about 1 to about 2.5 g/L). In some embodiments, the lactic acid can be present in an amount of at least about 225 mg/L (e.g., at least about 250 mg/L, 275 mg/L, 300 mg/L, 400 mg/L, 500 mg/L, 600 mg/L, 700 mg/L, 800 mg/L, 900 mg/L, 1 g/L, 1.5 g/L, or 2 g/L).

The one or more non-volatile compounds in a Moscato-like alcoholic beverage can include citric acid. In some embodiments, the citric acid can be present in an amount of about 80 mg/L to about 1 g/L (e.g., about 80 to about 100 mg/L, about 80 to about 140 mg/L, about 100 to about 150 mg/L, about 150 to about 200 mg/L, about 200 to about 250 mg/L, about 250 to about 300 mg/L, about 300 to about 400 mg/L, about 400 to about 500 mg/L, about 500 to about 600 mg/L, about 600 to about 700 mg/L, about 700 to about 800 mg/L, about 800 to about 900 mg/L, about 100 to about 500 mg/L, about 500 mg/L to about 1 g/L or about 900 to about 1 g/L). In some embodiments, the citric acid can be present in an amount less than about 145 mg/L (e.g., less than about 140 mg/L, 130 mg/L, 120 mg/L, 110 mg/L, 100 mg/L, or 90 mg/L)

The one or more non-volatile compounds in a Moscato-like alcoholic beverage can include fumaric acid. In some embodiments, the fumaric acid can be present in an amount of about 1 mg/L to about 11 mg/L (e.g., about 1 to about 5 mg/L, about 5 to about 10 mg/L, about 5 to about 11 mg/L, about 1 to about 3 mg/L, about 3 to about 5 mg/L, about 5 to about 7 mg/L, about 7 to about 9 mg/L, or about 9 to about 11 mg/L). In some embodiments, the one or more non-volatile compounds can include no fumaric acid.

The one or more non-volatile compounds in a Moscato-like alcoholic beverage can include succinic acid. In some embodiments, the succinic acid can be present in an amount of about 50 mg/L to about 2.5 g/L (e.g., about 50 to about 100 mg/L, about 50 to about 175 mg/L, about 100 to about 500 mg/L, about 500 mg/L to about 1 g/L, about 1 to about 1.5 g/L, about 1.2 to about 1.5 g/L, about 1.2 to about 2 g/L, about 1.5 to about 2.5 g/L, about 1 to about 2 g/L, about 1.5 to about 2 g/L, or about 2 to about 2.5 g/L). In some embodiments, the succinic acid can be present in an amount less than about 175 mg/L (e.g., less than about 170 mg/L, 160 mg/L, 150 mg/L, 140 mg/L, 130 mg/L, 120 mg/L, 110 mg/L, 100 mg/L, 90 mg/L, 80 mg/L, 70 mg/L, or 60 mg/L). In some embodiments, the succinic acid can be present in an amount of at least 1.2 g/L (e.g. at least about 1.3 g/L, 1.4 g/L, 1.5 g/L, 1.6 g/L, 1.7 g/L, 1.8 g/L, 1.9 g/L, 2.0 g/L, 2.1 g/L, 2.2 g/L, 2.3 g/L, or 2.4 g/L).

The one or more non-volatile compounds in a Moscato-like alcoholic beverage can include gallic acid. In some embodiments, the gallic acid can be present in an amount of about 0.5 mg/L to about 2.8 mg/L (e.g., about 0.5 to about 1 mg/L, about 1.0 to about 1.5 mg/L, about 1 to about 2 mg/L, about 1.5 to about 2.0 mg/L, about 2.0 to about 2.5 mg/L, about 2.0 to about 2.8 mg/L, about 1.5 to about 2.5 mg/L, about 1.5 to about 2.8 mg/L, about 1.2 to about 1.4 mg/L, about 1.4 to about 1.6 mg/L, about 1.6 to about 1.8 mg/L, about 1.8 to about 2.0 mg/L, about 2.0 to about 2.2 mg/L, about 2.2 to about 2.4 mg/L, about 2.4 to about 2.6 mg/L, or about 2.8 mg/L). In some embodiments, the one or more non-volatile compounds can include no gallic acid.

The one or more non-volatile compounds in a Moscato-like alcoholic beverage can include 2-furoic acid. In some embodiments, the 2-furoic acid can be present in an amount of about 280 mg/L to about 640 mg/L (e.g., about 280 to about 300 mg/L, about 300 to about 350 mg/L, about 350 to about 400 mg/L, about 400 to about 450 mg/L, about 450 to about 500 mg/L, about 500 to about 550 mg/L, about 550 to about 600 mg/L, about 300 to about 600 mg/L, about 300 to about 400 mg/L, about 400 to about 500 mg/L, about 500 to about 600 mg/L or about 600 to about 640 mg/L). In some embodiments, the one or more non-volatile compounds can include no 2-furoic acid. The one or more non-volatile compounds in a Moscato-like alcoholic beverage can include 3,4-dihydroxybenzoic acid. In some embodiments, the 3,4-dihydroxybenzoic acid can be present in an amount of about 0.07 mg/L to about 0.9 mg/L (e.g., about 0.07 to about 0.1 mg/L, about 0.1 to about 0.5 mg/L, about 0.5 to about 0.9 mg/L, about 0.1 to about 0.2 mg/L, about 0.2 to about 0.3 mg/L, about 0.3 to about 0.4 mg/L, about 0.4 to about 0.5 mg/L, about 0.5 to about 0.6 mg/L, about 0.6 to about 0.7 mg/L, about 0.7 to about 0.8 mg/L, or about 0.8 to about 0.9 mg/L). In some embodiments, the one or more non-volatile compounds can include no 3,4-dihydroxybenzoic acid.

The one or more non-volatile compounds in a Moscato-like alcoholic beverage can include 2-isopropylmalic acid. In some embodiments, the 2-isopropylmalic acid can be present in an amount of about 0.06 mg/L to about 15 mg/L, (e.g., about 0.06 to about 0.1 mg/L, about 0.1 to about 0.5 mg/L, about 0.5 to about 1 mg/L, about 1 to about 2 mg/L, about 1 to about 5 mg/L, about 5 to about 10 mg/L, or about 10 to about 15 mg/L). In some embodiments, the 2-isopropylmalic acid can be present in an amount of less than about 0.1 mg/L (e.g., less than about 0.09 mg/L, 0.08 mg/L, or 0.07 mg/L). In some embodiments, the one or more non-volatile compounds can include no 2-isopropylmalic acid.

The one or more non-volatile compounds in a Moscato-like alcoholic beverage can include catechin. In some embodiments, the catechin can be present in an amount of about 0.3 mg/L to about 5.5 mg/L (e.g., about 0.3 to about 0.5 mg/L, about 0.5 to about 1 mg/L, about 1 to about 5 mg/L, about 1 to about 2 mg/L, about 1 to about 3 mg/L, about 2 to about 3 mg/L, about 3 to about 4 mg/L, about 4 to about 5 mg/L, about 2 to about 4 mg/L, or about 3 to about 5 mg/L). In some embodiments, the one or more non-volatile compounds can include no catechin.

The one or more non-volatile compounds in a Moscato-like alcoholic beverage can include epicatechin. In some embodiments, the epicatechin can be present in an amount of about 0.2 mg/L to about 1.3 mg/L (e.g., about 0.2 to about 0.3 mg/L, about 0.3 to about 0.4 mg/L, about 0.4 to about 0.5 mg/L, about 0.5 to about 0.6 mg/L, 0.6 to about 0.7 mg/L, about 0.7 to about 0.8 mg/L, about 0.8 to about 0.9 mg/L, about 0.9 to about 1.0 mg/L, about 0.5 to about 1 mg/L, about 0.2 to about 0.5 mg/L, about 1.0 to about 1.3 mg/L, about 1.0 to about 1.1 mg/L, about 1.1 to about 1.2 mg/L, or about 1.2 to about 1.3 mg/L). In some embodiments, the one or more non-volatile compounds can include no epicatechin.

The one or more non-volatile compounds in a Moscato-like alcoholic beverage can include quercetin. In some embodiments, the quercetin can be present in an amount of about 0.4 mg/L to about 0.9 mg/L (e.g., about 0.4 to about 0.6 mg/L, about 0.6 to about 0.8 mg/L, about 0.5 to about 0.7 mg/L, or about 0.7 to about 0.9 mg/L). In some embodiments, the one or more non-volatile compounds can include no quercetin.

The one or more non-volatile compounds in a Moscato-like alcoholic beverage can include resveratrol. In some embodiments, the resveratrol can be present in an amount of about 0.005 mg/L to about 0.01 mg/L (e.g., about 0.005 to about 0.007 mg/L, about 0.007 to about 0.009 mg/L, about 0.006 to about 0.008 mg/L, or about 0.008 to about 0.01 mg/L). In some embodiments, the one or more non-volatile compounds can include no resveratrol.

The one or more non-volatile compounds in a Moscato-like alcoholic beverage can include ellagic acid. In some embodiments, the ellagic acid can be present in an amount of 0.04 mg/L to about 0.6 mg/L (e.g., about 0.04 to about 0.1 mg/L, about 0.05 to about 0.1 mg/L, about 0.1 to about 0.5 mg/L, about 0.1 to about 0.6 mg/L, about 0.1 to about 0.3 mg/L, about 0.3 to about 0.5 mg/L, about 0.2 to about 0.4 mg/L, or about 0.4 to about 0.6 mg/L). In some embodiments, the one or more non-volatile compounds can include no ellagic acid.

The one or more non-volatile compounds in a Moscato-like alcoholic beverage can include salicylic acid. In some embodiments, the salicylic acid can be present in an amount of about 0.03 mg/L to about 1.2 mg/L (e.g., about 0.03 to about 0.1 mg/L, about 0.05 to about 0.1 mg/L, about 0.1 to about 0.2 mg/L, about 0.2 to about 0.3 mg/L, about 0.3 to about 0.4 mg/L, about 0.4 to about 0.5 mg/L, about 0.1 to about 0.5 mg/L, about 0.5 to about 1 mg/L, about 0.5 to about 1.2 mg/L, about 0.5 to about 0.6 mg/L, about 0.6 to about 0.7 mg/L, about 0.7 to about 0.8 mg/L, about 0.8 to about 0.9 mg/L, about 0.9 to about 1.0 mg/L, about 1.0 to about 1.1 mg/L, or about 1.1 to about 1.2 mg/L). In some embodiments, the one or more non-volatile compounds can include no salicylic acid. The one or more non-volatile compounds in a Moscato-like alcoholic beverage can include camphoric acid. In some embodiments, the camphoric acid can be present in an amount of about 18 to about 45 mg/L (e.g., about 18 to about 20 mg/L, about 20 to about 30 mg/L, about 30 to about 40 mg/L, about 18 to about 25 mg/L, about 25 to about 35 mg/L, or about 35 to about 45 mg/L). In some embodiments, the one or more non-volatile compounds can include no camphoric acid.

The one or more non-volatile compounds in a Moscato-like alcoholic beverage can include cinnamic acid. In some embodiments, the cinnamic acid can be present in an amount of about 0.1 to about 0.2 mg/L. In some embodiments, the one or more non-volatile compounds can include no cinnamic acid.

The one or more non-volatile compounds in a Moscato-like alcoholic beverage can include trans-ferulic acid. In some embodiments, the trans-ferulic acid can be present in an amount of about 0.1 to about 0.4 mg/L (e.g., about 0.1 to about 0.2 mg/L, about 0.2 to about 0.3 mg/L, about 0.3 to about 0.4 mg/L, about 0.1 to about 0.3 mg/L, or about 0.2 to about 0.4 mg/L). In some embodiments, the one or more non-volatile compounds can include no trans-ferulic acid.

The one or more non-volatile compounds in a Moscato-like alcoholic beverage can include vanillic acid. In some embodiments, the vanillic acid can be present in an amount of about 0.4 to about 0.8 mg/L (e.g., about 0.4 to about 0.6 mg/L, about 0.6 to about 0.8 mg/L, or about 0.5 to about 0.7 mg/L). In some embodiments, the one or more non-volatile compounds can include no vanillic acid.

The one or more non-volatile compounds in a Moscato-like alcoholic beverage can include fructose. In some embodiments, the fructose can be present in an amount of about 3.5 g/L to about 200 g/L, (e.g., about 3.5 to about 5 g/L about 3.5 to about 10 g/L, about 5 to about 10 g/L, about 10 to about 20 g/L, about 10 to about 50 g/L, about 50 to about 100 g/L, about 100 to about 200 g/L, about 100 to about 150 g/L, or about 150 to about 200 g/L).

The one or more non-volatile compounds in a Moscato-like alcoholic beverage can include glucose. In some embodiments, the glucose can be present in an amount of about 3.5 g/L to about 160 g/L (e.g., about 3.5 to about 5 g/L, about 3.5 to about 10 g/L, about 5 to about 10 g/L, about 10 to about 20 g/L, about 10 to about 50 g/L, about 50 to about 100 g/L, about 100 to about 150 g/L, about 100 to about 160 g/L, about 50 to about 150 g/L, or about 50 to about 160 g/L).

The one or more non-volatile compounds in a Moscato-like alcoholic beverage can include ribose. In some embodiments, the ribose can be present in an amount of about 60 mg/L to about 130 mg/L (e.g., about 60 to about 70 mg/L, about 70 to about 80 mg/L, about 80 to about 90 mg/L, about 90 to about 100 mg/L, about 100 to about 110 mg/L, about 110 to about 120 mg/L, or about 120 to about 130 mg/L). In some embodiments, the one or more non-volatile compounds can include no ribose.

The one or more non-volatile compounds in a Moscato-like alcoholic beverage can include arabitol. In some embodiments, the arabitol can be present in an amount of about 0.1 mg/L to about 200 mg/L (e.g., 0.1 to about 0.5 mg/L, about 0.1 to about 1 mg/L, about 0.5 to about 1 mg/L, about 1 to about 5 mg/L, about 5 to about 10 mg/L, about 10 to about 20 mg/L, about 10 to about 50 mg/L, about 50 to about 100 mg/L, about 100 to about 200 mg/L, about 100 to about 150 mg/L, or about 150 to about 200 mg/L). In some embodiments, the arabitol can be present in an amount of less than about 1 mg/L (e.g., less than about 0.9 mg/L, 0.8 mg/L, 0.7 mg/L, 0.6 mg/L, 0.5 mg/L, 0.4 mg/L, 0.3 mg/L, or 0.1 mg/L). In some embodiments, the one or more non-volatile compounds can include no arabitol.

The one or more non-volatile compounds in a Moscato-like alcoholic beverage can include sorbitol. In some embodiments, the sorbitol can be present in an amount of about 20 mg/L to about 300 mg/L (e.g. about 20 to about 30 mg/L, about 30 to about 50 mg/L, about 50 to about 70 mg/L, about 70 to about 100 mg/L, about 100 to about 150 mg/L, about 150 to about 200 mg/L, about 200 to about 250 mg/L, about 100 to about 300 mg/L, about 100 to about 200 mg/L, about 200 to about 300 mg/L, or about 250 to about 300 mg/L). In some embodiments, the one or more non-volatile compounds can include no sorbitol.

The one or more non-volatile compounds in a Moscato-like alcoholic beverage can include mannose. In some embodiments, the mannose can be present in an amount of about 400 mg/L to about 1400 mg/L (e.g., about 400 to about 600 mg/L, about 600 to about 800 mg/L, about 800 to about 1000 mg/L, about 500 to about 1000 mg/L, about 1000 to about 1400 mg/L, about 1000 to about 1200 mg/L, or about 1200 to about 1400 mg/L). In some embodiments, the one or more non-volatile compounds can include no mannose.

The one or more non-volatile compounds in a Moscato-like alcoholic beverage can include inositol (e.g., myo-inositol) In some embodiments, the inositol can be present in an amount of about 150 mg/L to about 6.5 g/L (e.g., about 150 to about 500 mg/L, about 500 mg/L to about 1 g/L, about 1 g/L to about 5 g/L, about 1.0 to about 6.5 g/L, about 1 to about 2 g/L, about 2 to about 3 g/L, about 3 to about 4 g/L, about 4 to about 5 g/L, about 5 to about 6 g/L, about 5.0 to about 6.5 mg/L, about 1 to about 3 g/L, about 3 to about 5 g/L, about 2 to about 4 g/L, about 4 to about 6 g/L, or about 4 to about 6.5 mg/L). In some embodiments, the inositol can be present in an amount of at least about 680 mg/L (e.g., at least about 700 mg/L, 800 mg/L, 900 mg/L, 1 g/L, 2 g/L, 3 g/L, 4 g/L, 5 g/L, or 6 g/L). In some embodiments, the one or more non-volatile compounds can include no inositol.

The one or more non-volatile compounds in a Moscato-like alcoholic beverage can include mannitol. In some embodiments, the mannitol can be present in an amount of about 4 mg/L to about 550 mg/L (e.g., about 4 to about 10 mg/L, about 5 to about 10 mg/L, about 10 to about 20 mg/L, about 10 to about 50 mg/L, about 50 to about 100 mg/L, about 100 to about 500 mg/L, about 100 to about 550 mg/L, about 100 to about 200 mg/L, about 200 to about 300 mg/L, about 300 to about 400 mg/L, about 400 to about 500 mg/L, about 400 to about 550 mg/L, or about 500 to about 550 mg/L). In some embodiments, the mannitol can be present in an amount less than about 140 mg/L (e.g., less than about 130 mg/L, 125 mg/L, 120 mg/L, 110 mg/L, 100 mg/L, 90 mg/L, 80 mg/L, or 75 mg/L). In some embodiments, the mannitol can be present in an amount of at least about 360 mg/L (e.g., at least about 370 mg/L, 380 mg/L, 390 mg/L, 400 mg/L, 450 mg/L, or 500 mg/L). In some embodiments, the one or more non-volatile compounds can include no mannitol.

The one or more non-volatile compounds in a Moscato-like alcoholic beverage can include fucose. In some embodiments, the fucose can be present in an amount of about 20 mg/L to about 3.5 g/L (e.g., about 20 to about 50 mg/L, about 50 to about 100 mg/L, about 100 to about 500 mg/L, about 500 mg/L to about 1 g/L, about 1 to about 2 g/L, about 2 to about 3 g/L, about 1 to about 3 g/L, about 1.0 to about 3.5 g/L, or about 2.0 to about 3.5 g/L). In some embodiments, the one or more non-volatile compounds can include no fucose.

The one or more non-volatile compounds in a Moscato-like alcoholic beverage can include rhamnose. In some embodiments, the rhamnose can be present in an amount of about 2 to about 60 mg/L (e.g., about 2 to about 5 mg/L, about 5 to about 10 mg/L, about 10 to about 20 mg/L, about 10 to about 50 mg/L, about 10 to about 60 mg/L, about 20 to about 40 mg/L, or about 40 to about 60 mg/L). In some embodiments, the rhamnose can be present in an amount of at least about 40 mg/L (e.g., at least about 41 mg/L, 42 mg/L, 43 mg/L, 44 mg/L, 45 mg/L, 46 mg/L, 47 mg/L, 48 mg/L, 49 mg/L, 50 mg/L, 51 mg/L, 52 mg/L, 53 mg/L, 54 mg/L, 55 mg/L, 56 mg/L, 57 mg/L, 58 mg/L, or 59 mg/L). In some embodiments, the one or more non-volatile compounds can include no rhamnose.

The one or more non-volatile compounds in a Moscato-like alcoholic beverage can include xylose. In some embodiments, the xylose can be present in an amount of about 10 g/L to about 40 g/L, (e.g., about 10 to about 20 g/L, about 20 to about 30 g/L, about 30 to about 40 g/L, about 10 to about 30 g/L, or about 20 to about 40 g/). In some embodiments, the one or more non-volatile compounds can include no xylose.

The one or more non-volatile compounds in a Moscato-like alcoholic beverage can include acetic acid. In some embodiments, the acetic acid is provided as a solution at a concentration of about 4% to about 8% (v/v) (e.g., about 4% to about 5% (v/v), about 5% to about 6% (v/v), about 6% to about 7% (v/v), or about 7% to about 8% (v/v)). In some embodiments, an acetic acid solution can be present in a Moscato-like alcoholic beverage in an amount of about 0.035% to about 1.3% (v/v) (e.g., about 0.035% to about 0.05% (v/v), about 0.05% to about 0.1% (v/v), about 0.1% to about 0.5% (v/v), about 0.5% to about 1% (v/v), about 0.5% to about 1.3% (v/v), or about 0.7% to about 1.3% (v/v). In some embodiments, the one or more non-volatile compounds can include no acetic acid.

The one or more non-volatile compounds in a Moscato-like alcoholic beverage can include glycerol. In some embodiments, the glycerol is present in an amount of about 1 g/L to about 6.5 g/L (e.g., about 1 to about 5 g/L, about 1 to about 2 g/L, about 2 to about 3 g/L, about 3 to about 4 g/L, about 4 to about 5 g/L, about 5 to about 6 g/L, about 5.0 to about 6.5 g/L, about 1 to about 3 g/L, about 3 to about 5 g/L, about 2 to about 4 g/L, about 4 to about 6 g/L, or about 4 to about 6.5 g/L). In some embodiments, the one or more non-volatile compounds can include no glycerol.

The one or more non-volatile compounds in a Moscato-like alcoholic beverage can include 5′ ribonucleotides (e.g., 5′-guanylate, 5′-inosinate, or combination thereof, e.g., provided in the form of sodium or disodium salts) in some embodiments, the 5′ ribonucleotides can be present in an amount of about 0.4 mg/L to about 0.8 mg/L (e.g., about 0.4 to about 0.5 mg/L, about 0.5 to about 0.6 mg/L, about 0.6 to about 0.7 mg/L, or about 0.7 to about 0.8 mg/L). In some embodiments, the one or more non-volatile compounds can include no 5′ ribonucleotides.

The one or more non-volatile compounds in a Moscato-like alcoholic beverage can include monosodium glutamate (MSG). In some embodiments, the MSG can be present in an amount of about 6 mg/L to about 14 mg/L, (e.g., about 6 to about 8 mg/L, about 8 to about 10 mg/L, about 9 to about 11 mg/L, about 10 to about 12 mg/L, or about 12 to about 14 mg/L). In some embodiments, the one or more non-volatile compounds can include no monosodium glutamate.

The one or more non-volatile compounds in a Moscato-like alcoholic beverage can include potassium hydroxide (KOH). In some embodiments, the potassium hydroxide can be present in an amount of about 200 mg/L to about 2400 mg/L (e.g., about 200 to about 400 mg/L, about 200 to about 500 mg/L, about 500 to about 1000 mg/L, about 400 to about 600 mg/L, about 600 to about 800 mg/L, about 800 to about 1000 mg/L, about 1000 to about 2000 mg/L, about 1000 to about 2400 mg/L, about 2000 to about 2400 mg/L, about 1000 to about 1200 mg/L, about 1200 to about 1400 mg/L, about 1400 to about 1600 mg/L, about 1600 to about 1800 mg/L, about 1800 to about 2000 mg/L, about 2000 to about 2200 mg/L, or about 2200 to about 2400 mg/L). In some embodiments, the potassium hydroxide can be present in an amount such that the pH of the Moscato-like alcoholic beverage is about 3.0 to about 4.0 (e.g., about 3.0 to about 3.2, about 3.2 to about 3.4, about 3.4 to about 3.6, about 3.6 to about 3.8, about 3.0 to about 3.5, about 3.5 to about 4.0, or about 3.8 to about 4.0) The one or more non-volatile compounds in a Moscato-like alcoholic beverage can include carotene food coloring. In some embodiments, the carotene food coloring is present in an amount of about 0.0009% to about 0.005% (v/v) (e.g., about 0.0009% to about 0.001% (v/v), about 0.001% to about 0.002% (v/v), about 0.002% to about 0.003% (v/v), about 0.003% to about 0.004% (v/v), about 0.001% to about 0.003% (v/v), about 0.003% to about 0.005% (v/v), about 0.002% to about 0.004% (v/), or about 0.004% to about 0.005% (v/v)). In some embodiments, the one or more non-volatile compounds can include no carotene food coloring.

The one or more non-volatile compounds in a Moscato-like alcoholic beverage can include caramel food coloring. In some embodiments, the caramel food coloring can be present in an amount of about 0.0003% to about 0.016% (v/v) (e.g., about 0.0003% to about 0.001% (v/v), about 0.0005% to about 0.001% (v/v), about 0.001% to about 0.002% (v/v), about 0.002% to about 0.004% (v/v), about 0.001% to about 0.005% (v/v), about 0.005% to about 0.01% (v/v), about 0.010% to about 0.015% (v/v), about 0.010% to about 0.016% (v/v), about 0.004% to about 0.006% (v/v), about 0.008% to about 0.010% (v/v), about 0.010% to about 0.012% (v/v), about 0.012% to about 0.014% (v/v), or about 0.014% to about 0.016% (v/v). In some embodiments, the one or more non-volatile compounds can include no caramel food coloring.

The one or more non-volatile compounds in a Moscato-like alcoholic beverage can include gum arabic (e.g., PRE-HYDRATED® spray dried powder). In some embodiments, the gum arabic can be present in an amount of about 80 mg/L to about 170 mg/L (e.g., about 80 to about 100 mg/L, about 100 to about 120 mg/L, about 100 to about 150 mg/L, about 150 to about 170 mg/L, about 120 to about 140 mg/L, about 140 to about 160 mg/L, or about 160 to about 170 mg/L). In some embodiments, the one or more non-volatile compounds can include no gum arabic.

The one or more non-volatile compounds in a Moscato-like alcoholic beverage can include pectin (e.g., PRETESTED® Pectin 1400). In some embodiments, the pectin can be present in an amount of about 30 mg/L to about 70 mg/L (e.g., about 30 to about 40 mg/L, about 40 to about 50 mg/L, about 45 to about 55 mg/L, about 50 to about 60 mg/L, or about 60 to about 70 mg/L). In some embodiments, the one or more non-volatile compounds can include no pectin.

The one or more non-volatile compounds in a Moscato-like alcoholic beverage can include a surfactant (e.g., qualia bark extract, a lecithin, or an amphiphilic compound). In some embodiments, the surfactant can be present in an amount of 0.001% to about 0.012% (v/v) (e.g., about 0.001% to about 0.002% (v/v), about 0.001% to about 0.005% (v/v), about 0.002% to about 0.003% (v/v), about 0.003% to about 0.004% (v/v), about 0.003% to about 0.005% (v/v) about 0.004% to about 0.005% (v/v), about 0.005% to about 0.006% (v/v), about 0.006% to about 0.009% (v/v), about 0.005% to about 0.01% (v/v), about 0.005% to about 0.012% (v/v), or about 0.009 to about 0.012% (v/v)). In some embodiments, the one or more non-volatile compounds can include no surfactant.

The one or more non-volatile compounds in a Moscato-like alcoholic beverage can include one or more compounds selected from the group consisting of piperine, citrullene, acetanilide, trans-ferulic acid, quercetin, and galactose.

In some cases, the amount of any particular non-volatile compound in a Moscato replica may be different than the amount of that non-volatile compound in a corresponding reference Moscato. In some cases, the amount of a non-volatile compound in a Moscato replica can be 75% or less (e.g., 70% or less, 60% or less, 50% or less, 40% or less, 30% or less, 20% or less, or 10% or less), by concentration or percent mass, than the amount of the same non-volatile compound in a corresponding reference Moscato. In some cases, the amount of a non-volatile compound in a Moscato replica can be 125% or more (e.g., 150% or more, 200% or more, or 300% or more), by concentration or percent mass, than the amount of the same non-volatile compound in a corresponding reference Moscato.

For example, a Moscato-like alcoholic beverage can include one or more of the following: leucine in an amount of at least about 22 mg/L (e.g., about 23, 24, or 25 mg/L), methionine in an amount less than about 0.35 mg/L (e.g., about 0.34, 0.32, or 0.3 mg/L), lysine in an amount of at least about 8.5 mg/L (e.g., about 9.0, 9.5, or 10.0 mg/L), valine in an amount of at least about 7.1 mg/L (e.g., about 7.2, 7.4, or 7.6 mg/L), glutamic acid in an amount of at least about 45 mg/L (e.g., 50, 55, or 60 mg/L), arginine in an amount of at least about 8.7 mg/L (e.g., about 9.0, 9.5, or 10.0 mg/L), lactic acid in an amount of at least about 225 mg/L (e.g., about 230, 240, or 250 mg/L), citric acid in an amount less than about 145 mg/L (e.g., about 140, 130, or 120 mg/L), succinic acid in an amount less than about 175 mg/L (e.g., about 170, 160, or 150 mg/L), succinic acid in an amount of at least about 1200 mg/L (e.g., about 1300 mg/L, 1400 mg/L, or 1500 mg/L), mannitol in an amount of at least about 360 mg/L (e.g., about 370, 380, or 390 mg/L), 2-isopropylmalic acid in an amount less than about 0.1 mg/L (e.g., about 0.09, 0.08, or 0.07 mg/L), arabitol in an amount less than about 1.1 mg/L (e.g., about 1.0, 0.9, or 0.8 mg/L), beta-alanine in an amount of at least about 4.1 mg/L (e.g., about 4.2, 4.4, or 4.6 mg/L), D-glucuronic acid in an amount of less than about 400 mg/L (e.g., about 390, 380, or 370 mg/L), isoleucine in an amount of at least about 10.6 mg/L (e.g., about 10.7, 10.8, or 11 mg/L), inositol in an amount of at least about 680 mg/L (e.g., about 690, 700, or 710 mg/L), pyruvic acid in an amount of less than about 13 mg/L (e.g., about 12, 11, or 10 mg/L), rhamnose in an amount of at least about 40 mg/L (e.g., about 45, 50, or 60 mg/L), serine in an amount of less than about 0.36 mg/L (e.g., about 0.35, 0.34, or 0.33 mg/L), or tyrosine in an amount of at least about 105 mg/L (e.g., about 110, 120, or 130 mg/L).

Because of the methods by which they are made, the Moscato-like alcoholic beverages provided herein typically lack contaminants and other detrimental compounds that sometimes are encountered in traditional wines. These include, without limitation, organisms such as Escherichia coli, Salmonella sp., Brettanomyces sp., Lactobacillales, Saccharomyces sp. (which are often used by distillers and brewers), Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, and Verticillium psalliotae (strains that have been isolated from the corks of corked wine; see, www.ncbi.nlm.nih.gov/pmc/articles/PMC134401/), as well as mold, mildew, rot, insects, insect eggs, insect filth, rodent filth, mammalian excreta, insect lecithins, hydrogen sulfide, hydrogen disulfide, 2,4,6-trichloranisole (which has been linked to a skunked wine smell), 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, and dichloromethane.

In some embodiments, the VOCs in a Moscato-like alcoholic beverage can comprise (−)-beta-pinene, (−)-cis-rose oxide, 2-methyl-1-butanol, 2-methylbutyl acetate, 2-nonanone, 2-phenethylacetate, 2-phenylethanol, 3-mercaptohexylacetate, 3-methyl-1-pentanol, 4-carvomenthenol, acetovanillone, alpha-terpineol, benzaldehyde, benzyl alcohol, butanol, butyric acid, citronellol, damascenone, decanoic acid, delta-decalactone, diethyl succinate, ethyl acetate, ethyl butanoate, ethyl decanoate, ethyl hexanoate, ethyl isobutyrate, ethyl isovalerate, ethyl lactate, ethyl laurate, ethyl octanoate, ethyl valerate, gamma-decalactone, gamma-terpinene, geraniol, hexanoic acid, Hexanol, hexyl acetate, isoamyl acetate, isoamyl alcohol, isobutanol, isobutyric acid, limonene, linalool, linalyl acetate, linalyl butyrate, methyl decanoate, methyl hexanoate, nerol, octanoic acid, phenethyl butyrate, phenethyl propionate, and propanol.

In some embodiments, the VOCs in a Moscato-like alcoholic beverage can comprise at least 10 (e.g., at least 15, at least 20, at least 30, at least 40, at least 50, 10 to 50, 20 to 50, 30 to 50, 40 to 50, 10 to 20, 20 to 30, or 30 to 40) compounds selected from the group consisting of (−)-beta-pinene, (−)-cis-rose oxide, 2-methyl-1-butanol, 2-methylbutyl acetate, 2-nonanone, 2-phenethylacetate, 2-phenylethanol, 3-mercaptohexylacetate, 3-methyl-1-pentanol, 4-carvomenthenol, acetovanillone, alpha-terpineol, benzaldehyde, benzyl alcohol, butanol, butyric acid, citronellol, damascenone, decanoic acid, delta-decalactone, diethyl succinate, ethyl acetate, ethyl butanoate, ethyl decanoate, ethyl hexanoate, ethyl isobutyrate, ethyl isovalerate, ethyl lactate, ethyl laurate, ethyl octanoate, ethyl valerate, gamma-decalactone, gamma-terpinene, geraniol, hexanoic acid, hexanol, hexyl acetate, isoamyl acetate, isoamyl alcohol, isobutanol, isobutyric acid, limonene, linalool, linalyl acetate, linalyl butyrate, methyl decanoate, methyl hexanoate, nerol, octanoic acid, phenethyl butyrate, phenethyl propionate, and propanol.

In some embodiments, the VOCs in a Moscato-like alcoholic beverage can comprise 2-methyl-1-butanol, 2-nonanol, 2-nonanone, 2-undecanone, 3-methyl-1-pentanol, 4-carvomenthenol, a-terpineol, benzaldehyde, beta-pinene, butyl alcohol, butyric acid, citronellol, decanoic acid, delta-decalactone, diethyl malate, diethyl succinate, ethyl 2-methylbutyrate, ethyl butyrate, ethyl decanoate, ethyl isobutyrate, ethyl lactate, ethyl laurate, ethyl myristate, ethyl octanoate, ethyl salicylate, eucalyptol, gamma-terpinene, geraniol, hexanoic acid, hexyl acetate, hexyl alcohol, isoamyl acetate, isoamyl alcohol, isobutyl alcohol, isobutyraldehyde, isobutyric acid, linalyl acetate, 1-limonene, L-rose oxide, nerol, p-cymene, phenethyl acetate, phenethyl alcohol, phenethyl butyrate, and phenethyl propionate.

In some embodiments, the VOCs in a Moscato-like alcoholic beverage can comprise at least 10 (e.g., at least 20, at least 30, at least 40, about 10 to about 40, about 20 to about 40, about 30 to about 40, about 10 to about 20, or about 20 to about 30) compounds selected from the group consisting of 2-methyl-1-butanol, 2-nonanol, 2-nonanone, 2-undecanone, 3-methyl-1-pentanol, 4-carvomenthenol, a-terpineol, benzaldehyde, beta-pinene, butyl alcohol, butyric acid, citronellol, decanoic acid, delta-decalactone, diethyl malate, diethyl succinate, ethyl 2-methylbutyrate, ethyl butyrate, ethyl decanoate, ethyl isobutyrate, ethyl lactate, ethyl laurate, ethyl myristate, ethyl octanoate, ethyl salicylate, eucalyptol, gamma-terpinene, geraniol, hexanoic acid, hexyl acetate, hexyl alcohol, isoamyl acetate, isoamyl alcohol, isobutyl alcohol, isobutyraldehyde, isobutyric acid, linalyl acetate, 1-limonene, L-rose oxide, nerol, p-cymene, phenethyl acetate, phenethyl alcohol, phenethyl butyrate, and phenethyl propionate.

In some embodiments, the non-volatile compounds in a Moscato-like alcoholic beverage can include acetic acid, citric acid, lactic acid, malic acid, succinic acid, tartaric acid, fructose, glucose, glycerol, guanosine monophosphate, inosine monophosphate, potassium hydroxide, alanine, arginine, asparagine, aspartic acid, b-alanine, glutamic acid, glutamine, histidine, lysine, methionine, monosodium glutamate, phenylalanine, proline, serine, tryptophan, tyrosine, and valine.

In some embodiments, the non-volatile compounds in a Moscato-like alcoholic beverage can include at least 10 (e.g., at least 15, at least 20, at least 25, 10 to 15, 10 to 10, 15 to 20, 15 to 25, or 20 to 25) compounds selected from the group consisting of acetic acid, citric acid, lactic acid, malic acid, succinic acid, tartaric acid, fructose, glucose, glycerol, guanosine monophosphate, inosine monophosphate, potassium hydroxide, alanine, arginine, asparagine, aspartic acid, b-alanine, glutamic acid, glutamine, histidine, lysine, methionine, monosodium glutamate, phenylalanine, proline, serine, tryptophan, tyrosine, and valine.

In some embodiments, the non-volatile compounds in a Moscato-like alcoholic beverage can include 2-isopropylmalic acid, arginine, asparagine, beta-alanine, camphoric acid, choline, citric acid, D-glucuronic acid, fructose, fucose, fumaric acid, glucose, glutamic acid, glycine, histidine, leucine, lysine, malic acid, mannitol, phenylalanine, proline, quercetin, salicylic acid, succinic acid, tartaric acid, threonine, trans-ferulic acid, tryptophan, tyrosine, and valine.

In some embodiments, the non-volatile compounds in a Moscato-like alcoholic beverage can include at least 10 (e.g., at least 15, at least 20, at least 25, 10 to 15, 10 to 10, 15 to 20, 15 to 25, or 20 to 25) compounds selected from the group consisting of 2-isopropylmalic acid, arginine, asparagine, beta-alanine, camphoric acid, choline, citric acid, D-glucuronic acid, fructose, fucose, fumaric acid, glucose, glutamic acid, glycine, histidine, leucine, lysine, malic acid, mannitol, phenylalanine, proline, quercetin, salicylic acid, succinic acid, tartaric acid, threonine, trans-ferulic acid, tryptophan, tyrosine, and valine.

This document also provides methods for making Moscato-like alcoholic beverages. Any of the Moscato replicas described herein can be made by methods as disclosed herein. In some embodiments, the methods provided herein are carried out by first mixing one or more organic acids with water, adding ethanol and non-volatile ingredients as described herein, and then adding additional VOCs as described herein. In general, water, ethanol, organic acids, VOCs, amino acids, and certain texture and flavor modifying ingredients can all contribute to a final product having the characteristics of a traditionally-produced Moscato.

In some embodiments, the methods provided herein can include combining water one or more acids, one or more sugars or sugar alcohols, a pH-modifying salt, one or more nucleotide monophosphates, one or more amino acids, ethanol, and ten or more additional VOCs. The one or more acids can include tartaric acid and malic acid, and in some cases, they can include one or more of citric acid, succinic acid, lactic acid, and acetic acid. The one or more sugars or sugar alcohols can include glycerol, glucose, and fructose, and in some cases, they also may include one or more of sorbitol, inositol, mannose, and mannitol. The pH-modifying salt can be potassium hydroxide. The one or more nucleotide monophosphates can include guanosine monophosphate and inosine monophosphate, in some cases. The one or more amino acids can include, for example, alanine, arginine, aspartic acid, asparagine, b-alanine, glutamic acid, glutamine, histidine, lysine, methionine, monosodium glutamate, phenylalanine, proline, tryptophan, tyrosine, and valine, and in some cases, they also can include one or more of GABA, glycine, isoleucine, leucine, serine, and threonine. In some embodiments, the methods also can include adding a coloring agent (e.g., carotene and/or caramel), a surfactant (e.g., qualia bark extract, a lecithin, an amphiphilic compound, gum arabic, or pectin), or any combination thereof.

The additional VOCs that are combined with the other ingredients can be selected from the group consisting of (−)-beta-pinene, (−)-cis-rose-oxide, 1-decanol, 1-octanol, 1-octen-3-ol, 2,3-pentadione, 2-acetylpyridine, 2-heptanone, 2-isopropyl-3-methoxypyrazine, 2-methoxy-4-methylphenol, 2-methyl-1-butanol, 2-methylbutyl acetate, 2-methylbutyraldehyde, 2-nonanone, 2-phenethylacetate, 2-phenylethanol, 2-undecanone, 3-(methylthio)-1-propanol, 3,7-dimethyl-6-octenoic acid, 3-carene, 3-mercaptohexylacetate, 3-methyl-1-pentanol, 3-nonen-2-one, 4-carvomenthenol, 4-ethylguaiacol, 4-ethylphenol, acetaldehyde, acetovanillone, alpha-ionone, Amyl alcohol, amyl butyrate, alpha-phellandrene, alpha-terpineol, benzaldehyde, benzyl alcohol, butanol, butyl acetate, butyl formate, butyl isovalerate, butyric acid, cinnamaldehyde, cis-3-hexenyl acetate, citronellol, damascenone, decanoic acid, delta-decalactone, diethyl succinate, dimethyl sulfide, ethyl acetate, ethyl anthranilate, ethyl butanoate, ethyl butyrate, ethyl decanoate, ethyl hexanoate, ethyl isobutyrate, ethyl isovalerate, ethyl lactate, ethyl laurate, ethyl myristate, ethyl nonanoate, ethyl octanoate, ethyl palmitate, ethyl phenyl acetate, ethyl propionate, ethyl undecanoate, ethyl valerate, ethyl-2-methylbutyrate, ethyl-3-hydroxybutyrate, eucalyptol, eugenol, furfural, furfuryl mercaptan, gamma-decalactone, gamma-nonalactone, gamma-octalactone, gamma-terpinene, geraniol, guaiacol, heptyl acetate, hexanoic acid, hexanol, hexyl acetate, hexyl hexanoate, isoamyl acetate, isoamyl alcohol, isoamyl octanoate, isoborneol, isobutanol, isobutyric acid, isovaleraldehyde, isovaleric acid, Jasmine lactone, limonene, linalool, linalool oxide, linalyl acetate, linalyl butyrate, maltol, methional, methyl anthranilate, methyl decanoate, methyl hexanoate, methyl laurate, methyl octanoate, methyl salicylate, methyl vanillate, myrcene, myrtenol, nerol, octanoic acid, octyl acetate, p-anisaldehyde, p-cymene, phenethyl butyrate, phenethyl octanoate, phenethyl propionate, propanol, propyl hexanoate, trans-2-heptenal, trans-2-hexen-1-al, trans-2-hexen-1-ol, trans-2-pentenal, and cis-whiskey lactone.

It is noted that while Moscato replicas can include volatile and non-volatile compounds as listed herein, the added compounds may react with one another to generate additional compounds, or to change the effective amount of one or more of the added compounds within the Moscato replica formulations.

This document also provides methods for generating concentrated versions of Moscato replicas, where the concentrated versions include all of the additional VOCs and non-volatile components of the final product, but without the bulk of the ethanol and water. Such concentrates can be manufactured and then shipped to a second location, where water and ethanol can be added at the appropriate ABV and volume to create a finished Moscato replica.

Any suitable concentration of additional VOCs and nonvolatile compounds can be used. For example, a concentrated alcoholic beverage replica can include additional VOCs and nonvolatile components in a concentration of at least about 1.1-fold (e.g., 1.1-fold, 1.2-fold, 1.3-fold, 1.5-fold, 1.6-fold, 1.7-fold, 1.8-fold, 1.9-fold, 2-fold, 3-fold, 5-fold, 8-fold, 10-fold, 15-fold, or 20-fold) concentrations, as compared to their concentrations in the final product, such that they can be diluted by at least about 1.1-fold (e.g., 1.2-fold, 1.3-fold, 1.5-fold, 1.6-fold, 1.7-fold, 1.8-fold, 1.9-fold, 2-fold, 3-fold, 5-fold, 8-fold, 10-fold, 15-fold, or 20-fold), respectively, with water and ethanol to yield the final product. The concentrates provided herein can contain all of the formulaic flavor, acid, and other components (as well as any grain neutral spirits) that are present in the final product. In general, such concentrates can be prepared in much the same way as a non-concentrated alcoholic beverage replica, by combining the desired amounts of additional VOCs and nonvolatile components but omitting the water and the bulk of the ethanol. It is noted that in some cases, some amount of ethanol can be included in the concentrate in order to facilitate dissolution of the additional VOCs and nonvolatile compounds.

Any of the alcoholic beverage replicas described herein can be made as a concentrate, e.g., using the methods disclosed herein. It will be appreciated that the amount of any component (e.g., additional VOC or non-volatile) disclosed herein as an amount for an alcoholic beverage replica (e.g., a 1× alcoholic beverage replica) can be multiplied by the concentration factor (e.g., 1.1-fold, 1.2-fold, 1.3-fold, 1.5-fold, 1.6-fold, 1.7-fold, 1.8-fold, 1.9-fold 2-fold, 3-fold, 5-fold, 8-fold, 10-fold, 15-fold, or 20-fold) for the appropriate concentrated amount.

### Exemplary Embodiments

Embodiment 1 is a Moscato-like alcoholic beverage comprising ethanol, water, and one or more additional VOCs, wherein the additional VOCs do not comprise one or more of 1-octanol, 1-octen-3-ol, 1-propanol, 2,4,6-trimethylphenol, 2-acetylpyridine, 2-isopropyl-3-methoxypyrazine, 2-methylbutyl acetate, 2-methylbutyraldehyde, 3-(methylthio)-1-propanol, 3,7-dimethyl-6-octanoic acid, 3-nonen-2-one, 5-ethyl-3-hydroxy-4-methyl-2(5H)-furanone, 5-methyl furfural, 6-methyl-5-hepten-2-one, acetaldehyde, a-phellandrene, b-caryophellene, butyl formate, butyl isovalerate, cinnamaldehyde, citral, damascone, D-camphor, decanol, dimethyl sulfide, ethyl acetate, ethyl palmitate, ethyl phenylacetate, ethyl propionate, ethyl trans-2-butenoate, ethyl-3-hydroxybutyrate, furfural, hexadecanol, hexyl hexanoate, isoborneol, isobutyl acetate, isovaleraldehyde, isovaleric acid, jasmine lactone, linalool oxide, methyl acetate, methyl cyclopentenolone, methyl decanoate, myrtenol, octyl acetate, p,a-dimethylstyrene, phenylacetaldehyde, propyl butyrate, propyl hexanoate, terpinolene, trans-2-hexen-1-ol, and trans-2-pentenal.

Embodiment 2 is the Moscato-like alcoholic beverage of embodiment 1, wherein the additional VOCs do not comprise one or more of 1-octanol, 1-octen-3-ol, 2,4,6-trimethylphenol, 2-acetylpyridine, 2-isopropyl-3-methoxypyrazine, 2-methylbutyraldehyde, 3-(methylthio)-1-propanol, 3,7-dimethyl-6-octanoic acid, 3-nonen-2-one, 5-ethyl-3-hydroxy-4-methyl-2(5H)-furanone, 5-methyl furfural, 6-methyl-5-hepten-2-one, acetaldehyde, a-phellandrene, b-caryophellene, butyl formate, butyl isovalerate, cinnamaldehyde, citral, damascone, D-camphor, decanol, dimethyl sulfide, ethyl palmitate, ethyl phenylacetate, ethyl propionate, ethyl trans-2-butenoate, ethyl-3-hydroxybutyrate, furfural, hexadecanol, hexyl hexanoate, isoborneol, isobutyl acetate, isovaleraldehyde, isovaleric acid, jasmine lactone, linalool oxide, methyl acetate, methyl cyclopentenolone, myrtenol, octyl acetate, p,a-dimethylstyrene, phenylacetaldehyde, propyl butyrate, propyl hexanoate, terpinolene, trans-2-hexen-1-ol, trans-2-pentenal.

Embodiment 3 is the Moscato-like alcoholic beverage of embodiment 1, wherein the additional VOCs do not comprise one or more of 1-octanol, 1-octen-3-ol, 2,4,6-trimethylphenol, 2-methylbutyraldehyde, 5-ethyl-3-hydroxy-4-methyl-2(5H)-furanone, 6-methyl-5-hepten-2-one, b-caryophellene, butyl formate, cinnamaldehyde, citral, D-camphor, decanol, ethyl phenylacetate, ethyl propionate, ethyl trans-2-butenoate, hexadecanol, isobutyl acetate, isovaleraldehyde, methyl acetate, p,a-dimethylstyrene, phenylacetaldehyde, and terpinolene.

Embodiment 4 is the Moscato-like alcoholic beverage of embodiment 1, wherein the additional VOCs do not comprise one or more of 1-octanol, 1-octen-3-ol, 1-propanol, 2,4,6-trimethylphenol, 2-methylbutyl acetate, 2-methylbutyraldehyde, 5-ethyl-3-hydroxy-4-methyl-2(5H)-furanone, 6-methyl-5-hepten-2-one, b-caryophellene, butyl formate, cinnamaldehyde, citral, D-camphor, decanol, ethyl acetate, ethyl phenylacetate, ethyl propionate, ethyl trans-2-butenoate, hexadecanol, isobutyl acetate, isovaleraldehyde, methyl acetate, methyl decanoate, p,a-dimethylstyrene, phenylacetaldehyde, and terpinolene.

Embodiment 5 is the Moscato-like alcoholic beverage of any one of embodiments 1-4, wherein the one or more additional VOCs comprise at least one compound selected from the group consisting of (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-nonanol, 2-octanone, 2-pentylfuran, 3,7-dimethyl-6-octenoic acid, 3-heptyl acetate, 3-methylthio hexyl acetate, 3-phenylpropanal, 4-(4-hydroxyphenyl)-2-butanone, 4,5,6,7-tetrahydro-3,6-dimethylbenzofuran, 4-hydroxy-2,5-dimethyl-3(2H)-furanone, 4-mercapto-4-methyl-2-pentanone, 4-vinylphenol, 5-methyl-2-phenyl-2-hexenal, acetal (1,1-diethoxyethane), acetaldehyde, diethyl acetal, acetoin, acetovanillone, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-2-hexenol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, damascone, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexanal, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl isobutyrate, phenethyl tiglate, phenethylacetaldehyde dimethyl acetal, phenylacetaldehyde dimethyl acetal, propanal, propanoic acid, propionaldehyde, propyl isovalerate, sotolon, tetrahydrolinalool, thymol, valencene, valeraldehyde, valeric acid, vanillyl butyl ether, and vanillyl ethyl ether.

Embodiment 6 is the Moscato-like alcoholic beverage of any one of embodiments 1-5, wherein the one or more additional VOCs comprise at least one compound selected from the group consisting of (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-nonanol, 2-octanone, 2-pentylfuran, 3-heptyl acetate, 3-methylthio hexyl acetate, 3-phenylpropanal, 4-(4-hydroxyphenyl)-2-butanone, 4,5,6,7-tetrahydro-3,6-dimethylbenzofuran, 4-hydroxy-2,5-dimethyl-3(2H)-furanone, 4-mercapto-4-methyl-2-pentanone, 4-vinylphenol, 5-methyl-2-phenyl-2-hexenal, acetal (1,1-diethoxyethane), acetoin, acetovanillone, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, damascone, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexanal, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl tiglate, phenethylacetaldehyde dimethyl acetal, phenylacetaldehyde dimethyl acetal, propanal, propanoic acid, propionaldehyde, propyl isovalerate, sotolon, tetrahydrolinalool, thymol, valencene, valeraldehyde, valeric acid, vanillyl butyl ether, and vanillyl ethyl ether.

Embodiment 7 is the Moscato-like alcoholic beverage of any one of embodiments 1-5, wherein the one or more additional VOCs comprise at least one compound selected from the group consisting of 2-nonanol, 4-(4-hydroxyphenyl)-2-butanone, 4-hydroxy-2,5-dimethyl-3(2H)-furanone, 4-vinylphenol, butyraldehyde, citronellyl acetate, damascone, decanal, gamma-dodecalactone, hexanal, Propionaldehyde, sotolon, and valeric acid.

Embodiment 8 is the Moscato-like alcoholic beverage of any one of embodiments 1-5, wherein the one or more additional VOCs comprise 2-nonanol, 4-vinylphenol, or both.

Embodiment 9 is the Moscato-like alcoholic beverage of any one of embodiments 1-5, wherein the one or more additional VOCs comprise 2-nonanol.

Embodiment 10 is the Moscato-like alcoholic beverage of any one of embodiments 1-5, wherein the one or more additional VOCs comprise 4-vinylphenol.

Embodiment 11 is the Moscato-like alcoholic beverage of any one of embodiments 1-5, wherein the one or more additional VOCs comprise at least one compound selected from the group consisting of (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-octanone, 2-pentylfuran, 3-heptyl acetate, 3-methylthio hexyl acetate, 3-phenylpropanal, 4,5,6,7-tetrahydro-3,6-dimethylbenzofuran, 4-mercapto-4-methyl-2-pentanone, 5-methyl-2-phenyl-2-hexenal, acetal (1,1-diethoxyethane), acetoin, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl tiglate, phenethylacetaldehyde dimethyl acetal, phenylacetaldehyde dimethyl acetal, propanal, propanoic acid, propyl isovalerate, tetrahydrolinalool, thymol, valencene, valeraldehyde, vanillyl butyl ether, and vanillyl ethyl ether.

Embodiment 12 is the Moscato-like alcoholic beverage of any one of embodiments 1-5, wherein the one or more additional VOCs comprise at least one compound selected from the group consisting of 3,7-dimethyl-6-octenoic acid, 4-(4-hydroxyphenyl)-2-butanone, 4-hydroxy-2,5-dimethyl-3(2H)-furanone, acetaldehyde, diethyl acetal, cis-2-hexenol, hexanal, phenethyl formate, phenethyl isobutyrate, and sotolon.

Embodiment 13 is the Moscato-like alcoholic beverage of any one of embodiments 1-5, wherein the one or more additional VOCs comprise at least one compound selected from the group consisting of 2-nonanol, 4-(4-hydroxyphenyl)-2-butanone, 4-hydroxy-2,5-dimethyl-3(2H)-furanone, 4-vinylphenol, butyraldehyde, citronellyl acetate, damascone, decanal, gamma-dodecalactone, hexanal, propionaldehyde, sotolon, and valeric acid.

Embodiment 14 is a Moscato-like alcoholic beverage comprising ethanol, water, and one or more additional VOCs, wherein the additional VOCs comprise at least one compound selected from the group consisting of (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-nonanol, 2-octanone, 2-pentylfuran, 3,7-dimethyl-6-octenoic acid, 3-heptyl acetate, 3-methylthio hexyl acetate, 3-phenylpropanal, 4-(4-hydroxyphenyl)-2-butanone, 4,5,6,7-tetrahydro-3,6-dimethylbenzofuran, 4-hydroxy-2,5-dimethyl-3(2H)-furanone, 4-mercapto-4-methyl-2-pentanone, 4-vinylphenol, 5-methyl-2-phenyl-2-hexenal, acetal (1,1-diethoxyethane), acetaldehyde, diethyl acetal, acetoin, acetovanillone, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-2-hexenol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, damascone, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexanal, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl isobutyrate, phenethyl tiglate, phenethylacetaldehyde dimethyl acetal, phenylacetaldehyde dimethyl acetal, propanal, propanoic acid, propionaldehyde, propyl isovalerate, sotolon, tetrahydrolinalool, thymol, valencene, valeraldehyde, valeric acid, vanillyl butyl ether, and vanillyl ethyl ether.

Embodiment 15 is the Moscato-like alcoholic beverage of embodiment 14, wherein the one or more additional VOCs comprise at least one compound selected from the group consisting of (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-nonanol, 2-octanone, 2-pentylfuran, 3-heptyl acetate, 3-methylthio hexyl acetate, 3-phenylpropanal, 4-(4-hydroxyphenyl)-2-butanone, 4,5,6,7-tetrahydro-3,6-dimethylbenzofuran, 4-hydroxy-2,5-dimethyl-3(2H)-furanone, 4-mercapto-4-methyl-2-pentanone, 4-vinylphenol, 5-methyl-2-phenyl-2-hexenal, acetal (1,1-diethoxyethane), acetoin, acetovanillone, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, damascone, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexanal, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl tiglate, phenethylacetaldehyde dimethyl acetal, phenylacetaldehyde dimethyl acetal, propanal, propanoic acid, propionaldehyde, propyl isovalerate, sotolon, tetrahydrolinalool, thymol, valencene, valeraldehyde, valeric acid, vanillyl butyl ether, and vanillyl ethyl ether.

Embodiment 16 is the Moscato-like alcoholic beverage of embodiment 14 or embodiment 15, wherein the one or more additional VOCs comprise at least one compound selected from the group consisting of 2-nonanol, 4-(4-hydroxyphenyl)-2-butanone, 4-hydroxy-2,5-dimethyl-3(2H)-furanone, 4-vinylphenol, butyraldehyde, citronellyl acetate, damascone, decanal, gamma-dodecalactone, hexanal, propionaldehyde, sotolon, and valeric acid.

Embodiment 17 is the Moscato-like alcoholic beverage of any one of embodiments 14-16, wherein the one or more additional VOCs comprise 2-nonanol, 4-vinylphenol, or both.

Embodiment 18 is the Moscato-like alcoholic beverage of any one of embodiments 14-17, wherein the one or more additional VOCs comprise 2-nonanol.

Embodiment 19 is the Moscato-like alcoholic beverage of any one of embodiments 14-17, wherein the one or more additional VOCs comprise 4-vinylphenol.

Embodiment 20 is the Moscato-like alcoholic beverage of embodiment 14 or embodiment 15, wherein the one or more additional VOCs comprise at least one compound selected from the group consisting of (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-octanone, 2-pentylfuran, 3-heptyl acetate, 3-methylthio hexyl acetate, 3-phenylpropanal, 4,5,6,7-tetrahydro-3,6-dimethylbenzofuran, 4-mercapto-4-methyl-2-pentanone, 5-methyl-2-phenyl-2-hexenal, acetal (1,1-diethoxyethane), acetoin, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl tiglate, phenethylacetaldehyde dimethyl acetal, phenylacetaldehyde dimethyl acetal, propanal, propanoic acid, propyl isovalerate, tetrahydrolinalool, thymol, valencene, valeraldehyde, vanillyl butyl ether, and vanillyl ethyl ether.

Embodiment 21 is the Moscato-like alcoholic beverage of embodiment 14, wherein the one or more additional VOCs comprise at least one compound selected from the group consisting of 3,7-dimethyl-6-octenoic acid, 4-(4-hydroxyphenyl)-2-butanone, 4-hydroxy-2,5-dimethyl-3(2H)-furanone, acetaldehyde, diethyl acetal, cis-2-hexenol, hexanal, phenethyl formate, phenethyl isobutyrate, and sotolon.

Embodiment 22 is the Moscato-like alcoholic beverage of any one of embodiment 14 or embodiment 15, wherein the one or more additional VOCs comprise at least one compound selected from the group consisting of 2-nonanol, 4-(4-hydroxyphenyl)-2-butanone, 4-hydroxy-2,5-dimethyl-3(2H)-furanone, 4-vinylphenol, butyraldehyde, citronellyl acetate, damascone, decanal, gamma-dodecalactone, hexanal, propionaldehyde, sotolon, and valeric acid.

Embodiment 23 is the Moscato-like alcoholic beverage of any one of embodiments 14-22, wherein the one or more additional VOCs do not comprise one or more of 1-octanol, 1-octen-3-ol, 1-propanol, 2,4,6-trimethylphenol, 2-acetylpyridine, 2-isopropyl-3-methoxypyrazine, 2-methylbutyl acetate, 2-methylbutyraldehyde, 3-(methylthio)-1-propanol, 3,7-dimethyl-6-octanoic acid, 3-nonen-2-one, 5-ethyl-3-hydroxy-4-methyl-2(5H)-furanone, 5-methyl furfural, 6-methyl-5-hepten-2-one, acetaldehyde, a-phellandrene, b-caryophellene, butyl formate, butyl isovalerate, cinnamaldehyde, citral, damascone, D-camphor, decanol, dimethyl sulfide, ethyl acetate, ethyl palmitate, ethyl phenylacetate, ethyl propionate, ethyl trans-2-butenoate, ethyl-3-hydroxybutyrate, furfural, hexadecanol, hexyl hexanoate, isoborneol, isobutyl acetate, isovaleraldehyde, isovaleric acid, jasmine lactone, linalool oxide, methyl acetate, methyl cyclopentenolone, methyl decanoate, myrtenol, octyl acetate, p,a-dimethylstyrene, phenylacetaldehyde, propyl butyrate, propyl hexanoate, terpinolene, trans-2-hexen-1-ol, and trans-2-pentenal.

Embodiment 24 is the Moscato-like alcoholic beverage of any one of embodiments 14-23, wherein the additional VOCs do not comprise one or more of 1-octanol, 1-octen-3-ol, 2,4,6-trimethylphenol, 2-acetylpyridine, 2-isopropyl-3-methoxypyrazine, 2-methylbutyraldehyde, 3-(methylthio)-1-propanol, 3,7-dimethyl-6-octanoic acid, 3-nonen-2-one, 5-ethyl-3-hydroxy-4-methyl-2(5H)-furanone, 5-methyl furfural, 6-methyl-5-hepten-2-one, acetaldehyde, a-phellandrene, b-caryophellene, butyl formate, butyl isovalerate, cinnamaldehyde, citral, damascone, D-camphor, decanol, dimethyl sulfide, ethyl palmitate, ethyl phenylacetate, ethyl propionate, ethyl trans-2-butenoate, ethyl-3-hydroxybutyrate, furfural, hexadecanol, hexyl hexanoate, isoborneol, isobutyl acetate, isovaleraldehyde, isovaleric acid, jasmine lactone, linalool oxide, methyl acetate, methyl cyclopentenolone, myrtenol, octyl acetate, p,a-dimethylstyrene, phenylacetaldehyde, propyl butyrate, propyl hexanoate, terpinolene, trans-2-hexen-1-ol, trans-2-pentenal.

Embodiment 25 is the Moscato-like alcoholic beverage of any one of embodiments 14-23, wherein the additional VOCs do not comprise one or more of 1-octanol, 1-octen-3-ol, 2,4,6-trimethylphenol, 2-methylbutyraldehyde, 5-ethyl-3-hydroxy-4-methyl-2(5H)-furanone, 6-methyl-5-hepten-2-one, b-caryophellene, butyl formate, cinnamaldehyde, citral, D-camphor, decanol, ethyl phenylacetate, ethyl propionate, ethyl trans-2-butenoate, hexadecanol, isobutyl acetate, isovaleraldehyde, methyl acetate, p,a-dimethylstyrene, phenylacetaldehyde, and terpinolene.

Embodiment 26 is the Moscato-like alcoholic beverage of any one of embodiments 14-23, wherein the additional VOCs do not comprise one or more of 1-octanol, 1-octen-3-ol, 1-propanol, 2,4,6-trimethylphenol, 2-methylbutyl acetate, 2-methylbutyraldehyde, 5-ethyl-3-hydroxy-4-methyl-2(5H)-furanone, 6-methyl-5-hepten-2-one, b-caryophellene, butyl formate, cinnamaldehyde, citral, D-camphor, decanol, ethyl acetate, ethyl phenylacetate, ethyl propionate, ethyl trans-2-butenoate, hexadecanol, isobutyl acetate, isovaleraldehyde, methyl acetate, methyl decanoate, p,a-dimethylstyrene, phenylacetaldehyde, and terpinolene.

Embodiment 27 is the Moscato-like alcoholic beverage of any one of embodiments 1-26, wherein the one or more additional VOCs comprise one or more of butyl formate, ethyl octanoate, ethyl propionate, ethyl-2-methylbutyrate, isoamyl acetate, isoamyl alcohol, and isobutanol.

Embodiment 28 is the Moscato-like alcoholic beverage of any one of embodiments 1-26, wherein the one or more additional VOCs comprise two or more of butyl formate, ethyl octanoate, ethyl propionate, ethyl-2-methylbutyrate, isoamyl acetate, isoamyl alcohol, and isobutanol.

Embodiment 29 is the Moscato-like alcoholic beverage of any one of embodiments 1-26, wherein the one or more additional VOCs comprise three or more of butyl formate, ethyl octanoate, ethyl propionate, ethyl-2-methylbutyrate, isoamyl acetate, isoamyl alcohol, and isobutanol.

Embodiment 30 is the Moscato-like alcoholic beverage of any one of embodiments 1-26, wherein the one or more additional VOCs comprise four or more of butyl formate, ethyl octanoate, ethyl propionate, ethyl-2-methylbutyrate, isoamyl acetate, isoamyl alcohol, and isobutanol.

Embodiment 31 is the Moscato-like alcoholic beverage of any one of embodiments 1-26, wherein the one or more additional VOCs comprise five or more of butyl formate, ethyl octanoate, ethyl propionate, ethyl-2-methylbutyrate, isoamyl acetate, isoamyl alcohol, and isobutanol.

Embodiment 32 is the Moscato-like alcoholic beverage of any one of embodiments 1-26, wherein the one or more additional VOCs comprise six or more of butyl formate, ethyl octanoate, ethyl propionate, ethyl-2-methylbutyrate, isoamyl acetate, isoamyl alcohol, and isobutanol.

Embodiment 33 is the Moscato-like alcoholic beverage of any one of embodiments 1-26, wherein the one or more additional VOCs comprise butyl formate, ethyl octanoate, ethyl propionate, ethyl-2-methylbutyrate, isoamyl acetate, isoamyl alcohol, and isobutanol.

Embodiment 34 is the Moscato-like alcoholic beverage of any one of embodiments 1-26, wherein the one or more additional VOCs comprise no more than 6 of butyl formate, ethyl octanoate, ethyl propionate, ethyl-2-methylbutyrate, isoamyl acetate, isoamyl alcohol, and isobutanol.

Embodiment 35 is the Moscato-like alcoholic beverage of any one of embodiments 1-26, wherein the one or more additional VOCs comprise no more than 5 of butyl formate, ethyl octanoate, ethyl propionate, ethyl-2-methylbutyrate, isoamyl acetate, isoamyl alcohol, and isobutanol.

Embodiment 36 is the Moscato-like alcoholic beverage of any one of embodiments 1-26, wherein the one or more additional VOCs comprise no more than 4 of butyl formate, ethyl octanoate, ethyl propionate, ethyl-2-methylbutyrate, isoamyl acetate, isoamyl alcohol, and isobutanol.

Embodiment 37 is the Moscato-like alcoholic beverage of any one of embodiments 1-36, wherein the one or more additional VOCs comprise 2-nonanone in an amount of at least about 0.0014 mg/L.

Embodiment 38 is the Moscato-like alcoholic beverage of any one of embodiments 1-37, wherein the one or more additional VOCs comprise 2-phenylethanol in an amount less than about 13.5 mg/L.

Embodiment 39 is the Moscato-like alcoholic beverage of any one of embodiments 1-38, wherein the one or more additional VOCs comprise 2-phenyethylacetate in an amount of at least about 0.15 mg/L.

Embodiment 40 is the Moscato-like alcoholic beverage of any one of embodiments 1-39, wherein the one or more additional VOCs comprise 2-undecanone in an amount of at least about 0.0014 mg/L.

Embodiment 41 is the Moscato-like alcoholic beverage of any one of embodiments 1-40, wherein the one or more additional VOCs comprise 4-carvomenthenol in an amount of at least about 0.02 mg/L.

Embodiment 42 is the Moscato-like alcoholic beverage of any one of embodiments 1-41, wherein the one or more additional VOCs comprise benzaldehyde in an amount of at least about 0.022 mg/L.

Embodiment 43 is the Moscato-like alcoholic beverage of any one of embodiments 1-42, wherein the one or more additional VOCs comprise beta-pinene in an amount of at least about 0.014 mg/L.

Embodiment 44 is the Moscato-like alcoholic beverage of any one of embodiments 1-43, wherein the one or more additional VOCs comprise citronellol in an amount of at least about 0.01 mg/L.

Embodiment 45 is the Moscato-like alcoholic beverage of any one of embodiments 1-44, wherein the one or more additional VOCs comprise decanoic acid in an amount of at least about 0.6 mg/L.

Embodiment 46 is the Moscato-like alcoholic beverage of any one of embodiments 1-45, wherein the one or more additional VOCs comprise delta-decalactone in an amount of at least about 0.007 mg/L.

Embodiment 47 is the Moscato-like alcoholic beverage of any one of embodiments 1-46, wherein the one or more additional VOCs comprise diethyl malate in an amount of less than about 0.35 mg/L.

Embodiment 48 is the Moscato-like alcoholic beverage of any one of embodiments 1-47, wherein the one or more additional VOCs comprise diethyl succinate in an amount less than about 0.4 mg/L.

Embodiment 49 is the Moscato-like alcoholic beverage of any one of embodiments 1-48, wherein the one or more additional VOCs comprise ethyl acetate in an amount less than about 7 mg/L.

Embodiment 50 is the Moscato-like alcoholic beverage of any one of embodiments 1-49, wherein the one or more additional VOCs comprise ethyl butyrate in an amount of at least about 0.5 mg/L.

Embodiment 51 is the Moscato-like alcoholic beverage of any one of embodiments 1-50, wherein the one or more additional VOCs comprise ethyl isobutyrate in an amount of at least about 0.3 mg/L.

Embodiment 52 is the Moscato-like alcoholic beverage of any one of embodiments 1-51, wherein the one or more additional VOCs comprise ethyl isovalerate in an amount of at least about 0.07 mg/L.

Embodiment 53 is the Moscato-like alcoholic beverage of any one of embodiments 1-52, wherein the one or more additional VOCs comprise ethyl lactate in an amount less than about 2 mg/L.

Embodiment 54 is the Moscato-like alcoholic beverage of any one of embodiments 1-53, wherein the one or more additional VOCs comprise ethyl myristate in an amount of at least about 0.45 mg/L.

Embodiment 55 is the Moscato-like alcoholic beverage of any one of embodiments 1-54, wherein the one or more additional VOCs comprise ethyl valerate in an amount of at least about 0.0012 mg/L.

Embodiment 56 is the Moscato-like alcoholic beverage of any one of embodiments 1-55, wherein the one or more additional VOCs comprise eucalyptol in an amount of at least about 0.0009 mg/L.

Embodiment 57 is the Moscato-like alcoholic beverage of any one of embodiments 1-56, wherein the one or more additional VOCs comprise gamma-decalactone in an amount of at least about 0.012 mg/L.

Embodiment 58 is the Moscato-like alcoholic beverage of any one of embodiments 1-57, wherein the one or more additional VOCs comprise gamma-terpinene in an amount of at least about 0.04 mg/L.

Embodiment 59 is the Moscato-like alcoholic beverage of any one of embodiments 1-58, wherein the one or more additional VOCs comprise hexanoic acid in an amount of at least about 0.35 mg/L

Embodiment 60 is the Moscato-like alcoholic beverage of any one of embodiments 1-59, wherein the one or more additional VOCs comprise hexyl acetate in an amount of at least about 0.04 mg/L.

Embodiment 61 is the Moscato-like alcoholic beverage of any one of embodiments 1-60, wherein the one or more additional VOCs comprise isoamyl acetate in an amount of at least about 1.7 mg/L.

Embodiment 62 is the Moscato-like alcoholic beverage of any one of embodiments 1-61, wherein the one or more additional VOCs comprise isobutyraldehyde in an amount of at least about 0.0035 mg/L.

Embodiment 63 is the Moscato-like alcoholic beverage of any one of embodiments 1-62, wherein the one or more additional VOCs comprise isobutyric acid in an amount less than about 1.6 mg/L.

Embodiment 64 is the Moscato-like alcoholic beverage of any one of embodiments 1-63, wherein the one or more additional VOCs comprise limonene in an amount of at least about 0.012 mg/L.

Embodiment 65 is the Moscato-like alcoholic beverage of any one of embodiments 1-64, wherein the one or more additional VOCs comprise linalool in an amount of at least about 0.5 mg/L.

Embodiment 66 is the Moscato-like alcoholic beverage of any one of embodiments 1-65, wherein the one or more additional VOCs comprise linalyl acetate in an amount of at least about 0.22 mg/L.

Embodiment 67 is the Moscato-like alcoholic beverage of any one of embodiments 1-66, wherein the one or more additional VOCs comprise linalyl butyrate in an amount of at least about 0.0002 mg/L.

Embodiment 68 is the Moscato-like alcoholic beverage of any one of embodiments 1-67, wherein the one or more additional VOCs comprise L-rose oxide in an amount of at least about 0.0011 mg/L.

Embodiment 69 is the Moscato-like alcoholic beverage of any one of embodiments 1-68, wherein the one or more additional VOCs comprise nerol in an amount of at least about 0.006 mg/L.

Embodiment 70 is the Moscato-like alcoholic beverage of any one of embodiments 1-69, wherein the one or more additional VOCs comprise p-cymene in an amount of at least about 0.0006 mg/L.

Embodiment 71 is the Moscato-like alcoholic beverage of any one of embodiments 1-70, wherein the one or more additional VOCs comprise phenethyl butyrate in an amount of at least about 0.0017 mg/L.

Embodiment 72 is the Moscato-like alcoholic beverage of any one of embodiments 1-71, wherein the one or more additional VOCs comprise phenethyl propionate in an amount of at least about 0.0002 mg/L.

Embodiment 73 is the Moscato-like alcoholic beverage of any one of embodiments 1-72, wherein the one or more additional VOCs comprise propanol in an amount less than about 1.35 mg/L.

Embodiment 74 is the Moscato-like alcoholic beverage of any one of embodiments 1-73, wherein at least about 0.016% by mass of the one or more additional VOCs comprises (−)-beta-pinene.

Embodiment 75 is the Moscato-like alcoholic beverage of any one of embodiments 1-74, wherein at least about 0.0013% by mass of the one or more additional VOCs comprises L-rose oxide.

Embodiment 76 is the Moscato-like alcoholic beverage of any one of embodiments 1-75, wherein at least about 0.0017% by mass of the one or more additional VOCs comprises 2-nonanone.

Embodiment 77 is the Moscato-like alcoholic beverage of any one of embodiments 1-76, wherein at least about 0.18% by mass of the one or more additional VOCs comprises 2-phenethylacetate.

Embodiment 78 is the Moscato-like alcoholic beverage of any one of embodiments 1-77, wherein at least about 0.0017% by mass of the one or more additional VOCs comprises 2-undecanone.

Embodiment 79 is the Moscato-like alcoholic beverage of any one of embodiments 1-78, wherein at least about 0.025% by mass of the one or more additional VOCs comprises 4-carvomenthenol.

Embodiment 80 is the Moscato-like alcoholic beverage of any one of embodiments 1-79, wherein at least about 0.026% by mass of the one or more additional VOCs comprises benzaldehyde.

Embodiment 81 is the Moscato-like alcoholic beverage of any one of embodiments 1-80, wherein at least about 0.012% by mass of the one or more additional VOCs comprises citronellol.

Embodiment 82 is the Moscato-like alcoholic beverage of any one of embodiments 1-81, wherein at least about 0.7% by mass of the one or more additional VOCs comprises decanoic acid.

Embodiment 83 is the Moscato-like alcoholic beverage of any one of embodiments 1-82, wherein at least about 0.6% by mass of the one or more additional VOCs comprises ethyl butyrate.

Embodiment 84 is the Moscato-like alcoholic beverage of any one of embodiments 1-83, wherein at least about 0.36% by mass of the one or more additional VOCs comprises ethyl isobutyrate.

Embodiment 85 is the Moscato-like alcoholic beverage of any one of embodiments 1-84, wherein at least about 0.09% by mass of the one or more additional VOCs comprises ethyl isovalerate.

Embodiment 86 is the Moscato-like alcoholic beverage of any one of embodiments 1-85, wherein at least about 0.0015% by mass of the one or more additional VOCs comprises ethyl valerate.

Embodiment 87 is the Moscato-like alcoholic beverage of any one of embodiments 1-86, wherein at least about 0.0012% by mass of the one or more additional VOCs comprises eucalyptol.

Embodiment 88 is the Moscato-like alcoholic beverage of any one of embodiments 1-87, wherein at least about 0.014% by mass of the one or more additional VOCs comprises gamma-decalactone.

Embodiment 89 is the Moscato-like alcoholic beverage of any one of embodiments 1-88, wherein at least about 0.05% by mass of the one or more additional VOCs comprises gamma terpinene.

Embodiment 90 is the Moscato-like alcoholic beverage of any one of embodiments 1-89, wherein at least about 0.4% by mass of the one or more additional VOCs comprises hexanoic acid.

Embodiment 91 is the Moscato-like alcoholic beverage of any one of embodiments 1-90, wherein at least about 0.05% by mass of the one or more additional VOCs comprises hexyl acetate.

Embodiment 92 is the Moscato-like alcoholic beverage of any one of embodiments 1-91, wherein at least about 2% by mass of the one or more additional VOCs comprises isoamyl acetate.

Embodiment 93 is the Moscato-like alcoholic beverage of any one of embodiments 1-92, wherein at least about 0.0045% by mass of the one or more additional VOCs comprise isobutyraldehyde.

Embodiment 94 is the Moscato-like alcoholic beverage of any one of embodiments 1-93, wherein at least about 0.014% by mass of the one or more additional VOCs comprises limonene.

Embodiment 95 is the Moscato-like alcoholic beverage of any one of embodiments 1-94, wherein at least about 0.6% by mass of the one or more additional VOCs comprises linalool.

Embodiment 96 is the Moscato-like alcoholic beverage of any one of embodiments 1-95, wherein at least about 0.25% by mass of the one or more additional VOCs comprises linalyl acetate.

Embodiment 97 is the Moscato-like alcoholic beverage of any one of embodiments 1-96, wherein at least about 0.00025% by mass of the one or more additional VOCs comprises linalyl butyrate.

Embodiment 98 is the Moscato-like alcoholic beverage of any one of embodiments 1-97, wherein at least about 0.007% by mass of the one or more additional VOCs comprises nerol.

Embodiment 99 is the Moscato-like alcoholic beverage of any one of embodiments 1-98, wherein at least about 0.0007% by mass of the one or more additional VOCs comprise p-cymene.

Embodiment 100 is the Moscato-like alcoholic beverage of any one of embodiments 1-99, wherein at least about 0.002% by mass of the one or more additional VOCs comprises phenethyl butyrate.

Embodiment 101 is the Moscato-like alcoholic beverage of any one of embodiments 1-100, wherein at least about 0.00025% by mass of the one or more additional VOCs comprises phenethyl propionate.

Embodiment 102 is the Moscato-like alcoholic beverage of any one of embodiments 1-101, wherein the one or more additional VOCs comprise an ester, an acid, an alcohol, an aldehyde, a ketone, or an aldehyde and a ketone, a terpene, an isoprenoid, or a terpene and an isoprenoid, and a lactone.

Embodiment 103 is the Moscato-like alcoholic beverage of any one of embodiments 1-102, wherein the one or more additional VOCs comprise one or more esters.

Embodiment 104 is the Moscato-like alcoholic beverage of embodiment 103, wherein the one or more esters are selected from the group consisting of 2-methylbutyl acetate, 2-methylbutyl isovalerate, 3-heptyl acetate, 3-methylthio hexyl acetate, allyl heptanoate, allyl hexanoate, amyl butyrate, amyl formate, anisyl acetate, anisyl butyrate, benzyl acetate, benzyl benzoate, benzyl butyrate, benzyl formate, benzyl propionate, butyl acetate, butyl butyryllactate, butyl formate, butyl isovalerate, cis-3-hexenyl acetate, cis-3-hexenyl butyrate, cis-3-hexenyl caproate, cis-3-hexenyl valerate, citronellyl acetate, diethyl malate, diethyl succinate, dimethyl anthranilate, dimethyl succinate, ethyl (methylthio) acetate, ethyl 2-methylbutyrate, ethyl 2-trans-4-cis-decadienoate, ethyl 3-hydroxyhexanoate, ethyl acetate, ethyl anthranilate, ethyl benzoate, ethyl butyrate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenylacetate, ethyl propionate, ethyl salicylate, ethyl trans-2-butenoate, ethyl undecanoate, ethyl valerate, ethyl-2-mercaptopropionate, ethyl-3-hydroxybutyrate, ethyl-trans-3-hexenoate, geranyl acetate, geranyl butyrate, geranyl propionate, heptyl acetate, hexyl 3-methylbutanoate, hexyl acetate, hexyl butyrate, hexyl formate, hexyl hexanoate, hexyl isobutyrate, hexyl propionate, isoamyl acetate, isoamyl cinnamate, isoamyl hexanoate, isoamyl isobutyrate, isoamyl isovalerate, isoamyl octanoate, isoamyl phenylacetate, isobutyl acetate, isobutyl butyrate, isobutyl isobutyrate, isobutyl propionate, linalyl acetate, linalyl butyrate, linalyl formate, methionyl acetate (3-methylthio-propylacetate), methionyl butyrate, methyl acetate, methyl anthranilate, methyl benzoate, methyl cinnamate, methyl decanoate, methyl dihydrojasmonate, methyl hexanoate, methyl laurate, methyl octanoate, methyl salicylate, methyl vanillate, neryl acetate, octyl acetate, phenethyl 2-methylbutyrate, phenethyl acetate, phenethyl butyrate, phenethyl formate, phenethyl formate, phenethyl isobutyrate, phenethyl octanoate, phenethyl propionate, phenethyl tiglate, propyl acetate, propyl butyrate, propyl hexanoate, and mixtures thereof.

Embodiment 105 is the Moscato-like alcoholic beverage of embodiment 103 or embodiment 104, wherein the one or more esters are selected from the group consisting of 2-methylbutyl acetate, diethyl malate, diethyl succinate, ethyl 2-methylbutyrate, ethyl acetate, ethyl butyrate, ethyl decanoate, ethyl hexanoate, ethyl isobutyrate, ethyl isovalerate, ethyl lactate, ethyl laurate, ethyl myristate, ethyl octanoate, ethyl salicylate, ethyl valerate, hexyl acetate, isoamyl acetate, linalyl acetate, linalyl butyrate, methyl decanoate, methyl hexanoate, phenethyl acetate, phenethyl butyrate, phenethyl propionate, and mixtures thereof.

Embodiment 106 is the Moscato-like alcoholic beverage of any one of embodiment 103-105, wherein the one or more esters are selected from the group consisting of diethyl malate, diethyl succinate, ethyl 2-methylbutyrate, ethyl butyrate, ethyl decanoate, ethyl isobutyrate, ethyl lactate, ethyl laurate, ethyl myristate, ethyl octanoate, ethyl salicylate, hexyl acetate, isoamyl acetate, linalyl acetate, phenethyl acetate, phenethyl butyrate, phenethyl propionate, and mixtures thereof.

Embodiment 107 is the Moscato-like alcoholic beverage of any one of embodiments 103-106 wherein the one or more esters are present in a total amount of about 9 mg/L to about 70 mg/L.

Embodiment 108 is the Moscato-like alcoholic beverage of any one of embodiments 103-107, wherein the one or more esters are present in a total amount of at least about 26 mg/L.

Embodiment 109 is the Moscato-like alcoholic beverage of any one of embodiments 103-108, wherein about 15% to about 53% by mass of the one or more additional VOCs comprise the one or more esters.

Embodiment 110 is the Moscato-like alcoholic beverage of any one of embodiments 1-109, wherein the one or more additional VOCs comprise one or more acids.

Embodiment 111 is the Moscato-like alcoholic beverage of embodiment 110, wherein the one or more acids are selected from the group consisting of 3,7-dimethyl-6-octanoic acid, 3,7-dimethyl-6-octenoic acid, butyric acid, decanoic acid, hexanoic acid, isobutyric acid, isovaleric acid, octanoic acid, propanoic acid, and mixtures thereof.

Embodiment 112 is the Moscato-like alcoholic beverage of embodiment 110 or embodiment 111, wherein the one or more acids are selected from the group consisting of butyric acid, decanoic acid, hexanoic acid, isobutyric acid, octanoic acid, and mixtures thereof.

Embodiment 113 is the Moscato-like alcoholic beverage of any one of embodiments 110-112, wherein the one or more acids are selected from the group consisting of butyric acid, decanoic acid, hexanoic acid, isobutyric acid, and mixtures thereof.

Embodiment 114 is the Moscato-like alcoholic beverage of any one of embodiments 110-113, wherein the one or more acids are present in a total amount of about 0.07 mg/L to about 11 mg/L.

Embodiment 115 is the Moscato-like alcoholic beverage of any one of embodiments 110-114, wherein about 2% to about 8% by mass of the one or more additional VOCs comprise the one or more acids.

Embodiment 116 is the Moscato-like alcoholic beverage of embodiment any one of embodiments 1-115, wherein the one or more additional VOCs comprise one or more alcohols.

Embodiment 117 is the Moscato-like alcoholic beverage of embodiment 116, wherein the one or more alcohols are selected from the group consisting of 1-octanol, 1-octen-3-ol, 1-propanol, 2-(methylthio)ethanol, 2-heptanol, 2-methyl-1-butanol, 2-nonanol, 3-(methylthio)-1-propanol, 3-methyl-1-pentanol, amyl alcohol, anisyl alcohol, benzyl alcohol, butyl alcohol, cis-2-hexenol, cis-3-hexen-1-ol, cis-5-octen-1-ol, cis-6-nonen-1-ol, decanol, DL-3-methyl-2-butanol, hexadecanol, hexyl alcohol, isoamyl alcohol, isobutyl alcohol, phenethyl alcohol, trans-2-hexen-1-ol, and mixtures thereof.

Embodiment 118 is the Moscato-like alcoholic beverage of embodiment 116 or embodiment 117, wherein the one or more alcohols are selected from the group consisting of 1-propanol, 2-methyl-1-butanol, 2-nonanol, 3-methyl-1-pentanol, benzyl alcohol, butyl alcohol, hexyl alcohol, isoamyl alcohol, isobutyl alcohol, phenethyl alcohol, and mixtures thereof.

Embodiment 119 is the Moscato-like alcoholic beverage of any one of embodiments 116-118, wherein the one or more alcohols are selected from the group consisting of 2-methyl-1-butanol, 2-nonanol, 3-methyl-1-pentanol, butyl alcohol, hexyl alcohol, isoamyl alcohol, isobutyl alcohol, phenethyl alcohol, and mixtures thereof.

Embodiment 120 is the Moscato-like alcoholic beverage of any one of embodiments 116-119, wherein the one or more alcohols are present in a total amount of about 1.9 to about 86 mg/L.

Embodiment 121 is the Moscato-like alcoholic beverage of any one of embodiments 116-120, wherein the one or more alcohols are preset in a total amount of at least about 5.5 mg/L.

Embodiment 122 is the Moscato-like alcoholic beverage of any one of embodiments 116-121, wherein about 35% to about 95% by mass of the one or more additional VOCs comprise the one or more alcohols.

Embodiment 123 is the Moscato-like alcoholic beverage of any one of embodiments 1-122, wherein the one or more additional VOCs comprise one or more aldehydes or ketones.

Embodiment 124 is the Moscato-like alcoholic beverage of embodiment 123, wherein the one or more aldehydes or ketones are selected from the group consisting of 2,3-hexanedione, 2,3-pentadione, 2,6-dimethyl-5-heptenal, 2-acetyl-1-methylpyrrole, 2-heptanone, 2-methoxycinnamaldehyde, 2-methylbutyraldehyde, 2-nonanone, 2-octanone, 2-undecanone, 3-nonen-2-one, 3-phenylpropanal, 4-(4-Hydroxyphenyl)-2-butanone, 4-Hydroxy-2,5-dimethyl-3(2H)-furanone, 5-ethyl-3-hydroxy-4-methyl-2(5H)-furanone (maple furanone), 5-methyl furfural, 5-methyl-2-phenyl-2-hexenal, 6-methyl-5-hepten-2-one, acetaldehyde, acetoin, acetophenone, acetovanillone, benzaldehyde, butyraldehyde, cinnamaldehyde, cuminaldehyde, damascenone, decanal, diacetyl, furfural, hexanal, isobutyraldehyde, isovaleraldehyde, maltol, methional, methyl cyclopentenolone, methyl 3-naphthyl ketone, methyl-2-pyrrolyl ketone, nonanal, octanal, p-anisaldehyde, phenylacetaldehyde, phenylacetaldehyde dimethyl acetal, propanal, salicylaldehyde, sotolon, trans-2-heptenal, trans-2-hexen-1-al, trans-2-pentenal, valeraldehyde, and mixtures thereof.

Embodiment 125 is the Moscato-like alcoholic beverage of embodiment 123 or embodiment 124, wherein the one or more aldehydes or ketones are selected from the group consisting of 2-nonanone, 2-undecanone, acetovanillone, benzaldehyde, damascenone, isobutyraldehyde, and mixtures thereof.

Embodiment 126 is the Moscato-like alcoholic beverage of any one of embodiments 123-125, wherein the one or more aldehydes or ketones are selected from the group consisting of 2-nonanone, 2-undecanone, benzaldehyde, isobutyraldehyde, and mixtures thereof.

Embodiment 127 is the Moscato-like alcoholic beverage of any one of embodiments 123-126, wherein one or more aldehydes or ketones are present in a total amount of about 0.05 mg/L to about 0.6 mg/L.

Embodiment 128 is the Moscato-like alcoholic beverage of any one of embodiments 123-127, wherein about 0.04% to about 0.6% by mass of the one or more additional VOCs can comprise the one or more aldehydes or ketones.

Embodiment 129 is the Moscato-like alcoholic beverage of any one of embodiments 1-128, wherein the one or more additional VOCs comprise one or more terpenes or isoprenoids.

Embodiment 130 is the Moscato-like alcoholic beverage of embodiment 129, wherein the one or more terpenes or isoprenoids are selected from the group consisting of (1R)-(−)-myrtenal, 1,4-cineole, 3-carene, 4,5,6,7-tetrahydro-3,6-dimethylbenzofuran, 4-carvomenthenol, 4-ethyl guaiacol, 6,10-dimethyl-5,9-undecadien-2-one, a-ionone, a-phellandrene, a-pinene, a-terpineol, b-caryophellene, beta-ionone, beta-pinene, carvacrol, citral, citronellol, damascone, D-camphor, D-carvone, d-fenchone, eucalyptol, farnesol, gamma-terpinene, geraniol, isoborneol, L-carvone, linalool oxide, 1-limonene, 1-linalool, L-menthyl acetate, L-rose oxide, myrcene, myrtenol, nerol, nerolidol, p,a-dimethyl styrene, p-cymene, perillaldehyde, terpinolene, tetrahydrolinalool, thymol, valencene, and mixtures thereof.

Embodiment 131 is the Moscato-like alcoholic beverage of embodiment 129 or embodiment 130, wherein the one or more terpenes or isoprenoids are selected from the group consisting of 4-carvomenthenol, a-terpineol, beta-pinene, citronellol, eucalyptol, gamma-terpinene, geraniol, l-limonene, l-linalool, L-rose oxide, nerol, p-cymene, and mixtures thereof.

Embodiment 132 is the Moscato-like alcoholic beverage of any one of embodiments 129-131, wherein the one or more terpenes or isoprenoids are selected from the group consisting of 4-carvomenthenol, a-terpineol, beta-pinene, citronellol, eucalyptol, gamma-terpinene, geraniol, l-limonene, L-rose oxide, nerol, p-cymene, and mixtures thereof.

Embodiment 133 is the Moscato-like alcoholic beverage of any one of embodiments 129-132, wherein the one or more terpenes or isoprenoids are present in a total amount of about 0.08 mg/L to about 5 mg/L.

Embodiment 134 is the Moscato-like alcoholic beverage of any one of embodiments 129-133, wherein about 1% to about 3.5% by mass of the one or more additional VOCs comprise the one or more terpenes or isoprenoids.

Embodiment 135 is the Moscato-like alcoholic beverage of any one of embodiments 1-134, wherein the one or more additional VOCs comprise one or more phenols.

Embodiment 136 is the Moscato-like alcoholic beverage of embodiment 135, wherein the one or more phenols are selected from the group consisting of 2,4,6-trimethylphenol, 2-methoxy-4-methylphenol, 2-methoxy-4-propylphenol, 4-ethyl phenol, 4-vinylphenol, eugenol, guaiacol, isoeugenol, p-cresol, and mixtures thereof.

Embodiment 137 is the Moscato-like alcoholic beverage of embodiment 135 or embodiment 136, wherein the one or more phenols comprise 4-vinylphenol.

Embodiment 138 is the Moscato-like alcoholic beverage of any one of embodiments 135-137, wherein the one or more phenols are present in a total amount of about 0.001 mg/L to about 0.2 mg/L.

Embodiment 139 is the Moscato-like alcoholic beverage of any one of embodiments 135 to 138, wherein about 0.03% to about 0.15% by mass of the one or more additional VOCs comprise the one or more phenols.

Embodiment 140 is the Moscato-like alcoholic beverage of any one of embodiments 135 to 139, wherein at least about 0.034% by mass of the one or more additional VOCs comprise the one or more phenols.

Embodiment 141 is the Moscato-like alcoholic beverage of any one of embodiments 1 to 140, wherein the one or more additional VOCs comprise one or more lactones.

Embodiment 142 is the Moscato-like alcoholic beverage of embodiment 141, wherein the one or more lactones are selected from the group consisting of delta-decalactone, delta-dodecalactone, dihydrocoumarin, gamma-decalactone, gamma-dodecalactone, gamma-heptalactone, gamma-hexalactone, gamma-nonalactone, gamma-octalactone, gamma-undecalactone, Jasmine lactone, omega-pentadecalactone, whiskey lactone, and mixtures thereof.

Embodiment 143 is the Moscato-like alcoholic beverage of embodiment 141 or embodiment 142, wherein the one or more lactones comprise delta-decalactone, gamma-decalactone, or both.

Embodiment 144 is the Moscato-like alcoholic beverage of any one of embodiments 141-143, wherein the one or more lactones comprise delta-decalactone.

Embodiment 145 is the Moscato-like alcoholic beverage of any one of embodiments 141-144, wherein the one or more lactones are present in a total concentration of about 0.001 mg/L to about 2.5 mg/L.

Embodiment 146 is the Moscato-like alcoholic beverage of any one of embodiments 141-145, wherein about 0.004% to about 2% by mass of the one or more additional VOCs comprise the one or more lactones.

Embodiment 147 is the Moscato-like alcoholic beverage of any one of embodiments 141-146, wherein at least about 0.11% by mass of the one or more additional VOCs comprise the one or more lactones.

Embodiment 148 is the Moscato-like alcoholic beverage of any one of embodiments 1-147, wherein the one or more additional VOCs comprise one or more amines or pyrazines.

Embodiment 149 is the Moscato-like alcoholic beverage of embodiment 148, wherein the one or more amines or pyrazines are selected from the group consisting of 2,6-dimethylpyrazine, 2-acetylpyridine, 2-ethyl-3(5 or 6)-dimethylpyrazine, 2-ethyl-3-methylpyrazine, 2-isobutyl-3-methoxypyrazine, 2-isopropyl-3-methoxypyrazine, 2-methoxy-3-(1-methylpropyl) pyrazine, indole, and mixtures thereof.

Embodiment 150 is the Moscato-like alcoholic beverage of any one of embodiments 1-149, wherein the one or more additional VOCs comprise one or more thiols.

Embodiment 151 is the Moscato-like alcoholic beverage of embodiment 150, wherein the one or more thiols are selected from the group consisting of 1-para-menthene-8-thiol, 2-isopropyl-4-methyl thiazole, 3-mercaptohexyl acetate, 4-mercapto-4-methyl-2-pentanone, dimethyl sulfide, furfuryl mercaptan, furfuryl thioacetate, and mixtures thereof.

Embodiment 152 is the Moscato-like alcoholic beverage of embodiment 150 or embodiment 151, wherein the one or more thiols comprise 3-mercaptohexyl acetate.

Embodiment 153 is the Moscato-like alcoholic beverage of any one of embodiments 1-152, wherein the one or more additional VOCs comprise at least 10 compounds selected from the group consisting of 2-methyl-1-butanol, 3-methyl-1-pentanol, a-terpineol, beta-pinene, butyric acid, decanoic acid, delta-decalactone, diethyl succinate, ethyl butyrate, ethyl decanoate, ethyl hexanoate, ethyl isobutyrate, ethyl lactate, ethyl laurate, ethyl octanoate, gamma-terpinene, geraniol, hexyl acetate, hexyl alcohol, isoamyl acetate, isobutyl alcohol, isobutyric acid, linalyl acetate, 1-limonene, 1-linalool, phenethyl acetate, and phenethyl alcohol.

Embodiment 154 is the Moscato-like alcoholic beverage of any one of embodiments 1-153, wherein the one or more additional VOCs comprise at least 10 compounds selected from the group consisting of 1-propanol, 2-methylbutyl acetate, 2-nonanone, 2-undecanone, 3-mercaptohexyl acetate, 4-carvomenthenol, benzaldehyde, benzyl alcohol, butyl alcohol, citronellol, damascenone, diethyl malate, ethyl 2-methylbutyrate, ethyl acetate, ethyl isovalerate, ethyl myristate, ethyl salicylate, ethyl valerate, eucalyptol, gamma-decalactone, hexanoic acid, isoamyl alcohol, isobutyraldehyde, linalyl butyrate, L-rose oxide, methyl decanoate, methyl hexanoate, nerol, octanoic acid, p-cymene, phenethyl butyrate, and phenethyl propionate.

Embodiment 155 is the Moscato-like alcoholic beverage of any one of embodiments 1-154, wherein the one or more additional VOCs comprise a compound selected from the group consisting of 2-nonanol, 4-vinylphenol, and acetovanillone.

Embodiment 156 is the Moscato-like alcoholic beverage of any of embodiments 1-155, wherein the one or more additional VOCs comprise a compound selected from the group consisting of 1-octanol, 1-octen-3-ol, 2,3-pentadione, 2,4,6-trimethylphenol, 2-acetylpyridine, 2-heptanone, 2-isopropyl-3-methoxypyrazine, 2-Methoxy-4-methylphenol, 2-methoxy-4-propylphenol, 2-methylbutyraldehyde, 3-(methylthio)-1-propanol, 3,7-dimethyl-6-octanoic acid, 3-carene, 3-nonen-2-one, 4-ethyl guaiacol, 4-ethyl phenol, 5-ethyl-3-hydroxy-4-methyl-2(5H)-furanone, 5-methyl furfural, 6,10-dimethyl-5,9-undecadien-2-one, 6-methyl-5-hepten-2-one, acetaldehyde, acetophenone, a-ionone, amyl alcohol, amyl butyrate, a-phellandrene, b-caryophellene, beta-ionone, butyl acetate, butyl formate, butyl isovalerate, cinnamaldehyde, cis-3-hexen-1-ol, cis-3-hexenyl acetate, citral, damascone, D-camphor, decanol, dimethyl sulfide, DL-3-methyl-2-butanol, ethyl 3-hydroxyhexanoate, ethyl benzoate, ethyl cinnamate, ethyl levulinate, ethyl nonanoate, ethyl palmitate, ethyl phenylacetate, ethyl propionate, ethyl trans-2-butenoate, ethyl undecanoate, ethyl-3-hydroxybutyrate, eugenol, farnesol, furfural, furfuryl mercaptan, gamma-hexalactone, gamma-nonalactone, gamma-octalactone, gamma-undecalactone, guaiacol, heptyl acetate, Hexadecanol, hexyl hexanoate, isoamyl hexanoate, isoamyl isobutyrate, isoamyl isovalerate, isoamyl octanoate, isoborneol, isobutyl acetate, isovaleraldehyde, isovaleric acid, Jasmine lactone, linalool oxide, maltol, methional, methyl acetate, methyl anthranilate, methyl cyclopentenolone, methyl laurate, methyl octanoate, methyl salicylate, methyl vanillate, methyl β-naphthyl ketone, myrcene, myrtenol, nerolidol, nonanal, octyl acetate, p,a-dimethylstyrene, p-cresol, phenethyl octanoate, phenylacetaldehyde, propyl acetate, propyl butyrate, propyl hexanoate, salicylaldehyde, terpinolene, trans-2-heptenal, trans-2-Hexen-1-al, trans-2-hexen-1-ol, trans-2-pentenal, and whiskey lactone.

Embodiment 157 is the Moscato-like alcoholic beverage of any of embodiments 1-156, wherein the one or more additional VOCs comprise a compound selected from the group consisting of (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-octanone, 2-pentylfuran, 3,7-dimethyl-6-octenoic acid, 3-heptyl acetate, 3-methylthio hexyl acetate, 3-phenylpropanal, 4-(4-Hydroxyphenyl)-2-butanone, 4,5,6,7-tetrahydro-3,6-dimethylbenzofuran, 4-Hydroxy-2,5-dimethyl-3(2H)-furanone, 4-mercapto-4-methyl-2-pentanone, 5-methyl-2-phenyl-2-hexenal, acetal, acetaldehyde, diethyl acetal, acetoin, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-2-hexenol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexanal, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl formate, phenethyl isobutyrate, phenethyl tiglate, phenethylacetaldehyde dimethyl acetal, phenylacetaldehyde dimethyl acetal, propanal, propanoic acid, propyl isovalerate, sotolon, tetrahydrolinalool, thymol, valencene, valeraldehyde, vanillyl butyl ether, and vanillyl ethyl ether.

Embodiment 158 is the Moscato-like alcoholic beverage of any one of embodiments 1-156, wherein the additional VOCs have less than 90% identity to the VOCs in a single reference Moscato.

Embodiment 159 is the Moscato-like alcoholic beverage of any one of embodiments 1-156, wherein the additional VOCs have less than 80% identity to the VOCs in a single reference Moscato.

Embodiment 160 is the Moscato-like alcoholic beverage of any one of embodiments 1-156, wherein the additional VOCs have less than 70% identity to the VOCs in a single reference Moscato.

Embodiment 161 is the Moscato-like alcoholic beverage of any one of embodiments 1-156, wherein the additional VOCs have less than 60% identity to the VOCs in a single reference Moscato.

Embodiment 162 is the Moscato-like alcoholic beverage of any one of embodiments 1-156, wherein the additional VOCs have less than 50% identity to the VOCs in a single reference Moscato.

Embodiment 163 is the Moscato-like alcoholic beverage of any one of embodiments 1-156, wherein the additional VOCs have less than 40% identity to the VOCs in a single reference Moscato.

Embodiment 164 is the Moscato-like alcoholic beverage of any one of embodiments 1-156, wherein the Moscato-like alcoholic beverage comprises at least 30 additional VOCs and wherein no more than 29 of the additional VOCs are found in a single reference Moscato.

Embodiment 165 is the Moscato-like alcoholic beverage of any one of embodiments 1-156, wherein the Moscato-like alcoholic beverage comprises at least 35 additional VOCs and wherein no more than 34 of the additional VOCs are found in a single reference Moscato.

Embodiment 166 is the Moscato-like alcoholic beverage of any one of embodiments 1-156, wherein the Moscato-like alcoholic beverage comprises at least 40 additional VOCs and wherein no more than 39 of the additional VOCs are found in a single reference Moscato.

Embodiment 167 is the Moscato-like alcoholic beverage of any one of embodiments 1-166, further comprising one or more non-volatile compounds.

Embodiment 168 is the Moscato-like alcoholic beverage of embodiment 167 wherein the non-volatile compounds comprise one or more of 2,3-dimethylpyrazine, acetic acid, adipic acid, alanine, cysteine, cystine, disodium 5′ ribonucleotides (5′-guanylate & 5′-inosinate), epicatechin gallate, caramel food colouring, carotene food colouring, galactose, glutamine, glycerol, gum arabic, potassium hydroxide (KOH), mannose, methyl gallate, methyl 2-pyrrolyl ketone, monosodium glutamate, pectin, propyl gallate, pyridine, rutin, sorbic acid, a surfactant, syringaldehyde, syringic acid, tryptamine, tyramine, and vanillin.

Embodiment 169 is the Moscato-like alcoholic beverage of embodiment 167 or embodiment 168, wherein the non-volatile comprise one or more of 2,3-dimethylpyrazine, adipic acid, alanine, cysteine, cystine, epicatechin gallate, glutamine, mannose, methyl gallate, methyl 2-pyrrolyl ketone, propyl gallate, pyridine, rutin, sorbic acid, syringaldehyde, syringic acid, tryptamine, tyramine, and vanillin.

Embodiment 170 is the Moscato-like alcoholic beverage of any one of embodiments 167-169, wherein the non-volatile compounds comprise one or more of alanine, cysteine, glutamine, mannose, and vanillin.

Embodiment 171 is the Moscato-like alcoholic beverage of any one of embodiments 167-170, wherein the non-volatile compounds comprise one or more of alanine, glutamine, and vanillin.

Embodiment 172 is the Moscato-like alcoholic beverage of any one of embodiments 167-170, wherein the non-volatile compounds comprise one or more of cysteine, glutamine, mannose, and vanillin.

Embodiment 173 is the Moscato-like alcoholic beverage of any one of embodiments 167-171, wherein the non-volatile compounds comprise alanine.

Embodiment 174 is the Moscato-like alcoholic beverage of any one of embodiments 167-172, wherein the non-volatile compounds comprise glutamine, vanillin, or both.

Embodiment 175 is the Moscato-like alcoholic beverage of any one of embodiments 167-169, wherein the non-volatile compounds comprise one or more of 2,3-dimethylpyrazine, adipic acid, cystine, epicatechin gallate, methyl gallate, methyl 2-pyrrolyl ketone, propyl gallate, pyridine, rutin, sorbic acid, syringaldehyde, syringic acid, tryptamine, and tyramine.

Embodiment 176 is the Moscato-like alcoholic beverage of embodiment 167 or embodiment 168, wherein the non-volatile compounds comprise one or more of acetic acid, alanine, disodium 5′ ribonucleotides (5′-guanylate & 5′-inosinate), caramel food colouring, carotene food colouring, galactose, glycerol, gum arabic, KOH, monosodium glutamate, pectin, and a surfactant.

Embodiment 177 is the Moscato-like alcoholic beverage of any one of embodiments 167-176, wherein the non-volatile compounds do not comprise one or more of 2-isopropylmalic acid, 3,4-dihydroxybenzoic acid, 4-guanidinobutyric acid, adenine, caffeic acid, camphoric acid, carnitine, catechin, choline, coumaric acid, cytidine, cytosine, D-glucuronic acid, epicatechin, gallic acid, guanine, homoserine, methionine, pantothenic acid, polydatin, pyridoxine, pyruvic acid, quercetin, salicylic acid, serine, sorbitol, trans-4-hydroxyproline, trans-ferulic acid, and uracil.

Embodiment 178 is the Moscato-like alcoholic beverage of any one of embodiments 167-178, wherein the non-volatile compounds do not comprise one or more of 3,4-dihydroxybenzoic acid, 4-guanidinobutyric acid, adenine, caffeic acid, carnitine, catechin, coumaric acid, cytidine, cytosine, epicatechin, gallic acid, guanine, homoserine, methionine, pantothenic acid, polydatin, pyridoxine, pyruvic acid, serine, sorbitol, trans-4-hydroxyproline, and uracil.

Embodiment 179 is the Moscato-like alcoholic beverage of any one of embodiments 167-178, wherein the non-volatile compounds comprise leucine in an amount of at least about 22 mg/L.

Embodiment 180 is the Moscato-like alcoholic beverage of any one of embodiments 167-179, wherein the non-volatile compounds comprise methionine in an amount less than about 0.35 mg/L.

Embodiment 181 is the Moscato-like alcoholic beverage of any one of embodiments 167-180, wherein the non-volatile compounds comprise lysine in an amount of at least about 8.5 mg/L.

Embodiment 182 is the Moscato-like alcoholic beverage of any one of embodiments 167-181, wherein the non-volatile compounds comprise valine in an amount of at least about 7.1 mg/L.

Embodiment 183 is the Moscato-like alcoholic beverage of any one of embodiments 167-182, wherein the non-volatile compounds comprise glutamic acid in an amount of at least about 45 mg/L.

Embodiment 184 is the Moscato-like alcoholic beverage of any one of embodiments 167-183, wherein the non-volatile compounds comprise arginine in an amount of at least about 8.7 mg/L.

Embodiment 185 is the Moscato-like alcoholic beverage of any one of embodiments 167-184, wherein the non-volatile compounds comprise lactic acid in an amount of at least about 225 mg/L.

Embodiment 186 is the Moscato-like alcoholic beverage of any one of embodiments 167-185, wherein the non-volatile compounds comprise citric acid in an amount less than about 145 mg/L.

Embodiment 187 is the Moscato-like alcoholic beverage of any one of embodiments 167-186, wherein the non-volatile compounds comprise succinic acid in an amount less than about 175 mg/L.

Embodiment 188 is the Moscato-like alcoholic beverage of any one of embodiments 167-187, wherein the non-volatile compounds comprise succinic acid in an amount of at least about 1200 mg/L.

Embodiment 189 is the Moscato-like alcoholic beverage of any one of embodiments 167-188, wherein the non-volatile compounds comprise mannitol in an amount of at least about 360 mg/L.

Embodiment 190 is the Moscato-like alcoholic beverage of any one of embodiments 167-189, wherein the non-volatile compounds comprise 2-isopropylmalic acid in an amount less than about 0.1 mg/L.

Embodiment 191 is the Moscato-like alcoholic beverage of any one of embodiments 167-190, wherein the non-volatile compounds comprise arabitol in an amount less than about 1.1 mg/L.

Embodiment 192 is the Moscato-like alcoholic beverage of any one of embodiments 167-191, wherein the non-volatile compounds comprise beta-alanine in an amount of at least about 4.1 mg/L.

Embodiment 193 is the Moscato-like alcoholic beverage of any one of embodiments 167-192, wherein the non-volatile compounds comprise D-glucuronic acid in an amount of less than about 400 mg/L.

Embodiment 194 is the Moscato-like alcoholic beverage of any one of embodiments 167-193, wherein the non-volatile compounds comprise isoleucine in an amount of at least about 10.6 mg/L.

Embodiment 195 is the Moscato-like alcoholic beverage of any one of embodiments 167-194, wherein the non-volatile compounds comprise inositol in an amount of at least about 680 mg/L.

Embodiment 196 is the Moscato-like alcoholic beverage of any one of embodiments 167-195, wherein the non-volatile compounds comprise pyruvic acid in an amount of less than about 13 mg/L.

Embodiment 197 is the Moscato-like alcoholic beverage of any one of embodiments 167-196, wherein the non-volatile compounds comprise rhamnose in an amount of at least about 40 mg/L.

Embodiment 198 is the Moscato-like alcoholic beverage of any one of embodiments 167-197, wherein the non-volatile compounds comprise serine in an amount of less than about 0.36 mg/L.

Embodiment 199 is the Moscato-like alcoholic beverage of any one of embodiments 167-198, wherein the non-volatile compounds comprise tyrosine in an amount of at least about 105 mg/L.

Embodiment 200 is the Moscato-like alcoholic beverage of any one of embodiments 167-199, wherein the non-volatile compounds comprise at least 10 compounds selected from the group consisting of 2-isopropylmalic acid, arginine, asparagine, beta-alanine, camphoric acid, choline, citric acid, D-glucuronic acid, fructose, fucose, fumaric acid, GABA, glucose, glutamic acid, glutamine, glycine, histidine, isoleucine, lactic acid, leucine, lysine, malic acid, mannitol, inositol, phenylalanine, proline, quercetin, salicylic acid, sorbitol, succinic acid, tartaric acid, threonine, trans-ferulic acid, tryptophan, tyrosine, and valine.

Embodiment 201 is the Moscato-like alcoholic beverage of any one of embodiments 167-199, wherein the non-volatile compounds comprise at least 15 compounds selected from the group consisting of 2-isopropylmalic acid, arginine, asparagine, beta-alanine, camphoric acid, choline, citric acid, D-glucuronic acid, fructose, fucose, fumaric acid, GABA, glucose, glutamic acid, glutamine, glycine, histidine, isoleucine, lactic acid, leucine, lysine, malic acid, mannitol, inositol, phenylalanine, proline, quercetin, salicylic acid, sorbitol, succinic acid, tartaric acid, threonine, trans-ferulic acid, tryptophan, tyrosine, and valine.

Embodiment 202 is the Moscato-like alcoholic beverage of any one of embodiments 167-199, wherein the non-volatile compounds comprise at least 20 compounds selected from the group consisting of 2-isopropylmalic acid, arginine, asparagine, beta-alanine, camphoric acid, choline, citric acid, D-glucuronic acid, fructose, fucose, fumaric acid, GABA, glucose, glutamic acid, glutamine, glycine, histidine, isoleucine, lactic acid, leucine, lysine, malic acid, mannitol, inositol, phenylalanine, proline, quercetin, salicylic acid, sorbitol, succinic acid, tartaric acid, threonine, trans-ferulic acid, tryptophan, tyrosine, and valine.

Embodiment 203 is the Moscato-like alcoholic beverage of any one of embodiments 167-202, wherein the non-volatile compounds comprise at least 5 compounds selected from the group consisting of 2,3,5,6-tetramethylpyrazine, 2,3,5-trimethylpyrazine, 2-furoic acid, 3,4-dihydroxybenzoic acid, a pH-modifying salt, acetic acid, alanine, arabitol, aspartic acid, carnitine, cinnamic acid, cysteine, disodium 5′ ribonucleotides, ellagic acid, food colouring Caramel, food colouring Carotene, glucosamine, glycerol, guanine, hesperetin, mannose, methionine, monosodium glutamate, pantothenic acid, piperine, pyruvic acid, rhamnose, serine, sinapinic acid, trans-4-hydroxyproline, vanillic acid, vanillin, and xylose.

Embodiment 204 is the Moscato-like alcoholic beverage of any one of embodiments 167-202, wherein the non-volatile compounds comprise at least 10 compounds selected from the group consisting of 2,3,5,6-tetramethylpyrazine, 2,3,5-trimethylpyrazine, 2-furoic acid, 3,4-dihydroxybenzoic acid, a pH-modifying salt, acetic acid, alanine, arabitol, aspartic acid, carnitine, cinnamic acid, cysteine, disodium 5′ ribonucleotides, ellagic acid, food colouring Caramel, food colouring Carotene, glucosamine, glycerol, guanine, hesperetin, mannose, methionine, monosodium glutamate, pantothenic acid, piperine, pyruvic acid, rhamnose, serine, sinapinic acid, trans-4-hydroxyproline, vanillic acid, vanillin, and xylose.

Embodiment 205 is the Moscato-like alcoholic beverage of any one of embodiments 167-204, wherein the non-volatile compounds comprise one or more compounds selected from the group consisting of 4-guanidinobutyric acid, acetovanillone, adenine, betaine, caffeic acid, carnosine, catechin, citrulline, coumaric acid, cytidine, cytosine, epicatechin, gallic acid, homoserine, kynurenic acid, ornithine, pipecolinic acid, polydatin, pyridoxine, quinic acid, resveratrol, ribose, and uracil.

Embodiment 206 is the Moscato-like alcoholic beverage of any one of embodiments 167-205, wherein the non-volatile compounds comprise one or more compounds selected from the group consisting of a surfactant, gum arabic, and pectin.

Embodiment 207 is the Moscato-like alcoholic beverage of any one of embodiments 167-206, wherein the non-volatile compounds have less than 80% identity to the non-volatile compounds in a single reference Moscato.

Embodiment 208 is the Moscato-like alcoholic beverage of any one of embodiments 167-206, wherein the non-volatile compounds have less than 70% identity to the non-volatile compounds in a single reference Moscato.

Embodiment 209 is the Moscato-like alcoholic beverage of any one of embodiments 167-206, wherein the non-volatile compounds have less than 60% identity to the non-volatile compounds in a single reference Moscato.

Embodiment 210 is the Moscato-like alcoholic beverage of any one of embodiments 167-206, wherein the non-volatile compounds have less than 50% identity to the non-volatile compounds in a single reference Moscato.

Embodiment 211 is the Moscato-like alcoholic beverage of any one of embodiments 167-206, wherein the non-volatile compounds have less than 40% identity to the non-volatile compounds in a single reference Moscato.

Embodiment 212 is the Moscato-like alcoholic beverage of any one of embodiments 167-211, wherein the Moscato-like alcoholic beverage comprises at least 17 non-volatile compounds and wherein no more than 16 of the non-volatile compounds are present in a single reference Moscato.

Embodiment 213 is the Moscato-like alcoholic beverage of any one of embodiments 167-211, wherein the Moscato-like alcoholic beverage comprises at least 21 non-volatile compounds and wherein no more than 20 of the non-volatile compounds are present in a single reference Moscato.

Embodiment 214 is the Moscato-like alcoholic beverage of any one of embodiments 167-211, wherein the Moscato-like alcoholic beverage comprises at least 25 non-volatile compounds and wherein no more than 24 of the non-volatile compounds are present in a single reference Moscato.

Embodiment 215 is the Moscato-like beverage of any one of embodiments 1-214, wherein the one or more additional VOCs are present in a total amount of less than 120 mg/L.

Embodiment 216 is the Moscato-like alcoholic beverage of any one of embodiments 1-214, wherein the one or more additional VOCs are present in a total amount of less than 100 mg/L.

Embodiment 217 is the Moscato-like alcoholic beverage of any one of embodiments 1-216, wherein the Moscato-like alcoholic beverage does not comprise one or more of Escherichia coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, mold, mildew, rot, insects, insect eggs, insect filth, rodent filth, mammalian excreta, insect lecithins, hydrogen sulfide, hydrogen disulfide, 2,4,6-trichloranisole, 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, and dichloromethane.

Embodiment 218 is a Moscato-like alcoholic beverage comprising ethanol, water, and one or more non-volatile compounds, wherein the one or more non-volatile compounds comprise one or more of 2,3-dimethylpyrazine, acetic acid, adipic acid, alanine, cysteine, cystine, disodium 5′ ribonucleotides (5′-guanylate & 5′-inosinate), epicatechin gallate, caramel food colouring, carotene food colouring, galactose, glutamine, glycerol, gum arabic, potassium hydroxide (KOH), mannose, methyl gallate, methyl 2-pyrrolyl ketone, monosodium glutamate, pectin, propyl gallate, pyridine, rutin, sorbic acid, a surfactant, syringaldehyde, syringic acid, tryptamine, tyramine, and vanillin.

Embodiment 219 is the Moscato-like alcoholic beverage of embodiment 218, wherein the non-volatile comprise one or more of 2,3-dimethylpyrazine, adipic acid, alanine, cysteine, cystine, epicatechin gallate, glutamine, mannose, methyl gallate, methyl 2-pyrrolyl ketone, propyl gallate, pyridine, rutin, sorbic acid, syringaldehyde, syringic acid, tryptamine, tyramine, and vanillin.

Embodiment 220 is the Moscato-like alcoholic beverage of embodiment 218 or embodiment 219, wherein the non-volatile compounds comprise one or more of alanine, cysteine, glutamine, mannose, and vanillin.

Embodiment 221 is the Moscato-like alcoholic beverage of any one of embodiments 218-220, wherein the non-volatile compounds comprise one or more of alanine, glutamine, and vanillin.

Embodiment 222 is the Moscato-like alcoholic beverage of any one of embodiments 218-220, wherein the non-volatile compounds comprise one or more of cysteine, glutamine, mannose, and vanillin.

Embodiment 223 is the Moscato-like alcoholic beverage of any one of embodiments 218-221, wherein the non-volatile compounds comprise alanine.

Embodiment 224 is the Moscato-like alcoholic beverage of any one of embodiments 218-222, wherein the non-volatile compounds comprise glutamine, vanillin, or both.

Embodiment 225 is the Moscato-like alcoholic beverage of any one of embodiments 218 or embodiment 219, wherein the non-volatile compounds comprise one or more of 2,3-dimethylpyrazine, adipic acid, cystine, epicatechin gallate, methyl gallate, methyl 2-pyrrolyl ketone, propyl gallate, pyridine, rutin, sorbic acid, syringaldehyde, syringic acid, tryptamine, and tyramine.

Embodiment 226 is the Moscato-like alcoholic beverage of embodiment 218, wherein the non-volatile compounds comprise one or more of acetic acid, alanine, disodium 5′ ribonucleotides (5′-guanylate & 5′-inosinate), caramel food colouring, carotene food colouring, galactose, glycerol, gum arabic, KOH, monosodium glutamate, pectin, and a surfactant.

Embodiment 227 is the Moscato-like alcoholic beverage of any one of embodiments 218-226, wherein the non-volatile compounds do not comprise one or more of 2-isopropylmalic acid, 3,4-dihydroxybenzoic acid, 4-guanidinobutyric acid, adenine, caffeic acid, camphoric acid, carnitine, catechin, choline, coumaric acid, cytidine, cytosine, D-glucuronic acid, epicatechin, gallic acid, guanine, homoserine, methionine, pantothenic acid, polydatin, pyridoxine, pyruvic acid, quercetin, salicylic acid, serine, sorbitol, trans-4-hydroxyproline, trans-ferulic acid, and uracil.

Embodiment 228 is the Moscato-like alcoholic beverage of any one of embodiments 218-227, wherein the non-volatile compounds do not comprise one or more of 3,4-dihydroxybenzoic acid, 4-guanidinobutyric acid, adenine, caffeic acid, carnitine, catechin, coumaric acid, cytidine, cytosine, epicatechin, gallic acid, guanine, homoserine, methionine, pantothenic acid, polydatin, pyridoxine, pyruvic acid, serine, sorbitol, trans-4-hydroxyproline, and uracil.

Embodiment 229 is a Moscato-like alcoholic beverage comprising ethanol, water, and one or more non-volatile compounds, wherein the one or more non-volatile compounds do not comprise one or more of 2-isopropylmalic acid, 3,4-dihydroxybenzoic acid, 4-guanidinobutyric acid, adenine, caffeic acid, camphoric acid, carnitine, catechin, choline, coumaric acid, cytidine, cytosine, D-glucuronic acid, epicatechin, gallic acid, guanine, homoserine, methionine, pantothenic acid, polydatin, pyridoxine, pyruvic acid, quercetin, salicylic acid, serine, sorbitol, trans-4-hydroxyproline, trans-ferulic acid, and uracil.

Embodiment 230 is the Moscato-like alcoholic beverage of embodiment 229, wherein the non-volatile compounds do not comprise one or more of 3,4-dihydroxybenzoic acid, 4-guanidinobutyric acid, adenine, caffeic acid, carnitine, catechin, coumaric acid, cytidine, cytosine, epicatechin, gallic acid, guanine, homoserine, methionine, pantothenic acid, polydatin, pyridoxine, pyruvic acid, serine, sorbitol, trans-4-hydroxyproline, and uracil.

Embodiment 231 is the Moscato-like alcoholic beverage of embodiment 229 or embodiment 230, wherein the one or more non-volatile compounds comprise one or more of 2,3-dimethylpyrazine, acetic acid, adipic acid, alanine, cysteine, cystine, disodium 5′ ribonucleotides (5′-guanylate & 5′-inosinate), epicatechin gallate, caramel food colouring, carotene food colouring, galactose, glutamine, glycerol, gum arabic, potassium hydroxide (KOH), mannose, methyl gallate, methyl 2-pyrrolyl ketone, monosodium glutamate, pectin, propyl gallate, pyridine, rutin, sorbic acid, a surfactant, syringaldehyde, syringic acid, tryptamine, tyramine, and vanillin.

Embodiment 232 is the Moscato-like alcoholic beverage any one of embodiments 229-231, wherein the non-volatile comprise one or more of 2,3-dimethylpyrazine, adipic acid, alanine, cysteine, cystine, epicatechin gallate, glutamine, mannose, methyl gallate, methyl 2-pyrrolyl ketone, propyl gallate, pyridine, rutin, sorbic acid, syringaldehyde, syringic acid, tryptamine, tyramine, and vanillin.

Embodiment 233 is the Moscato-like alcoholic beverage of any one of embodiments 229-232, wherein the non-volatile compounds comprise one or more of alanine, cysteine, glutamine, mannose, and vanillin.

Embodiment 234 is the Moscato-like alcoholic beverage of any one of embodiments 229-233, wherein the non-volatile compounds comprise one or more of alanine, glutamine, and vanillin.

Embodiment 235 is the Moscato-like alcoholic beverage of any one of embodiments 229-233, wherein the non-volatile compounds comprise one or more of cysteine, glutamine, mannose, and vanillin.

Embodiment 236 is the Moscato-like alcoholic beverage of any one of embodiments 229-234, wherein the non-volatile compounds comprise alanine.

Embodiment 237 is the Moscato-like alcoholic beverage of any one of embodiments 229-236, wherein the non-volatile compounds comprise glutamine, vanillin, or both.

Embodiment 238 is the Moscato-like alcoholic beverage of any one of embodiments 229-232, wherein the non-volatile compounds comprise one or more of 2,3-dimethylpyrazine, adipic acid, cystine, epicatechin gallate, methyl gallate, methyl 2-pyrrolyl ketone, propyl gallate, pyridine, rutin, sorbic acid, syringaldehyde, syringic acid, tryptamine, and tyramine.

Embodiment 239 is the Moscato-like alcoholic beverage of any one of embodiments 229-232, wherein the non-volatile compounds comprise one or more of acetic acid, alanine, disodium 5′ ribonucleotides (5′-guanylate & 5′-inosinate), caramel food colouring, carotene food colouring, galactose, glycerol, gum arabic, KOH, monosodium glutamate, pectin, and a surfactant.

Embodiment 240 is the Moscato-like alcoholic beverage of any one of embodiments 229-239, wherein the non-volatile compounds comprise leucine in an amount of at least about 22 mg/L.

Embodiment 241 is the Moscato-like alcoholic beverage of any one of embodiments 229-240, wherein the non-volatile compounds comprise methionine in an amount less than about 0.35 mg/L.

Embodiment 242 is the Moscato-like alcoholic beverage of any one of embodiments 229-241, wherein the non-volatile compounds comprise lysine in an amount of at least about 8.5 mg/L.

Embodiment 243 is the Moscato-like alcoholic beverage of any one of embodiments 229-242, wherein the non-volatile compounds comprise valine in an amount of at least about 7.1 mg/L.

Embodiment 244 is the Moscato-like alcoholic beverage of any one of embodiments 229-243, wherein the non-volatile compounds comprise glutamic acid in an amount of at least about 45 mg/L.

Embodiment 245 is the Moscato-like alcoholic beverage of any one of embodiments 229-244, wherein the non-volatile compounds comprise arginine in an amount of at least about 8.7 mg/L.

Embodiment 246 is the Moscato-like alcoholic beverage of any one of embodiments 229-245, wherein the non-volatile compounds comprise lactic acid in an amount of at least about 225 mg/L.

Embodiment 247 is the Moscato-like alcoholic beverage of any one of embodiments 229-245, wherein the non-volatile compounds comprise citric acid in an amount less than about 145 mg/L.

Embodiment 248 is the Moscato-like alcoholic beverage of any one of embodiments 229-247, wherein the non-volatile compounds comprise succinic acid in an amount less than about 175 mg/L.

Embodiment 249 is the Moscato-like alcoholic beverage of any one of embodiments 229-248, wherein the non-volatile compounds comprise succinic acid in an amount of at least about 1200 mg/L.

Embodiment 250 is the Moscato-like alcoholic beverage of any one of embodiments 229-249, wherein the non-volatile compounds comprise mannitol in an amount of at least about 360 mg/L.

Embodiment 251 is the Moscato-like alcoholic beverage of any one of embodiments 229-250, wherein the non-volatile compounds comprise 2-isopropylmalic acid in an amount less than about 0.1 mg/L.

Embodiment 252 is the Moscato-like alcoholic beverage of any one of embodiments 229-251, wherein the non-volatile compounds comprise arabitol in an amount less than about 1.1 mg/L.

Embodiment 253 is the Moscato-like alcoholic beverage of any one of embodiments 229-252, wherein the non-volatile compounds comprise beta-alanine in an amount of at least about 4.1 mg/L.

Embodiment 254 is the Moscato-like alcoholic beverage of any one of embodiments 229-253, wherein the non-volatile compounds comprise D-glucuronic acid in an amount of less than about 400 mg/L.

Embodiment 255 is the Moscato-like alcoholic beverage of any one of embodiments 229-254, wherein the non-volatile compounds comprise isoleucine in an amount of at least about 10.6 mg/L.

Embodiment 256 is the Moscato-like alcoholic beverage of any one of embodiments 229-255, wherein the non-volatile compounds comprise inositol in an amount of at least about 680 mg/L.

Embodiment 257 is the Moscato-like alcoholic beverage of any one of embodiments 229-256, wherein the non-volatile compounds comprise pyruvic acid in an amount of less than about 13 mg/L.

Embodiment 258 is the Moscato-like alcoholic beverage of any one of embodiments 229-257, wherein the non-volatile compounds comprise rhamnose in an amount of at least about 40 mg/L.

Embodiment 259 is the Moscato-like alcoholic beverage of any one of embodiments 229-258, wherein the non-volatile compounds comprise serine in an amount of less than about 0.36 mg/L.

Embodiment 260 is the Moscato-like alcoholic beverage of any one of embodiments 229-259, wherein the non-volatile compounds comprise tyrosine in an amount of at least about 105 mg/L.

Embodiment 261 is the Moscato-like alcoholic beverage of any one of embodiments 229-260, wherein the non-volatile compounds comprise at least 10 compounds selected from the group consisting of 2-isopropylmalic acid, arginine, asparagine, beta-alanine, camphoric acid, choline, citric acid, D-glucuronic acid, fructose, fucose, fumaric acid, GABA, glucose, glutamic acid, glutamine, glycine, histidine, isoleucine, lactic acid, leucine, lysine, malic acid, mannitol, inositol, phenylalanine, proline, quercetin, salicylic acid, sorbitol, succinic acid, tartaric acid, threonine, trans-ferulic acid, tryptophan, tyrosine, and valine.

Embodiment 262 is the Moscato-like alcoholic beverage of any one of embodiments 229-261, wherein the non-volatile compounds comprise at least 15 compounds selected from the group consisting of 2-isopropylmalic acid, arginine, asparagine, beta-alanine, camphoric acid, choline, citric acid, D-glucuronic acid, fructose, fucose, fumaric acid, GABA, glucose, glutamic acid, glutamine, glycine, histidine, isoleucine, lactic acid, leucine, lysine, malic acid, mannitol, inositol, phenylalanine, proline, quercetin, salicylic acid, sorbitol, succinic acid, tartaric acid, threonine, trans-ferulic acid, tryptophan, tyrosine, and valine.

Embodiment 263 is the Moscato-like alcoholic beverage of any one of embodiments 229-262, wherein the non-volatile compounds comprise at least 20 compounds selected from the group consisting of 2-isopropylmalic acid, arginine, asparagine, beta-alanine, camphoric acid, choline, citric acid, D-glucuronic acid, fructose, fucose, fumaric acid, GABA, glucose, glutamic acid, glutamine, glycine, histidine, isoleucine, lactic acid, leucine, lysine, malic acid, mannitol, inositol, phenylalanine, proline, quercetin, salicylic acid, sorbitol, succinic acid, tartaric acid, threonine, trans-ferulic acid, tryptophan, tyrosine, and valine.

Embodiment 264 is the Moscato-like alcoholic beverage of any one of embodiments 229-263, wherein the non-volatile compounds comprise at least 5 compounds selected from the group consisting of 2,3,5,6-tetramethylpyrazine, 2,3,5-trimethylpyrazine, 2-furoic acid, 3,4-dihydroxybenzoic acid, a pH-modifying salt, acetic acid, alanine, arabitol, aspartic acid, carnitine, cinnamic acid, cysteine, disodium 5′ ribonucleotides, ellagic acid, food colouring Caramel, food colouring Carotene, glucosamine, glycerol, guanine, hesperetin, mannose, methionine, monosodium glutamate, pantothenic acid, piperine, pyruvic acid, rhamnose, serine, sinapinic acid, trans-4-hydroxyproline, vanillic acid, vanillin, and xylose.

Embodiment 265 is the Moscato-like alcoholic beverage of any one of embodiments 229-264, wherein the non-volatile compounds comprise at least 10 compounds selected from the group consisting of 2,3,5,6-tetramethylpyrazine, 2,3,5-trimethylpyrazine, 2-furoic acid, 3,4-dihydroxybenzoic acid, a pH-modifying salt, acetic acid, alanine, arabitol, aspartic acid, carnitine, cinnamic acid, cysteine, disodium 5′ ribonucleotides, ellagic acid, food colouring Caramel, food colouring Carotene, glucosamine, glycerol, guanine, hesperetin, mannose, methionine, monosodium glutamate, pantothenic acid, piperine, pyruvic acid, rhamnose, serine, sinapinic acid, trans-4-hydroxyproline, vanillic acid, vanillin, and xylose.

Embodiment 266 is the Moscato-like alcoholic beverage of any one of embodiments 229-265, wherein the non-volatile compounds comprise one or more compounds selected from the group consisting of 4-guanidinobutyric acid, acetovanillone, adenine, betaine, caffeic acid, carnosine, catechin, citrulline, coumaric acid, cytidine, cytosine, epicatechin, gallic acid, homoserine, kynurenic acid, ornithine, pipecolinic acid, polydatin, pyridoxine, quinic acid, resveratrol, ribose, and uracil.

Embodiment 267 is the Moscato-like alcoholic beverage of any one of embodiments 229-266, wherein the non-volatile compounds comprise one or more compounds selected from the group consisting of a surfactant, gum arabic, and pectin.

Embodiment 268 is the Moscato-like alcoholic beverage of any one of embodiments 229-266, wherein the non-volatile compounds have less than 80% identity to the non-volatile compounds in a single reference Moscato.

Embodiment 269 is the Moscato-like alcoholic beverage of any one of embodiments 229-266, wherein the non-volatile compounds have less than 70% identity to the non-volatile compounds in a single reference Moscato.

Embodiment 270 is the Moscato-like alcoholic beverage of any one of embodiments 229-266, wherein the non-volatile compounds have less than 60% identity to the non-volatile compounds in a single reference Moscato.

Embodiment 271 is the Moscato-like alcoholic beverage of any one of embodiments 229-266, wherein the non-volatile compounds have less than 50% identity to the non-volatile compounds in a single reference Moscato.

Embodiment 272 is the Moscato-like alcoholic beverage of any one of embodiments 229-266, wherein the non-volatile compounds have less than 40% identity to the non-volatile compounds in a single reference Moscato.

Embodiment 273 is the Moscato-like alcoholic beverage of any one of embodiments 229-272, wherein the Moscato-like alcoholic beverage comprises at least 17 non-volatile compounds and wherein no more than 16 of the non-volatile compounds are present in a single reference Moscato.

Embodiment 274 is the Moscato-like alcoholic beverage of any one of embodiments 229-272, wherein the Moscato-like alcoholic beverage comprises at least 21 non-volatile compounds and wherein no more than 20 of the non-volatile compounds are present in a single reference Moscato.

Embodiment 275 is the Moscato-like alcoholic beverage of any one of embodiments 229-272, wherein the Moscato-like alcoholic beverage comprises at least 25 non-volatile compounds and wherein no more than 24 of the non-volatile compounds are present in a single reference Moscato.

Embodiment 276 is the Moscato-like alcoholic beverage of any one of embodiments 229-275, further comprising one or more additional VOCs.

Embodiment 277 is the Moscato-like alcoholic beverage of embodiment 276, wherein the additional VOCs comprise at least one compound selected from the group consisting of (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-nonanol, 2-octanone, 2-pentylfuran, 3,7-dimethyl-6-octenoic acid, 3-heptyl acetate, 3-methylthio hexyl acetate, 3-phenylpropanal, 4-(4-hydroxyphenyl)-2-butanone, 4,5,6,7-tetrahydro-3,6-dimethylbenzofuran, 4-hydroxy-2,5-dimethyl-3(2H)-furanone, 4-mercapto-4-methyl-2-pentanone, 4-vinylphenol, 5-methyl-2-phenyl-2-hexenal, acetal (1,1-diethoxyethane), acetaldehyde, diethyl acetal, acetoin, acetovanillone, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-2-hexenol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, damascone, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexanal, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl isobutyrate, phenethyl tiglate, phenethylacetaldehyde dimethyl acetal, phenylacetaldehyde dimethyl acetal, propanal, propanoic acid, propionaldehyde, propyl isovalerate, sotolon, tetrahydrolinalool, thymol, valencene, valeraldehyde, valeric acid, vanillyl butyl ether, and vanillyl ethyl ether.

Embodiment 278 is the Moscato-like alcoholic beverage of embodiment 276 or embodiment 277, wherein the one or more additional VOCs comprise at least one compound selected from the group consisting of (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-nonanol, 2-octanone, 2-pentylfuran, 3-heptyl acetate, 3-methylthio hexyl acetate, 3-phenylpropanal, 4-(4-hydroxyphenyl)-2-butanone, 4,5,6,7-tetrahydro-3,6-dimethylbenzofuran, 4-hydroxy-2,5-dimethyl-3(2H)-furanone, 4-mercapto-4-methyl-2-pentanone, 4-vinylphenol, 5-methyl-2-phenyl-2-hexenal, acetal (1,1-diethoxyethane), acetoin, acetovanillone, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, damascone, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexanal, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl tiglate, phenethylacetaldehyde dimethyl acetal, phenylacetaldehyde dimethyl acetal, propanal, propanoic acid, propionaldehyde, propyl isovalerate, sotolon, tetrahydrolinalool, thymol, valencene, valeraldehyde, valeric acid, vanillyl butyl ether, and vanillyl ethyl ether.

Embodiment 279 is the Moscato-like alcoholic beverage of any one of embodiments 276-278, wherein the one or more additional VOCs comprise at least one compound selected from the group consisting of 2-nonanol, 4-(4-hydroxyphenyl)-2-butanone, 4-hydroxy-2,5-dimethyl-3(2H)-furanone, 4-vinylphenol, butyraldehyde, citronellyl acetate, damascone, decanal, gamma-dodecalactone, hexanal, Propionaldehyde, sotolon, and valeric acid.

Embodiment 280 is the Moscato-like alcoholic beverage of any one of embodiments 276-279, wherein the one or more additional VOCs comprise 2-nonanol, 4-vinylphenol, or both.

Embodiment 281 is the Moscato-like alcoholic beverage of any one of embodiments 276-280, wherein the one or more additional VOCs comprise 2-nonanol.

Embodiment 282 is the Moscato-like alcoholic beverage of any one of embodiments 276-280, wherein the one or more additional VOCs comprise 4-vinylphenol.

Embodiment 283 is the Moscato-like alcoholic beverage of any one of embodiments 276-278, wherein the one or more additional VOCs comprise at least one compound selected from the group consisting of (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-octanone, 2-pentylfuran, 3-heptyl acetate, 3-methylthio hexyl acetate, 3-phenylpropanal, 4,5,6,7-tetrahydro-3,6-dimethylbenzofuran, 4-mercapto-4-methyl-2-pentanone, 5-methyl-2-phenyl-2-hexenal, acetal (1,1-diethoxyethane), acetoin, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl tiglate, phenethylacetaldehyde dimethyl acetal, phenylacetaldehyde dimethyl acetal, propanal, propanoic acid, propyl isovalerate, tetrahydrolinalool, thymol, valencene, valeraldehyde, vanillyl butyl ether, and vanillyl ethyl ether.

Embodiment 284 is the Moscato-like alcoholic beverage of embodiment 276 or embodiment 277, wherein the one or more additional VOCs comprise at least one compound selected from the group consisting of 3,7-dimethyl-6-octenoic acid, 4-(4-hydroxyphenyl)-2-butanone, 4-hydroxy-2,5-dimethyl-3(2H)-furanone, acetaldehyde, diethyl acetal, cis-2-hexenol, hexanal, phenethyl formate, phenethyl isobutyrate, and sotolon.

Embodiment 285 is the Moscato-like alcoholic beverage of any one of embodiments 276-278, wherein the one or more additional VOCs comprise at least one compound selected from the group consisting of 2-nonanol, 4-(4-hydroxyphenyl)-2-butanone, 4-hydroxy-2,5-dimethyl-3(2H)-furanone, 4-vinylphenol, butyraldehyde, citronellyl acetate, damascone, decanal, gamma-dodecalactone, hexanal, propionaldehyde, sotolon, and valeric acid.

Embodiment 286 is the Moscato-like alcoholic beverage of any one of embodiments 276-285, wherein the one or more additional VOCs do not comprise one or more of 1-octanol, 1-octen-3-ol, 1-propanol, 2,4,6-trimethylphenol, 2-acetylpyridine, 2-isopropyl-3-methoxypyrazine, 2-methylbutyl acetate, 2-methylbutyraldehyde, 3-(methylthio)-1-propanol, 3,7-dimethyl-6-octanoic acid, 3-nonen-2-one, 5-ethyl-3-hydroxy-4-methyl-2(5H)-furanone, 5-methyl furfural, 6-methyl-5-hepten-2-one, acetaldehyde, a-phellandrene, b-caryophellene, butyl formate, butyl isovalerate, cinnamaldehyde, citral, damascone, D-camphor, decanol, dimethyl sulfide, ethyl acetate, ethyl palmitate, ethyl phenylacetate, ethyl propionate, ethyl trans-2-butenoate, ethyl-3-hydroxybutyrate, furfural, hexadecanol, hexyl hexanoate, isoborneol, isobutyl acetate, isovaleraldehyde, isovaleric acid, jasmine lactone, linalool oxide, methyl acetate, methyl cyclopentenolone, methyl decanoate, myrtenol, octyl acetate, p,a-dimethylstyrene, phenylacetaldehyde, propyl butyrate, propyl hexanoate, terpinolene, trans-2-hexen-1-ol, and trans-2-pentenal.

Embodiment 287 is the Moscato-like alcoholic beverage of any one of embodiments 276-286, wherein the additional VOCs do not comprise one or more of 1-octanol, 1-octen-3-ol, 2,4,6-trimethylphenol, 2-acetylpyridine, 2-isopropyl-3-methoxypyrazine, 2-methylbutyraldehyde, 3-(methylthio)-1-propanol, 3,7-dimethyl-6-octanoic acid, 3-nonen-2-one, 5-ethyl-3-hydroxy-4-methyl-2(5H)-furanone, 5-methyl furfural, 6-methyl-5-hepten-2-one, acetaldehyde, a-phellandrene, b-caryophellene, butyl formate, butyl isovalerate, cinnamaldehyde, citral, damascone, D-camphor, decanol, dimethyl sulfide, ethyl palmitate, ethyl phenylacetate, ethyl propionate, ethyl trans-2-butenoate, ethyl-3-hydroxybutyrate, furfural, hexadecanol, hexyl hexanoate, isoborneol, isobutyl acetate, isovaleraldehyde, isovaleric acid, jasmine lactone, linalool oxide, methyl acetate, methyl cyclopentenolone, myrtenol, octyl acetate, p,a-dimethylstyrene, phenylacetaldehyde, propyl butyrate, propyl hexanoate, terpinolene, trans-2-hexen-1-ol, trans-2-pentenal.

Embodiment 288 is the Moscato-like alcoholic beverage of any one of embodiments 276-287, wherein the additional VOCs do not comprise one or more of 1-octanol, 1-octen-3-ol, 2,4,6-trimethylphenol, 2-methylbutyraldehyde, 5-ethyl-3-hydroxy-4-methyl-2(5H)-furanone, 6-methyl-5-hepten-2-one, b-caryophellene, butyl formate, cinnamaldehyde, citral, D-camphor, decanol, ethyl phenylacetate, ethyl propionate, ethyl trans-2-butenoate, hexadecanol, isobutyl acetate, isovaleraldehyde, methyl acetate, p,a-dimethylstyrene, phenylacetaldehyde, and terpinolene.

Embodiment 289 is the Moscato-like alcoholic beverage of any one of embodiments 276-286, wherein the additional VOCs do not comprise one or more of 1-octanol, 1-octen-3-ol, 1-propanol, 2,4,6-trimethylphenol, 2-methylbutyl acetate, 2-methylbutyraldehyde, 5-ethyl-3-hydroxy-4-methyl-2(5H)-furanone, 6-methyl-5-hepten-2-one, b-caryophellene, butyl formate, cinnamaldehyde, citral, D-camphor, decanol, ethyl acetate, ethyl phenylacetate, ethyl propionate, ethyl trans-2-butenoate, hexadecanol, isobutyl acetate, isovaleraldehyde, methyl acetate, methyl decanoate, p,a-dimethylstyrene, phenylacetaldehyde, and terpinolene.

Embodiment 290 is the Moscato-like alcoholic beverage of any one of embodiments 276-289, wherein the one or more additional VOCs comprise one or more of butyl formate, ethyl octanoate, ethyl propionate, ethyl-2-methylbutyrate, isoamyl acetate, isoamyl alcohol, and isobutanol.

Embodiment 291 is the Moscato-like alcoholic beverage of any one of embodiments 276-289, wherein the one or more additional VOCs comprise two or more of butyl formate, ethyl octanoate, ethyl propionate, ethyl-2-methylbutyrate, isoamyl acetate, isoamyl alcohol, and isobutanol.

Embodiment 292 is the Moscato-like alcoholic beverage of any one of embodiments 276-289, wherein the one or more additional VOCs comprise three or more of butyl formate, ethyl octanoate, ethyl propionate, ethyl-2-methylbutyrate, isoamyl acetate, isoamyl alcohol, and isobutanol.

Embodiment 293 is the Moscato-like alcoholic beverage of any one of embodiments 276-289, wherein the one or more additional VOCs comprise four or more of butyl formate, ethyl octanoate, ethyl propionate, ethyl-2-methylbutyrate, isoamyl acetate, isoamyl alcohol, and isobutanol.

Embodiment 294 is the Moscato-like alcoholic beverage of any one of embodiments 276-289, wherein the one or more additional VOCs comprise five or more of butyl formate, ethyl octanoate, ethyl propionate, ethyl-2-methylbutyrate, isoamyl acetate, isoamyl alcohol, and isobutanol.

Embodiment 295 is the Moscato-like alcoholic beverage of any one of embodiments 276-289, wherein the one or more additional VOCs comprise six or more of butyl formate, ethyl octanoate, ethyl propionate, ethyl-2-methylbutyrate, isoamyl acetate, isoamyl alcohol, and isobutanol.

Embodiment 296 is the Moscato-like alcoholic beverage of any one of embodiments 276-289, wherein the one or more additional VOCs comprise butyl formate, ethyl octanoate, ethyl propionate, ethyl-2-methylbutyrate, isoamyl acetate, isoamyl alcohol, and isobutanol.

Embodiment 297 is the Moscato-like alcoholic beverage of any one of embodiments 276-289, wherein the one or more additional VOCs comprise no more than 6 of butyl formate, ethyl octanoate, ethyl propionate, ethyl-2-methylbutyrate, isoamyl acetate, isoamyl alcohol, and isobutanol.

Embodiment 298 is the Moscato-like alcoholic beverage of any one of embodiments 276-289, wherein the one or more additional VOCs comprise no more than 5 of butyl formate, ethyl octanoate, ethyl propionate, ethyl-2-methylbutyrate, isoamyl acetate, isoamyl alcohol, and isobutanol.

Embodiment 299 is the Moscato-like alcoholic beverage of any one of embodiments 276-289, wherein the one or more additional VOCs comprise no more than 4 of butyl formate, ethyl octanoate, ethyl propionate, ethyl-2-methylbutyrate, isoamyl acetate, isoamyl alcohol, and isobutanol.

Embodiment 300 is the Moscato-like alcoholic beverage of any one of embodiments 276-299, wherein the one or more additional VOCs comprise 2-nonanone in an amount of at least about 0.0014 mg/L.

Embodiment 301 is the Moscato-like alcoholic beverage of any one of embodiments 276-300, wherein the one or more additional VOCs comprise 2-phenylethanol in an amount less than about 13.5 mg/L.

Embodiment 302 is the Moscato-like alcoholic beverage of any one of embodiments 276-301, wherein the one or more additional VOCs comprise 2-phenyethylacetate in an amount of at least about 0.15 mg/L.

Embodiment 303 is the Moscato-like alcoholic beverage of any one of embodiments 276-302, wherein the one or more additional VOCs comprise 2-undecanone in an amount of at least about 0.0014 mg/L.

Embodiment 304 is the Moscato-like alcoholic beverage of any one of embodiments 276-303, wherein the one or more additional VOCs comprise 4-carvomenthenol in an amount of at least about 0.02 mg/L.

Embodiment 305 is the Moscato-like alcoholic beverage of any one of embodiments 276-304, wherein the one or more additional VOCs comprise benzaldehyde in an amount of at least about 0.022 mg/L.

Embodiment 306 is the Moscato-like alcoholic beverage of any one of embodiments 276-305, wherein the one or more additional VOCs comprise beta-pinene in an amount of at least about 0.014 mg/L.

Embodiment 307 is the Moscato-like alcoholic beverage of any one of embodiments 276-306, wherein the one or more additional VOCs comprise citronellol in an amount of at least about 0.01 mg/L.

Embodiment 308 is the Moscato-like alcoholic beverage of any one of embodiments 276-307, wherein the one or more additional VOCs comprise decanoic acid in an amount of at least about 0.6 mg/L.

Embodiment 309 is the Moscato-like alcoholic beverage of any one of embodiments 276-308, wherein the one or more additional VOCs comprise delta-decalactone in an amount of at least about 0.007 mg/L.

Embodiment 310 is the Moscato-like alcoholic beverage of any one of embodiments 276-309, wherein the one or more additional VOCs comprise diethyl malate in an amount of less than about 0.35 mg/L.

Embodiment 311 is the Moscato-like alcoholic beverage of any one of embodiments 276-310, wherein the one or more additional VOCs comprise diethyl succinate in an amount less than about 0.4 mg/L.

Embodiment 312 is the Moscato-like alcoholic beverage of any one of embodiments 276-311, wherein the one or more additional VOCs comprise ethyl acetate in an amount less than about 7 mg/L.

Embodiment 313 is the Moscato-like alcoholic beverage of any one of embodiments 276-312, wherein the one or more additional VOCs comprise ethyl butyrate in an amount of at least about 0.5 mg/L.

Embodiment 314 is the Moscato-like alcoholic beverage of any one of embodiments 276-313, wherein the one or more additional VOCs comprise ethyl isobutyrate in an amount of at least about 0.3 mg/L.

Embodiment 315 is the Moscato-like alcoholic beverage of any one of embodiments 276-314, wherein the one or more additional VOCs comprise ethyl isovalerate in an amount of at least about 0.07 mg/L.

Embodiment 316 is the Moscato-like alcoholic beverage of any one of embodiments 276-315, wherein the one or more additional VOCs comprise ethyl lactate in an amount less than about 2 mg/L.

Embodiment 317 is the Moscato-like alcoholic beverage of any one of embodiments 276-316, wherein the one or more additional VOCs comprise ethyl myristate in an amount of at least about 0.45 mg/L.

Embodiment 318 is the Moscato-like alcoholic beverage of any one of embodiments 276-317, wherein the one or more additional VOCs comprise ethyl valerate in an amount of at least about 0.0012 mg/L.

Embodiment 319 is the Moscato-like alcoholic beverage of any one of embodiments 276-318, wherein the one or more additional VOCs comprise eucalyptol in an amount of at least about 0.0009 mg/L.

Embodiment 320 is the Moscato-like alcoholic beverage of any one of embodiments 276-319, wherein the one or more additional VOCs comprise gamma-decalactone in an amount of at least about 0.012 mg/L.

Embodiment 321 is the Moscato-like alcoholic beverage of any one of embodiments 276-320, wherein the one or more additional VOCs comprise gamma-terpinene in an amount of at least about 0.04 mg/L.

Embodiment 322 is the Moscato-like alcoholic beverage of any one of embodiments 276-321, wherein the one or more additional VOCs comprise hexanoic acid in an amount of at least about 0.35 mg/L

Embodiment 323 is the Moscato-like alcoholic beverage of any one of embodiments 276-322, wherein the one or more additional VOCs comprise hexyl acetate in an amount of at least about 0.04 mg/L.

Embodiment 324 is the Moscato-like alcoholic beverage of any one of embodiments 276-323, wherein the one or more additional VOCs comprise isoamyl acetate in an amount of at least about 1.7 mg/L.

Embodiment 325 is the Moscato-like alcoholic beverage of any one of embodiments 276-324, wherein the one or more additional VOCs comprise isobutyraldehyde in an amount of at least about 0.0035 mg/L.

Embodiment 326 is the Moscato-like alcoholic beverage of any one of embodiments 276-325, wherein the one or more additional VOCs comprise isobutyric acid in an amount less than about 1.6 mg/L.

Embodiment 327 is the Moscato-like alcoholic beverage of any one of embodiments 276-326, wherein the one or more additional VOCs comprise limonene in an amount of at least about 0.012 mg/L.

Embodiment 328 is the Moscato-like alcoholic beverage of any one of embodiments 276-27, wherein the one or more additional VOCs comprise linalool in an amount of at least about 0.5 mg/L.

Embodiment 329 is the Moscato-like alcoholic beverage of any one of embodiments 276-328, wherein the one or more additional VOCs comprise linalyl acetate in an amount of at least about 0.22 mg/L.

Embodiment 330 is the Moscato-like alcoholic beverage of any one of embodiments 276-329, wherein the one or more additional VOCs comprise linalyl butyrate in an amount of at least about 0.0002 mg/L.

Embodiment 331 is the Moscato-like alcoholic beverage of any one of embodiments 276-330, wherein the one or more additional VOCs comprise L-rose oxide in an amount of at least about 0.0011 mg/L.

Embodiment 332 is the Moscato-like alcoholic beverage of any one of embodiments 276-331, wherein the one or more additional VOCs comprise nerol in an amount of at least about 0.006 mg/L.

Embodiment 333 is the Moscato-like alcoholic beverage of any one of embodiments 276-332, wherein the one or more additional VOCs comprise p-cymene in an amount of at least about 0.0006 mg/L.

Embodiment 334 is the Moscato-like alcoholic beverage of any one of embodiments 276-333, wherein the one or more additional VOCs comprise phenethyl butyrate in an amount of at least about 0.0017 mg/L.

Embodiment 335 is the Moscato-like alcoholic beverage of any one of embodiments 276-334, wherein the one or more additional VOCs comprise phenethyl propionate in an amount of at least about 0.0002 mg/L.

Embodiment 336 is the Moscato-like alcoholic beverage of any one of embodiments 276-335, wherein the one or more additional VOCs comprise propanol in an amount less than about 1.35 mg/L.

Embodiment 337 is the Moscato-like alcoholic beverage of any one of embodiments 276-336, wherein at least about 0.016% by mass of the one or more additional VOCs comprises (−)-beta-pinene.

Embodiment 338 is the Moscato-like alcoholic beverage of any one of embodiments 276-337, wherein at least about 0.0013% by mass of the one or more additional VOCs comprises L-rose oxide.

Embodiment 339 is the Moscato-like alcoholic beverage of any one of embodiments 276-338, wherein at least about 0.0017% by mass of the one or more additional VOCs comprises 2-nonanone.

Embodiment 340 is the Moscato-like alcoholic beverage of any one of embodiments 276-339, wherein at least about 0.18% by mass of the one or more additional VOCs comprises 2-phenethylacetate.

Embodiment 341 is the Moscato-like alcoholic beverage of any one of embodiments 276-340, wherein at least about 0.0017% by mass of the one or more additional VOCs comprises 2-undecanone.

Embodiment 342 is the Moscato-like alcoholic beverage of any one of embodiments 276-341, wherein at least about 0.025% by mass of the one or more additional VOCs comprises 4-carvomenthenol.

Embodiment 343 is the Moscato-like alcoholic beverage of any one of embodiments 276-342, wherein at least about 0.026% by mass of the one or more additional VOCs comprises benzaldehyde.

Embodiment 344 is the Moscato-like alcoholic beverage of any one of embodiments 276-343, wherein at least about 0.012% by mass of the one or more additional VOCs comprises citronellol.

Embodiment 345 is the Moscato-like alcoholic beverage of any one of embodiments 276-344, wherein at least about 0.7% by mass of the one or more additional VOCs comprises decanoic acid.

Embodiment 346 is the Moscato-like alcoholic beverage of any one of embodiments 276-345, wherein at least about 0.6% by mass of the one or more additional VOCs comprises ethyl butyrate.

Embodiment 347 is the Moscato-like alcoholic beverage of any one of embodiments 276-346, wherein at least about 0.36% by mass of the one or more additional VOCs comprises ethyl isobutyrate.

Embodiment 348 is the Moscato-like alcoholic beverage of any one of embodiments 276-347, wherein at least about 0.09% by mass of the one or more additional VOCs comprises ethyl isovalerate.

Embodiment 349 is the Moscato-like alcoholic beverage of any one of embodiments 276-348, wherein at least about 0.0015% by mass of the one or more additional VOCs comprises ethyl valerate.

Embodiment 350 is the Moscato-like alcoholic beverage of any one of embodiments 276-349, wherein at least about 0.0012% by mass of the one or more additional VOCs comprises eucalyptol.

Embodiment 351 is the Moscato-like alcoholic beverage of any one of embodiments 276-350, wherein at least about 0.014% by mass of the one or more additional VOCs comprises gamma-decalactone.

Embodiment 352 is the Moscato-like alcoholic beverage of any one of embodiments 276-351, wherein at least about 0.05% by mass of the one or more additional VOCs comprises gamma terpinene.

Embodiment 353 is the Moscato-like alcoholic beverage of any one of embodiments 276-352, wherein at least about 0.4% by mass of the one or more additional VOCs comprises hexanoic acid.

Embodiment 354 is the Moscato-like alcoholic beverage of any one of embodiments 276-353, wherein at least about 0.05% by mass of the one or more additional VOCs comprises hexyl acetate.

Embodiment 355 is the Moscato-like alcoholic beverage of any one of embodiments 276-354, wherein at least about 2% by mass of the one or more additional VOCs comprises isoamyl acetate.

Embodiment 356 is the Moscato-like alcoholic beverage of any one of embodiments 276-355, wherein at least about 0.0045% by mass of the one or more additional VOCs comprise isobutyraldehyde.

Embodiment 357 is the Moscato-like alcoholic beverage of any one of embodiments 276-356, wherein at least about 0.014% by mass of the one or more additional VOCs comprises limonene.

Embodiment 358 is the Moscato-like alcoholic beverage of any one of embodiments 276-357, wherein at least about 0.6% by mass of the one or more additional VOCs comprises linalool.

Embodiment 359 is the Moscato-like alcoholic beverage of any one of embodiments 276-358, wherein at least about 0.25% by mass of the one or more additional VOCs comprises linalyl acetate.

Embodiment 360 is the Moscato-like alcoholic beverage of any one of embodiments 276-359, wherein at least about 0.00025% by mass of the one or more additional VOCs comprises linalyl butyrate.

Embodiment 361 is the Moscato-like alcoholic beverage of any one of embodiments 276-360, wherein at least about 0.007% by mass of the one or more additional VOCs comprises nerol.

Embodiment 362 is the Moscato-like alcoholic beverage of any one of embodiments 276-361, wherein at least about 0.0007% by mass of the one or more additional VOCs comprise p-cymene.

Embodiment 363 is the Moscato-like alcoholic beverage of any one of embodiments 276-362, wherein at least about 0.002% by mass of the one or more additional VOCs comprises phenethyl butyrate.

Embodiment 364 is the Moscato-like alcoholic beverage of any one of embodiments 276-363, wherein at least about 0.00025% by mass of the one or more additional VOCs comprises phenethyl propionate.

Embodiment 365 is the Moscato-like alcoholic beverage of any one of embodiments 276-364, wherein the one or more additional VOCs comprise an ester, an acid, an alcohol, an aldehyde, a ketone, or an aldehyde and a ketone, a terpene, an isoprenoid, or a terpene and an isoprenoid, and a lactone.

Embodiment 366 is the Moscato-like alcoholic beverage of any one of embodiments 276-365, wherein the one or more additional VOCs comprise one or more esters.

Embodiment 367 is the Moscato-like alcoholic beverage of embodiment 366, wherein the one or more esters are selected from the group consisting of 2-methylbutyl acetate, 2-methylbutyl isovalerate, 3-heptyl acetate, 3-methylthio hexyl acetate, allyl heptanoate, allyl hexanoate, amyl butyrate, amyl formate, anisyl acetate, anisyl butyrate, benzyl acetate, benzyl benzoate, benzyl butyrate, benzyl formate, benzyl propionate, butyl acetate, butyl butyryllactate, butyl formate, butyl isovalerate, cis-3-hexenyl acetate, cis-3-hexenyl butyrate, cis-3-hexenyl caproate, cis-3-hexenyl valerate, citronellyl acetate, diethyl malate, diethyl succinate, dimethyl anthranilate, dimethyl succinate, ethyl (methylthio) acetate, ethyl 2-methylbutyrate, ethyl 2-trans-4-cis-decadienoate, ethyl 3-hydroxyhexanoate, ethyl acetate, ethyl anthranilate, ethyl benzoate, ethyl butyrate, ethyl cinnamate, ethyl decanoate, ethyl heptanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenylacetate, ethyl propionate, ethyl salicylate, ethyl trans-2-butenoate, ethyl undecanoate, ethyl valerate, ethyl-2-mercaptopropionate, ethyl-3-hydroxybutyrate, ethyl-trans-3-hexenoate, geranyl acetate, geranyl butyrate, geranyl propionate, heptyl acetate, hexyl 3-methylbutanoate, hexyl acetate, hexyl butyrate, hexyl formate, hexyl hexanoate, hexyl isobutyrate, hexyl propionate, isoamyl acetate, isoamyl cinnamate, isoamyl hexanoate, isoamyl isobutyrate, isoamyl isovalerate, isoamyl octanoate, isoamyl phenylacetate, isobutyl acetate, isobutyl butyrate, isobutyl isobutyrate, isobutyl propionate, linalyl acetate, linalyl butyrate, linalyl formate, methionyl acetate (3-methylthio-propylacetate), methionyl butyrate, methyl acetate, methyl anthranilate, methyl benzoate, methyl cinnamate, methyl decanoate, methyl dihydrojasmonate, methyl hexanoate, methyl laurate, methyl octanoate, methyl salicylate, methyl vanillate, neryl acetate, octyl acetate, phenethyl 2-methylbutyrate, phenethyl acetate, phenethyl butyrate, phenethyl formate, phenethyl formate, phenethyl isobutyrate, phenethyl octanoate, phenethyl propionate, phenethyl tiglate, propyl acetate, propyl butyrate, propyl hexanoate, and mixtures thereof.

Embodiment 368 is the Moscato-like alcoholic beverage of embodiment 365 or embodiment 366, wherein the one or more esters are selected from the group consisting of 2-methylbutyl acetate, diethyl malate, diethyl succinate, ethyl 2-methylbutyrate, ethyl acetate, ethyl butyrate, ethyl decanoate, ethyl hexanoate, ethyl isobutyrate, ethyl isovalerate, ethyl lactate, ethyl laurate, ethyl myristate, ethyl octanoate, ethyl salicylate, ethyl valerate, hexyl acetate, isoamyl acetate, linalyl acetate, linalyl butyrate, methyl decanoate, methyl hexanoate, phenethyl acetate, phenethyl butyrate, phenethyl propionate, and mixtures thereof.

Embodiment 369 is the Moscato-like alcoholic beverage of any one of embodiment 365-368, wherein the one or more esters are selected from the group consisting of diethyl malate, diethyl succinate, ethyl 2-methylbutyrate, ethyl butyrate, ethyl decanoate, ethyl isobutyrate, ethyl lactate, ethyl laurate, ethyl myristate, ethyl octanoate, ethyl salicylate, hexyl acetate, isoamyl acetate, linalyl acetate, phenethyl acetate, phenethyl butyrate, phenethyl propionate, and mixtures thereof.

Embodiment 370 is the Moscato-like alcoholic beverage of any one of embodiments 365-369 wherein the one or more esters are present in a total amount of about 9 mg/L to about 70 mg/L.

Embodiment 371 is the Moscato-like alcoholic beverage of any one of embodiments 365-370, wherein the one or more esters are present in a total amount of at least about 26 mg/L.

Embodiment 372 is the Moscato-like alcoholic beverage of any one of embodiments 365-371, wherein about 15% to about 53% by mass of the one or more additional VOCs comprise the one or more esters.

Embodiment 373 is the Moscato-like alcoholic beverage of any one of embodiments 365-372, wherein the one or more additional VOCs comprise one or more acids.

Embodiment 374 is the Moscato-like alcoholic beverage of embodiment 373, wherein the one or more acids are selected from the group consisting of 3,7-dimethyl-6-octanoic acid, 3,7-dimethyl-6-octenoic acid, butyric acid, decanoic acid, hexanoic acid, isobutyric acid, isovaleric acid, octanoic acid, propanoic acid, and mixtures thereof.

Embodiment 375 is the Moscato-like alcoholic beverage of embodiment 373 or embodiment 374, wherein the one or more acids are selected from the group consisting of butyric acid, decanoic acid, hexanoic acid, isobutyric acid, octanoic acid, and mixtures thereof.

Embodiment 376 is the Moscato-like alcoholic beverage of any one of embodiments 373-375, wherein the one or more acids are selected from the group consisting of butyric acid, decanoic acid, hexanoic acid, isobutyric acid, and mixtures thereof.

Embodiment 377 is the Moscato-like alcoholic beverage of any one of embodiments 373-376, wherein the one or more acids are present in a total amount of about 0.07 mg/L to about 11 mg/L.

Embodiment 378 is the Moscato-like alcoholic beverage of any one of embodiments 373-377, wherein about 2% to about 8% by mass of the one or more additional VOCs comprise the one or more acids.

Embodiment 379 is the Moscato-like alcoholic beverage of embodiment any one of embodiments 276-378, wherein the one or more additional VOCs comprise one or more alcohols.

Embodiment 380 is the Moscato-like alcoholic beverage of embodiment 379, wherein the one or more alcohols are selected from the group consisting of 1-octanol, 1-octen-3-ol, 1-propanol, 2-(methylthio)ethanol, 2-heptanol, 2-methyl-1-butanol, 2-nonanol, 3-(methylthio)-1-propanol, 3-methyl-1-pentanol, amyl alcohol, anisyl alcohol, benzyl alcohol, butyl alcohol, cis-2-hexenol, cis-3-hexen-1-ol, cis-5-octen-1-ol, cis-6-nonen-1-ol, decanol, DL-3-methyl-2-butanol, hexadecanol, hexyl alcohol, isoamyl alcohol, isobutyl alcohol, phenethyl alcohol, trans-2-hexen-1-ol, and mixtures thereof.

Embodiment 381 is the Moscato-like alcoholic beverage of embodiment 379 or embodiment 380, wherein the one or more alcohols are selected from the group consisting of 1-propanol, 2-methyl-1-butanol, 2-nonanol, 3-methyl-1-pentanol, benzyl alcohol, butyl alcohol, hexyl alcohol, isoamyl alcohol, isobutyl alcohol, phenethyl alcohol, and mixtures thereof.

Embodiment 382 is the Moscato-like alcoholic beverage of any one of embodiments 379-381, wherein the one or more alcohols are selected from the group consisting of 2-methyl-1-butanol, 2-nonanol, 3-methyl-1-pentanol, butyl alcohol, hexyl alcohol, isoamyl alcohol, isobutyl alcohol, phenethyl alcohol, and mixtures thereof.

Embodiment 383 is the Moscato-like alcoholic beverage of any one of embodiments 379-382, wherein the one or more alcohols are present in a total amount of about 1.9 to about 86 mg/L.

Embodiment 384 is the Moscato-like alcoholic beverage of any one of embodiments 379-383, wherein the one or more alcohols are preset in a total amount of at least about 5.5 mg/L.

Embodiment 385 is the Moscato-like alcoholic beverage of any one of embodiments 379-384, wherein about 35% to about 95% by mass of the one or more additional VOCs comprise the one or more alcohols.

Embodiment 386 is the Moscato-like alcoholic beverage of any one of embodiments 379-385, wherein the one or more additional VOCs comprise one or more aldehydes or ketones.

Embodiment 387 is the Moscato-like alcoholic beverage of embodiment 386, wherein the one or more aldehydes or ketones are selected from the group consisting of 2,3-hexanedione, 2,3-pentadione, 2,6-dimethyl-5-heptenal, 2-acetyl-1-methylpyrrole, 2-heptanone, 2-methoxycinnamaldehyde, 2-methylbutyraldehyde, 2-nonanone, 2-octanone, 2-undecanone, 3-nonen-2-one, 3-phenylpropanal, 4-(4-Hydroxyphenyl)-2-butanone, 4-Hydroxy-2,5-dimethyl-3(2H)-furanone, 5-ethyl-3-hydroxy-4-methyl-2(5H)-furanone (maple furanone), 5-methyl furfural, 5-methyl-2-phenyl-2-hexenal, 6-methyl-5-hepten-2-one, acetaldehyde, acetoin, acetophenone, acetovanillone, benzaldehyde, butyraldehyde, cinnamaldehyde, cuminaldehyde, damascenone, decanal, diacetyl, furfural, hexanal, isobutyraldehyde, isovaleraldehyde, maltol, methional, methyl cyclopentenolone, methyl 3-naphthyl ketone, methyl-2-pyrrolyl ketone, nonanal, octanal, p-anisaldehyde, phenylacetaldehyde, phenylacetaldehyde dimethyl acetal, propanal, salicylaldehyde, sotolon, trans-2-heptenal, trans-2-hexen-1-al, trans-2-pentenal, valeraldehyde, and mixtures thereof.

Embodiment 388 is the Moscato-like alcoholic beverage of embodiment 386 or embodiment 387, wherein the one or more aldehydes or ketones are selected from the group consisting of 2-nonanone, 2-undecanone, acetovanillone, benzaldehyde, damascenone, isobutyraldehyde, and mixtures thereof.

Embodiment 389 is the Moscato-like alcoholic beverage of any one of embodiments 386-388, wherein the one or more aldehydes or ketones are selected from the group consisting of 2-nonanone, 2-undecanone, benzaldehyde, isobutyraldehyde, and mixtures thereof.

Embodiment 390 is the Moscato-like alcoholic beverage of any one of embodiments 386-389, wherein one or more aldehydes or ketones are present in a total amount of about 0.05 mg/L to about 0.6 mg/L.

Embodiment 391 is the Moscato-like alcoholic beverage of any one of embodiments 386-390, wherein about 0.04% to about 0.6% by mass of the one or more additional VOCs can comprise the one or more aldehydes or ketones.

Embodiment 392 is the Moscato-like alcoholic beverage of any one of embodiments 276-391, wherein the one or more additional VOCs comprise one or more terpenes or isoprenoids.

Embodiment 393 is the Moscato-like alcoholic beverage of embodiment 392, wherein the one or more terpenes or isoprenoids are selected from the group consisting of (1R)-(−)-myrtenal, 1,4-cineole, 3-carene, 4,5,6,7-tetrahydro-3,6-dimethylbenzofuran, 4-carvomenthenol, 4-ethyl guaiacol, 6,10-dimethyl-5,9-undecadien-2-one, a-ionone, a-phellandrene, a-pinene, a-terpineol, b-caryophellene, beta-ionone, beta-pinene, carvacrol, citral, citronellol, damascone, D-camphor, D-carvone, d-fenchone, eucalyptol, farnesol, gamma-terpinene, geraniol, isoborneol, L-carvone, linalool oxide, 1-limonene, 1-linalool, L-menthyl acetate, L-rose oxide, myrcene, myrtenol, nerol, nerolidol, p,a-dimethyl styrene, p-cymene, perillaldehyde, terpinolene, tetrahydrolinalool, thymol, valencene, and mixtures thereof.

Embodiment 394 is the Moscato-like alcoholic beverage of embodiment 392 or embodiment 393, wherein the one or more terpenes or isoprenoids are selected from the group consisting of 4-carvomenthenol, a-terpineol, beta-pinene, citronellol, eucalyptol, gamma-terpinene, geraniol, l-limonene, l-linalool, L-rose oxide, nerol, p-cymene, and mixtures thereof.

Embodiment 395 is the Moscato-like alcoholic beverage of any one of embodiments 392-394, wherein the one or more terpenes or isoprenoids are selected from the group consisting of 4-carvomenthenol, a-terpineol, beta-pinene, citronellol, eucalyptol, gamma-terpinene, geraniol, l-limonene, L-rose oxide, nerol, p-cymene, and mixtures thereof.

Embodiment 396 is the Moscato-like alcoholic beverage of any one of embodiments 392-395, wherein the one or more terpenes or isoprenoids are present in a total amount of about 0.08 mg/L to about 5 mg/L.

Embodiment 397 is the Moscato-like alcoholic beverage of any one of embodiments 392-396, wherein about 1% to about 3.5% by mass of the one or more additional VOCs comprise the one or more terpenes or isoprenoids.

Embodiment 398 is the Moscato-like alcoholic beverage of any one of embodiments 392-397, wherein the one or more additional VOCs comprise one or more phenols.

Embodiment 399 is the Moscato-like alcoholic beverage of embodiment 398, wherein the one or more phenols are selected from the group consisting of 2,4,6-trimethylphenol, 2-methoxy-4-methylphenol, 2-methoxy-4-propylphenol, 4-ethyl phenol, 4-vinylphenol, eugenol, guaiacol, isoeugenol, p-cresol, and mixtures thereof.

Embodiment 400 is the Moscato-like alcoholic beverage of embodiment 398 or embodiment 399, wherein the one or more phenols comprise 4-vinylphenol.

Embodiment 401 is the Moscato-like alcoholic beverage of any one of embodiments 398-400, wherein the one or more phenols are present in a total amount of about 0.001 mg/L to about 0.2 mg/L.

Embodiment 402 is the Moscato-like alcoholic beverage of any one of embodiments 398-401, wherein about 0.03% to about 0.15% by mass of the one or more additional VOCs comprise the one or more phenols.

Embodiment 403 is the Moscato-like alcoholic beverage of any one of embodiments 398-402, wherein at least about 0.034% by mass of the one or more additional VOCs comprise the one or more phenols.

Embodiment 404 is the Moscato-like alcoholic beverage of any one of embodiments 276-403, wherein the one or more additional VOCs comprise one or more lactones.

Embodiment 405 is the Moscato-like alcoholic beverage of embodiment 404, wherein the one or more lactones are selected from the group consisting of delta-decalactone, delta-dodecalactone, dihydrocoumarin, gamma-decalactone, gamma-dodecalactone, gamma-heptalactone, gamma-hexalactone, gamma-nonalactone, gamma-octalactone, gamma-undecalactone, Jasmine lactone, omega-pentadecalactone, whiskey lactone, and mixtures thereof.

Embodiment 406 is the Moscato-like alcoholic beverage of embodiment 404 or embodiment 405, wherein the one or more lactones comprise delta-decalactone, gamma-decalactone, or both.

Embodiment 407 is the Moscato-like alcoholic beverage of any one of embodiments 404-406, wherein the one or more lactones comprise delta-decalactone.

Embodiment 408 is the Moscato-like alcoholic beverage of any one of embodiments 404-407, wherein the one or more lactones are present in a total concentration of about 0.001 mg/L to about 2.5 mg/L.

Embodiment 409 is the Moscato-like alcoholic beverage of any one of embodiments 404-408, wherein about 0.004% to about 2% by mass of the one or more additional VOCs comprise the one or more lactones.

Embodiment 410 is the Moscato-like alcoholic beverage of any one of embodiments 404-409, wherein at least about 0.11% by mass of the one or more additional VOCs comprise the one or more lactones.

Embodiment 411 is the Moscato-like alcoholic beverage of any one of embodiments 276-410, wherein the one or more additional VOCs comprise one or more amines or pyrazines.

Embodiment 412 is the Moscato-like alcoholic beverage of embodiment 411, wherein the one or more amines or pyrazines are selected from the group consisting of 2,6-dimethylpyrazine, 2-acetylpyridine, 2-ethyl-3(5 or 6)-dimethylpyrazine, 2-ethyl-3-methylpyrazine, 2-isobutyl-3-methoxypyrazine, 2-isopropyl-3-methoxypyrazine, 2-methoxy-3-(1-methylpropyl) pyrazine, indole, and mixtures thereof.

Embodiment 413 is the Moscato-like alcoholic beverage of any one of embodiments 276-412, wherein the one or more additional VOCs comprise one or more thiols.

Embodiment 414 is the Moscato-like alcoholic beverage of embodiment 413, wherein the one or more thiols are selected from the group consisting of 1-para-menthene-8-thiol, 2-isopropyl-4-methyl thiazole, 3-mercaptohexyl acetate, 4-mercapto-4-methyl-2-pentanone, dimethyl sulfide, furfuryl mercaptan, furfuryl thioacetate, and mixtures thereof.

Embodiment 415 is the Moscato-like alcoholic beverage of embodiment 413 or embodiment 414, wherein the one or more thiols comprise 3-mercaptohexyl acetate.

Embodiment 416 is the Moscato-like alcoholic beverage of any one of embodiments 276-415, wherein the one or more additional VOCs comprise at least 10 compounds selected from the group consisting of 2-methyl-1-butanol, 3-methyl-1-pentanol, a-terpineol, beta-pinene, butyric acid, decanoic acid, delta-decalactone, diethyl succinate, ethyl butyrate, ethyl decanoate, ethyl hexanoate, ethyl isobutyrate, ethyl lactate, ethyl laurate, ethyl octanoate, gamma-terpinene, geraniol, hexyl acetate, hexyl alcohol, isoamyl acetate, isobutyl alcohol, isobutyric acid, linalyl acetate, 1-limonene, 1-linalool, phenethyl acetate, and phenethyl alcohol.

Embodiment 417 is the Moscato-like alcoholic beverage of any one of embodiments 276-416, wherein the one or more additional VOCs comprise at least 10 compounds selected from the group consisting of 1-propanol, 2-methylbutyl acetate, 2-nonanone, 2-undecanone, 3-mercaptohexyl acetate, 4-carvomenthenol, benzaldehyde, benzyl alcohol, butyl alcohol, citronellol, damascenone, diethyl malate, ethyl 2-methylbutyrate, ethyl acetate, ethyl isovalerate, ethyl myristate, ethyl salicylate, ethyl valerate, eucalyptol, gamma-decalactone, hexanoic acid, isoamyl alcohol, isobutyraldehyde, linalyl butyrate, L-rose oxide, methyl decanoate, methyl hexanoate, nerol, octanoic acid, p-cymene, phenethyl butyrate, and phenethyl propionate.

Embodiment 418 is the Moscato-like alcoholic beverage of any one of embodiments 276-417, wherein the one or more additional VOCs comprise a compound selected from the group consisting of 2-nonanol, 4-vinylphenol, and acetovanillone.

Embodiment 419 is the Moscato-like alcoholic beverage of any of embodiments 276-418, wherein the one or more additional VOCs comprise a compound selected from the group consisting of 1-octanol, 1-octen-3-ol, 2,3-pentadione, 2,4,6-trimethylphenol, 2-acetylpyridine, 2-heptanone, 2-isopropyl-3-methoxypyrazine, 2-Methoxy-4-methylphenol, 2-methoxy-4-propylphenol, 2-methylbutyraldehyde, 3-(methylthio)-1-propanol, 3,7-dimethyl-6-octanoic acid, 3-carene, 3-nonen-2-one, 4-ethyl guaiacol, 4-ethyl phenol, 5-ethyl-3-hydroxy-4-methyl-2(5H)-furanone, 5-methyl furfural, 6,10-dimethyl-5,9-undecadien-2-one, 6-methyl-5-hepten-2-one, acetaldehyde, acetophenone, a-ionone, amyl alcohol, amyl butyrate, a-phellandrene, b-caryophellene, beta-ionone, butyl acetate, butyl formate, butyl isovalerate, cinnamaldehyde, cis-3-hexen-1-ol, cis-3-hexenyl acetate, citral, damascone, D-camphor, decanol, dimethyl sulfide, DL-3-methyl-2-butanol, ethyl 3-hydroxyhexanoate, ethyl benzoate, ethyl cinnamate, ethyl levulinate, ethyl nonanoate, ethyl palmitate, ethyl phenylacetate, ethyl propionate, ethyl trans-2-butenoate, ethyl undecanoate, ethyl-3-hydroxybutyrate, eugenol, farnesol, furfural, furfuryl mercaptan, gamma-hexalactone, gamma-nonalactone, gamma-octalactone, gamma-undecalactone, guaiacol, heptyl acetate, Hexadecanol, hexyl hexanoate, isoamyl hexanoate, isoamyl isobutyrate, isoamyl isovalerate, isoamyl octanoate, isoborneol, isobutyl acetate, isovaleraldehyde, isovaleric acid, Jasmine lactone, linalool oxide, maltol, methional, methyl acetate, methyl anthranilate, methyl cyclopentenolone, methyl laurate, methyl octanoate, methyl salicylate, methyl vanillate, methyl β-naphthyl ketone, myrcene, myrtenol, nerolidol, nonanal, octyl acetate, p,a-dimethylstyrene, p-cresol, phenethyl octanoate, phenylacetaldehyde, propyl acetate, propyl butyrate, propyl hexanoate, salicylaldehyde, terpinolene, trans-2-heptenal, trans-2-Hexen-1-al, trans-2-hexen-1-ol, trans-2-pentenal, and whiskey lactone.

Embodiment 420 is the Moscato-like alcoholic beverage of any of embodiments 276-419, wherein the one or more additional VOCs comprise a compound selected from the group consisting of (1R)-(−)-myrtenal, 1,4-cineole, 1-para-menthene-8-thiol, 2-(methylthio)ethanol, 2,3-hexanedione, 2,6-dimethyl-5-heptenal, 2,6-dimethylpyrazine, 2-acetyl-1-methylpyrrole, 2-ethyl-3(5 or 6)-dimethylpyrazine, 2-ethyl-3-methylpyrazine, 2-heptanol, 2-isobutyl-3-methoxypyrazine, 2-isobutyl-4-methyl-1,3-dioxolane, 2-isopropyl-4-methyl thiazole, 2-methoxy-3-(1-methylpropyl) pyrazine, 2-methoxycinnamaldehyde, 2-methylbutyl isovalerate, 2-octanone, 2-pentylfuran, 3,7-dimethyl-6-octenoic acid, 3-heptyl acetate, 3-methylthio hexyl acetate, 3-phenylpropanal, 4-(4-Hydroxyphenyl)-2-butanone, 4,5,6,7-tetrahydro-3,6-dimethylbenzofuran, 4-Hydroxy-2,5-dimethyl-3(2H)-furanone, 4-mercapto-4-methyl-2-pentanone, 5-methyl-2-phenyl-2-hexenal, acetal, acetaldehyde, diethyl acetal, acetoin, allyl heptanoate, allyl hexanoate, amyl formate, anisyl acetate, anisyl alcohol, anisyl butyrate, a-pinene, benzyl acetate, benzyl benzoate, benzyl butyrate, benzyl formate, benzyl propionate, butyl butyryllactate, butyraldehyde, carvacrol, cis-2-hexenol, cis-3-hexenyl butyrate, cis-3-hexenyl caproate, cis-3-hexenyl valerate, cis-5-octen-1-ol, cis-6-nonen-1-ol, citronellyl acetate, cuminaldehyde, D-carvone, decanal, delta-dodecalactone, d-fenchone, diacetyl, dihydrocoumarin, dimethyl anthranilate, dimethyl succinate, ethyl (methylthio) acetate, ethyl 2-trans-4-cis-decadienoate, ethyl anthranilate, ethyl heptanoate, ethyl-2-mercaptopropionate, ethyl-trans-3-hexenoate, furfuryl ether, furfuryl thioacetate, gamma-dodecalactone, gamma-heptalactone, geranyl acetate, geranyl butyrate, geranyl propionate, hexanal, hexyl 3-methylbutanoate, hexyl butyrate, hexyl formate, hexyl isobutyrate, hexyl propionate, indole, isoamyl cinnamate, isoamyl phenylacetate, isobutyl butyrate, isobutyl isobutyrate, isobutyl propionate, isoeugenol, L-carvone, linalyl formate, L-menthyl acetate, methionyl acetate (3-methylthio-propylacetate), methionyl butyrate, methyl benzoate, methyl cinnamate, methyl dihydrojasmonate, methyl-2-pyrrolyl ketone, neryl acetate, octanal, omega-pentadecalactone, p-anisaldehyde, perillaldehyde, phenethyl 2-methylbutyrate, phenethyl formate, phenethyl formate, phenethyl isobutyrate, phenethyl tiglate, phenethylacetaldehyde dimethyl acetal, phenylacetaldehyde dimethyl acetal, propanal, propanoic acid, propyl isovalerate, sotolon, tetrahydrolinalool, thymol, valencene, valeraldehyde, vanillyl butyl ether, and vanillyl ethyl ether.

Embodiment 421 is the Moscato-like alcoholic beverage of any one of embodiments 276-420, wherein the additional VOCs have less than 90% identity to the VOCs in a single reference Moscato.

Embodiment 422 is the Moscato-like alcoholic beverage of any one of embodiments 276-420, wherein the additional VOCs have less than 80% identity to the VOCs in a single reference Moscato.

Embodiment 423 is the Moscato-like alcoholic beverage of any one of embodiments 276-420, wherein the additional VOCs have less than 70% identity to the VOCs in a single reference Moscato.

Embodiment 424 is the Moscato-like alcoholic beverage of any one of embodiments 276-420, wherein the additional VOCs have less than 60% identity to the VOCs in a single reference Moscato.

Embodiment 425 is the Moscato-like alcoholic beverage of any one of embodiments 276-420, wherein the additional VOCs have less than 50% identity to the VOCs in a single reference Moscato.

Embodiment 426 is the Moscato-like alcoholic beverage of any one of embodiments 276-420, wherein the additional VOCs have less than 40% identity to the VOCs in a single reference Moscato.

Embodiment 427 is the Moscato-like alcoholic beverage of any one of embodiments 276-426, wherein the Moscato-like alcoholic beverage comprises at least 30 additional VOCs and wherein no more than 29 of the additional VOCs are found in a single reference Moscato.

Embodiment 428 is the Moscato-like alcoholic beverage of any one of embodiments 276-426, wherein the Moscato-like alcoholic beverage comprises at least 35 additional VOCs and wherein no more than 34 of the additional VOCs are found in a single reference Moscato.

Embodiment 429 is the Moscato-like alcoholic beverage of any one of embodiments 276-426, wherein the Moscato-like alcoholic beverage comprises at least 40 additional VOCs and wherein no more than 39 of the additional VOCs are found in a single reference Moscato.

Embodiment 430 is the Moscato-like beverage of any one of embodiments 276-429, wherein the one or more additional VOCs are present in a total amount of less than 120 mg/L.

Embodiment 431 is the Moscato-like alcoholic beverage of any one of embodiments 276-429, wherein the one or more additional VOCs are present in a total amount of less than 100 mg/L.

Embodiment 432 is the Moscato-like alcoholic beverage of any one of embodiments 218-431, wherein the Moscato-like alcoholic beverage does not comprise one or more of Escherichia coli, Salmonella sp., Brettanomyces sp., Lactobacillales, Saccharomyces sp., Acremonium strictum, Chrysonilia sitophila, Cladosporium oxysporum, Fusarium oxysporum, Mortierella alpina, Mucor plumbeus, Paecilomyces viridis, Penicillium chrysogenum, Penicillium citreonigrum, Penicillium decumbens, Penicillium purpurogenum, Trichoderma longibrachiatum, Trichoderma viride, Verticillium psalliotae, mold, mildew, rot, insects, insect eggs, insect filth, rodent filth, mammalian excreta, insect lecithins, hydrogen sulfide, hydrogen disulfide, 2,4,6-trichloranisole, 2,4,6,-tribromoanisole, aflatoxin, aldrin, dieldrin, benzene hexachloride, chlordane, dichlorodiphenyltrichloroethane (DDT), dichlorodiphenyldichloroethylene (DDE), dichlorodiphenyldichloroethane (TDE), dimethylnitrosamine (nitrosodimethylamine), ethylene dibromide (EDB), heptachlor, heptachlor epoxide, lindane, mercury, methanol, ethylene glycol, and dichloromethane.

Embodiment 433 is a method of making a Moscato-like alcoholic beverage, the method comprising combining ingredients comprising water, one or more acids, one or more sugars or sugar alcohols, a pH-modifying salt, optionally, one or more nucleotide monophosphates, one or more amino acids, ethanol, and ten or more additional VOCs selected from the group consisting of (−)-beta-pinene, (−)-cis-rose oxide, 1-decanol, 1-octanol, 1-octen-3-ol, 2,3-pentadione, 2-acetylpyridine, 2-heptanone, 2-isopropyl-3-methoxypyrazine, 2-methoxy-4-methylphenol, 2-methyl-1-butanol, 2-methylbutyl acetate, 2-methylbutyraldehyde, 2-nonanone, 2-phenethylacetate, 2-phenylethanol, 2-undecanone, 3-(methylthio)-1-propanol, 3,7-dimethyl-6-octenoic acid, 3-carene, 3-mercaptohexylacetate, 3-methyl-1-pentanol, 3-nonen-2-one, 4-carvomenthenol, 4-ethylguaiacol, 4-ethylphenol, acetaldehyde, acetovanillone, alpha-ionone, Amyl alcohol, amyl butyrate, alpha-phellandrene, alpha-terpineol, benzaldehyde, benzyl alcohol, butanol, butyl acetate, butyl formate, butyl isovalerate, butyric acid, cinnamaldehyde, cis-3-hexenyl acetate, citronellol, damascenone, decanoic acid, delta-decalactone, diethyl succinate, dimethyl sulfide, ethyl acetate, ethyl anthranilate, ethyl butanoate, ethyl butyrate, ethyl decanoate, ethyl hexanoate, ethyl isobutyrate, ethyl isovalerate, ethyl lactate, ethyl laurate, ethyl myristate, ethyl nonanoate, ethyl octanoate, ethyl palmitate, ethyl phenyl acetate, ethyl propionate, ethyl undecanoate, ethyl valerate, ethyl-2-methylbutyrate, ethyl-3-hydroxybutyrate, eucalyptol, eugenol, furfural, furfuryl mercaptan, gamma-decalactone, gamma-nonalactone, gamma-octalactone, gamma-terpinene, geraniol, guaiacol, heptyl acetate, hexanoic acid, Hexanol, hexyl acetate, hexyl hexanoate, isoamyl acetate, isoamyl alcohol, isoamyl octanoate, isoborneol, isobutanol, isobutyric acid, isovaleraldehyde, isovaleric acid, Jasmine lactone, limonene, linalool, linalool oxide, linalyl acetate, linalyl butyrate, maltol, methional, methyl anthranilate, methyl decanoate, methyl hexanoate, methyl laurate, methyl octanoate, methyl salicylate, methyl vanillate, myrcene, myrtenol, nerol, octanoic acid, octyl acetate, p-anisaldehyde, p-cymene, phenethyl butyrate, phenethyl octanoate, phenethyl propionate, propanol, propyl hexanoate, trans-2-heptenal, trans-2-hexen-1-al, trans-2-hexen-1-ol, trans-2-pentenal, and cis-whiskey lactone.

Embodiment 434 is a method of making a Moscato-like alcoholic beverage, the method comprising combining ingredients comprising water, one or more acids, one or more sugars or sugar alcohols, a pH-modifying salt, optionally, one or more nucleotide monophosphates, one or more amino acids, ethanol, and ten or more additional VOCs selected from the group consisting of 2-methyl-1-butanol, 2-nonanol, 2-nonanone, 2-undecanone, 3-methyl-1-pentanol, 4-carvomenthenol, a-terpineol, benzaldehyde, beta-pinene, butyl alcohol, butyric acid, citronellol, decanoic acid, delta-decalactone, diethyl malate, diethyl succinate, ethyl 2-methylbutyrate, ethyl butyrate, ethyl decanoate, ethyl isobutyrate, ethyl lactate, ethyl laurate, ethyl myristate, ethyl octanoate, ethyl salicylate, eucalyptol, gamma-terpinene, geraniol, hexanoic acid, hexyl acetate, hexyl alcohol, isoamyl acetate, isoamyl alcohol, isobutyl alcohol, isobutyraldehyde, isobutyric acid, linalyl acetate, 1-limonene, L-rose oxide, nerol, p-cymene, phenethyl acetate, phenethyl alcohol, phenethyl butyrate, and phenethyl propionate.

Embodiment 435 is a method of making a Moscato-like alcoholic beverage, the method comprising combining ingredients comprising water, one or more acids, one or more sugars or sugar alcohols, a pH-modifying salt, optionally, one or more nucleotide monophosphates, one or more amino acids, ethanol, and ten or more additional VOCs selected from the group consisting of 1-octanol, 1-octen-3-ol, 1-propanol, 2,3-pentadione, 2,4,6-trimethylphenol, 2-acetylpyridine, 2-heptanone, 2-isopropyl-3-methoxypyrazine, 2-Methoxy-4-methylphenol, 2-methoxy-4-propylphenol, 2-methyl-1-butanol, 2-methylbutyl acetate, 2-methylbutyraldehyde, 2-nonanol, 2-nonanone, 2-undecanone, 3-(methylthio)-1-propanol, 3,7-dimethyl-6-octanoic acid, 3-carene, 3-mercaptohexyl acetate, 3-methyl-1-pentanol, 3-nonen-2-one, 4-carvomenthenol, 4-ethyl guaiacol, 4-ethyl phenol, 4-vinylphenol, 5-ethyl-3-hydroxy-4-methyl-2(5H)-furanone, 5-methyl furfural, 6,10-dimethyl-5,9-undecadien-2-one, 6-methyl-5-hepten-2-one, acetaldehyde, acetophenone, acetovanillone, a-ionone, amyl alcohol, amyl butyrate, a-phellandrene, a-terpineol, b-caryophellene, benzaldehyde, benzyl alcohol, beta-ionone, beta-pinene, butyl acetate, butyl alcohol, butyl formate, butyl isovalerate, butyric acid, cinnamaldehyde, cis-3-hexen-1-ol, cis-3-hexenyl acetate, citral, citronellol, damascenone, damascone, D-camphor, decanoic acid, decanol, delta-decalactone, diethyl malate, diethyl succinate, dimethyl sulfide, DL-3-methyl-2-butanol, ethyl 2-methylbutyrate, ethyl 3-hydroxyhexanoate, ethyl acetate, ethyl benzoate, ethyl butyrate, ethyl cinnamate, ethyl decanoate, ethyl hexanoate, ethyl isobutyrate, ethyl isovalerate, ethyl lactate, ethyl laurate, ethyl levulinate, ethyl myristate, ethyl nonanoate, ethyl octanoate, ethyl palmitate, ethyl phenylacetate, ethyl propionate, ethyl salicylate, ethyl trans-2-butenoate, ethyl undecanoate, ethyl valerate, ethyl-3-hydroxybutyrate, eucalyptol, eugenol, farnesol, furfural, furfuryl mercaptan, gamma-decalactone, gamma-hexalactone, gamma-nonalactone, gamma-octalactone, gamma-terpinene, gamma-undecalactone, geraniol, guaiacol, heptyl acetate, hexadecanol, hexanoic acid, hexyl acetate, hexyl alcohol, hexyl hexanoate, isoamyl acetate, isoamyl alcohol, isoamyl hexanoate, isoamyl isobutyrate, isoamyl isovalerate, isoamyl octanoate, isoborneol, isobutyl acetate, isobutyl alcohol, isobutyraldehyde, isobutyric acid, isovaleraldehyde, isovaleric acid, Jasmine lactone, linalool oxide, linalyl acetate, linalyl butyrate, 1-limonene, 1-linalool, L-rose oxide, maltol, methional, methyl acetate, methyl anthranilate, methyl cyclopentenolone, methyl decanoate, methyl hexanoate, methyl laurate, methyl octanoate, methyl salicylate, methyl vanillate, methyl β-naphthyl ketone, myrcene, myrtenol, nerol, nerolidol, nonanal, octanoic acid, octyl acetate, p,a-dimethylstyrene, p-cresol, p-cymene, phenethyl acetate, phenethyl alcohol, phenethyl butyrate, phenethyl octanoate, phenethyl propionate, phenylacetaldehyde, propyl acetate, propyl butyrate, propyl hexanoate, salicylaldehyde, terpinolene, trans-2-heptenal, trans-2-Hexen-1-al, trans-2-hexen-1-ol, trans-2-pentenal, and whiskey lactone.

Embodiment 436 is the method of any one of embodiments 433-435, wherein the one or more acids comprise tartaric acid and malic acid.

Embodiment 437 is the method of embodiment 436, wherein the one or more acids further comprise a compound selected from the group consisting of citric acid, succinic acid, lactic acid, acetic acid, and combinations thereof.

Embodiment 438 is the method of any one of embodiments 433-437, wherein the one or more sugars or sugar alcohols comprise glycerol, glucose, and fructose.

Embodiment 439 is the method of embodiment 438, wherein the one or more sugars or sugar alcohols further comprise a compound selected from the group consisting of sorbitol, inositol, mannose, mannitol, and combinations thereof.

Embodiment 440 is the method of any one of embodiments 433-439, wherein the pH-modifying salt comprises potassium hydroxide.

Embodiment 441 is the method of any one of embodiments 433-440, wherein the one or more nucleotide monophosphates comprise guanosine monophosphate and inosine monophosphate.

Embodiment 442 is the method of any one of embodiments 433-441, wherein the one or more amino acids comprise arginine, asparagine, b-alanine, glutamic acid, glutamine, histidine, lysine, phenylalanine, proline, tryptophan, tyrosine, and valine.

Embodiment 443 is the method of embodiment 442, wherein the one or more amino acids further comprise a compound selected from the group consisting of alanine, aspartic acid, gamma-aminobutyric acid (GABA), glycine, isoleucine, leucine, methionine, monosodium glutamate, serine, threonine, and combinations thereof.

Embodiment 444 is the method of any one of embodiments 433-443, wherein the ingredients further comprise a coloring agent.

Embodiment 445 is the method of embodiment 444, wherein the coloring agent is selected from the group consisting of carotene, caramel, and combinations thereof.

Embodiment 446 is the method of any one of embodiments 433-445, wherein the ingredients further comprise a surfactant.

Embodiment 447 is the method of any one of embodiments 433-446, wherein the ingredients further comprise a compound selected from the group consisting of gum arabic, pectin, and combinations thereof.

Embodiment 448 is a Moscato-like alcoholic beverage comprising ethanol; water; VOCs, wherein the VOCs comprise (−)-beta-pinene, (−)-cis-rose oxide, 2-methyl-1-butanol, 2-methylbutyl acetate, 2-nonanone, 2-phenethylacetate, 2-phenylethanol, 3-mercaptohexylacetate, 3-methyl-1-pentanol, 4-carvomenthenol, acetovanillone, alpha-terpineol, benzaldehyde, benzyl alcohol, butanol, butyric acid, citronellol, damascenone, decanoic acid, delta-decalactone, diethyl succinate, ethyl acetate, ethyl butanoate, ethyl decanoate, ethyl hexanoate, ethyl isobutyrate, ethyl isovalerate, ethyl lactate, ethyl laurate, ethyl octanoate, ethyl valerate, gamma-decalactone, gamma-terpinene, geraniol, hexanoic acid, Hexanol, hexyl acetate, isoamyl acetate, isoamyl alcohol, isobutanol, isobutyric acid, limonene, linalool, linalyl acetate, linalyl butyrate, methyl decanoate, methyl hexanoate, nerol, octanoic acid, phenethyl butyrate, phenethyl propionate, and propanol, and one or more non-volatile compounds, wherein the non-volatile compounds comprise acetic acid, citric acid, lactic acid, malic acid, succinic acid, tartaric acid, fructose, glucose, glycerol, guanosine monophosphate, inosine monophosphate, potassium hydroxide, alanine, arginine, asparagine, aspartic acid, b-alanine, glutamic acid, glutamine, histidine, lysine, methionine, monosodium glutamate, phenylalanine, proline, serine, tryptophan, tyrosine, and valine.

Embodiment 449 is a Moscato-like alcoholic beverage comprising ethanol; water; VOCs, wherein the VOCs comprise 2-methyl-1-butanol, 2-nonanol, 2-nonanone, 2-undecanone, 3-methyl-1-pentanol, 4-carvomenthenol, a-terpineol, benzaldehyde, beta-pinene, butyl alcohol, butyric acid, citronellol, decanoic acid, delta-decalactone, diethyl malate, diethyl succinate, ethyl 2-methylbutyrate, ethyl butyrate, ethyl decanoate, ethyl isobutyrate, ethyl lactate, ethyl laurate, ethyl myristate, ethyl octanoate, ethyl salicylate, eucalyptol, gamma-terpinene, geraniol, hexanoic acid, hexyl acetate, hexyl alcohol, isoamyl acetate, isoamyl alcohol, isobutyl alcohol, isobutyraldehyde, isobutyric acid, linalyl acetate, 1-limonene, L-rose oxide, nerol, p-cymene, phenethyl acetate, phenethyl alcohol, phenethyl butyrate, and phenethyl propionate; and one or more non-volatile compounds, wherein the non-volatile compounds comprise 2-isopropylmalic acid, arginine, asparagine, beta-alanine, camphoric acid, choline, citric acid, D-glucuronic acid, fructose, fucose, fumaric acid, glucose, glutamic acid, glycine, histidine, leucine, lysine, malic acid, mannitol, phenylalanine, proline, quercetin, salicylic acid, succinic acid, tartaric acid, threonine, trans-ferulic acid, tryptophan, tyrosine, and valine.

Embodiment 450 is a method of making a Moscato-like alcoholic beverage, the method comprising providing a composition comprising ethanol, water, and one or more additional VOCs, wherein at least one of the one or more additional VOCs is present in a concentration of at least about 2-fold the concentration of the same VOC in a corresponding traditional Moscato, and adding to the composition ethanol, water, or a combination thereof such that the concentration of the at least one additional VOC is reduced to about the concentration of the same VOC in a corresponding traditional Moscato.

Embodiment 451 is the method of embodiment 450, wherein the one or more additional VOCs comprise at least one VOC that is not present in a corresponding traditional Moscato.

Embodiment 452 is the method of embodiment 450 or embodiment 451, wherein the one or more additional VOCs do not comprise at least one VOC that is present in a corresponding traditional Moscato.

Embodiment 453 is the method of any one of embodiments 450-453, wherein the Moscato-like alcoholic beverage further comprises one or more non-volatile compounds, and wherein the one or more non-volatile compounds comprise at least one non-volatile compound that is not present in a corresponding traditional Moscato.

Embodiment 454 is the method of any one of embodiments 450-453, wherein the Moscato-like alcoholic beverage further comprises one or more non-volatile compounds, and wherein the one or more non-volatile compounds do not comprise at least one non-volatile compound that is present in a corresponding traditional Moscato.

Embodiment 455 is the method of any one of embodiments 450-454, wherein the one or more additional VOCs are present in the composition in a concentration of at least about 5-fold the concentration of the same VOCs in a corresponding traditional Moscato.

Embodiment 456 is the method of any one of embodiments 450-454, wherein the one or more additional VOCs are present in the composition in a concentration of at least about 10-fold the concentration of the same VOC in a corresponding traditional Moscato.

Embodiment 457 is the method of any one of embodiments 450-454, wherein the one or more additional VOCs are present in the composition in a concentration of at least about 15-fold the concentration of the same VOCs in a corresponding traditional Moscato.

Embodiment 458 is the method of any one of embodiments 450-454, wherein the one or more additional VOCs are present in the composition in a concentration of at least about 20-fold the concentration of the same VOCs in a corresponding traditional Moscato.

Embodiment 459 is the method of any one of embodiments 450-458, wherein the composition comprises five or more additional VOCs, wherein at least five of the five or more additional VOCs are present in a concentration of at least about 5-fold the concentration of the same VOCs in a corresponding traditional Moscato.

Embodiment 460 is the method of any one of embodiments 450-459, wherein the total amount (in mg/L) of the one or more additional VOCs in the composition is greater than 5-fold the total amount of the same VOCs (in mg/L) in a corresponding traditional Moscato.

Embodiment 461 is a method of making a Moscato-like alcoholic beverage, the method comprising providing a composition comprising ethanol, water, and one or more non-volatile compounds, wherein at least one of the one or more non-volatile compounds is present in a concentration of at least about 2-fold the concentration of the same non-volatile compound in a corresponding traditional Moscato, and adding to the composition ethanol, water, or a combination thereof such that the concentration of the at least one non-volatile compound is reduced to about the concentration of the same non-volatile compound in a corresponding traditional Moscato.

Embodiment 462 is the method of any one of embodiment 461, wherein the one or more non-volatile compounds comprise at least one non-volatile compound that is not present in a corresponding traditional Moscato.

Embodiment 463 is the method of embodiment 461 or embodiment 462, wherein the one or more non-volatile compounds do not comprise at least one non-volatile compound that is present in a corresponding traditional Moscato.

Embodiment 464 is the method of any one of embodiments 461-463, wherein the Moscato-like alcoholic beverage further comprises one or more additional VOCs, and wherein the one or more additional VOCs comprise at least one VOC that is not present in a corresponding traditional Moscato.

Embodiment 465 is the method of any one of embodiments 461-464, wherein the Moscato-like alcoholic beverage further comprises one or more additional VOCs, and wherein the one or more additional VOCs do not comprise at least one VOC that is present in a corresponding traditional Moscato.

Embodiment 466 is the method of any one of embodiments 461-465, wherein the one or more non-volatile compounds are present in the composition in a concentration of at least about 5-fold the concentration of the same non-volatile compounds in a corresponding traditional Moscato.

Embodiment 467 is the method of any one of embodiments 461-465, wherein the one or more non-volatile compounds are present in the composition in a concentration of at least about 10-fold the concentration of the same non-volatile compounds in a corresponding traditional Moscato.

Embodiment 468 is the method of any one of embodiments 461-465, wherein the one or more non-volatile compounds are present in the composition in a concentration of at least about 15-fold the concentration of the same non-volatile compounds in a corresponding traditional Moscato.

Embodiment 469 is the method of any one of embodiments 461-465, wherein the one or more non-volatile compounds are present in the composition in a concentration of at least about 20-fold the concentration of the same non-volatile compounds in a corresponding traditional Moscato.

Embodiment 470 is the method of any one of embodiments 461-469, wherein the composition comprises five or more non-volatile compounds, wherein at least five of the five or more non-volatile compounds are present in a concentration of at least about 5-fold the concentration of the same non-volatile compounds in a corresponding traditional Moscato.

Embodiment 471 is the method of any one of embodiments 461-470, wherein the total amount (in mg/L) of the one or more non-volatile compounds in the composition is greater than 5-fold the total amount of the same non-volatile compounds (in mg/L) in a corresponding traditional Moscato.

Embodiment 472 is a method of making a Moscato-like alcoholic beverage concentrate, the method comprising combining ethanol, water, and one or more additional VOCs, wherein at least one of the one or more additional VOCs is present in a concentration of at least about 2-fold the concentration of the same VOC in a corresponding traditional Moscato.

Embodiment 473 is the method of embodiment 472, wherein the one or more additional VOCs comprise at least one VOC that is not present in a corresponding traditional Moscato.

Embodiment 474 is the method of embodiment 472 or embodiment 473, wherein the one or more additional VOCs do not comprise at least one VOC that is present in a corresponding traditional Moscato.

Embodiment 475 is the method of any one of embodiments 472-474, wherein the Moscato-like alcoholic beverage concentrate further comprises one or more non-volatile compounds, and wherein the one or more non-volatile compounds comprise at least one non-volatile compound that is not present in a corresponding traditional Moscato.

Embodiment 476 is the method of any one of embodiments 472-475, wherein the Moscato-like alcoholic beverage concentrate further comprises one or more non-volatile compounds, and wherein the one or more non-volatile compounds do not comprise at least one non-volatile compound that is present in a corresponding traditional Moscato.

Embodiment 477 is the method of any one of embodiments 472-476, wherein the one or more additional VOCs are present in the concentrate in a concentration of at least about 5-fold the concentration of the same VOCs in a corresponding traditional Moscato.

Embodiment 478 is the method of any one of embodiments 472-476, wherein the one or more additional VOCs are present in the concentrate in a concentration of at least about 10-fold the concentration of the same VOCs in a corresponding traditional Moscato.

Embodiment 479 is the method of any one of embodiments 472-476, wherein the one or more additional VOCs are present in the concentrate in a concentration of at least about 15-fold the concentration of the same VOCs in a corresponding traditional Moscato.

Embodiment 480 is the method of any one of embodiments 472-476, wherein the one or more additional VOCs are present in the concentrate in a concentration of at least about 20-fold the concentration of the same VOC in a corresponding traditional Moscato.

Embodiment 481 is the method of any one of embodiments 472-480, wherein the concentrate comprises five or more additional VOCs, wherein at least five of the five or more additional VOCs are present in a concentration of at least about 5-fold the concentration of the same VOCs in a corresponding traditional Moscato.

Embodiment 482 is the method of any one of embodiments 472-481, wherein the total amount (in mg/L) of the one or more additional VOCs in the concentrate is greater than 5-fold the total amount of the same VOCs (in mg/L) in a corresponding traditional Moscato.

Embodiment 483 is a method of making a Moscato-like alcoholic beverage concentrate, the method comprising combining ethanol, water, and one or more non-volatile compounds, wherein at least one of the one or more non-volatile compounds is present in a concentration of at least about 2-fold the concentration of the same non-volatile compound in a corresponding traditional Moscato.

Embodiment 484 is the method of embodiment 483, wherein the one or more non-volatile compounds comprise at least one non-volatile compound that is not present in a corresponding traditional Moscato.

Embodiment 485 is the method of embodiment 483 or embodiment 484, wherein the one or more non-volatile compounds do not comprise at least one non-volatile compound that is present in a corresponding traditional Moscato.

Embodiment 486 is the method of any one of embodiments 483-485, wherein the Moscato-like alcoholic beverage concentrate further comprises one or more additional VOCs, and wherein the one or more additional VOCs comprise at least one VOC that is not present in a corresponding traditional Moscato.

Embodiment 487 is the method of any one of embodiments 483-486, wherein the Moscato-like alcoholic beverage concentrate further comprises one or more additional VOCs, and wherein the one or more additional VOCs do not comprise at least one VOC that is present in a corresponding traditional Moscato.

Embodiment 488 is the method of any one of embodiments 483-487, wherein the one or more non-volatile compounds are present in the concentrate in a concentration of at least about 5-fold the concentration of the same non-volatile compounds in a corresponding traditional Moscato.

Embodiment 489 is the method of any one of embodiments 483-487, wherein the one or more non-volatile compounds are present in the concentrate in a concentration of at least about 10-fold the concentration of the same non-volatile compounds in a corresponding traditional Moscato.

Embodiment 490 is the method of any one of embodiments 483-487, wherein the one or more non-volatile compounds are present in the concentrate in a concentration of at least about 15-fold the concentration of the same non-volatile compounds in a corresponding traditional Moscato.

Embodiment 491 is the method of any one of embodiments 483-487, wherein the one or more non-volatile compounds are present in the concentrate in a concentration of at least about 20-fold the concentration of the same non-volatile compounds in a corresponding traditional Moscato.

Embodiment 492 is the method of any one of embodiments 483-491, wherein the concentrate comprises five or more non-volatile compounds, wherein at least five of the five or more non-volatile compounds are present in a concentration of at least about 5-fold the concentration of the same non-volatile compounds in a corresponding traditional Moscato.

Embodiment 493 is the method of any one of embodiments 483-492, wherein the total amount (in mg/L) of the one or more non-volatile compounds in the concentrate is greater than 5-fold the total amount of the same non-volatile compounds (in mg/L) in a corresponding traditional Moscato.

Embodiment 494 is a Moscato-like alcoholic beverage concentrate comprising ethanol, water, and one or more additional VOCs, wherein at least one of the one or more additional VOCs is present in a concentration of at least about 2-fold the concentration of the same VOC in a corresponding traditional Moscato.

Embodiment 495 is the Moscato-like alcoholic beverage concentrate of embodiment 494, wherein the one or more additional VOCs comprise at least one VOC that is not present in a corresponding traditional Moscato.

Embodiment 496 is the Moscato-like alcoholic beverage concentrate of embodiment 494 or embodiment 495, wherein the one or more additional VOCs do not comprise at least one VOC that is present in a corresponding traditional Moscato.

Embodiment 497 is the Moscato-like alcoholic beverage concentrate of any one of embodiments 494-496, wherein the Moscato-like alcoholic beverage concentrate further comprises one or more non-volatile compounds, and wherein the one or more non-volatile compounds comprise at least one non-volatile compound that is not present in a corresponding traditional Moscato.

Embodiment 498 is the Moscato-like alcoholic beverage concentrate of any one of embodiments 494-497, wherein the Moscato-like alcoholic beverage concentrate further comprises one or more non-volatile compounds, and wherein the one or more non-volatile compounds do not comprise at least one non-volatile compound that is present in a corresponding traditional Moscato.

Embodiment 499 is the Moscato-like alcoholic beverage concentrate of any one of embodiments 494-498, wherein the one or more additional VOCs are present in the concentrate in a concentration of at least about 5-fold the concentration of the same VOCs in a corresponding traditional Moscato.

Embodiment 500 is the Moscato-like alcoholic beverage concentrate of any one of embodiments 494-498, wherein the one or more additional VOCs are present in the concentrate in a concentration of at least about 10-fold the concentration of the same VOCs in a corresponding traditional Moscato.

Embodiment 501 is the Moscato-like alcoholic beverage concentrate of any one of embodiments 494-498, wherein the one or more additional VOCs are present in the concentrate in a concentration of at least about 15-fold the concentration of the same VOCs in a corresponding traditional Moscato.

Embodiment 502 is the Moscato-like alcoholic beverage concentrate of any one of embodiments 494-498, wherein the one or more additional VOCs are present in the concentrate in a concentration of at least about 20-fold the concentration of the same VOCs in a corresponding traditional Moscato.

Embodiment 503 is the Moscato-like alcoholic beverage concentrate of any one of embodiments 494-502, wherein the concentrate comprises five or more additional VOCs, wherein at least five of the five or more additional VOCs are present in a concentration of at least about 5-fold the concentration of the same VOCs in a corresponding traditional Moscato.

Embodiment 504 is the Moscato-like alcoholic beverage concentrate of any one of embodiments 494-503, wherein the total amount (in mg/L) of the one or more additional VOCs in the concentrate is greater than 5-fold the total amount of the same VOCs (in mg/L) in a corresponding traditional Moscato.

Embodiment 505 is a Moscato-like alcoholic beverage concentrate comprising ethanol, water, and one or more non-volatile compounds, wherein at least one of the one or more non-volatile compounds is present in a concentration of at least about 2-fold the concentration of the same non-volatile compound in a corresponding traditional Moscato.

Embodiment 506 is the Moscato-like alcoholic beverage concentrate of embodiment 505, wherein the one or more non-volatile compounds comprise at least one non-volatile compound that is not present in a corresponding traditional Moscato.

Embodiment 507 is the Moscato-like alcoholic beverage concentrate embodiment 505 or 506, wherein the one or more non-volatile compounds do not comprise at least one non-volatile compound that is present in a corresponding traditional Moscato.

Embodiment 508 is the Moscato-like alcoholic beverage concentrate of any one of embodiments 505-507, wherein the Moscato-like alcoholic beverage concentrate further comprises one or more additional VOCs, and wherein the one or more additional VOCs comprise at least one VOC that is not present in a corresponding traditional Moscato.

Embodiment 509 is the Moscato-like alcoholic beverage concentrate of any one of embodiments 505-508, wherein the Moscato-like alcoholic beverage concentrate further comprises one or more additional VOCs, and wherein the one or more additional VOCs do not comprise at least one VOC that is present in a corresponding traditional Moscato.

Embodiment 510 is the Moscato-like alcoholic beverage concentrate of any one of embodiments 505-509, wherein the one or more non-volatile compounds is present in the concentrate in a concentration of at least about 5-fold the concentration of the same non-volatile compound in a corresponding traditional Moscato.

Embodiment 511 is the Moscato-like alcoholic beverage concentrate of any one of embodiments 505-509, wherein the one or more non-volatile compounds is present in the concentrate in a concentration of at least about 10-fold the concentration of the same non-volatile compound in a corresponding traditional Moscato.

Embodiment 512 is the Moscato-like alcoholic beverage concentrate of any one of embodiments 505-509, wherein the one or more non-volatile compounds is present in the concentrate in a concentration of at least about 15-fold the concentration of the same non-volatile compound in a corresponding traditional Moscato.

Embodiment 513 is the Moscato-like alcoholic beverage concentrate of any one of embodiments 505-509, wherein the one or more non-volatile compounds is present in the concentrate in a concentration of at least about 20-fold the concentration of the same non-volatile compound in a corresponding traditional Moscato.

Embodiment 514 is the Moscato-like alcoholic beverage concentrate of any one of embodiments 505-513, wherein the concentrate comprises five or more non-volatile compounds, wherein at least five of the five or more non-volatile compounds are present in a concentration of at least about 5-fold the concentration of the same non-volatile compounds in a corresponding traditional Moscato.

Embodiment 515 is the Moscato-like alcoholic beverage concentrate of any one of embodiments 505-514, wherein the total amount (in mg/L) of the one or more non-volatile compounds in the concentrate is greater than 5-fold the total amount of the same non-volatile compounds (in mg/L) in a corresponding traditional Moscato.

The invention will be further described in the following examples, which do not limit the scope of the invention described in the claims.

### Examples

### Example 1—Moscato Replica and Method for Making

A 10 L batch of Moscato was prepared from individual components. The ingredients included:

| | | |
|---|---|---|
| 33.7 g tartaric acid | 17.99 g malic acid | 1.4 g citric acid |
| 1.68 g succinic acid | 0.37 g sorbitol | 8.63 g inositol |
| 5.95 g mannose | 0.853 g mannitol | 890 uL lactic acid (88%) |
| 100 mL 5% acetic acid | 16.2 g glycerol | 496.5 g glucose |
| 885.2 g fructose | 4 mL MSG (1.25 g/50 mL) | 6 mL 5′ ribonucleotides (1 mg/mL) |
| 11.2 g KOH | 632.6 mL ethanol | 150 uL Carotene color |
| 100 uL Caramel color | 360 uL surfactant | 161 mL VOCs (TABLE 1A) |
| 18.8 mg alanine | 37.2 mg arginine | 7.2 mg asparagine |
| 18.8 mg b-alanine | 45.9 mg GABA | 119 mg glutamic acid |
| 4.5 mg glutamine | 10.8 mg glycine | 25.4 mg histidine |
| 35.4 mg isoleucine | 39.3 mg leucine | 97.3 mg lysine |
| 0.8 mg methionine | 25.2 mg phenylalanine | 1.59 g proline |
| 40.5 mg threonine | 15.8 mg tryptophan | 88.1 mg tyrosine |
| 3.84 g valine | | |

### Moscato Base Preparation:

1) A 1 L beaker was filled to about 700 mL with room temperature tap water. Tartaric, malic, succinic, and citric acids were added and dissolved completely with stirring. The mixture was transferred to a 1 L graduated cylinder, which was then filled to 1 L with tap water. The solution was then deposited into a 10 L carboy.

2) The 1 L beaker was filled to about 700 mL with tap water, and sorbitol, inositol, mannose, and mannitol were added and allowed to dissolve completely with stirring. The solution was transferred to the 1 L graduated cylinder, brought to 1 L with tap water, and deposited into the 10 L carboy.

3) The 1 L beaker was filled to about 400 mL with tap water. Glycerol was measured into a weigh boat (about 13 mL was required to reach 16.2 g). The glycerol was added to the beaker, and the remaining residue was washed from the weigh boat into the beaker using 100 mL 5% acetic acid. The lactic acid, 5′R, and MSG solutions were added to the beaker, followed by the amino acids. (Solutions of 1 g/50 mL were prepared ahead of time for those compounds requiring less than 10 mg, for convenience.) Water was added to the beaker to bring the volume to about 900 mL to aid in dissolution. Once the solution was homogeneous, it was transferred to the 1 L graduated cylinder, brought to 1 L with tap water, and deposited into the 10 L carboy.

4) Half of the glucose (248.25 g) was weighed and dissolved in about 700 mL water in the 1 L beaker. Once it was dissolved, it was transferred to the graduated cylinder, brought to 1 L with tap water, and added to the carboy. This step was repeated with the other half of the glucose.

5) One third (295 g) of the fructose was weighed out and dissolved in about 700 mL water in the 1 L beaker. Once the fructose was dissolved completely, it was transferred to the graduated cylinder, brought to 1 L with tap water, and transferred to the carboy. This step was repeated twice. In the first repetition, the Carotene color was added, and in the second repetition, the Caramel color was added.

6) The 1 L beaker was filled with about 800 mL water. The KOH was quickly weighed out and added to the 1 L beaker (KOH reacts with air if left out longer than a minute or two). The KOH was completely dissolved, and the solution was transferred to the graduated cylinder, brought to 1 L with tap water, and added to the carboy. The overall solution was mixed well.

7) The ethanol (e.g., 75.5% ethanol) and then the VOCs were added to the graduated cylinder, according to the amounts shown in TABLE 1A. The cylinder was filled to 1 L with tap water and the solution was added to the carboy. After thorough mixing, the solution was refrigerated for several hours. (Alternatively, amounts of non-volatile compounds and ethanol as in TABLE 1B can be used, following the same procedure.)

### Carbonation:

1) 1 L of the Moscato base preparation was transferred from the carboy to a separate container and stored for later.

2) The remaining 9 L of Moscato base was transferred to a 2.5 gal Cornelius Keg (also referred to as a “kegerator;” obtained from AEB Kegs, Italy).

3) The kegerator was sealed with a carbonating stone placed inside. A CO₂ line was attached to the central valve on the lid of the kegerator (not to the valves to labelled ‘IN’ or ‘OUT’).

4) The gas (beverage grade CO₂) was set to 45-50 psi.

5) Once the gas line was attached, carbonation was allowed to proceed overnight or for at least 8 hours in a refrigerator (at about 3-5° C.).

### Bottling:

1) A dispensing apparatus was assembled. The apparatus consisted of a rubber stopper fit to the bottles, pierced by a dispensing tube of a length to extend almost to the bottom of the bottles when the stopper was firmly inserted. The dispensing apparatus also had a valved line connected to a CO₂ supply, and another valved line connected to the kegerator. The gas line had an adjustable pressure release valve and a pressure gauge rated to at least 60 psi.

2) The dispensing tube was inserted into a clean 750 mL bottle, forming a tight seal with the stopper.

3) After ensuring that the line connecting to the keg was closed, it was attached to the kegerator's ‘OUT’ valve.

4) The gas line was opened and the release valve was adjusted to pressurize the bottle to about 40 psi. The gas line was then closed.

5) The kegerator line was opened to begin filling the bottle. Gas escaped as the Moscato entered the bottle. The release valve was adjusted to maintain a pressure of about 37 psi while filling.

6) The kegerator line was closed about 2-3 inches below the bottom of the rubber stopper.

7) Using the pressure release valve, the bottle was slowly depressurized, as bubbles will rapidly leave the solution and flood the release valve if the pressure is relieved too quickly.

8) The rubber stopper was removed and 30 uL surfactant was added to the bottle.

9) The bottle was corked and inverted to mix in the surfactant.

10) The Moscato was refrigerated until needed.

The Moscato generated by the above method was an ode to those found in the northwestern Italian appellation of Moscato d'Asti. Like its Italian counterparts, the pale yellow-colored wine had a bit of froth upon pour, displaying notes of lychee, banana, peach, and flowers. The wine's gentle mousse on the palate opened up with sweetness but with bright acidity to balance it out, and with flavors that last. The alcohol was relatively low, matching the development method of Moscato d'Asti—arrested fermentation meant that sugar remained in the Moscato replica, and carbon dioxide derived from fermentation was captured in the bottles.

It is noted that the above process, and similar processes using variations of the VOC and non-volatile ingredient lists, can be scaled up for commercial production of a Moscato-like alcoholic beverage. Such scaled up processes (e.g., to generate 1000 L or more) can utilize tanks or vats for carbonation.

Additional combinations of non-volatile compounds are set forth in TABLE 2.

TABLE 1A
VOCs in Moscato formulation (mg/L)

| Compound | Amount | Compound | Amount |
|---|---|---|---|
| ethyl laurate | 0.06-0.12 | hexanol | 0.38-0.71 |
| ethyl decanoate | 0.29-0.54 | propanol | 0.23-0.42 |
| nerol | 0.12-0.23 | gamma-terpinene | 0.06-0.11 |
| citronellol | 0.07-0.12 | (−)-beta-Pinene | 0.06-0.11 |
| ethyl lactate | 0.59-1.09 | delta-decalactone | 0.007-0.013 |
| ethyl octanoate | 0.79-1.47 | 4-carvomenthenol | 0.04-0.07 |
| ethyl acetate | 0.63-1.17 | alpha-terpineol | 0.09-0.17 |
| isoamyl acetate | 10-35 | benzaldehyde | 0.017-0.031 |
| geraniol | 0.12-0.23 | benzyl alcohol | 0.014-0.026 |
| ethyl hexanoate | 1.1-2.0 | decanoic acid | 1.6-2.9 |
| linalool | 1.3-2.4 | diethyl succinate | 0.028-0.053 |
| linalyl acetate | 0.63-1.16 | ethyl isobutyrate | 0.29-0.53 |
| linalyl butyrate | 1.3-2.5 | ethyl valerate | 0.12-0.23 |
| damascenone | 0.007-0.013 | isobutyl alcohol | 10.2-19.0 |
| ethyl butanoate | 10-19 | 2-methylbutyl acetate | 0.012-0.023 |
| octanoic acid | 2.7-5.0 | 2-nonanone | 0.034-0.064 |
| butyric acid | 0.023-0.042 | 3 -methyl-1-pentanol | 0.016-0.030 |
| hexanoic acid | 1.3-2.5 | 4-vinylphenol | 0.100-0.185 |
| 2-phenethyl acetate | 0.39-0.72 | acetovanillone | 0.0004-0.0008 |
| isoamyl alcohol | 16-30 | isobutyric acid | 0.20-0.36 |
| 2-phenylethanol | 7.9-14.7 | methyl decanoate | 0.0012-0.0023 |
| limonene | 0.6-1.1 | methyl hexanoate | 0.41-0.77 |
| hexyl acetate | 0.35-0.65 | phenethyl butyrate | 0.014-0.026 |
| 2-methyl-1-butanol | 11.2-20.8 | butanol | 0.27-0.51 |
| gamma-decalactone | 1.3-2.5 | phenethyl propionate | 0.062-0.116 |
| 3-mercaptohexyl acetate | 0.00041-0.00077 | (−)-cis-rose oxide | 0.022-0.041 |
| ethyl isovalerate | 1.8-3.4 | | |

TABLE 1B
Non-volatiles and ethanol in Moscato formulation

| Component | Range | Component | Range |
|---|---|---|---|
| tartaric acid (g) | 2.36E+01-4.38E+01 | alanine (mg) | 1.32E+01-2.44E+01 |
| malic acid (g) | 1.26E+01-2.34E+01 | arginine (mg) | 2.60E+01-4.84E+01 |
| citric acid (g) | 9.80E−01-1.82E+00 | asparagine (mg) | 5.04E+00-9.36E+00 |
| succinic acid (g) | 1.18E+00-2.18E+00 | b-alanine (mg) | 1.32E+01-2.44E+01 |
| sorbitol (g) | 2.59E−01-4.81E−01 | GABA (mg) | 3.21E+01-5.97E+01 |
| inositol (g) | 6.04E+00-1.12E+01 | glutamic acid (mg) | 8.33E+01-1.55E+02 |
| mannose (g) | 4.17E+00-7.74E+00 | glutamine (mg) | 3.15E+00-5.85E+00 |
| mannitol (g) | 5.97E−01-1.11E+00 | glycine (mg) | 7.56E+00-1.40E+01 |
| lactic acid (μL; 88% stock) | 6.23E+02-1.16E+03 | histidine (mg) | 1.78E+01-3.30E+01 |
| acetic acid (mL; 5% stock) | 7.00E+01-1.30E+02 | isoleucine (mg) | 2.48E+01-4.60E+01 |
| glycerol (g) | 1.13E+01-2.11E+01 | leucine (mg) | 2.75E+01-5.11E+01 |
| glucose (g) | 3.48E+02-6.45E+02 | lysine (mg) | 6.81E+01-1.26E+02 |
| fructose (g) | 6.20E+02-1.15E+03 | methionine (mg) | 5.60E−01-1.04E+00 |
| monosodium glutamate | 2.80E+00-5.20E+00 | phenylalanine (mg) | 1.76E+01-3.28E+01 |
| (mL; stock 1.25 g/50 mL) | | | |
| 5′ ribonucleotides | 4.20E+00-7.80E+00 | proline (g) | 1.11E+00-2.07E+00 |
| (mL; stock 1 mg/mL) | | | |
| KOH (g) | 7.84E+00-1.46E+01 | threonine (mg) | 2.84E+01-5.27E+01 |
| carotene color (μL) | 1.05E+02-1.95E+02 | tryptophan (mg) | 1.11E+01-2.05E+01 |
| caramel color (μL) | 7.00E+01-1.30E+02 | tyrosine (mg) | 6.17E+00-1.15E+02 |
| surfactant (μL) | 2.52E+02-4.68E+02 | valine (g) | 2.69E+00-4.99E+00 |
| ethanol (mL) | 4.43E+02-8.22+02 | | |

TABLE 2
Additional non-volatile formulations

| *all values in mg/L, unless noted | Purity | Range | Subrange A | Subrange B | Subrange C | Subrange D |
|---|---|---|---|---|---|---|
| tartaric acid | 100% | 1000-4500 | 1000-2500 | 2500-3500 | 3500-4500 | 2300-4500 |
| malic acid | 99% | 650-3000 | 650-800 | 1500-2500 | 2500-3000 | 1200-2400 |
| citric acid | 100% | 0-750 | 0-200 | 200-600 | 600-750 | 90-180 |
| succinic acid | 99% | 0-1800 | 0-500 | 500-1500 | 1500-1800 | 110-225 |
| sorbitol | 97% | 0-250 | 0-50 | 50-150 | 150-250 | 25-50 |
| inositol | 100% | 0-5000 | 0-1000 | 1000-4000 | 4000-5000 | 0-1200 |
| Mannose | 100% | 0-1050 | 0-400 | 400-800 | 800-1050 | 0-775 |
| Mannitol | 97-102% | 0-410 | 0-50 | 50-100 | 100-410 | 1-125 |
| lactic acid | 88% | 0-1600 | 0-100 | 100-500 | 500-1600 | 50-110 |
| acetic acid (% v/v) | 5% | 0.5-1.5 | 0.5-0.7 | 0.7-1.2 | 1.2-1.5 | 7000-13000 |
| glycerol (vegetable glycerin) | 99.70% | 1100-5000 | 1600-1800 | 1800-4000 | 4000-5000 | 1100-2100 |
| glucose (from corn) | | 5000-95000 | 5000-8000 | 8000-35000 | 35000-90000 | 34000-65000 |
| fructose (from corn) | 100% | 19000-120000 | 19000-40000 | 40000-80000 | 80000-120000 | 60000-115000 |
| disodium 5′-guanylate and 5′-inosinate | | 0.4-1.0 | 0.5-0.7 | 0.7-0.9 | 0.8-1.0 | 0.4-0.8 |
| monosodium glutamate (from corn | | 5-15 | 5-7 | 7-12 | 12-15 | 7-13 |
| glucose) | | | | | | |
| KOH (target pH 3.15) | 90.00% | 300-1750 | 300-400 | 400-800 | 800-1750 | 750-1500 |
| ethanol (% v/v) (from grains) | 75.5 | 5-10 | 5-7 | 7-9 | 8-10 | 4-8 |
| food coloring Carotene (% v/v) | ? | 0.001-0.005 | 0.001-0.002 | 0.002-0.003 | 0.003-0.004 | 0.001-0.002 |
| food coloring Caramel (% v/v) | ? | 0.0001-0.015 | 0.0001-0.0005 | 0.0005-0.002 | 0.002-0.015 | 0.0007-0.0013 |
| surfactant (% v/v) (from Quillaja | ? | 0-0.005 | 0-0.002 | 0.002-0.003 | 0.003-0.005 | 0 |
| saponaria) | | | | | | |
| gum arabic (pre hydrated, spray dried | ? | 0-150 | 0-10 | 10-75 | 75-150 | 0 |
| powder) | | | | | | |
| pectin (Pectin 1400 pretested) (from | ? | 0-75 | 0-10 | 10-35 | 35-75 | 0 |
| citrus peels) | | | | | | |
| alanine | 100% | 1.0-2.0 | 1.5-1.7 | 1.7-1.9 | 1.8-2.0 | 1-5 |
| arginine | 100% | 2.5-27.5 | 3.5-5.0 | 5.0-20.0 | 5.0-27.5 | 2.5-5 |
| aspartic acid | 100% | 0-5 | 3.0-3.3 | 3.3-3.6 | 3.6-4.0 | 0-5 |
| asparagine | 100% | 0-1.5 | 0.6-0.8 | 0.8-1.3 | 1.3-1.5 | 0-1 |
| b-alanine | 99% | 0-2.5 | 1.5-1.7 | 1.7-1.9 | 1.8-2.0 | 0-2.5 |
| cysteine | 98.2-102% | 0 | NA | NA | NA | 0 |
| GABA | 100% | 0-6 | 0-2 | 2-4 | 4-5 | 3-6 |
| glutamic acid | 99% | 8-30 | 11-15 | 15-22 | 22-28 | 8-16 |
| glutamine | 100% | 0-0.6 | 0.3-0.4 | 0.4-0.5 | 0.5-0.6 | 0-0.6 |
| glycine | 100% | 0-1.5 | 0-0.5 | 0.5-1.0 | 1.0-1.5 | 0-1.5 |
| histidine | 100% | 0-3.5 | 2.5-2.7 | 2.7-2.9 | 2.9-3.0 | 0-3.5 |
| isoleucine | 101% | 0-4.6 | 0-1 | 1-2.5 | 2.5-3.6 | 2.5-4.6 |
| leucine | 95% | 0-5.1 | 0-2.0 | 2.0-3.0 | 3.0-5.0 | 2.7-5.1 |
| lysine | 99% | 6.5-13 | 9.5-10.0 | 10-11.5 | 11.5-12.5 | 6.5-13 |
| methionine | 98.5-101.5% | 0-1.5 | 0.05-0.1 | 0.1-0.8 | 0.8-1.5 | 0-0.1 |
| phenylalanine | 98.5-101.5% | 1.5-5.0 | 2.5-3.0 | 3.0-4.0 | 4.0-5.0 | 1.5-3.3 |
| proline | 98.5-101% | 0-210 | 150-175 | 175-190 | 190-200 | 0-210 |
| serine | 98.5-101% | 0-3.5 | 0-1.5 | 1.5-2.7 | 2.7-3.5 | 0 |
| threonine | 99-100.5% | 0-5.3 | 0-2.0 | 2.0-3.5 | 3.5-4.5 | 2.8-5.3 |
| tryptophan | 98.5-101.5% | 1.5-1.9 | 1.5-1.6 | 1.6-1.7 | 1.7-1.9 | 0-2 |
| tyrosine | 98.5-101.5% | 5.5-12 | 5.5-6.5 | 6.5-8.0 | 8.0-9.0 | 6-12 |
| valine | 98.5-101.5% | 0-5000 | 110-150 | 150-350 | 350-400 | 0-500 |

### Example 2—VOCs and Non-Volatile Compounds in Reference Moscato

GC-MS/MS was used to assess the amounts of various VOCs in traditional Moscato wines, as well as in some Moscato replicas.

GC-MS/MS Conditions:

All analyses were performed using an Agilent 7890B GC interfaced with a 7000D Triple Quadrupole mass spectrometer, and equipped with a PAL RSI 85 autosampler with HS-SPME attachment. For Headspace (HS) Solid Phase Microextraction (SPME) experiments, the SPME fiber was a 1 cm, 50/30 μm DVB/CAR/PDMS fiber (Supelco; Bellefonte, Pa.). HS-SPME autosampler conditions were as follows: pre-incubation time of 5 minutes, incubation temperature of 60° C., extraction time of 15 minutes, and desorption time 2 minutes. Post-desorption fiber conditioning time was 30 minutes. For liquid injection experiments, the injection volume was 0.5 μL. Both liquid and SPME injections had a split ratio of 1:20, with a desorption temperature of 250° C. The column was a 30 m×0.25 mm×0.25 Agilent HP-5 ms (ultra inert). Helium was used as the carrier gas at a constant flow rate of 1 mL/min. The MS ion source temperature and interface temperature were 250° C. The temperature program was as follows: initial temperature 40° C., held for 5 minutes, then increased to 180° C. at a rate of 4° C./min, and then increased to 240° C. at a rate of 45° C./min, and held for 10 minutes, for a total run time of 52 minutes.

Selection of Target Compounds and MRM Method Development:

An outline of the general workflow for GC-MS analyses is as follows. Real samples were first analyzed by HS-SPME-GC/MS in full scan mode (m/z 40-200) to identify potential target compounds. Collected data were analyzed manually using Agilent MassHunter Qualitative Analysis Version B.07.00, or using Agilent MassHunter Unknowns Analysis Version B.08.00. Additional compounds may have been targeted based on literature research. Multiple Reaction Monitoring (MRM) optimization was performed for commercially available standards. First, full scan experiments were repeated with liquid injection (5 mg/L in pure EtOH) to verify retention time and potential precursor ions. Product ion scans were performed using liquid injection and varying collision energies across a range of 5-35 V. Optimized MRM transitions and collision energies were selected, and are displayed in TABLES 3A, 3B, 3C, and 3D. A dynamic MRM (dMRM) method was developed for the generation of calibration curves, as described below. Compounds were divided into two methods (A and B, TABLES 3A and 3B respectively) to minimize simultaneous transitions (no greater than 6).

Preparation of Calibration Curves:

All calibration solutions were prepared as 10 mL of 10% EtOH in milliQ water in 20-mL amber vials, with 3 g of salt added to enhance volatility. This concentration of EtOH minimized swelling of the SPME fiber to maximize signal despite the dilution factor. The concentration range was varied by compound, based on the expected range in real samples.

Quantification in Real Samples:

All samples (reference samples and replica samples) were prepared as 10 mL in 20-mL amber vials with 3 g of salt, and were diluted in milliQ water to achieve a final concentration of 10% EtOH. Concentrations were later corrected to account for the dilution factor of the sample. All data were collected in triplicate, and were analyzed using Agilent Quantitative Analysis (for QQQ). Values reported as not detected (nd, zero) may be considered to be below the limits of detection (LODs) listed in TABLES 3A, 3B, 3C, and 3D. LODs were approximated based on S/N ratios as generated by the MassHunter software.

Various reference Moscato samples were assayed by GC-MS; the levels of VOCs therein are shown in TABLES 4A, 4B, and 4C.

TABLE 3A
Method A Transitions and Figures of Merit

| Compound Method | | | | Qualifier 1 Method | | | |
|---|---|---|---|---|---|---|---|
| | | | Collision | | Collision | Calibration | |
| Name | RT (min) | Transition | Energy | Transition | Energy | Range (mg/L) | LOD (mg/L) |
| propanol | 1.96 | 59.0 → 31.0 | 10 | 42.0 → 39.0 | 35 | 1-200 | 0.5 |
| ethyl acetate | 2.30 | 61.0 → 43.0 | 15 | 45.0 → 43.0 | 35 | 1-200 | 1 |
| isobutanol | 2.40 | 43.0 → 39.0 | 35 | 74.0 → 41.0 | 25 | 1-200 | 0.5 |
| isovaleraldehyde | 2.68 | 44.0 → 43.0 | 10 | 41.0 → 39.0 | 10 | 0.001-0.05 | 0.001 |
| butanol | 2.79 | 56.0 → 41.0 | 10 | 56.0 → 39.0 | 15 | 0.02-1 | 0.01 |
| 1,1-diethoxyethane | 3.91 | 73.0 → 45.0 | 10 | 103.0 → 47.0 | 10 | 0.05-2.5 | N/A |
| isoamyl alcohol | 4.03 | 70.0 → 55.0 | 15 | 55.0 → 39.0 | 15 | 15-750 | N/A |
| 2-methyl-1-butanol | 4.04 | 70.0 → 41.0 | 25 | 55.0 → 40.0 | 25 | 1-200 | 0.5 |
| ethyl isobutyrate | 4.66 | 43.0 → 27.0 | 20 | 71.0 → 43.0 | 10 | 0.001-0.05 | 0.0005 |
| isobutyl acetate | 5.11 | 73.0 → 43.0 | 5 | 56.0 → 41.0 | 15 | 0.001-0.05 | 0.001 |
| ethyl butyrate | 6.05 | 71.0 → 43.0 | 10 | 88.0 → 61.0 | 10 | 0.001-.2 | 0.0001 |
| ethyl lactate | 6.57 | 45.0 → 29.0 | 15 | 45.0 → 27.0 | 15 | 0.5-25 | 0.5 |
| ethyl-2-methylbutyrate | 7.97 | 102.0 → 74.0 | 10 | 85.0 → 57.0 | 5 | 0.001-0.05 | 0.0005 |
| ethyl isovalerate | 8.12 | 70.0 → 55.0 | 5 | 88.0 → 61.0 | 5 | 0.001-0.2 | 0.0001 |
| isoamyl acetate | 8.77 | 70.0 → 55.0 | 10 | 55.0 → 29.0 | 10 | 0.02-1 | 0.001 |
| hexanol | 9.09 | 69.0 → 41.0 | 15 | 56.0 → 41.0 | 15 | 0.001-0.05 | 0.001 |
| benzaldehyde | 12.50 | 105.0 → 51.0 | 35 | 106.0 → 77.0 | 35 | 0.001-0.05 | 0.001 |
| (−)-beta-pinene | 13.12 | 93.0 → 77.0 | 15 | 93.0 → 51.0 | 25 | 0.001-0.01 | 0.0001 |
| ethyl hexanoate | 14.31 | 88.0 → 61.0 | 5 | 99.0 → 43.0 | 5 | 0.005-1 | 0.001 |
| linalool oxide | 17.18 | 59.0 → 31.0 | 18 | 94.0 → 79.0 | 10 | 0.001-0.2 | 0.0005 |
| guaiacol | 17.85 | 109.0 → 81.0 | 15 | 124.0 → 109.0 | 15 | 0.001-0.2 | 0.0005 |
| linalool | 18.29 | 71.0 → 43.0 | 15 | 55.0 → 39.0 | 25 | 0.001-0.2 | 0.0001 |
| 2-phenylethanol | 18.77 | 122.0 → 91.0 | 15 | 92.0 → 65.0 | 25 | 0.2-10 | 0.05 |
| myrtenol | 18.77 | 79.0 → 51.0 | 35 | 91.0 → 65.0 | 35 | 0.001-0.05 | 0.001 |
| alpha-terpineol | 21.69 | 93.0 → 51.0 | 25 | 121.0 → 77.0 | 25 | 0.001-0.05 | 0.0001 |
| ethyl octanoate | 22.01 | 88.0 → 43.0 | 25 | 101.0 → 55.0 | 25 | 0.05-2.5 | 0.001 |
| citronellol | 23.10 | 69.0 → 41.0 | 10 | 41.0 → 39.0 | 10 | 0.001-0.2 | 0.0001 |
| linalyl acetate | 24.07 | 93.0 → 77.0 | 15 | 121.0 → 105.0 | 10 | 0.001-0.2 | 0.0001 |
| 4-ethyl guaiacol | 24.86 | 152.0 → 94.0 | 35 | 137.0 → 66.0 | 35 | 0.01-1 | 0.005 |
| ethyl nonanoate | 25.48 | 88.0 → 61.0 | 10 | 101.0 → 73.0 | 10 | 0.001-0.05 | 0.0001 |
| cis-whiskey lactone | 26.37 | 99.0 → 43.0 | 10 | 99.0 → 41.0 | 20 | 0.01-0.1 | 0.005 |
| eugenol | 27.51 | 164.0 →149.0 | 10 | 164.0 → 104.0 | 15 | 0.05-2.5 | 0.005 |
| damascenone | 28.41 | 69.0 → 41.0 | 20 | 121.0 → 77.0 | 20 | 0.001-0.05 | 0.0005 |
| ethyl decanoate | 28.75 | 88.0 → 43.0 | 20 | 61.0 → 43.0 | 20 | 0.05-2.5 | 0.005 |
| ethyl cinnamate | 30.93 | 131.0 → 103.0 | 10 | 131.0 → 77.0 | 25 | 0.0004-0.004 | 0.0001 |
| beta-ionone | 31.59 | 177.0 → 147.0 | 35 | 135.0 → 43.0 | 35 | 0.001-0.05 | 0.0001 |
| ethyl laurate | 34.75 | 88.0 → 61.0 | 15 | 101.0 → 55.0 | 25 | 0.001-0.05 | 0.0001 |

TABLE 3B
Method B Transitions and Figures of Merit

| Compound Method | | | | Qualifier 1 Method | | | |
|---|---|---|---|---|---|---|---|
| | | | Collision | | Collision | Calibration | |
| Name | RT (min) | Transition | Energy | Transition | Energy | Range (mg/L) | LOD (mg/L) |
| 2-methylbutyraldehyde | 2.79 | 57.0 → 39.0 | 25 | 58.0 → 31.0 | 25 | 0.005-0.05 | 0.001 |
| 2,3-pentadione | 3.20 | 100.0 → 57.0 | 5 | 57.0 → 42.0 | 30 | 0.005-0.05 | 0.001 |
| ethyl propionate | 3.52 | 102.0 → 46.0 | 35 | 75.0 → 57.0 | 35 | 0.005-0.05 | 0.005 |
| butyl formate | 3.75 | 73.0 → 45.0 | 15 | 56.0 → 41.0 | 15 | 0.005-0.05 | N/A |
| amyl alcohol | 4.92 | 70.0 → 55.0 | 5 | 55.0 → 53.0 | 35 | 0.005-0.05 | 0.005 |
| butyl acetate | 6.53 | 56.0 → 41.0 | 15 | 73.0 → 43.0 | 5 | 0.005-0.05 | N/A |
| furfural | 7.30 | 95.0 → 53.0 | 35 | 96.0 → 95.0 | 25 | 0.005-0.05 | 0.005 |
| 3-methyl-1-pentanol | 7.78 | 69.0 → 41.0 | 20 | 56.0 → 39.0 | 20 | 0.005-0.05 | 0.001 |
| ethyl valerate | 10.10 | 57.0 → 41.0 | 10 | 88.0 → 61.0 | 10 | 0.005-0.05 | 0.001 |
| 1-octen-3-ol | 13.42 | 57.0 → 31.0 | 25 | 72.0 → 43.0 | 15 | 0.005-0.05 | 0.001 |
| 3-(methylthio)-1-propanol | 13.50 | 106.0 → 58.0 | 10 | 88.0 → 73.0 | 10 | 0.005-0.05 | 0.005 |
| p-cymene | 15.20 | 134.0 → 91.0 | 35 | 119.0 → 77.0 | 35 | 0.005-0.05 | 0.001 |
| limonene | 15.34 | 93.0 → 77.0 | 15 | 68.0 → 53.0 | 15 | 0.005-0.05 | 0.001 |
| butyl isovalerate | 16.22 | 85.0 → 41.0 | 15 | 57.0 → 41.0 | 15 | 0.005-0.05 | 0.0005 |
| gamma-terpinene | 16.62 | 93.0 → 51.0 | 35 | 136.0 → 77.0 | 25 | 0.005-0.05 | 0.0005 |
| p-cresol | 17.39 | 108.0 → 107.0 | 0 | 107.0 → 77.0 | 0 | 0.005-0.05 | 0.001 |
| propyl hexanoate | 17.66 | 99.0 → 43.0 | 10 | 117.0 → 43.0 | 15 | 0.005-0.05 | 0.005 |
| 2-nonanone | 18.00 | 58.0 → 43.0 | 15 | 71.0 → 43.0 | 15 | 0.005-0.05 | 0.0001 |
| amyl butyrate | 18.10 | 71.0 → 43.0 | 10 | 89.0 → 43.0 | 15 | 0.005-0.05 | 0.0001 |
| ethyl heptanoate | 18.36 | 113.0 → 57.0 | 10 | 88.0 → 61.0 | 15 | 0.005-0.05 | N/A |
| nonanal | 18.47 | 98.0 → 56.0 | 5 | 57.0 → 39.0 | 15 | 0.005-0.05 | 0.0005 |
| 4-ethylphenol | 20.86 | 108.0 → 78.0 | 25 | 121.0 → 77.0 | 25 | 0.005-0.05 | 0.005 |
| isoamyl hexanoate | 23.57 | 70.0 → 55.0 | 10 | 99.0 → 43.0 | 10 | 0.005-0.05 | N/A |
| ethyl phenyl acetate | 23.69 | 91.0 → 65.0 | 35 | 164.0 → 91.0 | 10 | 0.005-0.05 | 0.0001 |
| phenylethyl acetate | 24.10 | 91.0 → 65.0 | 35 | 104.0 → 78.0 | 25 | 0.005-0.05 | 0.005 |
| cinnamaldehyde | 24.54 | 131.0 → 77.0 | 35 | 103.0 → 77.0 | 25 | 0.005-0.05 | 0.001 |
| 1-decanol | 24.63 | 70.0 → 55.0 | 15 | 55.0 → 51.0 | 40 | 0.005-0.05 | 0.0005 |
| gamma-nonalactone | 27.66 | 85.0 → 57.0 | 25 | 114.0 → 70.0 | 25 | 0.005-0.05 | 0.005 |
| damascone | 29.37 | 123.0 → 41.0 | 25 | 69.0 → 41.0 | 25 | 0.005-0.05 | 0.0005 |
| gamma-decalactone | 31.00 | 99.0 → 43.0 | 25 | 71.0 → 41.0 | 25 | 0.005-0.05 | 0.005 |
| ethyl myristate | 40.20 | 101.0 → 73.0 | 5 | 88.0 → 61.0 | 5 | 0.005-0.05 | 0.0005 |
| ethyl palmitate | 42.26 | 101.0 → 73.0 | 5 | 88.0 → 61.0 | 5 | 0.005-0.05 | 0.0005 |

TABLE 4A
VOCs in reference Moscato

| Round 1 assays | 1 | 2 | 3 | 4 | 5 |
|---|---|---|---|---|---|
| (−)alpha-pinene | BC | BC | BC | ND | ND |
| (−)-beta-pinene | 0.0034 | 0.0031 | 0.0048 | 0.0032 | 0.0037 |
| (−)-cis-rose oxide | BC | BC | BC | ND | ND |
| 1-decanol | 0.0016 | 0.0019 | 0.0018 | ND | ND |
| 1-octanol | 0.0006 | 0.0008 | 0.0009 | ND | ND |
| 1-octen-3-ol | 0.0003 | 0.0003 | 0.0021 | ND | ND |
| 2-(methylthio)ethanol | NF | NF | NF | ND | ND |
| 2,3-pentadione | 0.0223 | 0.0392 | 0.0179 | ND | ND |
| 2,6-dimethyl-5-heptenal | BC | BC | BC | ND | ND |
| 2,6-dimethylpyrazine | NF | NF | NF | ND | ND |
| 2-acetylpyridine | 0.0143 | 0.01 | 0.0112 | ND | ND |
| 2-heptanone | 0.0002 | 0.0002 | 0.0004 | ND | ND |
| 2-isobutyl-3-methoxypyrazine | BC | BC | BC | ND | ND |
| 2-isopropyl-3- | 0.0006 | 0.0001 | 0.0001 | ND | ND |
| methoxypyrazine | | | | | |
| 2-methoxy-4-methylphenol | 0.0035 | 0.0026 | 0.0035 | ND | ND |
| 2-methoxy-4-propylphenol | NF | NF | NF | ND | ND |
| 2-methyl-1-butanol | 194.7924 | 244.5273 | 268.3465 | ND | ND |
| 2-methylbutyl acetate | 0.0241 | 0.0221 | 0.0312 | 0.0234 | 0.0238 |
| 2-methylbutyraldehyde | 0.0023 | 0.003 | 0.0025 | ND | ND |
| 2-nonanone | NF | NF | NF | ND | ND |
| 2-phenethyl acetate | 0.0131 | 0.0378 | 0.0382 | ND | ND |
| 2-phenylethanol | 77.952 | 110.6814 | 126.9174 | ND | ND |
| 2-undecanone | 0.0002 | 0.0002 | 0.0002 | ND | ND |
| 3-(methylthio)-1-propanol | 1.6004 | 1.6514 | 1.1891 | ND | ND |
| 3,7 dimethyl-6-octenoic acid | 0.0009 | 0.001 | 0.0009 | ND | ND |
| 3-carene | 0.0067 | 0.0046 | 0.0043 | ND | ND |
| 3-mercaptohexyl acetate | NF | NF | NF | ND | ND |
| 3-methyl-1-pentanol | 0.059 | 0.0492 | 0.088 | ND | ND |
| 3-nonene-2-one | 0.0022 | 0.0026 | 0.0025 | ND | ND |
| 4-carvomenthenol | 0.0013 | 0.0014 | 0.0029 | ND | ND |
| 4-ethyl guaiacol | NF | NF | NF | ND | ND |
| 4-ethyl phenol | 0.0005 | 0.0001 | 0.0001 | ND | ND |
| acetaldehyde | 0.0088 | 0.0241 | 0.0225 | ND | ND |
| acetoin | NF | NF | NF | ND | ND |
| alpha ionone | 0.0001 | 0.0003 | 0.0003 | ND | ND |
| alpha terpineol | 0.4531 | 0.4718 | 0.7241 | ND | ND |
| amyl alcohol | BC | 0.0434* | BC | ND | ND |
| amyl butyrate | 0.0063 | 0.0072 | 0.0073 | ND | ND |
| amyl formate | BC | BC | BC | ND | ND |
| a-phellandrene | 0.014 | 0.0068 | 0.0056 | ND | ND |
| benzaldehyde | 0.0017 | 0.0016 | 0.002 | ND | ND |
| benzyl acetate | NF | NF | NF | ND | ND |
| benzyl alcohol | NF | NF | NF | ND | ND |
| beta-ionone | NF | NF | NF | 0 | 0 |
| butanol | BC | BC | BC | ND | ND |
| butyl acetate | 0.1268 | 0.1345 | 0.1512 | ND | ND |
| butyl formate | 1.1342 | 1.0267 | 1.4068 | 1.1119 | 1.1093 |
| butyl isovalerate | 0.0004 | 0.0006 | 0.0005 | ND | ND |
| butyric acid | 0.0977 | 0.0993 | 0.0701 | ND | ND |
| cinnamaldehyde | 0.0001 | 0.0001 | 0.0001 | ND | ND |
| cis-3-hexen-1-ol | BC | BC | BC | ND | ND |
| cis-3-hexenyl acetate | 0.0017 | 0.0018 | 0.0023 | ND | ND |
| cis-whiskey lactone | 0.0017 | 0.0014 | 0.0009 | 0.0015 | 0.0012 |
| citronellol | NF | NF | 0.0001 | ND | ND |
| citronellyl acetate | NF | NF | NF | ND | ND |
| damascenone | 0.4302 | 0.5365 | 0.9007 | ND | ND |
| damascone | 0.787* | 0.8533* | 0.7467* | ND | ND |
| decanal | NF | NF | NF | ND | ND |
| decanoic acid | 0.2945 | 0.0209 | 0.0056 | ND | ND |
| delta-decalactone | 0.0023 | 0.0007 | 0.0002 | 0.0034 | 0.0007 |
| diethyl succinate | 0.7863 | 1.5732 | 1.4867 | ND | ND |
| dimethyl anthranilate | BC | BC | BC | ND | ND |
| dimethyl succinate | NF | NF | NF | ND | ND |
| dimethyl sulfide | 0.0161 | 0.0097 | 0.0137 | ND | ND |
| ethyl acetate | 153.1713 | 168.7244 | 179.6349 | ND | ND |
| ethyl anthranilate | NF | NF | NF | ND | ND |
| ethyl butyrate | 0.0818 | 0.1169 | 0.1074 | 0.1018 | 0.1045 |
| ethyl cinnamate | NF | NF | NF | ND | ND |
| ethyl decanoate | 0.2702 | 0.0172 | 0.0032 | ND | ND |
| ethyl heptanoate | BC | BC | BC | ND | ND |
| ethyl hexanoate | 2.0475 | 1.194 | 0.3136 | ND | ND |
| ethyl isobutyrate | 0.0646 | 0.0603 | 0.0407 | ND | ND |
| ethyl isovalerate | 0.0048 | 0.0035 | 0.0016 | ND | ND |
| ethyl lactate | 9.5926 | 9.6073 | 8.4912 | 4.1428 | 4.954 |
| ethyl laurate | 0.0741 | 0.1013 | 0.0581 | 0.0773 | 0.0835 |
| ethyl myristate | 0.0196 | 0.0165 | 0.022 | ND | ND |
| ethyl nonanoate | 0.0002 | 0.0002 | 0.0002 | 0.0002 | 0.0002 |
| ethyl octanoate | 5.3134 | 6.1841 | 5.6028 | 6.6972 | 5.9387 |
| ethyl palmitate | 0.0114 | 0.0118 | 0.0171 | ND | ND |
| ethyl phenyl acetate | 0.0004 | 0.0006 | 0.0005 | ND | ND |
| ethyl propionate | 0.0325 | 0.0351 | 0.0444 | 0.0381 | 0.044 |
| ethyl undecanoate | 0.0002 | 0.0002 | 0.0002 | ND | ND |
| ethyl valerate | 0.0003 | 0.0005 | 0.0004 | ND | ND |
| ethyl-2-mercaptopropionate | NF | NF | NF | ND | ND |
| ethyl-2-methylbutyrate | 0.0035 | 0.0032 | 0.0046 | 0.0035 | 0.0034 |
| ethyl-3-hydroxybutyrate | 0.0309 | 0.0432 | 0.0496 | ND | ND |
| ethyl-trans-2-butenoate | NF | NF | NF | ND | ND |
| ethyl-trans-3-hexenoate | BC | BC | BC | ND | ND |
| eucalyptol | 0.0002 | 0.0002 | 0.0002 | ND | ND |
| eugenol | NF | NF | NF | ND | ND |
| furfural | 1.0548 | 1.0871 | 4.6193 | ND | ND |
| furfuryl ether | NF | NF | NF | ND | ND |
| furfuryl mercaptan | NF | NF | NF | 0.0001 | 0 |
| gamma-decalactone | 0.0034 | 0.0007 | 0.0005 | 0.0023 | 0.0007 |
| gamma-dodecalactone | NF | NF | NF | ND | ND |
| gamma-nonalactone | 0.0002 | 0.0001 | 0.0003 | ND | ND |
| gamma-octalactone | 0.0024 | 0.0046 | 0.0035 | ND | ND |
| gamma-terpinene | 0.0004 | 0.0003 | 0.0003 | ND | ND |
| gamma-undecalactone | NF | NF | NF | ND | ND |
| geraniol | 0.0034 | 0.0037 | 0.0055 | 0.0041 | 0.0042 |
| geranyl acetate | BC | BC | BC | ND | ND |
| guaiacol | 0.0031 | 0.0029 | 0.0035 | ND | ND |
| heptyl acetate | 0.0004 | 0.0004 | 0.0004 | ND | ND |
| hexanoic acid | SC | SC | SC | SC | SC |
| hexanol | 0.3946 | 0.4393 | 0.5256 | ND | ND |
| hexyl acetate | 0.014 | 0.0143 | 0.0201 | ND | ND |
| hexyl hexanoate | 0.0018 | 0.0015 | 0.0016 | ND | ND |
| isoamyl acetate | 0.658 | 0.6007 | 0.8561 | 0.6523 | 0.6449 |
| isoamyl alcohol | 17.1494 | 24.2306 | 23.3799 | 1152.675 | 244.3339 |
| isoamyl hexanoate | BC | BC | BC | ND | ND |
| isoamyl octanoate | 0.002 | 0.0019 | 0.0015 | 0.0044 | 0.0046 |
| isoborneol | 0.0026 | 0.0032 | 0.0033 | ND | ND |
| isobutanol | 5.4009 | 6.535 | 6.6788 | 164.093 | 140.3592 |
| isobutyl acetate | 0.0317 | 0.0297 | 0.0385 | ND | ND |
| isobutyric acid | 3.2199 | 4.8063 | 4.9116 | ND | ND |
| isovaleraldehyde | 0.0229 | 0.029 | 0.0274 | ND | ND |
| isovaleric acid | 3.8767 | 3.3551 | 3.8767 | 3.5634 | 3.4007 |
| Jasmine lactone | 0.01 | 0.0104 | 0.0105 | ND | ND |
| L/D-carvone | BC | BC | BC | ND | ND |
| limonene | 0.0015 | 0.0017 | 0.0022 | 0.0015 | 0.0019 |
| linalool | 0.0952 | 0.0888 | 0.2381 | 0.1182 | 0.1278 |
| linalool oxide | 0.2429 | 0.3085 | 0.3627 | ND | ND |
| linalyl acetate | 0.0045 | 0.0049 | 0.0046 | ND | ND |
| linalyl butyrate | 0.0001 | 0.0001 | 0.0001 | ND | ND |
| linalyl formate | NF | NF | NF | ND | ND |
| maltol | 1.9783 | 2.2314 | 3.7793 | ND | ND |
| methional | 0.0002 | 0.0003 | 0.0006 | ND | ND |
| methyl anthranilate | 0.0006 | 0.0001 | NF | ND | ND |
| methyl decanoate | 0.0004 | 0.0003 | 0.0003 | ND | ND |
| methyl dihydrojasmonate | NF | NF | NF | ND | ND |
| methyl hexanoate | 3.4745 | 3.3208 | 3.5423 | ND | ND |
| methyl laurate | 0.0007 | 0.0007 | 0.0006 | ND | ND |
| methyl octanoate | 0.0931 | 0.1003 | 0.1006 | ND | ND |
| methyl salicylate | 0.0001 | 0.0001 | 0.0001 | ND | ND |
| methyl vanillate | 0.1321 | 0.0403 | 0.2557 | 0 | 0 |
| myrcene | 0.0009 | 0.0017 | 0.0015 | ND | ND |
| myrtenol | 0.0669 | 0.0528 | 0.0574 | ND | ND |
| nerol | 0.0015 | 0.0013 | 0.0028 | 0.0016 | 0.0017 |
| neryl acetate/geranyl acetate | 0 | 0 | 0 | ND | ND |
| nonanal | NF | NF | NF | ND | ND |
| octanoic acid | 6.405 | 7.7898 | 8.3655 | 0 | 9.1662 |
| octyl acetate | 0.001 | 0.001 | 0.001 | ND | ND |
| p-anisaldehyde | NF | NF | NF | ND | ND |
| p-cresol | BC | BC | BC | ND | ND |
| p-cymene | 0.0003 | 0.0003 | 0.0002 | ND | ND |
| phenethyl acetaldehyde | NF | NF | NF | ND | ND |
| dimethylacetate | | | | | |
| phenethyl butyrate | BC | BC | BC | BC | BC |
| phenethyl octanoate | ND | 0.0014 | 0.0015 | ND | ND |
| phenethyl propionate | BC | BC | BC | ND | ND |
| propanoic acid | SC | SC | SC | SC | SC |
| propanol | 13.4993 | 9.7047 | 12.131 | 10.1616 | 10.4205 |
| propyl hexanoate | 0.0001 | 0.0001 | 0.0001 | ND | ND |
| trans-2-pentenal | 0.1296 | 0.1473 | 0.1315 | ND | ND |
| trans-2-heptenal | 0.0005 | 0.0005 | NF | ND | ND |
| trans-2-hexen-1-al | 0.0065 | 0.0084 | 0.0065 | ND | ND |
| trans-2-hexen-1-ol | 0.0664 | 0.0754 | 0.0825 | ND | ND |

| Round 1 assays | 6 | 7 | 8 | 9 |
|---|---|---|---|---|
| (−)alpha-pinene | ND | ND | ND | ND |
| (−)-beta-pinene | 0.0037 | ND | ND | ND |
| (−)-cis-rose oxide | ND | ND | ND | ND |
| 1-decanol | ND | ND | ND | ND |
| 1-octanol | ND | ND | ND | ND |
| 1-octen-3-ol | ND | ND | ND | ND |
| 2-(methylthio)ethanol | ND | ND | ND | ND |
| 2,3-pentadione | ND | ND | ND | ND |
| 2,6-dimethyl-5-heptenal | ND | ND | ND | ND |
| 2,6-dimethylpyrazine | ND | ND | ND | ND |
| 2-acetylpyridine | ND | ND | ND | ND |
| 2-heptanone | ND | ND | ND | ND |
| 2-isobutyl-3-methoxypyrazine | ND | ND | ND | ND |
| 2-isopropyl-3- | ND | ND | ND | ND |
| methoxypyrazine | | | | |
| 2-methoxy-4-methylphenol | ND | ND | ND | ND |
| 2-methoxy-4-propylphenol | ND | ND | ND | ND |
| 2-methyl-1-butanol | ND | ND | ND | ND |
| 2-methylbutyl acetate | 0.0259 | ND | ND | ND |
| 2-methylbutyraldehyde | ND | ND | ND | ND |
| 2-nonanone | ND | ND | ND | ND |
| 2-phenethyl acetate | ND | ND | ND | ND |
| 2-phenylethanol | ND | ND | ND | ND |
| 2-undecanone | ND | ND | ND | ND |
| 3-(methylthio)-1-propanol | ND | ND | ND | ND |
| 3,7 dimethyl-6-octenoic acid | ND | ND | ND | ND |
| 3-carene | ND | ND | ND | ND |
| 3-mercaptohexyl acetate | ND | ND | ND | ND |
| 3-methyl-1-pentanol | ND | ND | ND | ND |
| 3-nonene-2-one | ND | ND | ND | ND |
| 4-carvomenthenol | ND | ND | ND | ND |
| 4-ethyl guaiacol | ND | ND | ND | ND |
| 4-ethyl phenol | ND | ND | ND | ND |
| acetaldehyde | ND | ND | ND | ND |
| acetoin | ND | ND | ND | ND |
| alpha ionone | ND | ND | ND | ND |
| alpha terpineol | ND | ND | ND | ND |
| amyl alcohol | ND | ND | ND | ND |
| amyl butyrate | ND | ND | ND | ND |
| amyl formate | ND | ND | ND | ND |
| a-phellandrene | ND | ND | ND | ND |
| benzaldehyde | ND | ND | ND | ND |
| benzyl acetate | ND | ND | ND | ND |
| benzyl alcohol | ND | ND | ND | ND |
| beta-ionone | 0 | ND | ND | ND |
| butanol | ND | ND | ND | ND |
| butyl acetate | ND | ND | ND | ND |
| butyl formate | 1.1305 | ND | ND | ND |
| butyl isovalerate | ND | ND | ND | ND |
| butyric acid | ND | ND | ND | ND |
| cinnamaldehyde | ND | ND | ND | ND |
| cis-3-hexen-1-ol | ND | ND | ND | ND |
| cis-3-hexenyl acetate | ND | ND | ND | ND |
| cis-whiskey lactone | 0.0022 | ND | ND | ND |
| citronellol | ND | ND | ND | ND |
| citronellyl acetate | ND | ND | ND | ND |
| damascenone | ND | ND | ND | ND |
| damascone | ND | ND | ND | ND |
| decanal | ND | ND | ND | ND |
| decanoic acid | ND | ND | ND | ND |
| delta-decalactone | 0.0005 | ND | ND | ND |
| diethyl succinate | ND | ND | ND | ND |
| dimethyl anthranilate | ND | ND | ND | ND |
| dimethyl succinate | ND | ND | ND | ND |
| dimethyl sulfide | ND | ND | ND | ND |
| ethyl acetate | ND | ND | ND | ND |
| ethyl anthranilate | ND | ND | ND | ND |
| ethyl butyrate | 0.0735 | ND | ND | ND |
| ethyl cinnamate | ND | ND | ND | ND |
| ethyl decanoate | ND | ND | ND | ND |
| ethyl heptanoate | ND | ND | ND | ND |
| ethyl hexanoate | ND | ND | ND | ND |
| ethyl isobutyrate | ND | ND | ND | ND |
| ethyl isovalerate | ND | ND | ND | ND |
| ethyl lactate | 5.8814 | ND | ND | ND |
| ethyl laurate | 0.0718 | ND | ND | ND |
| ethyl myristate | ND | ND | ND | ND |
| ethyl nonanoate | 0.0002 | ND | ND | ND |
| ethyl octanoate | 5.934 | ND | ND | ND |
| ethyl palmitate | ND | ND | ND | ND |
| ethyl phenyl acetate | ND | ND | ND | ND |
| ethyl propionate | 0.0398 | ND | ND | ND |
| ethyl undecanoate | ND | ND | ND | ND |
| ethyl valerate | ND | ND | ND | ND |
| ethyl-2-mercaptopropionate | ND | ND | ND | ND |
| ethyl-2-methylbutyrate | 0.0034 | ND | ND | ND |
| ethyl-3-hydroxybutyrate | ND | ND | ND | ND |
| ethyl-trans-2-butenoate | ND | ND | ND | ND |
| ethyl-trans-3-hexenoate | ND | ND | ND | ND |
| eucalyptol | ND | ND | ND | ND |
| eugenol | ND | ND | ND | ND |
| furfural | ND | ND | ND | ND |
| furfuryl ether | ND | ND | ND | ND |
| furfuryl mercaptan | 0 | ND | ND | ND |
| gamma-decalactone | 0.0002 | ND | ND | ND |
| gamma-dodecalactone | ND | ND | ND | ND |
| gamma-nonalactone | ND | ND | ND | ND |
| gamma-octalactone | ND | ND | ND | ND |
| gamma-terpinene | ND | ND | ND | ND |
| gamma-undecalactone | ND | ND | ND | ND |
| geraniol | 0.0036 | ND | ND | ND |
| geranyl acetate | ND | ND | ND | ND |
| guaiacol | ND | ND | ND | ND |
| heptyl acetate | ND | ND | ND | ND |
| hexanoic acid | SC | ND | ND | ND |
| hexanol | ND | ND | ND | ND |
| hexyl acetate | ND | ND | ND | ND |
| hexyl hexanoate | ND | ND | ND | ND |
| isoamyl acetate | 0.6514 | ND | ND | ND |
| isoamyl alcohol | 1442.818 | ND | ND | ND |
| isoamyl hexanoate | ND | ND | ND | ND |
| isoamyl octanoate | 0.0045 | 275.6349 | 1065.758 | 274.3083 |
| isoborneol | ND | ND | ND | ND |
| isobutanol | 179.8129 | ND | ND | ND |
| isobutyl acetate | ND | ND | ND | ND |
| isobutyric acid | ND | 147.6942 | 145.3173 | 148.121 |
| isovaleraldehyde | ND | ND | ND | ND |
| isovaleric acid | 3.3874 | ND | ND | ND |
| Jasmine lactone | ND | ND | ND | ND |
| L/D-carvone | ND | ND | ND | ND |
| limonene | 0.002 | ND | ND | ND |
| linalool | 0.1089 | ND | ND | ND |
| linalool oxide | ND | ND | ND | ND |
| linalyl acetate | ND | ND | ND | ND |
| linalyl butyrate | ND | ND | ND | ND |
| linalyl formate | ND | ND | ND | ND |
| maltol | ND | ND | ND | ND |
| methional | ND | ND | ND | ND |
| methyl anthranilate | ND | ND | ND | ND |
| methyl decanoate | ND | ND | ND | ND |
| methyl dihydrojasmonate | ND | ND | ND | ND |
| methyl hexanoate | ND | ND | ND | ND |
| methyl laurate | ND | ND | ND | ND |
| methyl octanoate | ND | ND | ND | ND |
| methyl salicylate | ND | ND | ND | ND |
| methyl vanillate | 0 | ND | ND | ND |
| myrcene | ND | ND | ND | ND |
| myrtenol | ND | ND | ND | ND |
| nerol | 0.0015 | ND | ND | ND |
| neryl acetate/geranyl acetate | ND | ND | ND | ND |
| nonanal | ND | ND | ND | ND |
| octanoic acid | 2.0322 | ND | ND | ND |
| octyl acetate | ND | ND | ND | ND |
| p-anisaldehyde | ND | ND | ND | ND |
| p-cresol | ND | ND | ND | ND |
| p-cymene | ND | ND | ND | ND |
| phenethyl acetaldehyde | ND | ND | ND | ND |
| dimethylacetate | | | | |
| phenethyl butyrate | BC | ND | ND | ND |
| phenethyl octanoate | ND | ND | ND | ND |
| phenethyl propionate | ND | ND | ND | ND |
| propanoic acid | SC | ND | ND | ND |
| propanol | 10.0028 | 2.713 | 4.7499 | 4.1518 |
| propyl hexanoate | ND | ND | ND | ND |
| trans-2-pentenal | ND | ND | ND | ND |
| trans-2-heptenal | ND | ND | ND | ND |
| trans-2-hexen-1-al | ND | ND | ND | ND |
| trans-2-hexen-1-ol | ND | ND | ND | ND |

TABLE 3C
Additional LODs in GCMS assays

| Compound | LOD (mg/L) | Compound | LOD (mg/L) |
|---|---|---|---|
| (−)cis-rose oxide | <0.001 | ethyl undecanoate | <0.0005 |
| 1-octanol | <0.0005 | ethyl(methylthio) acetate | <0.0025 |
| 2-heptanone | <0.0025 | eucalyptol | <0.00025 |
| 2-methoxy-4-propylphenol | <0.0001 | farnesol | <0.0025 |
| 2-methylbutyl acetate | <0.01 | geraniol | <0.005 |
| 2-methylbutyl isovalerate | <0.005 | geranyl acetone | <0.005 |
| 2-nonanol | 0.0025 | heptyl acetate | <0.0025 |
| 2-undecanone | <0.0001 | isoamyl isobutyrate | <0.0025 |
| 3-carene | <0.0025 | isoamyl isovalerate | <0.0025 |
| 4-carvomenthenol | <0.0025 | isoamyl octanoate | <0.0005 |
| acetophenone | <0.0025 | isobutyl isobutyrate | <0.0025 |
| alpha ionone | <0.0005 | isobutyraldehyde | 0.0025 |
| a-pinene | <0.005 | Isobutyric Acid | 0.05 |
| benzyl acetate | <0.0025 | methyl acetate | <0.5 |
| butyric acid | 0.01 | methyl hexanoate | <0.0025 |
| carvone | <0.00025 | methyl laurate | <0.0005 |
| cis-3-hexen-1-ol | <0.02 | Methyl Octanoate | <0.0005 |
| cis-3-hexenyl acetate | <0.00025 | methyl salicylate | <0.0025 |
| decanoic acid | <0.01 | Myrcene | <0.0025 |
| delta-decalactone | <1 | octanoic acid | <0.1 |
| diethyl malate | 0.0025 (on wax); | p-anisaldehyde | 0.00025 |
| | 0.25 (on DB5 column) | | |
| diethyl succinate | <1 | Phenethyl Butyrate | <0.0001 |
| ethyl 3-hydroxyhexanoate | <0.005 | phenethyl formate | 0.005 |
| ethyl benzoate | <0.0005 | phenethyl octanoate | <0.0005 |
| ethyl levulinate | <0.0025 | phenethyl propionate | <0.0001 |
| ethyl salicylate | <0.001 | propyl acetate | <0.0025 |
| ethyl trans-2-butenoate | <0.0025 | salicylaldehyde | <0.0025 |
| ethyl trans-3-hexenoate | <0.02 | vanillyl ethyl ether | 0.0025 |

TABLE 3D
Additional LODs in GCMS assays

| | | | | | | Calibration | |
|---|---|---|---|---|---|---|---|
| Compound | RT | Quantifier | CE | Qualifier | CE | Range (mg/L) | LOD (mg/L) |
| propanal | 4.834 | 58 → 57 | 5 | 57 → 29 | 10 | 0.05-0.2 | 0.05 |
| myrcene | 8.804 | 69.0 → 41.0 | 10 | 93.0 → 77.0 | 25 | 0.05-0.2 | 0.0005 |
| heptyl acetate | 11.39 | 56.0 → 41.0 | 15 | 70.0 → 55.0 | 15 | 0.05-0.2 | 0.0002 |
| methyl octanoate | 11.509 | 74.0 → 43.0 | 15 | 87.0 → 55.0 | 15 | 0.05-0.2 | 0.00005 |
| isobutyric acid | 13.503 | 88 → 73 | 5 | 73 → 55 | 20 | 0.05-0.2 | 0.1 |
| phenethyl propionate | 17.094 | 104.0 → 78.0 | 25 | 57.0 → 42.0 | 25 | 0.01-0.04 | 0.0001 |
| phenethyl octanoate | 22.009 | 104.0 → 78.0 | 15 | 127.0 → 57.0 | 5 | 0.05-0.2 | 0.00005 |
| isobutyraldehyde | 4.911 | 72.0 → 43.0 | 5 | 72.0 → 57.0 | 5 | 0.05-0.2 | 0.001 |
| eucalyptol | 9.424 | 108.0 → 77.0 | 15 | 81.0 → 53.0 | 35 | 0.05-0.2 | 0.005 |
| isoamyl isobutyrate | 10.095 | 70.0 → 55.0 | 10 | 115.0 → 71.0 | 5 | 0.05-0.2 | 0.005 |
| acetoin | 10.468 | 88 → 45 | 5 | 45 → 29.27 | 20 | 0.05-0.2 | 0.05 |
| methyl laurate | 16.12 | 74.0 → 43.0 | 15 | 87.0 → 55.0 | 15 | 0.05-0.2 | 0.0001 |
| phenethyl butyrate | 17.85 | 104.0 → 78.0 | 25 | 71.0 → 41.0 | 10 | 0.01-0.04 | 0.0001 |
| p-anisaldehyde | 18.566 | 135 → 77 | 25 | 77 → 51 | 25 | 0.05-0.2 | 0.01 |
| methyl acetate | 5.072 | 74.0 → 43.0 | 5 | 74.0 → 59.0 | 5 | 0.05-0.2 | 0.005 |
| propyl acetate | 6.385 | 73.0 → 43.0 | 5 | 73.0 → 55.0 | 15 | 0.05-0.2 | 0.001 |
| isobutyl isobutyrate | 8.02 | 71.0 → 43.0 | 10 | 89.0 → 43.0 | 15 | 0.05-0.2 | 0.0005 |
| methyl hexanoate | 9.136 | 74.0 → 43.0 | 15 | 87.0 → 55.0 | 15 | 0.05-0.2 | 0.0004 |
| methyl decanoate | 13.96 | 74.0 → 43.0 | 25 | 87.0 → 55.0 | 25 | 0.05-0.2 | 0.00005 |
| isoamyl octanoate | 14.655 | 70.0 → 55.0 | 15 | 127.0 → 57.0 | 5 | 0.005-0.02 | 0.00005 |
| D-carvone | 15.68 | 82 → 54 | 15 | 54 → 39 | 15 | 0.005-0.02 | 0.0001 |
| methyl salicylate | 16.181 | 92.0 → 63.0 | 25 | 120.0 → 64.0 | 15 | 0.005-0.02 | 0.0005 |
| maltol | 17.956 | 126 → 71 | 20 | 71 → 43 | 10 | 0.05-0.2 | 0.05 |
| Butyraldehyde | 5.441 | 72 → 57 | 10 | 72 → 29 | 20 | 0.05-0.2 | 0.01 |
| isoamyl isovalerate | 10.454 | 85.0 → 57.0 | 5 | 115.0 → 73.0 | 10 | 0.05-0.2 | <0.00001 |
| salicylaldehyde | 15.112 | 122 → 121 | 15 | 121 → 65 | 15 | 0.05-0.2 | 0.005 |
| ethyl undecanoate | 15.53 | 101.0 → 73.0 | 5 | 88.0 → 61.0 | 5 | 0.05-0.2 | 0.0001 |
| geraniol | 16.504 | 69.0 → 41.0 | 30 | 93.0 → 51.0 | 15 | 0.05-0.2 | 0.1 |
| vanillyl ethyl ether Results | 21.382 | 137.0 → 94.0 | 20 | 182.0 → 138.0 | 5 | 0.05-0.2 | 0.001 |
| phenethyl formate | 16.094 | 104.0 → 78.0 | 15 | 91.0 → 65.0 | 15 | 0.1-0.4 | 0.1 |
| hexanoic acid | 16.408 | 73 → 55 | 25 | 60 → 42 | 25 | 0.5-2 | 0.01 |
| farnesol | 21.08 | 93.0 → 77.0 | 15 | 107.0 → 91.0 | 15 | 0.1-0.4 | 0.01 |
| linalyl butyrate | 14.887 | 93 → 77 | 10 | 80 → 79 | 15 | 0.11-0.44 | 0.0001 |
| nerol | 15.932 | 93 → 51 | 25 | 69 → 53 | 25 | 0.055-0.22 | 0.05 |
| acetaldehyde, diethyl acetal | 5.43 | 73 → 45 | 10 | 103 → 47 | 10 | n/a | |
| 2-isopropyl-3-methoxypyrazine | n/a | 107 → 51 | 35 | 77 → 51 | 25 | NDR | |
| 3,7-dimethyl-6-octanoic acid | n/a | 69 → 41 | 15 | 95 → 55 | 25 | NDR | |
| methyl dihydrojasmonate | n/a | 83 → 55 | 40 | 153 → 83 | 25 | NDR | |
| phenethyl isobutyrate | 17.03 | 105 → 79 | 15 | 104 → 78 | 15 | NDR | |
| furfuryl mercaptan | 12.234 | 114 → 53 | 35 | 81 → 53 | 35 | NDR | |
| 3-methylthio hexyl acetate | 16.094 | 115 → 81 | 5 | 190 → 115 | 10 | NDR | |
| *ug/L | | | | | | | |
| IBMP (3-Isobutyl-2- | 13.3 | 124 → 94 | 10 | 124 → 95.81 | 20 | NDR | |
| methoxypyrazine) | | | | | | | |
| dimethyl anthranilate | 18.988 | 165 → 105 | 15 | 105 → 104 | 10 | NDR | |
| ethyl-trans-3-hexenoate | 10.51 | 69.0 → 41.0 | 10 | 42.0 → 39.0 | 25 | NDR | |
| octyl acetate | 12.546 | 70 → 55 | 15 | 83 → 55 | 15 | NDR | |
| Amyl formate | 8.08 | 73 → 55 | 15 | 45 → 27 | 15 | NDR | |
| hexyl hexanoate | 14.101 | 99 → 43 | 15 | 117 → 43 | 15 | NDR | |
| Jasmine lactone | 20.421, 20.85 | 99 → 77 | 5 | 71 → 43 | 5 | NDR | |
| trans-2-pentenal | n/a | 83 → 55 | 35 | 84 → 55 | 15 | NDR | |
| hexanal | n/a | 56 → 39 | 15 | 57 → 31 | 25 | NDR | |
| 2-(methylthio)ethanol | n/a | 92 → 61 | 5 | 61 → 45 | 35 | NDR | |
| trans-2-hexen-1-ol | n/a | 57 → 31 | 25 | 67 → 41 | 35 | NDR | |
| ethyl-2-mercaptopropionate | n/a | 61 → 46 | 35 | 88 → 59 | 15 | NDR | |
| trans-2-heptenal | n/a | 83 → 55 | 30 | 70 → 41 | 15 | NDR | |
| 2,6-dimethyl-5-heptenal | n/a | 82 → 67 | 15 | 67 → 41 | 0 | NDR | |
| 3-nonen-2-one | n/a | 55 → 39 | 35 | 125 → 55 | 15 | NDR | |
| isoborneol | n/a | 95 → 55 | 25 | 110 → 95 | 5 | NDR | |
| linalyl formate | n/a | 93 → 77 | 15 | 121 → 77 | 20 | NDR | |
| furfuryl ether | n/a | 82 → 53 | 25 | 81 → 53 | 35 | NDR | |
| citronellyl acetate | n/a | 69 → 41 | 15 | 81 → 41 | 35 | NDR | |
| geranyl acetate | n/a | 69 → 41 | 10 | 93 → 77 | 10 | NDR | |
| ethyl anthranilate | n/a | 119 → 64 | 25 | 92 → 63 | 25 | NDR | |
| methyl vanillate | n/a | 182 → 122 | 15 | 151 → 65 | 15 | NDR | |
| DL-3-methyl-2-butanol | 7.949 | 73 → 45 | 10 | 45 → 27 | 15 | 0.005-0.2 | 0.005 |
| 1,4-cineole | 8.933 | 125 → 43 | 10 | 111 → 43 | 10 | 0.005-0.2 | 0.0001 |
| 2-pentylfuran | 9.483 | 138 → 81 | 10 | 81 → 53 | 10 | 0.005-0.2 | 0.00001 |
| 2-heptanol | 10.584 | 83 → 55 | 5 | 70 → 55 | 10 | 0.005-0.2 | 0.001 |
| tetrahydrolinalool | 11.956 | 73 → 55 | 10 | 69 → 41 | 10 | 0.005-0.2 | 0.005 |
| methional | 12.42 | 104.0 → 48.0 | 15 | 104.0 → 76.0 | 15 | 0.05-0.2 | 0.05 |
| decanal | 12.954 | 82 → 67 | 15 | 57 → 41 | 25 | 0.005-0.2 | 0.001 |
| Cis-5-octen-1-ol | 14.102 | 95→ 67 | 10 | 81 → 79 | 10 | 0.05-0.2 | 0.05 |
| 2-acetyl-1-methylpyrrole | 14.792 | 123 → 108 | 10 | 108 → 53 | 20 | 0.005-0.2 | 0.001 |
| cis-6-nonen-1-ol | 15.213 | 82 → 67 | 10 | 67 → 41 | 15 | 0.005-0.2 | 0.001 |
| gamma-heptalactone | 16.414 | 85 → 29 | 10 | 85 → 57 | 5 | 0.005-0.2 | 0.005 |
| gamma-octalactone | 17.5 | 100 → 43 | 15 | 85 → 29 | 15 | 0.005-0.2 | 0.001 |
| methyl-2-pyrrolyl ketone | 17.91 | 109 → 94 | 10 | 94 → 66 | 10 | 0.005-0.2 | 0.005 |
| nerolidol | 18.33 | 93 → 77 | 10 | 107 → 91 | 10 | 0.005-0.2 | 0.001 |
| thymol | 19.581 | 150 → 135 | 10 | 135 → 91 | 15 | 0.005-0.2 | 0.0001 |
| omega-pentadecalactone | 21.102 | 96 → 81 | 5 | 83 → 55 | 5 | 0.005-0.2 | 0.001 |
| gamma-dodecalactone | 22.07 | 43 → 41 | 5 | 43 → 27 | 10 | 0.005-0.2 | 0.005 |
| Methyl β-naphthyl ketone | 24.612 | 170 → 155 | 10 | 155 → 127 | 10 | 0.005-0.2 | 0.001 |
| Valeraldehyde | 6.5 | 58 → 57 | 10 | 57 → 29 | 5 | 0.005-0.2 | 0.005 |
| 2-isobutyl-4-methyl-1,3- | 8.668 | 87 → 59 | 5 | 87 → 31 | 15 | 0.005-0.2 | 0.005 |
| dioxolane | | | | | | | |
| hexyl acetate | 10.09 | 69.0 → 41.0 | 15 | 84.0 → 69.0 | 5 | 0.05-0.2 | 0.0005 |
| 2-ethyl-3-methylpyrazine | 11.904 | 122 → 121 | 10 | 121 → 93 | 15 | 0.005-0.2 | 0.001 |
| p,a-dimethylstyrene | 12.222 | 117 → 115 | 10 | 132 → 117 | 15 | 0.005-0.2 | 0.00001 |
| allyl heptanoate | 12.53 | 113 → 43 | 5 | 100 → 55 | 5 | 0.005-0.2 | 0.00001 |
| 4,5,6,7-tetrahydro-3,6- | 12.87 | 150 → 108 | 10 | 91 → 65 | 15 | 0.005-0.2 | 0.00001 |
| dimethylbenzofuran | | | | | | | |
| D-camphor | 13.445 | 152 → 108 | 5 | 108 → 93 | 5 | 0.005-0.2 | 0.001 |
| b-caryophellene | 14.285 | 133 → 105 | 15 | 93 → 77 | 15 | 0.005-0.2 | 0.0001 |
| phenylacetaldehyde | 14.66 | 120 → 91 | 10 | 91 → 65 | 15 | 0.005-0.2 | 0.001 |
| gamma-hexalactone | 15.389 | 85 → 29 | 15 | 86 → 29 | 15 | 0.005-0.2 | 0.001 |
| citral | 15.513 | 84 → 83 | 5 | 69 → 41 | 10 | 0.005-0.2 | 0.001 |
| cuminaldehyde | 16.182 | 148 → 119 | 10 | 148 → 133 | 10 | 0.005-0.2 | 0.0001 |
| benzyl alcohol | 16.9604 | 108 → 79 | 15 | 79 → 51 | 25 | 0.005-0.2 | 0.005 |
| 2-methoxy-4-methylphenol | 17.709 | 138 → 123 | 15 | 138 → 95 | 15 | 0.005-0.2 | 0.00001 |
| 2,4,6-trimethylphenol (mesitol) | 18.019 | 136 → 121 | 15 | ? | 0 | 0.005-0.2 | 0.00005 |
| 5-methyl-2-phenyl-2-hexenal | 18.836 | 117 → 115 | 15 | 104 → 78 | 10 | 0.005-0.2 | 0.001 |
| phenethyl tiglate | 19.971 | 104 → 78 | 15 | 83 → 55 | 5 | 0.005-0.2 | 0.00005 |
| gamma-undecalactone | 20.761 | 55 → 29 | 10 | 55 → 27 | 20 | 0.05-0.2 | 0.01 |
| Hexadecanol | 21.567 | 97 → 55 | 5 | 83 → 55 | 10 | 0.005-0.2 | 0.001 |
| trans-2-hexen-1-al | 9.495 | 83 → 55 | 5 | 69 → 41 | 5 | 0.03-0.13 | 0.03 |
| octanal | 10.34 | 84 → 55 | 10 | 84 → 69 | 5 | 0.0028-0.112 | 0.002 |
| 2-isopropyl-4-methyl thiazole | 11.183 | 141 → 126 | 10 | 126 → 73 | 10 | 0.005-0.2 | 0.001 |
| 4-mercapto-4-methyl-2- | 11.552 | 132 → 89 | 5 | 99 → 43 | 5 | 0.0005-0.002 | 0.0005 |
| pentanone | | | | | | | |
| 5-methyl furfural | 13.79 | 110 → 109 | 10 | 109 → 53 | 10 | 0.005-0.2 | 0.001 |
| methionyl acetate (3-methylthio- | 14.323 | 148 → 88 | 5 | 88 → 73 | 5 | 0.005-0.2 | 0.001 |
| propylacetate) | | | | | | | |
| furfuryl thioacetate | 15.868 | 156 → 81 | 15 | 81 → 53 | 15 | 0.005-0.2 | 0.001 |
| 3-phenylpropanal | 16.075 | 134 → 92 | 10 | 91 → 65 | 15 | 0.005-0.2 | 0.001 |
| Methyl cyclopentenolone | 16.45 | 112 → 84 | 5 | 112 → 56 | 10 | 0.002-0.08 | 0.005 |
| Methyl cinnamate | 18.814 | 103 → 77 | 10 | 131 → 103 | 10 | 0.0004-0.015 | 0.0001 |
| carvacrol | 19.778 | 150 → 135 | 10 | 135 → 91 | 10 | 0.0038-0.153 | 0.001 |
| methyl anthranilate | 20.42 | 151 → 119 | 10 | 119 → 92 | 5 | 0.005-0.2 | 0.001 |
| 5-ethyl-3-hydroxy-4-methyl- | 20.566 | 142 → 97 | 5 | 97 → 69 | 5 | 0.05-0.2 | 0.001 |
| 2(5H)-furanone (maple | | | | | | | |
| furanone) | | | | | | | |
| isoeugenol | 21.401 | 164 → 104 | 15 | 164 → 149 | 10 | 0.005-0.2 | 0.001 |
| indole | 22.79 | 117 → 90 | 10 | 90 → 89 | 10 | 0.0009-0.034 | 0.0001 |
| benzyl benzoate | 25.85 | 105 → 77 | 15 | 91 → 65 | 15 | 0.005-0.2 | 0.0001 |
| 1-para-menthene-8-thiol | 9.173 | 68 → 67 | 5 | 93 → 77 | 10 | n/a | 1 |
| propyl butyrate | 8.131 | 89 → 43 | 10 | 71 → 43 | 5 | 0.005-0.2 | 0.001 |
| hexyl isobutyrate | 10.874 | 89 → 43 | 5 | 71 → 43 | 10 | 0.005-0.2 | 0.00005 |
| d-fenchone | 11.852 | 69 → 41 | 5 | 81 → 41 | 15 | 0.005-0.2 | 0.005 |
| cis-3-hexenyl butyrate | 12.35 | 82 → 67 | 5 | 71 → 43 | 5 | 0.005-0.2 | 0.001 |
| 2-methoxy-3-(1-methylpropyl) | 12.898 | 124 → 94 | 10 | 138 → 123 | 10 | 0.005-0.2 | 0.001 |
| pyrazine | | | | | | | |
| cis-3-hexenyl valerate | 13.493 | 85 → 57 | 5 | 82 → 67 | 10 | 0.005-0.2 | 0.0001 |
| L-menthyl acetate | 13.654 | 138 → 95 | 5 | 123 → 81 | 5 | 0.005-0.2 | 0.00001 |
| methyl benzoate | 14.351 | 105 → 77 | 5 | 136 → 105 | 5 | 0.0062-0.246 | 0.05 |
| valencene | 15.527 | 161 → 105 | 15 | 189 → 133 | 10 | 0.005-0.2 | 0.001 |
| Perillaldehyde | 16.2 | 122 → 107 | 5 | 107 → 79 | 5 | 0.005-0.2 | 0.0001 |
| ethyl 2-trans-4-cis-decadienoate | 16.472 | 125 → 97 | 10 | 97 → 69 | 10 | 0.0042-0.1660 | 0.001 |
| Phenethyl 2-methylbutyrate | 17.846 | 107 → 78 | 15 | 105 → 79 | 15 | 0.005-0.2 | 0.00005 |
| isoamyl phenylacetate | 18.072 | 136 → 91 | 10 | 136 → 92 | 5 | 0.005-0.2 | 0.00001 |
| anisyl acetate | 19.381 | 180 → 138 | 5 | 180 → 120 | 10 | 0.006-0.24 | 0.0005 |
| isoamyl cinnamate | 21.986 | 131 → 103 | 10 | 148 → 147 | 5 | 0.005-0.2 | 0.0001 |
| vanillyl butyl ether | 23.499 | 137 → 94 | 15 | 138 → 123 | 5 | 0.005-0.2 | 0.001 |
| isobutyl propionate | 7.619 | 57 → 29 | 5 | 56 → 41 | 10 | 0.0045-0.179 | 0.0045 |
| 2,3-hexanedione | 8.112 | 114 → 71 | 5 | 71 → 43 | 5 | 0.005-0.2 | 0.005 |
| propyl isovalerate | 8.499 | 103 → 43 | 10 | 85 → 57 | 5 | 0.005-0.2 | 0.0005 |
| isobutyl butyrate | 8.555 | 71 → 43 | 5 | 89 → 43 | 15 | 0.0042-0.168 | 0.001 |
| hexyl formate | 9.362 | 84 → 55 | 10 | 69 → 41 | 5 | 0.005-0.2 | 0.005 |
| 3-heptyl acetate | 9.601 | 101 → 43 | 10 | 129 → 43 | 10 | 0.005-0.2 | 0.0005 |
| Terpinolene | 10.238 | 121 → 93 | 5 | 136 → 121 | 10 | 0.005-0.2 | 0.0005 |
| 2-octanone | 10.321 | 136 → 121 | 10 | 121 → 93 | 5 | 0.005-0.2 | 0.005 |
| hexyl propionate | 10.823 | 84 → 69 | 5 | 75 → 57 | 10 | 0.005-0.2 | 0.001 |
| 6-methyl-5-hepten-2-one | 10.865 | 108 → 93 | 5 | 111 → 43 | 15 | 0.005-0.2 | 0.0005 |
| allyl hexanoate | 11.197 | 99 → 71 | 5 | 84 → 69 | 5 | 0.005-0.2 | 0.0001 |
| hexyl butyrate | 11.773 | 71 → 43 | 5 | 89 → 43 | 10 | 0.005-0.2 | 0.0005 |
| hexyl 3-methylbutanoate | 12.128 | 103 → 43 | 15 | 85 → 57 | 5 | 0.005-0.2 | 0.0001 |
| benzyl formate | 14.955 | 136 → 108 | 5 | 90 → 89 | 10 | 0.005-0.2 | 0.005 |
| butyl butyryllactate | 15.407 | 71 → 43 | 5 | 71 → 41 | 15 | 0.005-0.2 | 0.0001 |
| methionyl butyrate | 15.923 | 88 → 73 | 5 | 73 → 45 | 10 | 0.005-0.2 | 0.0001 |
| benzyl propionate | 16.052 | 164 → 108 | 5 | 108 → 79 | 15 | 0.005-0.2 | 0.0001 |
| geranyl propionate | 16.246 | 93 → 77 | 15 | 69 → 41 | 10 | 0.005-0.2 | 0.0001 |
| benzyl butyrate | 16.822 | 108 → 79 | 5 | 91 → 65 | 15 | 0.005-0.2 | 0.0001 |
| geranyl butyrate | 16.979 | 93 → 77 | 10 | 69 → 41 | 10 | 0.005-0.2 | 0.0001 |
| anisyl alcohol | 20.608 | 138 → 137 | 10 | 138 → 109 | 5 | 0.005-0.2 | 0.0005 |
| anisyl butyrate | 20.801 | 121 → 77 | 15 | 138 → 109 | 5 | 0.005-0.2 | 0.0005 |
| dihydrocoumarin | 20.995 | 148 → 120 | 10 | 120 → 91 | 15 | 0.005-0.2 | 0.001 |
| delta-dodecalactone | 22.632 | 99 → 71 | 5 | 99 → 43 | 10 | 0.005-0.2 | 0.001 |
| 2-methoxycinnamaldehyde | 22.756 | 162 → 131 | 5 | n/a | n/a | 0.002-0.074 | 0.001 |
| 3-mercaptohexylacetate | 15.4 | 116 → 55 | 25 | 101 → 59 | 25 | 0.01-0.04 | 0.001 |
| Nonanoic acid | 19.346 | 73 → 55 | 15 | 60 → 42 | 15 | 0.05-0.2 | 0.01 |
| isovaleric acid | 14.616 | 87 → 41 | 15 | 60 → 42 | 25 | 0.05-0.2 | 0.01 |
| ethyl(methylthio) acetate | 12.391 | 134.0 → 88.0 | 5 | 88.0 → 61.0 | 5 | 0.05-0.2 | 0.01 |
| Valeric acid | 15.329 | 73 → 55 | 15 | 60 → 42 | 15 | 0.05-0.2 | 0.01 |
| propanoic acid | 13.168 | 73 → 55 | 10 | 74 → 45 | 35 | 0.05-0.2 | 0.01 |
| octanoic acid | 18.434 | 73 → 55 | 25 | 60 → 42 | 25 | 0.05-0.2 | 0.01 |

TABLE 4B
VOCs in reference Moscato

| Round 2 assays | 1 | 2 | 3 | Notes |
|---|---|---|---|---|
| (−)alpha-pinene | BC | BC | BC | Detected but below curve |
| (−)-beta-pinene | 0.001892155 | 0.001715072 | 0.002349202 | |
| (−)-cis-rose oxide | 0.000449433 | 0.000466262 | 0.000549681 | Measured but below the curve |
| 1,1-diethoxyethane | BC | BC | BC | Detected below the curve |
| 1-decanol | 0.003753218 | 0.002998288 | 0.003365339 | |
| 1-octanol | 0.002398118 | 0.002412743 | 0.002821679 | |
| 1-octen-3-ol | 0.002419445 | 0.002242089 | 0.001719782 | |
| 2,3-pentadione | 0.012463133 | 0.013358715 | 0.016290188 | |
| 2-heptanone | BC | BC | BC | Detected below the curve |
| 2-mcthoxy-4-propylphenol | 0.000124026 | 0.000110236 | 0.000108634 | Measured but below the curve |
| 2-methyl-1-butanol | 27.22852537 | 20.09513892 | 24.18764953 | |
| 2-methylbutyl acetate | 0.008545109 | 0.008308495 | 0.009521471 | |
| 2-methylbutyl isovalerate | BC | BC | BC | Detected below the curve |
| 2-methylbutyr aldehyde | 0.001318454 | 0.002261234 | ND | |
| 2-nonanol | SC | SC | SC | Bad curves |
| 2-nonanone | 0.00064378 | 0.00068446 | 0.000490382 | |
| 2-phenylethanol | 27.71891227 | 27.31803315 | 27.73553841 | Above the cune |
| 2-undecanone | 6.98851E−05 | 6.57321E−05 | 6.68176E−05 | Measured but below the curve |
| 3-carene | BC | BC | BC | Detected below the curve |
| 4-carvomenthenol | BC | BC | BC | Detected below the curve |
| 4-ethyl guaiacol | 0.347412368 | 0.345910146 | 0.343918945 | Measured but below the curve |
| 4-ethyl phenol | 0.002992436 | 0.002836355 | 0.002762316 | |
| acetophenone | BC | BC | BC | Detected below the curve |
| alpha ionone | 0.000386261 | 0.000341349 | 0.000348424 | Measured but below the curve |
| alpha terpineol | 0.16794239 | 0.163025192 | 0.171765935 | |
| amyl alcohol | NF | NF | NF | NF |
| amyl butyrate | BC | BC | BC | Detected below the curve |
| benzaldehyde | BC | BC | BC | Detected below the curve |
| benzyl acetate | NF | NF | NF | NF |
| beta-ionone | 9.59876E−05 | 9.45855E−05 | 9.04825E−05 | Measured but below the curve |
| butanol | 0.324946065 | 0.228399036 | ND | |
| butyl acetate | BC | BC | BC | Detected below the curve |
| carvone | NF | NF | NF | NF |
| cinnamaldehyde | 9.99824E−05 | 9.22496E−05 | 0.000117125 | |
| cis-3-hexen-1-ol | 0.049388653 | 0.045126991 | 0.050030327 | |
| cis-3-hexenyl acetate | 0.007928091 | 0.007366221 | 0.009934799 | Above the curve |
| cis-whiskey lactone | 0.005791638 | 0.003812944 | 0.003639476 | Measured but below the curve |
| citronellol | 0.004808149 | 0.004822645 | 0.003374777 | |
| diethyl malate | 34.48890462 | 31.63642633 | 32.03738635 | Above the curve |
| ethyl 3-hydroxyhexanoate | 0.002553921 | 0.002568911 | 0.002609872 | Measured but below the curve |
| ethyl acetate | 24.70768015 | 27.15990791 | 23.51440106 | |
| ethyl benzoate | 6.68237E−05 | 6.47061E−05 | 6.33772E−05 | Measured but below the curve |
| ethyl butanoate | 0.070013523 | 0.061772749 | 0.047458729 | |
| ethyl cinnamate | 3.20106E−05 | 3.01225E−05 | 2.9947E−05 | Measured but below the curve |
| ethyl decanoate | 0.285747423 | 0.285683617 | 0.259995219 | |
| ethyl heptanoate | BC | BC | BC | Detected below the curve |
| ethyl hexanoate | 0.258280699 | 0.245064623 | 0.305386967 | Above the curve |
| ethyl isobutyrate | 0.151177356 | 0.139857008 | 0.148534019 | Above the curve |
| ethyl isovalerate | 0.022632971 | 0.022171187 | 0.018955706 | Above the curve |
| ethyl lactate | 8.252388398 | 7.322633375 | ND | |
| ethyl laurate | 0.003610532 | 0.006781488 | ND | Measured but below the curve |
| ethyl levulinate | 0.003889749 | ND | 0.003971232 | |
| ethyl myristate | 0.000191394 | 5.59587E−05 | 9.99838E−05 | Detected below the curve |
| ethyl nonanoate | BC | BC | BC | Detected below the curve |
| ethyl octanoate | 1.06744332 | 1.135456398 | 0.501912514 | |
| ethyl phenyl acetate | 0.002440098 | 0.002305016 | 0.00207629 | |
| ethyl propionate | 0.07551169 | 0.061985894 | 0.052532184 | |
| ethyl salicylate | BC | BC | BC | Detected below the curve |
| ethyl trans-2-butenoate | 0.002307992 | 0.002442044 | 0.002624217 | Measured but below the curve |
| ethyl trans-3-hexenoate | BC | BC | BC | detected but below the curve |
| ethyl undecanoate | BC | BC | BC | Detected below the curve |
| ethyl valerate | 0.000589868 | 0.000566997 | 0.000432847 | Measured but below the curve |
| ethyl(methylthio) acetate | BC | BC | BC | Detected below the curve |
| ethyl-2-methylbutyrate | BC | BC | BC | Detected below the curve |
| eucalyptol | 0.000352756 | 0.000334686 | 0.000468757 | |
| eugenol | 0.005264017 | 0.005217056 | 0.005235575 | Measured but below the curve |
| farnesol | 0.003400752 | 0.003406477 | 0.003403629 | Detected below the curve |
| fufural | 3.916579419 | 3.406345104 | 3.967095026 | Above the curve |
| gamma-decalactone | 0.005846598 | 0.005829782 | 0.005862139 | |
| gamma-nonalactone | 0.0030033 | 0.003021643 | 0.003001943 | Measured but below the curve |
| gamma-terpinene | 0.000765981 | 0.000837802 | ND | |
| geraniol | 0.005390707 | 0.005364866 | 0.004862677 | |
| geranyl acetone | 0.001492267 | 0.001487225 | 0.001471223 | Measured but below the curve |
| guaiacol | 0.001541856 | 0.001368694 | 0.001371202 | Measured but below the curve |
| heptyl acetate | BC | BC | BC | Detected below the curve |
| hexanol | 0.534931643 | 0.446284222 | 0.427908192 | |
| isoamyl acetate | 0.114420284 | 0.100715094 | 0.127341387 | Above the curve |
| isoamyl alcohol | BC | BC | BC | Detected below the curve |
| isoamyl hexanoate | BC | BC | BC | Detected below the curve |
| isoamyl isobutyrate | BC | BC | BC | Detected below the curve |
| isoamyl isovalerate | NF | NF | NF | NF |
| isoamyl octanoate | BC | BC | BC | Detected below the curve |
| isobutyl acetate | 0.003146512 | 0.002530398 | 0.003168992 | Omit pt 3 |
| isobutyl alcohol | 1.848997646 | 15.75945523 | ND | |
| isobutyl isobutyrate | BC | BC | BC | Detected below the curve |
| isobutyraldehyde | 0.000715638 | 0.000380317 | 0.001763262 | Measured but below the curve |
| isovaleraldehyde | 0.002187486 | 0.003000257 | 0.003187493 | |
| limonene | 0.000382765 | 0.000384636 | 0.000298845 | |
| linalool | 0.102350127 | 0.108132412 | 0.101245113 | Above the curve |
| linalool oxide | 0.583418772 | 0.509669117 | 0.425229285 | Above the curve |
| linalyl acetate | 0.001219178 | 0.001180024 | 0.001124153 | |
| methional | 0.001200728 | 0.001155158 | 0.001145768 | Measured but below the curve |
| methyl acetate | 0.046656793 | ND | 0.043755887 | |
| methyl hexanoate | BC | BC | BC | Detected below the curve |
| methyl laurate | 2.46334E−05 | BC | BC | Detected below the curve |
| methyl octanoate | BC | BC | BC | Detected below the curve |
| methyl salicylate | 0.001907274 | 0.001842859 | 0.001794303 | Measured but below the curve |
| myrcene | BC | BC | BC | Detected below the curve |
| p-anisaldehyde | NF | NF | NF | NF |
| p-cresol | 0.004252195 | 0.004337536 | 0.00433469 | Measured but below the curve |
| p-cymene | BC | BC | BC | Detected below the curve |
| phenethyl acetate | 0.00860563 | 0.00764275 | 0.008215134 | |
| phenethyl butyrate | 0.000825128 | 0.000803692 | 0.000808073 | |
| phenethyl formate | SC | SC | SC | Bad curves |
| phenethyl octanoate | 8.0688E−05 | 7.82664E−05 | 7.93176E−05 | Measured but below the curve |
| phenethyl propionate | 9.96408E−05 | 9.32211E−05 | 9.2439E−05 | Measured but below the curve |
| propanol | 11.6301144 | 8.909499959 | ND | |
| propyl acetate | 0.003979912 | 0.00332731 | 0.00343983 | |
| salicylaldehyde | 0.001 | 0.0008 | 0.0008 | Measured but below the curve |
| vanillyl ethyl ether | NF | NF | NF | NF |

BC = below the standard curve
ND = not done
NF = not found
SC = bad standard curve
*Detected, but below the curve

TABLE 4C
VOCs in reference Moscato

| Round 3 assays Compound (mg/L) | 1A | 1B | 2A | 2B |
|---|---|---|---|---|
| (1R)-(−)-myrtenal | 0.00E+00 | ND (not determined) | 0.00E+00 | ND |
| 1,4-cineole | 0.00E+00 | ND | 0.00E+00 | ND |
| 1-octanol (nat) | 1.79E−02 | ND | 1.04E−02 | ND |
| 1-octen-3-ol | 3.60E−03 | ND | 2.40E−03 | ND |
| 1-para-menthene-8-thiol | 0.00E+00 | ND | 0.00E+00 | ND |
| 2,3-hexanedione | 0.00E+00 | ND | 0.00E+00 | ND |
| 2,3-pentadione | 0.00E+00 | ND | 0.00E+00 | ND |
| 2,4,6-trimethylphenol (mesitol) | 2.50E−03 | ND | 2.30E−03 | ND |
| 2-acetyl-1-methylpyrrole | 0.00E+00 | ND | 0.00E+00 | ND |
| 2-ethyl-3(5 or 6)-dimethylpyrazine | 0.00E+00 | ND | 0.00E+00 | ND |
| 2-ethyl-3-methylpyrazine | 0.00E+00 | ND | 0.00E+00 | ND |
| 2-heptanol | 0.00E+00 | ND | 0.00E+00 | ND |
| 2-heptanone | 2.70E−03 | ND | 0.00E+00 | ND |
| 2-isobutyl-3-methoxypyrazine | 0.00E+00 | ND | 0.00E+00 | ND |
| 2-isobutyl-4-methyl-1,3-dioxolane | 0.00E+00 | ND | 0.00E+00 | ND |
| 2-isopropyl-4-methyl thiazole | 0.00E+00 | ND | 0.00E+00 | ND |
| 2-methoxy-3-(1-methylpropyl) pyrazine | 0.00E+00 | ND | 0.00E+00 | ND |
| 2-Methoxy-4-methylphenol (creosol) | 0.00E+00 | ND | 0.00E+00 | ND |
| 2-methoxy-4-propylphenol | 0.00E+00 | ND | 0.00E+00 | ND |
| 2-methoxycinnamaldehyde | 0.00E+00 | ND | 0.00E+00 | ND |
| 2-methyl-1-butanol | 2.96E+01 | ND | 4.04E+01 | ND |
| 2-methylbutyl acetate | 1.41E−02 | ND | ND | ND |
| 2-methylbutyl isovalerate | 0.00E+00 | ND | 0.00E+00 | ND |
| 2-methylbutyraldehyde | 7.50E−02 | ND | 6.12E−02 | ND |
| 2-nonanol | 0.00E+00 | ND | 0.00E+00 | ND |
| 2-nonanone | 0.00E+00 | ND | 0.00E+00 | ND |
| 2-octanone | 0.00E+00 | ND | 0.00E+00 | ND |
| 2-pentylfuran | 0.00E+00 | ND | 0.00E+00 | ND |
| 2-undecanone | 7.00E−04 | ND | 0.00E+00 | ND |
| 3-carene | 1.80E−02 | ND | 0.00E+00 | ND |
| 3-heptyl acetate | 0.00E+00 | ND | 0.00E+00 | ND |
| 3-mercaptohexyl acetate | detected, below LOQ | ND | detected, below LOQ | ND |
| 3-methyl-1-pentanol | 1.12E−02 | ND | 3.05E−02 | ND |
| 3-methylthio hexyl acetate (ug/L) | 0.00E+00 | ND | 0.00E+00 | ND |
| 3-phenylpropanal | 0.00E+00 | ND | 0.00E+00 | ND |
| 4,5,6,7-tetrahydro-3,6-dimethylbenzofuran | 0.00E+00 | ND | 0.00E+00 | ND |
| 4-carvomenthenol | 9.30E−03 | ND | 7.60E−03 | ND |
| 4-Ethyl Guaiacol | 0.00E+00 | ND | 0.00E+00 | ND |
| 4-Ethyl Phenol | 0.00E+00 | ND | 0.00E+00 | ND |
| 4-mercapto-4-methyl-2-pentanone | 0.00E+00 | ND | 0.00E+00 | ND |
| 5-ethyl-3-hydroxy-4-methyl-2(5H)-furanone | 1.07E−01 | ND | 6.18E−02 | ND |
| (maple furanone) | | | | |
| 5-methyl furfural | 9.80E−03 | ND | 2.54E−02 | ND |
| 5-methyl-2-phenyl-2-hexenal | 0.00E+00 | ND | 0.00E+00 | ND |
| 6,10-dimethyl-5,9-undecadien-2-one | 0.00E+00 | ND | 0.00E+00 | ND |
| (geranyl acetone) | | | | |
| 6-methyl-5-hepten-2-one | 1.39E−03 | ND | 1.19E−03 | ND |
| acetal (1,1-diethoxyethane) | 0.00E+00 | ND | 0.00E+00 | ND |
| acetoin | 0.00E+00 | ND | 0.00E+00 | ND |
| acetophenone | 1.30E−03 | ND | 9.00E−04 | ND |
| a-ionone | 0.00E+00 | ND | 0.00E+00 | ND |
| allyl heptanoate | 0.00E+00 | ND | 0.00E+00 | ND |
| allyl hexanoate | 0.00E+00 | ND | 0.00E+00 | ND |
| amyl alcohol | 0.00E+00 | ND | 1.08E−01 | ND |
| amyl butyrate | 1.57E−02 | ND | 7.90E−03 | ND |
| anisyl acetate | 0.00E+00 | ND | 0.00E+00 | ND |
| anisyl alcohol | 0.00E+00 | ND | 0.00E+00 | ND |
| anisyl butyrate | 0.00E+00 | ND | 0.00E+00 | ND |
| a-pinene | 0.00E+00 | ND | 0.00E+00 | ND |
| b-caryophellene | 5.90E−03 | ND | 6.30E−03 | ND |
| benzaldehyde | 1.08E−02 | ND | 7.10E−03 | ND |
| benzyl acetate | 0.00E+00 | ND | 0.00E+00 | ND |
| benzyl alcohol | 4.72E−02 | ND | 2.10E−02 | ND |
| benzyl benzoate | 0.00E+00 | ND | 0.00E+00 | ND |
| benzyl butyrate | 0.00E+00 | ND | 0.00E+00 | ND |
| benzyl formate | 0.00E+00 | ND | 0.00E+00 | ND |
| benzyl propionate | 0.00E+00 | ND | 0.00E+00 | ND |
| beta-ionone | 0.00E+00 | ND | 0.00E+00 | ND |
| beta-pinene | 6.70E−03 | ND | 2.70E−03 | ND |
| butyl acetate | 0.00E+00 | ND | 0.00E+00 | ND |
| butyl alcohol | 1.85E−01 | 1.17E−01 | 1.81E−01 | 1.14E−01 |
| butyl butyryllactate | 0.00E+00 | ND | 0.00E+00 | ND |
| butyl formate | 4.23E−01 | ND | 2.94E−01 | ND |
| butyraldehyde | 0.00E+00 | ND | 0.00E+00 | ND |
| butyric acid | 2.20E−03 | ND | 2.10E−03 | ND |
| carvacrol | 0.00E+00 | ND | 0.00E+00 | ND |
| Cinnamaldehyde | 3.00E−04 | ND | 4.00E−04 | ND |
| cis-3-hexen-l-ol | 5.58E−02 | ND | 1.27E−01 | ND |
| cis-3-hexenyl acetate | 0.00E+00 | ND | 0.00E+00 | ND |
| cis-3-hexenyl butyrate | 0.00E+00 | ND | 0.00E+00 | ND |
| cis-3-hexenyl caproate | 0.00E+00 | ND | 0.00E+00 | ND |
| cis-3-hexenyl valerate | 0.00E+00 | ND | 0.00E+00 | ND |
| Cis-5-octen-l-ol | 0.00E+00 | ND | 0.00E+00 | ND |
| cis-6-nonen-l-ol | 0.00E+00 | ND | 0.00E+00 | ND |
| citral | 7.90E−03 | ND | 7.50E−03 | ND |
| citronellol | 0.00E+00 | ND | 0.00E+00 | ND |
| cuminaldehyde | 0.00E+00 | ND | 0.00E+00 | ND |
| damascenone | 0.00E+00 | ND | 0.00E+00 | ND |
| D-camphor | 1.62E−02 | ND | 1.93E−02 | ND |
| D-carvone | 0.00E+00 | ND | 0.00E+00 | ND |
| decanal | 0.00E+00 | ND | 0.00E+00 | ND |
| decanoic acid | 1.78E−02 | ND | 6.70E−03 | ND |
| decanol | 3.20E−03 | ND | 2.10E−03 | ND |
| delta-decalactone | 2.60E−03 | ND | 3.00E−03 | ND |
| delta-dodecalactone | 0.00E+00 | ND | 0.00E+00 | ND |
| d-fenchone | 0.00E+00 | ND | 0.00E+00 | ND |
| diethyl malate | ND | ND | 7.17E−01 | ND |
| dihydrocoumarin | 0.00E+00 | ND | 0.00E+00 | ND |
| DL-3-methyl-2-butanol | 2.54E−02 | ND | 0.00E+00 | ND |
| ethyl (methylthio) acetate | 0.00E+00 | ND | 0.00E+00 | ND |
| ethyl 2-methylbutyrate | 2.20E−03 | ND | 3.70E−03 | ND |
| ethyl 2-trans-4-cis-decadienoate | 0.00E+00 | ND | 0.00E+00 | ND |
| ethyl 3-hydroxyhexanoate | 0.00E+00 | ND | 0.00E+00 | ND |
| ethyl acetate | 1.75E+01 | ND | 1.47E+01 | ND |
| ethyl benzoate | 4.20E−03 | ND | 0.00E+00 | ND |
| Ethyl butyrate (ethyl butanoate) | 2.51E−01 | ND | 1.87E−01 | ND |
| ethyl cinnamate | 0.00E+00 | ND | 0.00E+00 | ND |
| ethyl decanoate | ND | ND | 1.44E+00 | ND |
| ethyl heptanoate | 0.00E+00 | ND | 0.00E+00 | ND |
| ethyl hexanoate | 4.27E−01 | ND | 5.25E−01 | ND |
| ethyl isobutyrate | 1.13E−01 | ND | 1.39E−01 | ND |
| ethyl isovalerate | 0.00E+00 | ND | 3.62E−02 | ND |
| ethyl lactate | ND | ND | 5.13E+00 | ND |
| ethyl laurate | 3.70E−02 | ND | 9.00E−02 | ND |
| ethyl levulinate | 2.90E−03 | ND | 0.00E+00 | ND |
| ethyl myristate | 1.47E−02 | ND | 1.42E−02 | ND |
| ethyl nonanoate | 0.00E+00 | ND | 2.10E−03 | ND |
| ethyl octanoate | 7.08E−01 | ND | ND | ND |
| ethyl phenylacetate | 3.90E−03 | ND | 3.30E−03 | ND |
| ethyl propionate | 5.80E−02 | ND | 4.63E−02 | ND |
| ethyl salicylate | 1.20E−03 | ND | 0.00E+00 | ND |
| ethyl trans-2-butenoate | 5.30E−03 | ND | 3.50E−03 | ND |
| ethyl undecanoate | 7.20E−03 | ND | 7.30E−03 | ND |
| Ethyl Valerate | 0.00E+00 | ND | 0.00E+00 | ND |
| ethyl-trans-3-hexenoate | 0.00E+00 | ND | 0.00E+00 | ND |
| eucalyptol | 0.00E+00 | ND | 0.00E+00 | ND |
| eugenol | 4.00E−04 | ND | 1.00E−04 | ND |
| farnesol | 0.00E+00 | ND | 0.00E+00 | ND |
| furfural | ND | ND | 2.55E−01 | ND |
| furfuryl thioacetate | 0.00E+00 | ND | 0.00E+00 | ND |
| gamma-decalactone | 0.00E+00 | ND | 0.00E+00 | ND |
| gamma-dodecalactone | 0.00E+00 | ND | 0.00E+00 | ND |
| gamma-heptalactone | 0.00E+00 | ND | 0.00E+00 | ND |
| gamma-hexalactone | 0.00E+00 | ND | 2.33E−02 | ND |
| gamma-nonalactone | 0.00E+00 | ND | 0.00E+00 | ND |
| gamma-octalactone | 0.00E+00 | ND | 0.00E+00 | ND |
| gamma-terpinene | 2.08E−02 | ND | 2.05E−02 | ND |
| gamma-undecalactone | 3.35E−02 | ND | 1.92E−02 | ND |
| geraniol | ND | ND | 3.48E−01 | ND |
| geranyl butyrate | 0.00E+00 | ND | 0.00E+00 | ND |
| geranyl propionate | 0.00E+00 | ND | 0.00E+00 | ND |
| guaiacol | 0.00E+00 | ND | 0.00E+00 | ND |
| heptyl acetate | 0.00E+00 | ND | 0.00E+00 | ND |
| Hexadecanol | 1.70E−02 | ND | 8.00E−03 | ND |
| hexanoic acid | 1.66E−01 | ND | 9.93E−02 | ND |
| hexyl 3-methylbutanoate | 0.00E+00 | ND | 0.00E+00 | ND |
| hexyl acetate | 7.30E−03 | ND | 5.20E−03 | ND |
| Hexyl alcohol (hexanol) | 4.40E−01 | ND | 5.70E−01 | ND |
| hexyl butyrate | 0.00E+00 | ND | 0.00E+00 | ND |
| hexyl formate | 0.00E+00 | ND | 0.00E+00 | ND |
| hexyl isobutyrate | 0.00E+00 | ND | 0.00E+00 | ND |
| hexyl propionate | 0.00E+00 | ND | 0.00E+00 | ND |
| indole | 0.00E+00 | ND | 0.00E+00 | ND |
| isoamyl acetate | 2.53E−01 | ND | 4.88E−01 | ND |
| isoamyl alcohol | 5.10E+01 | ND | 5.30E+01 | ND |
| isoamyl cinnamate | 0.00E+00 | ND | 0.00E+00 | ND |
| isoamyl hexanoate | 2.00E−04 | ND | 4.00E−04 | ND |
| isoamyl isobutyrate | 0.00E+00 | 4.29E−05 | 0.00E+00 | 0.00E+00 |
| isoamyl isovalerate | 6.90E−03 | ND | 0.00E+00 | ND |
| isoamyl octanoate | 2.90E−03 | ND | 5.90E−03 | ND |
| isoamyl phenylacetate | 0.00E+00 | ND | 0.00E+00 | ND |
| isobutyl acetate | 8.50E−03 | ND | 7.90E−03 | ND |
| isobutyl butyrate | 0.00E+00 | ND | 0.00E+00 | ND |
| isobutyl isobutyrate | 0.00E+00 | ND | 0.00E+00 | ND |
| isobutyl propionate | 0.00E+00 | ND | 0.00E+00 | ND |
| isobutyraldehyde | 0.00E+00 | ND | 0.00E+00 | ND |
| isoeugenol | 0.00E+00 | ND | 0.00E+00 | ND |
| isovaleraldehyde | 8.78E−02 | ND | 1.26E−01 | ND |
| L-Carvone | 0.00E+00 | ND | 0.00E+00 | ND |
| linalool oxide | 1.23E−01 | ND | 1.95E−01 | ND |
| linalyl acetate | 1.09E−01 | 1.28E−02 | 9.52E−02 | 1.35E−02 |
| linalyl butyrate | 0.00E+00 | ND | 0.00E+00 | ND |
| 1-limonene | 5.50E−03 | ND | 5.60E−03 | ND |
| 1-linalool | 3.61E−02 | ND | 4.75E−02 | ND |
| L-menthyl acetate | 0.00E+00 | ND | 0.00E+00 | ND |
| L-Rose Oxide | 0.00E+00 | ND | 0.00E+00 | ND |
| Maltol | 0.00E+00 | ND | 0.00E+00 | ND |
| methional | 0.00E+00 | ND | 0.00E+00 | ND |
| methionyl acetate (3-methylthio-propylacetate) | 0.00E+00 | ND | 0.00E+00 | ND |
| methionyl butyrate | 0.00E+00 | ND | 0.00E+00 | ND |
| methyl acetate | 1.12E−01 | ND | 8.79E−02 | ND |
| Methyl anthranilate | 0.00E+00 | ND | 0.00E+00 | ND |
| methyl benzoate | 0.00E+00 | ND | 0.00E+00 | ND |
| Methyl cinnamate | 0.00E+00 | ND | 0.00E+00 | ND |
| Methyl cyclopentenolone | 4.28E−02 | ND | 2.97E−02 | ND |
| methyl decanoate | 3.90E−03 | ND | 4.20E−03 | ND |
| methyl hexanoate | 0.00E+00 | ND | 2.60E−03 | ND |
| methyl laurate | 0.00E+00 | ND | 0.00E+00 | ND |
| Methyl Octanoate | 4.20E−03 | ND | 3.70E−03 | ND |
| methyl salicylate | 0.00E+00 | ND | 5.00E−04 | ND |
| Methyl β-naphthyl ketone | 2.37E−02 | ND | 0.00E+00 | ND |
| methyl-2-pyrrolyl ketone | 0.00E+00 | ND | 0.00E+00 | ND |
| Myrcene | 0.00E+00 | ND | 0.00E+00 | ND |
| nerol | 0.00E+00 | ND | 0.00E+00 | ND |
| nerolidol | 2.20E−03 | ND | 0.00E+00 | ND |
| nonanal | 6.90E−03 | ND | 1.41E−02 | ND |
| octanal | 0.00E+00 | ND | 0.00E+00 | ND |
| omega-pentadecalactone | 0.00E+00 | ND | 0.00E+00 | ND |
| p,a-dimethylstyrene | 2.00E−04 | ND | 3.00E−04 | ND |
| p-anisaldehyde | 0.00E+00 | ND | 0.00E+00 | ND |
| p-cresol | 0.00E+00 | ND | 0.00E+00 | ND |
| p-cymene | 0.00E+00 | ND | 0.00E+00 | ND |
| Perillaldehyde | 0.00E+00 | ND | 0.00E+00 | ND |
| Phenethyl 2-methylbutyrate | 0.00E+00 | ND | 0.00E+00 | ND |
| Phenethyl Acetate (2-phenylethylacetate) | 4.95E−02 | ND | 7.33E−02 | ND |
| phenethyl alcohol (2-phenylethanol) | 3.54E+01 | ND | 6.05E+01 | ND |
| Phenethyl Butyrate | 0.00E+00 | ND | 0.00E+00 | ND |
| phenethyl formate | 0.00E+00 | ND | 0.00E+00 | ND |
| phenethyl octanoate | 0.00E+00 | ND | 0.00E+00 | ND |
| phenethyl propionate | 0.00E+00 | ND | 0.00E+00 | ND |
| phenethyl tiglate | 0.00E+00 | ND | 0.00E+00 | ND |
| phenylacetaldehyde | 5.93E−02 | ND | 3.55E−02 | ND |
| phenylacetaldehyde dimethyl acetal | 0.00E+00 | ND | 0.00E+00 | ND |
| propanal | 0.00E+00 | ND | 0.00E+00 | ND |
| propyl acetate | 0.00E+00 | ND | 0.00E+00 | ND |
| propyl butyrate | 2.16E−03 | ND | 2.15E−03 | ND |
| propyl isovalerate | 0.00E+00 | ND | 0.00E+00 | ND |
| salicylaldehyde | 0.00E+00 | ND | 0.00E+00 | ND |
| Terpinolene | 1.78E−03 | ND | 2.20E−03 | ND |
| tetrahydrolinalool | 0.00E+00 | ND | 0.00E+00 | ND |
| thymol | 0.00E+00 | ND | 0.00E+00 | ND |
| trans-2-Hexen-1-al | 0.00E+00 | ND | 0.00E+00 | ND |
| valencene | 0.00E+00 | ND | 0.00E+00 | ND |
| valeraldehyde | 0.00E+00 | ND | 0.00E+00 | ND |
| vanillyl butyl ether | 0.00E+00 | ND | 0.00E+00 | ND |
| vanillyl ethyl ether | 0.00E+00 | ND | 0.00E+00 | ND |
| whiskey lactone | 0.00E+00 | ND | 0.00E+00 | ND |

LC-MS was used to measure the levels of various non-volatile compounds in several reference Moscato samples, according to the following method.

All analyses were performed on a Thermo Ultimate 3000 Ultra-Performance Liquid Chromatograph (UPLC) coupled with a Thermo Scientific Q-Exactive high resolution mass spectrometer (MS). XCalibur software was used for data acquisition, and the mass spectrometer instrument parameters were as follows for all methods:

Polarity: positive or negative mode, as indicated for each method

Resolution: 70,000

Scan range: 60-900 m/z for all methods with the exception of the lipid method, which is 134-2000 m/z

Isolation window: 1.5 m/z

MS/MS collision energy: 30

Preparation of Analytical Standards:

Stock solutions at a concentration of 1 mg/mL were made for each compound in 50% methanol. Serial dilutions were then made of each compound to create a 7-point standard curve, ranging from 10 ng/mL to 20 μg/mL. Standard curves were run in combinations of 7-12 compounds from each category per set, so long as there were no overlaps in retention time, which would have hindered quantitation.

Retention times were pre-determined for each compound by running the analytical standard at a 20 μg/mL dilution, and identifying the compound based on its accurate mass.

In all cases, five μL of each standard mix was injected through the autosampler and LC to the MS. Separation took place on a chromatographic column that was specific to each class of compounds. The conditions for each chromatographic method are described below, including the column, mobile phase and gradient used for each method.

Several types of columns were used for the different classes of compounds, as indicated in TABLE 5.

TABLE 5
List of compounds quantified by each method

| HILIC positive | HILIC negative | Omega negative | C18 positive | C18 negative | C18 positive |
|---|---|---|---|---|---|
| methionine | rhamnose | tartaric acid | quinic acid | rutin | lauric acid |
| histidine | glucose | citric acid | polydatin | quercetin | palmitic acid |
| lysine | arabinose | lactic acid | acetovanillone | salicylic acid | |
| serine | mannitol | 3,4-dihydroxybenzoic acid | epicatechin gallate | indole-3-lactic acid | |
| leucine | fructose | gallic acid | vanillic acid | sinapinic acid | |
| isoleucine | ribose | glucuronic acid | syringic acid | epicatechin | |
| phenylalanine | arabitol | fumaric acid | caffeic acid | catechin | |
| aspartic acid | inositol | ferulic acid | coumaric acid | resveratrol | |
| tyrosine | fucose | malic acid | cinnamic acid | propyl gallate | |
| glycine | mannose | galacturonic acid | syringaldehyde | herperetin | |
| γ-aminobutyric acid | xylose | 2-isopropylmalic acid | pantothenic acid | trans-ferulic acid | |
| pyridoxine | sorbitol | 2-furoic acid | vanillin | adipic acid | |
| glucosamine | galactose | pyruvic acid | trans-4-hydroxy proline | methyl gallate | |
| choline | | succinic acid | L-citrulline | ellagic acid | |
| arginine | | | tryptamine | | |
| valine | | | tyramine | | |
| proline | | | adenine | | |
| alanine | | | guanine | | |
| cysteine | | | acetylcholine | | |
| asparagine | | | kynurenic acid | | |
| glutamic acid | | | acetanilide | | |
| tryptophan | | | 4-methylumbelliferone | | |
| ornithine | | | felbamate | | |
| glutamine | | | sorbic acid | | |
| threonine | | | | | |
| carnitine | | | | | |

Quantitation of Amino Acids and Similar Polar Compounds:

A HILIC (hydrophilic interaction liquid chromatography) column was used to assess polar compounds that can retain a positive charge. The mobile phase used with this column included A: H₂O+5 mM Ammonium Acetate+0.1% TFA (trifluoroacetic acid), and B: 90/10 ACN (Acetonitrile)/H₂O+5 mM Ammonium Acetate+0.1% TFA. Each chromatographic run was 27.5 minutes long, and the column temperature was maintained at 40° C. The column used was a Phenomenex Luna, 3 μm NH2, 100 Å, 150×2 mm (Product #00F-4377-B0), and the guard column was a Phenomenex Security Guard Cartridges, NH2, 4×2 mm (#PRD-196870).

TABLE 6
HILIC positive mode gradient conditions

| Time | Flow Rate (mL/min) | % A | % B |
|---|---|---|---|
| 0 | 0.5 | 5 | 95 |
| 6 | 0.5 | 5 | 95 |
| 18 | 0.5 | 60 | 40 |
| 20 | 0.5 | 80 | 20 |
| 22 | 0.5 | 5 | 95 |
| 27 | 0.5 | 5 | 95 |

Quantitation of Sugars and Sugar Alcohols:

The same HILIC column used for quantitation of the amino acids was used for quantitation of sugars, but the polarity of the MS was run in negative mode. While the same mobile phases were used, the gradient was slightly modified to help with retention. The temperature of the column also was held at 50° C. for better peak shape and separation of the isobaric sugars.

TABLE 7
HILIC negative mode gradient conditions

| Time | Flow Rate (mL/min) | % A | % B |
|---|---|---|---|
| 0 | 0.5 | 0 | 100 |
| 3 | 0.5 | 0 | 100 |
| 18 | 0.5 | 18 | 82 |
| 19 | 0.5 | 26 | 74 |
| 20 | 0.5 | 60 | 40 |
| 21 | 0.4 | 80 | 20 |
| 23 | 0.4 | 0 | 100 |
| 28 | 0.4 | 0 | 100 |

Quantitation of Non-Polar Compounds:

A C18 column was used to assess non-polar compounds, as they are retained in the long carbon chains under polar conditions. This method was run in both positive and negative modes, depending on each compound and whether it ionizes better with a positive or negative charge, respectively. The mobile phases used for this method were A: H₂O+0.1% FA, and B: Methanol, and the temperature of the column was held at 50° C. The column used was an Agilent Poroshell 120, EC-C18 2.7 μm, 3.0×100 mm (Product #695975-302).

TABLE 8
C18 positive/negative mode gradient conditions

| Time | Flow Rate (mL/min) | % A | % B |
|---|---|---|---|
| 0 | 0.6 | 100 | 0 |
| 1.5 | 0.6 | 100 | 0 |
| 4 | 0.6 | 0 | 100 |
| 6 | 0.6 | 0 | 100 |
| 6.1 | 0.6 | 100 | 0 |
| 9 | 0.6 | 100 | 0 |

Quantitation of Organic Acids and Similarly Charged Polar Compounds:

To look at organic acids, a charged C18 column was used. The gradient used for the organic method was the same as for the C18 non-polar methods, as shown in TABLE 8. There was a modification to mobile phase B for this method, in that B: ACN+0.1% FA. The column used was a Phenomenex Luna Omega, 1.6 μm, PS C18 100 Å, 100×2.1 mm (Product #00D-4752-AN).

Quantitation of Lipids:

As lipids are very hydrophobic, they require stronger organic solvents in order to elute from any chromatographic column. The C18 column discussed above (Agilent Poroshell) was used to quantitate lipids, but the mobile phases that were used had a higher concentration of organic solvents. Samples were run in both positive and negative ionization modes, but the positive mode was used for quantitation of the two lipid standards. Mobile phase A: 60/40 H2O/ACN+5 mM Ammonium Acetate+0.1% FA, and B: 90/10 IPA/ACN+5 mM Ammonium Acetate+0.1% FA. The column temperature was held at 50° C.

TABLE 9
C18 Lipidpositive/negative mode gradient conditions

| Time | Flow Rate (mL/min) | % A | % B |
|---|---|---|---|
| 0 | 0.6 | 80 | 20 |
| 1.5 | 0.6 | 80 | 20 |
| 4 | 0.6 | 45 | 55 |
| 10 | 0.6 | 20 | 80 |
| 11.5 | 0.6 | 0 | 100 |
| 15 | 0.6 | 0 | 100 |
| 15.5 | 0.6 | 80 | 20 |
| 17.5 | 0.6 | 80 | 20 |

Data Analysis:

Data analysis methods were developed with the XCalibur Processing Setup program, where methods were made for each standard cassette for each LC method. The compound mass and retention time was added for each standard, and calibration levels were applied for each standard. To calculate concentrations in samples, the samples and standards for each run were processed together using XCalibur Quan software, and concentrations calculated based on the respective compound calibration curve. Limits of detection were determined for each standard by running each standard curve at low levels until nothing was detected.

TABLE 10A
LODs for each standard being quantified
(in pg/mL, ng/mL, or ug/mL)

| Cassette | Compound | LOD | |
|---|---|---|---|
| 10 | Methionine | 500 | pg |
| 10 | Histidine | 10 | ng |
| 10 | Lysine | 10 | ng |
| 10 | Serine | 2 | ng |
| 10 | Leucine | 500 | pg |
| 10 | Phenylalanine | 500 | pg |
| 10 | Aspartic Acid | 5 | ug |
| 10 | Tyrosine | 2 | ng |
| 10 | GABA | 2 | ng |
| 10 | Pyridoxine | 100 | pg |
| 10 | Glucosamine | 50 | ng |
| 10 | Choline | 2 | ng |
| 11 | Arginine | 10 | ng |
| 11 | Valine | 100 | ng |
| 11 | Proline | 2 | ng |
| 11 | Alanine | 10 | ng |
| 11 | Isoleucine | 10 | ng |
| 11 | Cysteine | 1 | ug |
| 11 | Asparagine | 10 | ng |
| 11 | Glutamic Acid | 10 | ng |
| 11 | Tryptophan | 2 | ng |
| 11 | Ornithine | 10 | ng |
| 11 | Glutamine | 10 | ng |
| 11 | Threonine | 10 | ng |
| 11 | Carnitine | 500 | pg |
| 12 | Tartaric Acid | 100 | pg |
| 12 | Citric Acid | 10 | ng |
| 12 | 2-Isopropylmalic Acid | 100 | pg |
| 12 | Lactic Acid | 2 | ng |
| 12 | 3,4-dihydroxybenzoic Acid | 100 | pg |
| 12 | Gallic Acid | 500 | pg |
| 12 | D-Glucuronic Acid | 100 | pg |
| 12 | Fumaric Acid | 500 | pg |
| 12 | malic Acid | 100 | pg |
| 12 | Galacturonic Acid | 100 | pg |
| 12 | 2-Furoic Acid | 10 | ng |
| 12 | Pyruvic Acid | 10 | pg |
| 12 | Succinic Acid | 500 | pg |
| 13 | Rhamnose | 10 | ng |
| 13 | Glucose | 100 | ng |
| 13 | Mannitol | 2 | ng |
| 13 | Fructose | 2 | ng |
| 13 | Ribose | 10 | ng |
| 13 | Arabitol | 2 | ng |
| 14 | Rutin | 1 | ng |
| 14 | Quercetin | 1 | ng |
| 14 | Salicylic Acid | 200 | pg |
| 14 | Sinapinic Acid | 200 | pg |
| 14 | Epicatechin | 1 | ng |
| 14 | Resveratrol | 4 | ng |
| 14 | Propyl Gallate | 200 | pg |
| 14 | Trans-Ferulic Acid | 1 | ng |
| 14 | Hesperetin | 200 | pg |
| 14 | Adipic Acid | 200 | pg |
| 14 | Methyl Gallate | 200 | pg |
| 14 | Catechin | 1 | ng |
| 14 | Ellagic Acid | 1 | ng |
| 15 | Inositol | 10 | ng |
| 15 | Fucose | 100 | ng |
| 15 | Mannose | 10 | ng |
| 15 | Xylose | 100 | ng |
| 15 | Sorbitol | 2 | ng |
| 15 | Galactose | 10 | ng |
| 16 | Quinic Acid | 1 | ng |
| 16 | Polydatin | 4 | ng |
| 16 | Acetovanillone | 1 | ng |
| 16 | Pantothenic Acid | 0.2 | ng |
| 16 | Vanillic Acid | 10 | ng |
| 16 | Syringic Acid | 50 | ng |
| 16 | Caffeic Acid | 20 | ng |
| 16 | Epicatechin Gallate | 2 | ng |
| 16 | Coumaric Acid | 4 | ng |
| 16 | Cinnamic Acid | 500 | ng |
| 16 | Syringaldehyde | 1 | ng |
| 16 | Vanillin | 200 | pg |
| 17 | Trans-4-hydroxy proline | 200 | pg |
| 17 | L-citrulline | 200 | pg |
| 17 | Tryptamine | 200 | pg |
| 17 | Tyramine | 1 | ng |
| 17 | Adenine | 200 | pg |
| 17 | Guanine | 200 | pg |
| 17 | Acetylcholine | 1 | ng |
| 17 | Kynurenic Acid | 200 | pg |
| 17 | Acetanilide | 200 | pg |
| 17 | 4-methylumbelliferone | 1 | ng |
| 17 | Felbamate | 20 | ng |
| 17 | Sorbic Acid | 100 | ng |
| 18 | Lauric Acid | 200 | pg |
| 18 | Palmitic Acid | 200 | pg |

TABLE 10B
Additional LODs for standards being quantified (by parts)

| Compound | LOD | |
|---|---|---|
| 2,3,5,6-tetramethylpyrazine | <1 | ppb |
| 2,3,5-trimethylpyrazine | <1 | ppb |
| 2,3-dimethylpyrazine | <1 | ppb |
| b-alanine-2 | 100 | ppb |
| camphoric acid | not detected well | |
| citrulline | 100 | ppb |
| methyl 2-pyrrolyl ketone | <1 | ppb |
| piperine | <1 | ppb |
| pyridine | <1 | ppb |
| 4-guanidinobutyric acid | 100 | ppt |
| Betaine | <10 | ppb |
| carnosine | <10 | ppb |
| cystine | <100 | ppb |
| cytidine | 5 | ppb |
| cytosine | 100 | ppt |
| D-glucuronic acid | 500 | ppt |
| homoserine | <10 | ppb |
| myo-inositol | 50 | ppb |
| pipecolinic acid | <10 | ppb |
| uracil | 5 | ppb |
| glycine | 50 | ppb |

The levels of the non-volatile compounds measured in the reference Moscato samples are shown in TABLES 11A and 11B. In TABLE 11B, for each compound analyzed by the LCMS, between 9 to 15 data points were run for each standard. Multiple standard curves of varying lengths were generated, from 4-point standard curves all the way to 15-point standard curves. In total between 15-66 standard curves were generated per sample replicate. Sample data is only counted if it falls within the bounds of any generated standard curve and is reported as the average value of all applicable standard curves.

TABLE 11A
LC-MS of reference Moscato

| Round 1 assays; | | | |
|---|---|---|---|
| All values in mg/L | Sample 1 | Sample 2 | Sample 3 |
| Pyridine | NF | NF | NF |
| 2,3-dimethylpvrazine | NF | NF | NF |
| methyl2-pyrrolyl ketone | NF | NF | NF |
| 2,3,5-trimethylpyrazine | NF | NF | NF |
| 2,3,5,6-tetramethylpyrazine | NF | NF | NF |
| Piperine | NQ | NQ | NQ |
| Pyridoxine | 0.199403036 | 0.481805766 | ND |
| Choline | 85.89217218 | 102.0707945 | 86.33845921 |
| Leucine | 10.1607167 | 10.30465706 | 10.94670147 |
| Phenylalanine | 4.678012476 | 6.015765027 | 5.839726201 |
| Methionine | 3.129717542 | 3.019698073 | 3.042192261 |
| GABA | 7.666032533 | 6.437404735 | 8.532519272 |
| Tyrosine | 4.661794734 | 4.509714182 | 5.284092148 |
| Serine | 1.414917723 | 1.661177711 | 1.795057091 |
| Aspartic Acid | ND | ND | ND |
| Glycine | ND | ND | ND |
| Glucosamine | 257.0063222 | 308.7104292 | 361.5683058 |
| Histidine | 1.851027247 | 1.869704239 | 2.044785509 |
| Lysine | 3.496517415 | 3.807746962 | 4.251842785 |
| Alanine | NM | NM | NM |
| Isoleucine | 3.546537195 | 4.890278584 | 5.30473154 |
| Carnitine | 1.947609282 | 2.97327195 | 3.608953903 |
| Tryptophan | 4.362924516 | 5.806331467 | 6.317194064 |
| Proline | 309.0802197 | 284.9568228 | 338.0987606 |
| Beta-ine | 16.931 | 16.632 | 16.418 |
| Valine | 0.394883618 | 0.414967712 | 0.008732626 |
| B-alanine-2 | ND | ND | ND |
| Threonine | 2.46966573 | 2.719806129 | 2.741757978 |
| Glutamine | NF | NF | NF |
| Asparagine | 1.607431843 | 1.761555118 | 1.766558253 |
| Glutamic acid | 10.34480463 | 9.511553646 | 10.01683479 |
| Cysteine | ND | ND | ND |
| Arginine | 3.603475444 | 3.981742654 | 4.362710993 |
| Ornithine | 0.113000686 | 0.114867698 | 0.11378003 |
| Trans-4-hydroxy-L-proline | 2.156342797 | 2.199709855 | 2.254573909 |
| Citrulline | NQ | NQ | NQ |
| Adenine | 9.466662642 | 9.759000998 | 9.625748602 |
| Guanine | 0.80676112 | 0.818507298 | 0.931713305 |
| Tyramine | NF | NF | NF |
| Tryptamine | NF | NF | NF |
| Kynurenic acid | 0.012133655 | 0.028393279 | 0.021038721 |
| Acetanilide | NQ | NQ | NQ |
| Felbamate | NF | NF | NF |
| 4-methylumbeliferone | NF | NF | NF |
| Sorbic acid | NF | NF | NF |
| Quinic acid | 30.30410149 | 34.47217975 | 31.04242236 |
| Pantothenic acid | 0.112870494 | 0.134855337 | 0.30964594 |
| Vanillic acid | NF | NF | NF |
| Caffeic acid | 15.68024577 | 15.95698585 | 16.58111781 |
| Epicatechin gallate | NF | NF | NF |
| Syringic acid | NF | NF | NF |
| Polydatin | 0.838486448 | 0.831157928 | 0.81266767 |
| Vanillin | NF | NF | NF |
| Syringaldehyde | NF | NF | NF |
| Coumaric acid | 3.664934204 | 3.719916262 | 3.699873722 |
| Acetovanillone | NF | NF | NF |
| Cinnamic acid | NF | NF | NF |
| Tartaric acid | 3774.741249 | 3600.333332 | 3615.108763 |
| Malic acid | 2138.70021 | 2134.870694 | 2067.056371 |
| Pyruvic acid | 74.4477403 | 78.76383667 | 77.58717987 |
| D-Glucuronic acid | 895.8479408 | 836.9347522 | 810.5812616 |
| Lactic acid | 97.36245583 | 106.7936816 | 110.6277224 |
| Citric acid | 385.6209301 | 380.2923421 | 374.2760298 |
| Fumaric acid | 4.867614826 | 5.071537659 | 5.958585671 |
| Succinic acid | 522.9927958 | 559.8262557 | 555.9312262 |
| Gallic acid | 1.736642269 | 1.996493364 | 2.127515928 |
| 2-Furoic acid | 429.6685299 | 463.3777596 | 478.8691217 |
| 3,4-dihydroxybenzoic acid | 0.563215665 | 0.632488065 | 0.567838455 |
| 2-Isopropylmalic acid | 0.246916427 | 0.19745168 | 0.303795213 |
| Catechin | 3.991959802 | 3.645419926 | 3.486911825 |
| Adipic acid | NF | NF | NF |
| Epicatechin | 0.966455038 | 0.854674717 | 0.909006893 |
| Methyl gallate | NF | NF | NF |
| Rutin | NF | NF | NF |
| Sinapinic acid | NF | NF | NF |
| Trans-Ferulic acid | ND | ND | ND |
| Resveratrol | NF | NF | NF |
| Ellagic acid | 0.059393451 | 0.145636683 | 0.154033941 |
| Propyl gallate | NF | NF | NF |
| Quercetin | NQ | NQ | NQ |
| Salicylic acid | 0.779498799 | 0.750042681 | 0.909546731 |
| Hesperetin | NF | NF | NF |
| Fructose | 121429.3813 | 145080.3803 | 144274.656 |
| Glucose | 103257.5921 | 110684.659 | 118104.6196 |
| Ribose | 92.61139715 | 98.71946603 | 92.87288931 |
| Arabitol | 153.3447793 | 136.398207 | 113.3905107 |
| Xylose | NF | NF | NF |
| Fucose | NF | NF | NF |
| Sorbitol | 31.47383412 | 32.50075144 | 29.42672705 |
| Mannose | NF | NF | NF |
| Galactose | ND | ND | ND |
| Inositol | NF | NF | NF |
| Mannitol | 164.877 | 179.4467 | 153.0881 |

NF = not present or below the limit of detection
NQ = present but below the standard curve (e.g., below the LOQ)
ND = not determined
NM = no method

TABLE 11B
LC-MS of reference alcoholic Moscato

| Round 2 assays (mg/L) | 1A | 1B | 1C | 2A | 2B | 2C |
|---|---|---|---|---|---|---|
| Pyridine | NF | NF | NF | NF | NF | NF |
| 2,3-dimethylpyrazine | NF | NF | NF | NF | NF | NF |
| Methyl 2-pyrrolyl ketone | NF | NF | NF | NF | NF | NF |
| 2,3,5-trimethylpyrazine | OC | OC | OC | NF | NF | NF |
| 2,3,5,6-Tetramethylpyrazine | OC | OC | OC | NF | NF | NF |
| Piperine | NF | NF | OC | NF | NF | NF |
| Pyridoxine | OC | 1.11E−01 | 1.07E−01 | 3.73E−01 | 3.37E−01 | 3.32E−01 |
| Choline | 1.97E+01 | 2.01E+01 | 1.96E+01 | OC | OC | OC |
| Leucine | 3.44E+00 | 3.44E+00 | 3.36E+00 | NR | 4.41E+00 | 5.50E+00 |
| Phenylalanine | 3.62E+00 | 3.53E+00 | 3.54E+00 | NR | 8.16E+00 | 1.06E+01 |
| Methionine | 1.49E+00 | 1.53E+00 | 1.49E+00 | NR | 2.36E+00 | 2.79E+00 |
| GABA | NF | NF | NF | NR | 1.00E+00 | 9.07E−01 |
| Tyrosine | 2.29E+00 | 2.32E+00 | 2.23E+00 | NR | 3.26E+00 | 3.32E+00 |
| Serine | 1.77E+00 | 1.72E+00 | 1.71E+00 | NR | 1.36E+00 | 1.44E+00 |
| Aspartic acid | OC | OC | OC | NR | NF | NF |
| Glycine | 1.87E+00 | 1.88E+00 | 1.87E+00 | NR | 1.02E+00 | 1.21E+00 |
| Glucosamine | NF | NF | NF | NR | 1.87E+01 | 1.66E+01 |
| Histidine | 1.44E+00 | 1.47E+00 | 1.39E+00 | NR | 1.52E+00 | 1.61E+00 |
| Lysine | OC | OC | OC | NR | 2.64E+00 | OC |
| isoleucine | OC | OC | OC | NR | OC | OC |
| Carnitine | 1.00E+00 | 1.02E+00 | 1.02E+00 | NR | 1.59E+00 | 1.92E+00 |
| tryptophan | 1.30E+00 | 1.42E+00 | 1.39E+00 | NR | 5.06E−01 | 5.13E−01 |
| proline | 1.13E+02 | 1.12E+02 | 1.12E+02 | NR | OC | OC |
| betaine | 3.98E+00 | 4.08E+00 | 4.09E+00 | NF | NF | NF |
| valine | NF | NF | NF | NR | 3.55E+00 | OC |
| beta-alanine | 1.87E+00 | 2.07E+00 | 1.98E+00 | NR | 1.42E+00 | 1.70E+00 |
| Threonine | 1.93E+00 | 9.36E−01 | 8.67E−01 | NR | OC | OC |
| Glutamine | NF | NF | NF | NR | NF | NF |
| asparagine | 1.06E+00 | 1.05E+00 | 1.06E+00 | NR | 9.49E−01 | 1.10E+00 |
| Glutamic acid | 4.83E+00 | 4.81E+00 | 4.27E+00 | NR | 1.61E+01 | 2.24E+01 |
| cysteine | NF | NF | NF | NR | NF | NF |
| arginine | 1.60E+00 | 1.66E+00 | 1.62E+00 | NR | 1.82E+00 | 3.45E+00 |
| Ornithine | NF | NF | NF | NR | NF | NF |
| 4-Guanidinobutyric acid | OC | OC | OC | OC | OC | OC |
| Pipecolinic acid | 1.22E+00 | 1.12E+00 | 1.13E+00 | NF | NF | NF |
| Carnosine | NF | NF | NF | NR | 2.23E−01 | 2.35E−01 |
| Homoserine | 7.08E−01 | 7.60E−01 | 7.68E−01 | NR | 6.14E−01 | 7.62E−01 |
| Cystine | NF | NF | NF | NR | NF | NF |
| Trans-4-hydroxyproline | 1.49E+00 | 1.49E+00 | 1.41E+00 | NR | 7.47E−01 | 9.77E−01 |
| Citrulline | NF | NF | NF | NR | NF | NF |
| Adenine | OC | OC | OC | 2.54E+00 | 2.45E+00 | 2.33E+00 |
| Guanine | 3.92E+02 | 3.92E+02 | 3.92E+02 | OC | OC | OC |
| Tyramine | NF | NF | NF | NF | NF | NF |
| Tryptamine | NF | NF | NF | NF | NF | NF |
| Kynurenic acid | NR | NR | NR | NR | NF | NF |
| Sorbic acid | NF | NF | NF | NF | NF | NF |
| Cytosine | OC | OC | OC | OC | OC | OC |
| Cytidine | 3.15E−01 | 3.16E−01 | 3.08E−01 | OC | OC | OC |
| Uracil | 1.87E+00 | 1.82E+00 | 1.81E+00 | 3.42E+00 | 3.41E+00 | 3.43E+00 |
| Quinic acid | NF | NF | NF | NF | NF | NF |
| Pantothenic acid | NR | NR | NR | OC | OC | OC |
| Vanillic acid | NR | NR | NR | NF | NF | NF |
| Caffeic acid | NR | NR | NR | 1.08E+01 | 1.03E+01 | 1.09E+01 |
| Epicatechin gallate | NR | NR | NR | NF | NF | NF |
| Syringic acid | NR | NR | NR | NF | NF | NF |
| Polydatin | NR | NR | NR | 2.38E−01 | 4.00E−01 | 2.20E−01 |
| Vanillin | NR | NR | NR | NF | NF | NF |
| Syringaldehyde | NR | NR | NR | NF | NF | NF |
| Coumaric acid | NR | NR | NR | 3.54E+00 | 3.36E+00 | 3.66E+00 |
| Acetovanillone | NR | NR | NR | OC | OC | OC |
| Cinnamic acid | NR | NR | NR | OC | OC | OC |
| Tartaric acid | 1.53E+03 | 1.42E+03 | 1.48E+03 | NR | OC | OC |
| Malic acid | 1.02E+03 | 9.72E+02 | 9.92E+02 | OC | OC | OC |
| Pyruvic acid | 3.53E+01 | 3.67E+01 | 3.80E+01 | 2.62E+01 | 2.64E+01 | 2.58E+01 |
| D-Glucuronic acid | 1.37E+03 | 1.36E+03 | 1.33E+03 | OC | OC | OC |
| Lactic acid | 4.43E+01 | 4.36E+01 | 4.29E+01 | NF | NF | NF |
| Citric acid | 2.91E+02 | 2.92E+02 | 2.89E+02 | NR | OC | OC |
| Fumaric acid | 2.71E+00 | 2.69E+00 | 2.61E+00 | NF | NF | NF |
| Succinic acid | 3.91E+02 | 3.98E+02 | 3.95E+02 | OC | OC | OC |
| Gallic acid | 1.24E+00 | 1.25E+00 | 1.27E+00 | 1.75E+00 | 1.66E+00 | 1.64E+00 |
| 2-Furoic acid | NF | NF | NF | OC | OC | OC |
| 3,4-dihydroxybenzoic acid | 3.24E−01 | 3.30E−01 | 3.33E−01 | 1.99E−01 | 1.92E−01 | 1.85E−01 |
| 2-Isopropylmalic acid | 8.00E+00 | 7.97E+00 | 8.90E+00 | 6.20E+00 | 6.26E+00 | 6.19E+00 |
| Catechin | 1.39E+00 | 1.40E+00 | 1.37E+00 | 4.41E−01 | 4.41E−01 | 4.41E−01 |
| Adipic acid | NF | NF | NF | NF | NF | NF |
| Epicatechin | 3.26E−01 | 3.35E−01 | 3.34E−01 | OC | OC | OC |
| Methyl gallate | NF | NF | NF | NF | NF | NF |
| Rutin | NF | NF | NF | NF | NF | NF |
| Sinapinic acid | OC | NF | NF | NF | NF | NF |
| Trans-Ferulic acid | 2.59E−01 | 2.43E−01 | 2.55E−01 | OC | OC | OC |
| Resveratrol | NF | NF | NF | 8.27E−03 | 8.27E−03 | 8.27E−03 |
| Ellagic acid | NF | NF | NF | 1.48E−01 | 1.48E−01 | 1.48E−01 |
| Propyl gallate | NF | NF | NF | NF | NF | NF |
| Quercetin | OC | OC | OC | OC | OC | OC |
| Salicylic acid | OC | 4.64E−02 | 6.46E−02 | OC | OC | OC |
| Hesperetin | OC | OC | OC | NF | NF | NF |
| Camphoric acid | OC | OC | OC | OC | OC | OC |
| Fructose | OC | OC | OC | 7.66E+03 | 5.52E+03 | 6.36E+03 |
| Glucose | OC | OC | OC | 8.72E+03 | 8.81E+03 | 8.06E+03 |
| Ribose | NF | NF | NF | NF | NF | NF |
| Arabitol | 1.10E+01 | 1.11E+01 | 1.17E+01 | NF | NF | NF |
| Xylose | NR | NR | NR | 2.59E+04 | 2.94E+04 | 2.82E+04 |
| Fucose | 8.52E+01 | 8.22E+01 | 1.09E+02 | 1.60E+03 | 2.27E+03 | 1.91E+03 |
| Sorbitol | NR | NR | NR | 1.60E+02 | 1.82E+02 | 1.83E+02 |
| Mannose | NR | NR | NR | NR | NR | NR |
| Galactose | NR | NR | NR | NR | NR | NR |
| Inositol | 3.29E+02 | 3.39E+02 | 2.89E+02 | NF | NF | NF |
| Mannitol | 2.25E+01 | 2.13E+01 | 2.20E+01 | 6.40E+01 | 7.72E+01 | 7.25E+01 |
| Rhamnose | 1.87E+01 | 1.97E+01 | 2.05E+01 | NF | NF | NF |
| Round 2 assays (mg/L) | 3A | 3B | 3C | 4A | 4B | 4C |
| Pyridine | NF | NF | NF | NF | NF | NF |
| 2,3-dimethylpyrazine | NF | NF | NF | NF | NF | NF |
| Methyl 2-pyrrolyl ketone | NF | NF | NF | NF | NF | NF |
| 2,3,5-trimethylpyrazine | OC | OC | OC | NF | NF | NF |
| 2,3,5,6-Tetramethylpyrazine | OC | OC | OC | NF | NF | NF |
| Piperine | NF | NF | OC | NF | NF | NF |
| Pyridoxine | OC | OC | 1.18E−01 | 2.84E−01 | 3.15E−01 | 2.96E−01 |
| Choline | 1.59E+01 | 1.59E+01 | 1.52E+01 | OC | OC | OC |
| Leucine | 5.00E−01 | 4.55E−01 | 5.00E−01 | OC | OC | OC |
| Phenylalanine | OC | OC | OC | 4.31E+00 | 4.25E+00 | 2.45E+00 |
| Methionine | OC | OC | OC | 8.40E−01 | 8.70E−01 | 7.02E−01 |
| GABA | NF | NF | NF | OC | OC | NF |
| Tyrosine | 9.28E−01 | 9.35E−01 | 8.90E−01 | 1.95E+00 | 2.02E+00 | 1.50E+00 |
| Serine | OC | OC | OC | 8.48E−01 | 8.36E−01 | 7.34E−01 |
| Aspartic acid | OC | OC | OC | NF | NF | NF |
| Glycine | OC | OC | OC | 4.08E−01 | 4.54E−01 | 4.87E−01 |
| Glucosamine | NF | NF | NF | 2.07E+01 | 1.71E+01 | 1.57E+01 |
| Histidine | OC | OC | OC | 4.85E−01 | 4.91E−01 | 4.65E−01 |
| Lysine | OC | OC | OC | OC | OC | OC |
| isoleucine | NF | NF | NF | OC | OC | OC |
| Carnitine | 8.58E−01 | 8.89E−01 | 8.85E−01 | 1.80E+00 | 1.80E+00 | 1.71E+00 |
| tryptophan | 5.17E−01 | 5.08E−01 | 5.01E−01 | 5.49E−01 | 5.30E−01 | 7.29E−01 |
| proline | 3.16E+01 | 3.17E+01 | 3.18E+01 | 6.24E+01 | 6.44E+01 | 5.96E+01 |
| betaine | 4.19E+00 | 4.31E+00 | 4.32E+00 | NF | NF | NF |
| valine | NF | NF | NF | OC | OC | OC |
| beta-alanine | 5.24E−01 | 4.04E−01 | 4.69E−01 | 1.37E−01 | 1.33E−01 | OC |
| Threonine | 2.06E−01 | 1.69E−01 | 1.83E−01 | OC | OC | OC |
| Glutamine | NF | NF | NF | NF | NF | NF |
| asparagine | 3.09E−01 | OC | 2.99E−01 | 4.03E−01 | 3.81E−01 | 3.36E−01 |
| Glutamic acid | 1.03E+00 | 9.01E−01 | 8.96E−01 | 6.16E+00 | 7.24E+00 | 7.21E+00 |
| cysteine | NF | NF | NF | NF | NF | NF |
| arginine | 4.31E−01 | 4.25E−01 | 3.73E−01 | 3.97E−01 | 3.46E−01 | 3.66E−01 |
| Ornithine | NF | NF | NF | NF | NF | NF |
| 4-Guanidinobutyric acid | OC | OC | OC | OC | OC | OC |
| Pipecolinic acid | 1.60E+00 | 1.63E+00 | 1.54E+00 | NF | NF | NF |
| Carnosine | NF | NF | NF | 6.20E−02 | 5.51E−02 | OC |
| Homoserine | OC | OC | OC | 4.11E−01 | 3.98E−01 | 4.06E−01 |
| Cystine | NF | NF | NF | NF | NF | NF |
| Trans-4-hydroxyproline | 7.79E−01 | 7.39E−01 | 7.97E−01 | 6.56E−01 | 7.37E−01 | 6.59E−01 |
| Citrulline | NF | NF | NF | NF | NF | NF |
| Adenine | OC | OC | OC | 9.91E−01 | 1.18E+00 | 9.58E−01 |
| Guanine | 3.91E+02 | 3.91E+02 | 3.91E+02 | OC | OC | OC |
| Tyramine | NF | NF | NF | NF | NF | NF |
| Tryptamine | NF | NF | NF | NF | NF | NF |
| Kynurenic acid | NR | NR | NR | NF | NF | NF |
| Sorbic acid | NF | NF | NF | NF | NF | NF |
| Cytosine | OC | OC | OC | OC | OC | OC |
| Cytidine | 3.73E−01 | 3.85E−01 | 3.92E−01 | OC | OC | OC |
| Uracil | 2.40E+00 | 2.52E+00 | 2.55E+00 | 3.30E+00 | 3.39E+00 | 3.36E+00 |
| Quinic acid | NF | NF | NF | NF | NF | NF |
| Pantothenic acid | NR | NR | NR | OC | OC | OC |
| Vanillic acid | NR | NR | NR | NF | NF | 6.17E−01 |
| Caffeic acid | NR | NR | NR | 6.38E+00 | 6.56E+00 | 6.54E+00 |
| Epicatechin gallate | NR | NR | NR | NF | NF | NF |
| Syringic acid | NR | NR | NR | NF | NF | NF |
| Polydatin | NR | NR | NR | OC | OC | OC |
| Vanillin | NR | NR | NR | NF | NF | NF |
| Syringaldehyde | NR | NR | NR | NF | NF | NF |
| Coumaric acid | NR | NR | NR | 2.06E+00 | 2.02E+00 | 1.85E+00 |
| Acetovanillone | NR | NR | NR | OC | OC | OC |
| Cinnamic acid | NR | NR | NR | 1.51E−01 | OC | OC |
| Tartaric acid | 6.12E+03 | 5.89E+03 | 6.03E+03 | OC | OC | OC |
| Malic acid | 4.31E+03 | 4.24E+03 | 4.16E+03 | OC | OC | OC |
| Pyruvic acid | 6.94E+01 | 7.01E+01 | 6.86E+01 | 4.02E+01 | 4.45E+01 | 4.08E+01 |
| D-Glucuronic acid | 8.48E+02 | 8.15E+02 | 8.15E+02 | OC | OC | OC |
| Lactic acid | 3.08E+01 | 3.38E+01 | 2.62E+01 | NF | NF | NF |
| Citric acid | OC | OC | OC | OC | OC | OC |
| Fumaric acid | 2.11E+00 | 1.82E+00 | 2.39E+00 | NF | NF | NF |
| Succinic acid | 3.65E+02 | 3.57E+02 | 3.52E+02 | OC | OC | OC |
| Gallic acid | 7.08E−01 | 7.08E−01 | 7.11E−01 | 1.13E+00 | 1.11E+00 | 1.06E+00 |
| 2-Furoic acid | NF | NF | NF | OC | OC | OC |
| 3,4-dihydroxybenzoic acid | 3.01E−01 | 2.98E−01 | 3.00E−01 | 1.09E−01 | 1.11E−01 | 1.05E−01 |
| 2-Isopropylmalic acid | 1.19E+01 | 1.22E+01 | 1.21E+01 | 8.81E+00 | 8.28E+00 | 8.47E+00 |
| Catechin | 1.65E+00 | 1.56E+00 | 1.79E+00 | 7.81E−01 | 7.81E−01 | 7.81E−01 |
| Adipic acid | NF | NF | NF | NF | NF | NF |
| Epicatechin | 3.74E−01 | 3.84E−01 | 4.07E−01 | OC | OC | OC |
| Methyl gallate | NF | NF | NF | NF | NF | NF |
| Rutin | NF | NF | NF | NF | NF | NF |
| Sinapinic acid | OC | NF | OC | NF | NF | NF |
| Trans-Ferulic acid | OC | OC | 1.48E−01 | OC | OC | OC |
| Resveratrol | NF | NF | NF | OC | OC | OC |
| Ellagic acid | NF | NF | NF | 4.48E−01 | 4.48E−01 | 4.48E−01 |
| Propyl gallate | NF | NF | NF | NF | NF | NF |
| Quercetin | 6.80E−01 | OC | 6.91E−01 | 6.22E−01 | 6.22E−01 | 6.22E−01 |
| Salicylic acid | OC | OC | OC | OC | OC | OC |
| Hesperetin | OC | OC | OC | NF | NF | NF |
| Camphoric acid | OC | OC | OC | 2.93E+01 | 3.28E+01 | 2.53E+01 |
| Fructose | OC | OC | OC | 6.25E+03 | 7.54E+03 | 1.54E+04 |
| Glucose | OC | OC | OC | 8.42E+03 | 1.14E+04 | 2.41E+04 |
| Ribose | NF | NF | NF | NF | NF | NF |
| Arabitol | 2.16E+00 | 2.39E+00 | 2.45E+00 | NF | NF | NF |
| Xylose | NR | NR | NR | 2.03E+04 | 2.01E+04 | 1.73E+04 |
| Fucose | 3.07E+01 | 3.71E+01 | 3.00E+01 | 2.56E+03 | 1.60E+03 | 2.50E+03 |
| Sorbitol | NR | NR | NR | 1.15E+02 | 1.11E+02 | 1.24E+02 |
| Mannose | NR | NR | NR | NR | NR | NR |
| Galactose | NR | NR | NR | NR | NR | NR |
| Inositol | 2.65E+02 | 2.21E+02 | 2.65E+02 | NF | NF | NF |
| Mannitol | 6.08E+00 | 6.09E+00 | 5.87E+00 | OC | OC | OC |
| Rhamnose | 3.43E+00 | 4.96E+00 | 2.90E+00 | NF | NF | NF |

NR = not run
NF = not found
OC = outside standard curve

### Example 3—Evaluation of the Moscato of Example 1

A Moscato replica was made as in Example 1 (non-volatiles were from Subrange D in Table 2) and the VOCs and non-volatiles were measured as set forth in Example 2. The measured volatiles are listed in TABLE 12, and the measured non-volatile compounds are listed in TABLE 13.

TABLE 12
VOCs measured in Moscato replica

| Compound (mg/L) | Run 1 | Run 2 |
|---|---|---|
| (1R)-(−)-myrtenal | 0 | ND |
| 1,4-cineole | 0 | ND |
| 1-octanol (nat) | 0 | ND |
| 1-octen-3-ol | 0 | ND |
| 1-propanol | 0 | ND |
| 2,3-hexanedione | 0 | ND |
| 2,3-pentadione | 0 | ND |
| 2,4,6-trimethylphenol (mesitol) | 0 | ND |
| 2-acetyl-1-methylpyrrole | 0 | ND |
| 2-ethyl-3(5 or 6)-dimethylpyrazine | 0 | ND |
| 2-ethyl-3-methylpyrazine | 0 | ND |
| 2-heptanol | 0 | ND |
| 2-heptanone | 0 | ND |
| 2-isobutyl-3-methoxypyrazine | 0 | ND |
| 2-isobutyl-4-methyl-1,3-dioxolane | 0 | ND |
| 2-isopropyl-4-methyl thiazole | 0 | ND |
| 2-methoxy-3-(1-methylpropyl) pyrazine | 0 | ND |
| 2-Methoxy-4-methylphenol (creosol) | 0 | ND |
| 2-methoxy-4-propylphenol | 0 | ND |
| 2-methoxycinnamaldehyde | 0 | ND |
| 2-methyl-1-butanol | 9.5802-17.7918 | ND |
| 2-methylbutyl acetate | 0 | ND |
| 2-methylbutyl isovalerate | 0 | ND |
| 2-methylbutyraldehyde | 0 | ND |
| 2-nonanol | 0.0455-0.0845 | ND |
| 2-nonanone | 0.0462-0.0858 | ND |
| 2-octanone | 0 | ND |
| 2-pentylfuran | 0 | ND |
| 2-undecanone | 0.00385-0.00715 | ND |
| 3-carene | 0 | ND |
| 3-heptyl acetate | 0 | ND |
| 3-mercaptohexyl acetate | 0 | ND |
| 3-methyl-1-pentanol | 0.00973-0.01807 | ND |
| 3-methylthio hexyl acetate (ug/L) | 0 | ND |
| 3-phenylpropanal | 0 | ND |
| 4,5,6,7-tetrahydro-3,6- | 0 | ND |
| dimethylbenzofuran | | |
| 4-carvomenthenol | 0.04921-0.09139 | ND |
| 4-Ethyl Guaiacol | 0 | ND |
| 4-Ethyl Phenol | 0 | ND |
| 4-mercapto-4-methyl-2-pentanone | 0 | ND |
| 5-ethyl-3-hydroxy-4-methyl-2(5H)- | 0 | ND |
| furanone (maple furanone) | | |
| 5-methyl-2-phenyl-2-hexenal | 0 | ND |
| 6,10-dimethyl-5,9-undecadien-2-one | 0 | ND |
| (geranyl acetone) | | |
| 6-methyl-5-hepten-2-one | 0 | ND |
| acetal (1,1-diethoxyethane) | 0 | ND |
| acetoin | 0 | ND |
| acetophenone | 0 | ND |
| allyl heptanoate | 0 | ND |
| allyl hexanoate | 0 | ND |
| amyl alcohol | 0 | ND |
| amyl butyrate | 0 | ND |
| anisyl acetate | 0 | ND |
| anisyl alcohol | 0 | ND |
| anisyl butyrate | 0 | ND |
| a-pinene | 0 | ND |
| a-terpineol | 0.41013-0.76167 | ND |
| b-caryophellene | 0 | ND |
| benzaldehyde | 0.11207-0.20813 | ND |
| benzyl acetate | 0 | ND |
| benzyl benzoate | 0 | ND |
| benzyl butyrate | 0 | ND |
| benzyl propionate | 0 | ND |
| beta-ionone | 0 | ND |
| beta-pinene | 0.00798-0.01482 | ND |
| butyl acetate | 0 | ND |
| butyl alcohol | 0.32403-0.60177 | 0.30975-0.57525 |
| butyl butyryllactate | 0 | ND |
| butyl formate | 0 | ND |
| butyraldehyde | 0 | ND |
| butyric acid | 0.02975-0.05525 | ND |
| carvacrol | 0 | ND |
| Cinnamaldehyde | 0 | ND |
| cis-3-hexen-1-ol | 0 | ND |
| cis-3-hexenyl acetate | 0 | ND |
| cis-3-hexenyl butyrate | 0 | ND |
| cis-3-hexenyl caproate | 0 | ND |
| cis-3-hexenyl valerate | 0 | ND |
| Cis-5-octen-1-ol | 0 | ND |
| cis-6-nonen-1-ol | 0 | ND |
| citral | 0 | ND |
| citronellol | 0.10311-0.19149 | ND |
| cuminaldehyde | 0 | ND |
| D-camphor | 0 | ND |
| D-carvone | 0 | ND |
| decanal | 0 | ND |
| decanoic acid | 0.10108-0.18772 | ND |
| decanol | 0 | ND |
| delta-decalactone | 0.00385-0.00715 | ND |
| delta-dodecalactone | 0 | ND |
| d-fenchone | 0 | ND |
| diethyl malate | 0.11116-0.20644 | ND |
| diethyl succinate | 0.03178-0.05902 | ND |
| dihydrocoumarin | 0 | ND |
| DL-3-methyl-2-butanol | 0 | ND |
| ethyl (methylthio) acetate | 0 | ND |
| ethyl 2-methylbutyrate | 0.00385-0.00715 | ND |
| ethyl 2-trans-4-cis-decadienoate | 0 | ND |
| ethyl 3-hydroxyhexanoate | 0 | ND |
| ethyl acetate | 0 | ND |
| ethyl benzoate | 0 | ND |
| Ethyl butyrate (ethyl butanoate) | 0.6965-1.2935 | ND |
| ethyl cinnamate | 0 | ND |
| ethyl decanoate | 0.14483-0.26897 | ND |
| ethyl heptanoate | 0 | ND |
| ethyl isobutyrate | 0.44646-0.82914 | ND |
| ethyl lactate | 1.99766-3.70994 | ND |
| ethyl laurate | 0.05663-0.10517 | ND |
| ethyl levulinate | 0 | ND |
| ethyl myristate | 0.03234-0.06006 | ND |
| ethyl nonanoate | 0 | ND |
| ethyl octanoate | 0.30163-0.56017 | ND |
| ethyl phenylacetate | 0 | ND |
| ethyl propionate | 0 | ND |
| ethyl salicylate | 0.00035-0.00065 | ND |
| ethyl trans-2-butenoate | 0 | ND |
| ethyl undecanoate | 0 | ND |
| Ethyl Valerate | 0 | ND |
| ethyl-trans-3-hexenoate | 0 | ND |
| eucalyptol | 0.01596-0.02964 | ND |
| eugenol | 0 | ND |
| farnesol | 0 | ND |
| furfuryl thioacetate | 0 | ND |
| gamma-decalactone | 0 | ND |
| gamma-dodecalactone | 0 | ND |
| gamma-heptalactone | 0 | ND |
| gamma-nonalactone | 0 | ND |
| gamma-octalactone | 0 | ND |
| gamma-terpinene | 0.01428-0.02652 | ND |
| gamma-undecalactone | 0 | ND |
| geraniol | 0.25333-0.47047 | ND |
| geranyl butyrate | 0 | ND |
| guaiacol | 0 | ND |
| heptyl acetate | 0 | ND |
| Hexadecanol | 0 | ND |
| hexanoic acid | 1.6751-3.1109 | ND |
| hexyl 3-methylbutanoate | 0 | ND |
| hexyl acetate | 0.1134-0.2106 | ND |
| Hexyl alcohol (hexanol) | 0.378-0.702 | ND |
| hexyl butyrate | 0 | ND |
| hexyl formate | 0 | ND |
| hexyl isobutyrate | 0 | ND |
| hexyl propionate | 0 | ND |
| indole | 0 | ND |
| isoamyl acetate | 9.443-17.537 | ND |
| isoamyl alcohol | 15.5694-28.9146 | ND |
| isoamyl cinnamate | 0 | ND |
| isoamyl hexanoate | 0 | ND |
| isoamyl isobutyrate | 0 | 0 |
| isoamyl isovalerate | 0 | ND |
| isoamyl octanoate | 0 | ND |
| isoamyl phenylacetate | 0 | ND |
| isobutyl acetate | 0 | ND |
| isobutyl alcohol | 13.41991-24.92269 | ND |
| isobutyl butyrate | 0 | ND |
| isobutyl isobutyrate | 0 | ND |
| isobutyl propionate | 0 | ND |
| isobutyraldehyde | 0.11963-0.22217 | ND |
| Isobutyric Acid | 0.18417-0.34203 | ND |
| isoeugenol | 0 | ND |
| isovaleraldehyde | 0 | ND |
| L-Carvone | 0 | ND |
| linalyl acetate | 0.50162-0.93158 | 0.5712-1.0608 |
| linalyl butyrate | 0 | ND |
| 1-limonene | 0.01491-0.02769 | ND |
| L-menthyl acetate | 0 | ND |
| L-Rose Oxide | 0.03297-0.06123 | ND |
| Maltol | 0 | ND |
| methional | 0 | ND |
| methionyl acetate (3-methylthio- | 0 | ND |
| propylacetate) | | |
| methionyl butyrate | 0 | ND |
| methyl acetate | 0 | ND |
| Methyl anthranilate | 0 | ND |
| methyl benzoate | 0 | ND |
| Methyl cinnamate | 0 | ND |
| methyl decanoate | 0 | ND |
| methyl laurate | 0 | ND |
| Methyl Octanoate | 0 | ND |
| methyl salicylate | 0 | ND |
| Methyl β-naphthyl ketone | 0 | ND |
| methyl-2-pyrrolyl ketone | 0 | ND |
| Myrcene | 0 | ND |
| nerol | 0.05306-0.09854 | ND |
| nerolidol | 0 | ND |
| nonanal | 0 | ND |
| octanal | 0 | ND |
| omega-pentadecalactone | 0 | ND |
| p,a-dimethylstyrene | 0 | ND |
| p-anisaldehyde | 0 | ND |
| p-cresol | 0 | ND |
| p-cymene | 0.00714-0.01326 | ND |
| Perillaldehyde | 0 | ND |
| Phenethyl 2-methylbutyrate | 0 | ND |
| Phenethyl Acetate (2-phenylethylacetate) | 0.32928-0.61152 | ND |
| phenethyl alcohol (2-phenylethanol) | 6.5765-12.2135 | ND |
| Phenethyl Butyrate | 0.01687-0.03133 | ND |
| phenethyl formate | 0 | ND |
| phenethyl octanoate | 0 | ND |
| phenethyl propionate | 0.03318-0.06162 | ND |
| phenethyl tiglate | 0 | ND |
| phenylacetaldehyde | 0 | ND |
| phenylacetaldehyde dimethyl acetal | 0 | ND |
| propanal | 0 | ND |
| propyl acetate | 0 | ND |
| propyl isovalerate | 0 | ND |
| salicylaldehyde | 0 | ND |
| Terpinolene | 0 | ND |
| tetrahydrolinalool | 0 | ND |
| thymol | 0 | ND |
| valencene | 0 | ND |
| valeraldehyde | 0 | ND |
| vanillyl butyl ether | 0 | ND |
| vanillyl ethyl ether | 0 | ND |
| whiskey lactone | 0 | ND |

ND = Not determined

TABLE 13
Non-volatile compounds measured in Moscato replica

| | Run 1 | Run 2 | Run 3 | Run 4 | Run 5 | Run 6 |
|---|---|---|---|---|---|---|
| 2,3,5,6-Tetramethylpyrazine | OC | OC | OC | NF | NF | NF |
| 2,3,5-trimethylpyrazine | NF | OC | OC | NF | NF | NF |
| 2,3-dimethylpyrazine | NF | NF | NF | NF | NF | NF |
| 2-Furoic acid | NF | NF | NF | OC | OC | OC |
| 2-Isopropylmalic acid | OC | OC | OC | 9.87E−02 | 9.72E−02 | 1.05E−01 |
| 3,4-dihydroxybenzoic acid | NF | NF | NF | OC | OC | OC |
| 4-Guanidinobutyric acid | NF | NF | NF | NF | NF | NF |
| Acetovanillone | NR | NR | NR | NF | NF | NF |
| Adenine | NF | NF | NF | NF | NF | NF |
| Adipic acid | NF | NF | NF | NF | NF | NF |
| Arabitol | OC | 2.05E−01 | OC | NF | NF | NF |
| arginine | 2.20E+00 | 2.16E+00 | 2.05E+00 | 1.24E+01 | 1.44E+01 | 1.15E+01 |
| asparagine | 2.82E−01 | OC | 2.86E−01 | 1.06E+00 | 1.15E+00 | 1.24E+00 |
| Aspartic acid | NF | NF | NF | NF | NF | NF |
| B-Alanine | 4.54E+00 | 4.29E+00 | 4.60E+00 | 8.16E+00 | 8.12E+00 | 9.16E+00 |
| betaine | NF | NF | NF | NF | NF | NF |
| Caffeic acid | NR | NR | NR | NF | NF | NF |
| Camphoric acid | OC | OC | OC | OC | OC | OC |
| Carnitine | NF | NF | NF | OC | OC | OC |
| Carnosine | NF | NF | NF | NF | NF | NF |
| Catechin | NF | NF | NF | NF | NF | NF |
| Choline | OC | OC | OC | OC | OC | OC |
| Cinnamic acid | NR | NR | NR | OC | OC | OC |
| Citric acid | 1.20E+02 | 1.19E+02 | 1.21E+02 | OC | OC | OC |
| Citrulline | NF | NF | NF | NF | NF | NF |
| Coumaric acid | NR | NR | NR | NF | NF | NF |
| cysteine | NF | NF | NF | NF | NF | NF |
| Cystine | NF | NF | NF | NF | NF | NF |
| Cytidine | NF | NF | NF | NF | NF | NF |
| Cytosine | NF | NF | NF | NF | NF | NF |
| D-Glucuronic acid | 7.76E+00 | 9.00E+00 | 8.10E+00 | 2.55E+00 | 1.57E+00 | 1.83E+00 |
| Ellagic acid | NF | NF | NF | 5.62E−02 | 5.62E−02 | 5.62E−02 |
| Epicatechin | NF | NF | NF | NF | NF | NF |
| Epicatechin gallate | NR | NR | NR | NF | NF | NF |
| Fructose | OC | OC | OC | 1.92E+04 | 1.78E+04 | 2.36E+04 |
| Fucose | 1.95E+02 | 1.89E+02 | 1.65E+02 | 1.58E+03 | 2.07E+03 | 1.56E+03 |
| Fumaric acid | 8.02E+00 | 7.62E+00 | 7.57E+00 | 6.85E+00 | 6.82E+00 | 7.68E+00 |
| GABA | NF | NF | NF | 6.71E+00 | 6.64E+00 | 7.20E+00 |
| Gallic acid | NF | NF | NF | NF | NF | NF |
| Glucosamine | NF | NF | NF | 1.76E+01 | 1.83E+01 | 1.73E+01 |
| Glucose | OC | OC | OC | 2.40E+04 | 2.42E+04 | 3.74E+04 |
| Glutamic acid | 1.53E+01 | 1.55E+01 | 1.57E+01 | 8.09E+01 | OC | OC |
| Glutamine | NF | NF | NF | 6.33E−02 | 6.80E−02 | 7.54E−02 |
| Glycine | 1.45E+00 | 1.49E+00 | 1.47E+00 | 1.36E+00 | 1.38E+00 | 1.49E+00 |
| Guanine | NF | NF | 3.92E+02 | NF | NF | NF |
| Hesperetin | OC | OC | OC | NF | NF | NF |
| Histidine | 1.98E+00 | 1.96E+00 | 1.96E+00 | 3.12E+00 | 3.25E+00 | 3.79E+00 |
| Homoserine | NF | NF | NF | NF | NF | NF |
| isoleucine | 2.44E+01 | 2.44E+01 | 2.44E+01 | 8.14E+00 | 8.27E+00 | NF |
| Kynurenic acid | NR | NR | NR | NF | NF | NF |
| Lactic acid | 4.30E+01 | 4.12E+01 | 4.09E+01 | NF | NF | NF |
| Leucine | 7.41E+00 | 7.03E+00 | 7.47E+00 | 2.82E+01 | 2.89E+01 | 2.95E+01 |
| Lysine | OC | OC | OC | 1.34E+01 | 1.37E+01 | 1.39E+01 |
| Malic acid | 3.00E+03 | 2.97E+03 | 2.89E+03 | OC | OC | OC |
| Mannitol | 5.37E+01 | 5.23E+01 | 5.22E+01 | 9.54E+01 | 9.73E+01 | 1.00E+02 |
| Methionine | NF | NF | NF | NF | NF | NF |
| Methyl Gallate | NF | NF | NF | NF | NF | NF |
| Methyl 2-pyrrolyl ketone | NF | NF | NF | NF | NF | NF |
| Myo-Inositol | OC | OC | OC | NF | NF | NF |
| Ornithine | NF | NF | NF | NF | NF | NF |
| Pantothenic acid | NR | NR | NR | OC | OC | OC |
| Phenylalanine | 3.92E+00 | 3.90E+00 | 3.88E+00 | 1.23E+01 | 1.27E+01 | 1.33E+01 |
| Pipecolinic acid | NF | NF | NF | NF | NF | NF |
| Piperine | NF | NF | OC | NF | NF | NF |
| Polydatin | NR | NR | NR | NF | NF | NF |
| proline | 1.35E+02 | 1.34E+02 | 1.34E+02 | OC | OC | OC |
| Propyl gallate | NF | NF | NF | NF | NF | NF |
| Pyridine | NF | NF | NF | NF | NF | NF |
| Pyridoxine | NF | NF | NF | NF | NF | NF |
| Pyruvic acid | NF | NF | NF | 1.43E−01 | 4.04E−01 | NF |
| Quercetin | OC | OC | OC | OC | OC | OC |
| Quinic acid | NF | NF | NF | NF | NF | NF |
| Resveratrol | NF | NF | NF | NF | NF | NF |
| Rhamnose | 4.55E+01 | 4.33E+01 | 3.87E+01 | NF | NF | NF |
| Ribose | NF | NF | NF | NF | NF | NF |
| Rutin | NF | NF | NF | NF | NF | NF |
| Salicylic acid | OC | OC | OC | OC | OC | OC |
| Serine | NF | NF | NF | NF | NF | 3.44E−01 |
| Sinapinic acid | OC | NF | NF | NF | NF | NF |
| Sorbic acid | NF | NF | NF | NF | NF | NF |
| Sorbitol | NR | NR | NR | 1.98E+02 | 2.21E+02 | 2.31E+02 |
| Succinic acid | 1.75E+02 | 1.71E+02 | 1.70E+02 | 9.45E+01 | 9.12E+01 | 7.72E+01 |
| Syringaldehyde | NR | NR | NR | NF | NF | NF |
| Syringic acid | NR | NR | NR | NF | NF | NF |
| Tartaric acid | 5.09E+03 | 5.04E+03 | 4.93E+03 | OC | OC | OC |
| Threonine | 3.11E+00 | 3.25E+00 | 3.31E+00 | 4.27E+00 | 4.37E+00 | 4.88E+00 |
| Trans-4-hydroxyproline | OC | OC | OC | NF | NF | NF |
| Trans-Ferulic acid | OC | OC | OC | OC | OC | OC |
| Tryptamine | NF | NF | NF | NF | NF | NF |
| tryptophan | 4.45E+00 | 4.70E+00 | 4.76E+00 | 5.18E+00 | 5.22E+00 | 5.28E+00 |
| Tyramine | NF | NF | NF | NF | NF | NF |
| Tyrosine | 7.78E+00 | 7.63E+00 | 7.61E+00 | 1.01E+01 | 1.00E+01 | 1.09E+01 |
| Uracil | NF | NF | NF | NF | NF | NF |
| valine | 3.17E+02 | 3.19E+02 | 3.20E+02 | 3.90E+00 | 2.95E+00 | 3.40E+00 |
| Vanillic acid | NR | NR | NR | OC | NF | NF |
| Vanillin | NR | NR | NR | OC | OC | OC |
| Xylose | NR | NR | NR | 1.49E+04 | 1.62E+04 | 1.75E+04 |

NR = Not run
NF = Not found
OC = Outside of standard curve

### Example 4—Moscato Replica Concentrates

Moscato replica concentrates are made in ˜100 L test batches and held for a minimum number of weeks (e.g., 8 weeks), with periodic sampling (e.g., at 1, 2, 4, 6, and/or 8 weeks). Density measurements were taken each week, and replicate bottles of Moscato replica are produced. Samples are submitted for analytical testing versus a corresponding non-concentrated Moscato replica, and versus each other, to assess volatile and non-volatile components. Organoleptic comparisons also are conducted. The concentrates are held in HDPE vessels, or in stainless steel at the highest concentration, to ensure that there are no changes in composition due to the storage material.

A 2× or 3× Moscato replica concentrate is generated by combining ingredients as described in Example 1 above, but at amounts to yield a 2× or 3× concentration of each VOC and nonvolatile ingredient. The ingredients are stirred in and held for about 24 hours. The liquid is decanted and held hours to allow larger particulates to settle. This liquid is then filtered (e.g., through a 5 micron absolute polypropylene cartridge filter).

To find the appropriate volume of concentrate (e.g., 2×, 3×, 5×, 10×, or 20×) to add to create a finished product, the following formulas are used:

$$( {C}_{c o ncentrate} ) ( {V}_{c o n c e n t r a t e} ) = ( {C}_{final product} ) ( {V}_{final product} )$$

$${V}_{c o ncentrate} = \frac{( 1 ) ( {V}_{final product} )}{( {C}_{c o ncentrate} )}$$

### Where:

C_{final product}=concentration of final product=1 (i.e., 1×)

V_{final product}=desired volume of finished product

C_{concentrate}=concentration of the concentrate (e.g., 2×, 3×, 5×, 10×, or 20×)

V_{concentrate}=volume of concentrate to add to create finished product

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims

1. A Moscato-like alcoholic beverage comprising:
ethanol;
water; and
one or more additional volatile organic compounds (VOCs), wherein the additional VOCs comprise at least one compound selected from the group consisting of 1 para-menthene-8-thiol, 2,6-dimethylpyrazine, 2-acetyl-1-methylpyrrole, 2-ethyl-3(5 or 6)-dimethylpyrazine, 2-ethyl-3-methylpyrazine, 2-isobutyl-3-methoxypyrazine, 2-isobutyl-4-methyl-1,3-dioxolane, 2-methoxy-3-(1-methylpropyl) pyrazine, 2-pentylfuran, 3,7-dimethyl-6-octenoic acid, 3-methylthio hexyl acetate, 3-phenylpropanal, 4,5,6,7-tetrahydro-3,6-dimethylbenzofuran, 4-mercapto-4-methyl-2-pentanone, 5-methyl-2-phenyl-2-hexenal, allyl hexanoate, ethyl (methylthio) acetate, ethyl 2-trans-4-cis-decadienoate, ethyl-2-mercaptopropionate, furfuryl thioacetate, methionyl acetate (3-methylthio-propylacetate), methionyl butyrate, methyl-2-pyrrolyl ketone, phenethyl tiglate, and phenethylacetaldehyde dimethyl acetal.

2. The Moscato-like alcoholic beverage of claim 1, wherein the one or more additional VOCs comprise at least one compound selected from the group consisting of isobutyl-4-methyl-1,3-dioxolane, 2-pentylfuran, allyl hexanoate, and methionyl butyrate.

3. The Moscato-like alcoholic beverage of claim 1, wherein the one or more additional VOCs comprise at least one compound selected from the group consisting of 2-nonanol, 4-(4-hydroxyphenyl)-2-butanone, 4-hydroxy-2,5-dimethyl-3(2H)-furanone, 4-vinylphenol, butyraldehyde, citronellyl acetate, damascone, decanal, gamma-dodecalactone, hexanal, propionaldehyde, sotolon, and valeric acid.

4. The Moscato-like alcoholic beverage of claim 1, wherein the one or more additional VOCs comprise 2-nonanol, 4-vinylphenol, or both.

5. The Moscato-like alcoholic beverage of claim 1, wherein the one or more additional VOCs do not comprise one or more of 1-octanol, 1-octen-3-ol, 1-propanol, 2,4,6-trimethylphenol, 2-acetylpyridine, 2-isopropyl-3-methoxypyrazine, 2-methylbutyl acetate, 2-methylbutyraldehyde, 3-(methylthio)-1-propanol, 3,7-dimethyl-6-octanoic acid, 3-nonen-2-one, 5-ethyl-3-hydroxy-4-methyl-2(5H)-furanone, 5-methyl furfural, 6-methyl-5-hepten-2-one, acetaldehyde, a-phellandrene, b-caryophellene, butyl formate, butyl isovalerate, cinnamaldehyde, citral, damascone, D-camphor, decanol, dimethyl sulfide, ethyl acetate, ethyl palmitate, ethyl phenylacetate, ethyl propionate, ethyl trans-2-butenoate, ethyl-3-hydroxybutyrate, furfural, hexadecanol, hexyl hexanoate, isoborneol, isobutyl acetate, isovaleraldehyde, isovaleric acid, jasmine lactone, linalool oxide, methyl acetate, methyl cyclopentenolone, methyl decanoate, myrtenol, octyl acetate, p,a-dimethylstyrene, phenylacetaldehyde, propyl butyrate, propyl hexanoate,

6. The Moscato-like alcoholic beverage of claim 1, wherein the additional VOCs do not comprise one or more of 1-octanol, 1-octen-3-ol, 1-propanol, 2,4,6-trimethylphenol, 2-methylbutyl acetate, 2-methylbutyraldehyde, 5-ethyl-3-hydroxy-4-methyl-2(5H)-furanone, 6-methyl-5-hepten-2-one, b-caryophellene, butyl formate, cinnamaldehyde, citral, D-camphor, decanol, ethyl acetate, ethyl phenylacetate, ethyl propionate, ethyl trans-2-butenoate, hexadecanol, isobutyl acetate, isovaleraldehyde, methyl acetate, methyl decanoate, p,a-dimethylstyrene, phenylacetaldehyde, and terpinolene.

7. The Moscato-like alcoholic beverage of claim 1, wherein the one or more additional VOCs comprise:
an ester;
an acid;
an alcohol;
an aldehyde, a ketone, or an aldehyde and a ketone;
a terpene, an isoprenoid, or a terpene and an isoprenoid; and
a lactone.

8. The Moscato-like alcoholic beverage of claim 1, wherein the one or more additional VOCs comprise one or more esters.

9. The Moscato-like alcoholic beverage of claim 8, wherein the one or more esters are selected from the group consisting of 2-methylbutyl acetate, diethyl malate, diethyl succinate, ethyl 2-methylbutyrate, ethyl acetate, ethyl butyrate, ethyl decanoate, ethyl hexanoate, ethyl isobutyrate, ethyl isovalerate, ethyl lactate, ethyl laurate, ethyl myristate, ethyl octanoate, ethyl salicylate, ethyl valerate, hexyl acetate, isoamyl acetate, linalyl acetate, linalyl butyrate, methyl decanoate, methyl hexanoate, phenethyl acetate, phenethyl butyrate, phenethyl propionate, and mixtures thereof.

10. The Moscato-like alcoholic beverage of claim 8, wherein the one or more esters are present in a total amount of about 9 mg/L to about 70 mg/L.

11. The Moscato-like alcoholic beverage of claim 8, wherein the one or more esters are present in a total amount of at least about 26 mg/L.

12. The Moscato-like alcoholic beverage of claim 1, wherein the one or more additional VOCs comprise one or more acids.

13. The Moscato-like alcoholic beverage of claim 12, wherein the one or more acids are selected from the group consisting of butyric acid, decanoic acid, hexanoic acid, isobutyric acid, octanoic acid, and mixtures thereof.

14. The Moscato-like alcoholic beverage of 12, wherein the one or more acids are present in a total amount of about 0.07 mg/L to about 11 mg/L.

15. The Moscato-like alcoholic beverage of claim claim 1, wherein the one or more additional VOCs comprise one or more alcohols.

16. The Moscato-like alcoholic beverage of claim 15, wherein the one or more alcohols are selected from the group consisting of 1-propanol, 2-methyl-1-butanol, 2-nonanol, 3-methyl-1-pentanol, benzyl alcohol, butyl alcohol, hexyl alcohol, isoamyl alcohol, isobutyl alcohol, phenethyl alcohol, and mixtures thereof.

17. The Moscato-like alcoholic beverage of claim 15, wherein the one or more alcohols are present in a total amount of about 1.9 to about 86 mg/L.

18. The Moscato-like alcoholic beverage of claim 15, wherein the one or more alcohols are preset in a total amount of at least about 5.5 mg/L.

19. The Moscato-like alcoholic beverage of claim 1, wherein the one or more additional VOCs comprise one or more aldehydes or ketones.

20. The Moscato-like alcoholic beverage of claim 19, wherein the one or more aldehydes or ketones are selected from the group consisting of 2-nonanone, 2-undecanone, acetovanillone, benzaldehyde, damascenone, isobutyraldehyde, and mixtures thereof.

21. The Moscato-like alcoholic beverage of claim 19, wherein one or more aldehydes or ketones are present in a total amount of about 0.05 mg/L to about 0.6 mg/L.

22. The Moscato-like alcoholic beverage of claim 1, wherein the one or more additional VOCs comprise one or more terpenes or isoprenoids.

23. The Moscato-like alcoholic beverage of claim 22, wherein the one or more terpenes or isoprenoids are selected from the group consisting of 4-carvomenthenol, a-terpineol, beta-pinene, citronellol, eucalyptol, gamma-terpinene, geraniol, l-limonene, l-linalool, L-rose oxide, nerol, p-cymene, and mixtures thereof.

24. The Moscato-like alcoholic beverage of claim 22, wherein the one or more terpenes or isoprenoids are present in a total amount of about 0.08 mg/L to about 5 mg/L.

25. The Moscato-like alcoholic beverage of claim 1, wherein the one or more additional VOCs comprise one or more phenols.

26. The Moscato-like alcoholic beverage of claim 25, wherein the one or more phenols comprise 4-vinylphenol.

27. The Moscato-like alcoholic beverage of claim 25, wherein the one or more phenols are present in a total amount of about 0.001 mg/L to about 0.2 mg/L.

28. The Moscato-like alcoholic beverage of claim 1, wherein the one or more additional VOCs comprise one or more lactones.

29. The Moscato-like alcoholic beverage of claim 28, wherein the one or more lactones comprise delta-decalactone, gamma-decalactone, or both.

30. The Moscato-like alcoholic beverage of claim 28, wherein the one or more lactones are present in a total concentration of about 0.001 mg/L to about 2.5 mg/L.

31. The Moscato-like alcoholic beverage of claim 1, wherein the one or more additional VOCs comprise one or more amines or pyrazines.

32. The Moscato-like alcoholic beverage of claim 1, wherein the one or more additional VOCs comprise one or more thiols.

33. The Moscato-like alcoholic beverage of claim 32, wherein the one or more thiols comprise 3-mercaptohexyl acetate.

34. The Moscato-like alcoholic beverage of claim 1, wherein the one or more additional VOCs comprise at least 10 compounds selected from the group consisting of 2-methyl-1-butanol, 3-methyl-1-pentanol, a-terpineol, beta-pinene, butyric acid, decanoic acid, delta-decalactone, diethyl succinate, ethyl butyrate, ethyl decanoate, ethyl hexanoate, ethyl isobutyrate, ethyl lactate, ethyl laurate, ethyl octanoate, gamma-terpinene, geraniol, hexyl acetate, hexyl alcohol, isoamyl acetate, isobutyl alcohol, isobutyric acid, linalyl acetate, 1-limonene, 1-linalool, phenethyl acetate, and phenethyl alcohol.

35. The Moscato-like alcoholic beverage of claim 1, wherein the one or more additional VOCs comprise at least 10 compounds selected from the group consisting of 1-propanol, 2-methylbutyl acetate, 2-nonanone, 2-undecanone, 3-mercaptohexyl acetate, 4-carvomenthenol, benzaldehyde, benzyl alcohol, butyl alcohol, citronellol, damascenone, diethyl malate, ethyl 2-methylbutyrate, ethyl acetate, ethyl isovalerate, ethyl myristate, ethyl salicylate, ethyl valerate, eucalyptol, gamma-decalactone, hexanoic acid, isoamyl alcohol, isobutyraldehyde, linalyl butyrate, L-rose oxide, methyl decanoate, methyl hexanoate, nerol, octanoic acid, p-cymene, phenethyl butyrate, and phenethyl propionate.

36. The Moscato-like alcoholic beverage of claim 1, further comprising one or more non-volatile compounds.

37. The Moscato-like alcoholic beverage of claim 36, wherein the non-volatile compounds comprise one or more of alanine, cysteine, glutamine, mannose, and vanillin.

38. The Moscato-like alcoholic beverage of claim 36, wherein the non-volatile compounds do not comprise one or more of 2-isopropylmalic acid, 3,4-dihydroxybenzoic acid, 4-guanidinobutyric acid, adenine, caffeic acid, camphoric acid, carnitine, catechin, choline, coumaric acid, cytidine, cytosine, D-glucuronic acid, epicatechin, gallic acid, guanine, homoserine, methionine, pantothenic acid, polydatin, pyridoxine, pyruvic acid, quercetin, salicylic acid, serine, sorbitol, trans-4-hydroxyproline, trans-ferulic acid, and uracil.

39. The Moscato-like alcoholic beverage of claim 36, wherein the non-volatile compounds comprise at least 10 compounds selected from the group consisting of 2-isopropylmalic acid, arginine, asparagine, beta-alanine, camphoric acid, choline, citric acid, D-glucuronic acid, fructose, fucose, fumaric acid, GABA, glucose, glutamic acid, glutamine, glycine, histidine, isoleucine, lactic acid, leucine, lysine, malic acid, mannitol, inositol, phenylalanine, proline, quercetin, salicylic acid, sorbitol, succinic acid, tartaric acid, threonine, trans-ferulic acid, tryptophan, tyrosine, and valine.

40. The Moscato-like beverage of claim 1, wherein the one or more additional VOCs are present in a total amount of less than 120 mg/L.

41. A method of making a Moscato-like alcoholic beverage, the method comprising combining ingredients comprising:
water,
one or more acids,
one or more sugars or sugar alcohols,
a pH-modifying salt,
optionally, one or more nucleotide monophosphates,
one or more amino acids,
ethanol, and
ten or more additional VOCs selected from the group consisting of 2-methyl-1-butanol, 2-nonanol, 2-nonanone, 2-undecanone, 3-methyl-1-pentanol, 4-carvomenthenol, a-terpineol, benzaldehyde, beta-pinene, butyl alcohol, butyric acid, citronellol, decanoic acid, delta-decalactone, diethyl malate, diethyl succinate, ethyl 2-methylbutyrate, ethyl butyrate, ethyl decanoate, ethyl isobutyrate, ethyl lactate, ethyl laurate, ethyl myristate, ethyl octanoate, ethyl salicylate, eucalyptol, gamma-terpinene, geraniol, hexanoic acid, hexyl acetate, hexyl alcohol, isoamyl acetate, isoamyl alcohol, isobutyl alcohol, isobutyraldehyde, isobutyric acid, linalyl acetate, 1-limonene, L-rose oxide, nerol, p-cymene, phenethyl acetate, phenethyl alcohol, phenethyl butyrate, and phenethyl propionate.

42. (canceled)

43. The Moscato-like alcoholic beverage of claim 36, wherein the one or more non-volatile compounds comprise glycerol, glucose, and fructose.

44. The Moscato-like alcoholic beverage of claim 36, wherein the one or more non-volatile compounds comprise potassium hydroxide.

45. (canceled)

46. The Moscato-like alcoholic beverage of claim 36, wherein the one or more non-volatile compounds comprise a surfactant.

47. The Moscato-like alcoholic beverage of claim 36, wherein the one or more non-volatile compounds comprise a compound selected from the group consisting of gum arabic, pectin, and combinations thereof.

48.-51. (canceled)

52. A Moscato-like alcoholic beverage concentrate comprising:
ethanol;
water; and
one or more additional VOCs, wherein at least one of the one or more additional VOCs is present in a concentration of at least about 2-fold the concentration of the same VOC in a corresponding traditional Moscato, one or more non-volatile compounds, wherein at least one of the one or more non-volatile compounds is present in a concentration of at least about 2-fold the concentration of the same non-volatile compound in a corresponding traditional Moscato, or a combination thereof.

53. (canceled)

54. (canceled)

55. The Moscato-like alcoholic beverage of claim 1, wherein the one or more additional VOCs comprise at least one compound selected from the group consisting of 3-phenylpropanal, ethyl 2-trans-4-cis-decadienoate, phenethyl tiglate, and phenethylacetaldehyde dimethyl acetal.

56. The Moscato-like alcoholic beverage of claim 1, wherein the one or more additional VOCs comprise at least one compound selected from the group consisting of 1-para-menthene-8-thiol, 3-methylthio hexyl acetate, 4-mercapto-4-methyl-2-pentanone, ethyl (methylthio) acetate, ethyl-2-mercaptopropionate, and methionyl acetate (3-methylthio-propylacetate).
